(19) United States
(12) Patent Application Publication
(10) Pub. No.: US 2020/0168026 A1
(43) Pub. Date: May 28, 2020

(54) Food Printing Systems and Methods

(71) Applicant: Elwha LLC, Bellevue, WA (US)

(72) Inventors: Paul Holman, Seattle, WA (US); Royce A. Levien, Cambridge, MA (US); Mark A. Malamud, Seattle, WA (US); Neal Stephenson, Seattle, WA (US); Christopher Charles Young, Seattle, WA (US)

(21) Appl. No.: 16/666,241

(22) Filed: Oct. 28, 2019

Related U.S. Application Data
(63) Continuation of application No. 14/793,693, filed on Jul. 7, 2015, now abandoned.
Application No. 14/793,693 is a continuation-in-part of application No. 14/792,552, filed on Jul. 6, 2015, now abandoned.
Application No. 14/792,552 is a continuation-in-part of application No. 14/789,962, filed on Jul. 1, 2015, now abandoned.
Application No. 14/789,962 is a continuation-in-part of application No. 14/788,716, filed on Jun. 30, 2015, now abandoned.
Application No. 14/788,716 is a continuation-in-part of application No. 14/753,907, filed on Jun. 29, 2015, now Pat. No. 10,115,093.
Application No. 14/753,907 is a continuation-in-part of application No. 14/750,950, filed on Jun. 25, 2015, now Pat. No. 10,239,256.
Application No. 14/750,950 is a continuation-in-part of application No. 14/748,220, filed on Jun. 23, 2015, now abandoned.
Application No. 14/748,220 is a continuation-in-part of application No. 14/745,313, filed on Jun. 19, 2015, now abandoned.
Application No. 14/745,313 is a continuation-in-part of application No. 13/596,499, filed on Aug. 28, 2012, now abandoned.
Application No. 13/596,499 is a continuation-in-part of application No. 13/596,469, filed on Aug. 28, 2012, now abandoned.
Application No. 13/596,469 is a continuation-in-part of application No. 13/590,799, filed on Aug. 21, 2012, now abandoned.
Application No. 13/590,799 is a continuation-in-part of application No. 13/590,774, filed on Aug. 21, 2012, now abandoned.
Application No. 13/590,774 is a continuation-in-part of application No. 13/560,477, filed on Jul. 27, 2012, now abandoned.
Application No. 13/560,477 is a continuation-in-part of application No. 13/560,447, filed on Jul. 27, 2012, now abandoned.
Application No. 13/560,447 is a continuation-in-part of application No. 13/554,237, filed on Jul. 20, 2012, now Pat. No. 9,619,958.
Application No. 13/554,237 is a continuation-in-part of application No. 13/554,194, filed on Jul. 20, 2012, now abandoned.
Application No. 13/554,194 is a continuation-in-part of application No. 13/548,671, filed on Jul. 13, 2012, now Pat. No. 10,104,904.
Application No. 13/548,671 is a continuation-in-part of application No. 13/548,633, filed on Jul. 13, 2012, now abandoned.
Application No. 13/548,633 is a continuation-in-part of application No. 13/535,902, filed on Jun. 28, 2012, now abandoned.
Application No. 13/535,902 is a continuation-in-part of application No. 13/535,855, filed on Jun. 28, 2012, now abandoned.
Application No. 13/535,855 is a continuation-in-part of application No. 13/528,331, filed on Jun. 20, 2012, now Pat. No. 10,121,218.
Application No. 13/528,331 is a continuation-in-part of application No. 13/528,298, filed on Jun. 20, 2012, now abandoned.
Application No. 13/528,298 is a continuation-in-part of application No. 13/494,654, filed on Jun. 12, 2012, now abandoned.
Application No. 13/494,654 is a continuation-in-part of application No. 13/494,536, filed on Jun. 12, 2012, now abandoned.
Application No. 13/494,536 is a continuation-in-part of application No. 13/435,591, filed on Mar. 30, 2012, now abandoned.
Application No. 13/435,591 is a continuation-in-part of application No. 13/435,550, filed on Mar. 30, 2012, now abandoned.
Application No. 13/435,550 is a continuation-in-part of application No. 13/432,525, filed on Mar. 28, 2012, now abandoned.
Application No. 13/432,525 is a continuation-in-part of application No. 13/432,507, filed on Mar. 28, 2012, now abandoned.
Application No. 13/432,507 is a continuation-in-part of application No. 13/385,690, filed on Feb. 29, 2012, now abandoned.
Application No. 13/385,690 is a continuation-in-part of application No. 13/385,687, filed on Feb. 29, 2012, now abandoned.
Application No. 13/385,687 is a continuation-in-part of application No. 13/385,129, filed on Feb. 1, 2012, now abandoned.
Application No. 13/385,129 is a continuation-in-part of application No. 13/385,128, filed on Feb. 1, 2012, now abandoned.
Application No. 13/385,128 is a continuation-in-part of application No. 13/373,847, filed on Nov. 30, 2011, now abandoned.
Application No. 13/373,847 is a continuation-in-part of application No. 13/373,846, filed on Nov. 30, 2011, now Pat. No. 10,026,336.
Application No. 13/373,846 is a continuation-in-part of application No. 13/373,675, filed on Nov. 22, 2011, now Pat. No. 9,922,576.
Application No. 13/373,675 is a continuation-in-part of application No. 13/373,674, filed on Nov. 22, 2011, now abandoned.
Application No. 13/373,674 is a continuation-in-part of application No. 13/317,979, filed on Oct. 31, 2011, now Pat. No. 9,111,256.
Application No. 13/317,979 is a continuation-in-part of application No. 13/317,978, filed on Oct. 31, 2011, now Pat. No. 9,785,985.
Application No. 13/317,978 is a continuation-in-part of application No. 13/317,546, filed on Oct. 19, 2011, now Pat. No. 9,037,478.
Application No. 13/317,546 is a continuation-in-part of application No. 13/317,545, filed on Oct. 19, 2011, now abandoned.
Application No. 13/317,545 is a continuation-in-part of application No. 13/200,907, filed on Oct. 3, 2011, now Pat. No. 9,997,006.
Application No. 13/200,907 is a continuation-in-part of application No. 13/200,906, filed on Oct. 3, 2011, now Pat. No. 9,947,167.
Application No. 13/200,906 is a continuation-in-part of application No. 13/200,830, filed on Sep. 30, 2011, now abandoned.
Application No. 13/200,830 is a continuation-in-part of application No. 13/200,829, filed on Sep. 30, 2011, now abandoned.
Application No. 13/200,829 is a continuation-in-part of application No. 13/200,113, filed on Sep. 16, 2011, now Pat. No. 8,892,249.
Application No. 13/200,113 is a continuation-in-part of application No. 13/200,106, filed on Sep. 16, 2011, now Pat. No. 8,989,895.
Application No. 13/200,106 is a continuation-in-part of application No. 13/199,545, filed on Aug. 31, 2011, now Pat. No. 9,240,028.
Application No. 13/199,545 is a continuation-in-part of application No. 13/199,544, filed on Aug. 31, 2011, now Pat. No. 10,192,037.
Application No. 13/199,544 is a continuation-in-part of application No. 13/199,481, filed on Aug. 30, 2011, now Pat. No. 9,600,850.
Application No. 13/199,481 is a continuation-in-part of application No. 13/199,361, filed on Aug. 26, 2011, now abandoned.

(51) Int. Cl. G07F 17/00; G06F 16/29; G06F 3/048; G05B 15/02; G06Q 30/02

(52) U.S. Cl. CPC G07F 17/0064; G06F 16/29; G06Q 30/02; G05B 15/02; G06F 3/048

(57) ABSTRACT

Electronically directing control at least in part of acquisition of refuse intelligence including information related to one or more discarded portions of at least one of the one or more selected ingestible products discarded by the particular individual subsequent to ingestion by the particular individual living being of one or more other ingested portions of the at least one of the one or more selected ingestible products within a second vicinity of the electronically outputting of the electronically generated one or more selection menus. In addition to the foregoing, other method aspects are described in the claims, drawings, and text forming a part of the present disclosure.

If an Application Data Sheet (ADS) has been filed on the filing date of this application, it is incorporated by reference herein. Any applications claimed on the ADS for priority under 35 U.S.C. § § 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)).

### Priority Applications

For purposes of the USPTO extra-statutory requirements, the present application constitutes a continuation-in-part of U.S. patent application Ser. No. 13/199,361, entitled CONTROLLED SUBSTANCE AUTHORIZATION SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 26 Aug. 2011, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/199,481, entitled CONTROLLED SUBSTANCE AUTHORIZATION SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 30 Aug. 2011, now issued as U.S. Pat. No. 9,600,850, and which is an application of which a currently co-pending application is entitled to the benefit of the filing date.

For purposes of the USPTO extra-statutory requirements, the present application constitutes a continuation-in-part of U.S. patent application Ser. No. 13/199,545, entitled REPORTING SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 31 Aug. 2011, now issued as U.S. Pat. No. 9,240,028, and which is an application of which a currently co-pending application is entitled to the benefit of the filing date.

For purposes of the USPTO extra-statutory requirements, the present application constitutes a continuation-in-part of U.S. patent application Ser. No. 13/199,544, entitled REPORTING SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 31 Aug. 2011, now issued as U.S. Pat. No. 10,192,037, and which is an application of which a currently co-pending application is entitled to the benefit of the filing date.

The present application claims benefit of priority of and constitutes a continuation-in-part of U.S. patent application Ser. No. 13/200,113, entitled SUBSTANCE CONTROL SYSTEM AND METHOD FOR DISPENSING SYSTEMS, naming PAUL HOLMAN, ROYCE A. LEVIEN, MARK A. MALAMUD, NEAL STEPHENSON, AND CHRISTOPHER CHARLES YOUNG as inventors, filed 16 Sep. 2011, now issued as U.S. Pat. No. 8,892,249, which is an application of which a currently co-pending priority application is entitled to the benefit of the filing date.

The present application claims benefit of priority of and constitutes a continuation-in-part of U.S. patent application Ser. No. 13/200,106, entitled SUBSTANCE CONTROL SYSTEM AND METHOD FOR DISPENSING SYSTEMS, naming PAUL HOLMAN, ROYCE A. LEVIEN, MARK A. MALAMUD, NEAL STEPHENSON, AND CHRISTOPHER CHARLES YOUNG as inventors, filed 16 Sep. 2011, now issued as U.S. Pat. No. 8,989,895, which is an application of which a currently co-pending priority application is entitled to the benefit of the filing date.

For purposes of the USPTO extra-statutory requirements, the present application constitutes a continuation-in-part of U.S. patent application Ser. No. 13/200,830, entitled CLEANING SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 30 Sep. 2011, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/200,829, entitled CLEANING SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 30 Sep. 2011, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/200,907, entitled TREATMENT SYSTEM AND METHOD FOR INGESTIBLE PRODUCT DISPENSING SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 3 Oct. 2011, now issued as U.S. Pat. No. 9,997,006, and which is an application of which a currently co-pending application is entitled to the benefit of the filing date.

For purposes of the USPTO extra-statutory requirements, the present application constitutes a continuation-in-part of U.S. patent application Ser. No. 13/200,906, entitled TREATMENT SYSTEM AND METHOD FOR INGESTIBLE PRODUCT DISPENSING SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 3 Oct. 2011, now issued as U.S. Pat. No. 9,947,167, and which is an application of which a currently co-pending application is entitled to the benefit of the filing date.

For purposes of the USPTO extra-statutory requirements, the present application constitutes a continuation-in-part of U.S. patent application Ser. No. 13/317,545, entitled SUBSTANCE ALLOCATION SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 19 Oct. 2011, which is currently co-pending or is an application of which a currently co-pending application is entitled to the benefit of the filing date.

The present application claims benefit of priority of U.S. patent application Ser. No. 13/317,546, entitled SUBSTANCE ALLOCATION SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 19 Oct. 2011, now issued as U.S. Pat. No. 9,037,478, which is an application of which a currently co-pending priority application is entitled to the benefit of the filing date.

For purposes of the USPTO extra-statutory requirements, the present application constitutes a continuation-in-part of U.S. patent application Ser. No. 13/317,979, entitled SELECTION INFORMATION SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 31 Oct. 2011, now issued as U.S. Pat. No. 9,111,256, and which is an application of which a currently co-pending application is entitled to the benefit of the filing date.

For purposes of the USPTO extra-statutory requirements, the present application constitutes a continuation-in-part of U.S. patent application Ser. No. 13/317,978, entitled SELECTION INFORMATION SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 31 Oct. 2011, now issued as U.S. Pat. No. 9,785,985, and which is an application of which a currently co-pending application is entitled to the benefit of the filing date.

For purposes of the USPTO extra-statutory requirements, the present application constitutes a continuation-in-part of U.S. patent application Ser. No. 13/373,675, entitled INGESTION INTELLIGENCE ACQUISITION SYSTEM AND METHOD FOR INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 22 Nov. 2011, now issued as U.S. Pat. No. 9,922,576, and which is an application of which a currently co-pending application is entitled to the benefit of the filing date.

For purposes of the USPTO extra-statutory requirements, the present application constitutes a continuation-in-part of U.S. patent application Ser. No. 13/373,674, entitled INGESTION INTELLIGENCE ACQUISITION SYSTEM AND METHOD FOR INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 22 Nov. 2011, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/373,846, entitled REFUSE INTELLIGENCE ACQUISITION SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 30 Nov. 2011, now issued as U.S. Pat. No. 10,026,336, and which is an application of which a currently co-pending application is entitled to the benefit of the filing date.

For purposes of the USPTO extra-statutory requirements, the present application constitutes a continuation-in-part of U.S. patent application Ser. No. 13/373,847, entitled REFUSE INTELLIGENCE ACQUISITION SYSTEM AND METHOD FOR INGESTIBLE PRODUCT PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 30 Nov. 2011, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/385,128, entitled ITINERARY INTEGRATION SYSTEM AND METHOD FOR VENDING NETWORK SYSTEMS, naming PAUL HOLMAN, ROYCE A. LEVIEN, MARK A. MALAMUD, NEAL STEPHENSON, AND CHRISTOPHER CHARLES YOUNG as inventors, filed 1 Feb. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/385,129, entitled ITINERARY INTEGRATION SYSTEM AND METHOD FOR VENDING NETWORK SYSTEMS, naming PAUL HOLMAN, ROYCE A. LEVIEN, MARK A. MALAMUD, NEAL STEPHENSON, AND CHRISTOPHER CHARLES YOUNG as inventors, filed 1 Feb. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/385,687, entitled SOCIAL NETWORK REPORTING SYSTEM AND METHOD FOR INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 29 Feb. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/385,690, entitled SOCIAL NETWORK REPORTING SYSTEM AND METHOD FOR INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 29 Feb. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/432,507, entitled SOCIAL NETWORK SELECTION SYSTEM AND METHOD FOR INGESTIBLE MATERIAL PREPARATION SYSTEM, naming PAUL HOLMAN, ROYCE A. LEVIEN, MARK A. MALAMUD, NEAL STEPHENSON, AND CHRISTOPHER CHARLES YOUNG as inventors, filed 28 Mar. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/432,525, entitled SOCIAL NETWORK SELECTION SYSTEM AND METHOD FOR INGESTIBLE MATERIAL PREPARATION SYSTEM, naming PAUL HOLMAN, ROYCE A. LEVIEN, MARK A. MALAMUD, NEAL STEPHENSON, AND CHRISTOPHER CHARLES YOUNG as inventors, filed 28 Mar. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/435,550, entitled STOCK SUPPLY BASED MODIFIABLE SELECTION SYSTEM AND METHOD FOR INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 30 Mar. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/435,591, entitled STOCK SUPPLY BASED MODIFIABLE SELECTION SYSTEM AND METHOD FOR INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 30 Mar. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/494,536, entitled SUBSTRATE STRUCTURE DEPOSITION TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 12 Jun. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/494,654, entitled SUBSTRATE STRUCTURE DEPOSITION TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 12 Jun. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/528,298 entitled SUBSTRATE STRUCTURE INJECTION TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 20 Jun. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/528,331 entitled SUBSTRATE STRUCTURE INJECTION TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 20 Jun. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/535,855 entitled SUBSTRATE STRUCTURE APPLIED FORCE TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 28 Jun. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/535,902 entitled SUBSTRATE STRUCTURE APPLIED FORCE TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 28 Jun. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/548,633 entitled SUBSTRATE STRUCTURE PARTS ASSEMBLY TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 13 Jul. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/548,671 entitled SUBSTRATE STRUCTURE PARTS ASSEMBLY TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 13 Jul. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/554,194 entitled SUBSTRATE STRUCTURE DUCT TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 20 Jul. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/554,237 entitled SUBSTRATE STRUCTURE DUCT TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 20 Jul. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/560,447 entitled SUBSTRATE STRUCTURE MASKING TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 27 Jul. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/560,477 entitled SUBSTRATE STRUCTURE MASKING TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 27 Jul. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/590,774 entitled SUBSTRATE STRUCTURE DIRECTED ENERGY TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 21 Aug. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/590,799 entitled SUBSTRATE STRUCTURE DIRECTED ENERGY TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 21 Aug. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/596,469 entitled SUBSTRATE STRUCTURE EMBEDDED SECONDARY MATERIAL TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 28 Aug. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/596,499 entitled SUBSTRATE STRUCTURE EMBEDDED SECONDARY MATERIAL TREATMENT SYSTEM AND METHOD FOR INGESTIBLE PRODUCT SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 28 Aug. 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 14/745,313 entitled 3D FOOD PRINTING SHOPPING HISTORY SUBSTRATE STRUCTURE INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 19 Jun. 2015, which is currently co-pending or is an application of which a currently co-pending application is entitled to the benefit of the filing date.

For purposes of the USPTO extra-statutory requirements, the present application constitutes a continuation-in-part of U.S. patent application Ser. No. 14/748,220 entitled FOOD PRINTING ADDITIVE MANUFACTURING SUBSTRATE STRUCTURE INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 23 Jun. 2015, which is currently co-pending or is an application of which a currently co-pending application is entitled to the benefit of the filing date.

For purposes of the USPTO extra-statutory requirements, the present application constitutes a continuation-in-part of U.S. patent application Ser. No. 14/750,950 entitled FOOD PRINTING ADDITIVE LAYERING SUBSTRATE STRUCTURE INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 25 Jun. 2015, now issued as U.S. Pat. No. 10,239,256, and which is an application of which a currently co-pending application is entitled to the benefit of the filing date.

For purposes of the USPTO extra-statutory requirements, the present application constitutes a continuation-in-part of U.S. patent application Ser. No. 14/753,907 entitled FOOD PRINTING GOAL IMPLEMENTATION SUBSTRATE STRUCTURE INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 29 Jun. 2015, now issued as U.S. Pat. No. 10,115,093, and which is an application of which a currently co-pending application is entitled to the benefit of the filing date.

For purposes of the USPTO extra-statutory requirements, the present application constitutes a continuation-in-part of U.S. patent application Ser. No. 14/788,716 entitled FOOD PRINTING DISTRIBUTION NETWORK SUBSTRATE STRUCTURE INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 30 Jun. 2015, which is currently co-pending or is an application of which a currently co-pending application is entitled to the benefit of the filing date.

For purposes of the USPTO extra-statutory requirements, the present application constitutes a continuation-in-part of U.S. patent application Ser. No. 14/789,962 entitled FOOD PRINTING STOCK SUPPLY SUBSTRATE STRUCTURE INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 1 Jul. 2015, which is currently co-pending or is an application of which a currently co-pending application is entitled to the benefit of the filing date.

For purposes of the USPTO extra-statutory requirements, the present application constitutes a continuation-in-part of U.S. patent application Ser. No. 14/792,552 entitled FOOD PRINTING CUSTOMER LOYALTY SUBSTRATE STRUCTURE INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 6 Jul. 2015, which is currently co-pending or is an application of which a currently co-pending application is entitled to the benefit of the filing date.

For purposes of the USPTO extra-statutory requirements, the present application constitutes a continuation of U.S. patent application Ser. No. 14/793,693 entitled FOOD PRINTING DATA STORE SUBSTRATE STRUCTURE INGESTIBLE MATERIAL PREPARATION SYSTEM AND METHOD, naming PAUL HOLMAN, ROYCE A. LEVIEN, MARK A. MALAMUD, NEAL STEPHENSON, AND CHRISTOPHER CHARLES YOUNG as inventors, filed 7 Jul. 2015, which is currently co-pending.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

A method includes, but is not limited to electronically receiving user status information regarding a particular individual living being including living being identification associated with the particular individual living being and electronically receiving selection information of one or more selected ingestible products via electronically enabled input in response to electronically outputted one or more selection menus prior to dispensing of the one or more selected ingestible products for ingestion by the particular individual living being to electronically direct control of at least partial preparation of the one or more selected ingestible products subsequent to and based at least in part upon the selection of the one or more selected ingestible products via the electronically enabled input in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus; and electronically directing control at least in part of acquisition of refuse intelligence including information related to one or more discarded portions of at least one of the one or more selected ingestible products discarded by the particular individual subsequent to ingestion by the particular individual living being of one or more other ingested portions of the at least one of the one or more selected ingestible products within a second vicinity of the electronically outputting of the electronically generated one or more selection menus.

In one or more various aspects, related machines, compositions of matter, or manufactures of systems may include, but are not limited to, virtually any combination of hardware, software, and/or firmware configured to effect the herein-referenced method aspects depending upon the design choices of the system designer (limited to patentable subject matter under 35 USC 101).

A system includes, but is not limited to: means for electronically receiving user status information regarding a particular individual living being including living being identification associated with the particular individual living being and electronically receiving selection information of one or more selected ingestible products via electronically enabled input in response to electronically outputted one or more selection menus prior to dispensing of the one or more selected ingestible products for ingestion by the particular individual living being to electronically direct control of at least partial preparation of the one or more selected ingestible products subsequent to and based at least in part upon the selection of the one or more selected ingestible products via the electronically enabled input in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus; and means for electronically directing control at least in part of acquisition of refuse intelligence including information related to one or more discarded portions of at least one of the one or more selected ingestible products discarded by the particular individual subsequent to ingestion by the particular individual living being of one or more other ingested portions of the at least one of the one or more selected ingestible products within a second vicinity of the electronically outputting of the electronically generated one or more selection menus. In addition to the foregoing, other system aspects are described in the claims, drawings, and text forming a part of the present disclosure.

A system includes, but is not limited to a receiving information electrical circuitry arrangement for electronically receiving user status information regarding a particular individual living being including living being identification associated with the particular individual living being and electronically receiving selection information of one or more selected ingestible products via electronically enabled input in response to electronically outputted one or more selection menus prior to dispensing of the one or more selected ingestible products for ingestion by the particular individual living being to electronically direct control of at least partial preparation of the one or more selected ingestible products subsequent to and based at least in part upon the selection of the one or more selected ingestible products via the electronically enabled input in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus; and a controlling acquisition electrical circuitry arrangement for electronically directing control at least in part of acquisition of refuse intelligence including information related to one or more discarded portions of at least one of the one or more selected ingestible products discarded by the particular individual subsequent to ingestion by the particular individual living being of one or more other ingested portions of the at least one of the one or more selected ingestible products within a second vicinity of the electronically outputting of the electronically generated one or more selection menus. In addition to the foregoing, other system aspects are described in the claims, drawings, and text forming a part of the present disclosure.

An article of manufacture including a non-transitory signal-bearing storage medium bearing one or more instructions for electronically receiving user status information regarding a particular individual living being including living being identification associated with the particular individual living being and electronically receiving selection information of one or more selected ingestible products via electronically enabled input in response to electronically outputted one or more selection menus prior to dispensing of the one or more selected ingestible products for ingestion by the particular individual living being to electronically direct control of at least partial preparation of the one or more selected ingestible products subsequent to and based at least in part upon the selection of the one or more selected ingestible products via the electronically enabled input in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus; and one or more instructions for electronically directing control at least in part of acquisition of refuse intelligence including information related to one or more discarded portions of at least one of the one or more selected ingestible products discarded by the particular individual subsequent to ingestion by the particular individual living being of one or more other ingested portions of the at least one of the one or more selected ingestible products within a second vicinity of the electronically outputting of the electronically generated one or more selection menus. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic diagram depicting a first application of a first exemplary implementation of an ingestible product preparation system 10 including a selection information system.

FIG. 1A is a fragmentary view depicting a second application of the first exemplary implementation of the ingestible product preparation system 10 of FIG. 1.

FIG. 1B is a fragmentary view depicting a third application of the first exemplary implementation of the ingestible product preparation system 10 of FIG. 1.

FIG. 1C is a fragmentary view depicting a fourth application of the first exemplary implementation of an ingestible product preparation system 10 including a substance allocation system therefor.

FIG. 2 is a schematic diagram depicting a first implementation of refuse intelligence acquisition associated with the ingestible product preparation system 10 of FIG. 1.

FIG. 3 is a schematic diagram depicting a second implementation of refuse intelligence acquisition associated with the ingestible product preparation system 10 of FIG. 1.

FIG. 4 is a schematic view depicting a third implementation of refuse intelligence acquisition related to the ingestible product preparation system 10 in FIG. 1.

FIG. 5 is a schematic view depicting a fourth implementation of refuse intelligence acquisition related to the ingestible product preparation system 10 in FIG. 1.

FIG. 6 is a schematic diagram depicting a network implementation of refuse some acquired acquisition intelligence information of extrinsic environmental factors related to the ingestible product preparation system 10 in FIG. 1.

FIG. 7 is a schematic view depicting a fifth implementation of refuse intelligence acquisition related to the ingestible product preparation system 10 in FIG. 1.

FIG. 8 is a schematic view depicting a sixth implementation of refuse intelligence acquisition related to the ingestible product preparation system 10 in FIG. 1.

FIG. 9 is a schematic view depicting a seventh implementation of refuse intelligence acquisition related to the ingestible product preparation system 10 in FIG. 1.

FIG. 10 is a schematic view depicting an eighth implementation of refuse intelligence acquisition related to the ingestible product preparation system 10 in FIG. 1.

FIG. 11 is a schematic view depicting a ninth implementation of refuse intelligence acquisition related to the ingestible product preparation system 10 in FIG. 1.

FIG. 12 is a perspective view depicting a first application of a first exemplary implementation of an ingestible product preparation system.

FIG. 12A is a fragmentary view depicting a second application of the first exemplary implementation of the ingestible product preparation system of FIG. 12.

FIG. 12B is a fragmentary view depicting a third application of the first exemplary implementation of the ingestible product preparation system of FIG. 12.

FIG. 12C is a fragmentary view depicting a fourth application of the first exemplary implementation of the ingestible product preparation system of FIG. 12.

FIG. 13 is a perspective view depicting a first application of a second exemplary implementation of the ingestible product preparation system of FIG. 12.

FIG. 14 is a perspective view depicting a second application of the second exemplary implementation of the ingestible product preparation system of FIG. 12.

FIG. 15 is a perspective view depicting another location for placement of the ingestible product preparation system.

FIG. 16 is a perspective view depicting a communication network incorporating the ingestible product preparation system of FIG. 12.

FIG. 17 is a perspective view depicting various locations for placement of the ingestible product preparation system of FIG. 12.

FIG. 18 is a perspective view of a first exemplary ingestible substrate implementation.

FIG. 19 is a perspective view of a second ingestible substrate implementation.

FIG. 20 is a perspective view of a third ingestible substrate implementation.

FIG. 21 is a perspective view of a fourth ingestible substrate implementation.

FIG. 22 is a perspective view of a first exemplary directed energy treatment assembly configured for the ingestible product preparation system.

FIG. 23 is a perspective view of a second exemplary directed energy treatment assembly configured for the ingestible product preparation system.

FIG. 24 is a perspective view of a third direct energy treatment assembly configured for the ingestible product preparation system.

FIG. 25 is a perspective view of a fourth directed energy treatment assembly configured for the ingestible product preparation system.

FIG. 26 is a perspective view of the fourth directed energy treatment assembly configured for the ingestible product preparation system.

FIG. 27 is a perspective view of a fifth directed energy treatment assembly configured for the ingestible product preparation system.

FIG. 28 is a perspective view of the fifth directed energy treatment assembly configured for the ingestible product preparation system.

FIG. 29 is a block diagram depicting an exemplary implementation of the ingestible product preparation system 110 of FIG. 12 including exemplary subsystems.

FIG. 30 is a block diagram depicting a control and information processing subsystem s100 of an exemplary implementation of the ingestible product preparation system 10 of FIG. 1.

FIG. 31 is a block diagram depicting an information storage subsystem s200 of an exemplary implementation of the ingestible product preparation system 10 of FIG. 1.

FIG. 32 is a block diagram depicting an information user interface subsystem s300 of an exemplary implementation of the ingestible product preparation system 10 of FIG. 1.

FIG. 33 is a block diagram depicting a sensing subsystem s400 of an exemplary implementation of the ingestible product preparation system 10 of FIG. 1.

FIG. 34 is a block diagram depicting an electronic communication subsystem s500 of an exemplary implementation of the ingestible product preparation system 10 of FIG. 1.

FIG. 35 is a block diagram depicting a power subsystem s600 of an exemplary implementation of the ingestible product preparation system 10 of FIG. 1.

FIG. 36 is a block diagram depicting a material processing subsystem s700 of an exemplary implementation of the ingestible product preparation system 10 of FIG. 1.

FIG. 37 is a block diagram depicting a preparation subsystem s800 of an exemplary implementation of the ingestible product preparation system 10 of FIG. 1.

FIG. 38 is a block diagram depicting a treatment subsystem s900 of an exemplary implementation of the ingestible product preparation system 110 of FIG. 12.

FIG. 39 is a block diagram depicting one or more exemplary electrical circuitry arrangements of the ingestible product preparation system 110 of FIG. 12.

FIG. 40 is a block diagram depicting one or more exemplary electrical circuitry arrangements of the ingestible product preparation system 110 of FIG. 12.

FIG. 41 is a block diagram depicting one or more exemplary electrical circuitry arrangements of the ingestible product preparation system 110 of FIG. 12.

FIG. 42 is a block diagram depicting one or more exemplary electrical circuitry arrangements of the ingestible product preparation system 110 of FIG. 12.

FIG. 43 is a block diagram depicting one or more exemplary electrical circuitry arrangements of the ingestible product preparation system 110 of FIG. 12.

FIG. 44 is a block diagram depicting one or more exemplary electrical circuitry arrangements of the ingestible product preparation system 110 of FIG. 12.

FIG. 45 is a block diagram depicting one or more exemplary electrical circuitry arrangements of the ingestible product preparation system 110 of FIG. 12.

FIG. 46 is a block diagram depicting one or more exemplary instructions of the information storage subsystem s200 of the ingestible product preparation system 110 of FIG. 12.

FIG. 47 is a block diagram depicting one or more exemplary instructions of the information storage subsystem s200 of the ingestible product preparation system 110 of FIG. 12.

FIG. 48 is a block diagram depicting one or more exemplary instructions of the information storage subsystem s200 of the ingestible product preparation system 110 of FIG. 12.

FIG. 49 is a block diagram depicting one or more exemplary instructions of the information storage subsystem s200 of the ingestible product preparation system 110 of FIG. 12.

FIG. 50 is a block diagram depicting one or more exemplary instructions of the information storage subsystem s200 of the ingestible product preparation system 110 of FIG. 12.

FIG. 51 is a block diagram depicting one or more exemplary instructions of the information storage subsystem s200 of the ingestible product preparation system 110 of FIG. 12.

FIG. 52 is a block diagram depicting one or more exemplary instructions of the information storage subsystem s200 of the ingestible product preparation system 110 of FIG. 12.

FIG. 53 is a block diagram depicting one or more exemplary modules of the ingestible product preparation system 110 of FIG. 12.

FIG. 54 is a block diagram depicting one or more exemplary modules of the ingestible product preparation system 110 of FIG. 12.

FIG. 55 is a block diagram depicting one or more exemplary modules of the ingestible product preparation system 110 of FIG. 21.

FIG. 56 is a block diagram depicting one or more exemplary modules of the ingestible product preparation system 110 of FIG. 12.

FIG. 57 is a block diagram depicting one or more exemplary modules of the ingestible product preparation system 110 of FIG. 12.

FIG. 58 is a block diagram depicting one or more exemplary modules of the ingestible product preparation system 110 of FIG. 12.

FIG. 59 is a block diagram depicting one or more exemplary modules of the ingestible product preparation system 110 of FIG. 12.

FIG. 60 is a high-level flowchart illustrating an operational flow p10 representing exemplary operations related to electronically receiving user status information regarding one or more particular individual living beings including one or more identifiers associated with the one or more particular individual living beings and electronically receiving selection information at least in part identifying one or more selected ingestible products being subject to ingestion by the one or more particular individual living beings, the selection information electronically received via electronically enabled input, the electronically receiving the user status information and the electronically receiving the selection information at least in part to electronically obtain treatment instructional information regarding one or more subsequent ingestible substrate structure directed energy operations for one or more portions of one or more ingestible substrate structures, and electronically directing control of at least partial treatment of the one or more portions of the one or more ingestible substrate structures according to the treatment instructional information regarding the one or more subsequent ingestible substrate structure directed energy operations including directing energy to treat at least in part the one or more portions of the one or more ingestible substrate structures to form at least in part the one or more selected ingestible products subsequent to and based at least in part upon the electronically receiving the user status information regarding the one or more particular individual living beings and the electronically receiving the selection information at least in part identifying the one or more selected ingestible products at least associated with the depicted exemplary implementations of the system.

FIG. 61 is a high-level flowchart including exemplary implementations of operation p11 of FIG. 60.

FIG. 62 is a high-level flowchart including exemplary implementations of operation p11 of FIG. 60.

FIG. 63 is a high-level flowchart including exemplary implementations of operation p11 of FIG. 60.

FIG. 64 is a high-level flowchart including exemplary implementations of operation p11 of FIG. 60.

FIG. 65 is a high-level flowchart including exemplary implementations of operation p11 of FIG. 60.

FIG. 66 is a high-level flowchart including exemplary implementations of operation p11 of FIG. 60.

FIG. 67 is a high-level flowchart including exemplary implementations of operation p11 of FIG. 60.

FIG. 68 is a high-level flowchart including exemplary implementations of operation p11 of FIG. 60.

FIG. 69 is a high-level flowchart including exemplary implementations of operation p11 of FIG. 60.

FIG. 70 is a high-level flowchart including exemplary implementations of operation p11 of FIG. 60.

FIG. 71 is a high-level flowchart including exemplary implementations of operation p11 of FIG. 60.

FIG. 72 is a high-level flowchart including exemplary implementations of operation p11 of FIG. 60.

FIG. 73 is a high-level flowchart including exemplary implementations of operation p11 of FIG. 60.

FIG. 74 is a high-level flowchart including exemplary implementations of operation p11 of FIG. 60.

FIG. 75 is a high-level flowchart including exemplary implementations of operation p11 of FIG. 60.

FIG. 76 is a high-level flowchart including exemplary implementations of operation p11 of FIG. 60.

FIG. 77 is a high-level flowchart including exemplary implementations of operation p11 of FIG. 60.

FIG. 78 is a high-level flowchart including exemplary implementations of operation p11 of FIG. 60.

FIG. 79 is a high-level flowchart including exemplary implementations of operation p11 of FIG. 60.

FIG. 80 is a high-level flowchart including exemplary implementations of operation p11 of FIG. 60.

FIG. 81 is a high-level flowchart including exemplary implementations of operation p11 of FIG. 60.

FIG. 82 is a high-level flowchart including exemplary implementations of operation p11 of FIG. 60.

FIG. 83 is a high-level flowchart including exemplary implementations of operation p11 of FIG. 60.

FIG. 84 is a high-level flowchart including exemplary implementations of operation p11 of FIG. 60.

FIG. 85 is a high-level flowchart including exemplary implementations of operation p11 of FIG. 60.

FIG. 86 is a high-level flowchart including exemplary implementations of operation p11 of FIG. 60.

FIG. 87 is a high-level flowchart including exemplary implementations of operation p11 of FIG. 60.

FIG. 88 is a high-level flowchart including exemplary implementations of operation p11 of FIG. 60.

FIG. 89 is a high-level flowchart including exemplary implementations of operation p11 of FIG. 60.

FIG. 90 is a high-level flowchart including exemplary implementations of operation p11 of FIG. 60.

FIG. 91 is a high-level flowchart including exemplary implementations of operation p11 of FIG. 60.

FIG. 92 is a high-level flowchart including exemplary implementations of operation p12 of FIG. 60.

FIG. 93 is a high-level flowchart including exemplary implementations of operation p12 of FIG. 60.

FIG. 94 is a high-level flowchart including exemplary implementations of operation p12 of FIG. 60.

FIG. 95 is a high-level flowchart including exemplary implementations of operation p12 of FIG. 60.

FIG. 96 is a high-level flowchart including exemplary implementations of operation p12 of FIG. 60.

FIG. 97 is a high-level flowchart including exemplary implementations of operation p12 of FIG. 60.

FIG. 98 is a high-level flowchart including exemplary implementations of operation p12 of FIG. 60.

FIG. 99 is a high-level flowchart including exemplary implementations of operation p12 of FIG. 60.

FIG. 100 is a high-level flowchart including exemplary implementations of operation p12 of FIG. 60.

FIG. 101 is a high-level flowchart including exemplary implementations of operation p12 of FIG. 60.

FIG. 102 is a block diagram depicting one or more exemplary electrical circuitry arrangements of the ingestible product preparation system 10 of FIG. 1.

FIG. 103 is a block diagram depicting one or more exemplary electrical circuitry arrangements of the ingestible product preparation system 10 of FIG. 1.

FIG. 104 is a block diagram depicting one or more exemplary electrical circuitry arrangements of the ingestible product preparation system 10 of FIG. 1.

FIG. 105 is a block diagram depicting one or more exemplary electrical circuitry arrangements of the ingestible product preparation system 10 of FIG. 1.

FIG. 106 is a block diagram depicting one or more exemplary electrical circuitry arrangements of the ingestible product preparation system 10 of FIG. 1.

FIG. 107 is a block diagram depicting one or more exemplary electrical circuitry arrangements of the ingestible product preparation system 10 of FIG. 1.

FIG. 108 is a block diagram depicting one or more exemplary electrical circuitry arrangements of the ingestible product preparation system 10 of FIG. 1.

FIG. 109 is a block diagram depicting one or more exemplary electrical circuitry arrangements of the ingestible product preparation system 10 of FIG. 1.

FIG. 110 is a block diagram depicting one or more exemplary electrical circuitry arrangements of the ingestible product preparation system 10 of FIG. 1.

FIG. 111 is a block diagram depicting one or more exemplary instructions of the information storage subsystem s200 of the ingestible product preparation system 10 of FIG. 1.

FIG. 112 is a block diagram depicting one or more exemplary instructions of the information storage subsystem s200 of the ingestible product preparation system 10 of FIG. 1.

FIG. 113 is a block diagram depicting one or more exemplary instructions of the information storage subsystem s200 of the ingestible product preparation system 10 of FIG. 1.

FIG. 114 is a block diagram depicting one or more exemplary instructions of the information storage subsystem s200 of the ingestible product preparation system 10 of FIG. 1.

FIG. 115 is a block diagram depicting one or more exemplary instructions of the information storage subsystem s200 of the ingestible product preparation system 10 of FIG. 1.

FIG. 116 is a block diagram depicting one or more exemplary instructions of the information storage subsystem s200 of the ingestible product preparation system 10 of FIG. 1.

FIG. 117 is a block diagram depicting one or more exemplary instructions of the information storage subsystem s200 of the ingestible product preparation system 10 of FIG. 1.

FIG. 118 is a block diagram depicting one or more exemplary instructions of the information storage subsystem s200 of the ingestible product preparation system 10 of FIG. 1.

FIG. 119 is a block diagram depicting one or more exemplary instructions of the information storage subsystem s200 of the ingestible product preparation system 10 of FIG. 1.

FIG. 120 is a high-level flowchart illustrating an operational flow ol0 representing exemplary operations related to electronically receiving user status information regarding a particular individual living being including living being identification associated with the particular individual living being and electronically receiving selection information of one or more selected ingestible products via electronically enabled input in response to electronically outputted one or more selection menus prior to dispensing of the one or more selected ingestible products for ingestion by the particular individual living being to electronically direct control of at least partial preparation of the one or more selected ingestible products subsequent to and based at least in part upon the selection of the one or more selected ingestible products via the electronically enabled input in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus, and electronically directing control at least in part of acquisition of refuse intelligence including information related to one or more discarded portions of at least one of the one or more selected ingestible products discarded by the particular individual subsequent to ingestion by the particular individual living being of one or more other ingested portions of the at least one of the one or more selected ingestible products within a second vicinity of the electronically outputting of the electronically generated one or more selection menus at least associated with the depicted exemplary implementations of the system.

FIG. 121 is a high-level flowchart including exemplary implementations of operation o11 of FIG. 120.

FIG. 122 is a high-level flowchart including exemplary implementations of operation o11 of FIG. 120.

FIG. 123 is a high-level flowchart including exemplary implementations of operation o11 of FIG. 120.

FIG. 124 is a high-level flowchart including exemplary implementations of operation o11 of FIG. 120.

FIG. 125 is a high-level flowchart including exemplary implementations of operation o11 of FIG. 120.

FIG. 126 is a high-level flowchart including exemplary implementations of operation o11 of FIG. 120.

FIG. 127 is a high-level flowchart including exemplary implementations of operation o11 of FIG. 120.

FIG. 128 is a high-level flowchart including exemplary implementations of operation o11 of FIG. 120.

FIG. 129 is a high-level flowchart including exemplary implementations of operation o11 of FIG. 120.

FIG. 130 is a high-level flowchart including exemplary implementations of operation o11 of FIG. 120.

FIG. 131 is a high-level flowchart including exemplary implementations of operation o11 of FIG. 120.

FIG. 132 is a high-level flowchart including exemplary implementations of operation o11 of FIG. 120.

FIG. 133 is a high-level flowchart including exemplary implementations of operation o11 of FIG. 120.

FIG. 134 is a high-level flowchart including exemplary implementations of operation o11 of FIG. 120.

FIG. 135 is a high-level flowchart including exemplary implementations of operation o11 of FIG. 120.

FIG. 136 is a high-level flowchart including exemplary implementations of operation o11 of FIG. 120.

FIG. 137 is a high-level flowchart including exemplary implementations of operation o11 of FIG. 120.

FIG. 138 is a high-level flowchart including exemplary implementations of operation o11 of FIG. 120.

FIG. 139 is a high-level flowchart including exemplary implementations of operation o11 of FIG. 120.

FIG. 140 is a high-level flowchart including exemplary implementations of operation o11 of FIG. 120.

FIG. 141 is a high-level flowchart including exemplary implementations of operation o11 of FIG. 120.

FIG. 142 is a high-level flowchart including exemplary implementations of operation o11 of FIG. 120.

FIG. 143 is a high-level flowchart including exemplary implementations of operation o11 of FIG. 120.

FIG. 144 is a high-level flowchart including exemplary implementations of operation o11 of FIG. 120.

FIG. 145 is a high-level flowchart including exemplary implementations of operation o11 of FIG. 120.

FIG. 146 is a high-level flowchart including exemplary implementations of operation o11 of FIG. 120.

FIG. 147 is a high-level flowchart including exemplary implementations of operation o11 of FIG. 120.

FIG. 148 is a high-level flowchart including exemplary implementations of operation o11 of FIG. 120.

FIG. 149 is a high-level flowchart including exemplary implementations of operation o11 of FIG. 120.

FIG. 150 is a high-level flowchart including exemplary implementations of operation o11 of FIG. 120.

FIG. 151 is a high-level flowchart including exemplary implementations of operation o11 of FIG. 120.

FIG. 152 is a high-level flowchart including exemplary implementations of operation o11 of FIG. 120.

FIG. 153 is a high-level flowchart including exemplary implementations of operation o11 of FIG. 120.

FIG. 154 is a high-level flowchart including exemplary implementations of operation o11 of FIG. 120.

FIG. 155 is a high-level flowchart including exemplary implementations of operation o11 of FIG. 120.

FIG. 156 is a high-level flowchart including exemplary implementations of operation O12 of FIG. 120.

FIG. 157 is a high-level flowchart including exemplary implementations of operation O12 of FIG. 120.

FIG. 158 is a high-level flowchart including exemplary implementations of operation O12 of FIG. 120.

FIG. 159 is a high-level flowchart including exemplary implementations of operation O12 of FIG. 120.

FIG. 160 is a high-level flowchart including exemplary implementations of operation O12 of FIG. 120.

FIG. 161 is a high-level flowchart including exemplary implementations of operation O12 of FIG. 120.

FIG. 162 is a high-level flowchart including exemplary implementations of operation O12 of FIG. 120.

FIG. 163 is a high-level flowchart including exemplary implementations of operation O12 of FIG. 120.

FIG. 164 is a high-level flowchart including exemplary implementations of operation O12 of FIG. 120.

FIG. 165 is a high-level flowchart including exemplary implementations of operation O12 of FIG. 120.

FIG. 166 is a high-level flowchart including exemplary implementations of operation O12 of FIG. 120.

FIG. 167 is a high-level flowchart including exemplary implementations of operation O12 of FIG. 120.

FIG. 168 is a high-level flowchart including exemplary implementations of operation O12 of FIG. 120.

FIG. 169 is a high-level flowchart including exemplary implementations of operation O12 of FIG. 120.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Generally, automated and semi-automated machines to make, manufacture, fabricate, or otherwise prepare and/or dispense ingestible products to be ingested by living beings such as humans, animals, plants, etc are known to a degree with interest existing for future development as well. Automated and semi-automated preparation of the ingestible products can incorporate all known forms of preparation of food and other ingestible products including but not limited to all known forms of energy addition to one or more ingredients of the ingestible products (such as through various forms of thermal heating or adding microwave, infrared, or ultrasonic energy), extracting energy from one or more ingredients of the ingestible products (such as through thermodynamic-cycle based cooling or peltier cooling), deposition methods (including deposition by layering or at the pixel level), and combinational methods (such as blending, mixing, ingredient injection, kneading, stirring, ultrasonic agitation, other agitational methods, etc.), etc.

Although ingestible products made, fabricated, or otherwise prepared and/or dispensed by semi-automated and automated machines are presently limited in scope to a degree, it is envisioned that with future development, this will change. Ingestible products can take many forms including, but not limited to, solids, semi-solids, liquids, gases, dispersions (such as true solutions, colloid dispersions, emulsions, foams, and gels) and vast combinations thereof. Ingestion by the living beings can occur through many pathways including, but not limited to, oral ingestion, transdermal ingestion, peg-tube ingestion, nasal ingestion, anal ingestion, injectable ingestion, tear-duct ingestion, and respiratory ingestion.

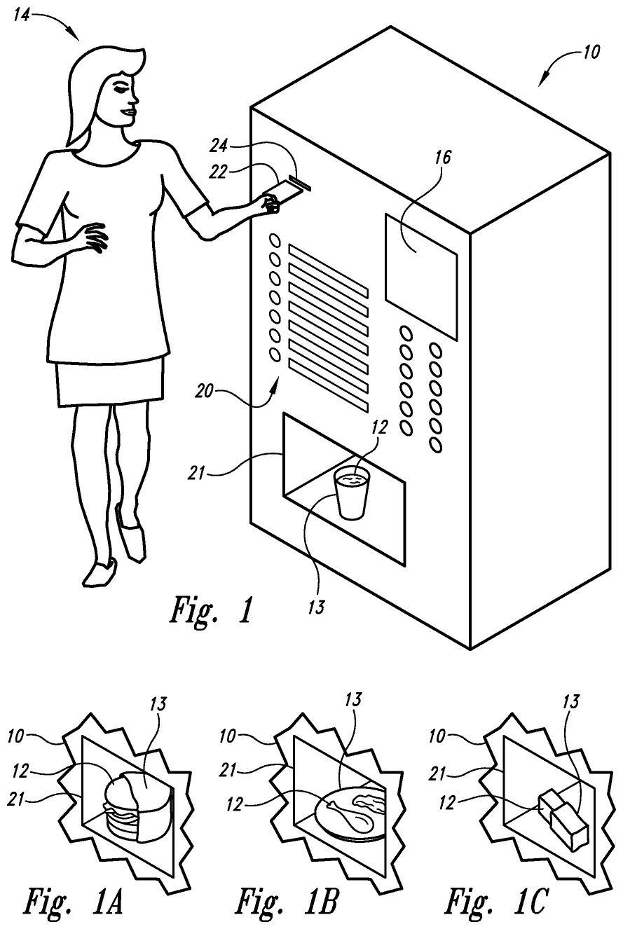

As depicted in FIGS. 1-3, exemplary implementations of an ingestible product preparation system 10 are shown to prepare and dispense ingestible products such as a liquid drink 12 (shown in dispensing area 21) to be consumed by a particular individual living being, such as a human being 14 (such as a user, etc.) shown. Exemplary implementations determine selection menus to be generated and outputted, for instance, on display 16 and selections or other information can be inputted through user interfaces, for instance, user input 20 or other types of user input. For instance, input may be collected through active user input (e.g. keyboard, textual, audio, graphical user interface, etc.) or passive user input (e.g. image recognition of user behavior, refuse analysis of past dispensing such as quantity of wrappers, leftovers, audio analysis of collected unsolicited user comments, etc.). Selection menus can be generated that are unique to a particular individual living being, such as the human being 14, based upon such information as but not limited to identification of the individual and other information such as past selections, allergies, preferences, specials, holidays, location of preparation, location of dispensing, time of day, dislikes, recent ingestion, health goals, present illness, past illness, sports requirements, injuries, fads, hobbies, associated social organizations, etc. Other sorts of ingestible products can include but are not limited to sandwiches (FIG. 1A), full meals (FIG. 1B), food bars (FIG. 1C), meal replacements, snacks, plant and/or animal based products, nutraceuticals, pharmaceuticals, smoothies, etc.

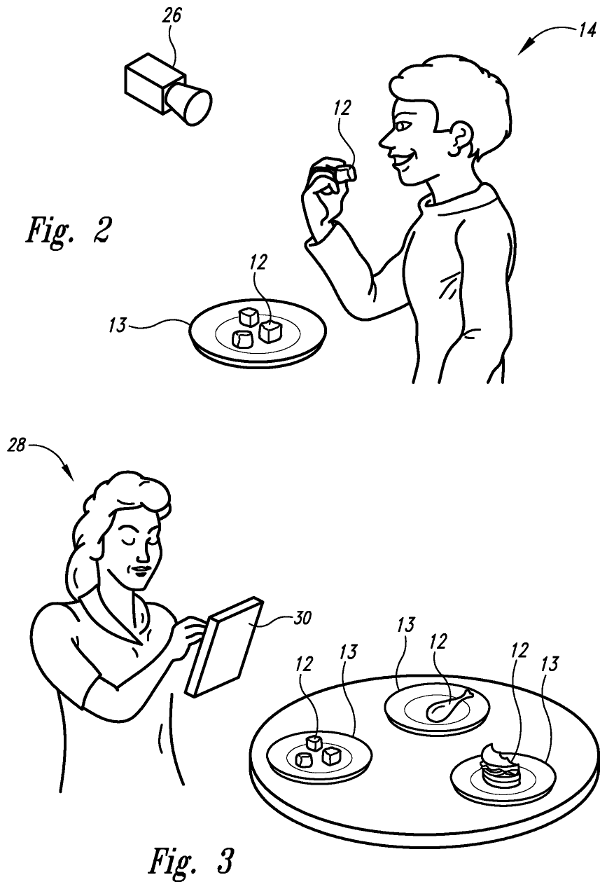

FIG. 2 is a schematic diagram depicting a first implementation of refuse intelligence acquisition associated with the ingestible product preparation system 10 in which camera 26 is used to collect video, photographic, or a combination thereof regarding discard activities of portions of ingestible product 12 and/or packaging 13 (such as paper plate) by user 14.

FIG. 3 is a schematic diagram depicting a second implementation of refuse intelligence acquisition associated with the ingestible product preparation system 10 in which electronic entry pad 30 (such as a handheld computer) is used by wait staff to input information regarding refuse left by restaurant customers.

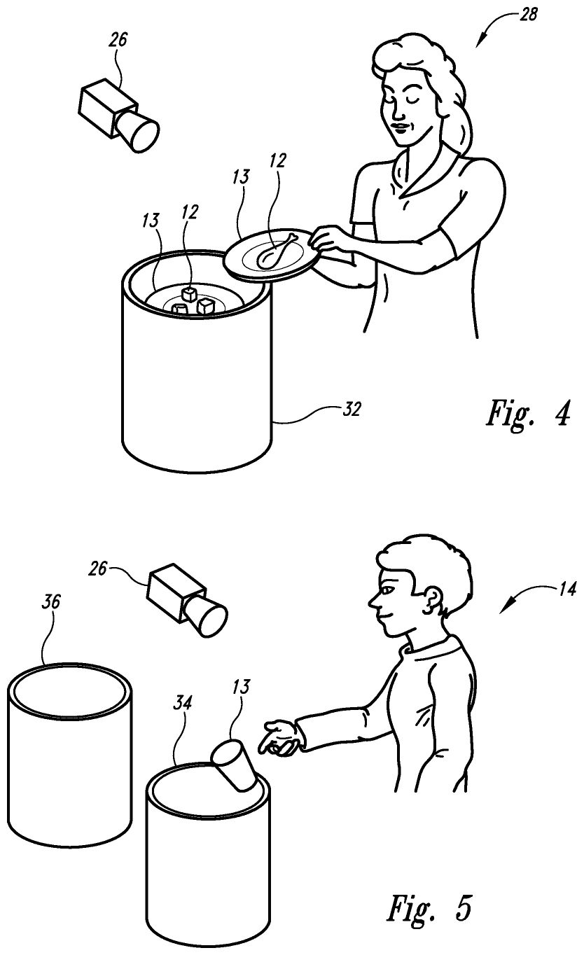

FIG. 4 is a schematic view depicting a third implementation of refuse intelligence acquisition related to the ingestible product preparation system 10 in which sensor equipped receptacle 32 receives refuse such as dispose of by wait staff 28 and as recorded through camera 26.

FIG. 5 is a schematic view depicting a fourth implementation of refuse intelligence acquisition related to the ingestible product preparation system 10 in which user 14 disposes of refuse (in form of packaging 14) into one of “like” receptacle 34 thereby indicating a favorable disposition toward a prior consumed ingestible product or into one of “dislike” receptacle 36 thereby indicating a disfavorable disposition toward the prior consumed ingestible product as recorded through use of camera 26 and/or sensors embedded in the receptacles.

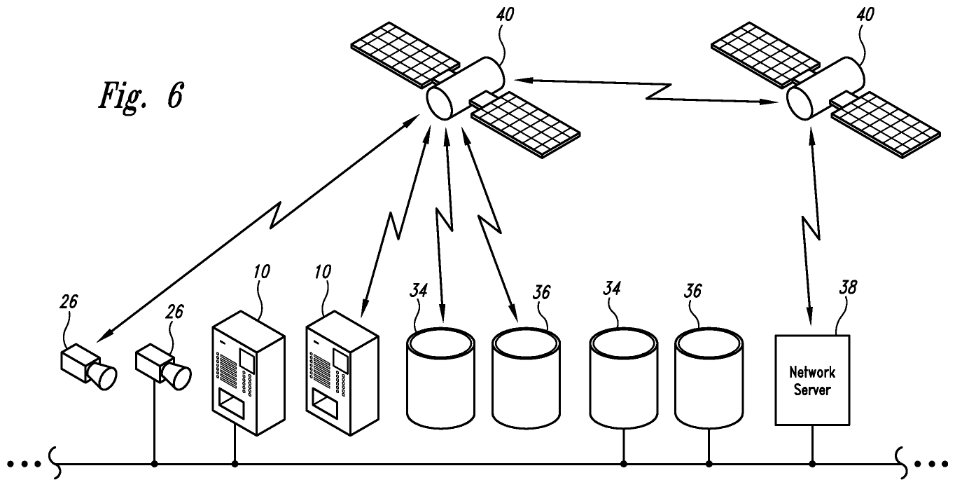

FIG. 6 is a schematic diagram depicting a network implementation of refuse intelligence acquisition related to the ingestible product preparation system including networked camera 26, receptacle 34, receptacle 36, server 38, and satellite 40.

FIG. 7 is a schematic view depicting a fifth implementation of refuse intelligence acquisition related to the ingestible product preparation system 10 including RFID tag 42 affixed to packaging 13 (in implementations RFID tag can also be affixed to one or more portions of ingestible product 12) to be read by RFID reader 44 affixed to receptacles such as receptacle 34 and receptacle 36.

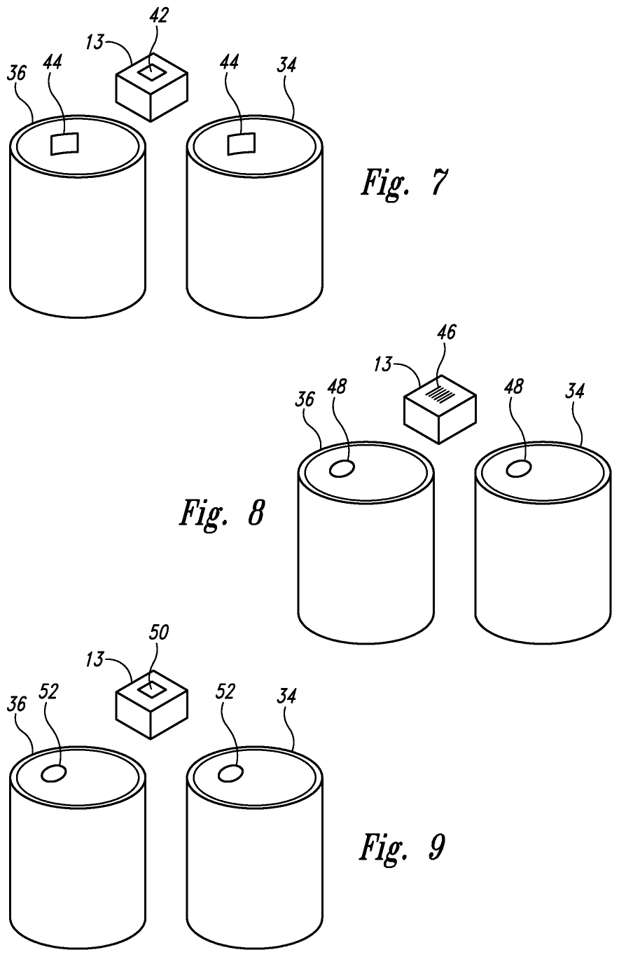

FIG. 8 is a schematic view depicting a sixth implementation of refuse intelligence acquisition related to the ingestible product preparation system 10 including barcode 46 affixed to packaging 13 to be read by bar code reader 48 affixed to receptacles such as receptacle 34 and receptacle 36.

FIG. 9 is a schematic view depicting a seventh implementation of refuse intelligence acquisition related to the ingestible product preparation system 10 including color code 50 affixed to packaging 13 (color coding may also be affixed to portions of ingestible product 12) to be read by color code reader 52 affixed to receptacles such as receptacle 34 and receptacle 36.

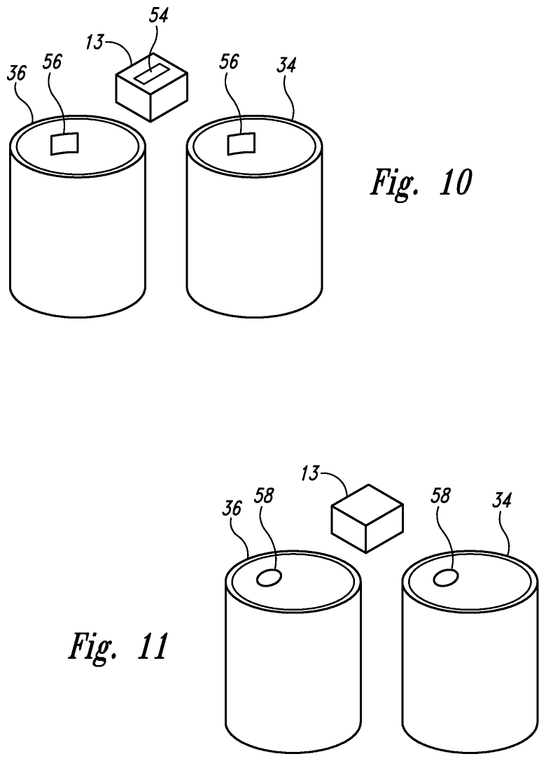

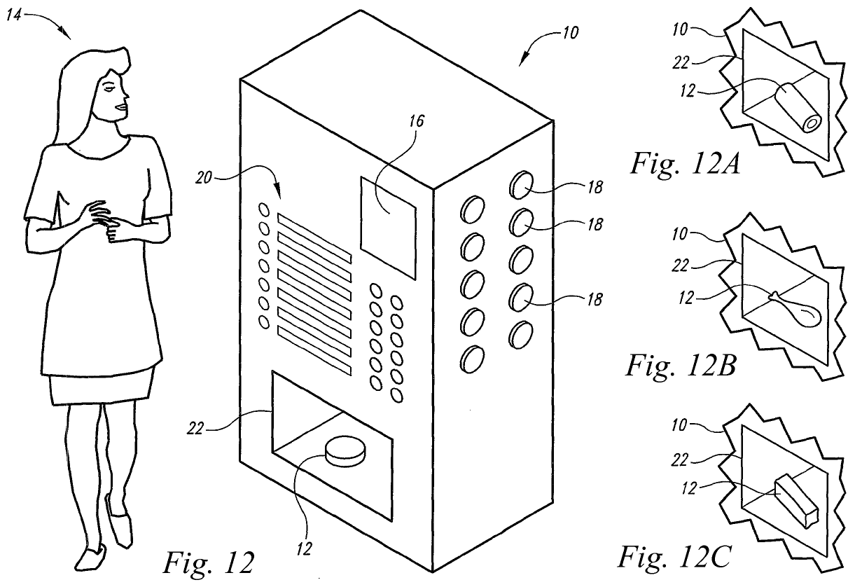

FIG. 10 is a schematic view depicting a eighth implementation of refuse intelligence acquisition related to the ingestible product preparation system 10 including magnetic strip 54 affixed to packaging 13 to be read by magnetic strip reader 56 affixed to receptacles such as receptacle 34 and receptacle 36.

FIG. 11 is a schematic view depicting a ninth implementation of refuse intelligence acquisition related to the ingestible product preparation system 10 including chemical sniffer 58 affixed to receptacles including receptacle 34 and receptacle 36 to acquire chemical based identifiers indicating one or more constituents of discarded portions of ingestible product 12.

As depicted in FIGS. 12-14, exemplary implementations of an ingestible product preparation system 110 are shown to prepare and dispense ingestible products 112 such as a liquid drink, hamburger, chicken dinner, or a snack bar (shown in dispensing area 122) to be consumed by a particular individual living being, such as a human being 114 (such as a user, etc.) shown. Exemplary implementations determine selection menus to be generated and outputted, for instance, on display 116 and selections or other information can be inputted through user interfaces, for instance, user input 120 or other types of user input.

For instance, input may be collected through active user input (e.g. keyboard, textual, audio, graphical user interface, etc.) or passive user input (e.g. image recognition of user behavior, refuse analysis of past dispensing such as quantity of wrappers, leftovers, audio analysis of collected unsolicited user comments, etc.). Selection menus can be generated that are unique to a particular individual living being, such as the human being 114, based upon such information as but not limited to identification of the individual and other information such as past selections, allergies, preferences, specials, holidays, location of preparation, location of dispensing, time of day, dislikes, recent ingestion, health goals, present illness, past illness, sports requirements, injuries, fads, hobbies, associated social organizations, etc. As further described these selection menus and other selection aspects can be influenced, guided, directed, or otherwise associated with factors that influence availability of ingredients used to prepare the ingestible products.

Other sorts of ingestible products can include but are not limited to sandwiches (FIG. 12A), full meals (FIG. 12B), food bars (FIG. 12C), meal replacements, snacks, plant and/or animal based products, nutraceuticals, pharmaceuticals, smoothies, etc. Just as the selection menus can be influenced by input from computer based social network services, the selection menus can also provide options for reporting to various computer based social networking services regarding use of the ingestible products including associates venues, parties, types of products involved, etc.

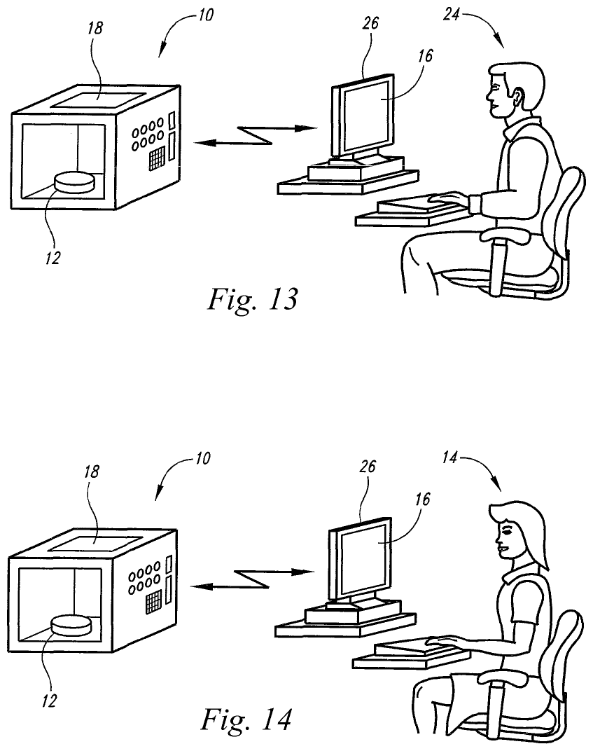

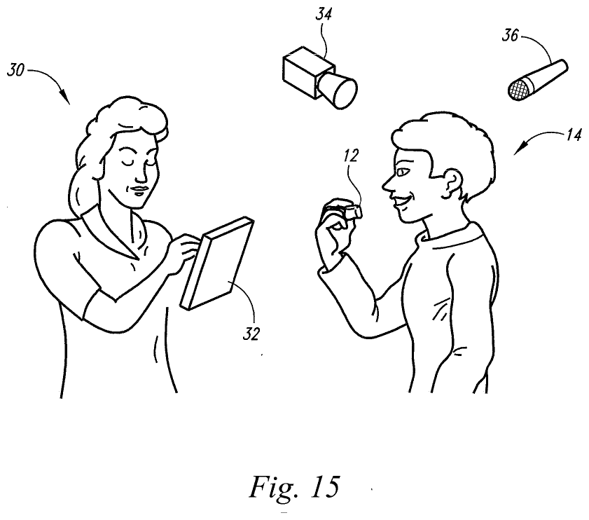

The ingestible product preparation system 110 and possibly smaller more portable versions such as unit 118 is further depicted in FIGS. 13 and 14 as communicating with the human being 114 an exemplary remotely located user or an exemplary advisor 124 (e.g. physician, nurse, nutritionist, health expert, sports coach, etc.) via a communication link (e.g. wireless or wired network or direct electronic communication, etc.) and display screen 116. The display screen 116 can include selection indicators configured to provide information described above by the users and advisors.

Selection menus can be furnished to suggest candidate ingestible products that once selected as selected ingestible products can be prepared and dispensed (in some implementations prepared such as from ingredient containers) and to provide other sorts of information discussed herein. The display screen 116 can display textual and graphic information such as including but not limited to menu screens allowing users to select various dispensing (including in some implementations preparation) options and information requests. Other implementations can include other devices and methods for information input and output including those further discussed below.

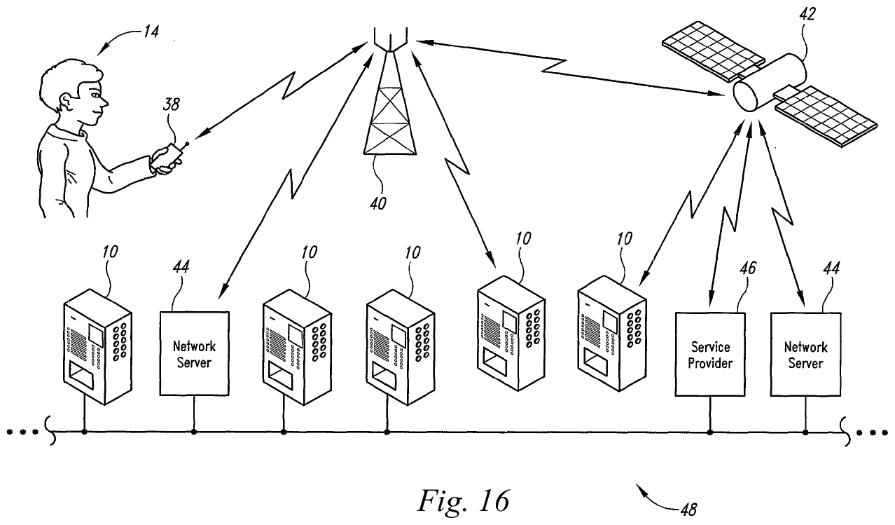

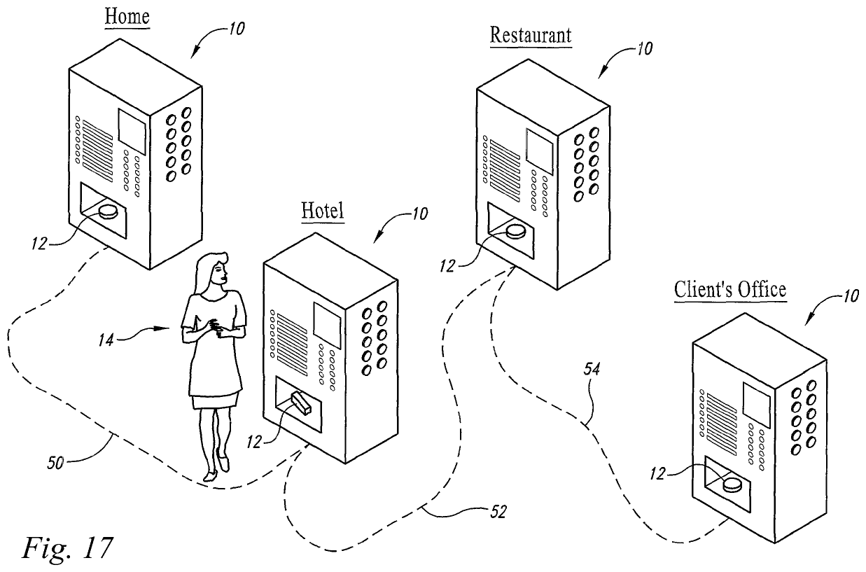

FIG. 15 is a perspective view depicting another location for placement of the ingestible product preparation system with the location including a wait staff 130, taking an order through input device 132 and having sensing devices such as camera 134 and microphone 136. FIG. 16 shows a schematic view of an exemplary communication network incorporating the ingestible product preparation system of FIG. 12 along with mobile device 138, base station 140, satellite 142, network server 144, and service provider 146. FIG. 17 is a perspective view depicting various locations for placement of the ingestible product preparation system of FIG. 12 along paths 150, 152, and 154.

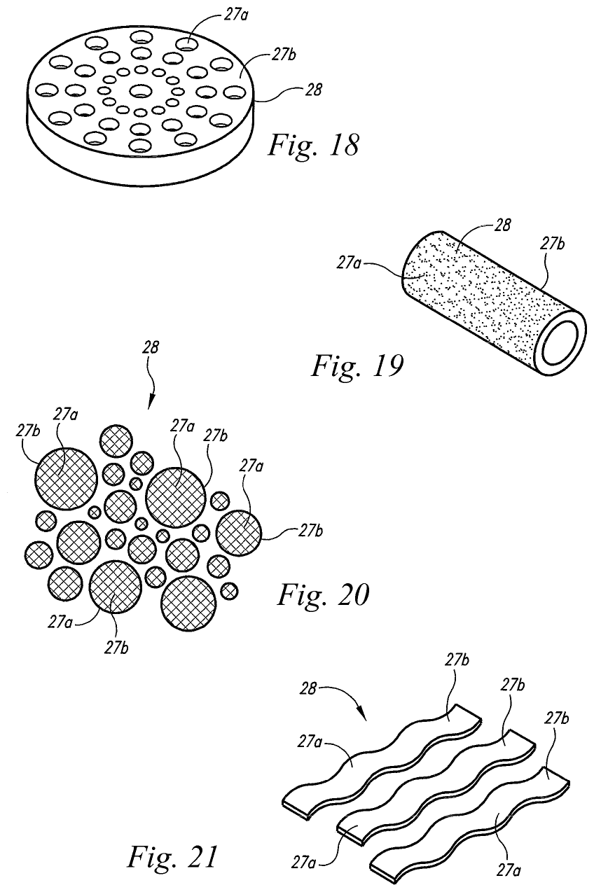

FIG. 18 is a perspective view of an exemplary implementation of an ingestible substrate structure 128 to be treated by one or more versions of the ingestible product preparation system. The ingestible substrate structure 128 is shown having an internal structural texture 127a and a surface texture 127b.

FIG. 19 is a perspective view of a second exemplary ingestible substrate structure 128. FIG. 20 is a perspective view of a third exemplary ingestible substrate structure 128. FIG. 21 is a perspective view of a fourth ingestible substrate structure 128.

The following exemplary assemblies of ingestible parts are for illustrative purposes so are not intended to be an exhaustive listing of what can be involved with various shapes, configurations, uses, or other characterization associated with the ingestible parts and their assemblies, which can include such factors as densities, void and other patterns, material selections, embedded encapsulations, structural textures, colors, olfactory properties, surface textures, oral sensations, shapes, sounds, psycho-sensory aspects, and/or etc.

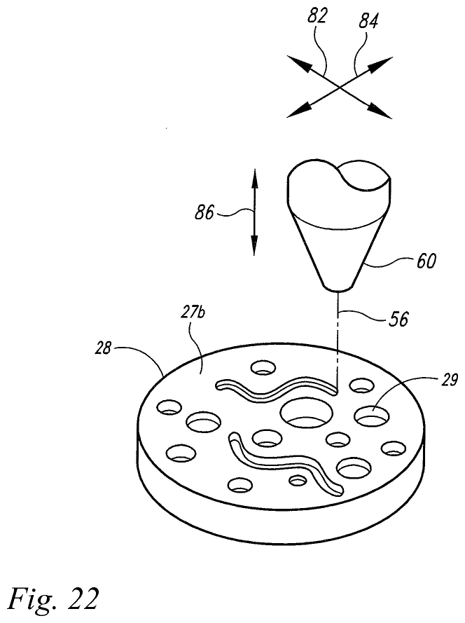

FIG. 22 is a perspective view of a first exemplary directed energy treatment assembly having movable energy emitter 160 directing energy in the form of a focused energy beam 156 onto the surface 127b of the substrate 128 to form treated portions 129 as configured for the ingestible product preparation system. The energy beam 156 can be one of laser, microwave, acoustic, radiant, electromagnetic, or other energy type.

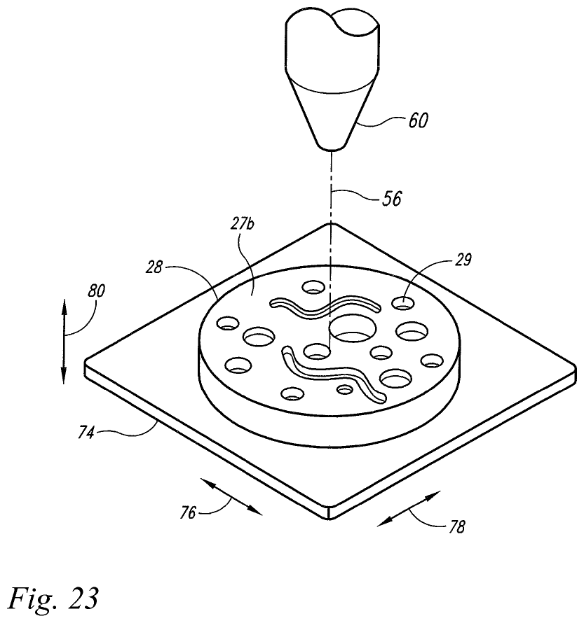

FIG. 23 is a perspective view of a second exemplary directed energy treatment assembly having movable platform 174 and a stationary energy emitter 160 directing energy in the form of the focused energy beam 156 onto the surface 127b of the substrate 128 to form treated portions 129 as configured for the ingestible product preparation system. The energy beam 156 can be one of laser, microwave, acoustic, radiant, electromagnetic, or other energy type.

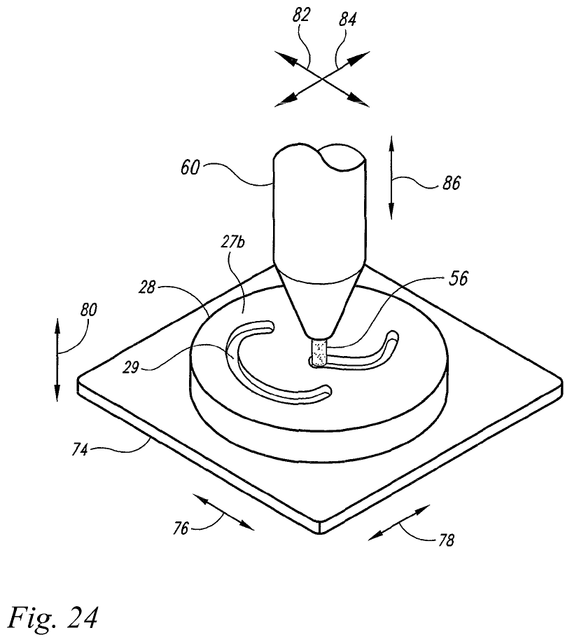

FIG. 24 is a perspective view of a third exemplary directed energy treatment assembly having the movable platform 174 and the movable energy emitter 160 directing energy in the form of a less focused energy beam 156 onto the surface 127b of the substrate 128 to form treated portions 129 as configured for the ingestible product preparation system. The energy beam 156 can be one of laser, microwave, acoustic, radiant, electromagnetic, or other energy type.

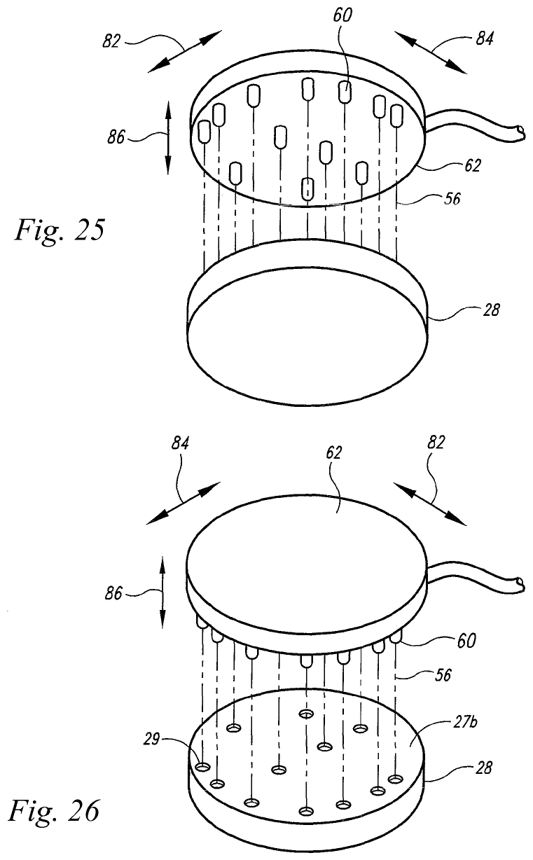

FIGS. 25 and 26 are perspective views of a fourth exemplary directed energy treatment assembly having a movable energy emitter array 162 directing energy in the form of patterned multiple energy beams 156 onto the surface 127b of the substrate 128 to form treated portions 129 as configured for the ingestible product preparation system. The patterned multiple energy beams 156 can be one of laser, microwave, acoustic, radiant, electromagnetic, or other energy type.

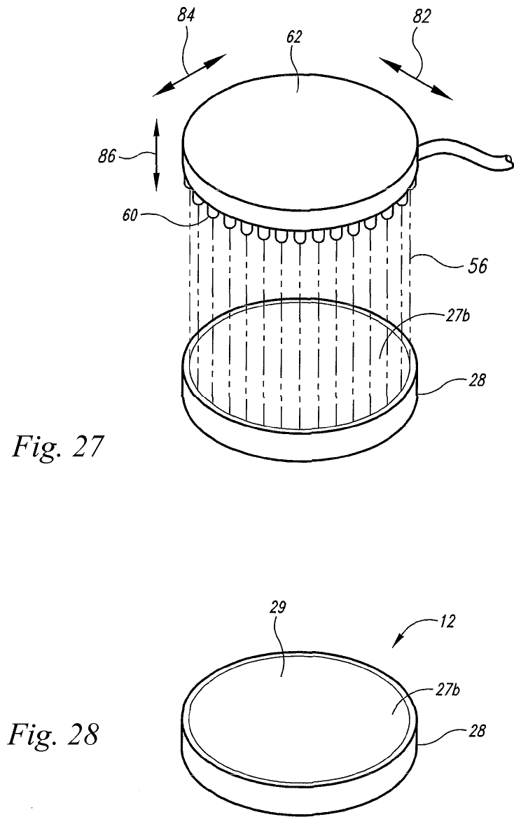

FIG. 27 is a perspective view of a fifth exemplary directed energy treatment assembly having a movable energy emitter array 162 directing energy in the form of multiple energy beams 156 onto the surface 127b of the substrate 128 to form treated portions 129 as configured for the ingestible product preparation system. The patterned multiple energy beams 156 can be one of laser, microwave, acoustic, radiant, electromagnetic, or other energy type. FIG. 28 shows the substrate 128 having been treated over a continuous region of the substrate.

One or more of the ingestible substrate structures 128 can be comprised from a wide variety of various ingestible materials. Some of these ingestible materials can include, but are not limited, one or more of the following:

Soy-based ingestible materials: such as for example textured vegetable protein (TVP), soy meat, tofu, tempeh or other ingestible materials through culturing and controlled fermentation processes, etc.

Corn-based ingestible materials: such as for example cornbread, unleavened; cornmeal, oil, water, salt: (combine and cook); corn tortilla masa harina (cornmeal treated with calcium hydroxide), water: (combine and cook), etc.

Rice-based ingestible materials: such as for example rice cake—rice (cooked), rice flour, water, sugar, salt: (combine and cook); rice cracker—rice, water, salt: (combine and cook) and/or—spread thin and cook rice again until crispy, etc.

Wheat-based ingestible materials such as for example wheat bread—unleavened, wheat flour, oil, water: (combine and cook); wheat cracker—wheat flour, salt, butter, baking soda, water: (combine and cook), etc.

Potato-based ingestible materials such as for example potato cake—potato (cooked), egg, salt: (combine and cook); potato cracker—potato (cooked), wheat flour, oats, oil: (combine and cook), etc.

Cassava-based ingestible materials such as for example cassava cake—cassava, milk, coconut cream, sugar, egg, egg white: (combine and cook), etc.

Sweet potato-based ingestible materials such as for example sweet potato bread—sweet potato (cooked), egg, oil, wheat flour, sugar, salt, baking soda, baking powder (combine and cook); sweet potato chip—potato, oil: (combine and cook), etc.

Sorghum-based ingestible materials such as for example sorghum cookie—sorghum, oil, sugar, baking soda, wheat flour, egg: (combine and cook); sorghum cake—sorghum, butter, cinnamon, wheat flour, vanilla, egg, baking soda, baking powder, salt, buttermilk: (combine and cook)—sorghum, butter, cinnamon, wheat flour, vanilla, egg, baking soda, baking powder, salt, buttermilk: (combine and cook), etc.

Yam-based ingestible materials such as for example yam cracker—yam (cooked), wheat flour, oats, oil (combine and cook); yam custard—yam (cooked), banana, milk, sugar, egg yolk, vanilla (combine and cook), etc.

Plantain-based ingestible materials such as for example plantain chip—plantain, oil, salt (combine and cook); plantain candied—plantain, butter, maple syrup, cinnamon (combine and cook), etc.

Legume-based ingestible materials such as for example adzuki, anasazi, black, black-eyed peas (cowpeas), broad, carob, chickpeas (garbanzo), edamame, fava, green, lentils, lima, lupins, mesquite, mung, navy, peanuts, peas, pinto, red kidney, soy, white, etc.

Grain-based ingestible materials such as for example amaranth, barley, buckwheat, durum, einkorn, emmer, fice, flax, fonio, kamut, kaniwa, maize, millet, oats, quinoa, rye, sorghum, spelt, teff, triticale, wild rice, wheat, etc.

Animal-based ingestible materials such as for example egg, meringue (whipped/foamed egg white), baked to hardened texture, yolk or white, etc.

Meat-based ingestible materials such as for example dehydrated (jerky), cured, cheese, hard, dry, creamed, string, melted, etc.

Other matter-based ingestible materials such as for example gelatin, pudding—custard, pureed fruit or vegetables, dehydrated and formed to shape, beverage—smoothie, etc.

Thinner-based ingestible materials such as for example oil, water, vinegar, etc.

Thickener-based ingestible materials such as for example starches, corn, arrowroot, kudzu, potato, rice, tapioca, wheat, etc.

Hydrocolloid-based ingestible materials such as for example agar, kappa carrageenan, lambda carrageenan, iota carrageenan, gelatin, high-acyl gellan, low-acyl gellan, guar gum, gum arabic, gum tragacanth, high methyl ester pectin, low methyl ester pectin, konjac gum, lucust bean gum, methylcellulose, hydroxypropyl methylcellulose, carboxy methylcellulose, microcrystalline cellulose, propylene glycol alginate, sodium alginate, xanthan gum, etc.

Surfactant emulsifier-based ingestible materials such as for example monoglyceride, diglyceride, sorbitan ester, polysorbate, propylene glycol esters, polyglycerol esters, phospholipids, gum arabic, etc.

Sugar-based ingestible materials such as for example monosaccharides, glucose (dextrose), fructose, galactose, disaccharides, sucrose, maltose, lactose, etc., sugar-based ingestible materials (common source) such as for example honey, sugar cane, sugar beet, etc. sweetener-based ingestible materials (natural) such as for example brazzein, curculin, erythritol, glycyrrhizin, glycerol, hydrogenated starch hydrolysates, inulin, isomalt, lactitol, luo han guo, mabinlin, maltitol, malto-oligosaccharide, mannitol, miraculin, monatin, monellin, osladin, pentadin, sorbitol, stevia, tagatose, thaumatin, xylitol, etc. sweetener-based ingestible materials (artificial) such as for example acesulfame potassium, aspartame, salt of aspartame-acesulfame, glucin, neohesperidin dihydrochalcone, neotame, saccharin, sucralose, etc.

Fat-based ingestible materials (plant) such as for example almond, avocado, beechnut, castor, cocoa butter, coconut, corn, cottonseed, grape seed, hazelnut, linseed, mustard, olive, palm, palm kernel, peanut, poppy seed, pumpkin seed, rapeseed, rice bran, safflower, soybean, sesame seed, sunflower seed, tea seed, walnut, etc. Fat-based ingestible materials (animal) such as for example milk, cow, milk, goat, chicken, cod liver, cow, egg yolk, fish, lard, pig, etc. Fat-based ingestible materials (forms) such as for example oil, milk, butter, lard, schmaltz, dripping, etc.

Binder-based ingestible materials (texture, forming, manipulation) such as for example egg albumen, semolina, rice gel, vital wheat gluten, saccharides, disaccharides, sucrose, lactose, polysaccharides, starches, cellulose, microcrystaline cellulose, cellulose esthers, hydroxypropyl, cellulose, sugar alcohols, xylitol, sorbitol, maltitol, protein, gelatin, synthetic, polymers, polyvinylpyrrolidone, polyethylene glycol, etc.

Coating-based ingestible materials such as those that generally, protect from deterioration by: moisture, light, air, other substances such as for example hydroxypropyl methylcellulose film coating, shellac, corn protein zein, gelatin, etc.

Disintegrant-based ingestible materials such as those that generally expand and dissolve when wet, causing material to break apart such as for example sodium starch glycolate, crosslinked polymers, crospovidone, croscamellose sodium, etc.

Filler-based ingestible materials such as those that generally increase volume of material for particular handling needs such as for example plant cellulose, dibasic calcium phosphate, fats and oils, lactose, sucrose, glucose, mannitol, sorbitol, calcium carbonate, magnesium stearate, etc.

Lubricant-based ingestible materials such as those that generally prevent ingredients from sticking together and from sticking to delivery devices such as for example talc, silica, fats and oils, stearin, magnesium stearate, stearic acid, etc.

Glidant-based ingestible materials such as those that generally are used to promote material flow by reducing interparticle friction and cohesion such as for example fumed silica, talc, magnesium carbonate, magnesium stearate, etc.

Sorbent-based ingestible materials such as those that generally are used for material-proofing by limiting fluid sorbing (fluid moving both directions, in or out of material) in a dry state.

Preservative-based ingestible materials such as for example antioxidants, vitamin A, vitamin E, vitamin C, retinyl palmitate, selenium, amino acids, cysteine, methionine, citric acid, sodium citrate, parabens, methyl paraben, propyl paraben, etc.

The one or more substrate structures 128 can be fabricated or otherwise made prior to final treatment at point of sale or otherwise prior to final treatment by a wide variety of methods such as, but not limited to one or more of the following exemplary processes such as for example heat processed, steamed, baked, boiled, cooked, heated, fried, grilled, radiated (microwave), roasted, pressure cooked, smoked, toasted, tempered, raw (untreated, unprocessed, uncooked), cooled, chilled, frozen, thawed, fluid, hydrated, reconstituted, solid, dehydrated, cured, evaporated, dried, salted, melted, thinned, fermented, preserved, heating, cooking, boiling, oxidation, use of sulfur dioxide, ozonation, use of ozone gas, or ozonated water, toxic inhibition, smoking, use of carbon dioxide, vinegar, alcohol, dehydration, osmotic inhibition, use of syrups, low temperature inactivation, freezing, ultra high water pressure, “cold” pasteurization, pickled, vinegar, pasteurized, ultra-pasteurization, uht (ultra high temperature) treated:, sterilization by heating for 1-2 seconds at temperatures exceeding 135 c (275 f), washed, cleansed/cleaned, sterilized, bleached, irradiated, deionized, ionized, thickened, gelled, crystallized, agglomerated, condensed, concentrated, hydrogenated, extended/expanded, stretched, reduced, hydrolyzed, rendered, refined, semi-refined, mixed, blended, emulsified, homogenized, mechanically processed, filtered, centrifuged, chopped, granulated, ground, grated, kneaded, minced, diced, squeezed, pureed, powdered, extruded, conched such as grinding and warming (through mechanical friction), pressed, injected, packed, wrapped, canned, jarred, sealed, etc.

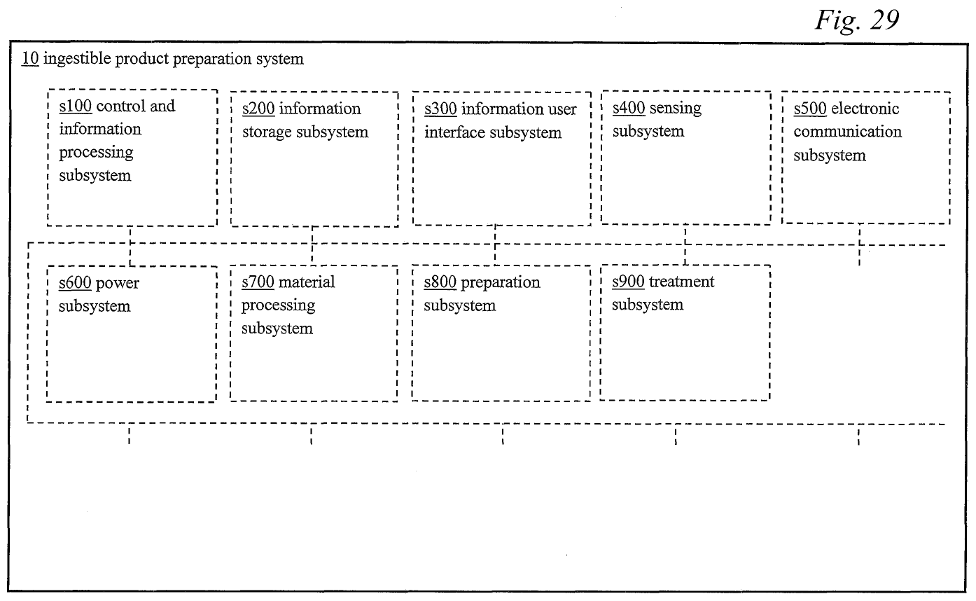

An exemplary version of the ingestible product preparation system 10 is shown in FIG. 29 to optionally include various subsystems such as control and information processing subsystem s100, information storage subsystem s200, information user interface subsystem s300, sensing subsystem s400, electronic communication subsystem s500, power subsystem s600, material processing subsystem s700, preparation subsystem s800, treatment subsystem s900.

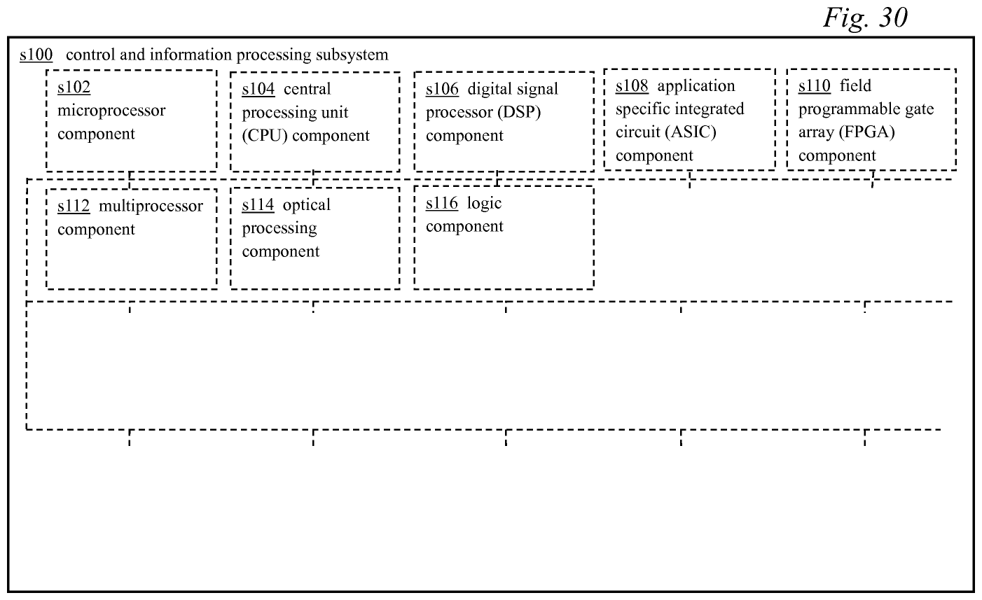

An exemplary implementation of the control and information processing subsystem s100 is shown in FIG. 30 to optionally include various components such as microprocessor component s102, central processing unit (CPU) component s104, digital signal processor (DSP) component s106, application specific integrated circuit (ASIC) component s108, field programmable gate array (FPGA) component s110, multiprocessor component s112, optical processing component s114, and logic component s116.

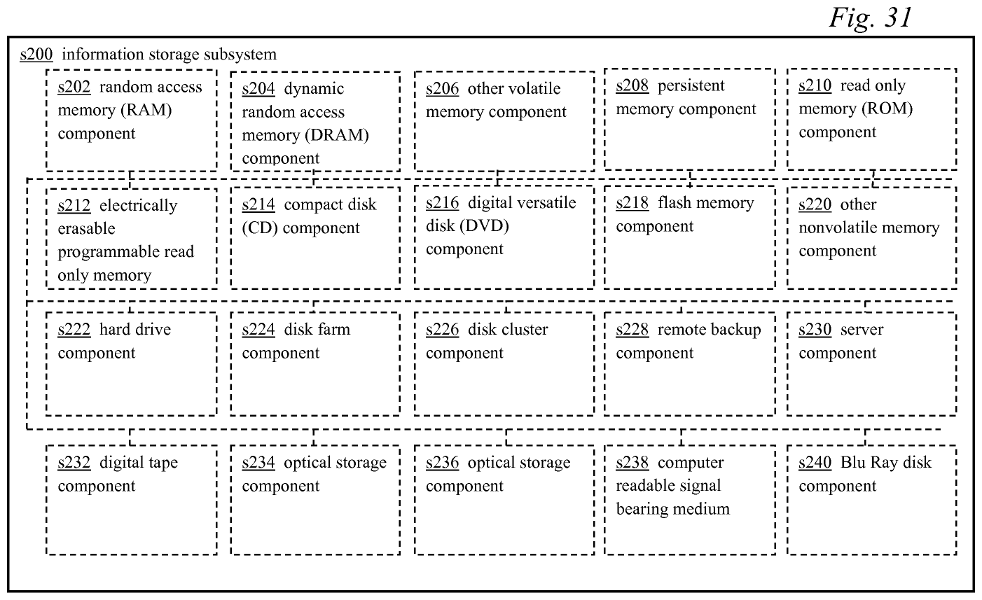

An exemplary implementation of the information storage subsystem s200 is shown in FIG. 31 to optionally include various components such as random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, and Blu Ray disk component s240.

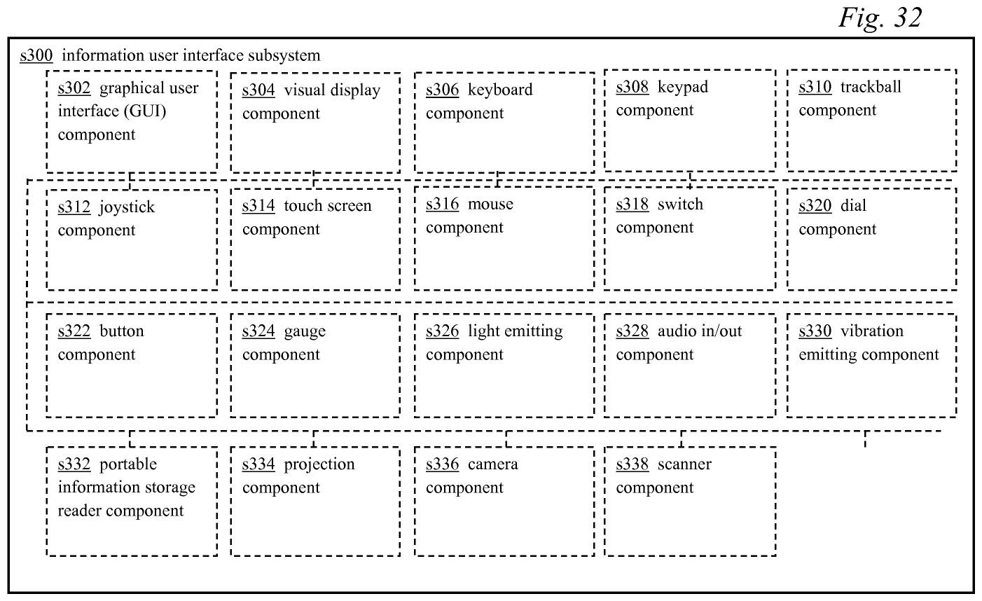

An exemplary implementation of the information user interface subsystem s300 is shown in FIG. 32 to optionally include various components such as graphical user interface (GUI) component s302, visual display component s304, keyboard component s306, keypad component s308, trackball component s310, joystick component s312, touch screen component s314, mouse component s316, switch component s318, dial component s320, button component s322, gauge component s324, light emitting component s326, audio in/out component s328, vibration emitting component s330, portable information storage reader component s332, projection component s334, camera component s336, and scanner component s338.

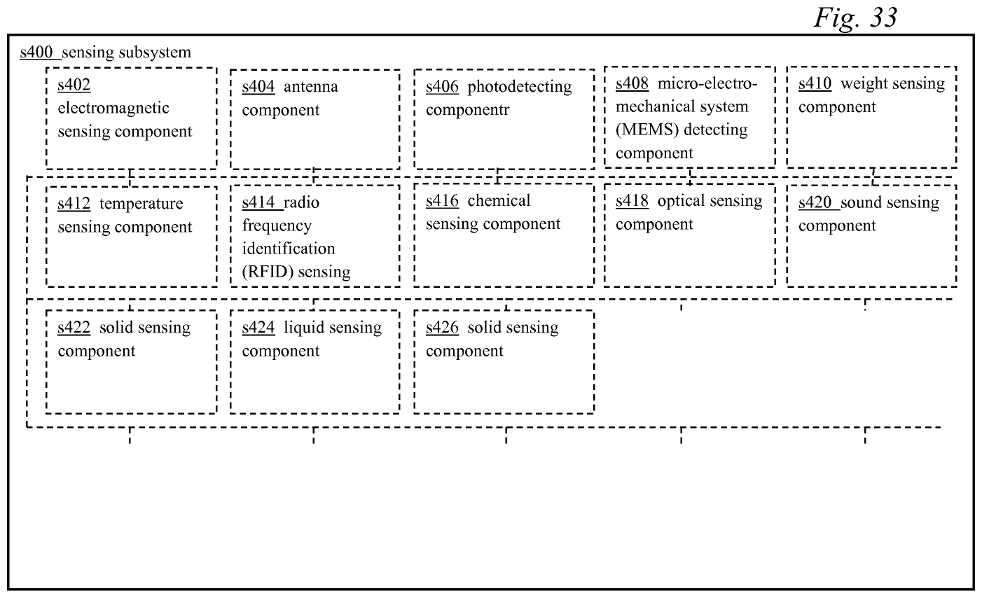

An exemplary implementation of the sensing subsystem s400 is shown in FIG. 33 to optionally include various components such as electromagnetic sensing component s402, antenna component s404, photodetecting component s406, micro-electro-mechanical system (MEMS) detecting component s408, weight sensing component s410, temperature sensing component s412, radio frequency identification (RFID) sensing component s414, chemical sensing component s416, optical sensing component s418, sound sensing component s420, solid sensing component s422, liquid sensing component s424, and solid sensing component s426.

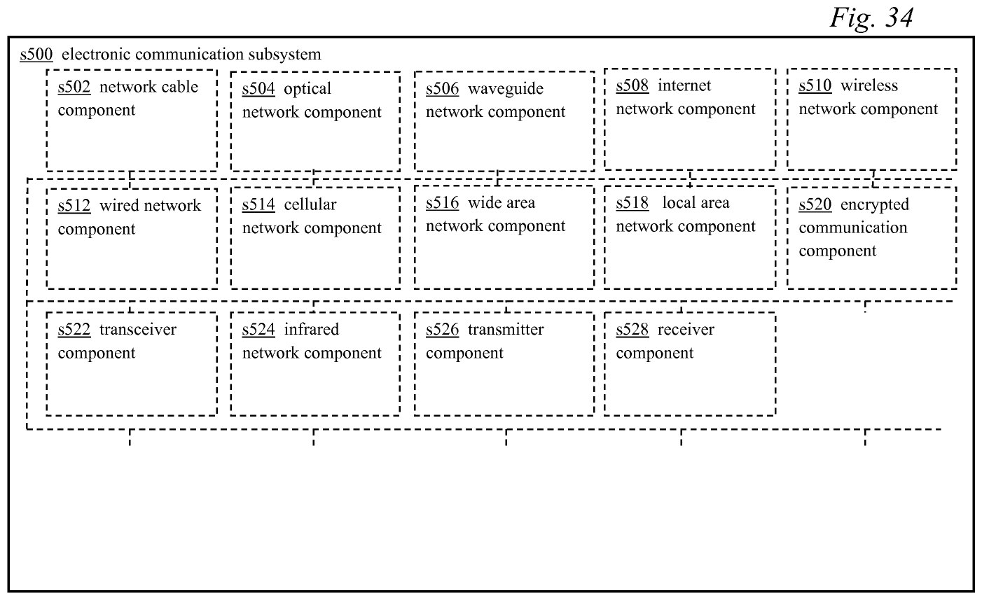

An exemplary implementation of the electronic communication subsystem s500 is shown in FIG. 34 to optionally include various components such as network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, and receiver component s528.

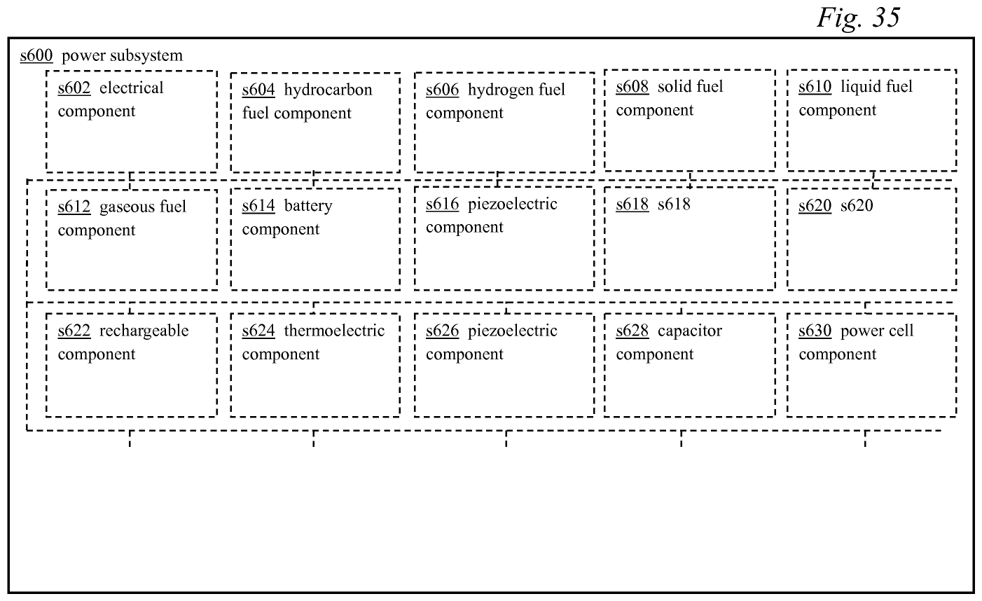

An exemplary implementation of the power subsystem s600 is shown in FIG. 35 to optionally include various components such as electrical component s602, hydrocarbon fuel component s604, hydrogen fuel component s606, solid fuel component s608, liquid fuel component s610, gaseous fuel component s612, battery component s614, battery component s622, battery component s624, battery component s626, battery component s628, and power cell component s630.

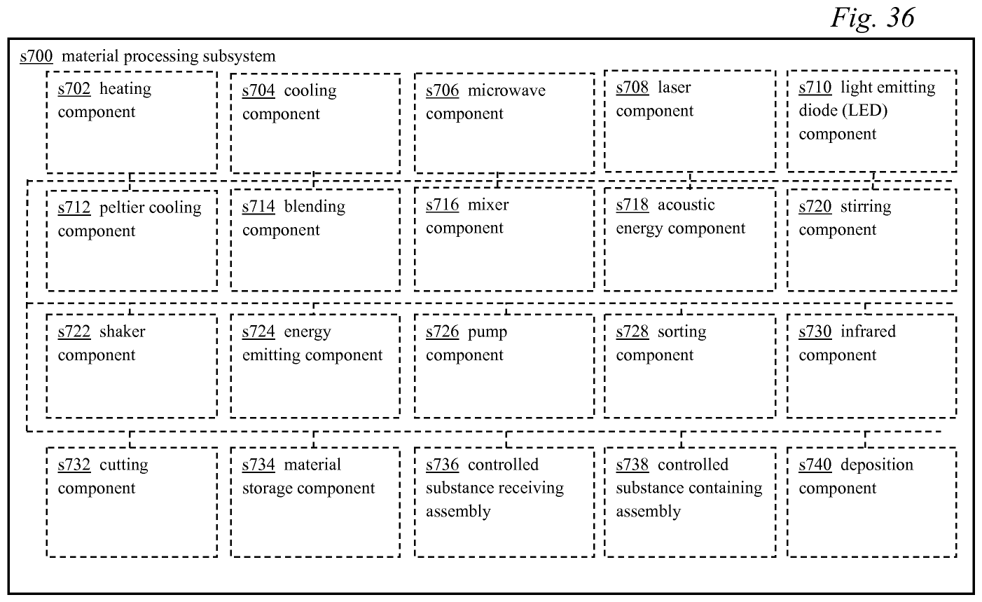

An exemplary implementation of the material processing subsystem s700 is shown in FIG. 36 to optionally include various components such as heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740.

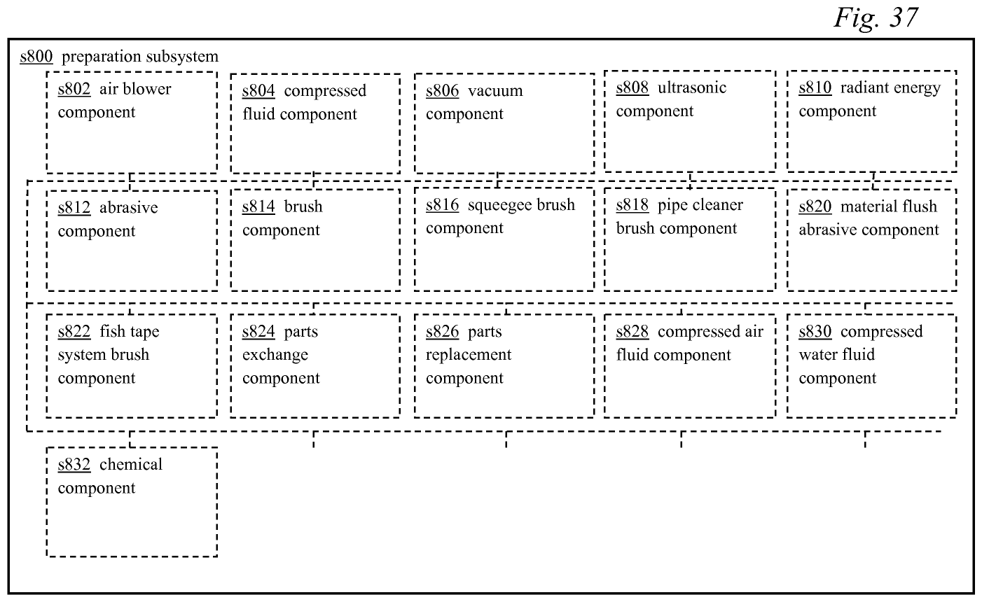

An exemplary implementation of the preparation subsystem s800 is shown in FIG. 37 to optionally include various components such as air blower component s802, compressed fluid component s804, vacuum component s806, ultrasonic component s808, radiant energy component s810, abrasive component s812, brush component s814, squeegee brush component s816, pipe cleaner brush component s818, material flush abrasive component s820, fish tape system brush component s822, parts exchange component s824, parts replacement component s826, compressed air fluid component s828, compressed water fluid component s830, and chemical component s832.

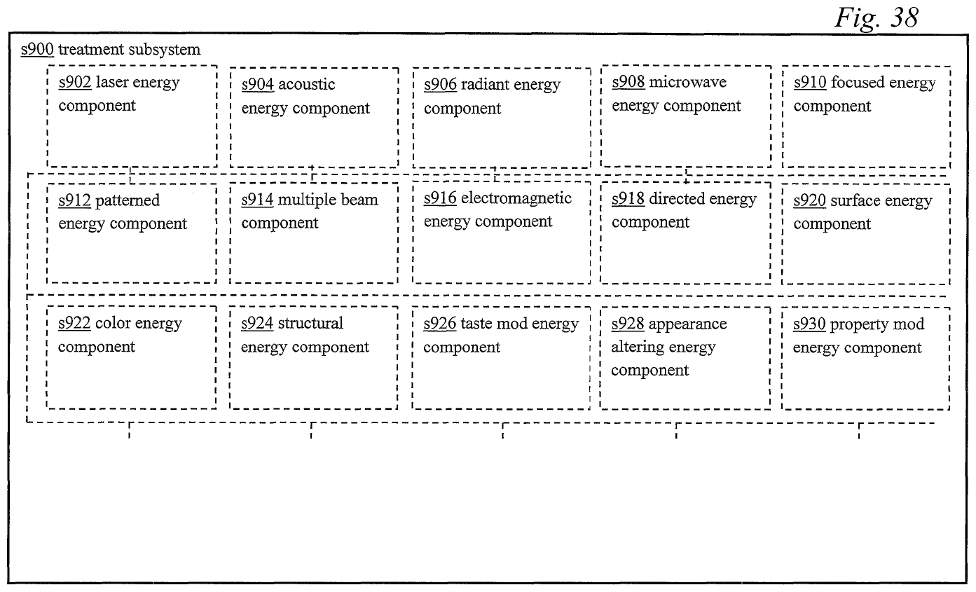

An exemplary implementation of the treatment subsystem s900 is shown in FIG. 38 to optionally include various components such as laser energy component s902, acoustic energy component s904, radiant energy component s906, microwave energy component s908, focused energy component s910, and patterned energy component s912.

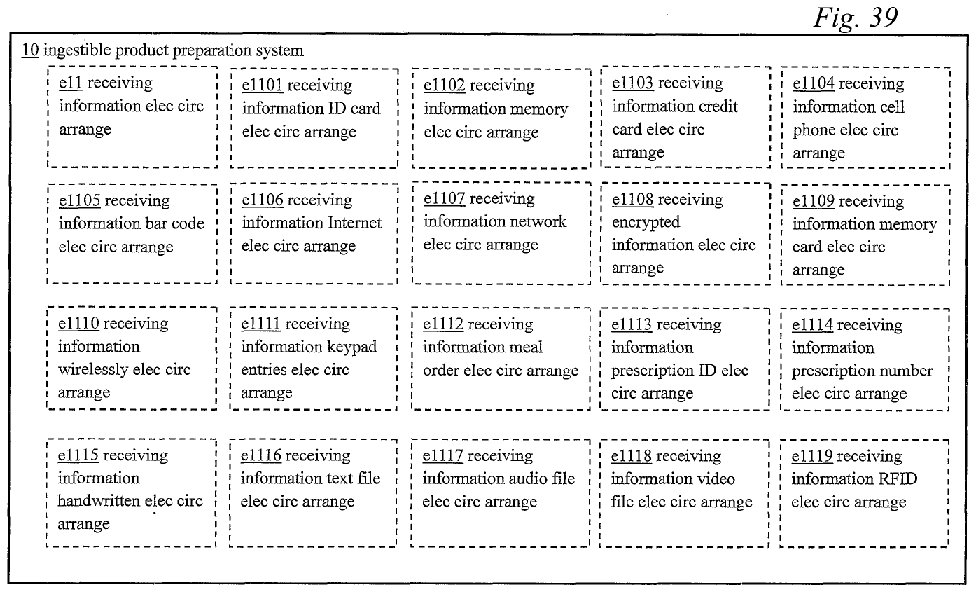

Implementations involve different combinations (otherwise known as “electrical circuitry arrangements”) of components from the subsystems of the ingestible product preparation system 10. Exemplary depictions of some of these electrical circuitry arrangements are shown in FIG. 39 to include receiving information electrical circuitry arrangement f11, receiving information ID card electrical circuitry arrangement f1101, receiving information memory electrical circuitry arrangement f1102, receiving information credit card electrical circuitry arrangement f1103, receiving information cell phone electrical circuitry arrangement f1104, receiving information bar code electrical circuitry arrangement f1105, receiving information Internet electrical circuitry arrangement f1106, receiving information network electrical circuitry arrangement f1107, receiving encrypted information electrical circuitry arrangement f1108, receiving information memory card electrical circuitry arrangement f1109, receiving information wirelessly electrical circuitry arrangement f1110, receiving information keypad entries electrical circuitry arrangement f1111, receiving information meal order electrical circuitry arrangement f1112, receiving information prescription ID electrical circuitry arrangement f1113, receiving information prescription number electrical circuitry arrangement f1114, receiving information handwritten electrical circuitry arrangement f1115, receiving information text file electrical circuitry arrangement f1116, receiving information audio file electrical circuitry arrangement f1117, receiving information video file electrical circuitry arrangement f1118, and receiving information RFID electrical circuitry arrangement f1119.

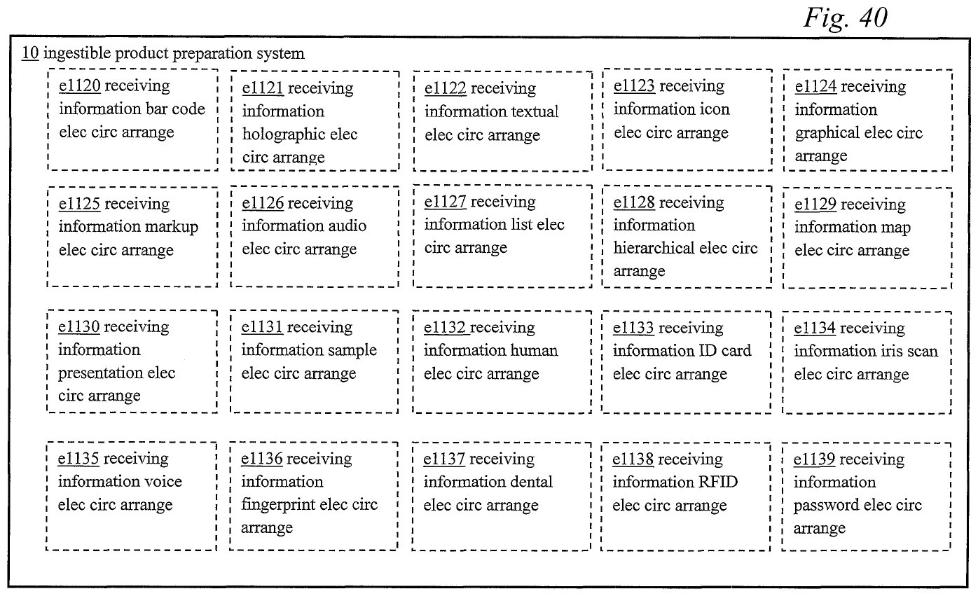

Some of these electrical circuitry arrangements are depicted in FIG. 40 to include receiving information bar code electrical circuitry arrangement f1120, receiving information holographic electrical circuitry arrangement f1121, receiving information textual electrical circuitry arrangement f1122, receiving information icon electrical circuitry arrangement f1123, receiving information graphical electrical circuitry arrangement f1124, receiving information markup electrical circuitry arrangement f1125, receiving information audio electrical circuitry arrangement f1126, receiving information list electrical circuitry arrangement f1127, receiving information hierarchical electrical circuitry arrangement f1128, receiving information map electrical circuitry arrangement f1129, receiving information presentation electrical circuitry arrangement f1130, receiving information sample electrical circuitry arrangement f113, receiving information human electrical circuitry arrangement f1132, receiving information ID card electrical circuitry arrangement f1133, receiving information iris scan electrical circuitry arrangement f1134, receiving information voice electrical circuitry arrangement f1135, receiving information fingerprint electrical circuitry arrangement f1136, receiving information dental electrical circuitry arrangement f1137, receiving information RFID electrical circuitry arrangement f1138, and receiving information password electrical circuitry arrangement f1139.

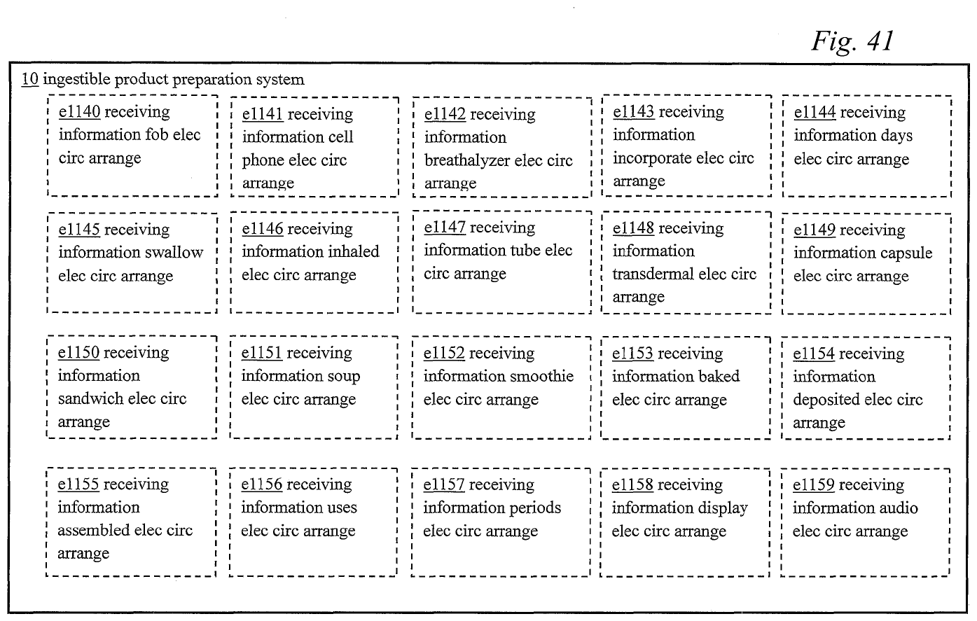

Some of these electrical circuitry arrangements are depicted in FIG. 41 to include receiving information fob electrical circuitry arrangement f1140, receiving information cell phone electrical circuitry arrangement f1141, receiving information breathalyzer electrical circuitry arrangement f1142, receiving information incorporate electrical circuitry arrangement f1143, receiving information days electrical circuitry arrangement f1144, receiving information swallow electrical circuitry arrangement f1145, receiving information inhaled electrical circuitry arrangement f1146, receiving information tube electrical circuitry arrangement f1147, receiving information transdermal electrical circuitry arrangement f1148, receiving information capsule electrical circuitry arrangement f1149, receiving information sandwich electrical circuitry arrangement f1150, receiving information soup electrical circuitry arrangement f1151, receiving information smoothie electrical circuitry arrangement f1152, receiving information baked electrical circuitry arrangement f1153, receiving information deposited electrical circuitry arrangement f1154, receiving information assembled electrical circuitry arrangement f1155, receiving information uses electrical circuitry arrangement f1156, receiving information periods electrical circuitry arrangement f1157, receiving information display electrical circuitry arrangement f1158, and receiving information audio electrical circuitry arrangement f1159.

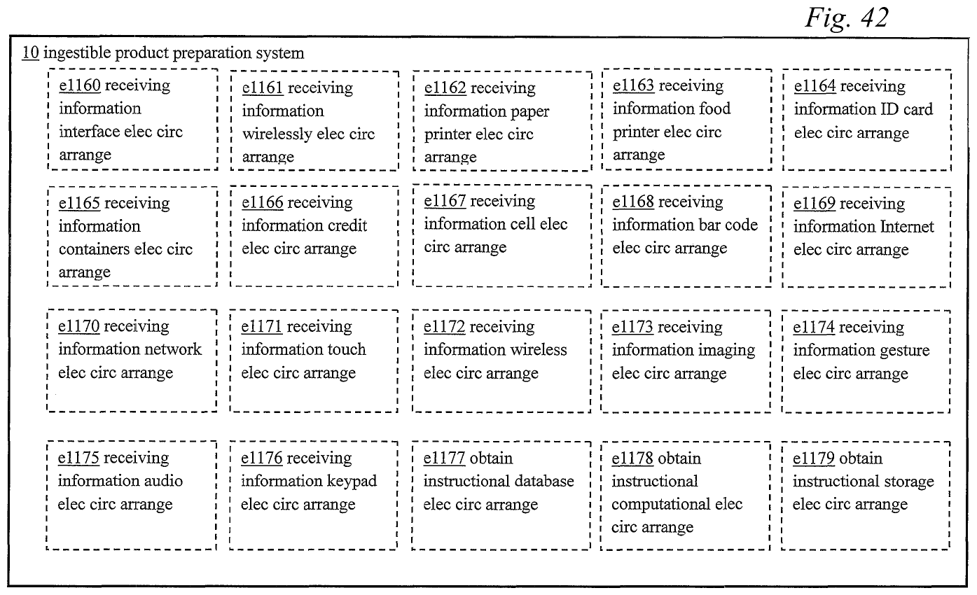

Some of these electrical circuitry arrangements are depicted in FIG. 42 to include receiving information interface electrical circuitry arrangement f1160, receiving information wirelessly electrical circuitry arrangement f1161, receiving information paper printer electrical circuitry arrangement f1162, receiving information food printer electrical circuitry arrangement f1163, receiving information ID card electrical circuitry arrangement f1164, receiving information containers electrical circuitry arrangement f1165, and receiving information credit electrical circuitry arrangement f1166, receiving information cell electrical circuitry arrangement f1167, receiving information bar code electrical circuitry arrangement f1168, receiving information Internet electrical circuitry arrangement f1169, receiving information network electrical circuitry arrangement f1170, receiving information touch electrical circuitry arrangement f1171, receiving information wireless electrical circuitry arrangement f1172, receiving information imaging electrical circuitry arrangement f1173, receiving information gesture electrical circuitry arrangement f1174, receiving information audio electrical circuitry arrangement f1175, receiving information keypad electrical circuitry arrangement f1176, obtain instructional database electrical circuitry arrangement f1177, obtain instructional computational electrical circuitry arrangement f1178, and obtain instructional storage electrical circuitry arrangement f1179.

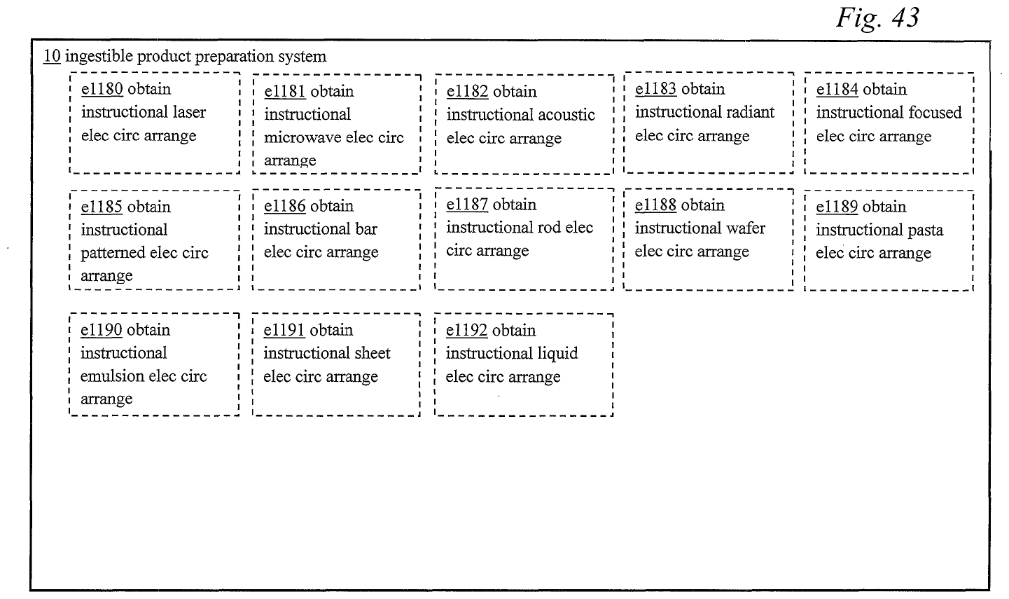

Some of these electrical circuitry arrangements are depicted in FIG. 43 to include obtain instructional laser electrical circuitry arrangement f1180, obtain instructional microwave electrical circuitry arrangement f1181, obtain instructional acoustic electrical circuitry arrangement f1182, obtain instructional radiant electrical circuitry arrangement f1183, obtain instructional focused electrical circuitry arrangement f1184, obtain instructional patterned electrical circuitry arrangement f1185, obtain instructional bar electrical circuitry arrangement f1186, obtain instructional rod electrical circuitry arrangement f1187, obtain instructional wafer electrical circuitry arrangement f1188, obtain instructional pasta electrical circuitry arrangement f1189, obtain instructional emulsion electrical circuitry arrangement f1190, obtain instructional sheet electrical circuitry arrangement f1191, and obtain instructional liquid electrical circuitry arrangement f1192.

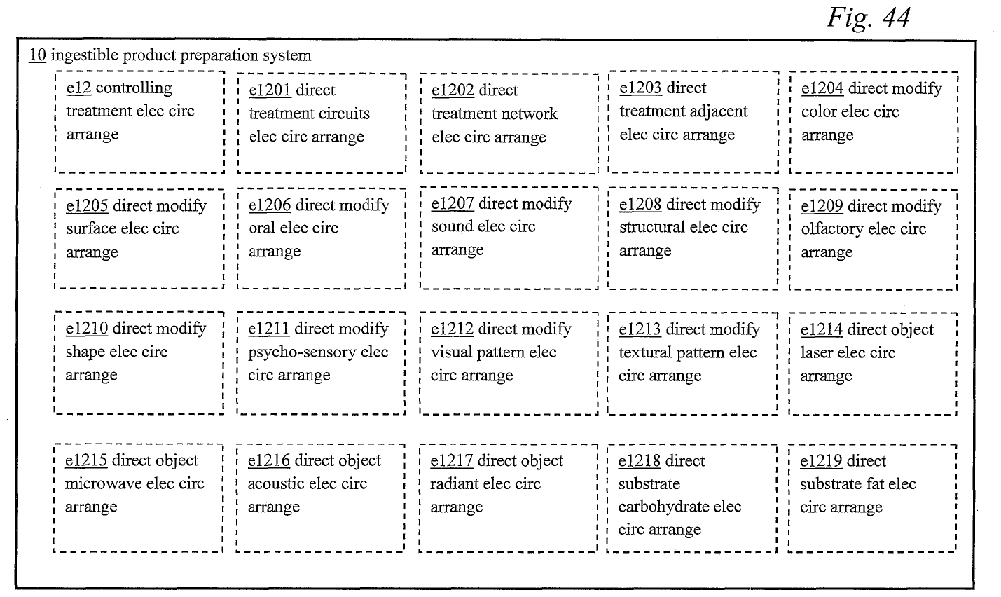

Some of these electrical circuitry arrangements are depicted in FIG. 44 to include controlling treatment electrical circuitry arrangement f12, direct treatment circuits electrical circuitry arrangement f1201, direct treatment network electrical circuitry arrangement f1202, direct treatment adjacent electrical circuitry arrangement f1203, direct modify color electrical circuitry arrangement f1204, direct modify surface electrical circuitry arrangement f1205, direct modify oral electrical circuitry arrangement f1206, direct modify sound electrical circuitry arrangement f1207, direct modify structural electrical circuitry arrangement f1208, direct modify olfactory electrical circuitry arrangement f1209, direct modify shape electrical circuitry arrangement f1210, direct modify psycho-sensory electrical circuitry arrangement f1211, and direct modify visual pattern electrical circuitry arrangement f1212, direct modify textural pattern electrical circuitry arrangement f1213, direct object laser electrical circuitry arrangement f1214, direct object microwave electrical circuitry arrangement f1215, direct object acoustic electrical circuitry arrangement f1216, direct object radiant electrical circuitry arrangement f1217, direct substrate carbohydrate electrical circuitry arrangement f1218, and direct substrate fat electrical circuitry arrangement f1219.

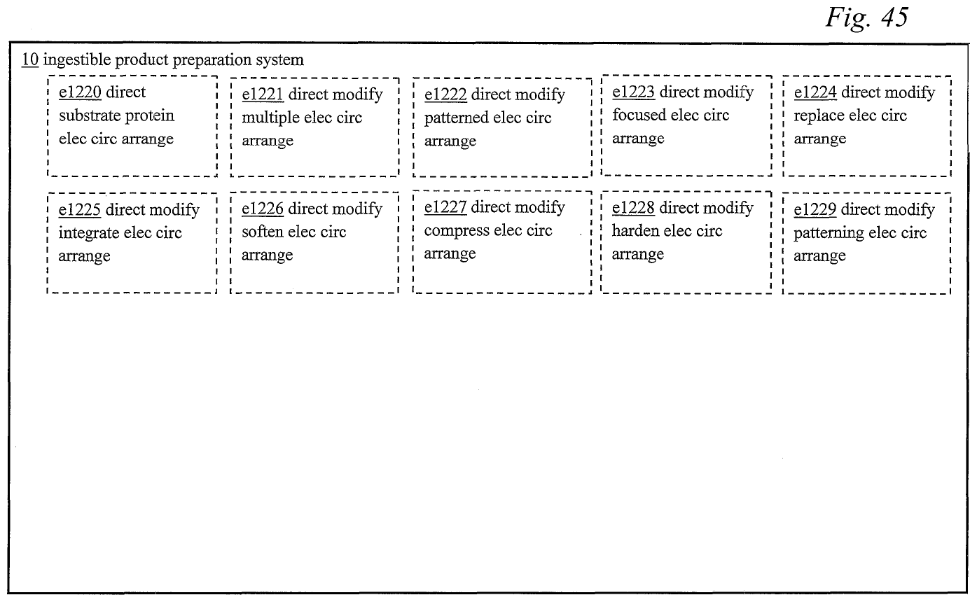

Some of these electrical circuitry arrangements are depicted in FIG. 45 to include direct substrate protein electrical circuitry arrangement f12, direct modify multiple electrical circuitry arrangement f1221, direct modify patterned electrical circuitry arrangement f1222, direct modify focused electrical circuitry arrangement f1223, direct modify replace electrical circuitry arrangement f1224, direct modify integrate electrical circuitry arrangement f1225, direct modify soften electrical circuitry arrangement f1226, direct modify compress electrical circuitry arrangement f1227, direct modify harden electrical circuitry arrangement f1228, and direct modify patterning electrical circuitry arrangement f1229.

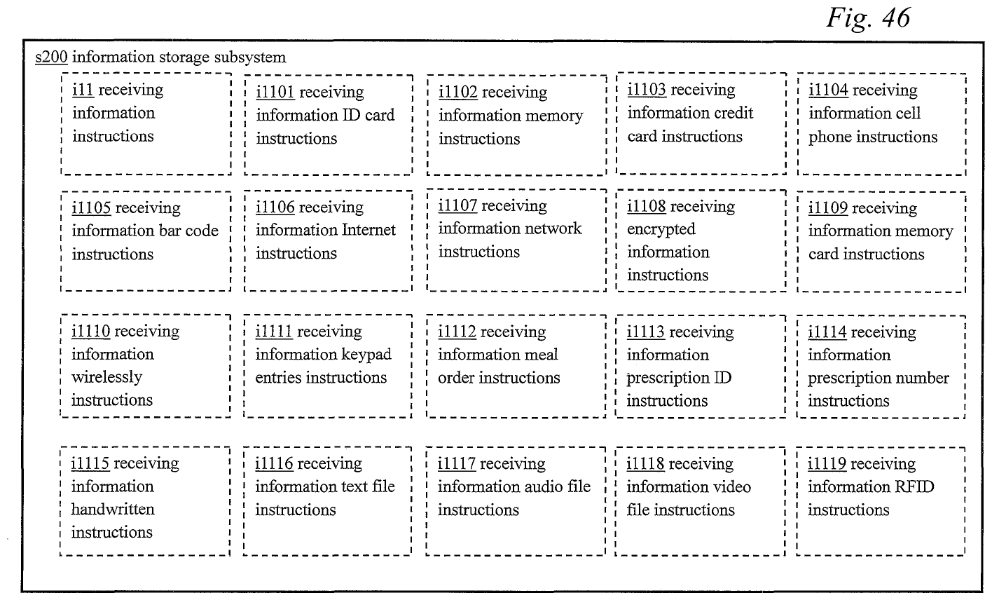

In implementations one or more instructions are stored and/or otherwise borne in various subsystems, components, and/or accessories of the ingestible product preparation system 10 such as being borne in a non-transitory signal bearing medium of information storage subsystem s200. One or more exemplary instructions depicted in FIG. 46 as being borne in an exemplary version of a non-transitory signal bearing medium of information storage subsystem s200 include one or more receiving information instructions j11, one or more receiving information ID card instructions j1101, one or more receiving information memory instructions j1102, one or more receiving information credit card instructions j1103, one or more receiving information cell phone instructions j1104, one or more receiving information bar code instructions j1105, one or more receiving information Internet instructions j1106, one or more receiving information network instructions j1107, one or more receiving encrypted information instructions j1108, one or more receiving information memory card instructions j1109, one or more receiving information wirelessly instructions j1110, one or more receiving information keypad entries instructions j1111, one or more receiving information meal order instructions j1112, one or more receiving information prescription ID instructions j1113, one or more receiving information prescription number instructions j1114, one or more receiving information handwritten instructions j1115, one or more receiving information text file instructions j1116, one or more receiving information audio file instructions j1117, one or more receiving information video file instructions j1118, and one or more receiving information RFID instructions j1119.

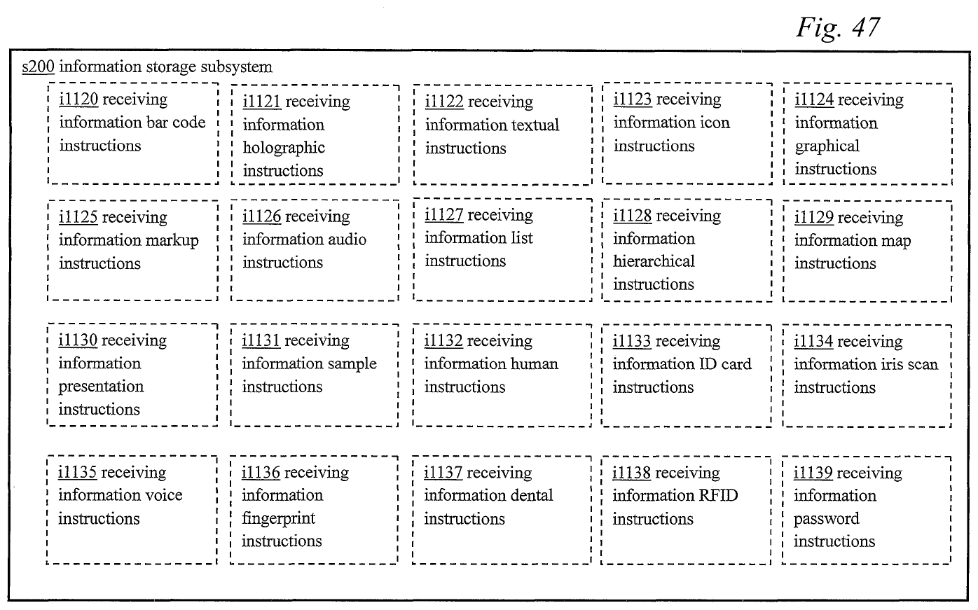

One or more exemplary instructions depicted in FIG. 47 as being borne in an exemplary version of a non-transitory signal bearing medium of information storage subsystem s200 include one or more receiving information bar code instructions j1120, one or more receiving information holographic instructions j1121, one or more receiving information textual instructions j1122, one or more receiving information icon instructions j1123, one or more receiving information graphical instructions j1124, one or more receiving information markup instructions j1125, one or more receiving information audio instructions j1126, one or more receiving information list instructions j1127, one or more receiving information hierarchical instructions j1128, one or more receiving information map instructions j1129, one or more receiving information presentation instructions j1130, one or more receiving information sample instructions j1131, one or more receiving information human instructions j1132, one or more receiving information ID card instructions j1133, one or more receiving information iris scan instructions j1134, one or more receiving information voice instructions j1135, one or more receiving information fingerprint instructions j1136, one or more receiving information dental instructions j1137, one or more receiving information RFID instructions j1138, and one or more receiving information password instructions j1139.

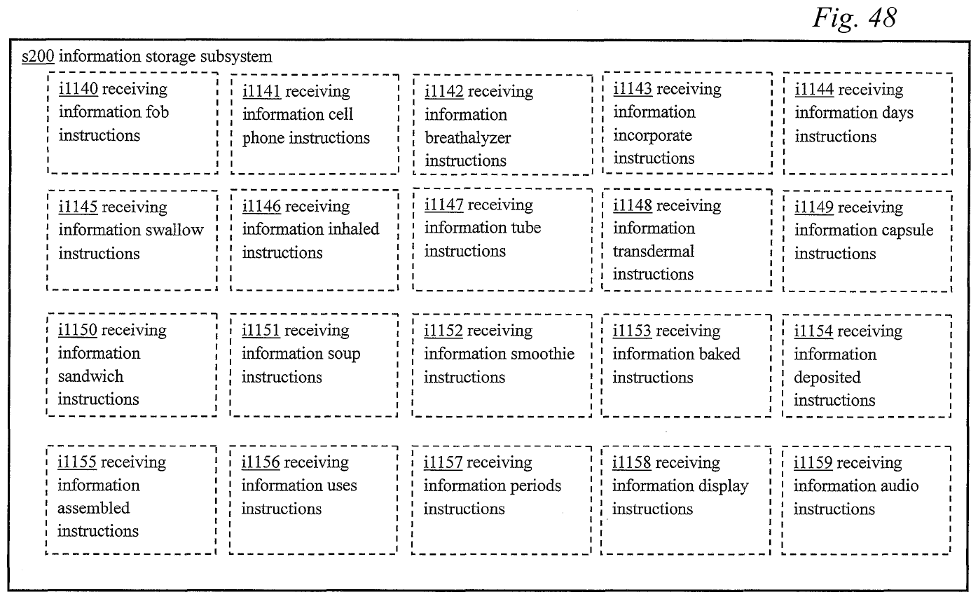

One or more exemplary instructions depicted in FIG. 48 as being borne in an exemplary version of a non-transitory signal bearing medium of information storage subsystem s200 include one or more receiving information fob instructions j1140, one or more receiving information cell phone instructions j1141, one or more receiving information breathalyzer instructions j1142, one or more receiving information incorporate instructions j1143, one or more receiving information days instructions j1144, one or more receiving information swallow instructions j1145, one or more receiving information inhaled instructions j1146, one or more receiving information tube instructions j1147, one or more receiving information transdermal instructions j1148, one or more receiving information capsule instructions j1149, one or more receiving information sandwich instructions j1150, one or more receiving information soup instructions j1151, one or more receiving information smoothie instructions j1152, one or more receiving information baked instructions j1153, one or more receiving information deposited instructions j1154, one or more receiving information assembled instructions j1155, one or more receiving information uses instructions j1156, one or more receiving information periods instructions j1157, one or more receiving information display instructions j1158, and one or more receiving information audio instructions j1159.

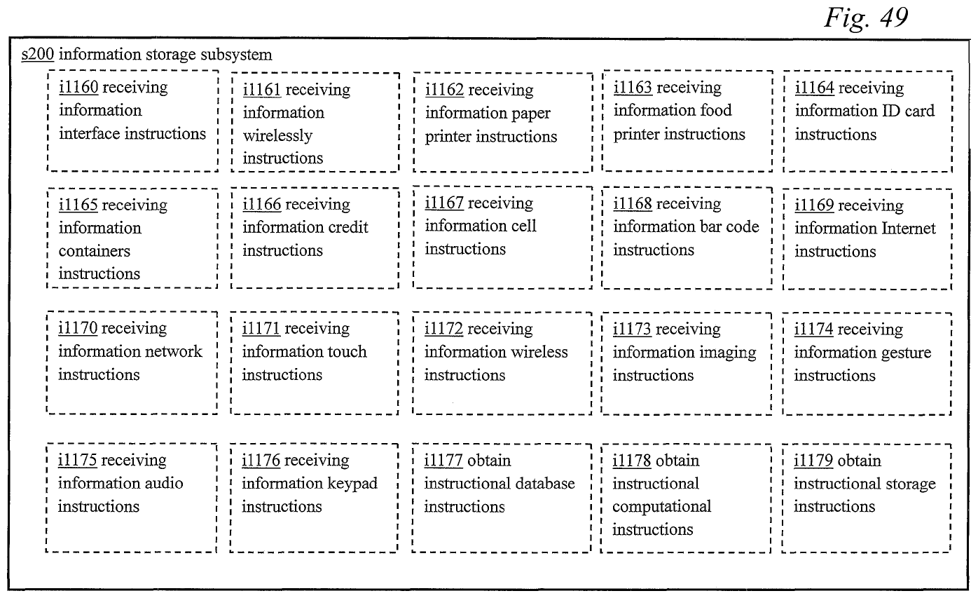

One or more exemplary instructions depicted in FIG. 49 as being borne in an exemplary version of a non-transitory signal bearing medium of information storage subsystem s200 include one or more receiving information interface instructions j1160, one or more receiving information wirelessly instructions j1161, one or more receiving information paper printer instructions j1162, one or more receiving information food printer instructions j1163, one or more receiving information ID card instructions j1164, one or more receiving information containers instructions j1165, and one or more receiving information credit instructions j1166, one or more receiving information cell instructions j1167, one or more receiving information bar code instructions j1168, one or more receiving information Internet instructions j1169, one or more receiving information network instructions j1170, one or more receiving information touch instructions j1171, one or more receiving information wireless instructions j1172, one or more receiving information imaging instructions j1173, one or more receiving information gesture instructions j1174, one or more receiving information audio instructions j1175, one or more receiving information keypad instructions j1176, one or more obtain instructional database instructions j1177, one or more obtain instructional computational instructions j1178, and one or more obtain instructional storage instructions j1179.

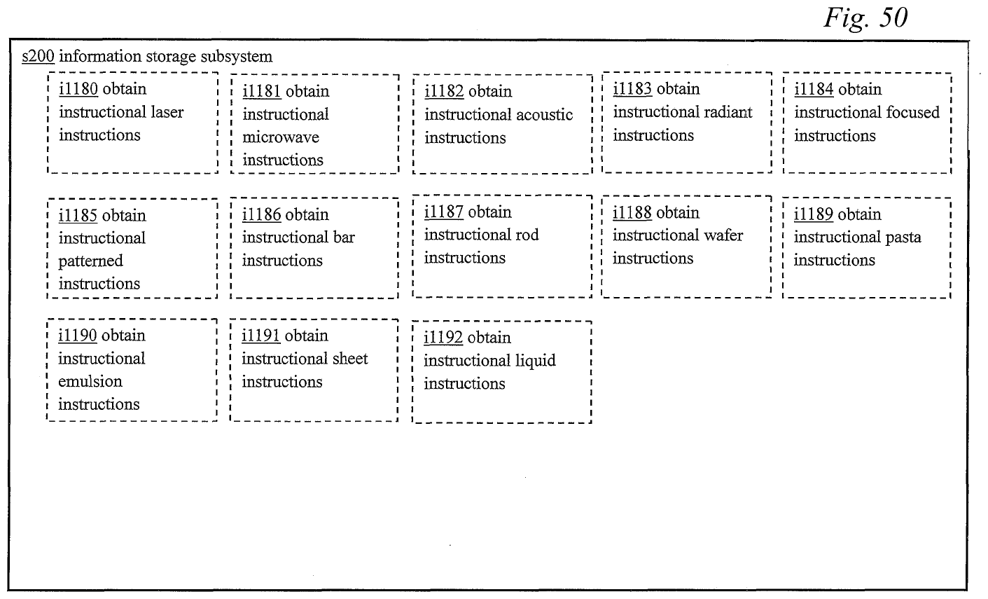

One or more exemplary instructions depicted in FIG. 50 as being borne in an exemplary version of a non-transitory signal bearing medium of information storage subsystem s200 include one or more obtain instructional laser instructions j1180, one or more obtain instructional microwave instructions j1181, one or more obtain instructional acoustic instructions j1182, one or more obtain instructional radiant instructions j1183, one or more obtain instructional focused instructions j1184, one or more obtain instructional patterned instructions j1185, one or more obtain instructional bar instructions j1186, one or more obtain instructional rod instructions j1187, one or more obtain instructional wafer instructions j1188, one or more obtain instructional pasta instructions j1189, one or more obtain instructional emulsion instructions j1190, one or more obtain instructional sheet instructions j1191, and one or more obtain instructional liquid instructions j1192.

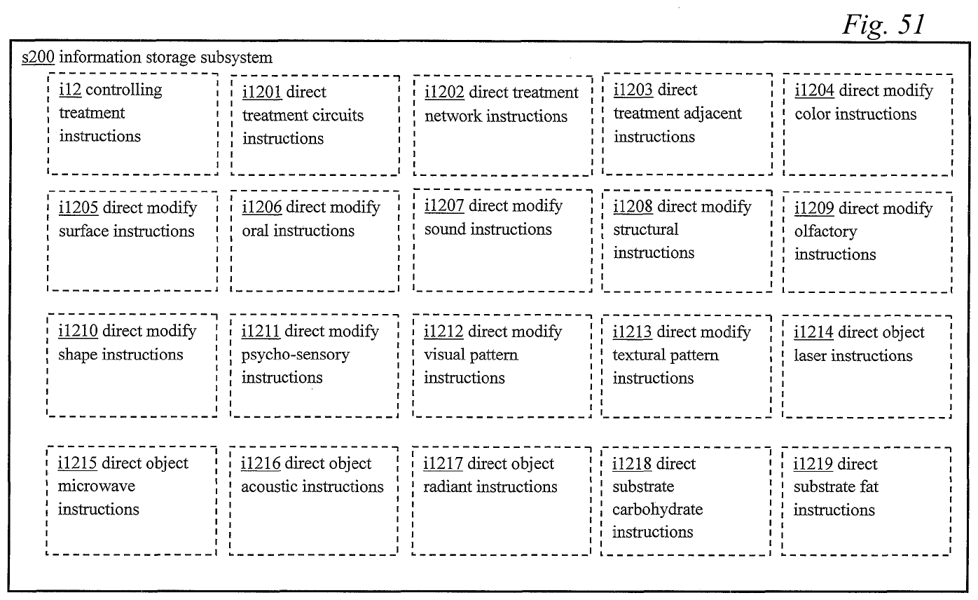

One or more exemplary instructions depicted in FIG. 51 as being borne in an exemplary version of a non-transitory signal bearing medium of information storage subsystem s200 include one or more controlling treatment instructions j12, one or more direct treatment circuits instructions j1201, one or more direct treatment network instructions j1202, one or more direct treatment adjacent instructions j1203, one or more direct modify color instructions j1204, one or more direct modify surface instructions j1205, one or more direct modify oral instructions j1206, one or more direct modify sound instructions j1207, one or more direct modify structural instructions j1208, one or more direct modify olfactory instructions j1209, one or more direct modify shape instructions j1210, one or more direct modify psycho-sensory instructions j1211, one or more direct modify visual pattern instructions j1212, one or more direct modify textural pattern instructions j1213, one or more direct object laser instructions j1214, one or more direct object microwave instructions j1215, one or more direct object acoustic instructions j1216, one or more direct object radiant instructions j1217, one or more direct substrate carbohydrate instructions j1218, and one or more direct substrate fat instructions j1219.

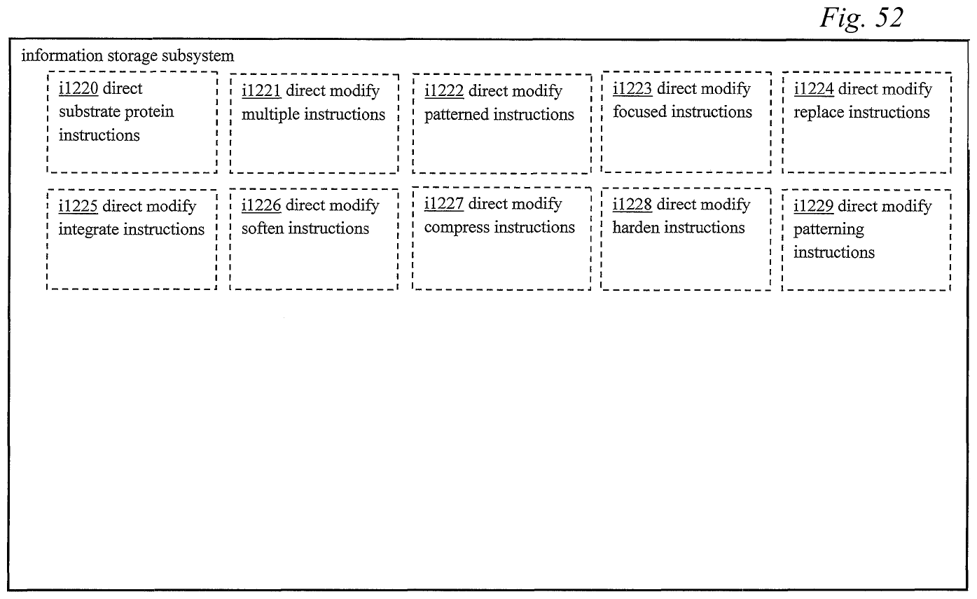

One or more exemplary instructions depicted in FIG. 52 as being borne in an exemplary version of a non-transitory signal bearing medium of information storage subsystem s200 include one or more direct substrate protein instructions j1220, one or more direct modify multiple instructions j1221, one or more direct modify patterned instructions j1222, one or more direct modify focused instructions j1223, one or more direct modify replace instructions j1224, one or more direct modify integrate instructions j1225, one or more direct modify soften instructions j1226, one or more direct modify compress instructions j1227, one or more direct modify harden instructions j1228, and one or more direct modify patterning instructions j1229.

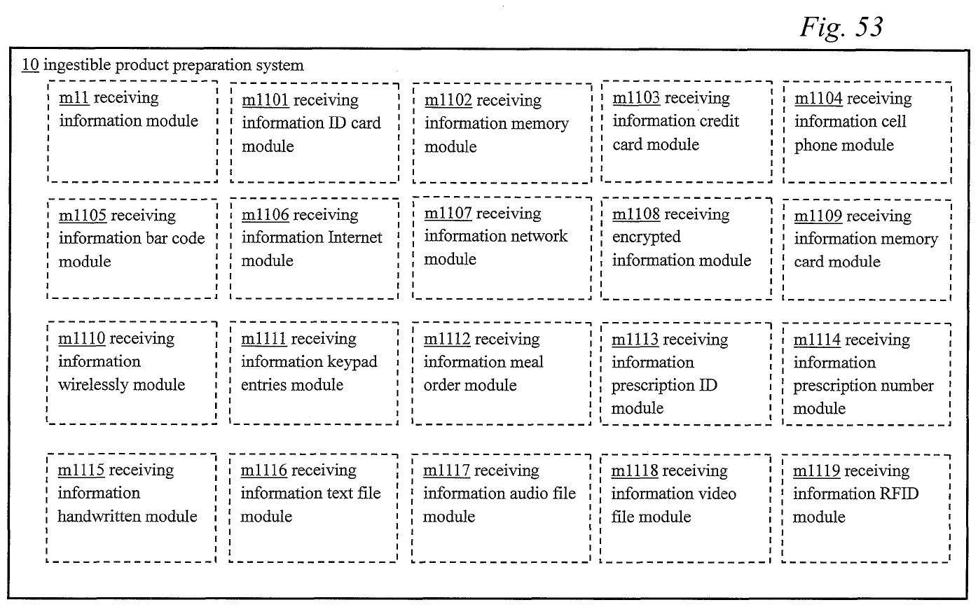

Implementations of modules involve different combinations (limited to patentable subject matter under 35 U.S.C. 101) of one or more aspects from one or more of the electrical circuitry arrangements and/or one or more aspects from one or more of the instructions of the ingestible product preparation system 10. Exemplary depictions of some of these modules are shown in FIG. 53 to include receiving information module n11, receiving information ID card module n1101, receiving information memory module n1102, receiving information credit card module n1103, receiving information cell phone module n1104, receiving information bar code module n1105, receiving information Internet module n1106, receiving information network module n1107, receiving encrypted information module n1108, receiving information memory card module n1109, receiving information wirelessly module n1110, receiving information keypad entries module n1111, receiving information meal order module n1112, receiving information prescription ID module n1113, receiving information prescription number module n1114, receiving information handwritten module n1115, receiving information text file module n1116, receiving information audio file module n1117, receiving information video file module n1118, and receiving information RFID module n1119.

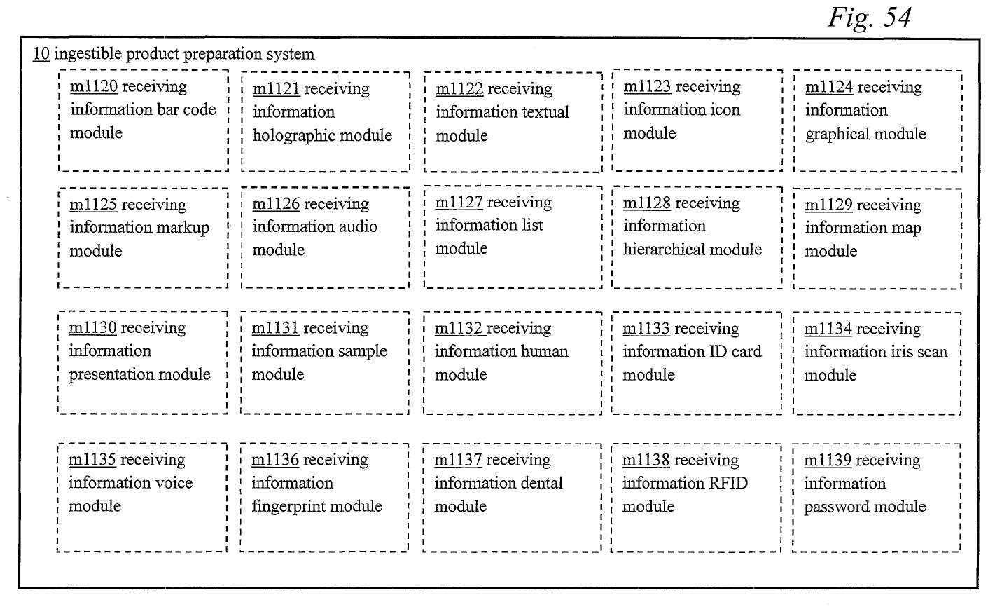

Some of these modules are depicted in FIG. 54 to include receiving information bar code module n1120, receiving information holographic module n1121, receiving information textual module n1122, receiving information icon module n1123, receiving information graphical module n1124, receiving information markup module n1125, receiving information audio module n1126, receiving information list module n1127, receiving information hierarchical module n1128, receiving information map module n1129, receiving information presentation module n1130, receiving information sample module n113, receiving information human module n1132, receiving information ID card module n1133, receiving information iris scan module n1134, receiving information voice module n1135, receiving information fingerprint module n1136, receiving information dental module n1137, receiving information RFID module n1138, and receiving information password module n1139.

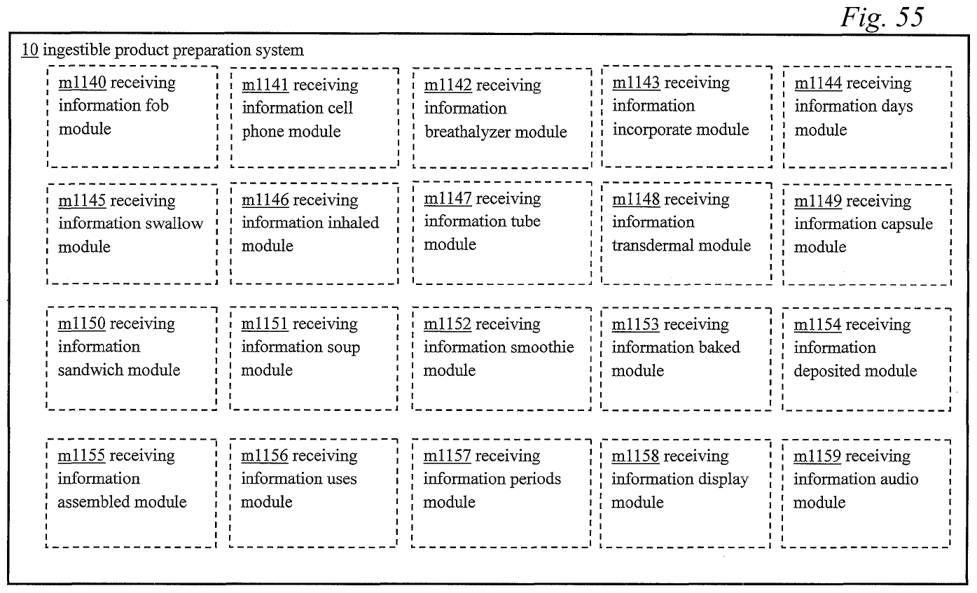

Some of these modules are depicted in FIG. 55 to include receiving information fob module n1140, receiving information cell phone module n1141, receiving information breathalyzer module n1142, receiving information incorporate module n1143, receiving information days module n1144, receiving information swallow module n1145, receiving information inhaled module n1146, receiving information tube module n1147, receiving information transdermal module n1148, receiving information capsule module n1149, receiving information sandwich module n1150, receiving information soup module n1151, receiving information smoothie module n1152, receiving information baked module n1153, receiving information deposited module n1154, receiving information assembled module n1155, receiving information uses module n1156, receiving information periods module n1157, receiving information display module n1158, and receiving information audio module n1159.

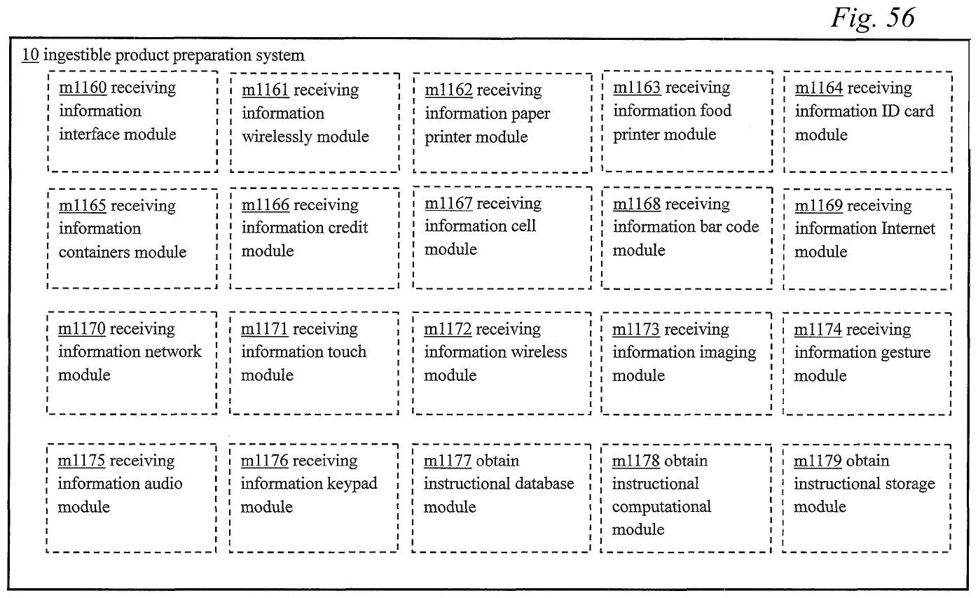

Some of these modules are depicted in FIG. 56 to include receiving information interface module n1160, receiving information wirelessly module n1161, receiving information paper printer module n1162, receiving information food printer module n1163, receiving information ID card module n1164, receiving information containers module n1165, and receiving information credit module n1166, receiving information cell module n1167, receiving information bar code module n1168, receiving information Internet module n1169, receiving information network module n1170, receiving information touch module n1171, receiving information wireless module n1172, receiving information imaging module n1173, receiving information gesture module n1174, receiving information audio module n1175, receiving information keypad module n1176, obtain instructional database module n1177, obtain instructional computational module n1178, and obtain instructional storage module n1179.

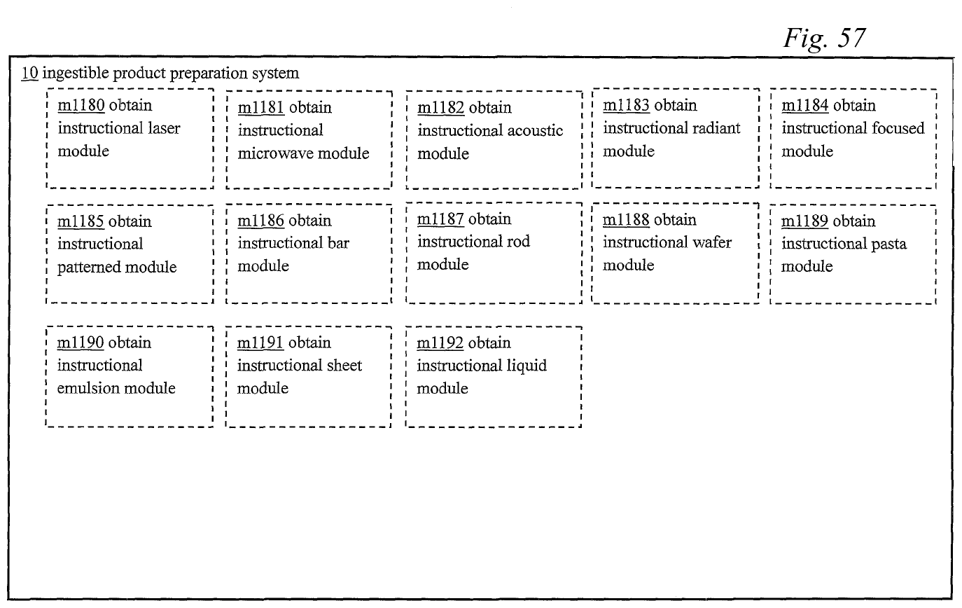

Some of these modules are depicted in FIG. 57 to include obtain instructional laser module n1180, obtain instructional microwave module n1181, obtain instructional acoustic module n1182, obtain instructional radiant module n1183, obtain instructional focused module n1184, obtain instructional patterned module n1185, obtain instructional bar module n1186, obtain instructional rod module n1187, obtain instructional wafer module n1188, obtain instructional pasta module n1189, obtain instructional emulsion module n1190, obtain instructional sheet module n1191, and obtain instructional liquid module n1192.

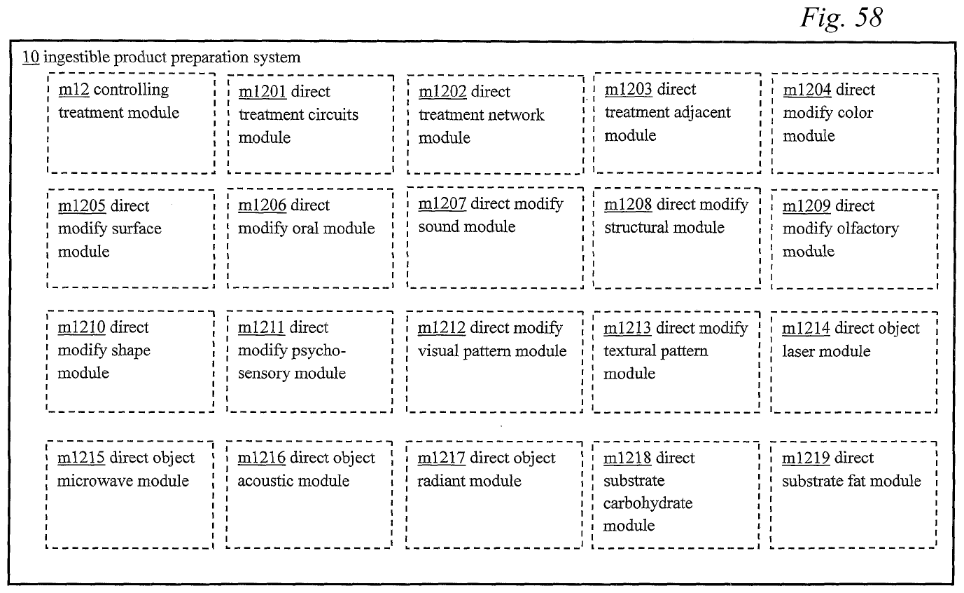

Some of these modules are depicted in FIG. 58 to include controlling treatment module n12, direct treatment circuits module n1201, direct treatment network module n1202, direct treatment adjacent module n1203, direct modify color module n1204, direct modify surface module n1205, direct modify oral module n1206, direct modify sound module n1207, direct modify structural module n1208, direct modify olfactory module n1209, direct modify shape module n1210, direct modify psycho-sensory module n1211, and direct modify visual pattern module n1212, direct modify textural pattern module n1213, direct object laser module n1214, direct object microwave module n1215, direct object acoustic module n1216, direct object radiant module n1217, direct substrate carbohydrate module n1218, and direct substrate fat module n1219.

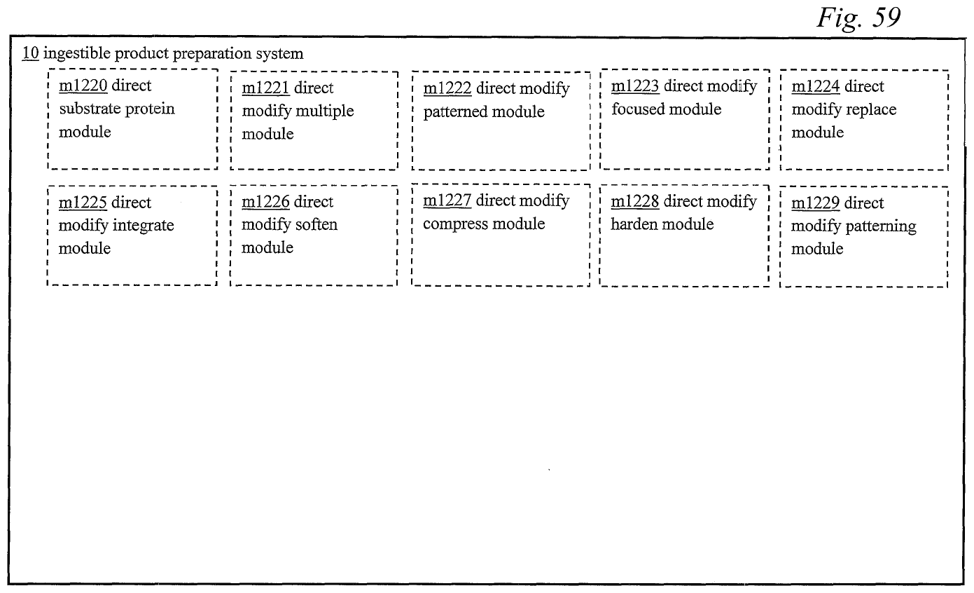

Some of these modules are depicted in FIG. 59 to include direct substrate protein module n12, direct modify multiple module n1221, direct modify patterned module n1222, direct modify focused module n1223, direct modify replace module n1224, direct modify integrate module n1225, direct modify soften module n1226, direct modify compress module n1227, direct modify harden module n1228, and direct modify patterning module n1229.

In some implementations, non-transistory signal-bearing medium of information storage subsystem s200 as articles of manufacture may store the one or more exemplary instructions. In some implementations, the non-transistory signal bearing medium may include a computer-readable medium. In some implementations, the non-transitory signal-bearing medium may include a recordable medium. In some implementations, the signal-bearing medium may include a communication medium.

The various subsystems and components of the ingestible product preparation system s10 such as the control and information processing subsystem s100, the information storage subsystem s200, the information user interface subsystem s300, the sensing subsystem s400 and the electronic communication subsystem s500 and their sub-components and the other exemplary entities depicted may be embodied by hardware, software and/or firmware (limited to patentable subject matter under 35 USC 101). For example, in some implementations of the ingestible product preparation system s10, aspects may be implemented with a processor (e.g., microprocessor, controller, and so forth) executing computer readable instructions (e.g., computer program product) stored in a storage medium (e.g., volatile or non-volatile memory) such as a signal-bearing medium. Alternatively, hardware such as application specific integrated circuit (ASIC) may be employed in order to implement such modules in some alternative implementations.

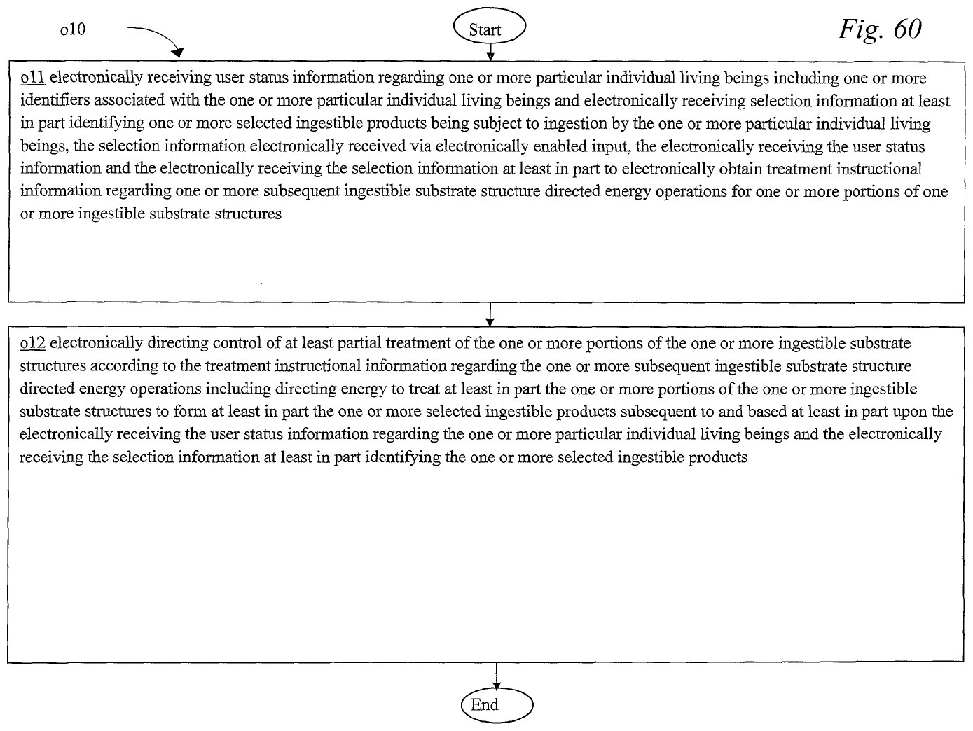

An operational flow p10 as shown in FIG. 60 represents example operations related to electronically receiving user status information regarding one or more particular individual living beings including one or more identifiers associated with the one or more particular individual living beings and electronically receiving selection information at least in part identifying one or more selected ingestible products being subject to ingestion by the one or more particular individual living beings, the selection information electronically received via electronically enabled input, the electronically receiving the user status information and the electronically receiving the selection information at least in part to electronically obtain treatment instructional information regarding one or more subsequent ingestible substrate structure directed energy operations for one or more portions of one or more ingestible substrate structures and electronically directing control of at least partial treatment of the one or more portions of the one or more ingestible substrate structures according to the treatment instructional information regarding the one or more subsequent ingestible substrate structure directed energy operations including directing energy to treat at least in part the one or more portions of the one or more ingestible substrate structures to form at least in part the one or more selected ingestible products subsequent to and based at least in part upon the electronically receiving the user status information regarding the one or more particular individual living beings and the electronically receiving the selection information at least in part identifying the one or more selected ingestible products.

FIG. 60 and those figures that follow may have various examples of operational flows, and explanation may be provided with respect to the above-described examples of FIGS. 12-28 and/or with respect to other examples and contexts. Nonetheless, it should be understood that the operational flows may be executed in a number of other environments and contexts, and/or in modified versions of FIGS. 12-28. Furthermore, although the various operational flows are presented in the sequence(s) illustrated, it should be understood that the various operations may be performed in other orders than those which are illustrated, or may be performed concurrently.

In FIG. 60 and those figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

As shown in FIG. 60, the operational flow p10 proceeds to operation p11 for electronically receiving user status information regarding one or more particular individual living beings including one or more identifiers associated with the one or more particular individual living beings and electronically receiving selection information at least in part identifying one or more selected ingestible products being subject to ingestion by the one or more particular individual living beings, the selection information electronically received via electronically enabled input, the electronically receiving the user status information and the electronically receiving the selection information at least in part to electronically obtain treatment instructional information regarding one or more subsequent ingestible substrate structure directed energy operations for one or more portions of one or more ingestible substrate structures. An exemplary version of a non-transitory signal bearing medium of information storage subsystem s200 is depicted as bearing one or more receiving information instructions j11 that when executed will direct performance of the operation p11. In an implementation, the one or more receiving information instructions j11 when executed direct electronically receiving (e.g. including the network cable component s502 carries information to the transceiver component s522, and/or etc.) user status information (e.g. including identification, characteristics, affiliations, and/or etc.) regarding one or more particular individual living beings (e.g. including one or more particular human beings, animals, and/or etc.) including one or more identifiers (e.g. including identification numbers, order numbers, passwords, biometric data such as voice prints, stored in information storage subsystem 200, and/or etc.) associated with the one or more particular individual living beings (e.g. including one or more humans, animals, and/or etc.) and electronically receiving (e.g. including through the receiver component s528, and/or etc.) selection information (e.g. including preferences, choices, and/or etc.) at least in part identifying (e.g. including textual descriptions, graphical representations, and/or etc.) one or more selected ingestible products (e.g. including sandwiches, snack bars, full course meals, deserts, drinks, side dishes, medications, and/or etc.) being subject to ingestion (e.g. including oral, dermal, nasal, and/or etc.) by the one or more particular individual living beings (e.g. including one or more humans, animals, and/or etc.), the selection information (e.g. including likes, dislikes, meal selection, and/or etc.) electronically received (e.g. including through the transceiver component s522, and/or etc.) via electronically enabled input (e.g. including voice, gesture, keypad, and/or etc.), the electronically receiving (e.g. including through transceiver component s522, and/or etc.) the user status information (e.g. including identification, associated location information, memberships, and/or etc.) and the electronically receiving (e.g. including through transceiver component s522, and/or etc.) the selection information (e.g. including ingestible materials desired, and/or etc.) at least in part to electronically obtain (e.g. including through data packets, and/or etc.) treatment instructional information (e.g. including methodology, preparation steps, and/or etc.) regarding one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) for one or more portions (e.g. including units, sections, randomized areas, items, isolated, preparation steps, and/or etc.) of one or more ingestible substrate structures (e.g. including bars, sheets, cylinders, spheroids, cuboids, polygons, and/or etc.). Furthermore, the receiving information electrical circuitry arrangement (“elec circ arrange”) f11 when activated will perform the operation p1101. Also, the receiving information ID card module n1101, when executed and/or activated, will direct performance of and/or performs the operation p11. In an implementation, the receiving information electrical circuitry arrangement f11, when activated performs electronically receiving (e.g. including the network cable component s502 carries information to the transceiver component s522, and/or etc.) user status information (e.g. including identification, characteristics, affiliations, and/or etc.) regarding one or more particular individual living beings (e.g. including one or more particular human beings, animals, and/or etc.) including one or more identifiers (e.g. including identification numbers, order numbers, passwords, biometric data such as voice prints, stored in information storage subsystem 200, and/or etc.) associated with the one or more particular individual living beings (e.g. including one or more humans, animals, and/or etc.) and electronically receiving (e.g. including through the receiver component s528, and/or etc.) selection information (e.g. including preferences, choices, and/or etc.) at least in part identifying (e.g. including textual descriptions, graphical representations, and/or etc.) one or more selected ingestible products (e.g. including sandwiches, snack bars, full course meals, deserts, drinks, side dishes, medications, and/or etc.) being subject to ingestion (e.g. including oral, dermal, nasal, and/or etc.) by the one or more particular individual living beings (e.g. including one or more humans, animals, and/or etc.), the selection information (e.g. including likes, dislikes, meal selection, and/or etc.) electronically received (e.g. including through the transceiver component s522, and/or etc.) via electronically enabled input (e.g. including voice, gesture, keypad, and/or etc.), the electronically receiving (e.g. including through transceiver component s522, and/or etc.) the user status information (e.g. including identification, associated location information, memberships, and/or etc.) and the electronically receiving (e.g. including through transceiver component s522, and/or etc.) the selection information (e.g. including ingestible materials desired, and/or etc.) at least in part to electronically obtain (e.g. including through data packets, and/or etc.) treatment instructional information (e.g. including methodology, preparation steps, and/or etc.) regarding one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) for one or more portions (e.g. including units, sections, randomized areas, items, isolated, preparation steps, and/or etc.) of one or more ingestible substrate structures (e.g. including bars, sheets, cylinders, spheroids, cuboids, polygons, and/or etc.). Also, the receiving information module n11, when executed and/or activated, will direct performance of and/or perform the operation p11. In an implementation, the electronically receiving user status information regarding one or more particular individual living beings including one or more identifiers associated with the one or more particular individual living beings and electronically receiving selection information at least in part identifying one or more selected ingestible products being subject to ingestion by the one or more particular individual living beings, the selection information electronically received via electronically enabled input, the electronically receiving the user status information and the electronically receiving the selection information at least in part to electronically obtain treatment instructional information regarding one or more subsequent ingestible substrate structure directed energy operations for one or more portions of one or more ingestible substrate structures is carried out by electronically receiving (e.g. including the network cable component s502 carries information to the transceiver component s522, and/or etc.) user status information (e.g. including identification, characteristics, affiliations, and/or etc.) regarding one or more particular individual living beings (e.g. including one or more particular human beings, animals, and/or etc.) including one or more identifiers (e.g. including identification numbers, order numbers, passwords, biometric data such as voice prints, stored in information storage subsystem 200, and/or etc.) associated with the one or more particular individual living beings (e.g. including one or more humans, animals, and/or etc.) and electronically receiving (e.g. including through the receiver component s528, and/or etc.) selection information (e.g. including preferences, choices, and/or etc.) at least in part identifying (e.g. including textual descriptions, graphical representations, and/or etc.) one or more selected ingestible products (e.g. including sandwiches, snack bars, full course meals, deserts, drinks, side dishes, medications, and/or etc.) being subject to ingestion (e.g. including oral, dermal, nasal, and/or etc.) by the one or more particular individual living beings (e.g. including one or more humans, animals, and/or etc.), the selection information (e.g. including likes, dislikes, meal selection, and/or etc.) electronically received (e.g. including through the transceiver component s522, and/or etc.) via electronically enabled input (e.g. including voice, gesture, keypad, and/or etc.), the electronically receiving (e.g. including through transceiver component s522, and/or etc.) the user status information (e.g. including identification, associated location information, memberships, and/or etc.) and the electronically receiving (e.g. including through transceiver component s522, and/or etc.) the selection information (e.g. including ingestible materials desired, and/or etc.) at least in part to electronically obtain (e.g. including through data packets, and/or etc.) treatment instructional information (e.g. including methodology, preparation steps, and/or etc.) regarding one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) for one or more portions (e.g. including units, sections, randomized areas, items, isolated, preparation steps, and/or etc.) of one or more ingestible substrate structures (e.g. including bars, sheets, cylinders, spheroids, cuboids, polygons, and/or etc.).

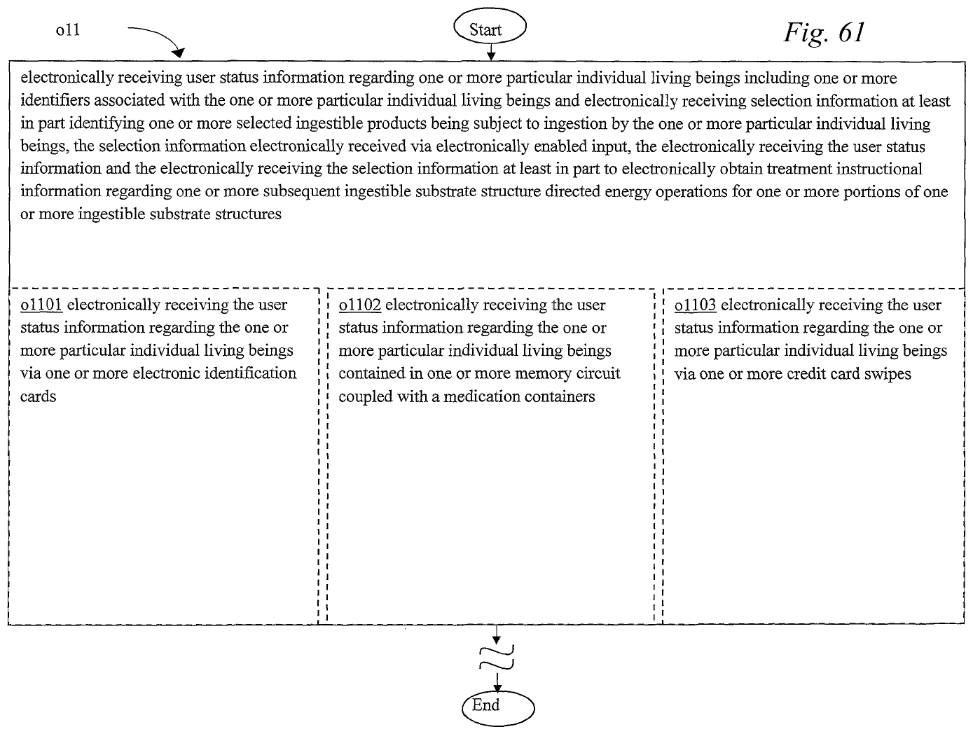

In one or more implementations, as shown in FIG. 61, operation p11 includes an operation p1101 for electronically receiving the user status information regarding the one or more particular individual living beings via one or more electronic identification cards. Origination of an illustratively derived receiving information ID card component group can be accomplished through skilled in the art design choice selection of one or more of the above depicted components from one or more of the above depicted subsystems shown in FIG. 51. Components from the receiving information ID card component group can be used in implementing execution of the one or more receiving information ID card instructions j1101 of FIG. 46, can be used in performance of the receiving information ID card electrical circuitry arrangement f1101 of FIG. 50, and/or can be used in otherwise fulfillment of the operation p1101. An exemplary non-transitory signal bearing medium version of the information storage subsystem s200 is depicted in FIG. 46 as bearing the one or more receiving information ID card instructions j1101 that when executed will direct performance of the operation p1101. Furthermore, the receiving information ID card electrical circuitry arrangement (“elec circ arrange”) f1101, when activated, will perform the operation p1101. Also, the receiving information ID card module n1101, when executed and/or activated, will direct performance of and/or perform the operation p1101. For instance, in one or more exemplary implementations, the one or more receiving information ID card instructions j1101, when executed, direct performance of the operation p1101 in the illustrative depiction as follows, and/or the receiving information ID card electrical circuitry arrangement f1101, when activated, performs the operation p1101 in the illustrative depiction as follows, and/or the receiving information ID card module n1101, when executed and/or activated, directs performance of and/or performs the operation p1101 in the illustrative depiction as follows, and/or the operation p1101 is otherwise carried out in the illustrative depiction as follows: electronically receiving the user status information regarding the one or more particular individual living beings via one or more electronic identification cards (e.g. including an implementation of the receiver component s528 is configured to electronically engage with a card having memory storage holding the user status information, and/or etc.).

In one or more implementations, as shown in FIG. 61, operation p11 includes an operation p1102 for electronically receiving the user status information regarding the one or more particular individual living beings contained in one or more memory circuit coupled with a medication containers. Origination of an illustratively derived receiving information memory component group can be accomplished through skilled in the art design choice selection of one or more of the above depicted components from one or more of the above depicted subsystems shown in FIG. 51. Components from the receiving information memory component group can be used in implementing execution of the one or more receiving information memory instructions j1102 of FIG. 46, can be used in performance of the receiving information memory electrical circuitry arrangement f1102 of FIG. 50, and/or can be used in otherwise fulfillment of the operation p1102. An exemplary non-transitory signal bearing medium version of the information storage subsystem s200 is depicted in FIG. 46 as bearing the one or more receiving information memory instructions j1102 that when executed will direct performance of the operation p1102. Furthermore, the receiving information memory electrical circuitry arrangement (“elec circ arrange”) f1102, when activated, will perform the operation p1102. Also, the receiving information memory module n1102, when executed and/or activated, will direct performance of and/or perform the operation p1102. For instance, in one or more exemplary implementations, the one or more receiving information memory instructions j1102, when executed, direct performance of the operation p1102 in the illustrative depiction as follows, and/or the receiving information memory electrical circuitry arrangement f1102, when activated, performs the operation p1102 in the illustrative depiction as follows, and/or the receiving information memory module n1102, when executed and/or activated, directs performance of and/or performs the operation p1102 in the illustrative depiction as follows, and/or the operation p1102 is otherwise carried out in the illustrative depiction as follows: electronically receiving the user status information regarding the one or more particular individual living beings contained in one or more memory circuit (e.g. including RAM component s202, and/or etc.) coupled with a medication containers (e.g. including an implementation of the receiver component s528 is configured to electronically engage with a memory storage coupled with a medication container to receive the user status information in electronic form, and/or etc.).

In one or more implementations, as shown in FIG. 61, operation p11 includes an operation p1103 for electronically receiving the user status information regarding the one or more particular individual living beings via one or more credit card swipes. Origination of an illustratively derived receiving information credit card component group can be accomplished through skilled in the art design choice selection of one or more of the above depicted components from one or more of the above depicted subsystems shown in FIG. 51. Components from the receiving information credit card component group can be used in implementing execution of the one or more receiving information credit card instructions j1103 of FIG. 46, can be used in performance of the receiving information credit card electrical circuitry arrangement f1103 of FIG. 50, and/or can be used in otherwise fulfillment of the operation p1103. An exemplary non-transitory signal bearing medium version of the information storage subsystem s200 is depicted in FIG. 46 as bearing the one or more receiving information credit card instructions j1103 that when executed will direct performance of the operation p1103. Furthermore, the receiving information credit card electrical circuitry arrangement (“elec circ arrange”) f1103, when activated, will perform the operation p1103. Also, the receiving information credit card module n1103, when executed and/or activated, will direct performance of and/or perform the operation p1103. For instance, in one or more exemplary implementations, the one or more receiving information credit card instructions j1103, when executed, direct performance of the operation p1103 in the illustrative depiction as follows, and/or the receiving information credit card electrical circuitry arrangement f1103, when activated, performs the operation p1103 in the illustrative depiction as follows, and/or the receiving information credit card module n1103, when executed and/or activated, directs performance of and/or performs the operation p1103 in the illustrative depiction as follows, and/or the operation p1103 is otherwise carried out in the illustrative depiction as follows: electronically receiving the user status information regarding the one or more particular individual living beings via one or more credit card swipes (e.g. including an implementation of the receiver component s528 is configured to electronically engage with an electronic memory stripe integrated into a credit card to receive the user status information, and/or etc.).

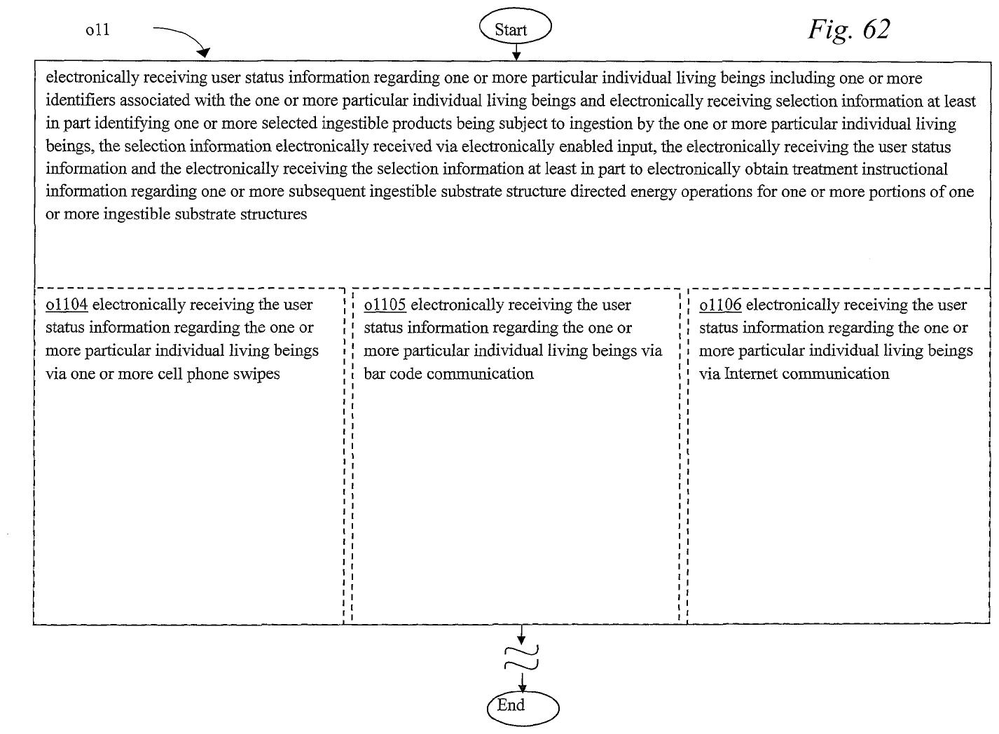

In one or more implementations, as shown in FIG. 62, operation p11 includes an operation p1104 for electronically receiving the user status information regarding the one or more particular individual living beings via one or more cell phone swipes. Origination of an illustratively derived receiving information cell phone component group can be accomplished through skilled in the art design choice selection of one or more of the above depicted components from one or more of the above depicted subsystems shown in FIG. 51. Components from the receiving information cell phone component group can be used in implementing execution of the one or more receiving information cell phone instructions j1104 of FIG. 46, can be used in performance of the receiving information cell phone electrical circuitry arrangement f1104 of FIG. 50, and/or can be used in otherwise fulfillment of the operation p1104. An exemplary non-transitory signal bearing medium version of the information storage subsystem s200 is depicted in FIG. 46 as bearing the one or more receiving information cell phone instructions j1104 that when executed will direct performance of the operation p1104. Furthermore, the receiving information cell phone electrical circuitry arrangement (“elec circ arrange”) f1104, when activated, will perform the operation p1104. Also, the receiving information cell phone module n1104, when executed and/or activated, will direct performance of and/or perform the operation p1104. For instance, in one or more exemplary implementations, the one or more receiving information cell phone instructions j1104, when executed, direct performance of the operation p1104 in the illustrative depiction as follows, and/or the receiving information cell phone electrical circuitry arrangement f1104, when activated, performs the operation p1104 in the illustrative depiction as follows, and/or the receiving information cell phone module n1104, when executed and/or activated, directs performance of and/or performs the operation p1104 in the illustrative depiction as follows, and/or the operation p1104 is otherwise carried out in the illustrative depiction as follows: electronically receiving the user status information regarding the one or more particular individual living beings via one or more cell phone swipes (e.g. including an implementation of the receiver component s528 is configured to electronically engage with an electronic memory component integrated into a cell phone to receive the user status information, and/or etc.).

In one or more implementations, as shown in FIG. 62, operation p11 includes an operation p1105 for electronically receiving the user status information regarding the one or more particular individual living beings via bar code communication. Origination of an illustratively derived receiving information bar code component group can be accomplished through skilled in the art design choice selection of one or more of the above depicted components from one or more of the above depicted subsystems shown in FIG. 51. Components from the receiving information bar code component group can be used in implementing execution of the one or more receiving information bar code instructions j1105 of FIG. 46, can be used in performance of the receiving information bar code electrical circuitry arrangement f1105 of FIG. 50, and/or can be used in otherwise fulfillment of the operation p1105. An exemplary non-transitory signal bearing medium version of the information storage subsystem s200 is depicted in FIG. 46 as bearing the one or more receiving information bar code instructions j1105 that when executed will direct performance of the operation p1105. Furthermore, the receiving information bar code electrical circuitry arrangement (“elec circ arrange”) f1105, when activated, will perform the operation p1105. Also, the receiving information bar code module n1105, when executed and/or activated, will direct performance of and/or perform the operation p1105. For instance, in one or more exemplary implementations, the one or more receiving information bar code instructions j1105, when executed, direct performance of the operation p1105 in the illustrative depiction as follows, and/or the receiving information bar code electrical circuitry arrangement f1105, when activated, performs the operation p1105 in the illustrative depiction as follows, and/or the receiving information bar code module n1105, when executed and/or activated, directs performance of and/or performs the operation p1105 in the illustrative depiction as follows, and/or the operation p1105 is otherwise carried out in the illustrative depiction as follows: electronically receiving the user status information regarding the one or more particular individual living beings via bar code communication (e.g. including an implementation of the receiver component s528 is configured to electronically read a bar code label to receive the user status information, and/or etc.).

In one or more implementations, as shown in FIG. 62, operation p11 includes an operation p1106 for electronically receiving the user status information regarding the one or more particular individual living beings via Internet communication. Origination of an illustratively derived receiving information Internet component group can be accomplished through skilled in the art design choice selection of one or more of the above depicted components from one or more of the above depicted subsystems shown in FIG. 51. Components from the receiving information Internet component group can be used in implementing execution of the one or more receiving information Internet instructions j1106 of FIG. 46, can be used in performance of the receiving information Internet electrical circuitry arrangement f1106 of FIG. 50, and/or can be used in otherwise fulfillment of the operation p1106. An exemplary non-transitory signal bearing medium version of the information storage subsystem s200 is depicted in FIG. 46 as bearing the one or more receiving information Internet instructions j1106 that when executed will direct performance of the operation p1106. Furthermore, the receiving information Internet electrical circuitry arrangement (“elec circ arrange”) f1106, when activated, will perform the operation p1106. Also, the receiving information Internet module n1106, when executed and/or activated, will direct performance of and/or perform the operation p1106. For instance, in one or more exemplary implementations, the one or more receiving information Internet instructions j1106, when executed, direct performance of the operation p1106 in the illustrative depiction as follows, and/or the receiving information Internet electrical circuitry arrangement f1106, when activated, performs the operation p1106 in the illustrative depiction as follows, and/or the receiving information Internet module n1106, when executed and/or activated, directs performance of and/or performs the operation p1106 in the illustrative depiction as follows, and/or the operation p1106 is otherwise carried out in the illustrative depiction as follows: electronically receiving the user status information regarding the one or more particular individual living beings via Internet communication (e.g. including an implementation of the receiver component s528 is configured to electronically receive through the internet network component s508 the user status information, and/or etc.).

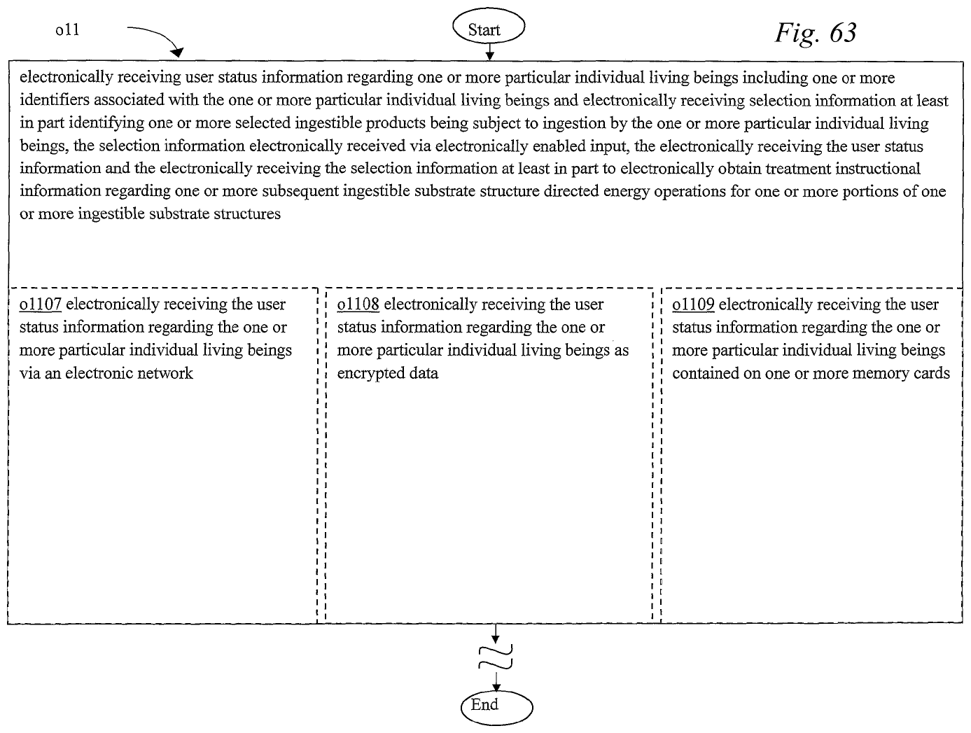

In one or more implementations, as shown in FIG. 63, operation p11 includes an operation p1107 for electronically receiving the user status information regarding the one or more particular individual living beings via an electronic network. Origination of an illustratively derived receiving information network component group can be accomplished through skilled in the art design choice selection of one or more of the above depicted components from one or more of the above depicted subsystems shown in FIG. 51. Components from the receiving information network component group can be used in implementing execution of the one or more receiving information network instructions j1107 of FIG. 46, can be used in performance of the receiving information network electrical circuitry arrangement f1107 of FIG. 50, and/or can be used in otherwise fulfillment of the operation p1107. An exemplary non-transitory signal bearing medium version of the information storage subsystem s200 is depicted in FIG. 46 as bearing the one or more receiving information network instructions j1107 that when executed will direct performance of the operation p1107. Furthermore, the receiving information network electrical circuitry arrangement (“elec circ arrange”) f1107, when activated, will perform the operation p1107. Also, the receiving information network module n1107, when executed and/or activated, will direct performance of and/or perform the operation p1107. For instance, in one or more exemplary implementations, the one or more receiving information network instructions j1107, when executed, direct performance of the operation p1107 in the illustrative depiction as follows, and/or the receiving information network electrical circuitry arrangement f1107, when activated, performs the operation p1107 in the illustrative depiction as follows, and/or the receiving information network module n1107, when executed and/or activated, directs performance of and/or performs the operation p1107 in the illustrative depiction as follows, and/or the operation p1107 is otherwise carried out in the illustrative depiction as follows: electronically receiving the user status information regarding the one or more particular individual living beings via an electronic network (e.g. including an implementation of the receiver component s528 is configured to electronically engage with the network cable component s502 to receive the user status information, and/or etc.).

In one or more implementations, as shown in FIG. 63, operation p11 includes an operation p1108 for electronically receiving the user status information regarding the one or more particular individual living beings as encrypted data. Origination of an illustratively derived receiving encrypted information component group can be accomplished through skilled in the art design choice selection of one or more of the above depicted components from one or more of the above depicted subsystems shown in FIG. 51. Components from the receiving encrypted information component group can be used in implementing execution of the one or more receiving encrypted information instructions j1108 of FIG. 46, can be used in performance of the receiving encrypted information electrical circuitry arrangement f1108 of FIG. 50, and/or can be used in otherwise fulfillment of the operation p1108. An exemplary non-transitory signal bearing medium version of the information storage subsystem s200 is depicted in FIG. 46 as bearing the one or more receiving encrypted information instructions j1108 that when executed will direct performance of the operation p1108. Furthermore, the receiving encrypted information electrical circuitry arrangement (“elec circ arrange”) f1108, when activated, will perform the operation p1108. Also, the receiving encrypted information module n1108, when executed and/or activated, will direct performance of and/or perform the operation p1108. For instance, in one or more exemplary implementations, the one or more receiving encrypted information instructions j1108, when executed, direct performance of the operation p1108 in the illustrative depiction as follows, and/or the receiving encrypted information electrical circuitry arrangement f1108, when activated, performs the operation p1108 in the illustrative depiction as follows, and/or the receiving encrypted information module n1108, when executed and/or activated, directs performance of and/or performs the operation p1108 in the illustrative depiction as follows, and/or the operation p1108 is otherwise carried out in the illustrative depiction as follows: electronically receiving the user status information regarding the one or more particular individual living beings as encrypted data (e.g. including an implementation of the receiver component s528 is configured to electronically receive through the encrypted communication component s520 the user status information, and/or etc.).

In one or more implementations, as shown in FIG. 63, operation p11 includes an operation p1109 for electronically receiving the user status information regarding the one or more particular individual living beings contained on one or more memory cards. Origination of an illustratively derived receiving information memory card component group can be accomplished through skilled in the art design choice selection of one or more of the above depicted components from one or more of the above depicted subsystems shown in FIG. 51. Components from the receiving information memory card component group can be used in implementing execution of the one or more receiving information memory card instructions j1109 of FIG. 46, can be used in performance of the receiving information memory card electrical circuitry arrangement f1109 of FIG. 50, and/or can be used in otherwise fulfillment of the operation p1109. An exemplary non-transitory signal bearing medium version of the information storage subsystem s200 is depicted in FIG. 46 as bearing the one or more receiving information memory card instructions j1109 that when executed will direct performance of the operation p1109. Furthermore, the receiving information memory card electrical circuitry arrangement (“elec circ arrange”) f1109, when activated, will perform the operation p1109. Also, the receiving information memory card module n1109, when executed and/or activated, will direct performance of and/or perform the operation p1109. For instance, in one or more exemplary implementations, the one or more receiving information memory card instructions j1109, when executed, direct performance of the operation p1109 in the illustrative depiction as follows, and/or the receiving information memory card electrical circuitry arrangement f1109, when activated, performs the operation p1109 in the illustrative depiction as follows, and/or the receiving information memory card module n1109, when executed and/or activated, directs performance of and/or performs the operation p1109 in the illustrative depiction as follows, and/or the operation p1109 is otherwise carried out in the illustrative depiction as follows: electronically receiving the user status information regarding the one or more particular individual living beings contained on one or more memory cards (e.g. including an implementation of the receiver component s528 is configured to electronically engage with an electronic memory card to receive the user status information, and/or etc.).

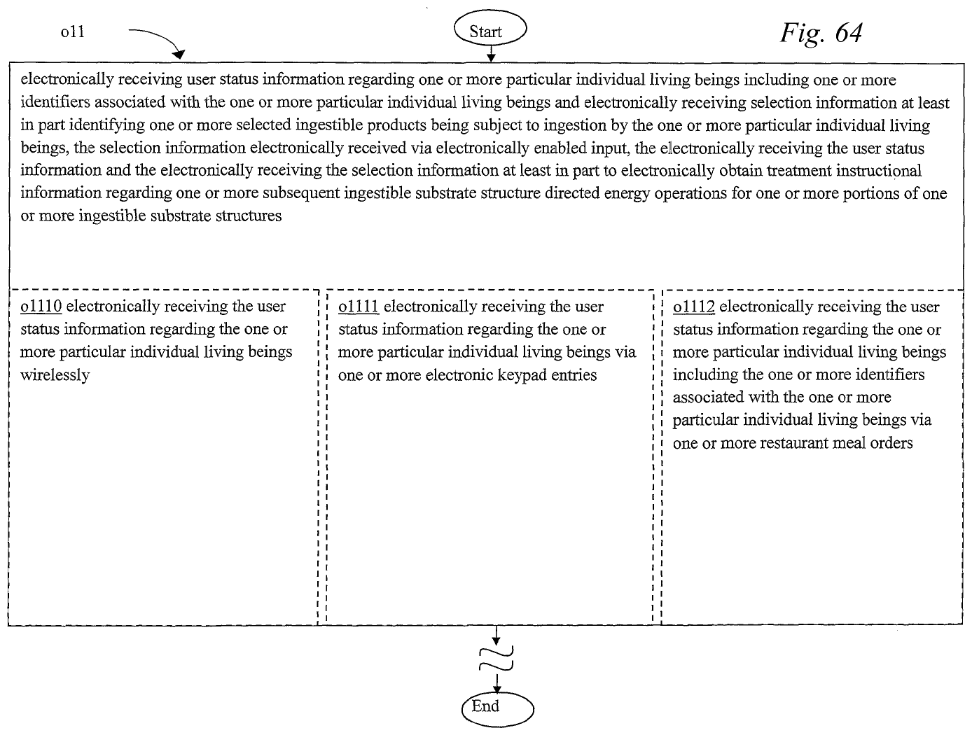

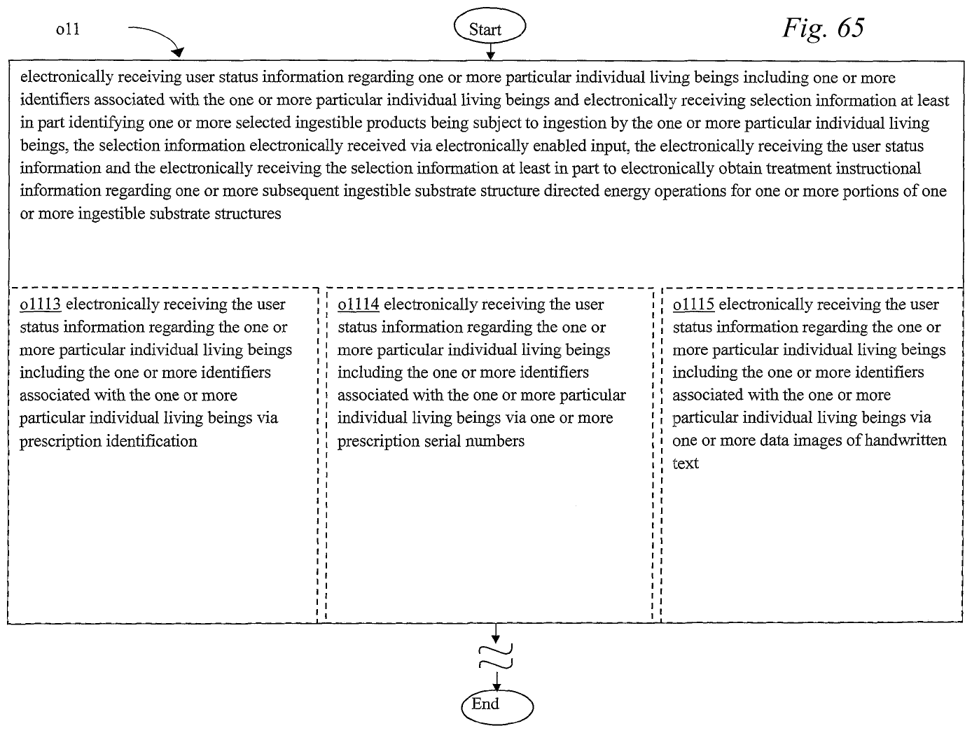

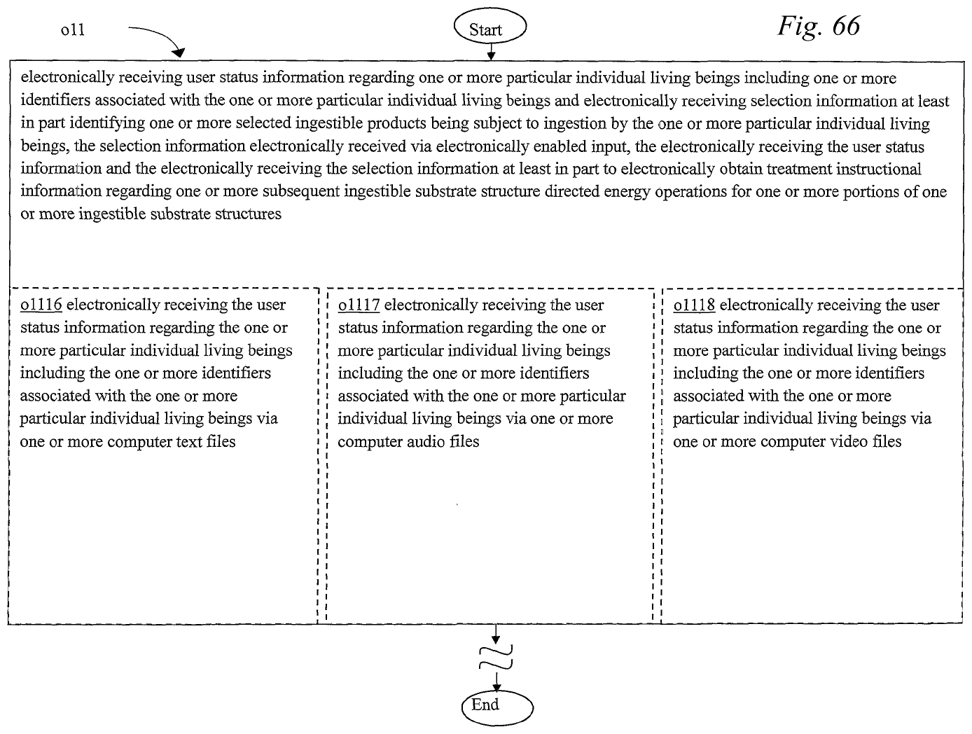

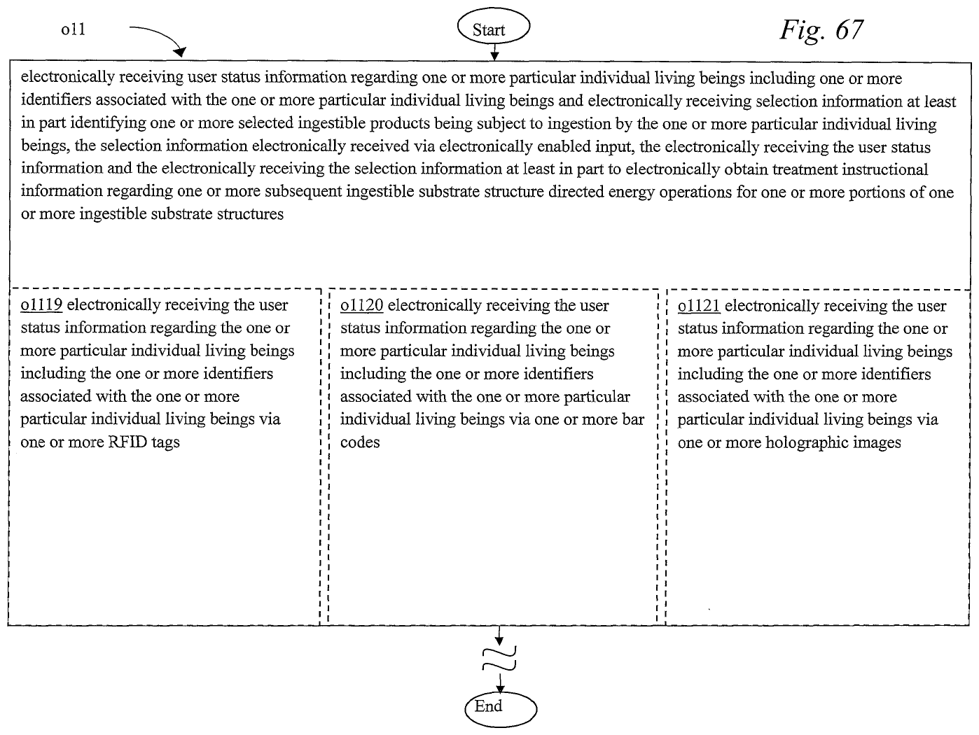

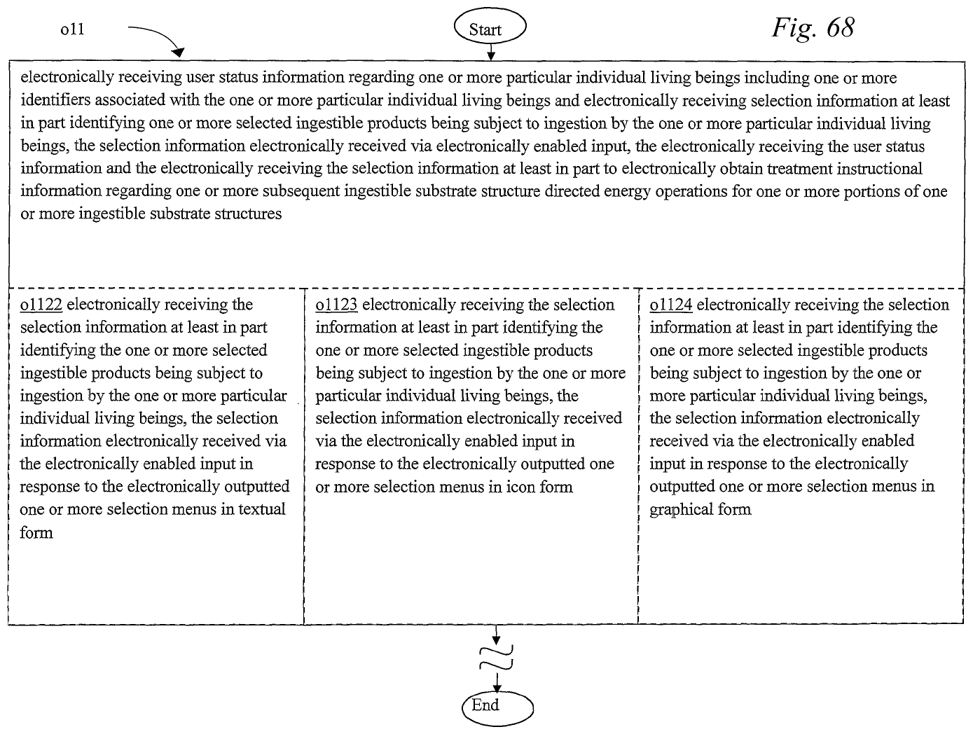

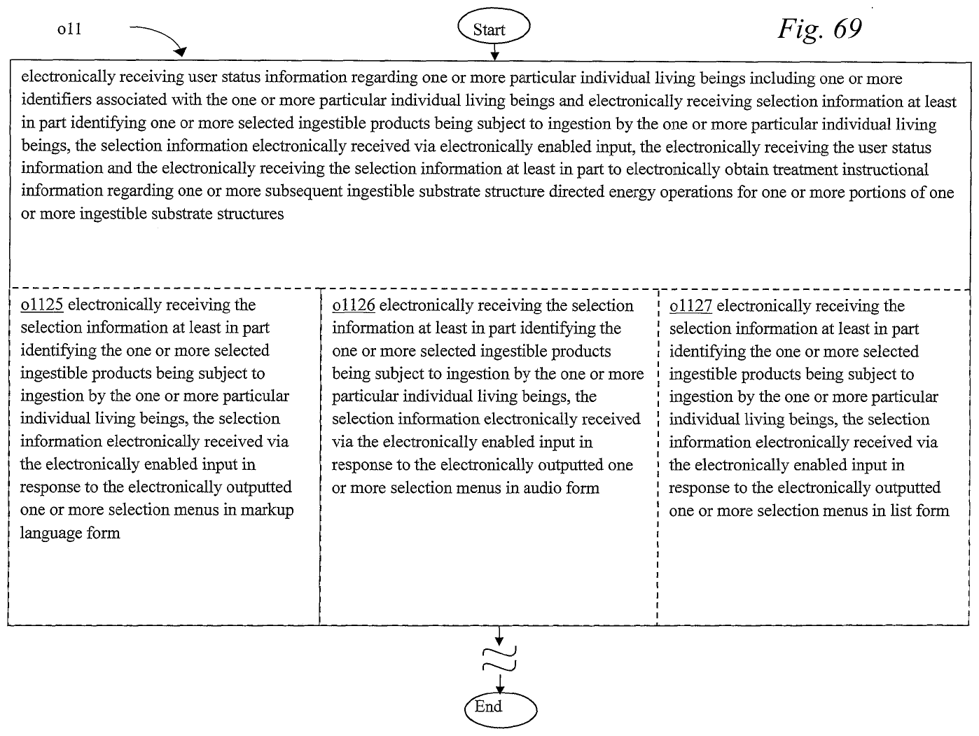

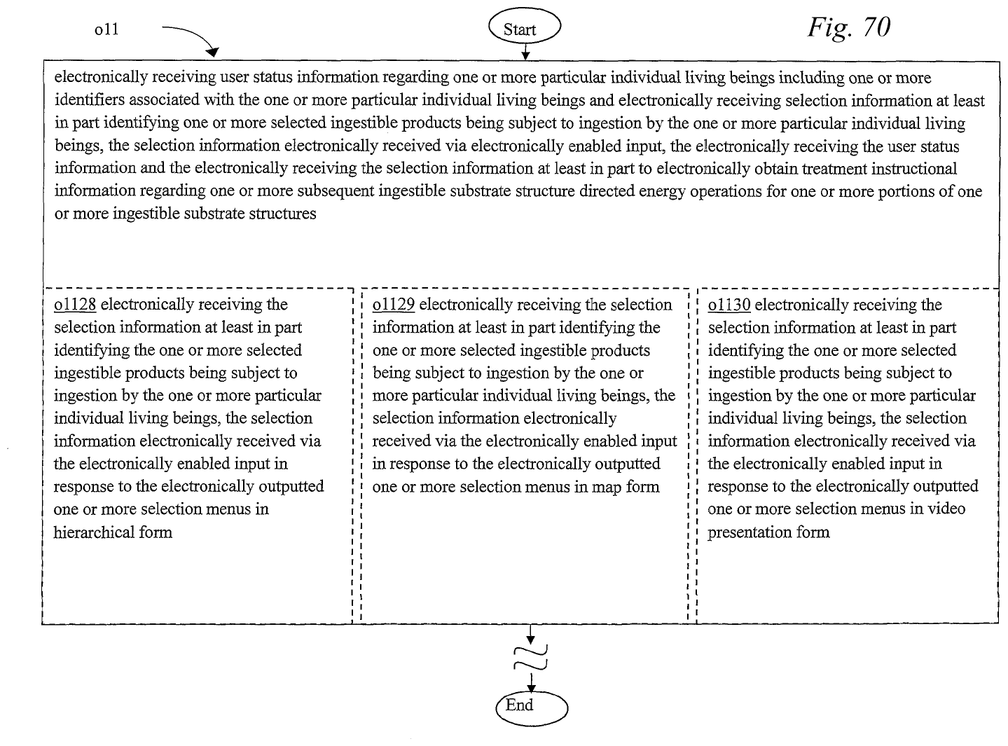

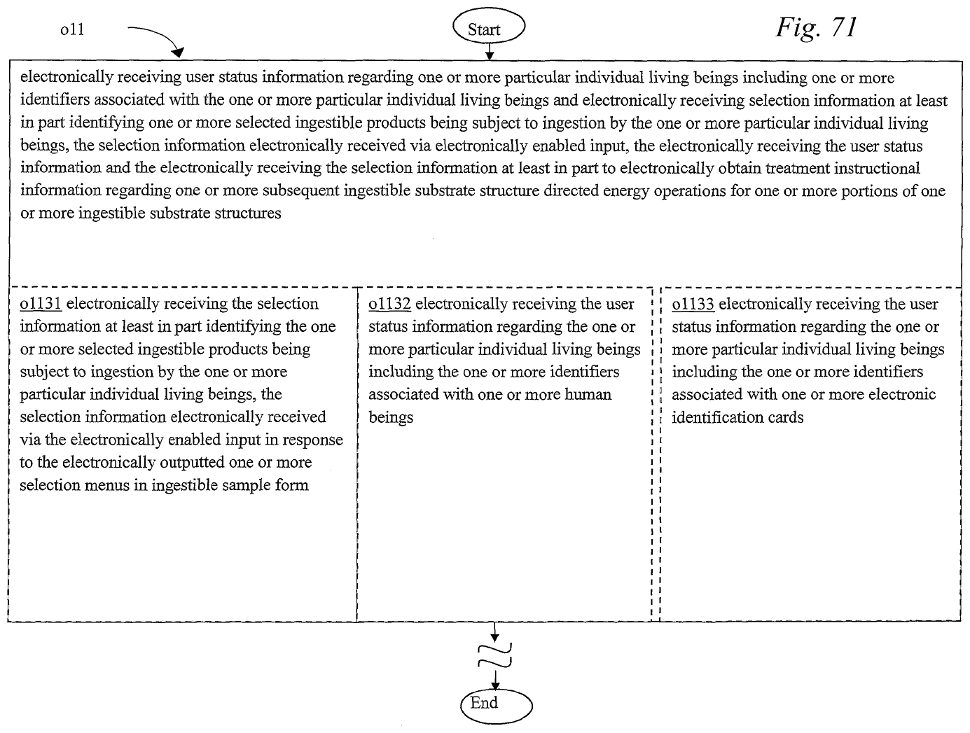

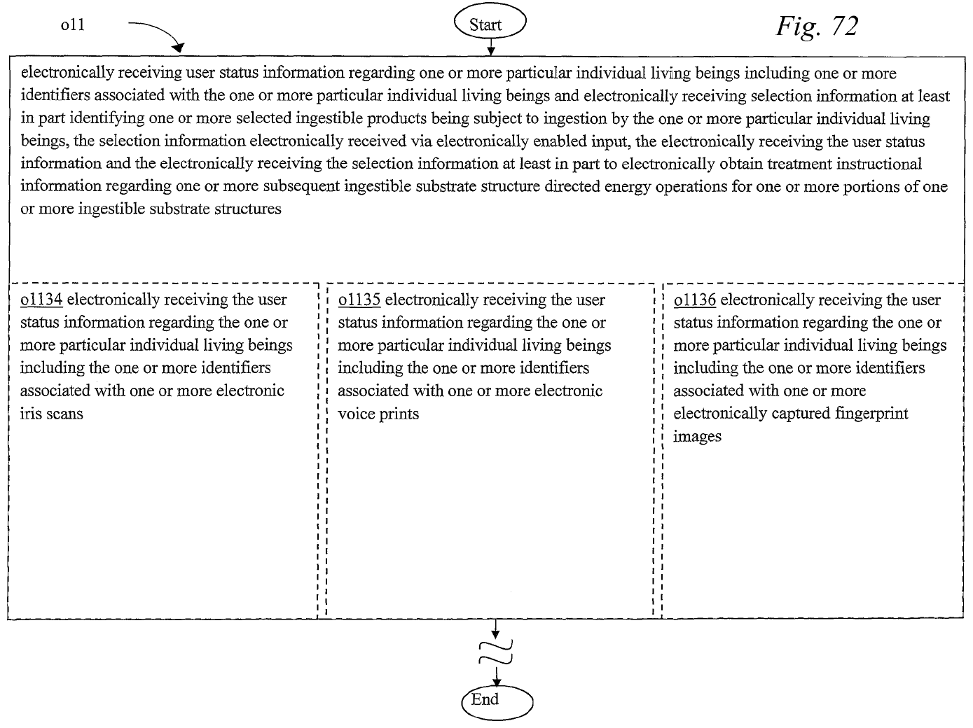

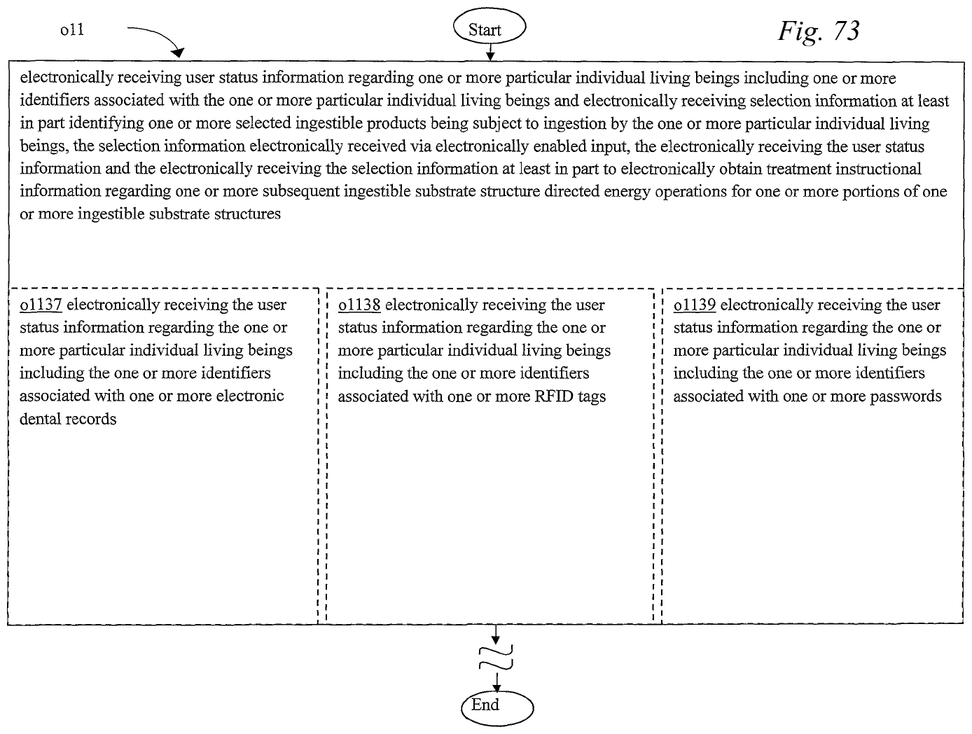

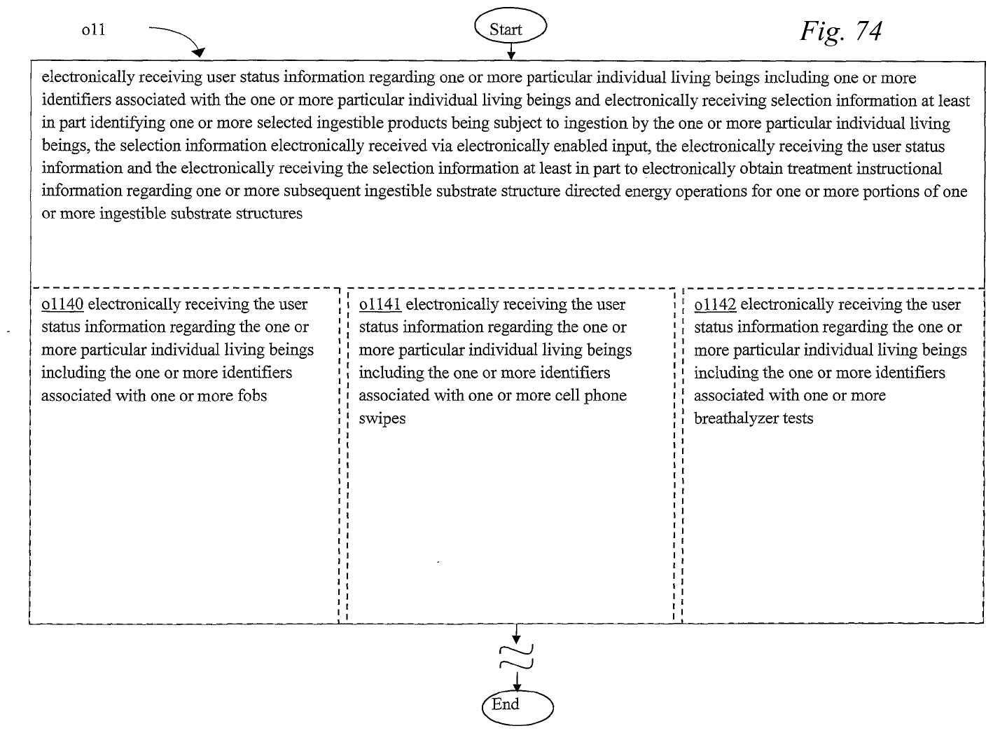

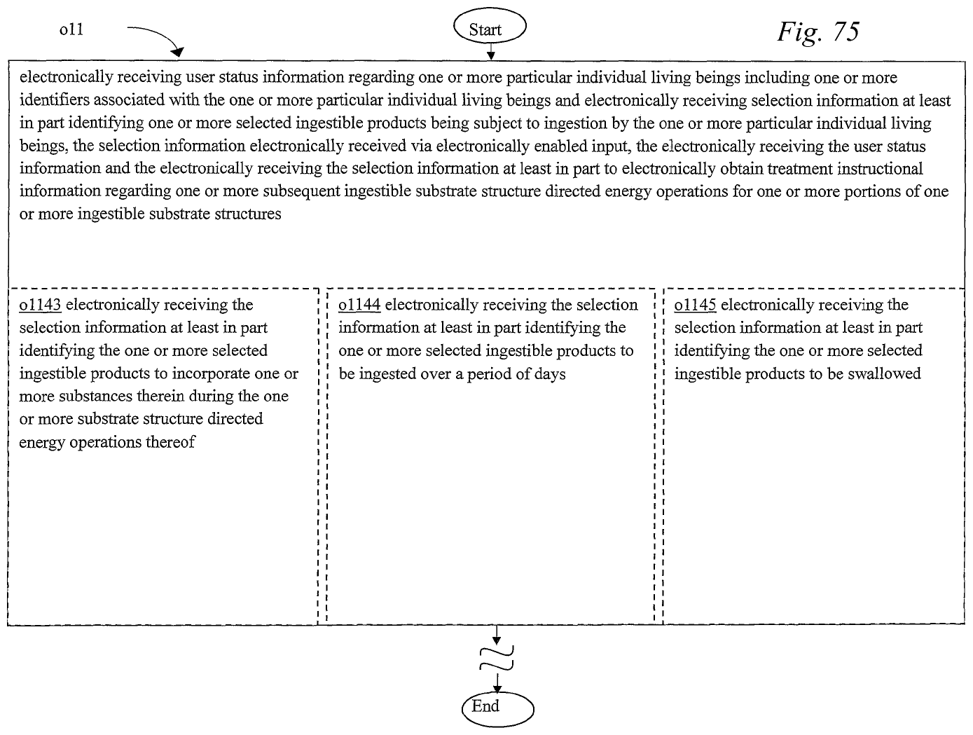

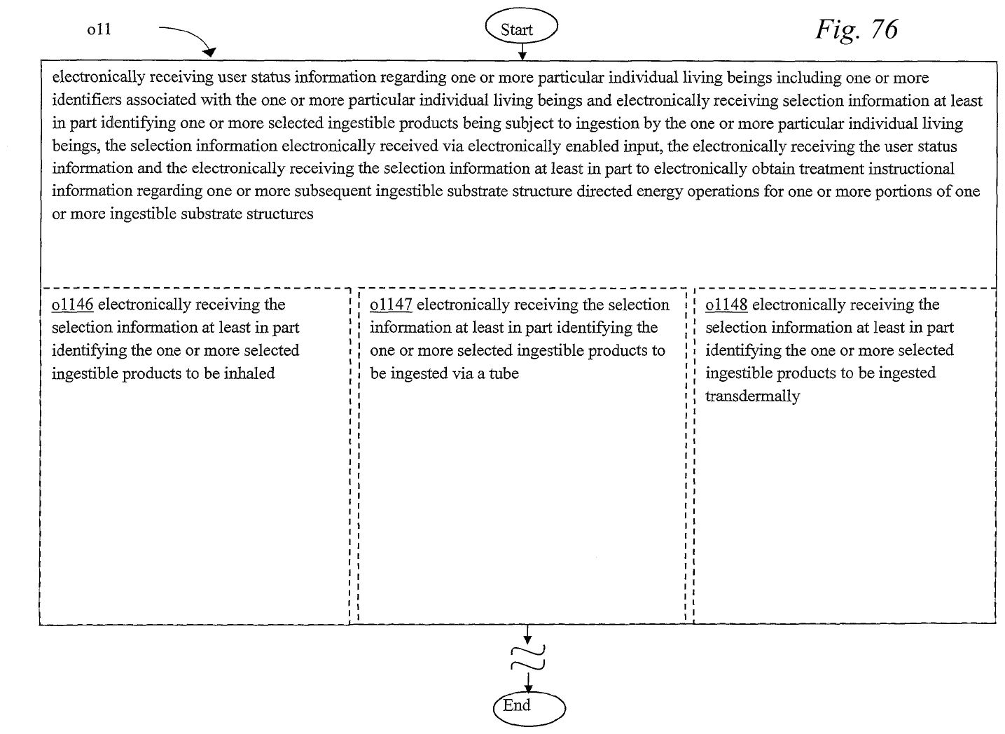

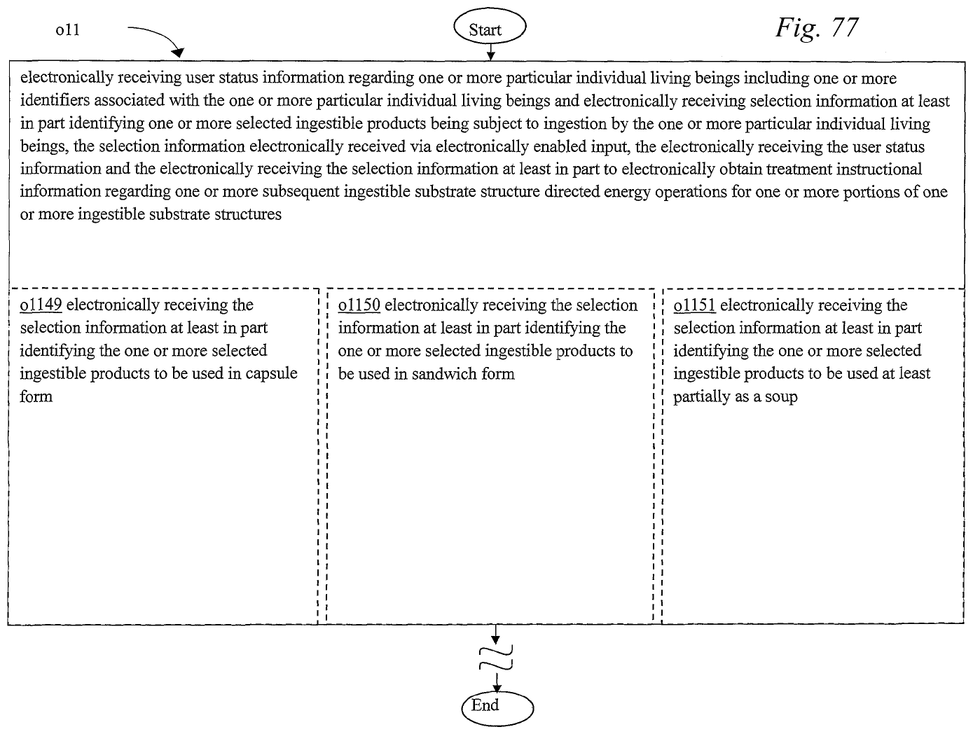

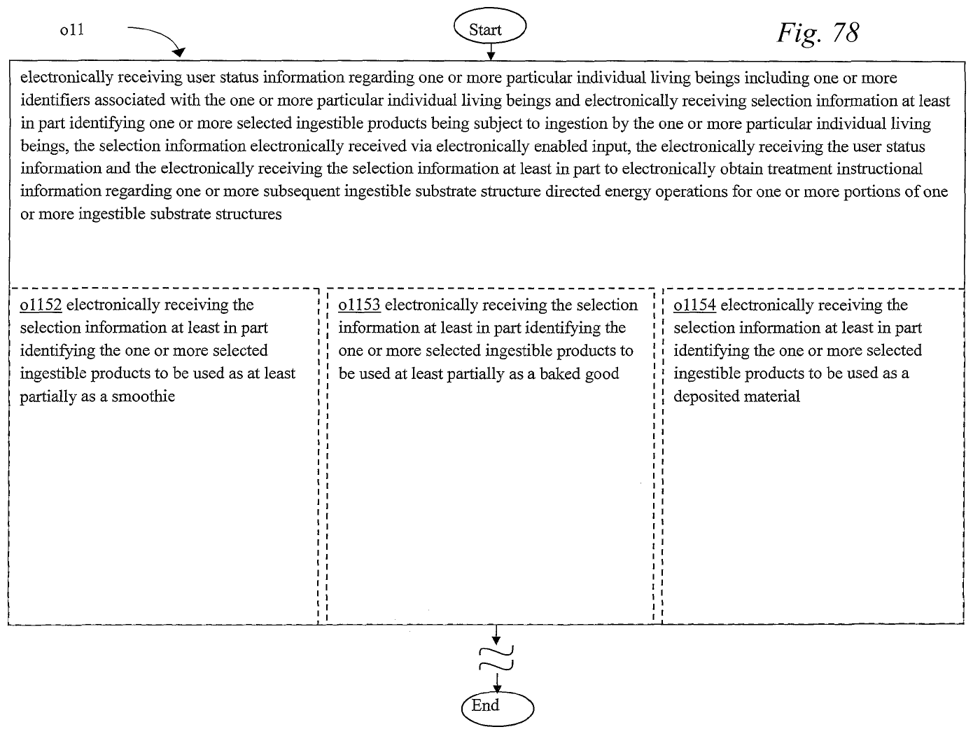

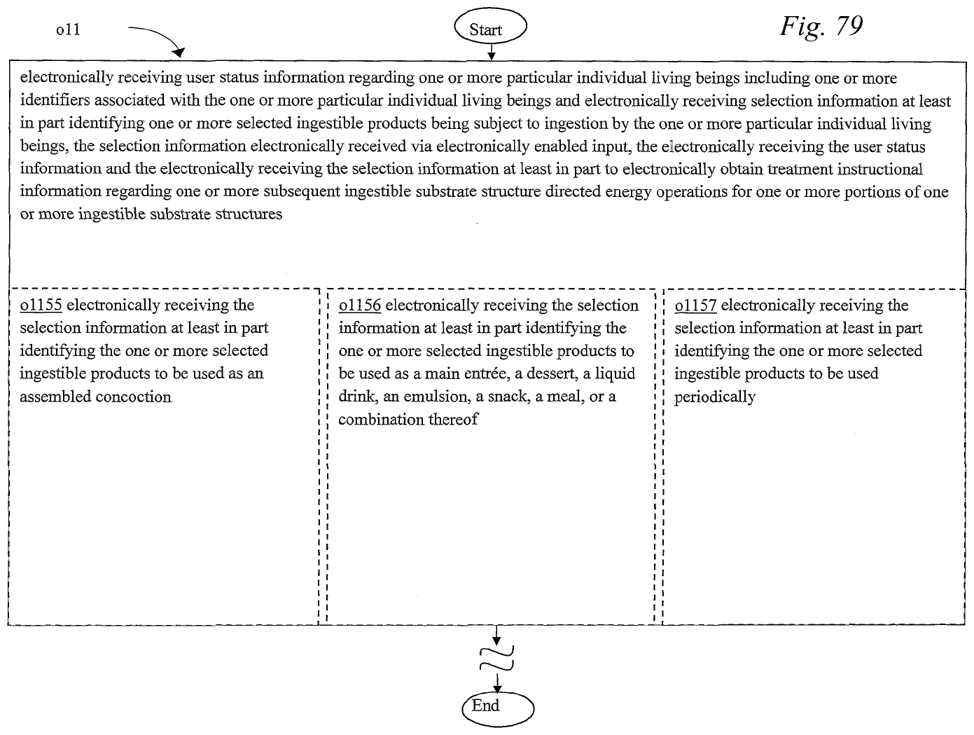

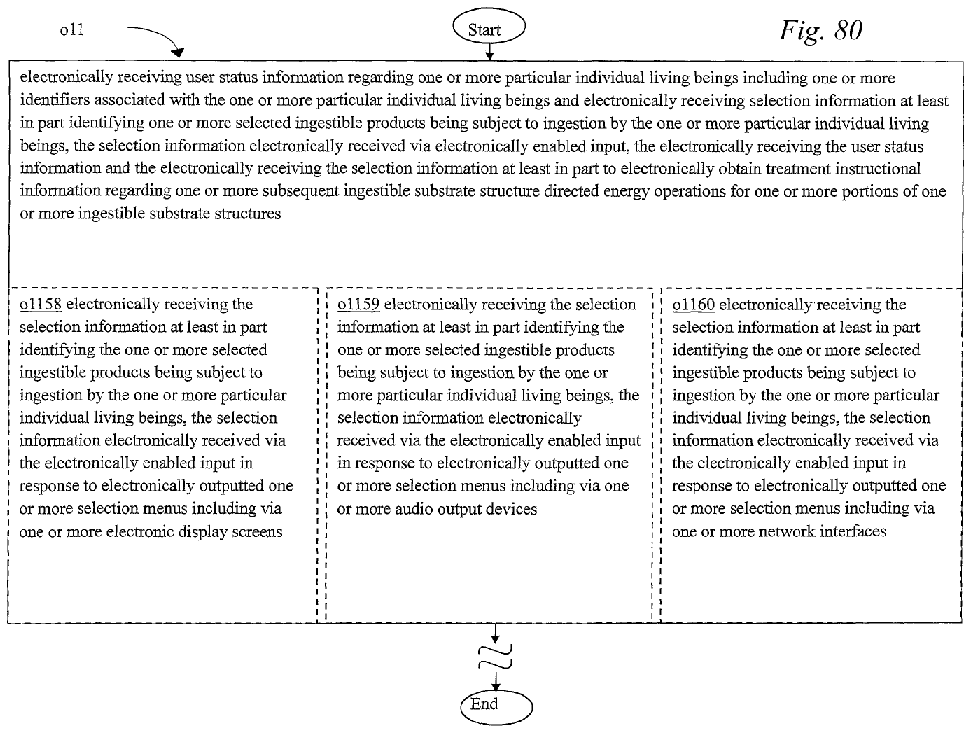

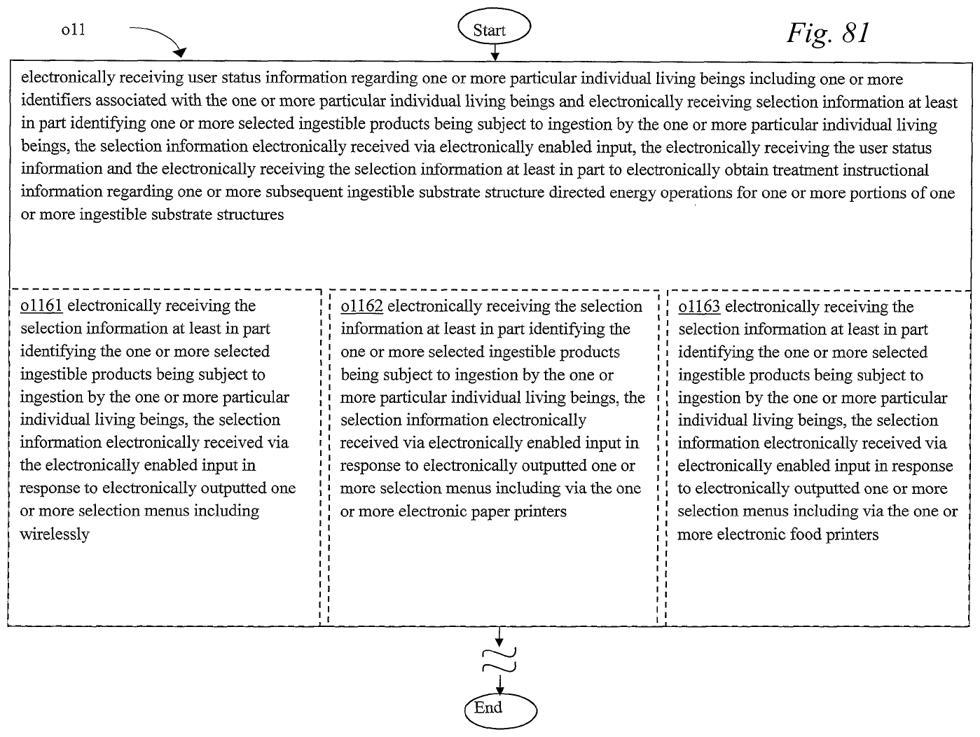

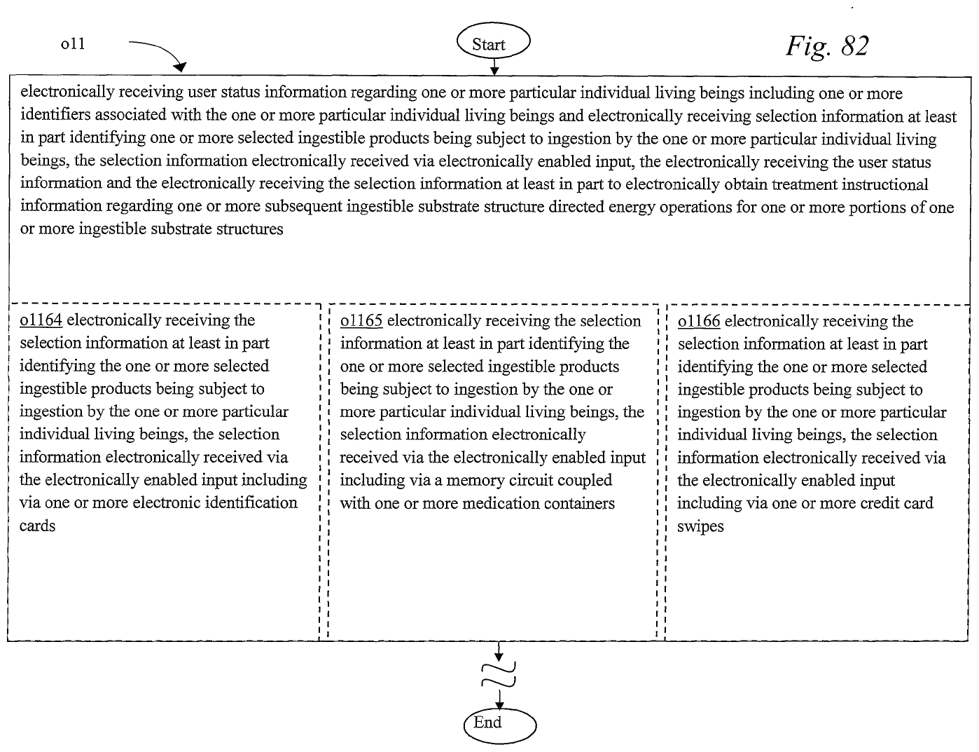

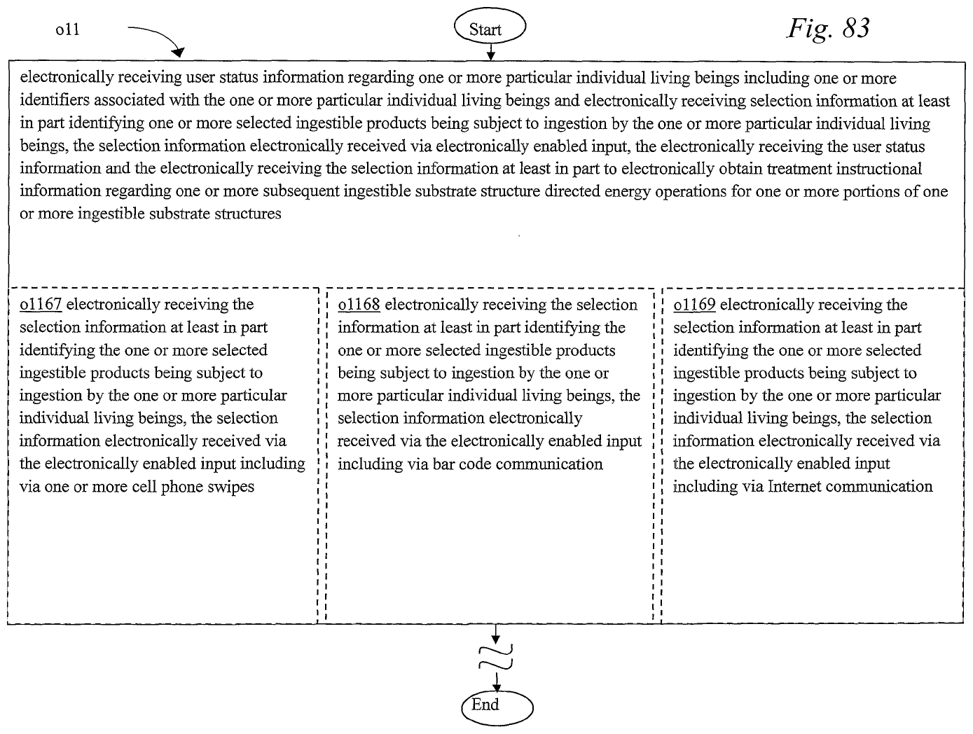

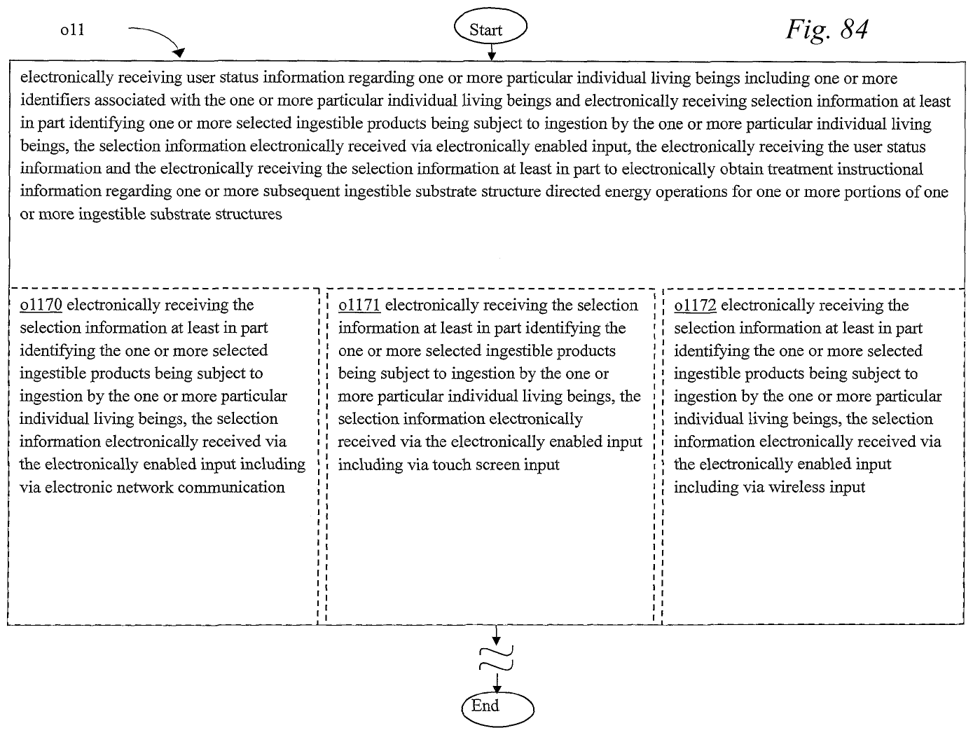

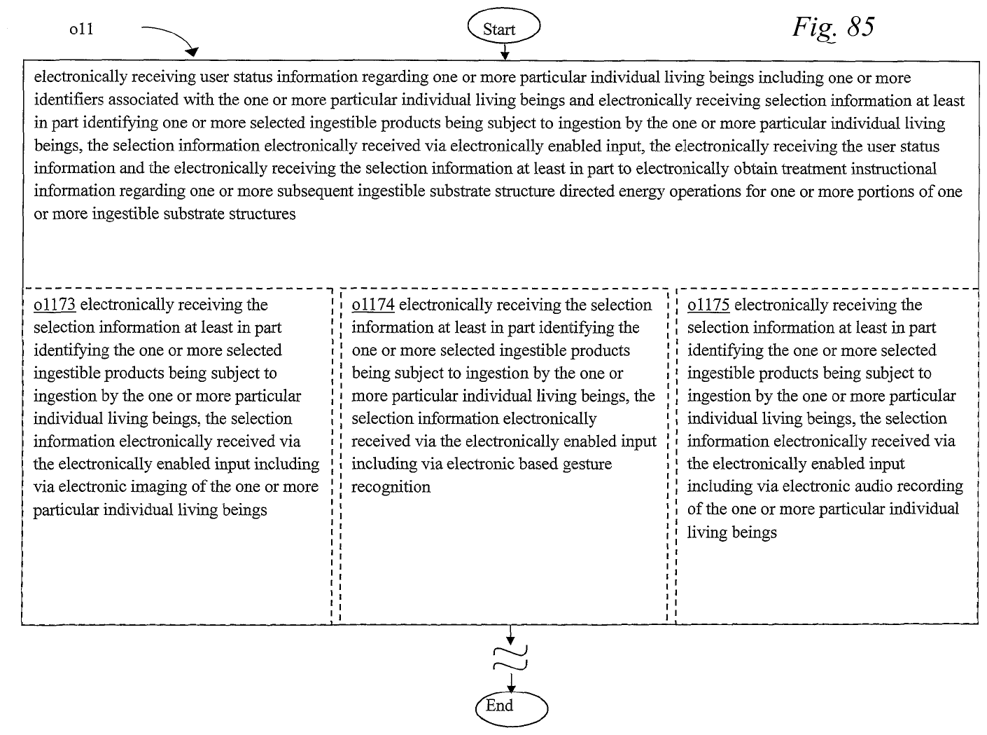

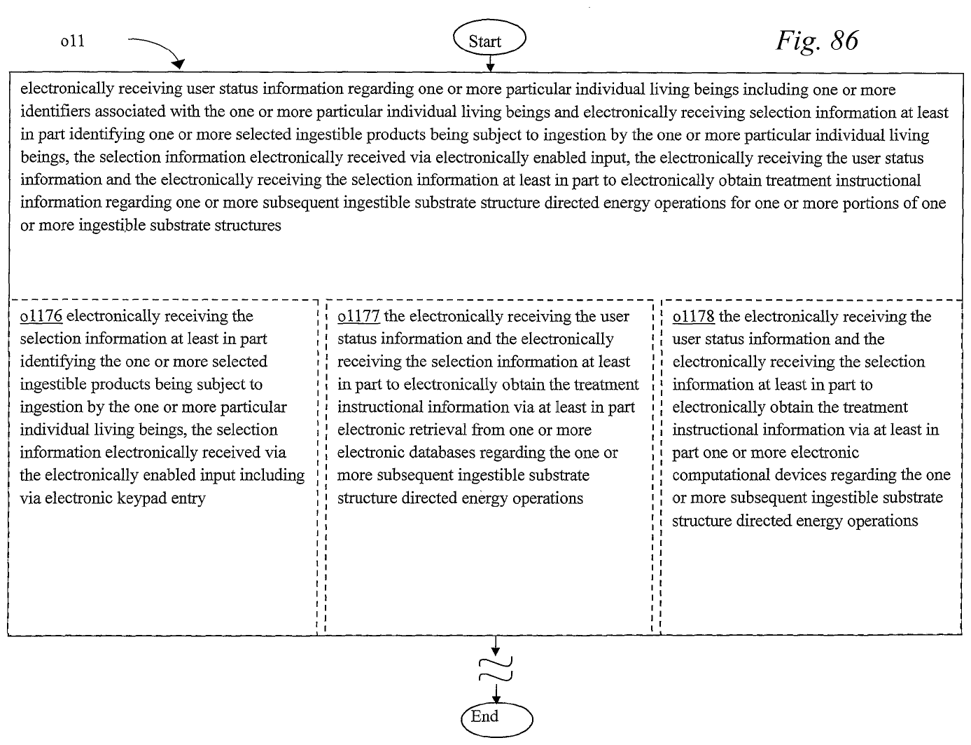

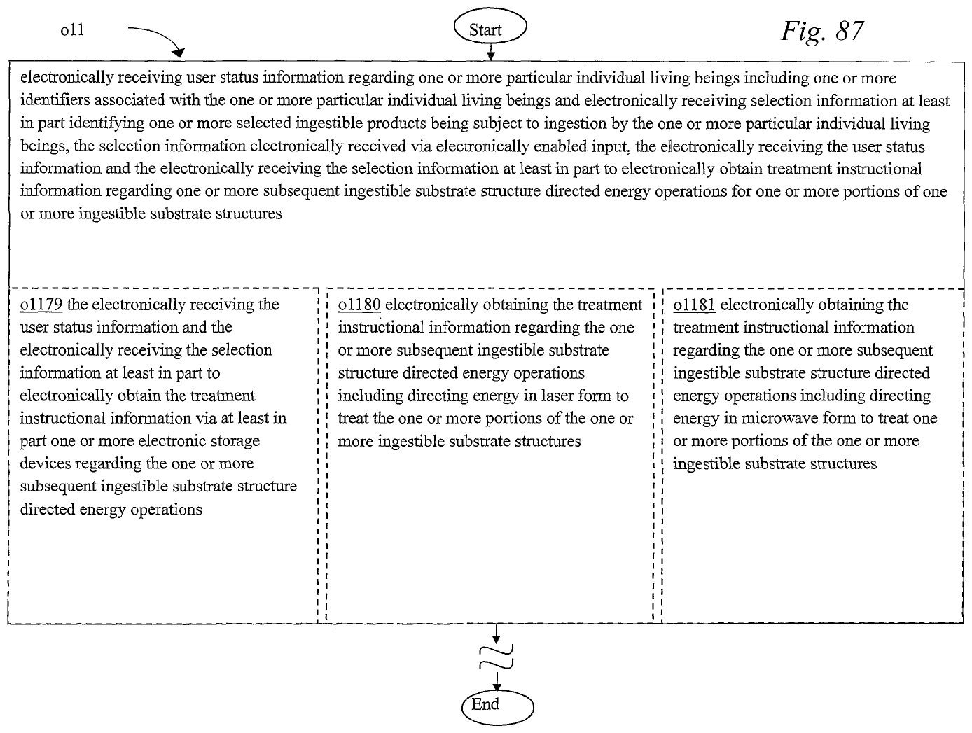

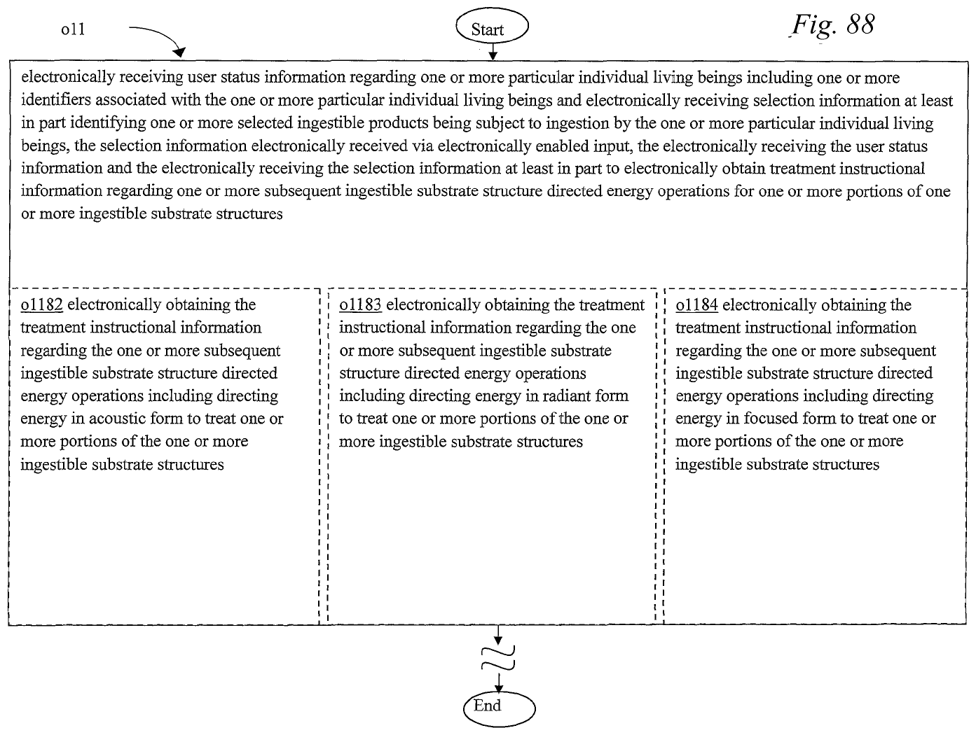

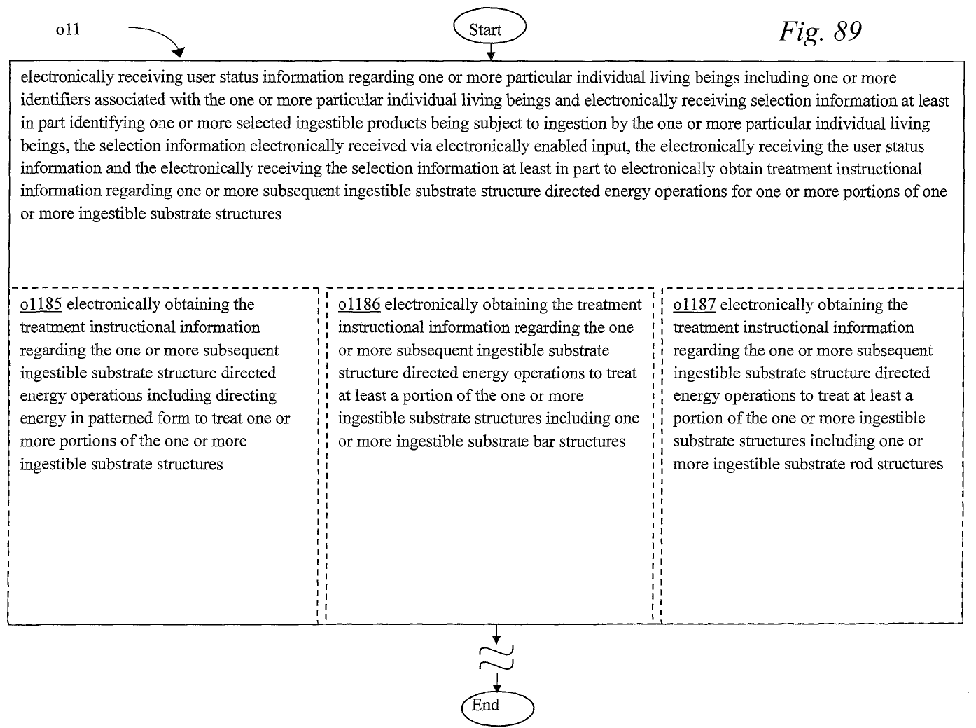

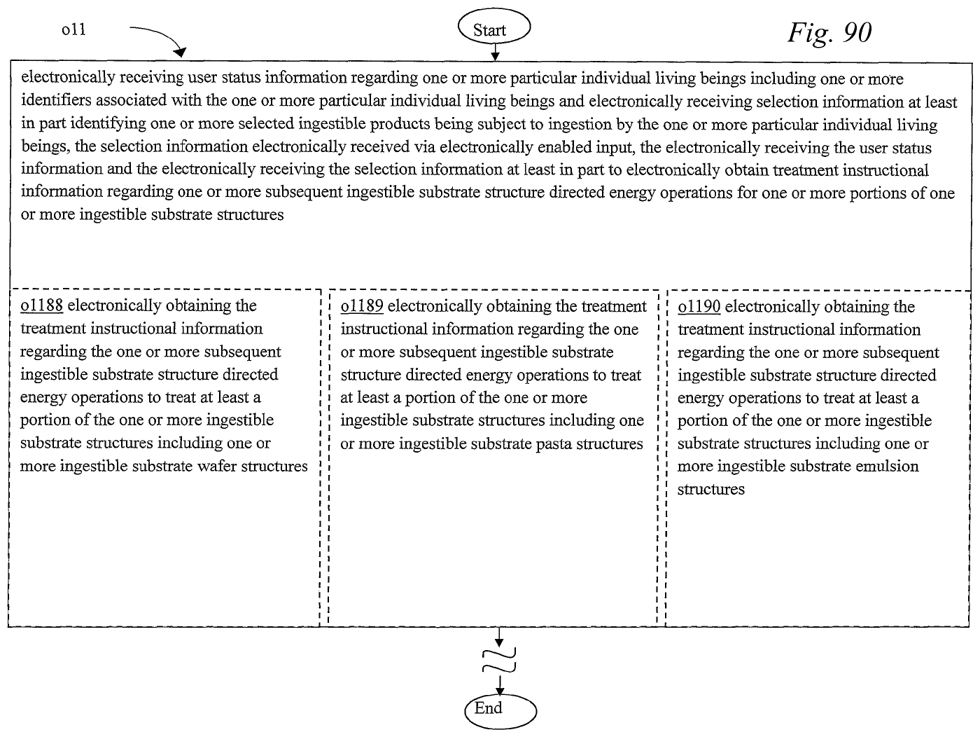

In one or more implementations, as shown in FIG. 64, operation p11 includes an operation p1110 for electronically receiving the user status information regarding the one or more particular individual living beings wirelessly. Origination of an illustratively derived receiving information wirelessly component group can be accomplished through skilled in the art design choice selection of one or more of the above depicted components from one or more of the above depicted subsystems shown in FIG. 51. Components from the receiving information wirelessly component group can be used in implementing execution of the one or more receiving information wirelessly instructions j1110 of FIG. 46, can be used in performance of the receiving information wirelessly electrical circuitry arrangement f1110 of FIG. 50, and/or can be used in otherwise fulfillment of the operation p1110. An exemplary non-transitory signal bearing medium version of the information storage subsystem s200 is depicted in FIG. 46 as bearing the one or more receiving information wirelessly instructions j1110 that when executed will direct performance of the operation p1110. Furthermore, the receiving information wirelessly electrical circuitry arrangement (“elec circ arrange”) f1110, when activated, will perform the operation p1110. Also, the receiving information wirelessly module n1110, when executed and/or activated, will direct performance of and/or perform the operation p1110. For instance, in one or more exemplary implementations, the one or more receiving information wirelessly instructions j1110, when executed, direct performance of the operation p1110 in the illustrative depiction as follows, and/or the receiving information wirelessly electrical circuitry arrangement f1110, when activated, performs the operation p1110 in the illustrative depiction as follows, and/or the receiving information wirelessly module n1110, when executed and/or activated, directs performance of and/or performs the operation p1110 in the illustrative depiction as follows, and/or the operation p1110 is otherwise carried out in the illustrative depiction as follows: electronically receiving the user status information regarding the one or more particular individual living beings wirelessly (e.g. including an implementation of the receiver component s528 is configured to electronically receive through the wireless network component s512 the user status information, and/or etc.).

In one or more implementations, as shown in FIG. 64, operation p11 includes an operation p1111 for electronically receiving the user status information regarding the one or more particular individual living beings via one or more electronic keypad entries. Origination of an illustratively derived receiving information keypad entries component group can be accomplished through skilled in the art design choice selection of one or more of the above depicted components from one or more of the above depicted subsystems shown in FIG. 51. Components from the receiving information keypad entries component group can be used in implementing execution of the one or more receiving information keypad entries instructions j1111 of FIG. 46, can be used in performance of the receiving information keypad entries electrical circuitry arrangement f1111 of FIG. 50, and/or can be used in otherwise fulfillment of the operation p1111. An exemplary non-transitory signal bearing medium version of the information storage subsystem s200 is depicted in FIG. 46 as bearing the one or more receiving information keypad entries instructions j1111 that when executed will direct performance of the operation p1111. Furthermore, the receiving information keypad entries electrical circuitry arrangement (“elec circ arrange”) f1111, when activated, will perform the operation p1111. Also, the receiving information keypad entries module n1111, when executed and/or activated, will direct performance of and/or perform the operation p1111. For instance, in one or more exemplary implementations, the one or more receiving information keypad entries instructions j1111, when executed, direct performance of the operation p1111 in the illustrative depiction as follows, and/or the receiving information keypad entries electrical circuitry arrangement f1111, when activated, performs the operation p1111 in the illustrative depiction as follows, and/or the receiving information keypad entries module n1111, when executed and/or activated, directs performance of and/or performs the operation p1111 in the illustrative depiction as follows, and/or the operation p1111 is otherwise carried out in the illustrative depiction as follows: electronically receiving the user status information regarding the one or more particular individual living beings via one or more electronic keypad entries (e.g. including an implementation of the receiver component s528 is configured to electronically engage with the keypad component s308 to receive the user status information as inputted by a user, and/or etc.).

In one or more implementations, as shown in FIG. 64, operation p11 includes an operation p1112 for electronically receiving the user status information regarding the one or more particular individual living beings including the one or more identifiers associated with the one or more particular individual living beings via one or more restaurant meal orders. Origination of an illustratively derived receiving information meal order component group can be accomplished through skilled in the art design choice selection of one or more of the above depicted components from one or more of the above depicted subsystems shown in FIG. 51. Components from the receiving information meal order component group can be used in implementing execution of the one or more receiving information meal order instructions j1112 of FIG. 46, can be used in performance of the receiving information meal order electrical circuitry arrangement f1112 of FIG. 50, and/or can be used in otherwise fulfillment of the operation p1112. An exemplary non-transitory signal bearing medium version of the information storage subsystem s200 is depicted in FIG. 46 as bearing the one or more receiving information meal order instructions j1112 that when executed will direct performance of the operation p1112. Furthermore, the receiving information meal order electrical circuitry arrangement (“elec circ arrange”) f1112, when activated, will perform the operation p1112. Also, the receiving information meal order module n1112, when executed and/or activated, will direct performance of and/or perform the operation p1112. For instance, in one or more exemplary implementations, the one or more receiving information meal order instructions j1112, when executed, direct performance of the operation p1112 in the illustrative depiction as follows, and/or the receiving information meal order electrical circuitry arrangement f1112, when activated, performs the operation p1112 in the illustrative depiction as follows, and/or the receiving information meal order module n1112, when executed and/or activated, directs performance of and/or performs the operation p1112 in the illustrative depiction as follows, and/or the operation p1112 is otherwise carried out in the illustrative depiction as follows: electronically receiving the user status information regarding the one or more particular individual living beings including the one or more identifiers associated with the one or more particular individual living beings via one or more restaurant meal orders (e.g. including an implementation of the receiver component s528 is configured to electronically engage with the processor component s102 to receive the user status information including the one or more identifiers associated with the one or more particular individual living beings via a meal order electronically inputted by a wait staff person, and/or etc.).

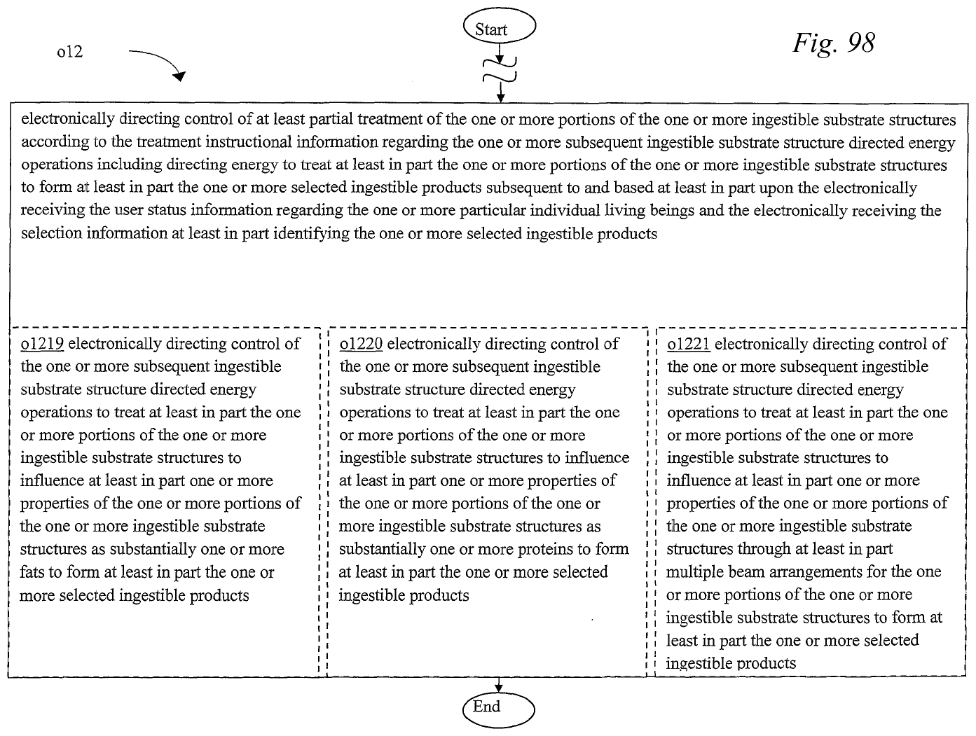

In one or more implementations, as shown in FIG. 98, operation p11 includes an operation p1113 for electronically receiving the user status information regarding the one or more particular individual living beings including the one or more identifiers associated with the one or more particular individual living beings via prescription identification. Origination of an illustratively derived receiving information prescription ID component group can be accomplished through skilled in the art design choice selection of one or more of the above depicted components from one or more of the above depicted subsystems shown in FIG. 51. Components from the receiving information prescription ID component group can be used in implementing execution of the one or more receiving information prescription ID instructions j1113 of FIG. 46, can be used in performance of the receiving information prescription ID electrical circuitry arrangement f1113 of FIG. 50, and/or can be used in otherwise fulfillment of the operation p1113. An exemplary non-transitory signal bearing medium version of the information storage subsystem s200 is depicted in FIG. 46 as bearing the one or more receiving information prescription ID instructions j1113 that when executed will direct performance of the operation p1113. Furthermore, the receiving information prescription ID electrical circuitry arrangement (“elec circ arrange”) f1113, when activated, will perform the operation p1113. Also, the receiving information prescription ID module n1113, when executed and/or activated, will direct performance of and/or perform the operation p1113. For instance, in one or more exemplary implementations, the one or more receiving information prescription ID instructions j1113, when executed, direct performance of the operation p1113 in the illustrative depiction as follows, and/or the receiving information prescription ID electrical circuitry arrangement f1113, when activated, performs the operation p1113 in the illustrative depiction as follows, and/or the receiving information prescription ID module n1113, when executed and/or activated, directs performance of and/or performs the operation p1113 in the illustrative depiction as follows, and/or the operation p1113 is otherwise carried out in the illustrative depiction as follows: electronically receiving the user status information regarding the one or more particular individual living beings including the one or more identifiers associated with the one or more particular individual living beings via prescription identification (e.g. including an implementation of the receiver component s528 is configured to electronically engage with the processor component s102 to receive the user status information including the one or more identifiers associated with the particular individual living being as determined by the processor component to include a prescription identification, and/or etc.).

In one or more implementations, as shown in FIG. 98, operation p11 includes an operation p1114 for electronically receiving the user status information regarding the one or more particular individual living beings including the one or more identifiers associated with the one or more particular individual living beings via one or more prescription serial numbers. Origination of an illustratively derived receiving information prescription number component group can be accomplished through skilled in the art design choice selection of one or more of the above depicted components from one or more of the above depicted subsystems shown in FIG. 51. Components from the receiving information prescription number component group can be used in implementing execution of the one or more receiving information prescription number instructions j1114 of FIG. 46, can be used in performance of the receiving information prescription number electrical circuitry arrangement f1114 of FIG. 50, and/or can be used in otherwise fulfillment of the operation p1114. An exemplary non-transitory signal bearing medium version of the information storage subsystem s200 is depicted in FIG. 46 as bearing the one or more receiving information prescription number instructions j1114 that when executed will direct performance of the operation p1114. Furthermore, the receiving information prescription number electrical circuitry arrangement (“elec circ arrange”) f1114, when activated, will perform the operation p1114. Also, the receiving information prescription number module n1114, when executed and/or activated, will direct performance of and/or perform the operation p1114. For instance, in one or more exemplary implementations, the one or more receiving information prescription number instructions j1114, when executed, direct performance of the operation p1114 in the illustrative depiction as follows, and/or the receiving information prescription number electrical circuitry arrangement f1114, when activated, performs the operation p1114 in the illustrative depiction as follows, and/or the receiving information prescription number module n1114, when executed and/or activated, directs performance of and/or performs the operation p1114 in the illustrative depiction as follows, and/or the operation p1114 is otherwise carried out in the illustrative depiction as follows: electronically receiving the user status information regarding the one or more particular individual living beings including the one or more identifiers associated with the one or more particular individual living beings via one or more prescription serial numbers (e.g. including an implementation of the receiver component s528 is configured to electronically engage with the processor component s102 to receive the user status information including the one or more identifiers associated with the particular individual living being as determined by the processor component to include a prescription serial number, and/or etc.).

In one or more implementations, as shown in FIG. 98, operation p11 includes an operation p1115 for electronically receiving the user status information regarding the one or more particular individual living beings including the one or more identifiers associated with the one or more particular individual living beings via one or more data images of handwritten text. Origination of an illustratively derived receiving information handwritten component group can be accomplished through skilled in the art design choice selection of one or more of the above depicted components from one or more of the above depicted subsystems shown in FIG. 51. Components from the receiving information handwritten component group can be used in implementing execution of the one or more receiving information handwritten instructions j1115 of FIG. 46, can be used in performance of the receiving information handwritten electrical circuitry arrangement f1115 of FIG. 50, and/or can be used in otherwise fulfillment of the operation p1115. An exemplary non-transitory signal bearing medium version of the information storage subsystem s200 is depicted in FIG. 46 as bearing the one or more receiving information handwritten instructions j1115 that when executed will direct performance of the operation p1115. Furthermore, the receiving information handwritten electrical circuitry arrangement (“elec circ arrange”) f1115, when activated, will perform the operation p1115. Also, the receiving information handwritten module n1115, when executed and/or activated, will direct performance of and/or perform the operation p1115. For instance, in one or more exemplary implementations, the one or more receiving information handwritten instructions j1115, when executed, direct performance of the operation p1115 in the illustrative depiction as follows, and/or the receiving information handwritten electrical circuitry arrangement f1115, when activated, performs the operation p1115 in the illustrative depiction as follows, and/or the receiving information handwritten module n1115, when executed and/or activated, directs performance of and/or performs the operation p1115 in the illustrative depiction as follows, and/or the operation p1115 is otherwise carried out in the illustrative depiction as follows: electronically receiving the user status information regarding the one or more particular individual living beings including the one or more identifiers associated with the one or more particular individual living beings via one or more data images of handwritten text (e.g. including an implementation of the receiver component s528 is configured to electronically engage with the processor component s102 to receive the user status information regarding the particular individual living being including the one or more identifiers associated with the particular individual living being as determined by the processor component through electronic handwriting analysis of the data image of the handwritten text, and/or etc.).

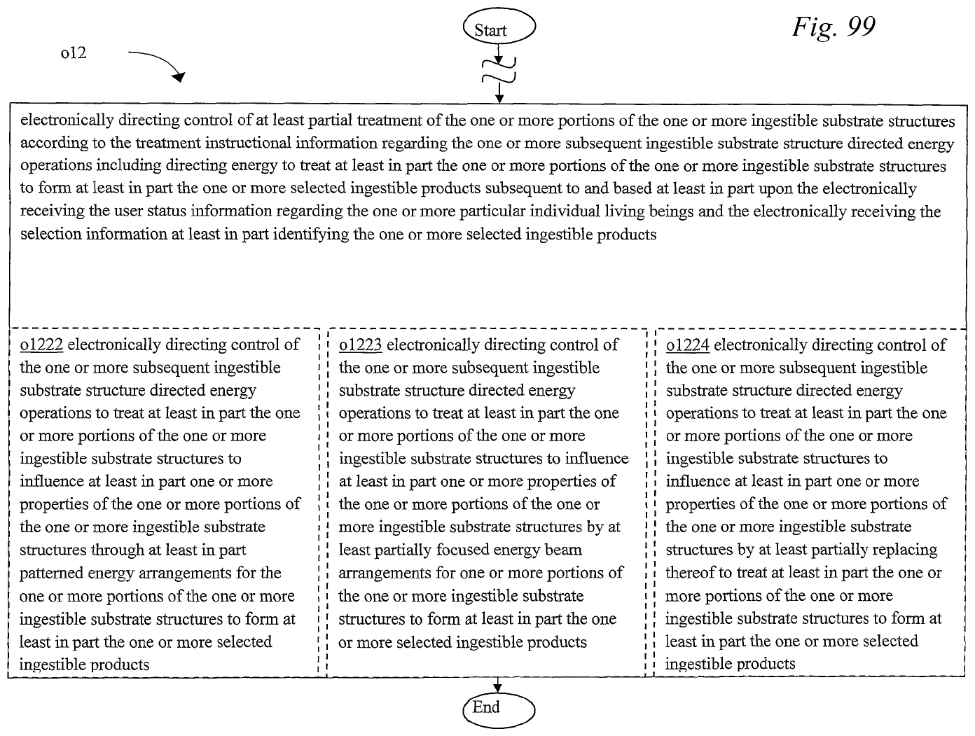

In one or more implementations, as shown in FIG. 99, operation p11 includes an operation p1116 for electronically receiving the user status information regarding the one or more particular individual living beings including the one or more identifiers associated with the one or more particular individual living beings via one or more computer text files. Origination of an illustratively derived receiving information text file component group can be accomplished through skilled in the art design choice selection of one or more of the above depicted components from one or more of the above depicted subsystems shown in FIG. 51. Components from the receiving information text file component group can be used in implementing execution of the one or more receiving information text file instructions j1116 of FIG. 46, can be used in performance of the receiving information text file electrical circuitry arrangement f1116 of FIG. 50, and/or can be used in otherwise fulfillment of the operation p1116. An exemplary non-transitory signal bearing medium version of the information storage subsystem s200 is depicted in FIG. 46 as bearing the one or more receiving information text file instructions j1116 that when executed will direct performance of the operation p1116. Furthermore, the receiving information text file electrical circuitry arrangement (“elec circ arrange”) f1116, when activated, will perform the operation p1116. Also, the receiving information text file module n1116, when executed and/or activated, will direct performance of and/or perform the operation p1116. For instance, in one or more exemplary implementations, the one or more receiving information text file instructions j1116, when executed, direct performance of the operation p1116 in the illustrative depiction as follows, and/or the receiving information text file electrical circuitry arrangement f1116, when activated, performs the operation p1116 in the illustrative depiction as follows, and/or the receiving information text file module n1116, when executed and/or activated, directs performance of and/or performs the operation p1116 in the illustrative depiction as follows, and/or the operation p1116 is otherwise carried out in the illustrative depiction as follows: electronically receiving the user status information regarding the one or more particular individual living beings including the one or more identifiers associated with the one or more particular individual living beings via one or more computer text files (e.g. including an implementation of the receiver component s528 is configured to electronically engage with the processor component s102 to receive the user status information including the one or more identifiers associated with the particular individual living being as determined by the processor component through electronic reading of the computer text file, and/or etc.).

In one or more implementations, as shown in FIG. 99, operation p11 includes an operation p1117 for electronically receiving the user status information regarding the one or more particular individual living beings including the one or more identifiers associated with the one or more particular individual living beings via one or more computer audio files. Origination of an illustratively derived receiving information audio file component group can be accomplished through skilled in the art design choice selection of one or more of the above depicted components from one or more of the above depicted subsystems shown in FIG. 51. Components from the receiving information audio file component group can be used in implementing execution of the one or more receiving information audio file instructions j1117 of FIG. 46, can be used in performance of the receiving information audio file electrical circuitry arrangement f1117 of FIG. 50, and/or can be used in otherwise fulfillment of the operation p1117. An exemplary non-transitory signal bearing medium version of the information storage subsystem s200 is depicted in FIG. 46 as bearing the one or more receiving information audio file instructions j1117 that when executed will direct performance of the operation p1117. Furthermore, the receiving information audio file electrical circuitry arrangement (“elec circ arrange”) f1117, when activated, will perform the operation p1117. Also, the receiving information audio file module n1117, when executed and/or activated, will direct performance of and/or perform the operation p1117. For instance, in one or more exemplary implementations, the one or more receiving information audio file instructions j1117, when executed, direct performance of the operation p1117 in the illustrative depiction as follows, and/or the receiving information audio file electrical circuitry arrangement f1117, when activated, performs the operation p1117 in the illustrative depiction as follows, and/or the receiving information audio file module n1117, when executed and/or activated, directs performance of and/or performs the operation p1117 in the illustrative depiction as follows, and/or the operation p1117 is otherwise carried out in the illustrative depiction as follows: electronically receiving the user status information regarding the one or more particular individual living beings including the one or more identifiers associated with the one or more particular individual living beings via one or more computer audio files (e.g. including an implementation of the receiver component s528 is configured to electronically engage with the processor component s102 to receive the user status information including the one or more identifiers associated with the particular individual living being as determined by the processor component through electronic reading of the computer audio file, and/or etc.).

In one or more implementations, as shown in FIG. 99, operation p11 includes an operation p1118 for electronically receiving the user status information regarding the one or more particular individual living beings including the one or more identifiers associated with the one or more particular individual living beings via one or more computer video files. Origination of an illustratively derived receiving information video file component group can be accomplished through skilled in the art design choice selection of one or more of the above depicted components from one or more of the above depicted subsystems shown in FIG. 51. Components from the receiving information video file component group can be used in implementing execution of the one or more receiving information video file instructions j1118 of FIG. 46, can be used in performance of the receiving information video file electrical circuitry arrangement f1118 of FIG. 50, and/or can be used in otherwise fulfillment of the operation p1118. An exemplary non-transitory signal bearing medium version of the information storage subsystem s200 is depicted in FIG. 46 as bearing the one or more receiving information video file instructions j1118 that when executed will direct performance of the operation p1118. Furthermore, the receiving information video file electrical circuitry arrangement (“elec circ arrange”) f1118, when activated, will perform the operation p1118. Also, the receiving information video file module n1118, when executed and/or activated, will direct performance of and/or perform the operation p1118. For instance, in one or more exemplary implementations, the one or more receiving information video file instructions j1118, when executed, direct performance of the operation p1118 in the illustrative depiction as follows, and/or the receiving information video file electrical circuitry arrangement f1118, when activated, performs the operation p1118 in the illustrative depiction as follows, and/or the receiving information video file module n1118, when executed and/or activated, directs performance of and/or performs the operation p1118 in the illustrative depiction as follows, and/or the operation p1118 is otherwise carried out in the illustrative depiction as follows: electronically receiving the user status information regarding the one or more particular individual living beings including the one or more identifiers associated with the one or more particular individual living beings via one or more computer video files (e.g. including an implementation of the receiver component s528 is configured to electronically engage with the processor component s102 to receive the user status information including the one or more identifiers associated with the particular individual living being as determined by the processor component through electronic reading of the computer video file, and/or etc.).

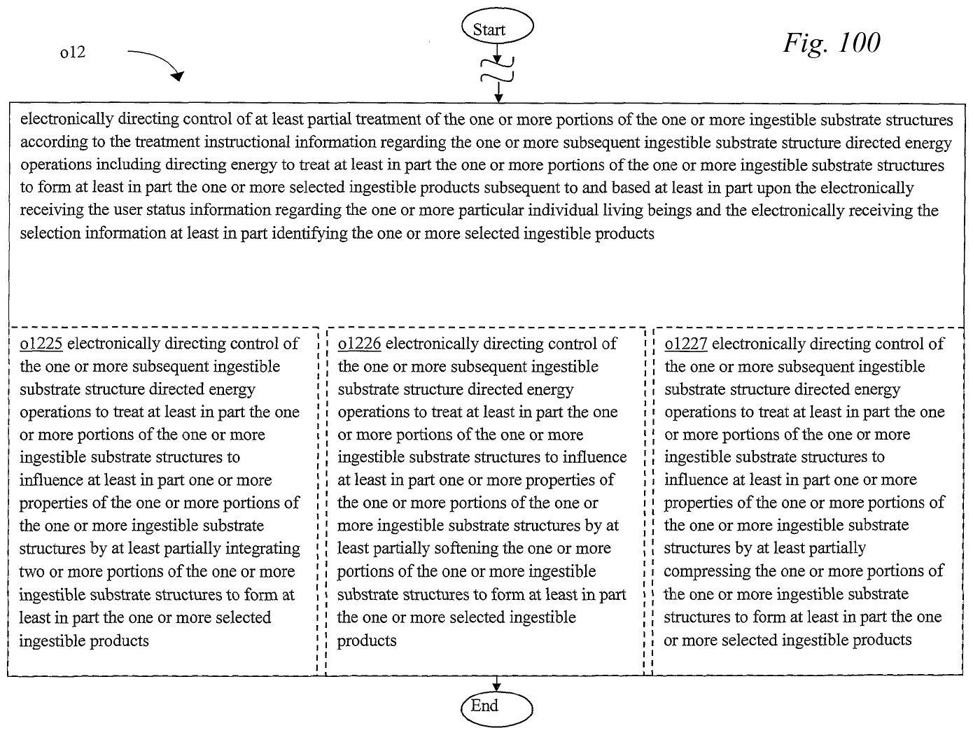

In one or more implementations, as shown in FIG. 100, operation p11 includes an operation p1119 for electronically receiving the user status information regarding the one or more particular individual living beings including the one or more identifiers associated with the one or more particular individual living beings via one or more RFID tags. Origination of an illustratively derived receiving information RFID component group can be accomplished through skilled in the art design choice selection of one or more of the above depicted components from one or more of the above depicted subsystems shown in FIG. 51. Components from the receiving information RFID component group can be used in implementing execution of the one or more receiving information RFID instructions j1119 of FIG. 46, can be used in performance of the receiving information RFID electrical circuitry arrangement f1119 of FIG. 50, and/or can be used in otherwise fulfillment of the operation p1119. An exemplary non-transitory signal bearing medium version of the information storage subsystem s200 is depicted in FIG. 46 as bearing the one or more receiving information RFID instructions j1119 that when executed will direct performance of the operation p1119. Furthermore, the receiving information RFID electrical circuitry arrangement (“elec circ arrange”) f1119, when activated, will perform the operation p1119. Also, the receiving information RFID module n1119, when executed and/or activated, will direct performance of and/or perform the operation p1119. For instance, in one or more exemplary implementations, the one or more receiving information RFID instructions j1119, when executed, direct performance of the operation p1119 in the illustrative depiction as follows, and/or the receiving information RFID electrical circuitry arrangement f1119, when activated, performs the operation p1119 in the illustrative depiction as follows, and/or the receiving information RFID module n1119, when executed and/or activated, directs performance of and/or performs the operation p1119 in the illustrative depiction as follows, and/or the operation p1119 is otherwise carried out in the illustrative depiction as follows: electronically receiving the user status information regarding the one or more particular individual living beings including the one or more identifiers associated with the one or more particular individual living beings via one or more RFID tags (e.g. including an implementation of the receiver component s528 is configured to electronically engage with the processor component s102 to receive the user status information including the one or more identifiers associated with the particular individual living being as determined by the processor component through electronic reading be the radio frequency identification (RFID) sensing component s414 of the RFID tag, and/or etc.).

In one or more implementations, as shown in FIG. 100, operation p11 includes an operation p1120 for electronically receiving the user status information regarding the one or more particular individual living beings including the one or more identifiers associated with the one or more particular individual living beings via one or more bar codes. Origination of an illustratively derived receiving information bar code component group can be accomplished through skilled in the art design choice selection of one or more of the above depicted components from one or more of the above depicted subsystems shown in FIG. 51. Components from the receiving information bar code component group can be used in implementing execution of the one or more receiving information bar code instructions j1120 of FIG. 47, can be used in performance of the receiving information bar code electrical circuitry arrangement f1120 of FIG. 51, and/or can be used in otherwise fulfillment of the operation p1120. An exemplary non-transitory signal bearing medium version of the information storage subsystem s200 is depicted in FIG. 47 as bearing the one or more receiving information bar code instructions j1120 that when executed will direct performance of the operation p1120. Furthermore, the receiving information bar code electrical circuitry arrangement (“elec circ arrange”) f1120, when activated, will perform the operation p1120. Also, the receiving information bar code module n1120, when executed and/or activated, will direct performance of and/or perform the operation p1120. For instance, in one or more exemplary implementations, the one or more receiving information bar code instructions j1120, when executed, direct performance of the operation p1120 in the illustrative depiction as follows, and/or the receiving information bar code electrical circuitry arrangement f1120, when activated, performs the operation p1120 in the illustrative depiction as follows, and/or the receiving information bar code module n1120, when executed and/or activated, directs performance of and/or performs the operation p1120 in the illustrative depiction as follows, and/or the operation p1120 is otherwise carried out in the illustrative depiction as follows: electronically receiving the user status information regarding the one or more particular individual living beings including the one or more identifiers associated with the one or more particular individual living beings via one or more bar codes (e.g. including an implementation of the receiver component s528 is configured to electronically engage with the processor component s102 to receive the user status information including the one or more identifiers associated with the particular individual living being as determined by the processor component through electronic reading of the bar code, and/or etc.).

In one or more implementations, as shown in FIG. 100, operation p11 includes an operation p1121 for electronically receiving the user status information regarding the one or more particular individual living beings including the one or more identifiers associated with the one or more particular individual living beings via one or more holographic images. Origination of an illustratively derived receiving information holographic component group can be accomplished through skilled in the art design choice selection of one or more of the above depicted components from one or more of the above depicted subsystems shown in FIG. 51. Components from the receiving information holographic component group can be used in implementing execution of the one or more receiving information holographic instructions j1121 of FIG. 47, can be used in performance of the receiving information holographic electrical circuitry arrangement f1121 of FIG. 51, and/or can be used in otherwise fulfillment of the operation p1121. An exemplary non-transitory signal bearing medium version of the information storage subsystem s200 is depicted in FIG. 47 as bearing the one or more receiving information holographic instructions j1121 that when executed will direct performance of the operation p1121. Furthermore, the receiving information holographic electrical circuitry arrangement (“elec circ arrange”) f1121, when activated, will perform the operation p1121. Also, the receiving information holographic module n1121, when executed and/or activated, will direct performance of and/or perform the operation p1121. For instance, in one or more exemplary implementations, the one or more receiving information holographic instructions j1121, when executed, direct performance of the operation p1121 in the illustrative depiction as follows, and/or the receiving information holographic electrical circuitry arrangement f1121, when activated, performs the operation p1121 in the illustrative depiction as follows, and/or the receiving information holographic module n1121, when executed and/or activated, directs performance of and/or performs the operation p1121 in the illustrative depiction as follows, and/or the operation p1121 is otherwise carried out in the illustrative depiction as follows: electronically receiving the user status information regarding the one or more particular individual living beings including the one or more identifiers associated with the one or more particular individual living beings via one or more holographic images (e.g. including an implementation of the receiver component s528 is configured to electronically engage with the processor component s102 to receive the user status information including the one or more identifiers associated with the particular individual living being as determined by the processor component through electronic reading of the holographic image, and/or etc.).

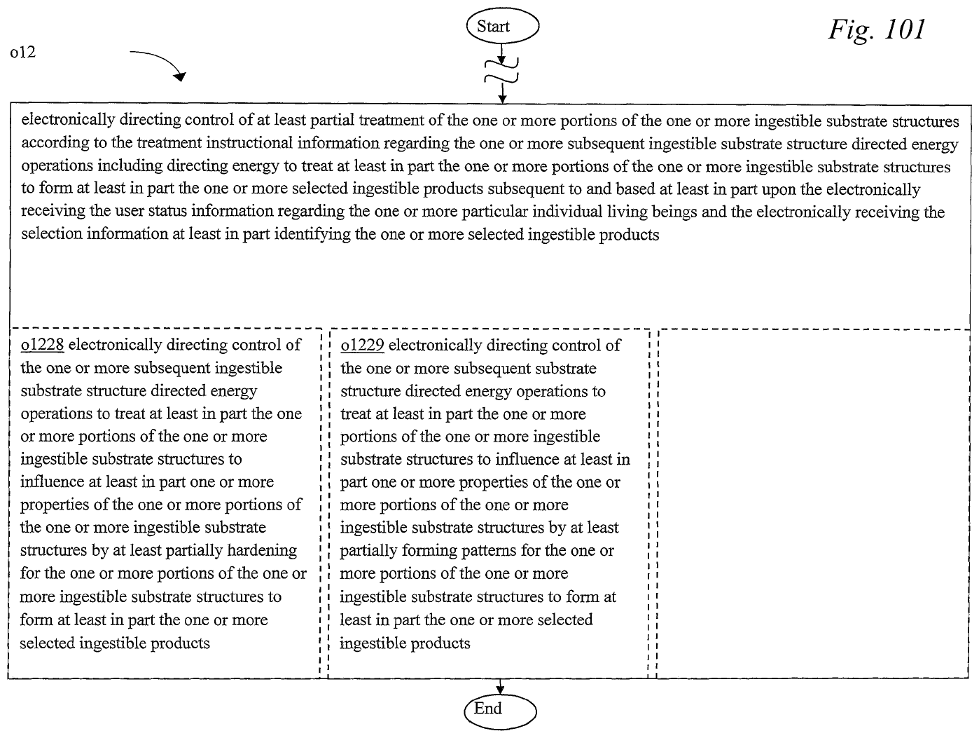

In one or more implementations, as shown in FIG. 101, operation p11 includes an operation p1122 for electronically receiving the selection information at least in part identifying the one or more selected ingestible products being subject to ingestion by the one or more particular individual living beings, the selection information electronically received via the electronically enabled input in response to the electronically outputted one or more selection menus in textual form. Origination of an illustratively derived receiving information textual component group can be accomplished through skilled in the art design choice selection of one or more of the above depicted components from one or more of the above depicted subsystems shown in FIG. 51. Components from the receiving information textual component group can be used in implementing execution of the one or more receiving information textual instructions j1122 of FIG. 47, can be used in performance of the receiving information textual electrical circuitry arrangement f1122 of FIG. 51, and/or can be used in otherwise fulfillment of the operation p1122. An exemplary non-transitory signal bearing medium version of the information storage subsystem s200 is depicted in FIG. 47 as bearing the one or more receiving information textual instructions j1122 that when executed will direct performance of the operation p1122. Furthermore, the receiving information textual electrical circuitry arrangement (“elec circ arrange”) f1122, when activated, will perform the operation p1122. Also, the receiving information textual module n1122, when executed and/or activated, will direct performance of and/or perform the operation p1122. For instance, in one or more exemplary implementations, the one or more receiving information textual instructions j1122, when executed, direct performance of the operation p1122 in the illustrative depiction as follows, and/or the receiving information textual electrical circuitry arrangement f1122, when activated, performs the operation p1122 in the illustrative depiction as follows, and/or the receiving information textual module n1122, when executed and/or activated, directs performance of and/or performs the operation p1122 in the illustrative depiction as follows, and/or the operation p1122 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to the electronically outputted one or more selection menus in textual form (e.g. including an implementation of the receiver component s528 is configured to electronically engage with the processor component s102 to receive the user status information including the one or more identifiers associated with the particular individual living being for the processor component to at least in part electronically generate, based at least in part upon the user status information regarding the particular individual living being, such as based on associated allergies, one or more selection menus in textual form, such as a menu containing textual one or more descriptions of possible ingestible product to select from, and/or etc.).

In one or more implementations, as shown in FIG. 101, operation p11 includes an operation p1123 for electronically receiving the selection information at least in part identifying the one or more selected ingestible products being subject to ingestion by the one or more particular individual living beings, the selection information electronically received via the electronically enabled input in response to the electronically outputted one or more selection menus in icon form. Origination of an illustratively derived receiving information icon component group can be accomplished through skilled in the art design choice selection of one or more of the above depicted components from one or more of the above depicted subsystems shown in FIG. 51. Components from the receiving information icon component group can be used in implementing execution of the one or more receiving information icon instructions j1123 of FIG. 47, can be used in performance of the receiving information icon electrical circuitry arrangement f1123 of FIG. 51, and/or can be used in otherwise fulfillment of the operation p1123. An exemplary non-transitory signal bearing medium version of the information storage subsystem s200 is depicted in FIG. 47 as bearing the one or more receiving information icon instructions j1123 that when executed will direct performance of the operation p1123. Furthermore, the receiving information icon electrical circuitry arrangement (“elec circ arrange”) f1123, when activated, will perform the operation p1123. Also, the receiving information icon module n1123, when executed and/or activated, will direct performance of and/or perform the operation p1123. For instance, in one or more exemplary implementations, the one or more receiving information icon instructions j1123, when executed, direct performance of the operation p1123 in the illustrative depiction as follows, and/or the receiving information icon electrical circuitry arrangement f1123, when activated, performs the operation p1123 in the illustrative depiction as follows, and/or the receiving information icon module n1123, when executed and/or activated, directs performance of and/or performs the operation p1123 in the illustrative depiction as follows, and/or the operation p1123 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to the electronically outputted one or more selection menus in icon form (e.g. including an implementation of the receiver component s528 is configured to electronically engage with the processor component s102 to receive the user status information including the one or more identifiers associated with the particular individual living being for the processor component to at least in part electronically generate, based at least in part upon the user status information regarding the particular individual living being, such as based on associated previous meals, one or more selection menus in icon form, such as a menu containing iconic one or more descriptions of possible ingestible product to select from, and/or etc.).

In one or more implementations, as shown in FIG. 101, operation p11 includes an operation p1124 for electronically receiving the selection information at least in part identifying the one or more selected ingestible products being subject to ingestion by the one or more particular individual living beings, the selection information electronically received via the electronically enabled input in response to the electronically outputted one or more selection menus in graphical form. Origination of an illustratively derived receiving information graphical component group can be accomplished through skilled in the art design choice selection of one or more of the above depicted components from one or more of the above depicted subsystems shown in FIG. 51. Components from the receiving information graphical component group can be used in implementing execution of the one or more receiving information graphical instructions j1124 of FIG. 47, can be used in performance of the receiving information graphical electrical circuitry arrangement f1124 of FIG. 51, and/or can be used in otherwise fulfillment of the operation p1124. An exemplary non-transitory signal bearing medium version of the information storage subsystem s200 is depicted in FIG. 47 as bearing the one or more receiving information graphical instructions j1124 that when executed will direct performance of the operation p1124. Furthermore, the receiving information graphical electrical circuitry arrangement (“elec circ arrange”) f1124, when activated, will perform the operation p1124. Also, the receiving information graphical module n1124, when executed and/or activated, will direct performance of and/or perform the operation p1124. For instance, in one or more exemplary implementations, the one or more receiving information graphical instructions j1124, when executed, direct performance of the operation p1124 in the illustrative depiction as follows, and/or the receiving information graphical electrical circuitry arrangement f1124, when activated, performs the operation p1124 in the illustrative depiction as follows, and/or the receiving information graphical module n1124, when executed and/or activated, directs performance of and/or performs the operation p1124 in the illustrative depiction as follows, and/or the operation p1124 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to the electronically outputted one or more selection menus in graphical form (e.g. including an implementation of the receiver component s528 is configured to electronically engage with the processor component s102 to receive the user status information including the one or more identifiers associated with the particular individual living being for the processor component to at least in part electronically generate, based at least in part upon the user status information regarding the particular individual living being, such as based on associated favorite foods as observed and recorded in a database, one or more selection menus in graphical form, such as a menu containing graphical one or more descriptions of possible ingestible product to select from, and/or etc.).

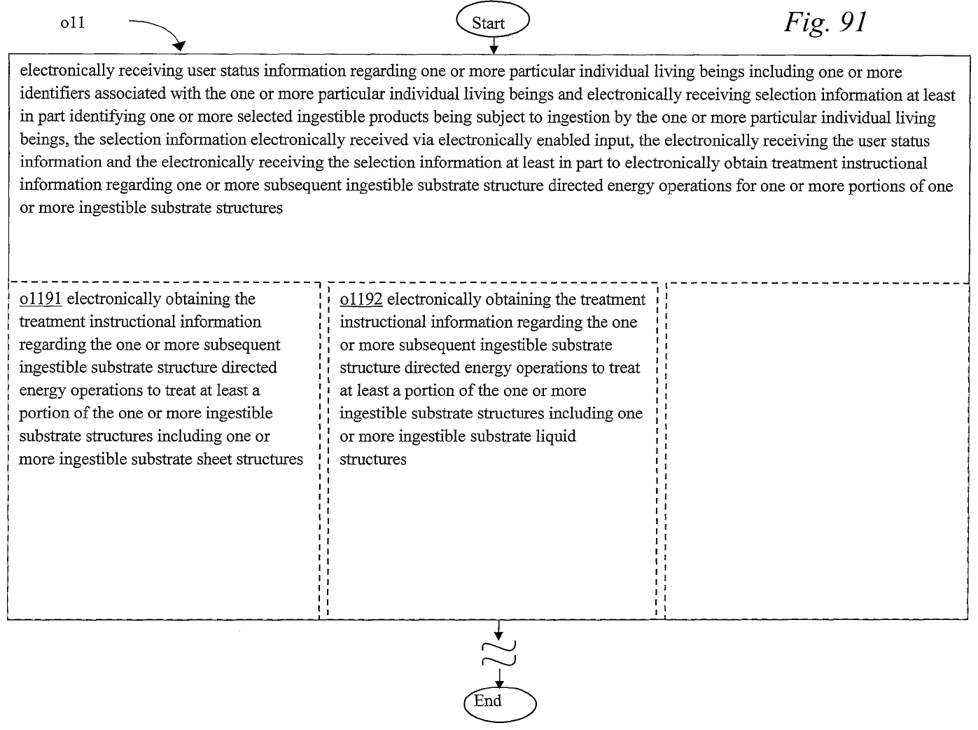

In one or more implementations, as shown in FIG. 91, operation p11 includes an operation p1125 for electronically receiving the selection information at least in part identifying the one or more selected ingestible products being subject to ingestion by the one or more particular individual living beings, the selection information electronically received via the electronically enabled input in response to the electronically outputted one or more selection menus in markup language form. Origination of an illustratively derived receiving information markup component group can be accomplished through skilled in the art design choice selection of one or more of the above depicted components from one or more of the above depicted subsystems shown in FIG. 51. Components from the receiving information markup component group can be used in implementing execution of the one or more receiving information markup instructions j1125 of FIG. 47, can be used in performance of the receiving information markup electrical circuitry arrangement f1125 of FIG. 51, and/or can be used in otherwise fulfillment of the operation p1125. An exemplary non-transitory signal bearing medium version of the information storage subsystem s200 is depicted in FIG. 47 as bearing the one or more receiving information markup instructions j1125 that when executed will direct performance of the operation p1125. Furthermore, the receiving information markup electrical circuitry arrangement (“elec circ arrange”) f1125, when activated, will perform the operation p1125. Also, the receiving information markup module n1125, when executed and/or activated, will direct performance of and/or perform the operation p1125. For instance, in one or more exemplary implementations, the one or more receiving information markup instructions j1125, when executed, direct performance of the operation p1125 in the illustrative depiction as follows, and/or the receiving information markup electrical circuitry arrangement f1125, when activated, performs the operation p1125 in the illustrative depiction as follows, and/or the receiving information markup module n1125, when executed and/or activated, directs performance of and/or performs the operation p1125 in the illustrative depiction as follows, and/or the operation p1125 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to the electronically outputted one or more selection menus in markup language form (e.g. including an implementation of the receiver component s528 is configured to electronically engage with the processor component s102 to receive the user status information including the one or more identifiers associated with the particular individual living being for the processor component to at least in part electronically generate, based at least in part upon the user status information regarding the particular individual living being, such as based on associated health building goals, one or more selection menus in markup language form, such as a menu containing markup language one or more descriptions of possible ingestible product to select from, and/or etc.).

In one or more implementations, as shown in FIG. 91, operation p11 includes an operation p1126 for electronically receiving the selection information at least in part identifying the one or more selected ingestible products being subject to ingestion by the one or more particular individual living beings, the selection information electronically received via the electronically enabled input in response to the electronically outputted one or more selection menus in audio form. Origination of an illustratively derived receiving information audio component group can be accomplished through skilled in the art design choice selection of one or more of the above depicted components from one or more of the above depicted subsystems shown in FIG. 51. Components from the receiving information audio component group can be used in implementing execution of the one or more receiving information audio instructions j1126 of FIG. 47, can be used in performance of the receiving information audio electrical circuitry arrangement f1126 of FIG. 51, and/or can be used in otherwise fulfillment of the operation p1126. An exemplary non-transitory signal bearing medium version of the information storage subsystem s200 is depicted in FIG. 47 as bearing the one or more receiving information audio instructions j1126 that when executed will direct performance of the operation p1126. Furthermore, the receiving information audio electrical circuitry arrangement (“elec circ arrange”) f1126, when activated, will perform the operation p1126. Also, the receiving information audio module n1126, when executed and/or activated, will direct performance of and/or perform the operation p1126. For instance, in one or more exemplary implementations, the one or more receiving information audio instructions j1126, when executed, direct performance of the operation p1126 in the illustrative depiction as follows, and/or the receiving information audio electrical circuitry arrangement f1126, when activated, performs the operation p1126 in the illustrative depiction as follows, and/or the receiving information audio module n1126, when executed and/or activated, directs performance of and/or performs the operation p1126 in the illustrative depiction as follows, and/or the operation p1126 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to the electronically outputted one or more selection menus in audio form (e.g. including an implementation of the receiver component s528 is configured to electronically engage with the processor component s102 to receive the user status information including the one or more identifiers associated with the particular individual living being for the processor component to at least in part electronically generate, based at least in part upon the user status information regarding the particular individual living being, such as based on associated disease mitigating measures, one or more selection menus in audio form, such as a menu containing audio one or more descriptions of possible ingestible product to select from, and/or etc.).

In one or more implementations, as shown in FIG. 91, operation p11 includes an operation p1127 for electronically receiving the selection information at least in part identifying the one or more selected ingestible products being subject to ingestion by the one or more particular individual living beings, the selection information electronically received via the electronically enabled input in response to the electronically outputted one or more selection menus in list form. Origination of an illustratively derived receiving information list component group can be accomplished through skilled in the art design choice selection of one or more of the above depicted components from one or more of the above depicted subsystems shown in FIG. 51. Components from the receiving information list component group can be used in implementing execution of the one or more receiving information list instructions j1127 of FIG. 47, can be used in performance of the receiving information list electrical circuitry arrangement f1127 of FIG. 51, and/or can be used in otherwise fulfillment of the operation p1127. An exemplary non-transitory signal bearing medium version of the information storage subsystem s200 is depicted in FIG. 47 as bearing the one or more receiving information list instructions j1127 that when executed will direct performance of the operation p1127. Furthermore, the receiving information list electrical circuitry arrangement (“elec circ arrange”) f1127, when activated, will perform the operation p1127. Also, the receiving information list module n1127, when executed and/or activated, will direct performance of and/or perform the operation p1127. For instance, in one or more exemplary implementations, the one or more receiving information list instructions j1127, when executed, direct performance of the operation p1127 in the illustrative depiction as follows, and/or the receiving information list electrical circuitry arrangement f1127, when activated, performs the operation p1127 in the illustrative depiction as follows, and/or the receiving information list module n1127, when executed and/or activated, directs performance of and/or performs the operation p1127 in the illustrative depiction as follows, and/or the operation p1127 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to the electronically outputted one or more selection menus in list form (e.g. including an implementation of the receiver component s528 is configured to electronically engage with the processor component s102 to receive the user status information including the one or more identifiers associated with the particular individual living being for the processor component to at least in part electronically generate, based at least in part upon the user status information regarding the particular individual living being, such as based on associated dislikes, one or more selection menus in list form, such as a menu containing listed one or more descriptions of possible ingestible product to select from, and/or etc.).

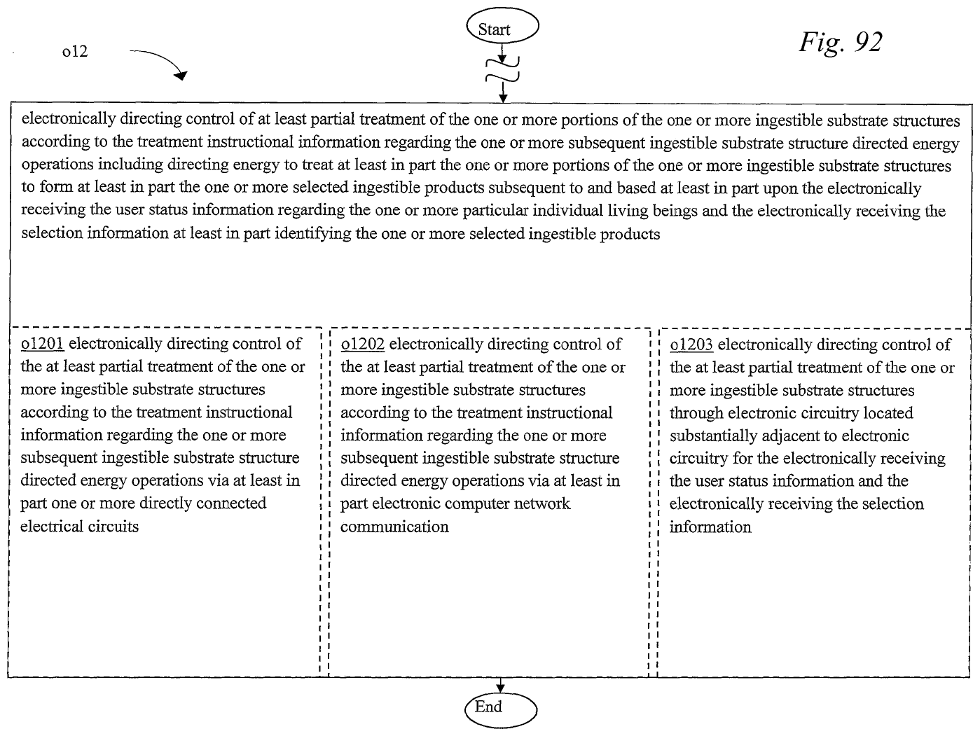

In one or more implementations, as shown in FIG. 92, operation p11 includes an operation p1128 for electronically receiving the selection information at least in part identifying the one or more selected ingestible products being subject to ingestion by the one or more particular individual living beings, the selection information electronically received via the electronically enabled input in response to the electronically outputted one or more selection menus in hierarchical form. Origination of an illustratively derived receiving information hierarchical component group can be accomplished through skilled in the art design choice selection of one or more of the above depicted components from one or more of the above depicted subsystems shown in FIG. 51. Components from the receiving information hierarchical component group can be used in implementing execution of the one or more receiving information hierarchical instructions j1128 of FIG. 47, can be used in performance of the receiving information hierarchical electrical circuitry arrangement f1128 of FIG. 51, and/or can be used in otherwise fulfillment of the operation p1128. An exemplary non-transitory signal bearing medium version of the information storage subsystem s200 is depicted in FIG. 47 as bearing the one or more receiving information hierarchical instructions j1128 that when executed will direct performance of the operation p1128. Furthermore, the receiving information hierarchical electrical circuitry arrangement (“elec circ arrange”) f1128, when activated, will perform the operation p1128. Also, the receiving information hierarchical module n1128, when executed and/or activated, will direct performance of and/or perform the operation p1128. For instance, in one or more exemplary implementations, the one or more receiving information hierarchical instructions j1128, when executed, direct performance of the operation p1128 in the illustrative depiction as follows, and/or the receiving information hierarchical electrical circuitry arrangement f1128, when activated, performs the operation p1128 in the illustrative depiction as follows, and/or the receiving information hierarchical module n1128, when executed and/or activated, directs performance of and/or performs the operation p1128 in the illustrative depiction as follows, and/or the operation p1128 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to the electronically outputted one or more selection menus in hierarchical form (e.g. including an implementation of the receiver component s528 is configured to electronically engage with the processor component s102 to receive the user status information including the one or more identifiers associated with the particular individual living being for the processor component to at least in part electronically generate, based at least in part upon the user status information regarding the particular individual living being, such as based on associated past purchases, one or more selection menus in hierarchical form, such as a menu containing hierarchical one or more descriptions of possible ingestible product to select from, and/or etc.).

In one or more implementations, as shown in FIG. 92, operation p11 includes an operation p1129 for electronically receiving the selection information at least in part identifying the one or more selected ingestible products being subject to ingestion by the one or more particular individual living beings, the selection information electronically received via the electronically enabled input in response to the electronically outputted one or more selection menus in map form. Origination of an illustratively derived receiving information map component group can be accomplished through skilled in the art design choice selection of one or more of the above depicted components from one or more of the above depicted subsystems shown in FIG. 51. Components from the receiving information map component group can be used in implementing execution of the one or more receiving information map instructions j1129 of FIG. 47, can be used in performance of the receiving information map electrical circuitry arrangement f1129 of FIG. 51, and/or can be used in otherwise fulfillment of the operation p1129. An exemplary non-transitory signal bearing medium version of the information storage subsystem s200 is depicted in FIG. 47 as bearing the one or more receiving information map instructions j1129 that when executed will direct performance of the operation p1129. Furthermore, the receiving information map electrical circuitry arrangement (“elec circ arrange”) f1129, when activated, will perform the operation p1129. Also, the receiving information map module n1129, when executed and/or activated, will direct performance of and/or perform the operation p1129. For instance, in one or more exemplary implementations, the one or more receiving information map instructions j1129, when executed, direct performance of the operation p1129 in the illustrative depiction as follows, and/or the receiving information map electrical circuitry arrangement f1129, when activated, performs the operation p1129 in the illustrative depiction as follows, and/or the receiving information map module n1129, when executed and/or activated, directs performance of and/or performs the operation p1129 in the illustrative depiction as follows, and/or the operation p1129 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to the electronically outputted one or more selection menus in map form (e.g. including an implementation of the receiver component s528 is configured to electronically engage with the processor component s102 to receive the user status information including the one or more identifiers associated with the particular individual living being for the processor component to at least in part electronically generate, based at least in part upon the user status information regarding the particular individual living being, such as based on associated food preferences determined from use history stored in one or more distributed databases, one or more selection menus in map form, such as a menu having arrangements resembling one or more maps containing one or more selections and one or more descriptions of possible ingestible product to select from, and/or etc.).

In one or more implementations, as shown in FIG. 92, operation p11 includes an operation p1130 for electronically receiving the selection information at least in part identifying the one or more selected ingestible products being subject to ingestion by the one or more particular individual living beings, the selection information electronically received via the electronically enabled input in response to the electronically outputted one or more selection menus in video presentation form. Origination of an illustratively derived receiving information presentation component group can be accomplished through skilled in the art design choice selection of one or more of the above depicted components from one or more of the above depicted subsystems shown in FIG. 51. Components from the receiving information presentation component group can be used in implementing execution of the one or more receiving information presentation instructions j1130 of FIG. 47, can be used in performance of the receiving information presentation electrical circuitry arrangement f1130 of FIG. 51, and/or can be used in otherwise fulfillment of the operation p1130. An exemplary non-transitory signal bearing medium version of the information storage subsystem s200 is depicted in FIG. 47 as bearing the one or more receiving information presentation instructions j1130 that when executed will direct performance of the operation p1130. Furthermore, the receiving information presentation electrical circuitry arrangement (“elec circ arrange”) f1130, when activated, will perform the operation p1130. Also, the receiving information presentation module n1130, when executed and/or activated, will direct performance of and/or perform the operation p1130. For instance, in one or more exemplary implementations, the one or more receiving information presentation instructions j1130, when executed, direct performance of the operation p1130 in the illustrative depiction as follows, and/or the receiving information presentation electrical circuitry arrangement f1130, when activated, performs the operation p1130 in the illustrative depiction as follows, and/or the receiving information presentation module n1130, when executed and/or activated, directs performance of and/or performs the operation p1130 in the illustrative depiction as follows, and/or the operation p1130 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to the electronically outputted one or more selection menus in video presentation form (e.g. including an implementation of the receiver component s528 is configured to electronically engage with the processor component s102 to receive the user status information including the one or more identifiers associated with the particular individual living being for the processor component to at least in part electronically generate, based at least in part upon the user status information regarding the particular individual living being, such as based on associated one or more prescriptions, one or more selection menus in video presentation form, such as a menu containing one or more video presentations having one or more descriptions of possible ingestible product to select from, and/or etc.).

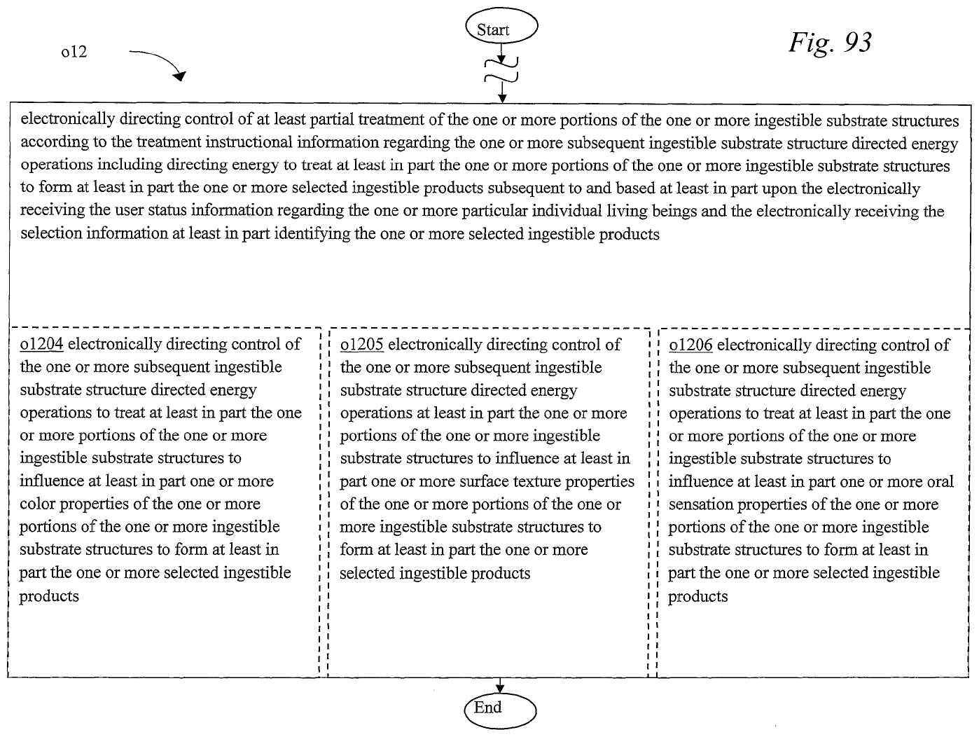

In one or more implementations, as shown in FIG. 93, operation p11 includes an operation p1131 for electronically receiving the selection information at least in part identifying the one or more selected ingestible products being subject to ingestion by the one or more particular individual living beings, the selection information electronically received via the electronically enabled input in response to the electronically outputted one or more selection menus in ingestible sample form. Origination of an illustratively derived receiving information sample component group can be accomplished through skilled in the art design choice selection of one or more of the above depicted components from one or more of the above depicted subsystems shown in FIG. 51. Components from the receiving information sample component group can be used in implementing execution of the one or more receiving information sample instructions j1131 of FIG. 47, can be used in performance of the receiving information sample electrical circuitry arrangement f1131 of FIG. 51, and/or can be used in otherwise fulfillment of the operation p1131. An exemplary non-transitory signal bearing medium version of the information storage subsystem s200 is depicted in FIG. 47 as bearing the one or more receiving information sample instructions j1131 that when executed will direct performance of the operation p1131. Furthermore, the receiving information sample electrical circuitry arrangement (“elec circ arrange”) f1131, when activated, will perform the operation p1131. Also, the receiving information sample module n1131, when executed and/or activated, will direct performance of and/or perform the operation p1131. For instance, in one or more exemplary implementations, the one or more receiving information sample instructions j1131, when executed, direct performance of the operation p1131 in the illustrative depiction as follows, and/or the receiving information sample electrical circuitry arrangement f1131, when activated, performs the operation p1131 in the illustrative depiction as follows, and/or the receiving information sample module n1131, when executed and/or activated, directs performance of and/or performs the operation p1131 in the illustrative depiction as follows, and/or the operation p1131 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to the electronically outputted one or more selection menus in ingestible sample form (e.g. including an implementation of the receiver component s528 is configured to electronically engage with the processor component s102 to receive the user status information including the one or more identifiers associated with the particular individual living being for the processor component to at least in part electronically generate, based at least in part upon the user status information regarding the particular individual living being, such as based on associated one or more holidays stored in one or more databases, one or more selection menus in ingestible sample form, such as a menu containing ingestible samples that are either stored or produced in real time to serve as or otherwise complement one or more descriptions of possible ingestible product to select from, and/or etc.).

In one or more implementations, as shown in FIG. 93, operation p11 includes an operation p1132 for electronically receiving the user status information regarding the one or more particular individual living beings including the one or more identifiers associated with one or more human beings. Origination of an illustratively derived receiving information human component group can be accomplished through skilled in the art design choice selection of one or more of the above depicted components from one or more of the above depicted subsystems shown in FIG. 51. Components from the receiving information human component group can be used in implementing execution of the one or more receiving information human instructions j1132 of FIG. 47, can be used in performance of the receiving information human electrical circuitry arrangement f1132 of FIG. 51, and/or can be used in otherwise fulfillment of the operation p1132. An exemplary non-transitory signal bearing medium version of the information storage subsystem s200 is depicted in FIG. 47 as bearing the one or more receiving information human instructions j1132 that when executed will direct performance of the operation p1132. Furthermore, the receiving information human electrical circuitry arrangement (“elec circ arrange”) f1132, when activated, will perform the operation p1132. Also, the receiving information human module n1132, when executed and/or activated, will direct performance of and/or perform the operation p1132. For instance, in one or more exemplary implementations, the one or more receiving information human instructions j1132, when executed, direct performance of the operation p1132 in the illustrative depiction as follows, and/or the receiving information human electrical circuitry arrangement f1132, when activated, performs the operation p1132 in the illustrative depiction as follows, and/or the receiving information human module n1132, when executed and/or activated, directs performance of and/or performs the operation p1132 in the illustrative depiction as follows, and/or the operation p1132 is otherwise carried out in the illustrative depiction as follows: electronically receiving the user status information regarding the one or more particular individual living beings including the one or more identifiers associated with one or more human beings (e.g. including an implementation of the receiver component s528 is configured to electronically engage with the processor component s102 to receive the user status information regarding the particular individual living being including one or more identifiers as determined by the processor component to be identifying a human being, and/or etc.).

In one or more implementations, as shown in FIG. 93, operation p11 includes an operation p1133 for electronically receiving the user status information regarding the one or more particular individual living beings including the one or more identifiers associated with one or more electronic identification cards. Origination of an illustratively derived receiving information ID card component group can be accomplished through skilled in the art design choice selection of one or more of the above depicted components from one or more of the above depicted subsystems shown in FIG. 51. Components from the receiving information ID card component group can be used in implementing execution of the one or more receiving information ID card instructions j1133 of FIG. 47, can be used in performance of the receiving information ID card electrical circuitry arrangement f1133 of FIG. 51, and/or can be used in otherwise fulfillment of the operation p1133. An exemplary non-transitory signal bearing medium version of the information storage subsystem s200 is depicted in FIG. 47 as bearing the one or more receiving information ID card instructions j1133 that when executed will direct performance of the operation p1133. Furthermore, the receiving information ID card electrical circuitry arrangement (“elec circ arrange”) f1133, when activated, will perform the operation p1133. Also, the receiving information ID card module n1133, when executed and/or activated, will direct performance of and/or perform the operation p1133. For instance, in one or more exemplary implementations, the one or more receiving information ID card instructions j1133, when executed, direct performance of the operation p1133 in the illustrative depiction as follows, and/or the receiving information ID card electrical circuitry arrangement f1133, when activated, performs the operation p1133 in the illustrative depiction as follows, and/or the receiving information ID card module n1133, when executed and/or activated, directs performance of and/or performs the operation p1133 in the illustrative depiction as follows, and/or the operation p1133 is otherwise carried out in the illustrative depiction as follows: electronically receiving the user status information regarding the one or more particular individual living beings including the one or more identifiers associated with one or more electronic identification cards (e.g. including an implementation of the receiver component s528 is configured to electronically engage with the processor component s102 to receive the user status information regarding the particular individual living being including one or more identifiers as determined by the processor component to be identifying a living being through the electronic identification card, and/or etc.).

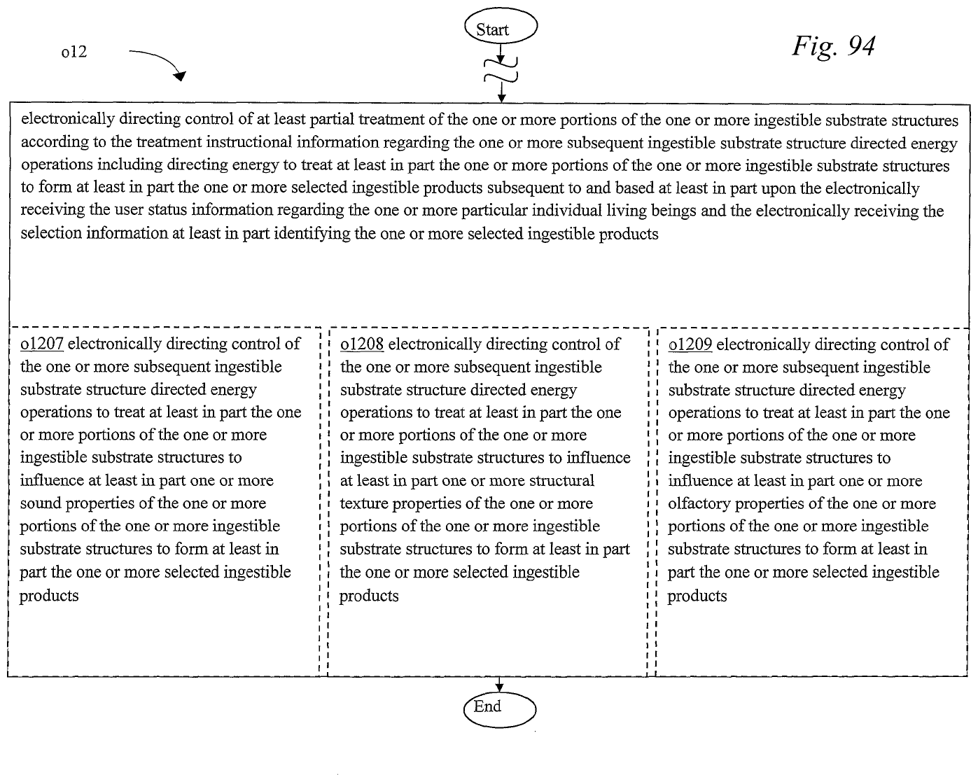

In one or more implementations, as shown in FIG. 94, operation p11 includes an operation p1134 for electronically receiving the user status information regarding the one or more particular individual living beings including the one or more identifiers associated with one or more electronic iris scans. Origination of an illustratively derived receiving information iris scan component group can be accomplished through skilled in the art design choice selection of one or more of the above depicted components from one or more of the above depicted subsystems shown in FIG. 51. Components from the receiving information iris scan component group can be used in implementing execution of the one or more receiving information iris scan instructions j1134 of FIG. 47, can be used in performance of the receiving information iris scan electrical circuitry arrangement f1134 of FIG. 51, and/or can be used in otherwise fulfillment of the operation p1134. An exemplary non-transitory signal bearing medium version of the information storage subsystem s200 is depicted in FIG. 47 as bearing the one or more receiving information iris scan instructions j1134 that when executed will direct performance of the operation p1134. Furthermore, the receiving information iris scan electrical circuitry arrangement (“elec circ arrange”) f1134, when activated, will perform the operation p1134. Also, the receiving information iris scan module n1134, when executed and/or activated, will direct performance of and/or perform the operation p1134. For instance, in one or more exemplary implementations, the one or more receiving information iris scan instructions j1134, when executed, direct performance of the operation p1134 in the illustrative depiction as follows, and/or the receiving information iris scan electrical circuitry arrangement f1134, when activated, performs the operation p1134 in the illustrative depiction as follows, and/or the receiving information iris scan module n1134, when executed and/or activated, directs performance of and/or performs the operation p1134 in the illustrative depiction as follows, and/or the operation p1134 is otherwise carried out in the illustrative depiction as follows: electronically receiving the user status information regarding the one or more particular individual living beings including the one or more identifiers associated with one or more electronic iris scans (e.g. including an implementation of the receiver component s528 is configured to electronically engage with the processor component s102 to receive the user status information regarding the particular individual living being including one or more identifiers as determined by the processor component to be identifying the living being through the electronic iris scan, and/or etc.).

In one or more implementations, as shown in FIG. 94, operation p11 includes an operation p1135 for electronically receiving the user status information regarding the one or more particular individual living beings including the one or more identifiers associated with one or more electronic voice prints. Origination of an illustratively derived receiving information voice component group can be accomplished through skilled in the art design choice selection of one or more of the above depicted components from one or more of the above depicted subsystems shown in FIG. 51. Components from the receiving information voice component group can be used in implementing execution of the one or more receiving information voice instructions j1135 of FIG. 47, can be used in performance of the receiving information voice electrical circuitry arrangement f1135 of FIG. 51, and/or can be used in otherwise fulfillment of the operation p1135. An exemplary non-transitory signal bearing medium version of the information storage subsystem s200 is depicted in FIG. 47 as bearing the one or more receiving information voice instructions j1135 that when executed will direct performance of the operation p1135. Furthermore, the receiving information voice electrical circuitry arrangement (“elec circ arrange”) f1135, when activated, will perform the operation p1135. Also, the receiving information voice module n1135, when executed and/or activated, will direct performance of and/or perform the operation p1135. For instance, in one or more exemplary implementations, the one or more receiving information voice instructions j1135, when executed, direct performance of the operation p1135 in the illustrative depiction as follows, and/or the receiving information voice electrical circuitry arrangement f1135, when activated, performs the operation p1135 in the illustrative depiction as follows, and/or the receiving information voice module n1135, when executed and/or activated, directs performance of and/or performs the operation p1135 in the illustrative depiction as follows, and/or the operation p1135 is otherwise carried out in the illustrative depiction as follows: electronically receiving the user status information regarding the one or more particular individual living beings including the one or more identifiers associated with one or more electronic voice prints (e.g. including an implementation of the receiver component s528 is configured to electronically engage with the processor component s102 to receive the user status information regarding the particular individual living being including one or more identifiers as determined by the processor component to be identifying the living being through the electronic voice print, and/or etc.).

In one or more implementations, as shown in FIG. 94, operation p11 includes an operation p1136 for electronically receiving the user status information regarding the one or more particular individual living beings including the one or more identifiers associated with one or more electronically captured fingerprint images. Origination of an illustratively derived receiving information fingerprint component group can be accomplished through skilled in the art design choice selection of one or more of the above depicted components from one or more of the above depicted subsystems shown in FIG. 51. Components from the receiving information fingerprint component group can be used in implementing execution of the one or more receiving information fingerprint instructions j1136 of FIG. 47, can be used in performance of the receiving information fingerprint electrical circuitry arrangement f1136 of FIG. 51, and/or can be used in otherwise fulfillment of the operation p1136. An exemplary non-transitory signal bearing medium version of the information storage subsystem s200 is depicted in FIG. 47 as bearing the one or more receiving information fingerprint instructions j1136 that when executed will direct performance of the operation p1136. Furthermore, the receiving information fingerprint electrical circuitry arrangement (“elec circ arrange”) f1136, when activated, will perform the operation p1136. Also, the receiving information fingerprint module n1136, when executed and/or activated, will direct performance of and/or perform the operation p1136. For instance, in one or more exemplary implementations, the one or more receiving information fingerprint instructions j1136, when executed, direct performance of the operation p1136 in the illustrative depiction as follows, and/or the receiving information fingerprint electrical circuitry arrangement f1136, when activated, performs the operation p1136 in the illustrative depiction as follows, and/or the receiving information fingerprint module n1136, when executed and/or activated, directs performance of and/or performs the operation p1136 in the illustrative depiction as follows, and/or the operation p1136 is otherwise carried out in the illustrative depiction as follows: electronically receiving the user status information regarding the one or more particular individual living beings including the one or more identifiers associated with one or more electronically captured fingerprint images (e.g. including an implementation of the receiver component s528 is configured to electronically engage with the processor component s102 to receive the user status information regarding the particular individual living being including one or more identifiers as determined by the processor component to be identifying the living being through the electronically captured fingerprint image, and/or etc.).

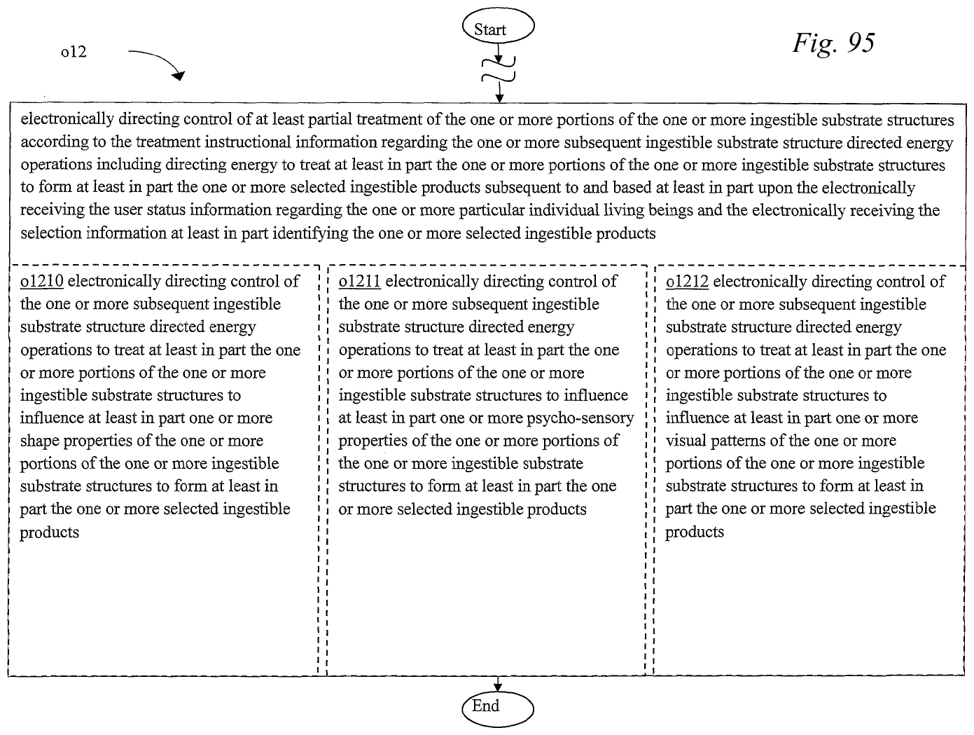

In one or more implementations, as shown in FIG. 95, operation p11 includes an operation p1137 for electronically receiving the user status information regarding the one or more particular individual living beings including the one or more identifiers associated with one or more electronic dental records. Origination of an illustratively derived receiving information dental component group can be accomplished through skilled in the art design choice selection of one or more of the above depicted components from one or more of the above depicted subsystems shown in FIG. 51. Components from the receiving information dental component group can be used in implementing execution of the one or more receiving information dental instructions j1137 of FIG. 47, can be used in performance of the receiving information dental electrical circuitry arrangement f1137 of FIG. 51, and/or can be used in otherwise fulfillment of the operation p1137. An exemplary non-transitory signal bearing medium version of the information storage subsystem s200 is depicted in FIG. 47 as bearing the one or more receiving information dental instructions j1137 that when executed will direct performance of the operation p1137. Furthermore, the receiving information dental electrical circuitry arrangement (“elec circ arrange”) f1137, when activated, will perform the operation p1137. Also, the receiving information dental module n1137, when executed and/or activated, will direct performance of and/or perform the operation p1137. For instance, in one or more exemplary implementations, the one or more receiving information dental instructions j1137, when executed, direct performance of the operation p1137 in the illustrative depiction as follows, and/or the receiving information dental electrical circuitry arrangement f1137, when activated, performs the operation p1137 in the illustrative depiction as follows, and/or the receiving information dental module n1137, when executed and/or activated, directs performance of and/or performs the operation p1137 in the illustrative depiction as follows, and/or the operation p1137 is otherwise carried out in the illustrative depiction as follows: electronically receiving the user status information regarding the one or more particular individual living beings including the one or more identifiers associated with one or more electronic dental records (e.g. including an implementation of the receiver component s528 is configured to electronically engage with the processor component s102 to receive the user status information regarding the particular individual living being including one or more identifiers as determined by the processor component to be identifying the living being through the electronic dental records, and/or etc.).

In one or more implementations, as shown in FIG. 95, operation p11 includes an operation p1138 for electronically receiving the user status information regarding the one or more particular individual living beings including the one or more identifiers associated with one or more RFID tags. Origination of an illustratively derived receiving information RFID component group can be accomplished through skilled in the art design choice selection of one or more of the above depicted components from one or more of the above depicted subsystems shown in FIG. 51. Components from the receiving information RFID component group can be used in implementing execution of the one or more receiving information RFID instructions j1138 of FIG. 47, can be used in performance of the receiving information RFID electrical circuitry arrangement f1138 of FIG. 51, and/or can be used in otherwise fulfillment of the operation p1138. An exemplary non-transitory signal bearing medium version of the information storage subsystem s200 is depicted in FIG. 47 as bearing the one or more receiving information RFID instructions j1138 that when executed will direct performance of the operation p1138. Furthermore, the receiving information RFID electrical circuitry arrangement (“elec circ arrange”) f1138, when activated, will perform the operation p1138. Also, the receiving information RFID module n1138, when executed and/or activated, will direct performance of and/or perform the operation p1138. For instance, in one or more exemplary implementations, the one or more receiving information RFID instructions j1138, when executed, direct performance of the operation p1138 in the illustrative depiction as follows, and/or the receiving information RFID electrical circuitry arrangement f1138, when activated, performs the operation p1138 in the illustrative depiction as follows, and/or the receiving information RFID module n1138, when executed and/or activated, directs performance of and/or performs the operation p1138 in the illustrative depiction as follows, and/or the operation p1138 is otherwise carried out in the illustrative depiction as follows: electronically receiving the user status information regarding the one or more particular individual living beings including the one or more identifiers associated with one or more RFID tags (e.g. including an implementation of the receiver component s528 is configured to electronically engage with the processor component s102 to receive the user status information regarding the particular individual living being including one or more identifiers as determined by the processor component to be identifying the living being through the RFID tag, and/or etc.).

In one or more implementations, as shown in FIG. 95, operation p11 includes an operation p1139 for electronically receiving the user status information regarding the one or more particular individual living beings including the one or more identifiers associated with one or more passwords. Origination of an illustratively derived receiving information password component group can be accomplished through skilled in the art design choice selection of one or more of the above depicted components from one or more of the above depicted subsystems shown in FIG. 51. Components from the receiving information password component group can be used in implementing execution of the one or more receiving information password instructions j1139 of FIG. 47, can be used in performance of the receiving information password electrical circuitry arrangement f1139 of FIG. 51, and/or can be used in otherwise fulfillment of the operation p1139. An exemplary non-transitory signal bearing medium version of the information storage subsystem s200 is depicted in FIG. 47 as bearing the one or more receiving information password instructions j1139 that when executed will direct performance of the operation p1139. Furthermore, the receiving information password electrical circuitry arrangement (“elec circ arrange”) f1139, when activated, will perform the operation p1139. Also, the receiving information password module n1139, when executed and/or activated, will direct performance of and/or perform the operation p1139. For instance, in one or more exemplary implementations, the one or more receiving information password instructions j1139, when executed, direct performance of the operation p1139 in the illustrative depiction as follows, and/or the receiving information password electrical circuitry arrangement f1139, when activated, performs the operation p1139 in the illustrative depiction as follows, and/or the receiving information password module n1139, when executed and/or activated, directs performance of and/or performs the operation p1139 in the illustrative depiction as follows, and/or the operation p1139 is otherwise carried out in the illustrative depiction as follows: electronically receiving the user status information regarding the one or more particular individual living beings including the one or more identifiers associated with one or more passwords (e.g. including an implementation of the receiver component s528 is configured to electronically engage with the processor component s102 to receive the user status information regarding the particular individual living being including one or more identifiers as determined by the processor component to be identifying the living being through the password, and/or etc.).

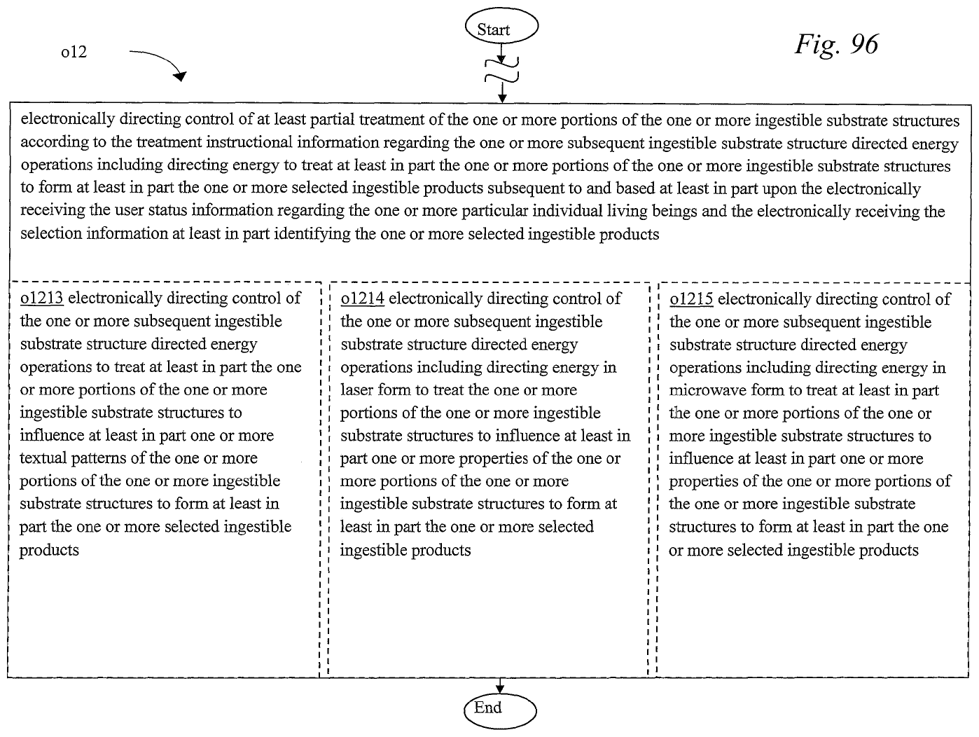

In one or more implementations, as shown in FIG. 96, operation p11 includes an operation p1140 for electronically receiving the user status information regarding the one or more particular individual living beings including the one or more identifiers associated with one or more fobs. Origination of an illustratively derived receiving information fob component group can be accomplished through skilled in the art design choice selection of one or more of the above depicted components from one or more of the above depicted subsystems shown in FIG. 51. Components from the receiving information fob component group can be used in implementing execution of the one or more receiving information fob instructions j1140 of FIG. 48, can be used in performance of the receiving information fob electrical circuitry arrangement f1140 of FIG. 52, and/or can be used in otherwise fulfillment of the operation p1140. An exemplary non-transitory signal bearing medium version of the information storage subsystem s200 is depicted in FIG. 48 as bearing the one or more receiving information fob instructions j1140 that when executed will direct performance of the operation p1140. Furthermore, the receiving information fob electrical circuitry arrangement (“elec circ arrange”) f1140, when activated, will perform the operation p1140. Also, the receiving information fob module n1140, when executed and/or activated, will direct performance of and/or perform the operation p1140. For instance, in one or more exemplary implementations, the one or more receiving information fob instructions j1140, when executed, direct performance of the operation p1140 in the illustrative depiction as follows, and/or the receiving information fob electrical circuitry arrangement f1140, when activated, performs the operation p1140 in the illustrative depiction as follows, and/or the receiving information fob module n1140, when executed and/or activated, directs performance of and/or performs the operation p1140 in the illustrative depiction as follows, and/or the operation p1140 is otherwise carried out in the illustrative depiction as follows: electronically receiving the user status information regarding the one or more particular individual living beings including the one or more identifiers associated with one or more fobs (e.g. including an implementation of the receiver component s528 is configured to electronically engage with the processor component s102 to receive the user status information regarding the particular individual living being including one or more identifiers as determined by the processor component to be identifying the living being through electronic data contained on the fob, and/or etc.).

In one or more implementations, as shown in FIG. 96, operation p11 includes an operation p1141 for electronically receiving the user status information regarding the one or more particular individual living beings including the one or more identifiers associated with one or more cell phone swipes. Origination of an illustratively derived receiving information cell phone component group can be accomplished through skilled in the art design choice selection of one or more of the above depicted components from one or more of the above depicted subsystems shown in FIG. 51. Components from the receiving information cell phone component group can be used in implementing execution of the one or more receiving information cell phone instructions j1141 of FIG. 48, can be used in performance of the receiving information cell phone electrical circuitry arrangement f1141 of FIG. 52, and/or can be used in otherwise fulfillment of the operation p1141. An exemplary non-transitory signal bearing medium version of the information storage subsystem s200 is depicted in FIG. 48 as bearing the one or more receiving information cell phone instructions j1141 that when executed will direct performance of the operation p1141. Furthermore, the receiving information cell phone electrical circuitry arrangement (“elec circ arrange”) f1141, when activated, will perform the operation p1141. Also, the receiving information cell phone module n1141, when executed and/or activated, will direct performance of and/or perform the operation p1141. For instance, in one or more exemplary implementations, the one or more receiving information cell phone instructions j1141, when executed, direct performance of the operation p1141 in the illustrative depiction as follows, and/or the receiving information cell phone electrical circuitry arrangement f1141, when activated, performs the operation p1141 in the illustrative depiction as follows, and/or the receiving information cell phone module n1141, when executed and/or activated, directs performance of and/or performs the operation p1141 in the illustrative depiction as follows, and/or the operation p1141 is otherwise carried out in the illustrative depiction as follows: electronically receiving the user status information regarding the one or more particular individual living beings including the one or more identifiers associated with one or more cell phone swipes (e.g. including an implementation of the receiver component s528 is configured to electronically engage with the processor component s102 to receive the user status information regarding the particular individual living being including one or more identifiers as determined by the processor component to be identifying the living being through passing the cell phone in close proximity to the cell phone, and/or etc.).

In one or more implementations, as shown in FIG. 96, operation p11 includes an operation p1142 for electronically receiving the user status information regarding the one or more particular individual living beings including the one or more identifiers associated with one or more breathalyzer tests. Origination of an illustratively derived receiving information breathalyzer component group can be accomplished through skilled in the art design choice selection of one or more of the above depicted components from one or more of the above depicted subsystems shown in FIG. 51. Components from the receiving information breathalyzer component group can be used in implementing execution of the one or more receiving information breathalyzer instructions j1142 of FIG. 48, can be used in performance of the receiving information breathalyzer electrical circuitry arrangement f1142 of FIG. 52, and/or can be used in otherwise fulfillment of the operation p1142. An exemplary non-transitory signal bearing medium version of the information storage subsystem s200 is depicted in FIG. 48 as bearing the one or more receiving information breathalyzer instructions j1142 that when executed will direct performance of the operation p1142. Furthermore, the receiving information breathalyzer electrical circuitry arrangement (“elec circ arrange”) f1142, when activated, will perform the operation p1142. Also, the receiving information breathalyzer module n1142, when executed and/or activated, will direct performance of and/or perform the operation p1142. For instance, in one or more exemplary implementations, the one or more receiving information breathalyzer instructions j1142, when executed, direct performance of the operation p1142 in the illustrative depiction as follows, and/or the receiving information breathalyzer electrical circuitry arrangement f1142, when activated, performs the operation p1142 in the illustrative depiction as follows, and/or the receiving information breathalyzer module n1142, when executed and/or activated, directs performance of and/or performs the operation p1142 in the illustrative depiction as follows, and/or the operation p1142 is otherwise carried out in the illustrative depiction as follows: electronically receiving the user status information regarding the one or more particular individual living beings including the one or more identifiers associated with one or more breathalyzer tests (e.g. including an implementation of the receiver component s528 is configured to electronically engage with the processor component s102 to receive the user status information regarding the particular individual living being including one or more identifiers as determined by the processor component to be identifying the living being through the breathalyzer test of the living being, and/or etc.).

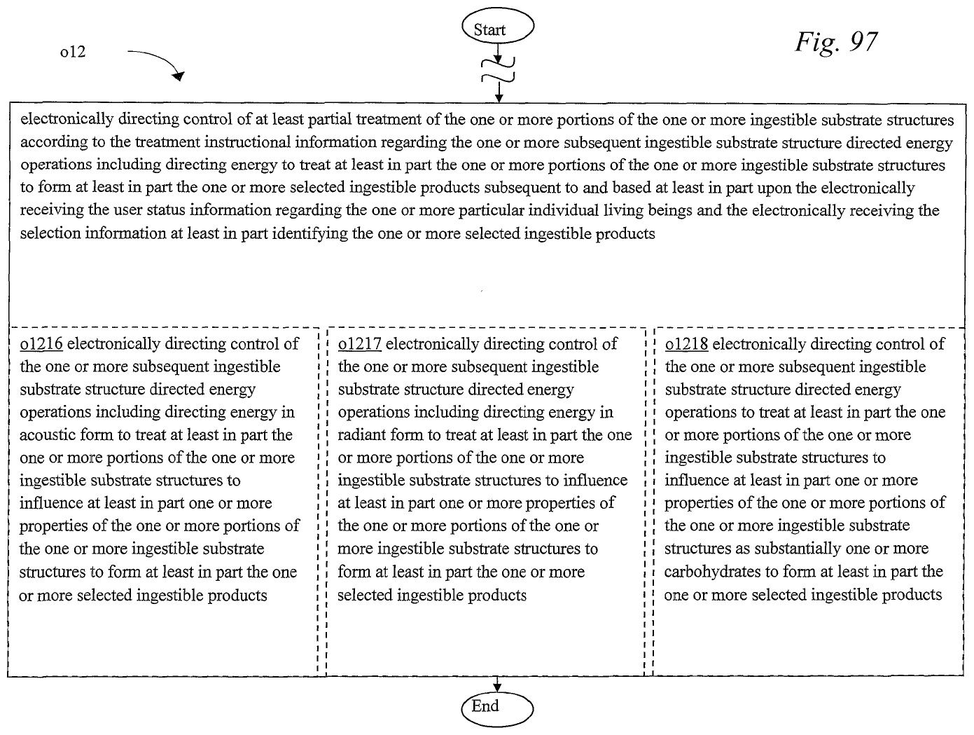

In one or more implementations, as shown in FIG. 97, operation p11 includes an operation p1143 for electronically receiving the selection information at least in part identifying the one or more selected ingestible products to incorporate one or more substances therein during the one or more substrate structure directed energy operations thereof. Origination of an illustratively derived receiving information incorporate component group can be accomplished through skilled in the art design choice selection of one or more of the above depicted components from one or more of the above depicted subsystems shown in FIG. 51. Components from the receiving information incorporate component group can be used in implementing execution of the one or more receiving information incorporate instructions j1143 of FIG. 48, can be used in performance of the receiving information incorporate electrical circuitry arrangement f1143 of FIG. 52, and/or can be used in otherwise fulfillment of the operation p1143. An exemplary non-transitory signal bearing medium version of the information storage subsystem s200 is depicted in FIG. 48 as bearing the one or more receiving information incorporate instructions j1143 that when executed will direct performance of the operation p1143. Furthermore, the receiving information incorporate electrical circuitry arrangement (“elec circ arrange”) f1143, when activated, will perform the operation p1143. Also, the receiving information incorporates module n1143, when executed and/or activated, will direct performance of and/or perform the operation p1143. For instance, in one or more exemplary implementations, the one or more receiving information incorporate instructions j1143, when executed, direct performance of the operation p1143 in the illustrative depiction as follows, and/or the receiving information incorporate electrical circuitry arrangement f1143, when activated, performs the operation p1143 in the illustrative depiction as follows, and/or the receiving information incorporate module n1143, when executed and/or activated, directs performance of and/or performs the operation p1143 in the illustrative depiction as follows, and/or the operation p1143 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to incorporate one or more substances (e.g. including an implementation of the receiver component s528 is configured to electronically receive the selection information and to engage with the processor component s102 to at least in part electronically identify one or more selected ingestible products to incorporate one or more substances such as a sandwich to include the substance as an amino acid incorporated into the sandwich, and/or etc.) therein during the one or more substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) thereof.

In one or more implementations, as shown in FIG. 97, operation p11 includes an operation p1144 for electronically receiving the selection information at least in part identifying the one or more selected ingestible products to be ingested over a period of days. Origination of an illustratively derived receiving information days component group can be accomplished through skilled in the art design choice selection of one or more of the above depicted components from one or more of the above depicted subsystems shown in FIG. 51. Components from the receiving information days component group can be used in implementing execution of the one or more receiving information days instructions j1144 of FIG. 48, can be used in performance of the receiving information days electrical circuitry arrangement f1144 of FIG. 52, and/or can be used in otherwise fulfillment of the operation p1144. An exemplary non-transitory signal bearing medium version of the information storage subsystem s200 is depicted in FIG. 48 as bearing the one or more receiving information days instructions j1144 that when executed will direct performance of the operation p1144. Furthermore, the receiving information days electrical circuitry arrangement (“elec circ arrange”) f1144, when activated, will perform the operation p1144. Also, the receiving information days module n1144, when executed and/or activated, will direct performance of and/or perform the operation p1144. For instance, in one or more exemplary implementations, the one or more receiving information days instructions j1144, when executed, direct performance of the operation p1144 in the illustrative depiction as follows, and/or the receiving information days electrical circuitry arrangement f1144, when activated, performs the operation p1144 in the illustrative depiction as follows, and/or the receiving information days module n1144, when executed and/or activated, directs performance of and/or performs the operation p1144 in the illustrative depiction as follows, and/or the operation p1144 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be ingested over a period of days (e.g. including an implementation of the receiver component s528 is configured to electronically receive the selection information and engage with the processor component s102 to at least in part electronically identify one or more selected ingestible products to be ingested over a period of days such as a smoothie to contain an activator that is designed to interact with a substance, such as a pharmaceutical agent that is encapsulated in pill form to be ingested over a period of days by a living being, such as a boy, at the same time that the smoothie is being ingested by the boy, and/or etc.).

In one or more implementations, as shown in FIG. 97, operation p11 includes an operation p1145 for electronically receiving the selection information at least in part identifying the one or more selected ingestible products to be swallowed. Origination of an illustratively derived receiving information swallow component group can be accomplished through skilled in the art design choice selection of one or more of the above depicted components from one or more of the above depicted subsystems shown in FIG. 51. Components from the receiving information swallow component group can be used in implementing execution of the one or more receiving information swallow instructions j1145 of FIG. 48, can be used in performance of the receiving information swallow electrical circuitry arrangement f1145 of FIG. 52, and/or can be used in otherwise fulfillment of the operation p1145. An exemplary non-transitory signal bearing medium version of the information storage subsystem s200 is depicted in FIG. 48 as bearing the one or more receiving information swallow instructions j1145 that when executed will direct performance of the operation p1145. Furthermore, the receiving information swallow electrical circuitry arrangement (“elec circ arrange”) f1145, when activated, will perform the operation p1145. Also, the receiving information swallow module n1145, when executed and/or activated, will direct performance of and/or perform the operation p1145. For instance, in one or more exemplary implementations, the one or more receiving information swallow instructions j1145, when executed, direct performance of the operation p1145 in the illustrative depiction as follows, and/or the receiving information swallow electrical circuitry arrangement f1145, when activated, performs the operation p1145 in the illustrative depiction as follows, and/or the receiving information swallow module n1145, when executed and/or activated, directs performance of and/or performs the operation p1145 in the illustrative depiction as follows, and/or the operation p1145 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be swallowed (e.g. including an implementation of the receiver component s528 is configured to electronically receive the selection information and engage with the processor component s102 to direct the material processing subsystem s700 to electronically identify the one or more selected ingestible products to be swallowed such as a snack bar, and/or etc.).

In one or more implementations, as shown in FIG. 98, operation p11 includes an operation p1146 for electronically receiving the selection information at least in part identifying the one or more selected ingestible products to be inhaled. Origination of an illustratively derived receiving information inhaled component group can be accomplished through skilled in the art design choice selection of one or more of the above depicted components from one or more of the above depicted subsystems shown in FIG. 51. Components from the receiving information inhaled component group can be used in implementing execution of the one or more receiving information inhaled instructions j1146 of FIG. 48, can be used in performance of the receiving information inhaled electrical circuitry arrangement f1146 of FIG. 52, and/or can be used in otherwise fulfillment of the operation p1146. An exemplary non-transitory signal bearing medium version of the information storage subsystem s200 is depicted in FIG. 48 as bearing the one or more receiving information inhaled instructions j1146 that when executed will direct performance of the operation p1146. Furthermore, the receiving information inhaled electrical circuitry arrangement (“elec circ arrange”) f1146, when activated, will perform the operation p1146. Also, the receiving information inhaled module n1146, when executed and/or activated, will direct performance of and/or perform the operation p1146. For instance, in one or more exemplary implementations, the one or more receiving information inhaled instructions j1146, when executed, direct performance of the operation p1146 in the illustrative depiction as follows, and/or the receiving information inhaled electrical circuitry arrangement f1146, when activated, performs the operation p1146 in the illustrative depiction as follows, and/or the receiving information inhaled module n1146, when executed and/or activated, directs performance of and/or performs the operation p1146 in the illustrative depiction as follows, and/or the operation p1146 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be inhaled (e.g. including an implementation of the receiver component s528 is configured to electronically receive the selection information and engage with the processor component s102 to direct the material processing subsystem s700 to electronically identify the one or more selected ingestible products to be inhaled such as a medicament dispensed through a nebulizer, and/or etc.).

In one or more implementations, as shown in FIG. 98, operation p11 includes an operation p1147 for electronically receiving the selection information at least in part identifying the one or more selected ingestible products to be ingested via a tube. Origination of an illustratively derived receiving information tube component group can be accomplished through skilled in the art design choice selection of one or more of the above depicted components from one or more of the above depicted subsystems shown in FIG. 51. Components from the receiving information tube component group can be used in implementing execution of the one or more receiving information tube instructions j1147 of FIG. 48, can be used in performance of the receiving information tube electrical circuitry arrangement f1147 of FIG. 52, and/or can be used in otherwise fulfillment of the operation p1147. An exemplary non-transitory signal bearing medium version of the information storage subsystem s200 is depicted in FIG. 48 as bearing the one or more receiving information tube instructions j1147 that when executed will direct performance of the operation p1147. Furthermore, the receiving information tube electrical circuitry arrangement (“elec circ arrange”) f1147, when activated, will perform the operation p1147. Also, the receiving information tube module n1147, when executed and/or activated, will direct performance of and/or perform the operation p1147. For instance, in one or more exemplary implementations, the one or more receiving information tube instructions j1147, when executed, direct performance of the operation p1147 in the illustrative depiction as follows, and/or the receiving information tube electrical circuitry arrangement f1147, when activated, performs the operation p1147 in the illustrative depiction as follows, and/or the receiving information tube module n1147, when executed and/or activated, directs performance of and/or performs the operation p1147 in the illustrative depiction as follows, and/or the operation p1147 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be ingested via a tube (e.g. including an implementation of the receiver component s528 is configured to electronically receive the selection information and engage with the processor component s102 to direct the material processing subsystem s700 to electronically identify at least in part the one or more selected ingestible products to be ingested via a tube such as a liquid meal replacement, and/or etc.).

In one or more implementations, as shown in FIG. 98, operation p11 includes an operation p1148 for electronically receiving the selection information at least in part identifying the one or more selected ingestible products to be ingested transdermally. Origination of an illustratively derived receiving information transdermal component group can be accomplished through skilled in the art design choice selection of one or more of the above depicted components from one or more of the above depicted subsystems shown in FIG. 51. Components from the receiving information transdermal component group can be used in implementing execution of the one or more receiving information transdermal instructions j1148 of FIG. 48, can be used in performance of the receiving information transdermal electrical circuitry arrangement f1148 of FIG. 52, and/or can be used in otherwise fulfillment of the operation p1148. An exemplary non-transitory signal bearing medium version of the information storage subsystem s200 is depicted in FIG. 48 as bearing the one or more receiving information transdermal instructions j1148 that when executed will direct performance of the operation p1148. Furthermore, the receiving information transdermal electrical circuitry arrangement (“elec circ arrange”) f1148, when activated, will perform the operation p1148. Also, the receiving information transdermal module n1148, when executed and/or activated, will direct performance of and/or perform the operation p1148. For instance, in one or more exemplary implementations, the one or more receiving information transdermal instructions j1148, when executed, direct performance of the operation p1148 in the illustrative depiction as follows, and/or the receiving information transdermal electrical circuitry arrangement f1148, when activated, performs the operation p1148 in the illustrative depiction as follows, and/or the receiving information transdermal module n1148, when executed and/or activated, directs performance of and/or performs the operation p1148 in the illustrative depiction as follows, and/or the operation p1148 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be ingested transdermally (e.g. including an implementation of the receiver component s528 is configured to electronically receive the selection information and engage with the processor component s102 to direct the material processing subsystem s700 to at least in part electronically identify the one or more selected ingestible products to be ingested transdermally such as a cream, and/or etc.).

In one or more implementations, as shown in FIG. 99, operation p11 includes an operation p1149 for electronically receiving the selection information at least in part identifying the one or more selected ingestible products to be used in capsule form. Origination of an illustratively derived receiving information capsule component group can be accomplished through skilled in the art design choice selection of one or more of the above depicted components from one or more of the above depicted subsystems shown in FIG. 51. Components from the receiving information capsule component group can be used in implementing execution of the one or more receiving information capsule instructions j1149 of FIG. 48, can be used in performance of the receiving information capsule electrical circuitry arrangement f1149 of FIG. 52, and/or can be used in otherwise fulfillment of the operation p1149. An exemplary non-transitory signal bearing medium version of the information storage subsystem s200 is depicted in FIG. 48 as bearing the one or more receiving information capsule instructions j1149 that when executed will direct performance of the operation p1149. Furthermore, the receiving information capsule electrical circuitry arrangement (“elec circ arrange”) f1149, when activated, will perform the operation p1149. Also, the receiving information capsule module n1149, when executed and/or activated, will direct performance of and/or perform the operation p1149. For instance, in one or more exemplary implementations, the one or more receiving information capsule instructions j1149, when executed, direct performance of the operation p1149 in the illustrative depiction as follows, and/or the receiving information capsule electrical circuitry arrangement f1149, when activated, performs the operation p1149 in the illustrative depiction as follows, and/or the receiving information capsule module n1149, when executed and/or activated, directs performance of and/or performs the operation p1149 in the illustrative depiction as follows, and/or the operation p1149 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be used in capsule form (e.g. including an implementation of the receiver component s528 is configured to electronically receive the selection information and engage with the processor component s102 to direct the material processing subsystem s700 to at least in part electronically generate the one or more selection menus electronically identifying at least in part the one or more selected ingestible products to be used in capsule form, such as through capsules via encapsulation, and/or etc.).

In one or more implementations, as shown in FIG. 99, operation p11 includes an operation p1150 for electronically receiving the selection information at least in part identifying the one or more selected ingestible products to be used in sandwich form. Origination of an illustratively derived receiving information sandwich component group can be accomplished through skilled in the art design choice selection of one or more of the above depicted components from one or more of the above depicted subsystems shown in FIG. 51. Components from the receiving information sandwich component group can be used in implementing execution of the one or more receiving information sandwich instructions j1150 of FIG. 48, can be used in performance of the receiving information sandwich electrical circuitry arrangement f1150 of FIG. 52, and/or can be used in otherwise fulfillment of the operation p1150. An exemplary non-transitory signal bearing medium version of the information storage subsystem s200 is depicted in FIG. 48 as bearing the one or more receiving information sandwich instructions j1150 that when executed will direct performance of the operation p1150. Furthermore, the receiving information sandwich electrical circuitry arrangement (“elec circ arrange”) f1150, when activated, will perform the operation p1150. Also, the receiving information sandwich module n1150, when executed and/or activated, will direct performance of and/or perform the operation p1150. For instance, in one or more exemplary implementations, the one or more receiving information sandwich instructions j1150, when executed, direct performance of the operation p1150 in the illustrative depiction as follows, and/or the receiving information sandwich electrical circuitry arrangement f1150, when activated, performs the operation p1150 in the illustrative depiction as follows, and/or the receiving information sandwich module n1150, when executed and/or activated, directs performance of and/or performs the operation p1150 in the illustrative depiction as follows, and/or the operation p1150 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be used in sandwich form (e.g. including an implementation of the receiver component s528 is configured to electronically receive the selection information and engage with the processor component s102 to at least in part electronically identify the one or more selected ingestible products in sandwich form such as a hamburger, and/or etc.).

In one or more implementations, as shown in FIG. 99, operation p11 includes an operation p1151 for electronically receiving the selection information at least in part identifying the one or more selected ingestible products to be used at least partially as a soup. Origination of an illustratively derived receiving information soup component group can be accomplished through skilled in the art design choice selection of one or more of the above depicted components from one or more of the above depicted subsystems shown in FIG. 51. Components from the receiving information soup component group can be used in implementing execution of the one or more receiving information soup instructions j1151 of FIG. 48, can be used in performance of the receiving information soup electrical circuitry arrangement f1151 of FIG. 52, and/or can be used in otherwise fulfillment of the operation p1151. An exemplary non-transitory signal bearing medium version of the information storage subsystem s200 is depicted in FIG. 48 as bearing the one or more receiving information soup instructions j1151 that when executed will direct performance of the operation p1151. Furthermore, the receiving information soup electrical circuitry arrangement (“elec circ arrange”) f1151, when activated, will perform the operation p1151. Also, the receiving information soup module n1151, when executed and/or activated, will direct performance of and/or perform the operation p1151. For instance, in one or more exemplary implementations, the one or more receiving information soup instructions j1151, when executed, direct performance of the operation p1151 in the illustrative depiction as follows, and/or the receiving information soup electrical circuitry arrangement f1151, when activated, performs the operation p1151 in the illustrative depiction as follows, and/or the receiving information soup module n1151, when executed and/or activated, directs performance of and/or performs the operation p1151 in the illustrative depiction as follows, and/or the operation p1151 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be used at least partially as a soup (e.g. including an implementation of the receiver component s528 is configured to electronically receive the selection information and engage with the processor component s102 to at least in part electronically identify the one or more selected ingestible products to be used as a soup such as tomato soup, and/or etc.).

In one or more implementations, as shown in FIG. 100, operation p11 includes an operation p1152 for electronically receiving the selection information at least in part identifying the one or more selected ingestible products to be used as at least partially as a smoothie. Origination of an illustratively derived receiving information smoothie component group can be accomplished through skilled in the art design choice selection of one or more of the above depicted components from one or more of the above depicted subsystems shown in FIG. 51. Components from the receiving information smoothie component group can be used in implementing execution of the one or more receiving information smoothie instructions j1152 of FIG. 48, can be used in performance of the receiving information smoothie electrical circuitry arrangement f1152 of FIG. 52, and/or can be used in otherwise fulfillment of the operation p1152. An exemplary non-transitory signal bearing medium version of the information storage subsystem s200 is depicted in FIG. 48 as bearing the one or more receiving information smoothie instructions j1152 that when executed will direct performance of the operation p1152. Furthermore, the receiving information smoothie electrical circuitry arrangement (“elec circ arrange”) f1152, when activated, will perform the operation p1152. Also, the receiving information smoothie module n1152, when executed and/or activated, will direct performance of and/or perform the operation p1152. For instance, in one or more exemplary implementations, the one or more receiving information smoothie instructions j1152, when executed, direct performance of the operation p1152 in the illustrative depiction as follows, and/or the receiving information smoothie electrical circuitry arrangement f1152, when activated, performs the operation p1152 in the illustrative depiction as follows, and/or the receiving information smoothie module n1152, when executed and/or activated, directs performance of and/or performs the operation p1152 in the illustrative depiction as follows, and/or the operation p1152 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be used as at least partially as a smoothie (e.g. including an implementation of the receiver component s528 is configured to electronically receive the selection information and engage with the processor component s102 to at least in part electronically identify the one or more selected ingestible products to be used a smoothie such as a fruit smoothie, and/or etc.).

In one or more implementations, as shown in FIG. 100, operation p11 includes an operation p1153 for electronically receiving the selection information at least in part identifying the one or more selected ingestible products to be used at least partially as a baked good. Origination of an illustratively derived receiving information baked component group can be accomplished through skilled in the art design choice selection of one or more of the above depicted components from one or more of the above depicted subsystems shown in FIG. 51. Components from the receiving information baked component group can be used in implementing execution of the one or more receiving information baked instructions j1153 of FIG. 48, can be used in performance of the receiving information baked electrical circuitry arrangement f1153 of FIG. 52, and/or can be used in otherwise fulfillment of the operation p1153. An exemplary non-transitory signal bearing medium version of the information storage subsystem s200 is depicted in FIG. 48 as bearing the one or more receiving information baked instructions j1153 that when executed will direct performance of the operation p1153. Furthermore, the receiving information baked electrical circuitry arrangement (“elec circ arrange”) f1153, when activated, will perform the operation p1153. Also, the receiving information baked module n1153, when executed and/or activated, will direct performance of and/or perform the operation p1153. For instance, in one or more exemplary implementations, the one or more receiving information baked instructions j1153, when executed, direct performance of the operation p1153 in the illustrative depiction as follows, and/or the receiving information baked electrical circuitry arrangement f1153, when activated, performs the operation p1153 in the illustrative depiction as follows, and/or the receiving information baked module n1153, when executed and/or activated, directs performance of and/or performs the operation p1153 in the illustrative depiction as follows, and/or the operation p1153 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be used at least partially as a baked good (e.g. including an implementation of the receiver component s528 is configured to electronically receive the selection information and engage with the processor component s102 to at least in part electronically identifying at least in part the one or more selected ingestible products to be used as a baked good such as a muffin, and/or etc.).

In one or more implementations, as shown in FIG. 100, operation p11 includes an operation p1154 for electronically receiving the selection information at least in part identifying the one or more selected ingestible products to be used as a deposited material. Origination of an illustratively derived receiving information deposited component group can be accomplished through skilled in the art design choice selection of one or more of the above depicted components from one or more of the above depicted subsystems shown in FIG. 51. Components from the receiving information deposited component group can be used in implementing execution of the one or more receiving information deposited instructions j1154 of FIG. 48, can be used in performance of the receiving information deposited electrical circuitry arrangement f1154 of FIG. 52, and/or can be used in otherwise fulfillment of the operation p1154. An exemplary non-transitory signal bearing medium version of the information storage subsystem s200 is depicted in FIG. 48 as bearing the one or more receiving information deposited instructions j1154 that when executed will direct performance of the operation p1154. Furthermore, the receiving information deposited electrical circuitry arrangement (“elec circ arrange”) f1154, when activated, will perform the operation p1154. Also, the receiving information deposited module n1154, when executed and/or activated, will direct performance of and/or perform the operation p1154. For instance, in one or more exemplary implementations, the one or more receiving information deposited instructions j1154, when executed, direct performance of the operation p1154 in the illustrative depiction as follows, and/or the receiving information deposited electrical circuitry arrangement f1154, when activated, performs the operation p1154 in the illustrative depiction as follows, and/or the receiving information deposited module n1154, when executed and/or activated, directs performance of and/or performs the operation p1154 in the illustrative depiction as follows, and/or the operation p1154 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be used as a deposited material (e.g. including an implementation of the receiver component s528 is configured to electronically receive the selection information and engage with the processor component s102 to direct the material processing subsystem s700 to at least in part electronically identify at least in part the one or more selected ingestible products to be used as a deposited material such as frosting on a multi-layered cake, and/or etc.).

In one or more implementations, as shown in FIG. 101, operation p11 includes an operation p1155 for electronically receiving the selection information at least in part identifying the one or more selected ingestible products to be used as an assembled concoction. Origination of an illustratively derived receiving information assembled component group can be accomplished through skilled in the art design choice selection of one or more of the above depicted components from one or more of the above depicted subsystems shown in FIG. 51. Components from the receiving information assembled component group can be used in implementing execution of the one or more receiving information assembled instructions j1155 of FIG. 48, can be used in performance of the receiving information assembled electrical circuitry arrangement f1155 of FIG. 52, and/or can be used in otherwise fulfillment of the operation p1155. An exemplary non-transitory signal bearing medium version of the information storage subsystem s200 is depicted in FIG. 48 as bearing the one or more receiving information assembled instructions j1155 that when executed will direct performance of the operation p1155. Furthermore, the receiving information assembled electrical circuitry arrangement (“elec circ arrange”) f1155, when activated, will perform the operation p1155. Also, the receiving information assembled module n1155, when executed and/or activated, will direct performance of and/or perform the operation p1155. For instance, in one or more exemplary implementations, the one or more receiving information assembled instructions j1155, when executed, direct performance of the operation p1155 in the illustrative depiction as follows, and/or the receiving information assembled electrical circuitry arrangement f1155, when activated, performs the operation p1155 in the illustrative depiction as follows, and/or the receiving information assembled module n1155, when executed and/or activated, directs performance of and/or performs the operation p1155 in the illustrative depiction as follows, and/or the operation p1155 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be used as an assembled concoction (e.g. including an implementation of the receiver component s528 is configured to electronically receive the selection information and engage with the processor component s102 to direct the material processing subsystem s700 to at least in part electronically identify at least the one or more selected ingestible products to be used as an assembled concoction such as a decorated confection, and/or etc.).

In one or more implementations, as shown in FIG. 101, operation p11 includes an operation p1156 for electronically receiving the selection information at least in part identifying the one or more selected ingestible products to be used as a main entrée, a dessert, a liquid drink, an emulsion, a snack, a meal, or a combination thereof. Origination of an illustratively derived receiving information uses component group can be accomplished through skilled in the art design choice selection of one or more of the above depicted components from one or more of the above depicted subsystems shown in FIG. 51. Components from the receiving information uses component group can be used in implementing execution of the one or more receiving information uses instructions j1156 of FIG. 48, can be used in performance of the receiving information uses electrical circuitry arrangement f1156 of FIG. 52, and/or can be used in otherwise fulfillment of the operation p1156. An exemplary non-transitory signal bearing medium version of the information storage subsystem s200 is depicted in FIG. 48 as bearing the one or more receiving information uses instructions j1156 that when executed will direct performance of the operation p1156. Furthermore, the receiving information uses electrical circuitry arrangement (“elec circ arrange”) f1156, when activated, will perform the operation p1156. Also, the receiving information uses module n1156, when executed and/or activated, will direct performance of and/or perform the operation p1156. For instance, in one or more exemplary implementations, the one or more receiving information uses instructions j1156, when executed, direct performance of the operation p1156 in the illustrative depiction as follows, and/or the receiving information uses electrical circuitry arrangement f1156, when activated, performs the operation p1156 in the illustrative depiction as follows, and/or the receiving information uses module n1156, when executed and/or activated, directs performance of and/or performs the operation p1156 in the illustrative depiction as follows, and/or the operation p1156 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be used as a main entrée, a dessert, a liquid drink, an emulsion, a snack, a meal, or a combination thereof (e.g. including an implementation of the receiver component s528 is configured to electronically receive the selection information and engage with the processor component s102 to at least in part electronically identify the one or more selected ingestible products to be used as a as a main entrée, a dessert, a liquid drink, an emulsion, a snack, a meal, or a combination thereof such as a steak dinner, and/or etc.).

In one or more implementations, as shown in FIG. 101, operation p11 includes an operation p1157 for electronically receiving the selection information at least in part identifying the one or more selected ingestible products to be used periodically. Origination of illustratively derived receiving information periods component group can be accomplished through skilled in the art design choice selection of one or more of the above depicted components from one or more of the above depicted subsystems shown in FIG. 51. Components from the receiving information periods component group can be used in implementing execution of the one or more receiving information periods instructions j1157 of FIG. 48, can be used in performance of the receiving information periods electrical circuitry arrangement f1157 of FIG. 52, and/or can be used in otherwise fulfillment of the operation p1157. An exemplary non-transitory signal bearing medium version of the information storage subsystem s200 is depicted in FIG. 48 as bearing the one or more receiving information periods instructions j1157 that when executed will direct performance of the operation p1157. Furthermore, the receiving information periods electrical circuitry arrangement (“elec circ arrange”) f1157, when activated, will perform the operation p1157. Also, the receiving information periods module n1157, when executed and/or activated, will direct performance of and/or perform the operation p1157. For instance, in one or more exemplary implementations, the one or more receiving information periods instructions j1157, when executed, direct performance of the operation p1157 in the illustrative depiction as follows, and/or the receiving information periods electrical circuitry arrangement f1157, when activated, performs the operation p1157 in the illustrative depiction as follows, and/or the receiving information periods module n1157, when executed and/or activated, directs performance of and/or performs the operation p1157 in the illustrative depiction as follows, and/or the operation p1157 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) to be used periodically (e.g. including an implementation of the receiver component s528 is configured to electronically receive the selection information and engage with the processor component s102 to at least in part electronically identify the one or more selected ingestible products to be used periodically such as once a week, and/or etc.).

In one or more implementations, as shown in FIG. 91, operation p11 includes an operation p1158 for electronically receiving the selection information at least in part identifying the one or more selected ingestible products being subject to ingestion by the one or more particular individual living beings, the selection information electronically received via the electronically enabled input in response to electronically outputted one or more selection menus including via one or more electronic display screens. Origination of an illustratively derived receiving information display component group can be accomplished through skilled in the art design choice selection of one or more of the above depicted components from one or more of the above depicted subsystems shown in FIG. 51. Components from the receiving information display component group can be used in implementing execution of the one or more receiving information display instructions j1158 of FIG. 48, can be used in performance of the receiving information display electrical circuitry arrangement f1158 of FIG. 52, and/or can be used in otherwise fulfillment of the operation p1158. An exemplary non-transitory signal bearing medium version of the information storage subsystem s200 is depicted in FIG. 48 as bearing the one or more receiving information display instructions j1158 that when executed will direct performance of the operation p1158. Furthermore, the receiving information display electrical circuitry arrangement (“elec circ arrange”) f1158, when activated, will perform the operation p1158. Also, the receiving information display module n1158, when executed and/or activated, will direct performance of and/or perform the operation p1158. For instance, in one or more exemplary implementations, the one or more receiving information display instructions j1158, when executed, direct performance of the operation p1158 in the illustrative depiction as follows, and/or the receiving information display electrical circuitry arrangement f1158, when activated, performs the operation p1158 in the illustrative depiction as follows, and/or the receiving information display module n1158, when executed and/or activated, directs performance of and/or performs the operation p1158 in the illustrative depiction as follows, and/or the operation p1158 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to electronically outputted one or more selection menus including via one or more electronic display screens (e.g. including an implementation of the receiver component s528 is configured to electronically receive the selection information in a format for the processor component s102 to at least in part electronically output the one or more selection menus to be electronically outputted including via one or more display screens such as via graphical user interface (GUI) component s302, and/or etc.).

In one or more implementations, as shown in FIG. 91, operation p11 includes an operation p1159 for electronically receiving the selection information at least in part identifying the one or more selected ingestible products being subject to ingestion by the one or more particular individual living beings, the selection information electronically received via the electronically enabled input in response to electronically outputted one or more selection menus including via one or more audio output devices. Origination of an illustratively derived receiving information audio component group can be accomplished through skilled in the art design choice selection of one or more of the above depicted components from one or more of the above depicted subsystems shown in FIG. 51. Components from the receiving information audio component group can be used in implementing execution of the one or more receiving information audio instructions j1159 of FIG. 48, can be used in performance of the receiving information audio electrical circuitry arrangement f1159 of FIG. 52, and/or can be used in otherwise fulfillment of the operation p1159. An exemplary non-transitory signal bearing medium version of the information storage subsystem s200 is depicted in FIG. 48 as bearing the one or more receiving information audio instructions j1159 that when executed will direct performance of the operation p1159. Furthermore, the receiving information audio electrical circuitry arrangement (“elec circ arrange”) f1159, when activated, will perform the operation p1159. Also, the receiving information audio module n1159, when executed and/or activated, will direct performance of and/or perform the operation p1159. For instance, in one or more exemplary implementations, the one or more receiving information audio instructions j1159, when executed, direct performance of the operation p1159 in the illustrative depiction as follows, and/or the receiving information audio electrical circuitry arrangement f1159, when activated, performs the operation p1159 in the illustrative depiction as follows, and/or the receiving information audio module n1159, when executed and/or activated, directs performance of and/or performs the operation p1159 in the illustrative depiction as follows, and/or the operation p1159 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to electronically outputted one or more selection menus including via one or more audio output devices (e.g. including an implementation of the receiver component s528 is configured to electronically receive the selection information in a format for the processor component s102 to at least in part electronically generate the one or more selection menus to be electronically outputted including via one or more audio output devices such as via audio in/out component s328, and/or etc.).

In one or more implementations, as shown in FIG. 91, operation p11 includes an operation p1160 for electronically receiving the selection information at least in part identifying the one or more selected ingestible products being subject to ingestion by the one or more particular individual living beings, the selection information electronically received via the electronically enabled input in response to electronically outputted one or more selection menus including via one or more network interfaces. Origination of an illustratively derived receiving information interface component group can be accomplished through skilled in the art design choice selection of one or more of the above depicted components from one or more of the above depicted subsystems shown in FIG. 51. Components from the receiving information interface component group can be used in implementing execution of the one or more receiving information interface instructions j1160 of FIG. 49, can be used in performance of the receiving information interface electrical circuitry arrangement f1160 of FIG. 42, and/or can be used in otherwise fulfillment of the operation p1160. An exemplary non-transitory signal bearing medium version of the information storage subsystem s200 is depicted in FIG. 49 as bearing the one or more receiving information interface instructions j1160 that when executed will direct performance of the operation p1160. Furthermore, the receiving information interface electrical circuitry arrangement (“elec circ arrange”) f1160, when activated, will perform the operation p1160. Also, the receiving information interface module n1160, when executed and/or activated, will direct performance of and/or perform the operation p1160. For instance, in one or more exemplary implementations, the one or more receiving information interface instructions j1160, when executed, direct performance of the operation p1160 in the illustrative depiction as follows, and/or the receiving information interface electrical circuitry arrangement f1160, when activated, performs the operation p1160 in the illustrative depiction as follows, and/or the receiving information interface module n1160, when executed and/or activated, directs performance of and/or performs the operation p1160 in the illustrative depiction as follows, and/or the operation p1160 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to electronically outputted one or more selection menus including via one or more network interfaces (e.g. including an implementation of the receiver component s528 is configured to electronically receive the selection information in a format for the processor component s102 to at least in part electronically generate the one or more selection menus to be electronically outputted including via one or more network interfaces such as via wide area network component s516, and/or etc.).

In one or more implementations, as shown in FIG. 92, operation p11 includes an operation p1161 for electronically receiving the selection information at least in part identifying the one or more selected ingestible products being subject to ingestion by the one or more particular individual living beings, the selection information electronically received via the electronically enabled input in response to electronically outputted one or more selection menus including wirelessly. Origination of an illustratively derived receiving information wirelessly component group can be accomplished through skilled in the art design choice selection of one or more of the above depicted components from one or more of the above depicted subsystems shown in FIG. 51. Components from the receiving information wirelessly component group can be used in implementing execution of the one or more receiving information wirelessly instructions j1161 of FIG. 49, can be used in performance of the receiving information wirelessly electrical circuitry arrangement f1161 of FIG. 42, and/or can be used in otherwise fulfillment of the operation p1161. An exemplary non-transitory signal bearing medium version of the information storage subsystem s200 is depicted in FIG. 49 as bearing the one or more receiving information wirelessly instructions j1161 that when executed will direct performance of the operation p1161. Furthermore, the receiving information wirelessly electrical circuitry arrangement (“elec circ arrange”) f1161, when activated, will perform the operation p1161. Also, the receiving information wirelessly module n1161, when executed and/or activated, will direct performance of and/or perform the operation p1161. For instance, in one or more exemplary implementations, the one or more receiving information wirelessly instructions j1161, when executed, direct performance of the operation p1161 in the illustrative depiction as follows, and/or the receiving information wirelessly electrical circuitry arrangement f1161, when activated, performs the operation p1161 in the illustrative depiction as follows, and/or the receiving information wirelessly module n1161, when executed and/or activated, directs performance of and/or performs the operation p1161 in the illustrative depiction as follows, and/or the operation p1161 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input in response to electronically outputted one or more selection menus including wirelessly (e.g. including an implementation of the receiver component s528 is configured to electronically receive the selection information in a format for the processor component s102 to at least in part electronically generate the one or more selection menus to be electronically outputted including wirelessly such as via wireless network component s510, and/or etc.).

In one or more implementations, as shown in FIG. 92, operation p11 includes an operation p1162 for electronically receiving the selection information at least in part identifying the one or more selected ingestible products being subject to ingestion by the one or more particular individual living beings, the selection information electronically received via electronically enabled input in response to electronically outputted one or more selection menus including via the one or more electronic paper printers. Origination of an illustratively derived receiving information paper printer component group can be accomplished through skilled in the art design choice selection of one or more of the above depicted components from one or more of the above depicted subsystems shown in FIG. 51. Components from the receiving information paper printer component group can be used in implementing execution of the one or more receiving information paper printer instructions j1162 of FIG. 49, can be used in performance of the receiving information paper printer electrical circuitry arrangement f1162 of FIG. 42, and/or can be used in otherwise fulfillment of the operation p1162. An exemplary non-transitory signal bearing medium version of the information storage subsystem s200 is depicted in FIG. 49 as bearing the one or more receiving information paper printer instructions j1162 that when executed will direct performance of the operation p1162. Furthermore, the receiving information paper printer electrical circuitry arrangement (“elec circ arrange”) f1162, when activated, will perform the operation p1162. Also, the receiving information paper printer module n1162, when executed and/or activated, will direct performance of and/or perform the operation p1162. For instance, in one or more exemplary implementations, the one or more receiving information paper printer instructions j1162, when executed, direct performance of the operation p1162 in the illustrative depiction as follows, and/or the receiving information paper printer electrical circuitry arrangement f1162, when activated, performs the operation p1162 in the illustrative depiction as follows, and/or the receiving information paper printer module n1162, when executed and/or activated, directs performance of and/or performs the operation p1162 in the illustrative depiction as follows, and/or the operation p1162 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via electronically enabled input in response to electronically outputted one or more selection menus including via the one or more electronic paper printers (e.g. including an implementation of the receiver component s528 is configured to electronically receive the selection information in a format for the processor component s102 to at least in part electronically generate the one or more selection menus to be electronically outputted including via electronic paper printer such as via scanner component s338, and/or etc.).

In one or more implementations, as shown in FIG. 92, operation p11 includes an operation p1163 for electronically receiving the selection information at least in part identifying the one or more selected ingestible products being subject to ingestion by the one or more particular individual living beings, the selection information electronically received via electronically enabled input in response to electronically outputted one or more selection menus including via the one or more electronic food printers. Origination of an illustratively derived receiving information food printer component group can be accomplished through skilled in the art design choice selection of one or more of the above depicted components from one or more of the above depicted subsystems shown in FIG. 51. Components from the receiving information food printer component group can be used in implementing execution of the one or more receiving information food printer instructions j1163 of FIG. 49, can be used in performance of the receiving information food printer electrical circuitry arrangement f1163 of FIG. 42, and/or can be used in otherwise fulfillment of the operation p1163. An exemplary non-transitory signal bearing medium version of the information storage subsystem s200 is depicted in FIG. 49 as bearing the one or more receiving information food printer instructions j1163 that when executed will direct performance of the operation p1163. Furthermore, the receiving information food printer electrical circuitry arrangement (“elec circ arrange”) f1163, when activated, will perform the operation p1163. Also, the receiving information food printer module n1163, when executed and/or activated, will direct performance of and/or perform the operation p1163. For instance, in one or more exemplary implementations, the one or more receiving information food printer instructions j1163, when executed, direct performance of the operation p1163 in the illustrative depiction as follows, and/or the receiving information food printer electrical circuitry arrangement f1163, when activated, performs the operation p1163 in the illustrative depiction as follows, and/or the receiving information food printer module n1163, when executed and/or activated, directs performance of and/or performs the operation p1163 in the illustrative depiction as follows, and/or the operation p1163 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via electronically enabled input in response to electronically outputted one or more selection menus including via the one or more electronic food printers (e.g. including an implementation of the receiver component s528 is configured to electronically receive the user status information in a format for the processor component s102 to at least in part electronically generate the one or more selection menus to be electronically outputted including via electronic food printer such as via deposition component s740, and/or etc.).

In one or more implementations, as shown in FIG. 93, operation p11 includes an operation p1164 for electronically receiving the selection information at least in part identifying the one or more selected ingestible products being subject to ingestion by the one or more particular individual living beings, the selection information electronically received via the electronically enabled input including via one or more electronic identification cards. Origination of an illustratively derived receiving information ID card component group can be accomplished through skilled in the art design choice selection of one or more of the above depicted components from one or more of the above depicted subsystems shown in FIG. 51. Components from the receiving information ID card component group can be used in implementing execution of the one or more receiving information ID card instructions j1164 of FIG. 49, can be used in performance of the receiving information ID card electrical circuitry arrangement f1164 of FIG. 42, and/or can be used in otherwise fulfillment of the operation p1164. An exemplary non-transitory signal bearing medium version of the information storage subsystem s200 is depicted in FIG. 49 as bearing the one or more receiving information ID card instructions j1164 that when executed will direct performance of the operation p1164. Furthermore, the receiving information ID card electrical circuitry arrangement (“elec circ arrange”) f1164, when activated, will perform the operation p1164. Also, the receiving information ID card module n1164, when executed and/or activated, will direct performance of and/or perform the operation p1164. For instance, in one or more exemplary implementations, the one or more receiving information ID card instructions j1164, when executed, direct performance of the operation p1164 in the illustrative depiction as follows, and/or the receiving information ID card electrical circuitry arrangement f1164, when activated, performs the operation p1164 in the illustrative depiction as follows, and/or the receiving information ID card module n1164, when executed and/or activated, directs performance of and/or performs the operation p1164 in the illustrative depiction as follows, and/or the operation p1164 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via one or more electronic identification cards (e.g. including an implementation of the receiver component s528 is configured to electronically engage with a card having memory storage holding the selection information to be used by the processor component s102, and/or etc.).

In one or more implementations, as shown in FIG. 93, operation p11 includes an operation p1165 for electronically receiving the selection information at least in part identifying the one or more selected ingestible products being subject to ingestion by the one or more particular individual living beings, the selection information electronically received via the electronically enabled input including via a memory circuit coupled with one or more medication containers. Origination of an illustratively derived receiving information containers component group can be accomplished through skilled in the art design choice selection of one or more of the above depicted components from one or more of the above depicted subsystems shown in FIG. 51. Components from the receiving information containers component group can be used in implementing execution of the one or more receiving information containers instructions j1165 of FIG. 49, can be used in performance of the receiving information containers electrical circuitry arrangement f1165 of FIG. 42, and/or can be used in otherwise fulfillment of the operation p1165. An exemplary non-transitory signal bearing medium version of the information storage subsystem s200 is depicted in FIG. 49 as bearing the one or more receiving information containers instructions j1165 that when executed will direct performance of the operation p1165. Furthermore, the receiving information containers electrical circuitry arrangement (“elec circ arrange”) f1165, when activated, will perform the operation p1165. Also, the receiving information containers module n1165, when executed and/or activated, will direct performance of and/or perform the operation p1165. For instance, in one or more exemplary implementations, the one or more receiving information containers instructions j1165, when executed, direct performance of the operation p1165 in the illustrative depiction as follows, and/or the receiving information containers electrical circuitry arrangement f1165, when activated, performs the operation p1165 in the illustrative depiction as follows, and/or the receiving information containers module n1165, when executed and/or activated, directs performance of and/or performs the operation p1165 in the illustrative depiction as follows, and/or the operation p1165 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via a memory circuit coupled with one or more medication containers (e.g. including an implementation of the receiver component s528 is configured to electronically engage with a memory storage coupled with a medication container to receive the selection information via the electronically enabled input in electronic form to be used by the processor component s102, and/or etc.).

In one or more implementations, as shown in FIG. 93, operation p11 includes an operation p1166 for electronically receiving the selection information at least in part identifying the one or more selected ingestible products being subject to ingestion by the one or more particular individual living beings, the selection information electronically received via the electronically enabled input including via one or more credit card swipes. Origination of an illustratively derived receiving information credit component group can be accomplished through skilled in the art design choice selection of one or more of the above depicted components from one or more of the above depicted subsystems shown in FIG. 51. Components from the receiving information credit component group can be used in implementing execution of the one or more receiving information credit instructions j1166 of FIG. 49, can be used in performance of the receiving information credit electrical circuitry arrangement f1166 of FIG. 42, and/or can be used in otherwise fulfillment of the operation p1166. An exemplary non-transitory signal bearing medium version of the information storage subsystem s200 is depicted in FIG. 49 as bearing the one or more receiving information credit instructions j1166 that when executed will direct performance of the operation p1166. Furthermore, the receiving information credit electrical circuitry arrangement (“elec circ arrange”) f1166, when activated, will perform the operation p1166. Also, the receiving information credit module n1166, when executed and/or activated, will direct performance of and/or perform the operation p1166. For instance, in one or more exemplary implementations, the one or more receiving information credit instructions j1166, when executed, direct performance of the operation p1166 in the illustrative depiction as follows, and/or the receiving information credit electrical circuitry arrangement f1166, when activated, performs the operation p1166 in the illustrative depiction as follows, and/or the receiving information credit module n1166, when executed and/or activated, directs performance of and/or performs the operation p1166 in the illustrative depiction as follows, and/or the operation p1166 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via one or more credit card swipes (e.g. including an implementation of the receiver component s528 is configured to electronically engage with an electronic memory stripe integrated into a credit card to receive the selection information via electronically enabled input to be used by the processor component s102, and/or etc.).

In one or more implementations, as shown in FIG. 94, operation p11 includes an operation p1167 for electronically receiving the selection information at least in part identifying the one or more selected ingestible products being subject to ingestion by the one or more particular individual living beings, the selection information electronically received via the electronically enabled input including via one or more cell phone swipes. Origination of an illustratively derived receiving information cell component group can be accomplished through skilled in the art design choice selection of one or more of the above depicted components from one or more of the above depicted subsystems shown in FIG. 51. Components from the receiving information cell component group can be used in implementing execution of the one or more receiving information cell instructions j1167 of FIG. 49, can be used in performance of the receiving information cell electrical circuitry arrangement f1167 of FIG. 42, and/or can be used in otherwise fulfillment of the operation p1167. An exemplary non-transitory signal bearing medium version of the information storage subsystem s200 is depicted in FIG. 49 as bearing the one or more receiving information cell instructions j1167 that when executed will direct performance of the operation p1167. Furthermore, the receiving information cell electrical circuitry arrangement (“elec circ arrange”) f1167, when activated, will perform the operation p1167. Also, the receiving information cell module n1167, when executed and/or activated, will direct performance of and/or perform the operation p1167. For instance, in one or more exemplary implementations, the one or more receiving information cell instructions j1167, when executed, direct performance of the operation p1167 in the illustrative depiction as follows, and/or the receiving information cell electrical circuitry arrangement f1167, when activated, performs the operation p1167 in the illustrative depiction as follows, and/or the receiving information cell module n1167, when executed and/or activated, directs performance of and/or performs the operation p1167 in the illustrative depiction as follows, and/or the operation p1167 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via one or more cell phone swipes (e.g. including an implementation of the receiver component s528 is configured to electronically engage with an electronic memory component integrated into a cell phone to receive the selection information via electronically enabled input to be used by the processor component s102 to generate the one or more selection menus, and/or etc.).

In one or more implementations, as shown in FIG. 94, operation p11 includes an operation p1168 for electronically receiving the selection information at least in part identifying the one or more selected ingestible products being subject to ingestion by the one or more particular individual living beings, the selection information electronically received via the electronically enabled input including via bar code communication. Origination of an illustratively derived receiving information bar code component group can be accomplished through skilled in the art design choice selection of one or more of the above depicted components from one or more of the above depicted subsystems shown in FIG. 51. Components from the receiving information bar code component group can be used in implementing execution of the one or more receiving information bar code instructions j1168 of FIG. 49, can be used in performance of the receiving information bar code electrical circuitry arrangement f1168 of FIG. 42, and/or can be used in otherwise fulfillment of the operation p1168. An exemplary non-transitory signal bearing medium version of the information storage subsystem s200 is depicted in FIG. 49 as bearing the one or more receiving information bar code instructions j1168 that when executed will direct performance of the operation p1168. Furthermore, the receiving information bar code electrical circuitry arrangement (“elec circ arrange”) f1168, when activated, will perform the operation p1168. Also, the receiving information bar code module n1168, when executed and/or activated, will direct performance of and/or perform the operation p1168. For instance, in one or more exemplary implementations, the one or more receiving information bar code instructions j1168, when executed, direct performance of the operation p1168 in the illustrative depiction as follows, and/or the receiving information bar code electrical circuitry arrangement f1168, when activated, performs the operation p1168 in the illustrative depiction as follows, and/or the receiving information bar code module n1168, when executed and/or activated, directs performance of and/or performs the operation p1168 in the illustrative depiction as follows, and/or the operation p1168 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via bar code communication (e.g. including an implementation of the receiver component s528 is configured to electronically read a bar code label to receive the selection information via electronically enabled input to be used by the processor component s102, and/or etc.).

In one or more implementations, as shown in FIG. 94, operation p11 includes an operation p1169 for electronically receiving the selection information at least in part identifying the one or more selected ingestible products being subject to ingestion by the one or more particular individual living beings, the selection information electronically received via the electronically enabled input including via Internet communication. Origination of an illustratively derived receiving information Internet component group can be accomplished through skilled in the art design choice selection of one or more of the above depicted components from one or more of the above depicted subsystems shown in FIG. 51. Components from the receiving information Internet component group can be used in implementing execution of the one or more receiving information Internet instructions j1169 of FIG. 49, can be used in performance of the receiving information Internet electrical circuitry arrangement f1169 of FIG. 42, and/or can be used in otherwise fulfillment of the operation p1169. An exemplary non-transitory signal bearing medium version of the information storage subsystem s200 is depicted in FIG. 49 as bearing the one or more receiving information Internet instructions j1169 that when executed will direct performance of the operation p1169. Furthermore, the receiving information Internet electrical circuitry arrangement (“elec circ arrange”) f1169, when activated, will perform the operation p1169. Also, the receiving information Internet module n1169, when executed and/or activated, will direct performance of and/or perform the operation p1169. For instance, in one or more exemplary implementations, the one or more receiving information Internet instructions j1169, when executed, direct performance of the operation p1169 in the illustrative depiction as follows, and/or the receiving information Internet electrical circuitry arrangement f1169, when activated, performs the operation p1169 in the illustrative depiction as follows, and/or the receiving information Internet module n1169, when executed and/or activated, directs performance of and/or performs the operation p1169 in the illustrative depiction as follows, and/or the operation p1169 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via Internet communication (e.g. including an implementation of the receiver component s528 is configured to electronically receive the selection information through the internet network component s508 to be used by the processor component s102, and/or etc.).

In one or more implementations, as shown in FIG. 95, operation p11 includes an operation p1170 for electronically receiving the selection information at least in part identifying the one or more selected ingestible products being subject to ingestion by the one or more particular individual living beings, the selection information electronically received via the electronically enabled input including via electronic network communication. Origination of an illustratively derived receiving information network component group can be accomplished through skilled in the art design choice selection of one or more of the above depicted components from one or more of the above depicted subsystems shown in FIG. 51. Components from the receiving information network component group can be used in implementing execution of the one or more receiving information network instructions j1170 of FIG. 49, can be used in performance of the receiving information network electrical circuitry arrangement f1170 of FIG. 42, and/or can be used in otherwise fulfillment of the operation p1170. An exemplary non-transitory signal bearing medium version of the information storage subsystem s200 is depicted in FIG. 49 as bearing the one or more receiving information network instructions j1170 that when executed will direct performance of the operation p1170. Furthermore, the receiving information network electrical circuitry arrangement (“elec circ arrange”) f1170, when activated, will perform the operation p1170. Also, the receiving information network module n1170, when executed and/or activated, will direct performance of and/or perform the operation p1170. For instance, in one or more exemplary implementations, the one or more receiving information network instructions j1170, when executed, direct performance of the operation p1170 in the illustrative depiction as follows, and/or the receiving information network electrical circuitry arrangement f1170, when activated, performs the operation p1170 in the illustrative depiction as follows, and/or the receiving information network module n1170, when executed and/or activated, directs performance of and/or performs the operation p1170 in the illustrative depiction as follows, and/or the operation p1170 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via electronic network communication (e.g. including an implementation of the receiver component s528 is configured to electronically engage with the network cable component s502 to receive the selection information to be used by the processor component s102, and/or etc.).

In one or more implementations, as shown in FIG. 95, operation p11 includes an operation p1171 for electronically receiving the selection information at least in part identifying the one or more selected ingestible products being subject to ingestion by the one or more particular individual living beings, the selection information electronically received via the electronically enabled input including via touch screen input. Origination of an illustratively derived receiving information touch component group can be accomplished through skilled in the art design choice selection of one or more of the above depicted components from one or more of the above depicted subsystems shown in FIG. 51. Components from the receiving information touch component group can be used in implementing execution of the one or more receiving information touch instructions j1171 of FIG. 49, can be used in performance of the receiving information touch electrical circuitry arrangement f1171 of FIG. 42, and/or can be used in otherwise fulfillment of the operation p1171. An exemplary non-transitory signal bearing medium version of the information storage subsystem s200 is depicted in FIG. 49 as bearing the one or more receiving information touch instructions j1171 that when executed will direct performance of the operation p1171. Furthermore, the receiving information touch electrical circuitry arrangement (“elec circ arrange”) f1171, when activated, will perform the operation p1171. Also, the receiving information touch module n1171, when executed and/or activated, will direct performance of and/or perform the operation p1171. For instance, in one or more exemplary implementations, the one or more receiving information touch instructions j1171, when executed, direct performance of the operation p1171 in the illustrative depiction as follows, and/or the receiving information touch electrical circuitry arrangement f1171, when activated, performs the operation p1171 in the illustrative depiction as follows, and/or the receiving information touch module n1171, when executed and/or activated, directs performance of and/or performs the operation p1171 in the illustrative depiction as follows, and/or the operation p1171 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via touch screen input (e.g. including an implementation of the receiver component s528 is configured to electronically receive through the touch screen component s314 the selection information to be used by the processor component s102, and/or etc.).

In one or more implementations, as shown in FIG. 95, operation p11 includes an operation p1172 for electronically receiving the selection information at least in part identifying the one or more selected ingestible products being subject to ingestion by the one or more particular individual living beings, the selection information electronically received via the electronically enabled input including via wireless input. Origination of an illustratively derived receiving information wireless component group can be accomplished through skilled in the art design choice selection of one or more of the above depicted components from one or more of the above depicted subsystems shown in FIG. 51. Components from the receiving information wireless component group can be used in implementing execution of the one or more receiving information wireless instructions j1172 of FIG. 49, can be used in performance of the receiving information wireless electrical circuitry arrangement f1172 of FIG. 42, and/or can be used in otherwise fulfillment of the operation p1172. An exemplary non-transitory signal bearing medium version of the information storage subsystem s200 is depicted in FIG. 49 as bearing the one or more receiving information wireless instructions j1172 that when executed will direct performance of the operation p1172. Furthermore, the receiving information wireless electrical circuitry arrangement (“elec circ arrange”) f1172, when activated, will perform the operation p1172. Also, the receiving information wireless module n1172, when executed and/or activated, will direct performance of and/or perform the operation p1172. For instance, in one or more exemplary implementations, the one or more receiving information wireless instructions j1172, when executed, direct performance of the operation p1172 in the illustrative depiction as follows, and/or the receiving information wireless electrical circuitry arrangement f1172, when activated, performs the operation p1172 in the illustrative depiction as follows, and/or the receiving information wireless module n1172, when executed and/or activated, directs performance of and/or performs the operation p1172 in the illustrative depiction as follows, and/or the operation p1172 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via wireless input (e.g. including an implementation of the receiver component s528 is configured to electronically receive through the wireless network component s510 to receive the selection information to be used by the processor component s102, and/or etc.).

In one or more implementations, as shown in FIG. 96, operation p11 includes an operation p1173 for electronically receiving the selection information at least in part identifying the one or more selected ingestible products being subject to ingestion by the one or more particular individual living beings, the selection information electronically received via the electronically enabled input including via electronic imaging of the one or more particular individual living beings. Origination of an illustratively derived receiving information imaging component group can be accomplished through skilled in the art design choice selection of one or more of the above depicted components from one or more of the above depicted subsystems shown in FIG. 51. Components from the receiving information imaging component group can be used in implementing execution of the one or more receiving information imaging instructions j1173 of FIG. 49, can be used in performance of the receiving information imaging electrical circuitry arrangement f1173 of FIG. 42, and/or can be used in otherwise fulfillment of the operation p1173. An exemplary non-transitory signal bearing medium version of the information storage subsystem s200 is depicted in FIG. 49 as bearing the one or more receiving information imaging instructions j1173 that when executed will direct performance of the operation p1173. Furthermore, the receiving information imaging electrical circuitry arrangement (“elec circ arrange”) f1173, when activated, will perform the operation p1173. Also, the receiving information imaging module n1173, when executed and/or activated, will direct performance of and/or perform the operation p1173. For instance, in one or more exemplary implementations, the one or more receiving information imaging instructions j1173, when executed, direct performance of the operation p1173 in the illustrative depiction as follows, and/or the receiving information imaging electrical circuitry arrangement f1173, when activated, performs the operation p1173 in the illustrative depiction as follows, and/or the receiving information imaging module n1173, when executed and/or activated, directs performance of and/or performs the operation p1173 in the illustrative depiction as follows, and/or the operation p1173 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via electronic imaging (e.g. including an implementation of the receiver component s528 is configured to electronically receive through the camera component s336 the selection information to be used by the processor component s102, and/or etc.) of the one or more particular individual living beings.

In one or more implementations, as shown in FIG. 96, operation p11 includes an operation p1174 for electronically receiving the selection information at least in part identifying the one or more selected ingestible products being subject to ingestion by the one or more particular individual living beings, the selection information electronically received via the electronically enabled input including via electronic based gesture recognition. Origination of an illustratively derived receiving information gesture component group can be accomplished through skilled in the art design choice selection of one or more of the above depicted components from one or more of the above depicted subsystems shown in FIG. 51. Components from the receiving information gesture component group can be used in implementing execution of the one or more receiving information gesture instructions j1174 of FIG. 49, can be used in performance of the receiving information gesture electrical circuitry arrangement f1174 of FIG. 42, and/or can be used in otherwise fulfillment of the operation p1174. An exemplary non-transitory signal bearing medium version of the information storage subsystem s200 is depicted in FIG. 49 as bearing the one or more receiving information gesture instructions j1174 that when executed will direct performance of the operation p1174. Furthermore, the receiving information gesture electrical circuitry arrangement (“elec circ arrange”) f1174, when activated, will perform the operation p1174. Also, the receiving information gesture module n1174, when executed and/or activated, will direct performance of and/or perform the operation p1174. For instance, in one or more exemplary implementations, the one or more receiving information gesture instructions j1174, when executed, direct performance of the operation p1174 in the illustrative depiction as follows, and/or the receiving information gesture electrical circuitry arrangement f1174, when activated, performs the operation p1174 in the illustrative depiction as follows, and/or the receiving information gesture module n1174, when executed and/or activated, directs performance of and/or performs the operation p1174 in the illustrative depiction as follows, and/or the operation p1174 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via electronic based gesture recognition (e.g. including an implementation of the receiver component s528 is configured to electronically engage with the optical sensing component s418 to receive the selection to be used by the processor component s102, and/or etc.).

In one or more implementations, as shown in FIG. 96, operation p11 includes an operation p1175 for electronically receiving the selection information at least in part identifying the one or more selected ingestible products being subject to ingestion by the one or more particular individual living beings, the selection information electronically received via the electronically enabled input including via electronic audio recording of the one or more particular individual living beings. Origination of an illustratively derived receiving information audio component group can be accomplished through skilled in the art design choice selection of one or more of the above depicted components from one or more of the above depicted subsystems shown in FIG. 51. Components from the receiving information audio component group can be used in implementing execution of the one or more receiving information audio instructions j1175 of FIG. 49, can be used in performance of the receiving information audio electrical circuitry arrangement f1175 of FIG. 42, and/or can be used in otherwise fulfillment of the operation p1175. An exemplary non-transitory signal bearing medium version of the information storage subsystem s200 is depicted in FIG. 49 as bearing the one or more receiving information audio instructions j1175 that when executed will direct performance of the operation p1175. Furthermore, the receiving information audio electrical circuitry arrangement (“elec circ arrange”) f1175, when activated, will perform the operation p1175. Also, the receiving information audio module n1175, when executed and/or activated, will direct performance of and/or perform the operation p1175. For instance, in one or more exemplary implementations, the one or more receiving information audio instructions j1175, when executed, direct performance of the operation p1175 in the illustrative depiction as follows, and/or the receiving information audio electrical circuitry arrangement f1175, when activated, performs the operation p1175 in the illustrative depiction as follows, and/or the receiving information audio module n1175, when executed and/or activated, directs performance of and/or performs the operation p1175 in the illustrative depiction as follows, and/or the operation p1175 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via electronic audio recording (e.g. including an implementation of the receiver component s528 is configured to electronically engage with the sound sensing component s420 to receive the selection information to be used by the processor component s102, and/or etc.) of the one or more particular individual living beings.

In one or more implementations, as shown in FIG. 97, operation p11 includes an operation p1176 for electronically receiving the selection information at least in part identifying the one or more selected ingestible products being subject to ingestion by the one or more particular individual living beings, the selection information electronically received via the electronically enabled input including via electronic keypad entry. Origination of an illustratively derived receiving information keypad component group can be accomplished through skilled in the art design choice selection of one or more of the above depicted components from one or more of the above depicted subsystems shown in FIG. 51. Components from the receiving information keypad component group can be used in implementing execution of the one or more receiving information keypad instructions j1176 of FIG. 49, can be used in performance of the receiving information keypad electrical circuitry arrangement f1176 of FIG. 42, and/or can be used in otherwise fulfillment of the operation p1176. An exemplary non-transitory signal bearing medium version of the information storage subsystem s200 is depicted in FIG. 49 as bearing the one or more receiving information keypad instructions j1176 that when executed will direct performance of the operation p1176. Furthermore, the receiving information keypad electrical circuitry arrangement (“elec circ arrange”) f1176, when activated, will perform the operation p1176. Also, the receiving information keypad module n1176, when executed and/or activated, will direct performance of and/or perform the operation p1176. For instance, in one or more exemplary implementations, the one or more receiving information keypad instructions j1176, when executed, direct performance of the operation p1176 in the illustrative depiction as follows, and/or the receiving information keypad electrical circuitry arrangement f1176, when activated, performs the operation p1176 in the illustrative depiction as follows, and/or the receiving information keypad module n1176, when executed and/or activated, directs performance of and/or performs the operation p1176 in the illustrative depiction as follows, and/or the operation p1176 is otherwise carried out in the illustrative depiction as follows: electronically receiving the selection information at least in part identifying the one or more selected ingestible products (e.g. including sandwiches, snack bars, full course meals, deserts, drinks, side dishes, medications, and/or etc.) being subject to ingestion by the one or more particular individual living beings, the selection information electronically received via the electronically enabled input including via electronic keypad entry (e.g. including an implementation of the receiver component s528 is configured to electronically engage with the keypad component s308 to receive the selection information to be used by the processor component s102, and/or etc.).

In one or more implementations, as shown in FIG. 97, operation p11 includes an operation p1177 for the electronically receiving the user status information and the electronically receiving the selection information at least in part to electronically obtain the treatment instructional information via at least in part electronic retrieval from one or more electronic databases regarding the one or more subsequent ingestible substrate structure directed energy operations. Origination of an illustratively derived obtain instructional database component group can be accomplished through skilled in the art design choice selection of one or more of the above depicted components from one or more of the above depicted subsystems shown in FIG. 51. Components from the obtain instructional database component group can be used in implementing execution of the one or more obtain instructional database instructions j1177 of FIG. 49, can be used in performance of the obtain instructional database electrical circuitry arrangement f1177 of FIG. 42, and/or can be used in otherwise fulfillment of the operation p1177. An exemplary non-transitory signal bearing medium version of the information storage subsystem s200 is depicted in FIG. 49 as bearing the one or more obtain instructional database instructions j1177 that when executed will direct performance of the operation p1177. Furthermore, the obtain instructional database electrical circuitry arrangement (“elec circ arrange”) f1177, when activated, will perform the operation p1177. Also, the obtain instructional database module n1177, when executed and/or activated, will direct performance of and/or perform the operation p1177. For instance, in one or more exemplary implementations, the one or more obtain instructional database instructions j1177, when executed, direct performance of the operation p1177 in the illustrative depiction as follows, and/or the obtain instructional database electrical circuitry arrangement f1177, when activated, performs the operation p1177 in the illustrative depiction as follows, and/or the obtain instructional database module n1177, when executed and/or activated, directs performance of and/or performs the operation p1177 in the illustrative depiction as follows, and/or the operation p1177 is otherwise carried out in the illustrative depiction as follows: the electronically receiving the user status information and the electronically receiving the selection information at least in part to electronically obtain the treatment instructional information via at least in part electronic retrieval from one or more electronic databases (e.g. including an implementation of the receiver component s528 is configured to electronically engage with the electromagnetic sensing component s402 to receive the selection information to be used by the processor component s102, and/or etc.) regarding the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.).

In one or more implementations, as shown in FIG. 97, operation p11 includes an operation p1178 for the electronically receiving the user status information and the electronically receiving the selection information at least in part to electronically obtain the treatment instructional information via at least in part one or more electronic computational devices regarding the one or more subsequent ingestible substrate structure directed energy operations. Origination of an illustratively derived obtain instructional computational component group can be accomplished through skilled in the art design choice selection of one or more of the above depicted components from one or more of the above depicted subsystems shown in FIG. 51. Components from the obtain instructional computational component group can be used in implementing execution of the one or more obtain instructional computational instructions j1178 of FIG. 49, can be used in performance of the obtain instructional computational electrical circuitry arrangement f1178 of FIG. 42, and/or can be used in otherwise fulfillment of the operation p1178. An exemplary non-transitory signal bearing medium version of the information storage subsystem s200 is depicted in FIG. 49 as bearing the one or more obtain instructional computational instructions j1178 that when executed will direct performance of the operation p1178. Furthermore, the obtain instructional computational electrical circuitry arrangement (“elec circ arrange”) f1178, when activated, will perform the operation p1178. Also, the obtain instructional computational module n1178, when executed and/or activated, will direct performance of and/or perform the operation p1178. For instance, in one or more exemplary implementations, the one or more obtain instructional computational instructions j1178, when executed, direct performance of the operation p1178 in the illustrative depiction as follows, and/or the obtain instructional computational electrical circuitry arrangement f1178, when activated, performs the operation p1178 in the illustrative depiction as follows, and/or the obtain instructional computational module n1178, when executed and/or activated, directs performance of and/or performs the operation p1178 in the illustrative depiction as follows, and/or the operation p1178 is otherwise carried out in the illustrative depiction as follows: the electronically receiving the user status information and the electronically receiving the selection information at least in part to electronically obtain the treatment instructional information via at least in part one or more electronic computational devices (e.g. including an implementation of the receiver component s528 is configured to electronically engage with the encrypted communication component s520 to receive the selection information to be used by the processor component s102, and/or etc.) regarding the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.).

In one or more implementations, as shown in FIG. 98, operation p11 includes an operation p1179 for the electronically receiving the user status information and the electronically receiving the selection information at least in part to electronically obtain the treatment instructional information via at least in part one or more electronic storage devices regarding the one or more subsequent ingestible substrate structure directed energy operations. Origination of an illustratively derived obtain instructional storage component group can be accomplished through skilled in the art design choice selection of one or more of the above depicted components from one or more of the above depicted subsystems shown in FIG. 51. Components from the obtain instructional storage component group can be used in implementing execution of the one or more obtain instructional storage instructions j1179 of FIG. 49, can be used in performance of the obtain instructional storage electrical circuitry arrangement f1179 of FIG. 42, and/or can be used in otherwise fulfillment of the operation p1179. An exemplary non-transitory signal bearing medium version of the information storage subsystem s200 is depicted in FIG. 49 as bearing the one or more obtain instructional storage instructions j1179 that when executed will direct performance of the operation p1179. Furthermore, the obtain instructional storage electrical circuitry arrangement (“elec circ arrange”) f1179, when activated, will perform the operation p1179. Also, the obtain instructional storage module n1179, when executed and/or activated, will direct performance of and/or perform the operation p1179. For instance, in one or more exemplary implementations, the one or more obtain instructional storage instructions j1179, when executed, direct performance of the operation p1179 in the illustrative depiction as follows, and/or the obtain instructional storage electrical circuitry arrangement f1179, when activated, performs the operation p1179 in the illustrative depiction as follows, and/or the obtain instructional storage module n1179, when executed and/or activated, directs performance of and/or performs the operation p1179 in the illustrative depiction as follows, and/or the operation p1179 is otherwise carried out in the illustrative depiction as follows: the electronically receiving the user status information and the electronically receiving the selection information at least in part to electronically obtain the treatment instructional information via at least in part one or more electronic storage devices (e.g. including an implementation of the receiver component s528 is configured to electronically engage with one or more components of the information storage subsystem s200, such as the server component s230, to receive the selection information to be used by the processor component s102, and/or etc.) regarding the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.).

In one or more implementations, as shown in FIG. 98, operation p11 includes an operation p1180 for electronically obtaining the treatment instructional information regarding the one or more subsequent ingestible substrate structure directed energy operations including directing energy in laser form to treat the one or more portions of the one or more ingestible substrate structures. Origination of an illustratively derived obtain instructional laser component group can be accomplished through skilled in the art design choice selection of one or more of the above depicted components from one or more of the above depicted subsystems shown in FIG. 51. Components from the obtain instructional laser component group can be used in implementing execution of the one or more obtain instructional laser instructions j1180 of FIG. 50, can be used in performance of the obtain instructional laser electrical circuitry arrangement f1180 of FIG. 43, and/or can be used in otherwise fulfillment of the operation p1180. An exemplary non-transitory signal bearing medium version of the information storage subsystem s200 is depicted in FIG. 50 as bearing the one or more obtain instructional laser instructions j1180 that when executed will direct performance of the operation p1180. Furthermore, the obtain instructional laser electrical circuitry arrangement (“elec circ arrange”) f1180, when activated, will perform the operation p1180. Also, the obtain instructional laser module n1180, when executed and/or activated, will direct performance of and/or perform the operation p1180. For instance, in one or more exemplary implementations, the one or more obtain instructional laser instructions j1180, when executed, direct performance of the operation p1180 in the illustrative depiction as follows, and/or the obtain instructional laser electrical circuitry arrangement f1180, when activated, performs the operation p1180 in the illustrative depiction as follows, and/or the obtain instructional laser module n1180, when executed and/or activated, directs performance of and/or performs the operation p1180 in the illustrative depiction as follows, and/or the operation p1180 is otherwise carried out in the illustrative depiction as follows: electronically obtaining the treatment instructional information (e.g. information including location, direction, number and type of parts and order of assembly, and/or etc.) regarding the one or more subsequent ingestible substrate structure duct operations including flowing one or more fluids through one or more ducts located internally within one or more portions of the one or more ingestible substrate structures (e.g. one or more pins, nails, and/or etc.) to treat (including processing, changing, modifying, supplementing, refining, amplifying, enhancing, acting upon, exposing, reacting with, integrating with, and/or etc.) the one or more portions of the one or more ingestible substrate structures (e.g. including projection surfaces of food products, and/or etc.).

In one or more implementations, as shown in FIG. 98, operation p11 includes an operation p1181 for electronically obtaining the treatment instructional information regarding the one or more subsequent ingestible substrate structure directed energy operations including directing energy in microwave form to treat one or more portions of the one or more ingestible substrate structures. Origination of an illustratively derived obtain instructional microwave component group can be accomplished through skilled in the art design choice selection of one or more of the above depicted components from one or more of the above depicted subsystems shown in FIG. 51. Components from the obtain instructional microwave component group can be used in implementing execution of the one or more obtain instructional microwave instructions j1181 of FIG. 50, can be used in performance of the obtain instructional microwave electrical circuitry arrangement f1181 of FIG. 43, and/or can be used in otherwise fulfillment of the operation p1181. An exemplary non-transitory signal bearing medium version of the information storage subsystem s200 is depicted in FIG. 50 as bearing the one or more obtain instructional microwave instructions j1181 that when executed will direct performance of the operation p1181. Furthermore, the obtain instructional microwave electrical circuitry arrangement (“elec circ arrange”) f1181, when activated, will perform the operation p1181. Also, the obtain instructional microwave module n1181, when executed and/or activated, will direct performance of and/or perform the operation p1181. For instance, in one or more exemplary implementations, the one or more obtain instructional microwave instructions j1181, when executed, direct performance of the operation p1181 in the illustrative depiction as follows, and/or the obtain instructional microwave electrical circuitry arrangement f1181, when activated, performs the operation p1181 in the illustrative depiction as follows, and/or the obtain instructional microwave module n1181, when executed and/or activated, directs performance of and/or performs the operation p1181 in the illustrative depiction as follows, and/or the operation p1181 is otherwise carried out in the illustrative depiction as follows: electronically obtaining the treatment instructional information regarding the one or more subsequent ingestible substrate structure duct operations including flowing one or more fluids through one or more ducts having one or more linear surfaces (e.g. including one or more channel, raceway, or wire-like surfaces, and/or etc.) to treat (including processing, changing, modifying, supplementing, refining, amplifying, enhancing, acting upon, exposing, reacting with, integrating with, and/or etc.) one or more portions of the one or more ingestible substrate structures (e.g. including one or more external surfaces of the one or more ingestible substrate structures, and/or etc.).

In one or more implementations, as shown in FIG. 99, operation p11 includes an operation p1182 for electronically obtaining the treatment instructional information regarding the one or more subsequent ingestible substrate structure directed energy operations including directing energy in acoustic form to treat one or more portions of the one or more ingestible substrate structures. Origination of an illustratively derived obtain instructional acoustic component group can be accomplished through skilled in the art design choice selection of one or more of the above depicted components from one or more of the above depicted subsystems shown in FIG. 51. Components from the obtain instructional acoustic component group can be used in implementing execution of the one or more obtain instructional acoustic instructions j1182 of FIG. 50, can be used in performance of the obtain instructional acoustic electrical circuitry arrangement f1182 of FIG. 43, and/or can be used in otherwise fulfillment of the operation p1182. An exemplary non-transitory signal bearing medium version of the information storage subsystem s200 is depicted in FIG. 50 as bearing the one or more obtain instructional acoustic instructions j1182 that when executed will direct performance of the operation p1182. Furthermore, the obtain instructional acoustic electrical circuitry arrangement (“elec circ arrange”) f1182, when activated, will perform the operation p1182. Also, the obtain instructional acoustic module n1182, when executed and/or activated, will direct performance of and/or perform the operation p1182. For instance, in one or more exemplary implementations, the one or more obtain instructional acoustic instructions j1182, when executed, direct performance of the operation p1182 in the illustrative depiction as follows, and/or the obtain instructional acoustic electrical circuitry arrangement f1182, when activated, performs the operation p1182 in the illustrative depiction as follows, and/or the obtain instructional acoustic module n1182, when executed and/or activated, directs performance of and/or performs the operation p1182 in the illustrative depiction as follows, and/or the operation p1182 is otherwise carried out in the illustrative depiction as follows: electronically obtaining the treatment instructional information regarding the one or more subsequent ingestible substrate structure duct operations including flowing one or more fluids through one or more ducts having one or more dissolvable surfaces (e.g. including one or more ingestible pieces with substantially flat surfaces, and/or etc.) to treat (including processing, changing, modifying, supplementing, refining, amplifying, enhancing, acting upon, exposing, reacting with, integrating with, and/or etc.) one or more portions of the one or more ingestible substrate structures (e.g. including one or more external surfaces of the one or more portions of the one or more ingestible substrate structures, and/or etc.).

In one or more implementations, as shown in FIG. 99, operation p11 includes an operation p1183 for electronically obtaining the treatment instructional information regarding the one or more subsequent ingestible substrate structure directed energy operations including directing energy in radiant form to treat one or more portions of the one or more ingestible substrate structures. Origination of an illustratively derived obtain instructional radiant component group can be accomplished through skilled in the art design choice selection of one or more of the above depicted components from one or more of the above depicted subsystems shown in FIG. 51. Components from the obtain instructional radiant component group can be used in implementing execution of the one or more obtain instructional radiant instructions j1183 of FIG. 50, can be used in performance of the obtain instructional radiant electrical circuitry arrangement f1183 of FIG. 43, and/or can be used in otherwise fulfillment of the operation p1183. An exemplary non-transitory signal bearing medium version of the information storage subsystem s200 is depicted in FIG. 50 as bearing the one or more obtain instructional radiant instructions j1183 that when executed will direct performance of the operation p1183. Furthermore, the obtain instructional radiant electrical circuitry arrangement (“elec circ arrange”) f1183, when activated, will perform the operation p1183. Also, the obtain instructional radiant module n1183, when executed and/or activated, will direct performance of and/or perform the operation p1183. For instance, in one or more exemplary implementations, the one or more obtain instructional radiant instructions j1183, when executed, direct performance of the operation p1183 in the illustrative depiction as follows, and/or the obtain instructional radiant electrical circuitry arrangement f1183, when activated, performs the operation p1183 in the illustrative depiction as follows, and/or the obtain instructional radiant module n1183, when executed and/or activated, directs performance of and/or performs the operation p1183 in the illustrative depiction as follows, and/or the operation p1183 is otherwise carried out in the illustrative depiction as follows: electronically obtaining the treatment instructional information regarding the one or more subsequent ingestible substrate structure duct operations including flowing one or more fluids through one or more ducts having one or more cylindrical surfaces (e.g. including one or more ingestible pieces with substantially cylindrical surfaces, and/or etc.) to treat (including processing, changing, modifying, supplementing, refining, amplifying, enhancing, acting upon, exposing, reacting with, integrating with, and/or etc.) one or more portions of the one or more ingestible substrate structures (e.g. including one or more external surfaces of the one or more portions of the one or more ingestible substrate structures, and/or etc.).

In one or more implementations, as shown in FIG. 99, operation p11 includes an operation p1184 for electronically obtaining the treatment instructional information regarding the one or more subsequent ingestible substrate structure directed energy operations including directing energy in focused form to treat one or more portions of the one or more ingestible substrate structures. Origination of an illustratively derived obtain instructional focused component group can be accomplished through skilled in the art design choice selection of one or more of the above depicted components from one or more of the above depicted subsystems shown in FIG. 51. Components from the obtain instructional focused component group can be used in implementing execution of the one or more obtain instructional focused instructions j1184 of FIG. 50, can be used in performance of the obtain instructional focused electrical circuitry arrangement f1184 of FIG. 43, and/or can be used in otherwise fulfillment of the operation p1184. An exemplary non-transitory signal bearing medium version of the information storage subsystem s200 is depicted in FIG. 50 as bearing the one or more obtain instructional focused instructions j1184 that when executed will direct performance of the operation p1184. Furthermore, the obtain instructional focused electrical circuitry arrangement (“elec circ arrange”) f1184, when activated, will perform the operation p1184. Also, the obtain instructional focused module n1184, when executed and/or activated, will direct performance of and/or perform the operation p1184. For instance, in one or more exemplary implementations, the one or more obtain instructional focused instructions j1184, when executed, direct performance of the operation p1184 in the illustrative depiction as follows, and/or the obtain instructional focused electrical circuitry arrangement f1184, when activated, performs the operation p1184 in the illustrative depiction as follows, and/or the obtain instructional focused module n1184, when executed and/or activated, directs performance of and/or performs the operation p1184 in the illustrative depiction as follows, and/or the operation p1184 is otherwise carried out in the illustrative depiction as follows: electronically obtaining the treatment instructional information regarding the one or more subsequent ingestible substrate structure duct operations including flowing one or more fluids through one or more ducts having one or more removable surfaces (e.g. including one or more pieces with one or more matrices of ingestible pieces having structures such as rods, pins, and/or etc.) to treat (including processing, changing, modifying, supplementing, refining, amplifying, enhancing, acting upon, exposing, reacting with, integrating with, and/or etc.) one or more portions of the one or more ingestible substrate structures (e.g. including one or more external surfaces of the one or more portions of the one or more ingestible substrate structures, and/or etc.).

In one or more implementations, as shown in FIG. 100, operation p11 includes an operation p1185 for electronically obtaining the treatment instructional information regarding the one or more subsequent ingestible substrate structure directed energy operations including directing energy in patterned form to treat one or more portions of the one or more ingestible substrate structures. Origination of an illustratively derived obtain instructional patterned component group can be accomplished through skilled in the art design choice selection of one or more of the above depicted components from one or more of the above depicted subsystems shown in FIG. 51. Components from the obtain instructional patterned component group can be used in implementing execution of the one or more obtain instructional patterned instructions j1185 of FIG. 50, can be used in performance of the obtain instructional patterned electrical circuitry arrangement f1185 of FIG. 43, and/or can be used in otherwise fulfillment of the operation p1185. An exemplary non-transitory signal bearing medium version of the information storage subsystem s200 is depicted in FIG. 50 as bearing the one or more obtain instructional patterned instructions j1185 that when executed will direct performance of the operation p1185. Furthermore, the obtain instructional patterned electrical circuitry arrangement (“elec circ arrange”) f1185, when activated, will perform the operation p1185. Also, the obtain instructional patterned module n1185, when executed and/or activated, will direct performance of and/or perform the operation p1185. For instance, in one or more exemplary implementations, the one or more obtain instructional patterned instructions j1185, when executed, direct performance of the operation p1185 in the illustrative depiction as follows, and/or the obtain instructional patterned electrical circuitry arrangement f1185, when activated, performs the operation p1185 in the illustrative depiction as follows, and/or the obtain instructional patterned module n1185, when executed and/or activated, directs performance of and/or performs the operation p1185 in the illustrative depiction as follows, and/or the operation p1185 is otherwise carried out in the illustrative depiction as follows: electronically obtaining the treatment instructional information regarding the one or more subsequent ingestible substrate structure duct operations including flowing one or more fluids through one or more ducts having one or more curvilinear surfaces (e.g. including ingestible pieces with one or more substantially straight surfaces, such as rod, rule, and/or etc.) to treat (including processing, changing, modifying, supplementing, refining, amplifying, enhancing, acting upon, exposing, reacting with, integrating with, and/or etc.) one or more portions of the one or more ingestible substrate structures (e.g. including one or more external surfaces of the one or more portions of the one or more ingestible substrate structures, and/or etc.).

In one or more implementations, as shown in FIG. 100, operation p11 includes an operation p1186 for electronically obtaining the treatment instructional information regarding the one or more subsequent ingestible substrate structure directed energy operations to treat at least a portion of the one or more ingestible substrate structures including one or more ingestible substrate bar structures. Origination of an illustratively derived obtain instructional bar component group can be accomplished through skilled in the art design choice selection of one or more of the above depicted components from one or more of the above depicted subsystems shown in FIG. 51. Components from the obtain instructional bar component group can be used in implementing execution of the one or more obtain instructional bar instructions j1186 of FIG. 50, can be used in performance of the obtain instructional bar electrical circuitry arrangement f1186 of FIG. 43, and/or can be used in otherwise fulfillment of the operation p1186. An exemplary non-transitory signal bearing medium version of the information storage subsystem s200 is depicted in FIG. 50 as bearing the one or more obtain instructional bar instructions j1186 that when executed will direct performance of the operation p1186. Furthermore, the obtain instructional bar electrical circuitry arrangement (“elec circ arrange”) f1186, when activated, will perform the operation p1186. Also, the obtain instructional bar module n1186, when executed and/or activated, will direct performance of and/or perform the operation p1186. For instance, in one or more exemplary implementations, the one or more obtain instructional bar instructions j1186, when executed, direct performance of the operation p1186 in the illustrative depiction as follows, and/or the obtain instructional bar electrical circuitry arrangement f1186, when activated, performs the operation p1186 in the illustrative depiction as follows, and/or the obtain instructional bar module n1186, when executed and/or activated, directs performance of and/or performs the operation p1186 in the illustrative depiction as follows, and/or the operation p1186 is otherwise carried out in the illustrative depiction as follows: electronically obtaining the treatment instructional information regarding the one or more subsequent ingestible substrate structure duct operations to treat (including processing, changing, modifying, supplementing, refining, amplifying, enhancing, acting upon, exposing, reacting with, integrating with, and/or etc.) at least a portion of the one or more ingestible substrate structures including one or more ingestible substrate bar structures (e.g. including rectangular shaped bars, and/or etc.).

In one or more implementations, as shown in FIG. 100, operation p11 includes an operation p1187 for electronically obtaining the treatment instructional information regarding the one or more subsequent ingestible substrate structure directed energy operations to treat at least a portion of the one or more ingestible substrate structures including one or more ingestible substrate rod structures. Origination of an illustratively derived obtain instructional rod component group can be accomplished through skilled in the art design choice selection of one or more of the above depicted components from one or more of the above depicted subsystems shown in FIG. 51. Components from the obtain instructional rod component group can be used in implementing execution of the one or more obtain instructional rod instructions j1187 of FIG. 50, can be used in performance of the obtain instructional rod electrical circuitry arrangement f1187 of FIG. 43, and/or can be used in otherwise fulfillment of the operation p1187. An exemplary non-transitory signal bearing medium version of the information storage subsystem s200 is depicted in FIG. 50 as bearing the one or more obtain instructional rod instructions j1187 that when executed will direct performance of the operation p1187. Furthermore, the obtain instructional rod electrical circuitry arrangement (“elec circ arrange”) f1187, when activated, will perform the operation p1187. Also, the obtain instructional rod module n1187, when executed and/or activated, will direct performance of and/or perform the operation p1187. For instance, in one or more exemplary implementations, the one or more obtain instructional rod instructions j1187, when executed, direct performance of the operation p1187 in the illustrative depiction as follows, and/or the obtain instructional rod electrical circuitry arrangement f1187, when activated, performs the operation p1187 in the illustrative depiction as follows, and/or the obtain instructional rod module n1187, when executed and/or activated, directs performance of and/or performs the operation p1187 in the illustrative depiction as follows, and/or the operation p1187 is otherwise carried out in the illustrative depiction as follows: electronically obtaining the treatment instructional information regarding the one or more subsequent ingestible substrate structure duct operations to treat (including processing, changing, modifying, supplementing, refining, amplifying, enhancing, acting upon, exposing, reacting with, integrating with, and/or etc.) at least a portion of the one or more ingestible substrate structures including one or more ingestible substrate rod structures (e.g. including pretzel sticks, and/or etc.).

In one or more implementations, as shown in FIG. 101, operation p11 includes an operation p1188 for electronically obtaining the treatment instructional information regarding the one or more subsequent ingestible substrate structure directed energy operations to treat at least a portion of the one or more ingestible substrate structures including one or more ingestible substrate wafer structures. Origination of an illustratively derived obtain instructional wafer component group can be accomplished through skilled in the art design choice selection of one or more of the above depicted components from one or more of the above depicted subsystems shown in FIG. 51. Components from the obtain instructional wafer component group can be used in implementing execution of the one or more obtain instructional wafer instructions j1188 of FIG. 50, can be used in performance of the obtain instructional wafer electrical circuitry arrangement f1188 of FIG. 43, and/or can be used in otherwise fulfillment of the operation p1188. An exemplary non-transitory signal bearing medium version of the information storage subsystem s200 is depicted in FIG. 50 as bearing the one or more obtain instructional wafer instructions j1188 that when executed will direct performance of the operation p1188. Furthermore, the obtain instructional wafer electrical circuitry arrangement (“elec circ arrange”) f1188, when activated, will perform the operation p1188. Also, the obtain instructional wafer module n1188, when executed and/or activated, will direct performance of and/or perform the operation p1188. For instance, in one or more exemplary implementations, the one or more obtain instructional wafer instructions j1188, when executed, direct performance of the operation p1188 in the illustrative depiction as follows, and/or the obtain instructional wafer electrical circuitry arrangement f1188, when activated, performs the operation p1188 in the illustrative depiction as follows, and/or the obtain instructional wafer module n1188, when executed and/or activated, directs performance of and/or performs the operation p1188 in the illustrative depiction as follows, and/or the operation p1188 is otherwise carried out in the illustrative depiction as follows: electronically obtaining the treatment instructional information regarding the one or more subsequent ingestible substrate structure duct operations to treat (including processing, changing, modifying, supplementing, refining, amplifying, enhancing, acting upon, exposing, reacting with, integrating with, and/or etc.) at least a portion of the one or more ingestible substrate structures including one or more ingestible substrate wafer structures (e.g. including cookie textured structures, and/or etc.).

In one or more implementations, as shown in FIG. 101, operation p11 includes an operation p1189 for electronically obtaining the treatment instructional information regarding the one or more subsequent ingestible substrate structure directed energy operations to treat at least a portion of the one or more ingestible substrate structures including one or more ingestible substrate pasta structures. Origination of an illustratively derived obtain instructional pasta component group can be accomplished through skilled in the art design choice selection of one or more of the above depicted components from one or more of the above depicted subsystems shown in FIG. 51. Components from the obtain instructional pasta component group can be used in implementing execution of the one or more obtain instructional pasta instructions j1189 of FIG. 50, can be used in performance of the obtain instructional pasta electrical circuitry arrangement f1189 of FIG. 43, and/or can be used in otherwise fulfillment of the operation p1189. An exemplary non-transitory signal bearing medium version of the information storage subsystem s200 is depicted in FIG. 50 as bearing the one or more obtain instructional pasta instructions j1189 that when executed will direct performance of the operation p1189. Furthermore, the obtain instructional pasta electrical circuitry arrangement (“elec circ arrange”) f1189, when activated, will perform the operation p1189. Also, the obtain instructional pasta module n1189, when executed and/or activated, will direct performance of and/or perform the operation p1189. For instance, in one or more exemplary implementations, the one or more obtain instructional pasta instructions j1189, when executed, direct performance of the operation p1189 in the illustrative depiction as follows, and/or the obtain instructional pasta electrical circuitry arrangement f1189, when activated, performs the operation p1189 in the illustrative depiction as follows, and/or the obtain instructional pasta module n1189, when executed and/or activated, directs performance of and/or performs the operation p1189 in the illustrative depiction as follows, and/or the operation p1189 is otherwise carried out in the illustrative depiction as follows: electronically obtaining the treatment instructional information regarding the one or more subsequent ingestible substrate structure duct operations to treat (including processing, changing, modifying, supplementing, refining, amplifying, enhancing, acting upon, exposing, reacting with, integrating with, and/or etc.) at least a portion of the one or more ingestible substrate structures including one or more ingestible substrate pasta structures (e.g. including noodle structures, and/or etc.).

In one or more implementations, as shown in FIG. 101, operation p11 includes an operation p1190 for electronically obtaining the treatment instructional information regarding the one or more subsequent ingestible substrate structure directed energy operations to treat at least a portion of the one or more ingestible substrate structures including one or more ingestible substrate emulsion structures. Origination of an illustratively derived obtain instructional emulsion component group can be accomplished through skilled in the art design choice selection of one or more of the above depicted components from one or more of the above depicted subsystems shown in FIG. 51. Components from the obtain instructional emulsion component group can be used in implementing execution of the one or more obtain instructional emulsion instructions j1190 of FIG. 50, can be used in performance of the obtain instructional emulsion electrical circuitry arrangement f1190 of FIG. 43, and/or can be used in otherwise fulfillment of the operation p1190. An exemplary non-transitory signal bearing medium version of the information storage subsystem s200 is depicted in FIG. 50 as bearing the one or more obtain instructional emulsion instructions j1190 that when executed will direct performance of the operation p1190. Furthermore, the obtain instructional emulsion electrical circuitry arrangement (“elec circ arrange”) f1190, when activated, will perform the operation p1190. Also, the obtain instructional emulsion module n1190, when executed and/or activated, will direct performance of and/or perform the operation p1190. For instance, in one or more exemplary implementations, the one or more obtain instructional emulsion instructions j1190, when executed, direct performance of the operation p1190 in the illustrative depiction as follows, and/or the obtain instructional emulsion electrical circuitry arrangement f1190, when activated, performs the operation p1190 in the illustrative depiction as follows, and/or the obtain instructional emulsion module n1190, when executed and/or activated, directs performance of and/or performs the operation p1190 in the illustrative depiction as follows, and/or the operation p1190 is otherwise carried out in the illustrative depiction as follows: electronically obtaining the treatment instructional information regarding the one or more subsequent ingestible substrate structure duct operations to treat (including processing, changing, modifying, supplementing, refining, amplifying, enhancing, acting upon, exposing, reacting with, integrating with, and/or etc.) at least a portion of the one or more ingestible substrate structures including one or more ingestible substrate emulsion structures (e.g. including a substrate incorporating oil and vinegar, and/or etc.).

In one or more implementations, as shown in FIG. 91, operation p11 includes an operation p1191 for electronically obtaining the treatment instructional information regarding the one or more subsequent ingestible substrate structure directed energy operations to treat at least a portion of the one or more ingestible substrate structures including one or more ingestible substrate sheet structures. Origination of an illustratively derived obtain instructional sheet component group can be accomplished through skilled in the art design choice selection of one or more of the above depicted components from one or more of the above depicted subsystems shown in FIG. 51. Components from the obtain instructional sheet component group can be used in implementing execution of the one or more obtain instructional sheet instructions j1191 of FIG. 50, can be used in performance of the obtain instructional sheet electrical circuitry arrangement f1191 of FIG. 43, and/or can be used in otherwise fulfillment of the operation p1191. An exemplary non-transitory signal bearing medium version of the information storage subsystem s200 is depicted in FIG. 50 as bearing the one or more obtain instructional sheet instructions j1191 that when executed will direct performance of the operation p1191. Furthermore, the obtain instructional sheet electrical circuitry arrangement (“elec circ arrange”) f1191, when activated, will perform the operation p1191. Also, the obtain instructional sheet module n1191, when executed and/or activated, will direct performance of and/or perform the operation p1191. For instance, in one or more exemplary implementations, the one or more obtain instructional sheet instructions j1191, when executed, direct performance of the operation p1191 in the illustrative depiction as follows, and/or the obtain instructional sheet electrical circuitry arrangement f1191, when activated, performs the operation p1191 in the illustrative depiction as follows, and/or the obtain instructional sheet module n1191, when executed and/or activated, directs performance of and/or performs the operation p1191 in the illustrative depiction as follows, and/or the operation p1191 is otherwise carried out in the illustrative depiction as follows: electronically obtaining the treatment instructional information regarding the one or more subsequent ingestible substrate structure duct operations to treat (including processing, changing, modifying, supplementing, refining, amplifying, enhancing, acting upon, exposing, reacting with, integrating with, and/or etc.) at least a portion of the one or more ingestible substrate structures including one or more ingestible substrate sheet structures (e.g. including cake layers, and/or etc.).

In one or more implementations, as shown in FIG. 91, operation p11 includes an operation p1192 for electronically obtaining the treatment instructional information regarding the one or more subsequent ingestible substrate structure directed energy operations to treat at least a portion of the one or more ingestible substrate structures including one or more ingestible substrate liquid structures. Origination of an illustratively derived obtain instructional liquid component group can be accomplished through skilled in the art design choice selection of one or more of the above depicted components from one or more of the above depicted subsystems shown in FIG. 51. Components from the obtain instructional liquid component group can be used in implementing execution of the one or more obtain instructional liquid instructions j1192 of FIG. 50, can be used in performance of the obtain instructional liquid electrical circuitry arrangement f1192 of FIG. 43, and/or can be used in otherwise fulfillment of the operation p1192. An exemplary non-transitory signal bearing medium version of the information storage subsystem s200 is depicted in FIG. 50 as bearing the one or more obtain instructional liquid instructions j1192 that when executed will direct performance of the operation p1192. Furthermore, the obtain instructional liquid electrical circuitry arrangement (“elec circ arrange”) f1192, when activated, will perform the operation p1192. Also, the obtain instructional liquid module n1192, when executed and/or activated, will direct performance of and/or perform the operation p1192. For instance, in one or more exemplary implementations, the one or more obtain instructional liquid instructions j1192, when executed, direct performance of the operation p1192 in the illustrative depiction as follows, and/or the obtain instructional liquid electrical circuitry arrangement f1192, when activated, performs the operation p1192 in the illustrative depiction as follows, and/or the obtain instructional liquid module n1192, when executed and/or activated, directs performance of and/or performs the operation p1192 in the illustrative depiction as follows, and/or the operation p1192 is otherwise carried out in the illustrative depiction as follows: electronically obtaining the treatment instructional information regarding the one or more subsequent ingestible substrate structure duct operations to treat (including processing, changing, modifying, supplementing, refining, amplifying, enhancing, acting upon, exposing, reacting with, integrating with, and/or etc.) at least a portion of the one or more ingestible substrate structures including one or more ingestible substrate liquid structures (e.g. including smoothie ingredients, and/or etc.).

As shown in FIG. 60, the operational flow p10 proceeds to operation p12 for electronically directing control of at least partial treatment of the one or more portions of the one or more ingestible substrate structures according to the treatment instructional information regarding the one or more subsequent ingestible substrate structure directed energy operations including directing energy to treat at least in part the one or more portions of the one or more ingestible substrate structures to form at least in part the one or more selected ingestible products subsequent to and based at least in part upon the electronically receiving the user status information regarding the one or more particular individual living beings and the electronically receiving the selection information at least in part identifying the one or more selected ingestible products. An exemplary version of a non-transitory signal bearing medium of information storage subsystem s200 is depicted as bearing one or more controlling treatment instructions j12 that when executed will direct performance of the operation p12. In an implementation, the one or more controlling treatment instructions j12 when executed direct electronically directing control (e.g. including the microprocessor component s102 can direct control, and/or etc.) of at least partial treatment (e.g. including ingestible parts assembly treatment assembly various ingestible parts to form at least in part one or more ingestible substrate structures, and/or etc.) of the one or more portions of the one or more ingestible substrate structures (e.g. including rods, pasta, wafers, and/or etc.) according to the treatment instructional information (e.g. including treatment steps, and/or etc.) regarding the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) including flowing one or more fluids through one or more ducts (including tubes, channels, conduits, raceways, piping, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures (e.g. including cones, semi-spheres, rectangles, girders, and/or etc.) to form (e.g. including assemble fabricate, layer, make, and/or etc.) at least in part the one or more selected ingestible products (e.g. including snacks, meals, sandwiches, smoothies, medications and/or etc.) subsequent to and based at least in part upon the electronically receiving (e.g. including through wireless, network, direct electrical connection, packets, and/or etc.) the user status information (e.g. including identification, memberships, and/or etc.) regarding the one or more particular individual living beings (e.g. including children, adults, retired, and/or etc.) and the electronically receiving (e.g. including wired reception, and/or etc.) the selection information (e.g. including meal selection, and/or etc.) at least in part identifying (e.g. including titles, names, serial numbers, and/or etc.) the one or more selected ingestible products (e.g. including full meals, European dishes, Asian dishes, Mexican dishes, South American dishes, American dishes, and/or etc.). Furthermore, the controlling treatment electrical circuitry arrangement f12 when activated will perform the operation p12. Also, the controlling treatment module n12, when executed and/or activated, will direct performance of and/or perform the operation p12. In an implementation, the controlling treatment electrical circuitry arrangement f12, when activated performs the operation p12 in the illustrative depiction as follows, and/or the controlling treatment module n12, when executed and/or activated, directs performance of and/or performs electronically directing control (e.g. including the microprocessor component s102 can direct control, and/or etc.) of at least partial treatment (e.g. including ingestible parts assembly treatment assembly various ingestible parts to form at least in part one or more ingestible substrate structures, and/or etc.) of the one or more portions of the one or more ingestible substrate structures (e.g. including rods, pasta, wafers, and/or etc.) according to the treatment instructional information (e.g. including treatment steps, and/or etc.) regarding the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) including flowing one or more fluids through one or more ducts (including tubes, channels, conduits, raceways, piping, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures (e.g. including cones, semi-spheres, rectangles, girders, and/or etc.) to form (e.g. including assemble fabricate, layer, make, and/or etc.) at least in part the one or more selected ingestible products (e.g. including snacks, meals, sandwiches, smoothies, medications and/or etc.) subsequent to and based at least in part upon the electronically receiving (e.g. including through wireless, network, direct electrical connection, packets, and/or etc.) the user status information (e.g. including identification, memberships, and/or etc.) regarding the one or more particular individual living beings (e.g. including children, adults, retired, and/or etc.) and the electronically receiving (e.g. including wired reception, and/or etc.) the selection information (e.g. including meal selection, and/or etc.) at least in part identifying (e.g. including titles, names, serial numbers, and/or etc.) the one or more selected ingestible products (e.g. including full meals, European dishes, Asian dishes, Mexican dishes, South American dishes, American dishes, and/or etc.). In an implementation, the electronically directing control of at least partial treatment of the one or more portions of the one or more ingestible substrate structures according to the treatment instructional information regarding the one or more subsequent ingestible substrate structure directed energy operations including directing energy to treat at least in part the one or more portions of the one or more ingestible substrate structures to form at least in part the one or more selected ingestible products subsequent to and based at least in part upon the electronically receiving the user status information regarding the one or more particular individual living beings and the electronically receiving the selection information at least in part identifying the one or more selected ingestible products is carried out by electronically directing control (e.g. including the microprocessor component s102 can direct control, and/or etc.) of at least partial treatment (e.g. including ingestible parts assembly treatment assembly various ingestible parts to form at least in part one or more ingestible substrate structures, and/or etc.) of the one or more portions of the one or more ingestible substrate structures (e.g. including rods, pasta, wafers, and/or etc.) according to the treatment instructional information (e.g. including treatment steps, and/or etc.) regarding the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) including flowing one or more fluids through one or more ducts (including tubes, channels, conduits, raceways, piping, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures (e.g. including cones, semi-spheres, rectangles, girders, and/or etc.) to form (e.g. including assemble fabricate, layer, make, and/or etc.) at least in part the one or more selected ingestible products (e.g. including snacks, meals, sandwiches, smoothies, medications and/or etc.) subsequent to and based at least in part upon the electronically receiving (e.g. including through wireless, network, direct electrical connection, packets, and/or etc.) the user status information (e.g. including identification, memberships, and/or etc.) regarding the one or more particular individual living beings (e.g. including children, adults, retired, and/or etc.) and the electronically receiving (e.g. including wired reception, and/or etc.) the selection information (e.g. including meal selection, and/or etc.) at least in part identifying (e.g. including titles, names, serial numbers, and/or etc.) the one or more selected ingestible products (e.g. including full meals, European dishes, Asian dishes, Mexican dishes, South American dishes, American dishes, and/or etc.).

In one or more implementations, as shown in FIG. 92, operation p12 includes an operation p1201 for electronically directing control of the at least partial treatment of the one or more ingestible substrate structures according to the treatment instructional information regarding the one or more subsequent ingestible substrate structure directed energy operations via at least in part one or more directly connected electrical circuits. Origination of an illustratively derived direct treatment circuits component group can be accomplished through skilled in the art design choice selection of one or more of the above depicted components from one or more of the above depicted subsystems shown in FIG. 51. Components from the direct treatment circuits component group can be used in implementing execution of the one or more direct treatment circuits instructions j1201 of FIG. 51, can be used in performance of the direct treatment circuits electrical circuitry arrangement f1201 of FIG. 44, and/or can be used in otherwise fulfillment of the operation p1201. An exemplary non-transitory signal bearing medium version of the information storage subsystem s200 is depicted in FIG. 51 as bearing the one or more direct treatment circuits instructions j1201 that when executed will direct performance of the operation p1201. Furthermore, the direct treatment circuits electrical circuitry arrangement (“elec circ arrange”) f1201, when activated, will perform the operation p1201. Also, the direct treatment circuits module n1201, when executed and/or activated, will direct performance of and/or perform the operation p1201. For instance, in one or more exemplary implementations, the one or more direct treatment circuits instructions j1201, when executed, direct performance of the operation p1201 in the illustrative depiction as follows, and/or the direct treatment circuits electrical circuitry arrangement f1201, when activated, performs the operation p1201 in the illustrative depiction as follows, and/or the direct treatment circuits module n1201, when executed and/or activated, directs performance of and/or performs the operation p1201 in the illustrative depiction as follows, and/or the operation p1201 is otherwise carried out in the illustrative depiction as follows: electronically directing control of the at least partial treatment of the one or more ingestible substrate structures according to the treatment instructional information regarding the one or more subsequent ingestible substrate structure duct operations via at least in part one or more directly connected electrical circuits (e.g. including an implementation of the processor component s102 is configured to electronically receive directing control through receiver component s528 electrically connected with the material processing subsystem 700 for treatment of the one or more ingestible products, and/or etc.).

In one or more implementations, as shown in FIG. 92, operation p12 includes an operation p1202 for electronically directing control of the at least partial treatment of the one or more ingestible substrate structures according to the treatment instructional information regarding the one or more subsequent ingestible substrate structure directed energy operations via at least in part electronic computer network communication. Origination of an illustratively derived direct treatment network component group can be accomplished through skilled in the art design choice selection of one or more of the above depicted components from one or more of the above depicted subsystems shown in FIG. 51. Components from the direct treatment network component group can be used in implementing execution of the one or more direct treatment network instructions j1202 of FIG. 51, can be used in performance of the direct treatment network electrical circuitry arrangement f1202 of FIG. 44, and/or can be used in otherwise fulfillment of the operation p1202. An exemplary non-transitory signal bearing medium version of the information storage subsystem s200 is depicted in FIG. 51 as bearing the one or more direct treatment network instructions j1202 that when executed will direct performance of the operation p1202. Furthermore, the direct treatment network electrical circuitry arrangement (“elec circ arrange”) f1202, when activated, will perform the operation p1202. Also, the direct treatment network module n1202, when executed and/or activated, will direct performance of and/or perform the operation p1202. For instance, in one or more exemplary implementations, the one or more direct treatment network instructions j1202, when executed, direct performance of the operation p1202 in the illustrative depiction as follows, and/or the direct treatment network electrical circuitry arrangement f1202, when activated, performs the operation p1202 in the illustrative depiction as follows, and/or the direct treatment network module n1202, when executed and/or activated, directs performance of and/or performs the operation p1202 in the illustrative depiction as follows, and/or the operation p1202 is otherwise carried out in the illustrative depiction as follows: electronically directing control of the at least partial treatment of the one or more ingestible substrate structures according to the treatment instructional information regarding the one or more subsequent ingestible substrate structure duct operations via at least in part electronic computer network communication (e.g. including an implementation of the processor component s102 is configured to electronically receive directing control through internet network components s508 to control the material processing subsystem 700 for treatment of the one or more ingestible products, and/or etc.).

In one or more implementations, as shown in FIG. 92, operation p12 includes an operation p1203 for electronically directing control of the at least partial treatment of the one or more ingestible substrate structures through electronic circuitry located substantially adjacent to electronic circuitry for the electronically receiving the user status information and the electronically receiving the selection information. Origination of an illustratively derived direct treatment adjacent component group can be accomplished through skilled in the art design choice selection of one or more of the above depicted components from one or more of the above depicted subsystems shown in FIG. 51. Components from the direct treatment adjacent component group can be used in implementing execution of the one or more direct treatment adjacent instructions j1203 of FIG. 51, can be used in performance of the direct treatment adjacent electrical circuitry arrangement f1203 of FIG. 44, and/or can be used in otherwise fulfillment of the operation p1203. An exemplary non-transitory signal bearing medium version of the information storage subsystem s200 is depicted in FIG. 51 as bearing the one or more direct treatment adjacent instructions j1203 that when executed will direct performance of the operation p1203. Furthermore, the direct treatment adjacent electrical circuitry arrangement (“elec circ arrange”) f1203, when activated, will perform the operation p1203. Also, the direct treatment adjacent module n1203, when executed and/or activated, will direct performance of and/or perform the operation p1203. For instance, in one or more exemplary implementations, the one or more direct treatment adjacent instructions j1203, when executed, direct performance of the operation p1203 in the illustrative depiction as follows, and/or the direct treatment adjacent electrical circuitry arrangement f1203, when activated, performs the operation p1203 in the illustrative depiction as follows, and/or the direct treatment adjacent module n1203, when executed and/or activated, directs performance of and/or performs the operation p1203 in the illustrative depiction as follows, and/or the operation p1203 is otherwise carried out in the illustrative depiction as follows: electronically directing control of the at least partial treatment of the one or more ingestible substrate structures through electronic circuitry (e.g. including a first electronic component of processing subsystem s100 such as the processor component s102, and/or etc.) located substantially adjacent to electronic circuitry (e.g. including a second electronic component of the processing subsystem s100 such as the CPU component s104, and/or etc.) for the electronically receiving the user status information and the electronically receiving the selection information.

In one or more implementations, as shown in FIG. 93, operation p12 includes an operation p1204 for electronically directing control of the one or more subsequent ingestible substrate structure directed energy operations to treat at least in part the one or more portions of the one or more ingestible substrate structures to influence at least in part one or more color properties of the one or more portions of the one or more ingestible substrate structures to form at least in part the one or more selected ingestible products. Origination of an illustratively derived direct modify color component group can be accomplished through skilled in the art design choice selection of one or more of the above depicted components from one or more of the above depicted subsystems shown in FIG. 51. Components from the direct modify color component group can be used in implementing execution of the one or more direct modify color instructions j1204 of FIG. 51, can be used in performance of the direct modify color electrical circuitry arrangement f1204 of FIG. 44, and/or can be used in otherwise fulfillment of the operation p1204. An exemplary non-transitory signal bearing medium version of the information storage subsystem s200 is depicted in FIG. 51 as bearing the one or more direct modify color instructions j1204 that when executed will direct performance of the operation p1204. Furthermore, the direct modify color electrical circuitry arrangement (“elec circ arrange”) f1204, when activated, will perform the operation p1204. Also, the direct modify color module n1204, when executed and/or activated, will direct performance of and/or perform the operation p1204. For instance, in one or more exemplary implementations, the one or more direct modify color instructions j1204, when executed, direct performance of the operation p1204 in the illustrative depiction as follows, and/or the direct modify color electrical circuitry arrangement f1204, when activated, performs the operation p1204 in the illustrative depiction as follows, and/or the direct modify color module n1204, when executed and/or activated, directs performance of and/or performs the operation p1204 in the illustrative depiction as follows, and/or the operation p1204 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including replace, and/or etc.) one or more color properties (e.g. including increase intensity of existing surface color, and/or etc.) of the one or more portions of the one or more ingestible substrate structures (e.g. one or more rectangular structures, etc.) to form (e.g. including assemble fabricate, layer, make, and/or etc.) at least in part the one or more selected ingestible products.

In one or more implementations, as shown in FIG. 93, operation p12 includes an operation p1205 for electronically directing control of the one or more subsequent ingestible substrate structure directed energy operations at least in part the one or more portions of the one or more ingestible substrate structures to influence at least in part one or more surface texture properties of the one or more portions of the one or more ingestible substrate structures to form at least in part the one or more selected ingestible products. Origination of an illustratively derived direct modify surface component group can be accomplished through skilled in the art design choice selection of one or more of the above depicted components from one or more of the above depicted subsystems shown in FIG. 51. Components from the direct modify surface component group can be used in implementing execution of the one or more direct modify surface instructions j1205 of FIG. 51, can be used in performance of the direct modify surface electrical circuitry arrangement f1205 of FIG. 44, and/or can be used in otherwise fulfillment of the operation p1205. An exemplary non-transitory signal bearing medium version of the information storage subsystem s200 is depicted in FIG. 51 as bearing the one or more direct modify surface instructions j1205 that when executed will direct performance of the operation p1205. Furthermore, the direct modify surface electrical circuitry arrangement (“elec circ arrange”) f1205, when activated, will perform the operation p1205. Also, the direct modify surface module n1205, when executed and/or activated, will direct performance of and/or perform the operation p1205. For instance, in one or more exemplary implementations, the one or more direct modify surface instructions j1205, when executed, direct performance of the operation p1205 in the illustrative depiction as follows, and/or the direct modify surface electrical circuitry arrangement f1205, when activated, performs the operation p1205 in the illustrative depiction as follows, and/or the direct modify surface module n1205, when executed and/or activated, directs performance of and/or performs the operation p1205 in the illustrative depiction as follows, and/or the operation p1205 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including create indentations, and/or etc.) one or more surface texture properties (e.g. including surface integrity, and/or etc.) of the one or more portions of the one or more ingestible substrate structures (e.g. one or more flake structures, etc.) to form (e.g. including assemble fabricate, layer, make, and/or etc.) at least in part the one or more selected ingestible products.

In one or more implementations, as shown in FIG. 93, operation p12 includes an operation p1206 for electronically directing control of the one or more subsequent ingestible substrate structure directed energy operations to treat at least in part the one or more portions of the one or more ingestible substrate structures to influence at least in part one or more oral sensation properties of the one or more portions of the one or more ingestible substrate structures to form at least in part the one or more selected ingestible products. Origination of an illustratively derived direct modify oral component group can be accomplished through skilled in the art design choice selection of one or more of the above depicted components from one or more of the above depicted subsystems shown in FIG. 51. Components from the direct modify oral component group can be used in implementing execution of the one or more direct modify oral instructions j1206 of FIG. 51, can be used in performance of the direct modify oral electrical circuitry arrangement f1206 of FIG. 44, and/or can be used in otherwise fulfillment of the operation p1206. An exemplary non-transitory signal bearing medium version of the information storage subsystem s200 is depicted in FIG. 51 as bearing the one or more direct modify oral instructions j1206 that when executed will direct performance of the operation p1206. Furthermore, the direct modify oral electrical circuitry arrangement (“elec circ arrange”) f1206, when activated, will perform the operation p1206. Also, the direct modify oral module n1206, when executed and/or activated, will direct performance of and/or perform the operation p1206. For instance, in one or more exemplary implementations, the one or more direct modify oral instructions j1206, when executed, direct performance of the operation p1206 in the illustrative depiction as follows, and/or the direct modify oral electrical circuitry arrangement f1206, when activated, performs the operation p1206 in the illustrative depiction as follows, and/or the direct modify oral module n1206, when executed and/or activated, directs performance of and/or performs the operation p1206 in the illustrative depiction as follows, and/or the operation p1206 is otherwise carried out in the illustrative depiction as follows: electronically directing control of the one or more subsequent ingestible substrate structure duct operations (e.g. e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including enhancement, and/or etc.) one or more oral sensation properties (e.g. including adding mint-based flavors, and/or etc.) of the one or more portions of the one or more ingestible substrate structures (e.g. one or more strip structures, etc.) to form (e.g. including assemble fabricate, layer, make, and/or etc.) at least in part the one or more selected ingestible products.

In one or more implementations, as shown in FIG. 94, operation p12 includes an operation p1207 for electronically directing control of the one or more subsequent ingestible substrate structure directed energy operations to treat at least in part the one or more portions of the one or more ingestible substrate structures to influence at least in part one or more sound properties of the one or more portions of the one or more ingestible substrate structures to form at least in part the one or more selected ingestible products. Origination of an illustratively derived direct modify sound component group can be accomplished through skilled in the art design choice selection of one or more of the above depicted components from one or more of the above depicted subsystems shown in FIG. 51. Components from the direct modify sound component group can be used in implementing execution of the one or more direct modify sound instructions j1207 of FIG. 51, can be used in performance of the direct modify sound electrical circuitry arrangement f1207 of FIG. 44, and/or can be used in otherwise fulfillment of the operation p1207. An exemplary non-transitory signal bearing medium version of the information storage subsystem s200 is depicted in FIG. 51 as bearing the one or more direct modify sound instructions j1207 that when executed will direct performance of the operation p1207. Furthermore, the direct modify sound electrical circuitry arrangement (“elec circ arrange”) f1207, when activated, will perform the operation p1207. Also, the direct modify sound module n1207, when executed and/or activated, will direct performance of and/or perform the operation p1207. For instance, in one or more exemplary implementations, the one or more direct modify sound instructions j1207, when executed, direct performance of the operation p1207 in the illustrative depiction as follows, and/or the direct modify sound electrical circuitry arrangement f1207, when activated, performs the operation p1207 in the illustrative depiction as follows, and/or the direct modify sound module n1207, when executed and/or activated, directs performance of and/or performs the operation p1207 in the illustrative depiction as follows, and/or the operation p1207 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including reducing decibel levels, and/or etc.) one or more sound properties (e.g. including decibel levels when substrate is bitten into, and/or etc.) of the one or more portions of the one or more ingestible substrate structures (e.g. one or more pasta structures, etc.) to form (e.g. including assemble fabricate, layer, make, and/or etc.) at least in part the one or more selected ingestible products.

In one or more implementations, as shown in FIG. 94, operation p12 includes an operation p1208 for electronically directing control of the one or more subsequent ingestible substrate structure directed energy operations to treat at least in part the one or more portions of the one or more ingestible substrate structures to influence at least in part one or more structural texture properties of the one or more portions of the one or more ingestible substrate structures to form at least in part the one or more selected ingestible products. Origination of an illustratively derived direct modify structural component group can be accomplished through skilled in the art design choice selection of one or more of the above depicted components from one or more of the above depicted subsystems shown in FIG. 51. Components from the direct modify structural component group can be used in implementing execution of the one or more direct modify structural instructions j1208 of FIG. 51, can be used in performance of the direct modify structural electrical circuitry arrangement f1208 of FIG. 44, and/or can be used in otherwise fulfillment of the operation p1208. An exemplary non-transitory signal bearing medium version of the information storage subsystem s200 is depicted in FIG. 51 as bearing the one or more direct modify structural instructions j1208 that when executed will direct performance of the operation p1208. Furthermore, the direct modify structural electrical circuitry arrangement (“elec circ arrange”) f1208, when activated, will perform the operation p1208. Also, the direct modify structural module n1208, when executed and/or activated, will direct performance of and/or perform the operation p1208. For instance, in one or more exemplary implementations, the one or more direct modify structural instructions j1208, when executed, direct performance of the operation p1208 in the illustrative depiction as follows, and/or the direct modify structural electrical circuitry arrangement f1208, when activated, performs the operation p1208 in the illustrative depiction as follows, and/or the direct modify structural module n1208, when executed and/or activated, directs performance of and/or performs the operation p1208 in the illustrative depiction as follows, and/or the operation p1208 is otherwise carried out in the illustrative depiction as follows: electronically directing control of the one or more subsequent ingestible substrate structure duct operations (e.g. including stacking, inserting, laying, placing, joining, affixing, gluing, joining, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including strengthening, and/or etc.) one or more structural texture properties (e.g. including rigidity, and/or etc.) of the one or more portions of the one or more ingestible substrate structures (e.g. one or more sheet structures, etc.) to form (e.g. including assemble fabricate, layer, make, and/or etc.) at least in part the one or more selected ingestible products.

In one or more implementations, as shown in FIG. 94, operation p12 includes an operation p1209 for electronically directing control of the one or more subsequent ingestible substrate structure directed energy operations to treat at least in part the one or more portions of the one or more ingestible substrate structures to influence at least in part one or more olfactory properties of the one or more portions of the one or more ingestible substrate structures to form at least in part the one or more selected ingestible products. Origination of an illustratively derived direct modify olfactory component group can be accomplished through skilled in the art design choice selection of one or more of the above depicted components from one or more of the above depicted subsystems shown in FIG. 51. Components from the direct modify olfactory component group can be used in implementing execution of the one or more direct modify olfactory instructions j1209 of FIG. 51, can be used in performance of the direct modify olfactory electrical circuitry arrangement f1209 of FIG. 44, and/or can be used in otherwise fulfillment of the operation p1209. An exemplary non-transitory signal bearing medium version of the information storage subsystem s200 is depicted in FIG. 51 as bearing the one or more direct modify olfactory instructions j1209 that when executed will direct performance of the operation p1209. Furthermore, the direct modify olfactory electrical circuitry arrangement (“elec circ arrange”) f1209, when activated, will perform the operation p1209. Also, the direct modify olfactory module n1209, when executed and/or activated, will direct performance of and/or perform the operation p1209. For instance, in one or more exemplary implementations, the one or more direct modify olfactory instructions j1209, when executed, direct performance of the operation p1209 in the illustrative depiction as follows, and/or the direct modify olfactory electrical circuitry arrangement f1209, when activated, performs the operation p1209 in the illustrative depiction as follows, and/or the direct modify olfactory module n1209, when executed and/or activated, directs performance of and/or performs the operation p1209 in the illustrative depiction as follows, and/or the operation p1209 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including adding scents, and/or etc.) one or more olfactory properties (e.g. including smell of the substrate, and/or etc.) of the one or more portions of the one or more ingestible substrate structures (e.g. one or more liquid filled structures, etc.) to form (e.g. including assemble fabricate, layer, make, and/or etc.) at least in part the one or more selected ingestible products.

In one or more implementations, as shown in FIG. 95, operation p12 includes an operation p1210 for electronically directing control of the one or more subsequent ingestible substrate structure directed energy operations to treat at least in part the one or more portions of the one or more ingestible substrate structures to influence at least in part one or more shape properties of the one or more portions of the one or more ingestible substrate structures to form at least in part the one or more selected ingestible products. Origination of an illustratively derived direct modify shape component group can be accomplished through skilled in the art design choice selection of one or more of the above depicted components from one or more of the above depicted subsystems shown in FIG. 51. Components from the direct modify shape component group can be used in implementing execution of the one or more direct modify shape instructions j1210 of FIG. 51, can be used in performance of the direct modify shape electrical circuitry arrangement f1210 of FIG. 44, and/or can be used in otherwise fulfillment of the operation p1210. An exemplary non-transitory signal bearing medium version of the information storage subsystem s200 is depicted in FIG. 51 as bearing the one or more direct modify shape instructions j1210 that when executed will direct performance of the operation p1210. Furthermore, the direct modify shape electrical circuitry arrangement (“elec circ arrange”) f1210, when activated, will perform the operation p1210. Also, the direct modify shape module n1210, when executed and/or activated, will direct performance of and/or perform the operation p1210. For instance, in one or more exemplary implementations, the one or more direct modify shape instructions j1210, when executed, direct performance of the operation p1210 in the illustrative depiction as follows, and/or the direct modify shape electrical circuitry arrangement f1210, when activated, performs the operation p1210 in the illustrative depiction as follows, and/or the direct modify shape module n1210, when executed and/or activated, directs performance of and/or performs the operation p1210 in the illustrative depiction as follows, and/or the operation p1210 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including eliminate portions of the substrate, and/or etc.) one or more shape properties (e.g. including changing a rectangularly configured substrate to irregularly configured substrate, and/or etc.) of the one or more portions of the one or more ingestible substrate structures (e.g. one or more sheet structures, etc.) to form (e.g. including assemble fabricate, layer, make, and/or etc.) at least in part the one or more selected ingestible products.

In one or more implementations, as shown in FIG. 95, operation p12 includes an operation p1211 for electronically directing control of the one or more subsequent ingestible substrate structure directed energy operations to treat at least in part the one or more portions of the one or more ingestible substrate structures to influence at least in part one or more psycho-sensory properties of the one or more portions of the one or more ingestible substrate structures to form at least in part the one or more selected ingestible products. Origination of an illustratively derived direct modify psycho-sensory component group can be accomplished through skilled in the art design choice selection of one or more of the above depicted components from one or more of the above depicted subsystems shown in FIG. 51. Components from the direct modify psycho-sensory component group can be used in implementing execution of the one or more direct modify psycho-sensory instructions j1211 of FIG. 51, can be used in performance of the direct modify psycho-sensory electrical circuitry arrangement f1211 of FIG. 44, and/or can be used in otherwise fulfillment of the operation p1211. An exemplary non-transitory signal bearing medium version of the information storage subsystem s200 is depicted in FIG. 51 as bearing the one or more direct modify psycho-sensory instructions j1211 that when executed will direct performance of the operation p1211. Furthermore, the direct modify psycho-sensory electrical circuitry arrangement (“elec circ arrange”) f1211, when activated, will perform the operation p1211. Also, the direct modify psycho-sensory module n1211, when executed and/or activated, will direct performance of and/or perform the operation p1211. For instance, in one or more exemplary implementations, the one or more direct modify psycho-sensory instructions j1211, when executed, direct performance of the operation p1211 in the illustrative depiction as follows, and/or the direct modify psycho-sensory electrical circuitry arrangement f1211, when activated, performs the operation p1211 in the illustrative depiction as follows, and/or the direct modify psycho-sensory module n1211, when executed and/or activated, directs performance of and/or performs the operation p1211 in the illustrative depiction as follows, and/or the operation p1211 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including adding perceived sensory output associated with a selected ingestible product, and/or etc.) one or more psycho-sensory properties (e.g. including perceived flavor as influenced by a combination of color and scent, and/or etc.) of the one or more portions of the one or more ingestible substrate structures (e.g. one or more color or scent encapsulation containing structures, etc.) to form (e.g. including assemble fabricate, layer, make, and/or etc.) at least in part the one or more selected ingestible products.

In one or more implementations, as shown in FIG. 95, operation p12 includes an operation p1212 for electronically directing control of the one or more subsequent ingestible substrate structure directed energy operations to treat at least in part the one or more portions of the one or more ingestible substrate structures to influence at least in part one or more visual patterns of the one or more portions of the one or more ingestible substrate structures to form at least in part the one or more selected ingestible products. Origination of an illustratively derived direct modify visual pattern component group can be accomplished through skilled in the art design choice selection of one or more of the above depicted components from one or more of the above depicted subsystems shown in FIG. 51. Components from the direct modify visual pattern component group can be used in implementing execution of the one or more direct modify visual pattern instructions j1212 of FIG. 51, can be used in performance of the direct modify visual pattern electrical circuitry arrangement f1212 of FIG. 44, and/or can be used in otherwise fulfillment of the operation p1212. An exemplary non-transitory signal bearing medium version of the information storage subsystem s200 is depicted in FIG. 51 as bearing the one or more direct modify visual pattern instructions j1212 that when executed will direct performance of the operation p1212. Furthermore, the direct modify visual pattern electrical circuitry arrangement (“elec circ arrange”) f1212, when activated, will perform the operation p1212. Also, the direct modify visual pattern module n1212, when executed and/or activated, will direct performance of and/or perform the operation p1212. For instance, in one or more exemplary implementations, the one or more direct modify visual pattern instructions j1212, when executed, direct performance of the operation p1212 in the illustrative depiction as follows, and/or the direct modify visual pattern electrical circuitry arrangement f1212, when activated, performs the operation p1212 in the illustrative depiction as follows, and/or the direct modify visual pattern module n1212, when executed and/or activated, directs performance of and/or performs the operation p1212 in the illustrative depiction as follows, and/or the operation p1212 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including intensify, and/or etc.) one or more visual patterns (e.g. including variations in surface shading made by slight impressions, and/or etc.) of the one or more portions of the one or more ingestible substrate structures (e.g. one or more sheet structures, etc.) to form (e.g. including assemble fabricate, layer, make, and/or etc.) at least in part the one or more selected ingestible products.

In one or more implementations, as shown in FIG. 96, operation p12 includes an operation p1213 for electronically directing control of the one or more subsequent ingestible substrate structure directed energy operations to treat at least in part the one or more portions of the one or more ingestible substrate structures to influence at least in part one or more textual patterns of the one or more portions of the one or more ingestible substrate structures to form at least in part the one or more selected ingestible products. Origination of an illustratively derived direct modify textural pattern component group can be accomplished through skilled in the art design choice selection of one or more of the above depicted components from one or more of the above depicted subsystems shown in FIG. 51. Components from the direct modify textural pattern component group can be used in implementing execution of the one or more direct modify textural pattern instructions j1213 of FIG. 51, can be used in performance of the direct modify textural pattern electrical circuitry arrangement f1213 of FIG. 44, and/or can be used in otherwise fulfillment of the operation p1213. An exemplary non-transitory signal bearing medium version of the information storage subsystem s200 is depicted in FIG. 51 as bearing the one or more direct modify textural pattern instructions j1213 that when executed will direct performance of the operation p1213. Furthermore, the direct modify textural pattern electrical circuitry arrangement (“elec circ arrange”) f1213, when activated, will perform the operation p1213. Also, the direct modify textural pattern module n1213, when executed and/or activated, will direct performance of and/or perform the operation p1213. For instance, in one or more exemplary implementations, the one or more direct modify textural pattern instructions j1213, when executed, direct performance of the operation p1213 in the illustrative depiction as follows, and/or the direct modify textural pattern electrical circuitry arrangement f1213, when activated, performs the operation p1213 in the illustrative depiction as follows, and/or the direct modify textural pattern module n1213, when executed and/or activated, directs performance of and/or performs the operation p1213 in the illustrative depiction as follows, and/or the operation p1213 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including variability in surface depth, and/or etc.) one or more textual patterns (e.g. including regular rows of depressions running along the surface of the substrate structure, and/or etc.) of the one or more portions of the one or more ingestible substrate structures (e.g. one or more rectangular structures, etc.) to form (e.g. including assemble fabricate, layer, make, and/or etc.) at least in part the one or more selected ingestible products.

In one or more implementations, as shown in FIG. 96, operation p12 includes an operation p1214 for electronically directing control of the one or more subsequent ingestible substrate structure directed energy operations including directing energy in laser form to treat the one or more portions of the one or more ingestible substrate structures to influence at least in part one or more properties of the one or more portions of the one or more ingestible substrate structures to form at least in part the one or more selected ingestible products. Origination of an illustratively derived direct object laser component group can be accomplished through skilled in the art design choice selection of one or more of the above depicted components from one or more of the above depicted subsystems shown in FIG. 51. Components from the direct object laser component group can be used in implementing execution of the one or more direct object laser instructions j1214 of FIG. 51, can be used in performance of the direct object laser electrical circuitry arrangement f1214 of FIG. 44, and/or can be used in otherwise fulfillment of the operation p1214. An exemplary non-transitory signal bearing medium version of the information storage subsystem s200 is depicted in FIG. 51 as bearing the one or more direct object laser instructions j1214 that when executed will direct performance of the operation p1214. Furthermore, the direct object laser electrical circuitry arrangement (“elec circ arrange”) f1214, when activated, will perform the operation p1214. Also, the direct object laser module n1214, when executed and/or activated, will direct performance of and/or perform the operation p1214. For instance, in one or more exemplary implementations, the one or more direct object laser instructions j1214, when executed, direct performance of the operation p1214 in the illustrative depiction as follows, and/or the direct object laser electrical circuitry arrangement f1214, when activated, performs the operation p1214 in the illustrative depiction as follows, and/or the direct object laser module n1214, when executed and/or activated, directs performance of and/or performs the operation p1214 in the illustrative depiction as follows, and/or the operation p1214 is otherwise carried out in the illustrative depiction as follows: electronically directing control of the one or more subsequent ingestible substrate structure duct operations including flowing one or more fluids through one or more ducts located internally within one or more portions of the one or more ingestible structures (e.g. one or more pins, nails, spikes, etc.) to treat (including processing, changing, modifying, supplementing, refining, amplifying, enhancing, acting upon, exposing, reacting with, integrating with, and/or etc.) the one or more portions (e.g. including one or more embedded flavor encapsulations, etc.) of the one or more ingestible substrate structures to influence at least in part (e.g. change surface composition, and/or etc.) one or more properties (e.g. including flavor, and/or etc.) of the one or more portions of the one or more ingestible substrate structures to form (e.g. including assemble fabricate, layer, make, and/or etc.) at least in part the one or more selected ingestible products.

In one or more implementations, as shown in FIG. 96, operation p12 includes an operation p1215 for electronically directing control of the one or more subsequent ingestible substrate structure directed energy operations including directing energy in microwave form to treat at least in part the one or more portions of the one or more ingestible substrate structures to influence at least in part one or more properties of the one or more portions of the one or more ingestible substrate structures to form at least in part the one or more selected ingestible products. Origination of an illustratively derived direct object microwave component group can be accomplished through skilled in the art design choice selection of one or more of the above depicted components from one or more of the above depicted subsystems shown in FIG. 51. Components from the direct object microwave component group can be used in implementing execution of the one or more direct object microwave instructions j1215 of FIG. 51, can be used in performance of the direct object microwave electrical circuitry arrangement f1215 of FIG. 44, and/or can be used in otherwise fulfillment of the operation p1215. An exemplary non-transitory signal bearing medium version of the information storage subsystem s200 is depicted in FIG. 51 as bearing the one or more direct object microwave instructions j1215 that when executed will direct performance of the operation p1215. Furthermore, the direct object microwave electrical circuitry arrangement (“elec circ arrange”) f1215, when activated, will perform the operation p1215. Also, the direct object microwave module n1215, when executed and/or activated, will direct performance of and/or perform the operation p1215. For instance, in one or more exemplary implementations, the one or more direct object microwave instructions j1215, when executed, direct performance of the operation p1215 in the illustrative depiction as follows, and/or the direct object microwave electrical circuitry arrangement f1215, when activated, performs the operation p1215 in the illustrative depiction as follows, and/or the direct object microwave module n1215, when executed and/or activated, directs performance of and/or performs the operation p1215 in the illustrative depiction as follows, and/or the operation p1215 is otherwise carried out in the illustrative depiction as follows: electronically directing control of the one or more subsequent ingestible substrate structure duct operations including flowing one or more fluids through one or more ducts located externally in juxtaposition thereto one or more portions of the one or more ingestible structures (e.g. one or more planar, cuboid, polygonal, wire, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including add to the surface composition, and/or etc.) one or more properties (e.g. including modifying surface texture, and/or etc.) of the one or more portions of the one or more ingestible substrate structures to form (e.g. including assemble fabricate, layer, make, and/or etc.) at least in part the one or more selected ingestible products.

In one or more implementations, as shown in FIG. 97, operation p12 includes an operation p1216 for electronically directing control of the one or more subsequent ingestible substrate structure directed energy operations including directing energy in acoustic form to treat at least in part the one or more portions of the one or more ingestible substrate structures to influence at least in part one or more properties of the one or more portions of the one or more ingestible substrate structures to form at least in part the one or more selected ingestible products. Origination of an illustratively derived direct object acoustic component group can be accomplished through skilled in the art design choice selection of one or more of the above depicted components from one or more of the above depicted subsystems shown in FIG. 51. Components from the direct object acoustic component group can be used in implementing execution of the one or more direct object acoustic instructions j1216 of FIG. 51, can be used in performance of the direct object acoustic electrical circuitry arrangement f1216 of FIG. 44, and/or can be used in otherwise fulfillment of the operation p1216. An exemplary non-transitory signal bearing medium version of the information storage subsystem s200 is depicted in FIG. 51 as bearing the one or more direct object acoustic instructions j1216 that when executed will direct performance of the operation p1216. Furthermore, the direct object acoustic electrical circuitry arrangement (“elec circ arrange”) f1216, when activated, will perform the operation p1216. Also, the direct object acoustic module n1216, when executed and/or activated, will direct performance of and/or perform the operation p1216. For instance, in one or more exemplary implementations, the one or more direct object acoustic instructions j1216, when executed, direct performance of the operation p1216 in the illustrative depiction as follows, and/or the direct object acoustic electrical circuitry arrangement f1216, when activated, performs the operation p1216 in the illustrative depiction as follows, and/or the direct object acoustic module n1216, when executed and/or activated, directs performance of and/or performs the operation p1216 in the illustrative depiction as follows, and/or the operation p1216 is otherwise carried out in the illustrative depiction as follows: electronically directing control of the one or more subsequent ingestible substrate structure duct operations including flowing one or more fluids through one or more ducts as substantially matrix structures to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including changing shape of structure, and/or etc.) one or more properties (e.g. including textural patterns, and/or etc.) of the one or more portions of the one or more ingestible substrate structures to form (e.g. including assemble fabricate, layer, make, and/or etc.) at least in part the one or more selected ingestible products.

In one or more implementations, as shown in FIG. 97, operation p12 includes an operation p1217 for electronically directing control of the one or more subsequent ingestible substrate structure directed energy operations including directing energy in radiant form to treat at least in part the one or more portions of the one or more ingestible substrate structures to influence at least in part one or more properties of the one or more portions of the one or more ingestible substrate structures to form at least in part the one or more selected ingestible products. Origination of an illustratively derived direct object radiant component group can be accomplished through skilled in the art design choice selection of one or more of the above depicted components from one or more of the above depicted subsystems shown in FIG. 51. Components from the direct object radiant component group can be used in implementing execution of the one or more direct object radiant instructions j1217 of FIG. 51, can be used in performance of the direct object radiant electrical circuitry arrangement f1217 of FIG. 44, and/or can be used in otherwise fulfillment of the operation p1217. An exemplary non-transitory signal bearing medium version of the information storage subsystem s200 is depicted in FIG. 51 as bearing the one or more direct object radiant instructions j1217 that when executed will direct performance of the operation p1217. Furthermore, the direct object radiant electrical circuitry arrangement (“elec circ arrange”) f1217, when activated, will perform the operation p1217. Also, the direct object radiant module n1217, when executed and/or activated, will direct performance of and/or perform the operation p1217. For instance, in one or more exemplary implementations, the one or more direct object radiant instructions j1217, when executed, direct performance of the operation p1217 in the illustrative depiction as follows, and/or the direct object radiant electrical circuitry arrangement f1217, when activated, performs the operation p1217 in the illustrative depiction as follows, and/or the direct object radiant module n1217, when executed and/or activated, directs performance of and/or performs the operation p1217 in the illustrative depiction as follows, and/or the operation p1217 is otherwise carried out in the illustrative depiction as follows: electronically directing control of the one or more subsequent ingestible substrate structure duct operations including flowing one or more fluids through one or more ducts as one or more substantially curvilinear structures to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including changing volume, and/or etc.) one or more properties (e.g. including size and structural texture, and/or etc.) of the one or more portions of the one or more ingestible substrate structures to form (e.g. including assemble fabricate, layer, make, and/or etc.) at least in part the one or more selected ingestible products.

In one or more implementations, as shown in FIG. 97, operation p12 includes an operation p1218 for electronically directing control of the one or more subsequent ingestible substrate structure directed energy operations to treat at least in part the one or more portions of the one or more ingestible substrate structures to influence at least in part one or more properties of the one or more portions of the one or more ingestible substrate structures as substantially one or more carbohydrates to form at least in part the one or more selected ingestible products. Origination of an illustratively derived direct substrate carbohydrate component group can be accomplished through skilled in the art design choice selection of one or more of the above depicted components from one or more of the above depicted subsystems shown in FIG. 51. Components from the direct substrate carbohydrate component group can be used in implementing execution of the one or more direct substrate carbohydrate instructions j1218 of FIG. 51, can be used in performance of the direct substrate carbohydrate electrical circuitry arrangement f1218 of FIG. 44, and/or can be used in otherwise fulfillment of the operation p1218. An exemplary non-transitory signal bearing medium version of the information storage subsystem s200 is depicted in FIG. 51 as bearing the one or more direct substrate carbohydrate instructions j1218 that when executed will direct performance of the operation p1218. Furthermore, the direct substrate carbohydrate electrical circuitry arrangement (“elec circ arrange”) f1218, when activated, will perform the operation p1218. Also, the direct substrate carbohydrate module n1218, when executed and/or activated, will direct performance of and/or perform the operation p1218. For instance, in one or more exemplary implementations, the one or more direct substrate carbohydrate instructions j1218, when executed, direct performance of the operation p1218 in the illustrative depiction as follows, and/or the direct substrate carbohydrate electrical circuitry arrangement f1218, when activated, performs the operation p1218 in the illustrative depiction as follows, and/or the direct substrate carbohydrate module n1218, when executed and/or activated, directs performance of and/or performs the operation p1218 in the illustrative depiction as follows, and/or the operation p1218 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including changing, and/or etc.) one or more properties (e.g. including flavor, and/or etc.) of the one or more portions of the one or more ingestible substrate structures as substantially one or more carbohydrates (e.g. including rice starch, and/or etc.) to form (e.g. including assemble fabricate, layer, make, and/or etc.) at least in part the one or more selected ingestible products.

In one or more implementations, as shown in FIG. 98, operation p12 includes an operation p1219 for electronically directing control of the one or more subsequent ingestible substrate structure directed energy operations to treat at least in part the one or more portions of the one or more ingestible substrate structures to influence at least in part one or more properties of the one or more portions of the one or more ingestible substrate structures as substantially one or more fats to form at least in part the one or more selected ingestible products. Origination of an illustratively derived direct substrate fat component group can be accomplished through skilled in the art design choice selection of one or more of the above depicted components from one or more of the above depicted subsystems shown in FIG. 51. Components from the direct substrate fat component group can be used in implementing execution of the one or more direct substrate fat instructions j1219 of FIG. 51, can be used in performance of the direct substrate fat electrical circuitry arrangement f1219 of FIG. 44, and/or can be used in otherwise fulfillment of the operation p1219. An exemplary non-transitory signal bearing medium version of the information storage subsystem s200 is depicted in FIG. 51 as bearing the one or more direct substrate fat instructions j1219 that when executed will direct performance of the operation p1219. Furthermore, the direct substrate fat electrical circuitry arrangement (“elec circ arrange”) f1219, when activated, will perform the operation p1219. Also, the direct substrate fat module n1219, when executed and/or activated, will direct performance of and/or perform the operation p1219. For instance, in one or more exemplary implementations, the one or more direct substrate fat instructions j1219, when executed, direct performance of the operation p1219 in the illustrative depiction as follows, and/or the direct substrate fat electrical circuitry arrangement f1219, when activated, performs the operation p1219 in the illustrative depiction as follows, and/or the direct substrate fat module n1219, when executed and/or activated, directs performance of and/or performs the operation p1219 in the illustrative depiction as follows, and/or the operation p1219 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including darken, and/or etc.) one or more properties (e.g. including substrate color, and/or etc.) of the one or more portions of the one or more ingestible substrate structures as substantially one or more fats (e.g. including coconut oil, and/or etc.) to form (e.g. including assemble fabricate, layer, make, and/or etc.) at least in part the one or more selected ingestible products.

In one or more implementations, as shown in FIG. 98, operation p12 includes an operation p1220 for electronically directing control of the one or more subsequent ingestible substrate structure directed energy operations to treat at least in part the one or more portions of the one or more ingestible substrate structures to influence at least in part one or more properties of the one or more portions of the one or more ingestible substrate structures as substantially one or more proteins to form at least in part the one or more selected ingestible products. Origination of an illustratively derived direct substrate protein component group can be accomplished through skilled in the art design choice selection of one or more of the above depicted components from one or more of the above depicted subsystems shown in FIG. 51. Components from the direct substrate protein component group can be used in implementing execution of the one or more direct substrate protein instructions j1220 of FIG. 52, can be used in performance of the direct substrate protein electrical circuitry arrangement f1220 of FIG. 45, and/or can be used in otherwise fulfillment of the operation p1220. An exemplary non-transitory signal bearing medium version of the information storage subsystem s200 is depicted in FIG. 52 FIG. 52 as bearing the one or more direct substrate protein instructions j1220 that when executed will direct performance of the operation p1220. Furthermore, the direct substrate protein electrical circuitry arrangement (“elec circ arrange”) f1220, when activated, will perform the operation p1220. Also, the direct substrate protein module n1220, when executed and/or activated, will direct performance of and/or perform the operation p1220. For instance, in one or more exemplary implementations, the one or more direct substrate protein instructions j1220, when executed, direct performance of the operation p1220 in the illustrative depiction as follows, and/or the direct substrate protein electrical circuitry arrangement f1220, when activated, performs the operation p1220 in the illustrative depiction as follows, and/or the direct substrate protein module n1220, when executed and/or activated, directs performance of and/or performs the operation p1220 in the illustrative depiction as follows, and/or the operation p1220 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including increase, and/or etc.) one or more properties (e.g. including patterning of surface texture, and/or etc.) of the one or more portions of the one or more ingestible substrate structures as substantially one or more proteins (e.g. including peanut butter, and/or etc.) to form (e.g. including assemble fabricate, layer, make, and/or etc.) at least in part the one or more selected ingestible products.

In one or more implementations, as shown in FIG. 98, operation p12 includes an operation p1221 for electronically directing control of the one or more subsequent ingestible substrate structure directed energy operations to treat at least in part the one or more portions of the one or more ingestible substrate structures to influence at least in part one or more properties of the one or more portions of the one or more ingestible substrate structures through at least in part multiple beam arrangements for the one or more portions of the one or more ingestible substrate structures to form at least in part the one or more selected ingestible products. Origination of an illustratively derived direct modify multiple component group can be accomplished through skilled in the art design choice selection of one or more of the above depicted components from one or more of the above depicted subsystems shown in FIG. 51. Components from the direct modify multiple component group can be used in implementing execution of the one or more direct modify multiple instructions j1221 of FIG. 52, can be used in performance of the direct modify multiple electrical circuitry arrangement f1221 of FIG. 45, and/or can be used in otherwise fulfillment of the operation p1221. An exemplary non-transitory signal bearing medium version of the information storage subsystem s200 is depicted in FIG. 52 as bearing the one or more direct modify multiple instructions j1221 that when executed will direct performance of the operation p1221. Furthermore, the direct modify multiple electrical circuitry arrangement (“elec circ arrange”) f1221, when activated, will perform the operation p1221. Also, the direct modify multiple module n1221, when executed and/or activated, will direct performance of and/or perform the operation p1221. For instance, in one or more exemplary implementations, the one or more direct modify multiple instructions j1221, when executed, direct performance of the operation p1221 in the illustrative depiction as follows, and/or the direct modify multiple electrical circuitry arrangement f1221, when activated, performs the operation p1221 in the illustrative depiction as follows, and/or the direct modify multiple module n1221, when executed and/or activated, directs performance of and/or performs the operation p1221 in the illustrative depiction as follows, and/or the operation p1221 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including changing, and/or etc.) one or more properties (e.g. including internal densities, and/or etc.) of the one or more portions of the one or more ingestible substrate structures through at least in part tubular duct arrangements for (e.g. modifying internal densities of the substrate structures through assembly of ingestible parts having internally positioned passageways, and/or etc.) the one or more portions of the one or more ingestible substrate structures (e.g. one or more rectangular structures, etc.) to form (e.g. including assemble fabricate, layer, make, and/or etc.) at least in part the one or more selected ingestible products.

In one or more implementations, as shown in FIG. 99, operation p12 includes an operation p1222 for electronically directing control of the one or more subsequent ingestible substrate structure directed energy operations to treat at least in part the one or more portions of the one or more ingestible substrate structures to influence at least in part one or more properties of the one or more portions of the one or more ingestible substrate structures through at least in part patterned energy arrangements for the one or more portions of the one or more ingestible substrate structures to form at least in part the one or more selected ingestible products. Origination of an illustratively derived direct modify patterned component group can be accomplished through skilled in the art design choice selection of one or more of the above depicted components from one or more of the above depicted subsystems shown in FIG. 51. Components from the direct modify patterned component group can be used in implementing execution of the one or more direct modify patterned instructions j1222 of FIG. 52, can be used in performance of the direct modify patterned electrical circuitry arrangement f1222 of FIG. 45, and/or can be used in otherwise fulfillment of the operation p1222. An exemplary non-transitory signal bearing medium version of the information storage subsystem s200 is depicted in FIG. 52 FIG. 52 as bearing the one or more direct modify patterned instructions j1222 that when executed will direct performance of the operation p1222. Furthermore, the direct modify patterned electrical circuitry arrangement (“elec circ arrange”) f1222, when activated, will perform the operation p1222. Also, the direct modify patterned module n1222, when executed and/or activated, will direct performance of and/or perform the operation p1222. For instance, in one or more exemplary implementations, the one or more direct modify patterned instructions j1222, when executed, direct performance of the operation p1222 in the illustrative depiction as follows, and/or the direct modify patterned electrical circuitry arrangement f1222, when activated, performs the operation p1222 in the illustrative depiction as follows, and/or the direct modify patterned module n1222, when executed and/or activated, directs performance of and/or performs the operation p1222 in the illustrative depiction as follows, and/or the operation p1222 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including removing, and/or etc.) one or more properties (e.g. including shape, and/or etc.) of the one or more portions of the one or more ingestible substrate structures through at least in part channel arrangements for (e.g. including stacking through dropping ingestible pieces into bins and pressing the pieces together, grabbing and stacking ingestible pieces with robotic hands, and/or etc.) the one or more portions of the one or more ingestible substrate structures (e.g. one or more sheet structures, etc.) to form (e.g. including assemble fabricate, layer, make, and/or etc.) at least in part the one or more selected ingestible products.

In one or more implementations, as shown in FIG. 99, operation p12 includes an operation p1223 for electronically directing control of the one or more subsequent ingestible substrate structure directed energy operations to treat at least in part the one or more portions of the one or more ingestible substrate structures to influence at least in part one or more properties of the one or more portions of the one or more ingestible substrate structures by at least partially focused energy beam arrangements for one or more portions of the one or more ingestible substrate structures to form at least in part the one or more selected ingestible products. Origination of an illustratively derived direct modify focused component group can be accomplished through skilled in the art design choice selection of one or more of the above depicted components from one or more of the above depicted subsystems shown in FIG. 51. Components from the direct modify focused component group can be used in implementing execution of the one or more direct modify focused instructions j1223 of FIG. 52, can be used in performance of the direct modify focused electrical circuitry arrangement f1223 of FIG. 45, and/or can be used in otherwise fulfillment of the operation p1223. An exemplary non-transitory signal bearing medium version of the information storage subsystem s200 is depicted in FIG. 52 FIG. 52 as bearing the one or more direct modify focused instructions j1223 that when executed will direct performance of the operation p1223. Furthermore, the direct modify focused electrical circuitry arrangement (“elec circ arrange”) f1223, when activated, will perform the operation p1223. Also, the direct modify focused module n1223, when executed and/or activated, will direct performance of and/or perform the operation p1223. For instance, in one or more exemplary implementations, the one or more direct modify focused instructions j1223, when executed, direct performance of the operation p1223 in the illustrative depiction as follows, and/or the direct modify focused electrical circuitry arrangement f1223, when activated, performs the operation p1223 in the illustrative depiction as follows, and/or the direct modify focused module n1223, when executed and/or activated, directs performance of and/or performs the operation p1223 in the illustrative depiction as follows, and/or the operation p1223 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including increasing, and/or etc.) one or more properties (e.g. including surface texture, and/or etc.) of the one or more portions of the one or more ingestible substrate structures by at least partially dissolvable duct arrangements for (e.g. including recombining through assembly one or more surface textures, and/or etc.) one or more portions of the one or more ingestible substrate structures (e.g. one or more bar structures, etc.) to form (e.g. including assemble fabricate, layer, make, and/or etc.) at least in part the one or more selected ingestible products.

In one or more implementations, as shown in FIG. 99, operation p12 includes an operation p1224 for electronically directing control of the one or more subsequent ingestible substrate structure directed energy operations to treat atleast in part the one or more portions of the one or more ingestible substrate structures to influence at least in part one or more properties of the one or more portions of the one or more ingestible substrate structures by at least partially replacing thereof to treat at least in part the one or more portions of the one or more ingestible substrate structures to form at least in part the one or more selected ingestible products. Origination of an illustratively derived direct modify replace component group can be accomplished through skilled in the art design choice selection of one or more of the above depicted components from one or more of the above depicted subsystems shown in FIG. 51. Components from the direct modify replace component group can be used in implementing execution of the one or more direct modify replace instructions j1224 of FIG. 52, can be used in performance of the direct modify replace electrical circuitry arrangement f1224 of FIG. 45, and/or can be used in otherwise fulfillment of the operation p1224. An exemplary non-transitory signal bearing medium version of the information storage subsystem s200 is depicted in FIG. 52 FIG. 52 as bearing the one or more direct modify replace instructions j1224 that when executed will direct performance of the operation p1224. Furthermore, the direct modify replace electrical circuitry arrangement (“elec circ arrange”) f1224, when activated, will perform the operation p1224. Also, the direct modify replace module n1224, when executed and/or activated, will direct performance of and/or perform the operation p1224. For instance, in one or more exemplary implementations, the one or more direct modify replace instructions j1224, when executed, direct performance of the operation p1224 in the illustrative depiction as follows, and/or the direct modify replace electrical circuitry arrangement f1224, when activated, performs the operation p1224 in the illustrative depiction as follows, and/or the direct modify replace module n1224, when executed and/or activated, directs performance of and/or performs the operation p1224 in the illustrative depiction as follows, and/or the operation p1224 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including decreasing, and/or etc.) one or more properties (e.g. including structural texture, and/or etc.) of the one or more portions of the one or more ingestible substrate structures by at least partially replacing thereof to treat at least in part (e.g. including replacing through assembly of ingestible parts having selected ingestible materials in portions of the substrate, and/or etc.) the one or more portions of the one or more ingestible substrate structures (e.g. one or more rectangular structures, etc.) to form (e.g. including assemble fabricate, layer, make, and/or etc.) at least in part the one or more selected ingestible products.

In one or more implementations, as shown in FIG. 100, operation p12 includes an operation p1225 for electronically directing control of the one or more subsequent ingestible substrate structure directed energy operations to treat at least in part the one or more portions of the one or more ingestible substrate structures to influence at least in part one or more properties of the one or more portions of the one or more ingestible substrate structures by at least partially integrating two or more portions of the one or more ingestible substrate structures to form at least in part the one or more selected ingestible products. Origination of an illustratively derived direct modify integrate component group can be accomplished through skilled in the art design choice selection of one or more of the above depicted components from one or more of the above depicted subsystems shown in FIG. 51. Components from the direct modify integrate component group can be used in implementing execution of the one or more direct modify integrate instructions j1225 of FIG. 52, can be used in performance of the direct modify integrate electrical circuitry arrangement f1225 of FIG. 45, and/or can be used in otherwise fulfillment of the operation p1225. An exemplary non-transitory signal bearing medium version of the information storage subsystem s200 is depicted in FIG. 52 FIG. 52 as bearing the one or more direct modify integrate instructions j1225 that when executed will direct performance of the operation p1225. Furthermore, the direct modify integrate electrical circuitry arrangement (“elec circ arrange”) f1225, when activated, will perform the operation p1225. Also, the direct modify integrate module n1225, when executed and/or activated, will direct performance of and/or perform the operation p1225. For instance, in one or more exemplary implementations, the one or more direct modify integrate instructions j1225, when executed, direct performance of the operation p1225 in the illustrative depiction as follows, and/or the direct modify integrate electrical circuitry arrangement f1225, when activated, performs the operation p1225 in the illustrative depiction as follows, and/or the direct modify integrate module n1225, when executed and/or activated, directs performance of and/or performs the operation p1225 in the illustrative depiction as follows, and/or the operation p1225 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including changing, and/or etc.) one or more properties (e.g. including substrate color, and/or etc.) of the one or more portions of the one or more ingestible substrate structures by at least partially integrating (e.g. including combining through assembly of ingestible parts one or more added ingredients to the substrate structure to change color, and/or etc.) two or more portions of the one or more ingestible substrate structures (e.g. one or more bars, etc.) to form (e.g. including assemble fabricate, layer, make, and/or etc.) at least in part the one or more selected ingestible products.

In one or more implementations, as shown in FIG. 100, operation p12 includes an operation p1226 for electronically directing control of the one or more subsequent ingestible substrate structure directed energy operations to treat at least in part the one or more portions of the one or more ingestible substrate structures to influence at least in part one or more properties of the one or more portions of the one or more ingestible substrate structures by at least partially softening the one or more portions of the one or more ingestible substrate structures to form at least in part the one or more selected ingestible products. Origination of an illustratively derived direct modify soften component group can be accomplished through skilled in the art design choice selection of one or more of the above depicted components from one or more of the above depicted subsystems shown in FIG. 51. Components from the direct modify soften component group can be used in implementing execution of the one or more direct modify soften instructions j1226 of FIG. 52, can be used in performance of the direct modify soften electrical circuitry arrangement f1226 of FIG. 45, and/or can be used in otherwise fulfillment of the operation p1226. An exemplary non-transitory signal bearing medium version of the information storage subsystem s200 is depicted in FIG. 52 FIG. 52 as bearing the one or more direct modify soften instructions j1226 that when executed will direct performance of the operation p1226. Furthermore, the direct modify soften electrical circuitry arrangement (“elec circ arrange”) f1226, when activated, will perform the operation p1226. Also, the direct modify soften module n1226, when executed and/or activated, will direct performance of and/or perform the operation p1226. For instance, in one or more exemplary implementations, the one or more direct modify soften instructions j1226, when executed, direct performance of the operation p1226 in the illustrative depiction as follows, and/or the direct modify soften electrical circuitry arrangement f1226, when activated, performs the operation p1226 in the illustrative depiction as follows, and/or the direct modify soften module n1226, when executed and/or activated, directs performance of and/or performs the operation p1226 in the illustrative depiction as follows, and/or the operation p1226 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including changing, and/or etc.) one or more properties (e.g. including structural texture, and/or etc.) of the one or more portions of the one or more ingestible substrate structures by at least partially softening (e.g. including softening through assembly of ingestible parts to form at least in part the substrate structure, and/or etc.) the one or more portions of the one or more ingestible substrate structures (e.g. one or more rectangular structures, etc.) to form (e.g. including assemble fabricate, layer, make, and/or etc.) at least in part the one or more selected ingestible products.

In one or more implementations, as shown in FIG. 100, operation p12 includes an operation p1227 for electronically directing control of the one or more subsequent ingestible substrate structure directed energy operations to treat at least in part the one or more portions of the one or more ingestible substrate structures to influence at least in part one or more properties of the one or more portions of the one or more ingestible substrate structures by at least partially compressing the one or more portions of the one or more ingestible substrate structures to form at least in part the one or more selected ingestible products. Origination of an illustratively derived direct modify compress component group can be accomplished through skilled in the art design choice selection of one or more of the above depicted components from one or more of the above depicted subsystems shown in FIG. 51. Components from the direct modify compress component group can be used in implementing execution of the one or more direct modify compress instructions j1227 of FIG. 52, can be used in performance of the direct modify compress electrical circuitry arrangement f1227 of FIG. 45, and/or can be used in otherwise fulfillment of the operation p1227. An exemplary non-transitory signal bearing medium version of the information storage subsystem s200 is depicted in FIG. 52 FIG. 52 as bearing the one or more direct modify compress instructions j1227 that when executed will direct performance of the operation p1227. Furthermore, the direct modify compress electrical circuitry arrangement (“elec circ arrange”) f1227, when activated, will perform the operation p1227. Also, the direct modify compress module n1227, when executed and/or activated, will direct performance of and/or perform the operation p1227. For instance, in one or more exemplary implementations, the one or more direct modify compress instructions j1227, when executed, direct performance of the operation p1227 in the illustrative depiction as follows, and/or the direct modify compress electrical circuitry arrangement f1227, when activated, performs the operation p1227 in the illustrative depiction as follows, and/or the direct modify compress module n1227, when executed and/or activated, directs performance of and/or performs the operation p1227 in the illustrative depiction as follows, and/or the operation p1227 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including decreasing, and/or etc.) one or more properties (e.g. including structural texture including rigidity, and/or etc.) of the one or more portions of the one or more ingestible substrate structures by at least partially compressing (e.g. including increasing rigidity through assembly of ingestible parts, and/or etc.) the one or more portions of the one or more ingestible substrate structures (e.g. one or more sheets, etc.) to form (e.g. including assemble fabricate, layer, make, and/or etc.) at least in part the one or more selected ingestible products.

In one or more implementations, as shown in FIG. 101, operation p12 includes an operation p1228 for electronically directing control of the one or more subsequent ingestible substrate structure directed energy operations to treat at least in part the one or more portions of the one or more ingestible substrate structures to influence at least in part one or more properties of the one or more portions of the one or more ingestible substrate structures by at least partially hardening for the one or more portions of the one or more ingestible substrate structures to form at least in part the one or more selected ingestible products. Origination of an illustratively derived direct modify harden component group can be accomplished through skilled in the art design choice selection of one or more of the above depicted components from one or more of the above depicted subsystems shown in FIG. 51. Components from the direct modify harden component group can be used in implementing execution of the one or more direct modify harden instructions j1228 of FIG. 52, can be used in performance of the direct modify harden electrical circuitry arrangement f1228 of FIG. 45, and/or can be used in otherwise fulfillment of the operation p1228. An exemplary non-transitory signal bearing medium version of the information storage subsystem s200 is depicted in FIG. 52 as bearing the one or more direct modify harden instructions j1228 that when executed will direct performance of the operation p1228. Furthermore, the direct modify harden electrical circuitry arrangement (“elec circ arrange”) f1228, when activated, will perform the operation p1228. Also, the direct modify harden module n1228, when executed and/or activated, will direct performance of and/or perform the operation p1228. For instance, in one or more exemplary implementations, the one or more direct modify harden instructions j1228, when executed, direct performance of the operation p1228 in the illustrative depiction as follows, and/or the direct modify harden electrical circuitry arrangement f1228, when activated, performs the operation p1228 in the illustrative depiction as follows, and/or the direct modify harden module n1228, when executed and/or activated, directs performance of and/or performs the operation p1228 in the illustrative depiction as follows, and/or the operation p1228 is otherwise carried out in the illustrative depiction as follows: electronically directing control of the one or more subsequent ingestible substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including changing, and/or etc.) one or more properties (e.g. including structural texture, and/or etc.) of the one or more portions of the one or more ingestible substrate structures by at least partially hardening (e.g. including hardening through assembly of ingestible parts, and/or etc.) for the one or more portions of the one or more ingestible substrate structures (e.g. one or more pasta structures, etc.) to form (e.g. including assemble fabricate, layer, make, and/or etc.) at least in part the one or more selected ingestible products.

In one or more implementations, as shown in FIG. 101, operation p12 includes an operation p1229 for electronically directing control of the one or more subsequent substrate structure directed energy operations to treat at least in part the one or more portions of the one or more ingestible substrate structures to influence at least in part one or more properties of the one or more portions of the one or more ingestible substrate structures by at least partially forming patterns for the one or more portions of the one or more ingestible substrate structures to form at least in part the one or more selected ingestible products. Origination of an illustratively derived direct modify patterning component group can be accomplished through skilled in the art design choice selection of one or more of the above depicted components from one or more of the above depicted subsystems shown in FIG. 51. Components from the direct modify patterning component group can be used in implementing execution of the one or more direct modify patterning instructions j1229 of FIG. 52, can be used in performance of the direct modify patterning electrical circuitry arrangement f1229 of FIG. 45, and/or can be used in otherwise fulfillment of the operation p1229. An exemplary non-transitory signal bearing medium version of the information storage subsystem s200 is depicted in FIG. 52 as bearing the one or more direct modify patterning instructions j1229 that when executed will direct performance of the operation p1229. Furthermore, the direct modify patterning electrical circuitry arrangement (“elec circ arrange”) f1229, when activated, will perform the operation p1229. Also, the direct modify patterning module n1229, when executed and/or activated, will direct performance of and/or perform the operation p1229. For instance, in one or more exemplary implementations, the one or more direct modify patterning instructions j1229, when executed, direct performance of the operation p1229 in the illustrative depiction as follows, and/or the direct modify patterning electrical circuitry arrangement f1229, when activated, performs the operation p1229 in the illustrative depiction as follows, and/or the direct modify patterning module n1229, when executed and/or activated, directs performance of and/or performs the operation p1229 in the illustrative depiction as follows, and/or the operation p1229 is otherwise carried out in the illustrative depiction as follows: electronically directing control of the one or more subsequent substrate structure duct operations (e.g. including flowing liquids, gases, fluidized powders, microfluidics, and/or etc. through tubes, channels, conduits, raceways, piping, and/or etc. located internally within one or more portions of one or more substrate structures, located externally to one or more portions of one or more substrate structures, and/or etc. located internally within packaging such as packaging containing one or more portions of one or more substrate structures, and/or etc.) to treat (including processing, changing, modifying, supplementing, refining, amplifying, enhancing, acting upon, exposing, reacting with, integrating with, and/or etc.) at least in part the one or more portions of the one or more ingestible substrate structures to influence at least in part (e.g. including increasing, and/or etc.) one or more properties (e.g. including structural texture, and/or etc.) of the one or more portions of the one or more ingestible substrate structures by at least partially forming patterns (e.g. including adding and/or changing surface and/or internal patterns through assembly of ingestible parts, and/or etc.) for the one or more portions of the one or more ingestible substrate structures (e.g. one or more pasta structures, etc.) to form (e.g. including assemble fabricate, layer, make, and/or etc.) at least in part the one or more selected ingestible products.

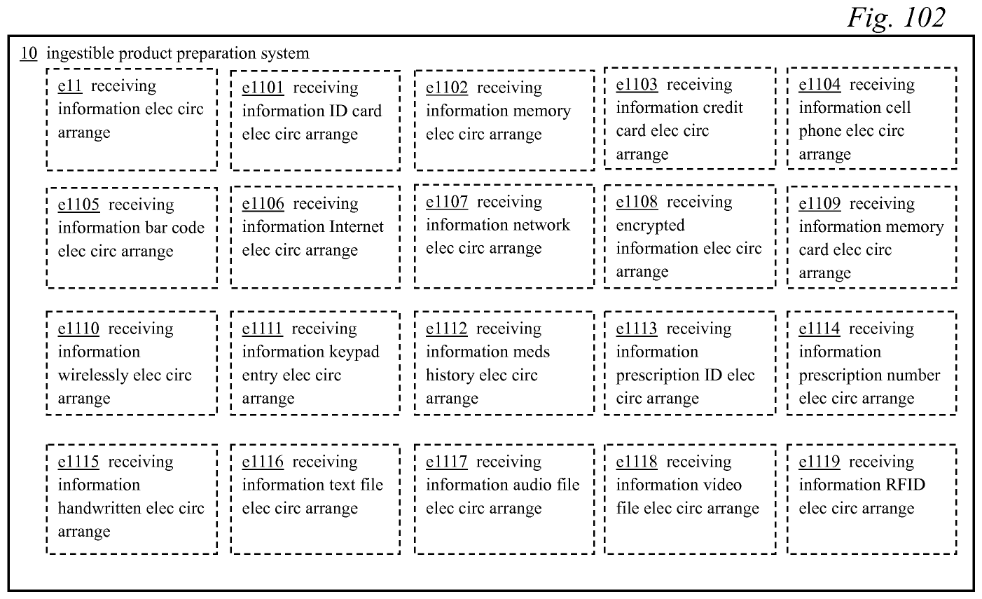

Implementations involve different combinations (otherwise known as “electrical circuitry arrangements”) of components from the subsystems of the ingestible product preparation system 10. Exemplary depictions of some of these electrical circuitry arrangements are shown in FIG. 102 to include receiving information electrical circuitry arrangement e11, receiving information ID card electrical circuitry arrangement e1101, receiving information memory electrical circuitry arrangement e1102, receiving information credit card electrical circuitry arrangement e1103, receiving information cell phone electrical circuitry arrangement e1104, receiving information bar code electrical circuitry arrangement e1105, receiving information Internet electrical circuitry arrangement e1106, receiving information network electrical circuitry arrangement e1107, receiving encrypted information electrical circuitry arrangement e1108, receiving information memory card electrical circuitry arrangement e1109, receiving information wirelessly electrical circuitry arrangement e1110, receiving information keypad entry electrical circuitry arrangement e1111, receiving information meds history electrical circuitry arrangement e1112, receiving information prescription ID electrical circuitry arrangement e1113, receiving information prescription number electrical circuitry arrangement e1114, receiving information handwritten electrical circuitry arrangement e1115, receiving information text file electrical circuitry arrangement e1116, receiving information audio file electrical circuitry arrangement e1117, receiving information video file electrical circuitry arrangement e1118, and receiving information RFID electrical circuitry arrangement e1119.

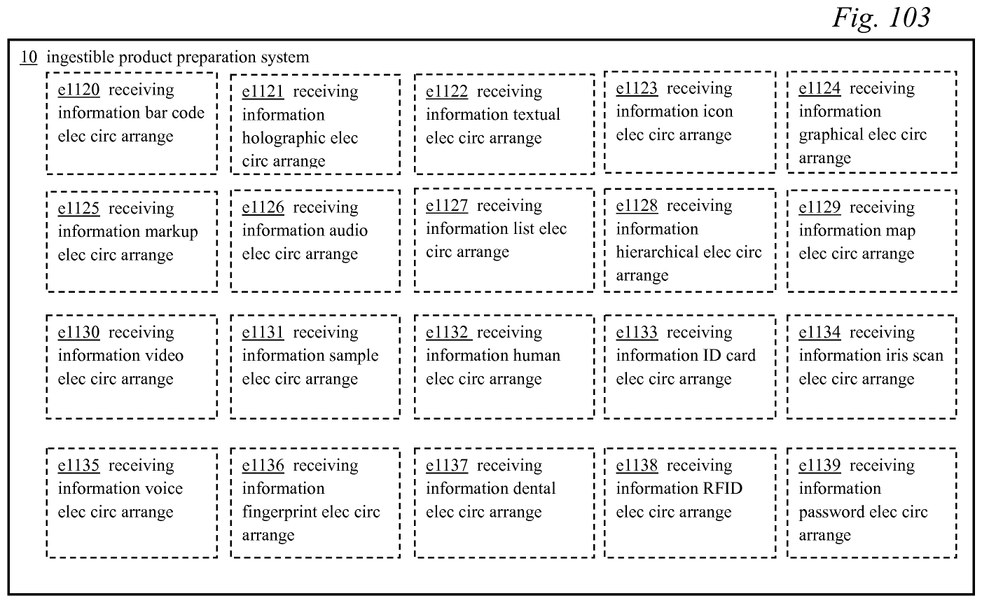

Some of these electrical circuitry arrangements are depicted in FIG. 103 to include receiving information bar code electrical circuitry arrangement e1120, receiving information holographic electrical circuitry arrangement e1121, receiving information textual electrical circuitry arrangement e1122, receiving information icon electrical circuitry arrangement e1123, receiving information graphical electrical circuitry arrangement e1124, receiving information markup electrical circuitry arrangement e1125, receiving information audio electrical circuitry arrangement e1126, receiving information list electrical circuitry arrangement e1127, receiving information hierarchical electrical circuitry arrangement e1128, receiving information map electrical circuitry arrangement e1129, receiving information video electrical circuitry arrangement e1130, receiving information sample electrical circuitry arrangement e113, receiving information human electrical circuitry arrangement e1132, receiving information ID card electrical circuitry arrangement e1133, receiving information iris scan electrical circuitry arrangement e1134, receiving information voice electrical circuitry arrangement e1135, receiving information fingerprint electrical circuitry arrangement e1136, receiving information dental electrical circuitry arrangement e1137, receiving information RFID electrical circuitry arrangement e1138, and receiving information password electrical circuitry arrangement e1139.

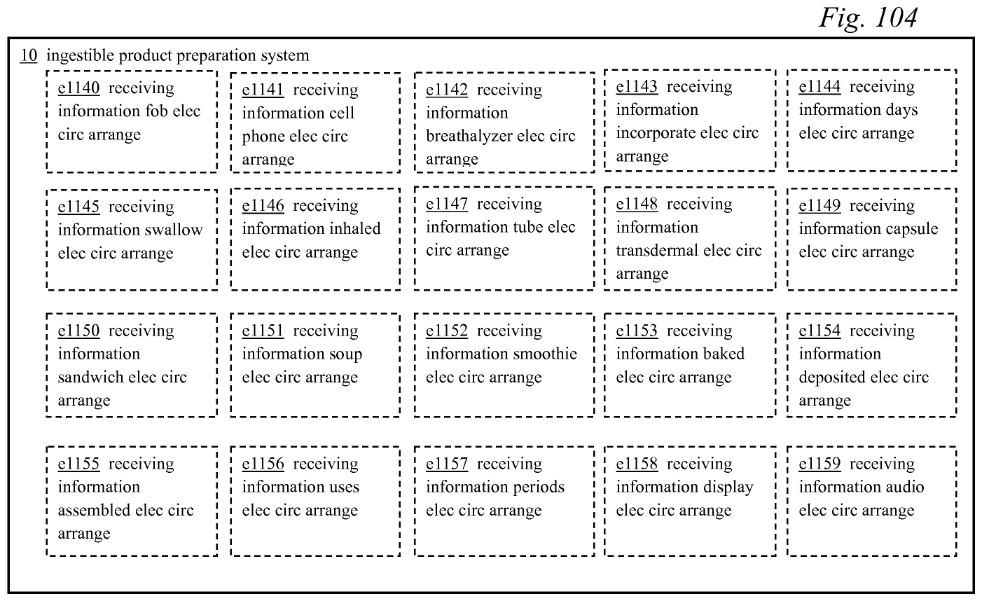

Some of these electrical circuitry arrangements are depicted in FIG. 104 to include receiving information fob electrical circuitry arrangement e1140, receiving information cell phone electrical circuitry arrangement e1141, receiving information breathalyzer electrical circuitry arrangement e1142, receiving information incorporate electrical circuitry arrangement e1143, receiving information days electrical circuitry arrangement e1144, receiving information swallow electrical circuitry arrangement e1145, receiving information inhaled electrical circuitry arrangement e1146, receiving information tube electrical circuitry arrangement e1147, receiving information transdermal electrical circuitry arrangement e1148, receiving information capsule electrical circuitry arrangement e1149, receiving information sandwich electrical circuitry arrangement e1150, receiving information soup electrical circuitry arrangement e1151, receiving information smoothie electrical circuitry arrangement e1152, receiving information baked electrical circuitry arrangement e1153, receiving information deposited electrical circuitry arrangement e1154, receiving information assembled electrical circuitry arrangement e1155, receiving information uses electrical circuitry arrangement e1156, receiving information periods electrical circuitry arrangement e1157, receiving information display electrical circuitry arrangement e1158, and receiving information audio electrical circuitry arrangement e1159.

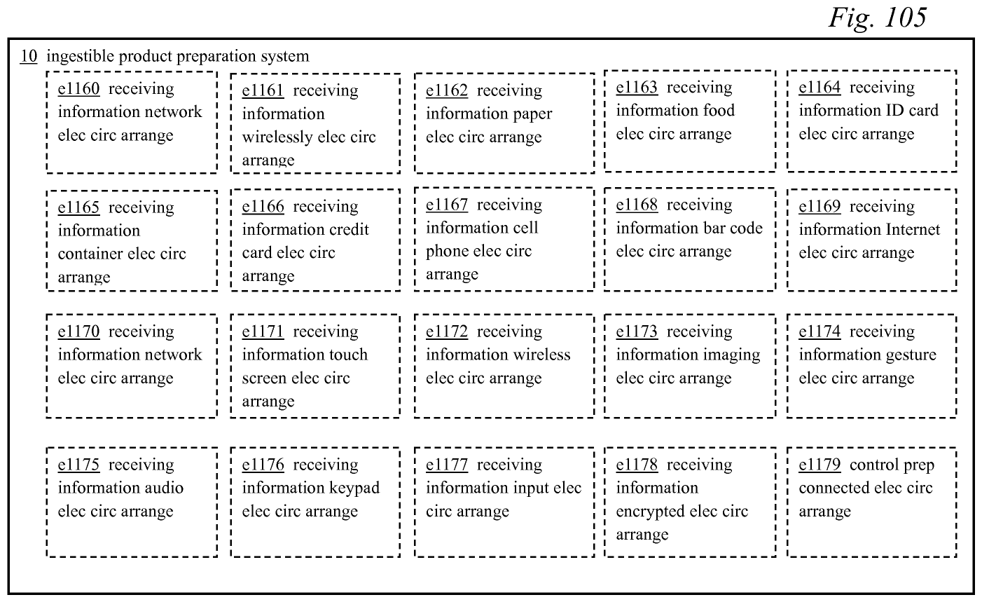

Some of these electrical circuitry arrangements are depicted in FIG. 105 to include receiving information network electrical circuitry arrangement e1160, receiving information wirelessly electrical circuitry arrangement e1161, receiving information paper electrical circuitry arrangement e1162, receiving information food electrical circuitry arrangement e1163, receiving information ID card electrical circuitry arrangement e1164, receiving information container electrical circuitry arrangement e1165, and receiving information credit card electrical circuitry arrangement e1166, receiving information cell phone electrical circuitry arrangement e1167, receiving information bar code electrical circuitry arrangement e1168, receiving information Internet electrical circuitry arrangement e1169, receiving information network electrical circuitry arrangement e1170, receiving information touch screen electrical circuitry arrangement e1171, receiving information wireless electrical circuitry arrangement e1172, receiving information imaging electrical circuitry arrangement e1173, receiving information gesture electrical circuitry arrangement e1174, receiving information audio electrical circuitry arrangement e1175, receiving information keypad electrical circuitry arrangement e1176, receiving information input electrical circuitry arrangement e1177, receiving information encrypted electrical circuitry arrangement e1178, and control prep connected electrical circuitry arrangement e1179.

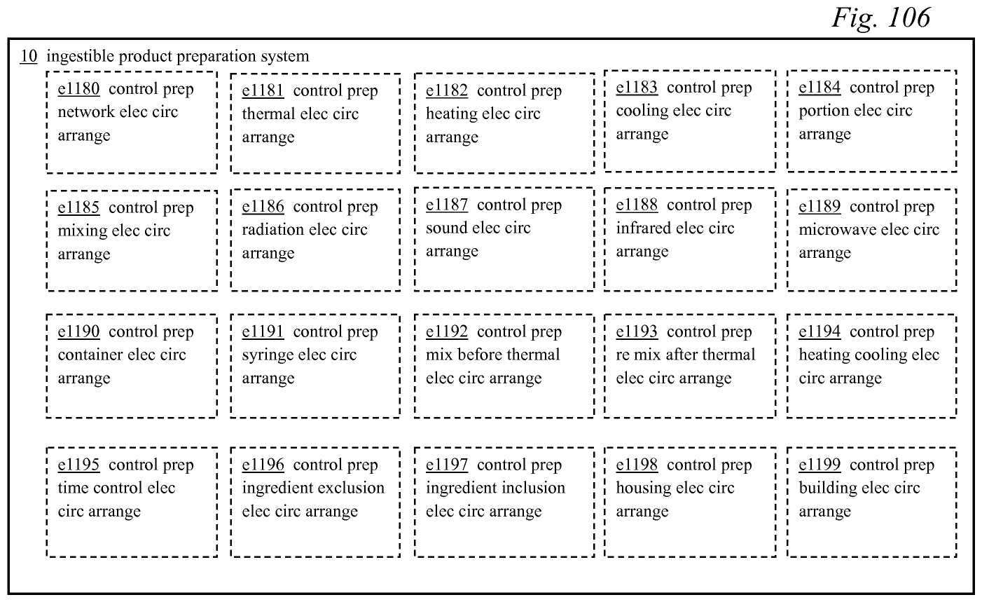

Some of these electrical circuitry arrangements are depicted in FIG. 106 to include control prep network electrical circuitry arrangement e1180, control prep thermal electrical circuitry arrangement e1181, control prep heating electrical circuitry arrangement e1182, control prep cooling electrical circuitry arrangement e1183, control prep portion electrical circuitry arrangement e1184, control prep mixing electrical circuitry arrangement e1185, and control prep radiation electrical circuitry arrangement e1186, control prep sound electrical circuitry arrangement e1187, control prep infrared electrical circuitry arrangement e1188, control prep microwave electrical circuitry arrangement e1189, control prep container electrical circuitry arrangement e1190, control prep syringe electrical circuitry arrangement e1191, control prep mix before thermal electrical circuitry arrangement e1192, control prep re mix after thermal electrical circuitry arrangement e1193, control prep heating cooling electrical circuitry arrangement e1194, control prep time control electrical circuitry arrangement e1195, control prep ingredient exclusion electrical circuitry arrangement e1196, control prep ingredient inclusion electrical circuitry arrangement e1197, control prep housing electrical circuitry arrangement e1198, and control prep building electrical circuitry arrangement e1199.

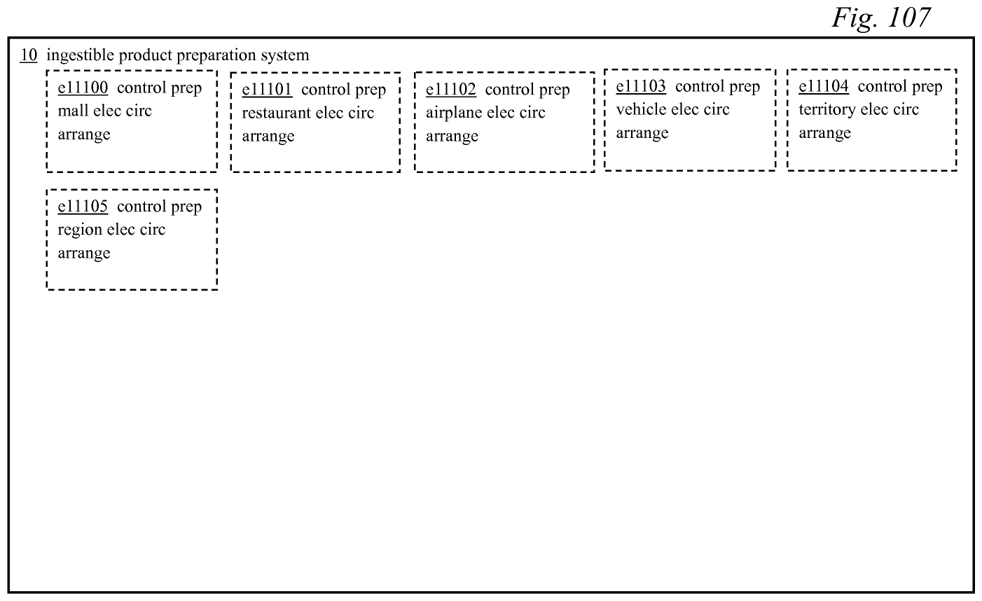

Some of these electrical circuitry arrangements are depicted in FIG. 107 to include control prep mall electrical circuitry arrangement e11100, control prep restaurant electrical circuitry arrangement e11101, control prep airplane electrical circuitry arrangement e11102, control prep vehicle electrical circuitry arrangement e11103, control prep territory electrical circuitry arrangement e11104, and control prep region electrical circuitry arrangement e11105.

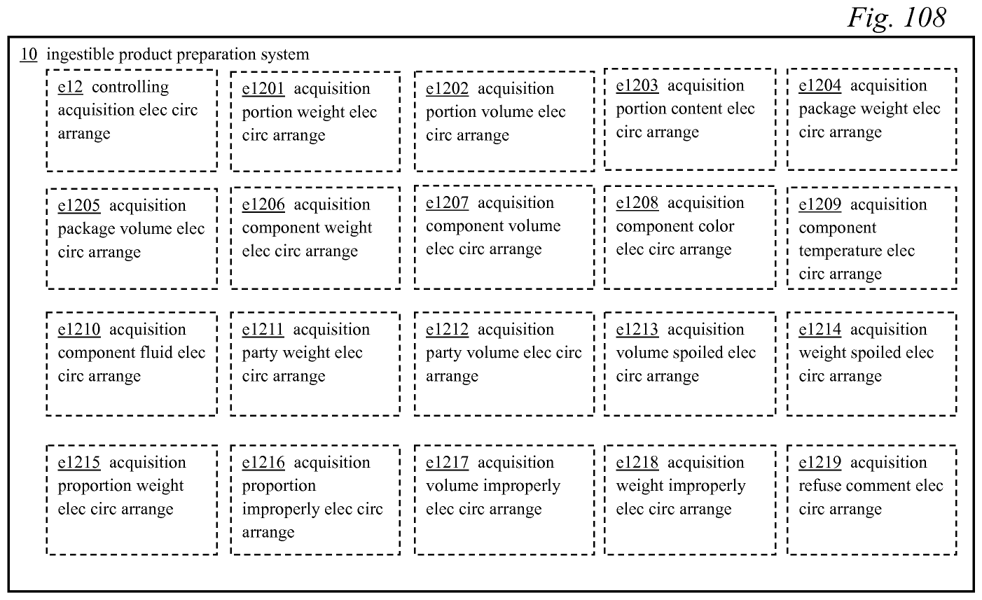

Some of these electrical circuitry arrangements are depicted in FIG. 108 to include controlling acquisition electrical circuitry arrangement e12, acquisition portion weight electrical circuitry arrangement e1201, acquisition portion volume electrical circuitry arrangement e1202, acquisition portion content electrical circuitry arrangement e1203, acquisition package weight electrical circuitry arrangement e1204, acquisition package volume electrical circuitry arrangement e1205, acquisition component weight electrical circuitry arrangement e1206, acquisition component volume electrical circuitry arrangement e1207, acquisition component color electrical circuitry arrangement e1208, acquisition component temperature electrical circuitry arrangement e1209, acquisition component fluid electrical circuitry arrangement e1210, acquisition party weight electrical circuitry arrangement e1211, and acquisition party volume electrical circuitry arrangement e1212, acquisition volume spoiled electrical circuitry arrangement e1213, acquisition weight spoiled electrical circuitry arrangement e1214, acquisition proportion weight electrical circuitry arrangement e1215, acquisition proportion improperly electrical circuitry arrangement e1216, acquisition volume improperly electrical circuitry arrangement e1217, acquisition weight improperly electrical circuitry arrangement e1218, and acquisition refuse comment electrical circuitry arrangement e1219.

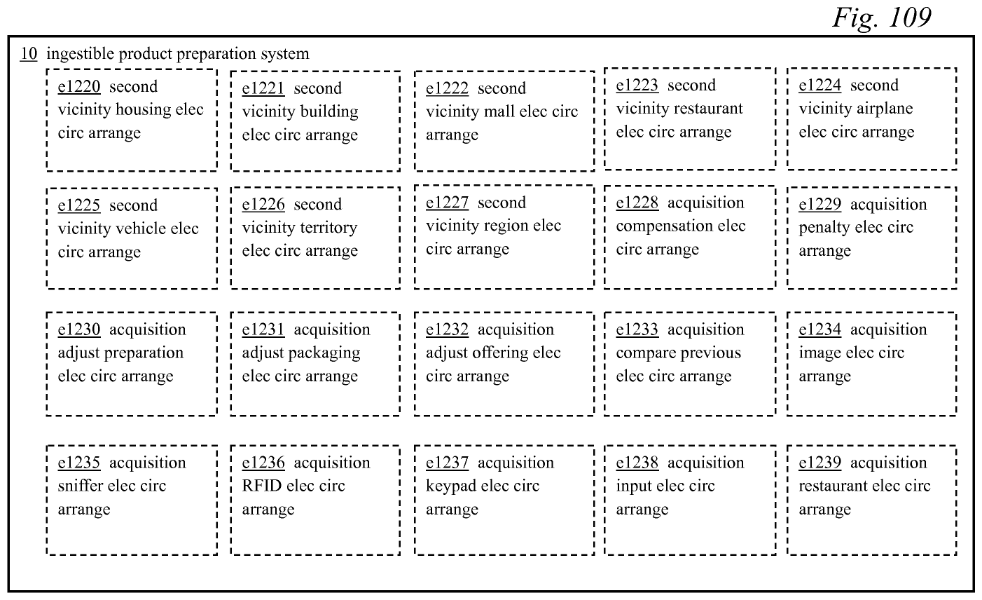

Some of these electrical circuitry arrangements are depicted in FIG. 109 to include second vicinity housing electrical circuitry arrangement e12, second vicinity building electrical circuitry arrangement e1221, second vicinity mall electrical circuitry arrangement e1222, second vicinity restaurant electrical circuitry arrangement e1223, second vicinity airplane electrical circuitry arrangement e1224, second vicinity vehicle electrical circuitry arrangement e1225, second vicinity territory electrical circuitry arrangement e1226, second vicinity region electrical circuitry arrangement e1227, acquisition compensation electrical circuitry arrangement e1228, acquisition penalty electrical circuitry arrangement e1229, acquisition adjust preparation electrical circuitry arrangement e1230, acquisition adjust packaging electrical circuitry arrangement e1231, and acquisition adjust offering electrical circuitry arrangement e1232, acquisition compare previous electrical circuitry arrangement e1233, acquisition image electrical circuitry arrangement e1234, acquisition sniffer electrical circuitry arrangement e1235, acquisition RFID electrical circuitry arrangement e1236, acquisition keypad electrical circuitry arrangement e1237, acquisition input electrical circuitry arrangement e1238, and acquisition restaurant electrical circuitry arrangement e1239.

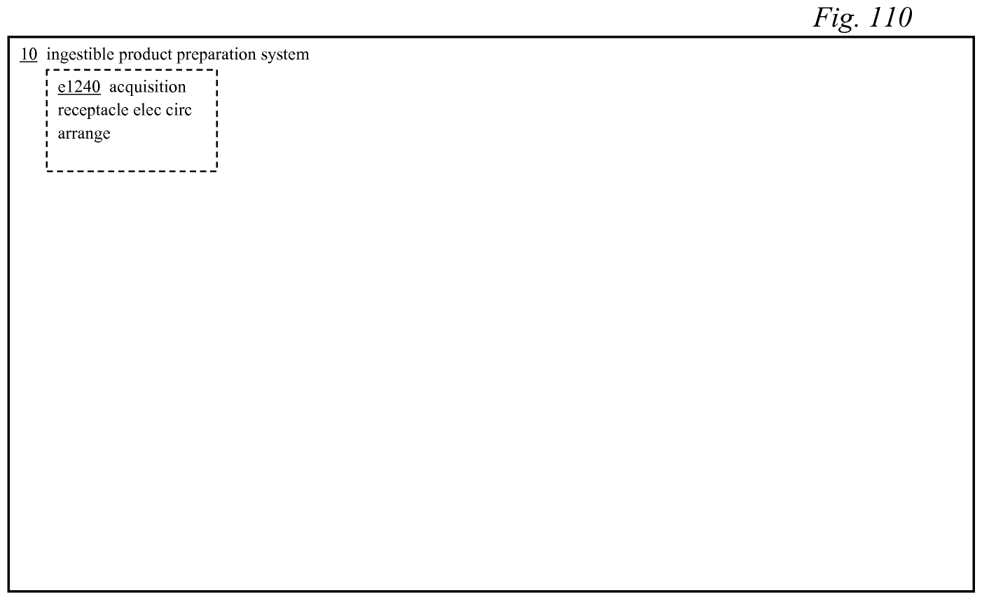

Some of these electrical circuitry arrangements are depicted in FIG. 110 to include acquisition receptacle electrical circuitry arrangement e1240.

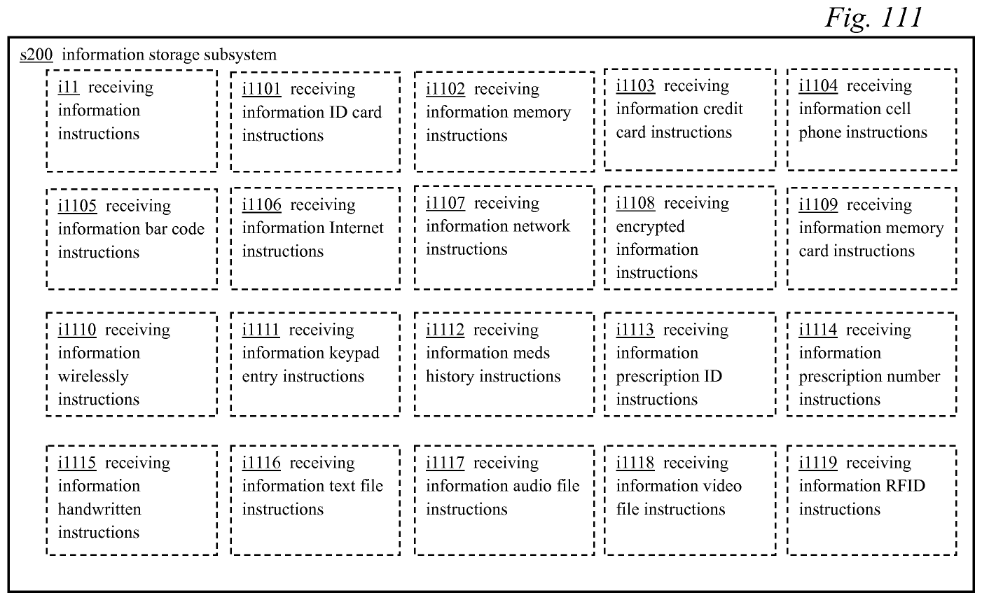

In implementations one or more instructions are stored and/or otherwise borne in various subsystems, components, and/or accessories of the ingestible product preparation system 10 such as being borne in a non-transitory signal bearing medium of information storage subsystem s200. One or more exemplary instructions depicted in FIG. 111 as being borne in an exemplary version of a non-transitory signal bearing medium of information storage subsystem s200 include one or more receiving information instructions i11, one or more receiving information ID card instructions i1101, one or more receiving information memory instructions i1102, one or more receiving information credit card instructions i1103, one or more receiving information cell phone instructions i1104, one or more receiving information bar code instructions i1105, one or more receiving information Internet instructions i1106, one or more receiving information network instructions i1107, one or more receiving encrypted information instructions i1108, one or more receiving information memory card instructions i1109, one or more receiving information wirelessly instructions i1110, one or more receiving information keypad entry instructions i1111, one or more receiving information meds history instructions i1112, one or more receiving information prescription ID instructions i1113, one or more receiving information prescription number instructions i1114, one or more receiving information handwritten instructions i1115, one or more receiving information text file instructions i1116, one or more receiving information audio file instructions i1117, one or more receiving information video file instructions i1118, and one or more receiving information RFID instructions i1119.

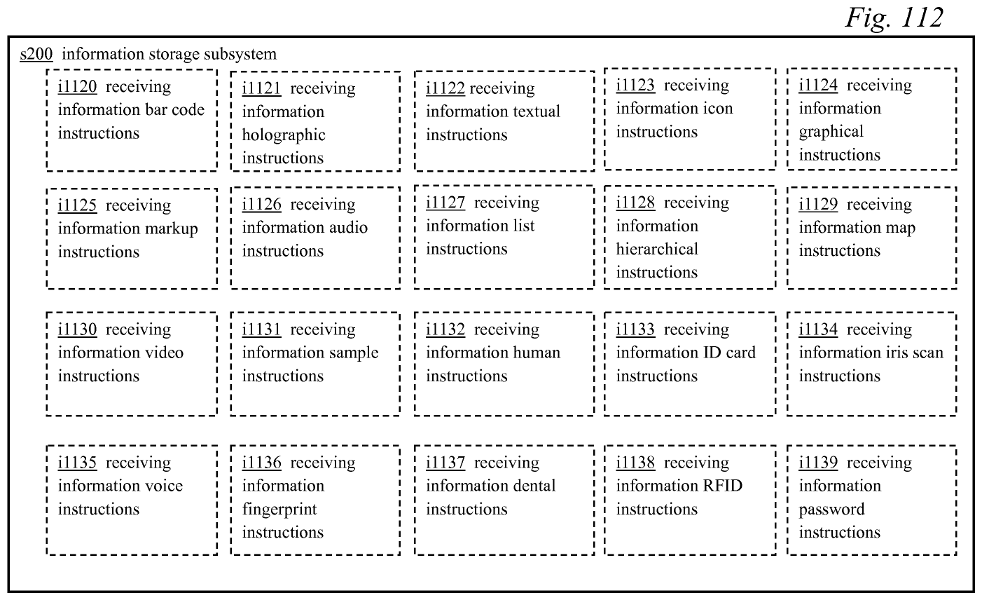

One or more exemplary instructions depicted in FIG. 112 as being borne in an exemplary version of a non-transitory signal bearing medium of information storage subsystem s200 include one or more receiving information bar code instructions i1120, one or more receiving information holographic instructions i1121, one or more receiving information textual instructions i1122, one or more receiving information icon instructions i1123, one or more receiving information graphical instructions i1124, one or more receiving information markup instructions i1125, one or more receiving information audio instructions i1126, one or more receiving information list instructions i1127, one or more receiving information hierarchical instructions i1128, one or more receiving information map instructions i1129, one or more receiving information video instructions i1130, one or more receiving information sample instructions i1131, one or more receiving information human instructions i1132, one or more receiving information ID card instructions i1133, one or more receiving information iris scan instructions i1134, one or more receiving information voice instructions i1135, one or more receiving information fingerprint instructions i1136, one or more receiving information dental instructions i1137, one or more receiving information RFID instructions i1138, and one or more receiving information password instructions i1139.

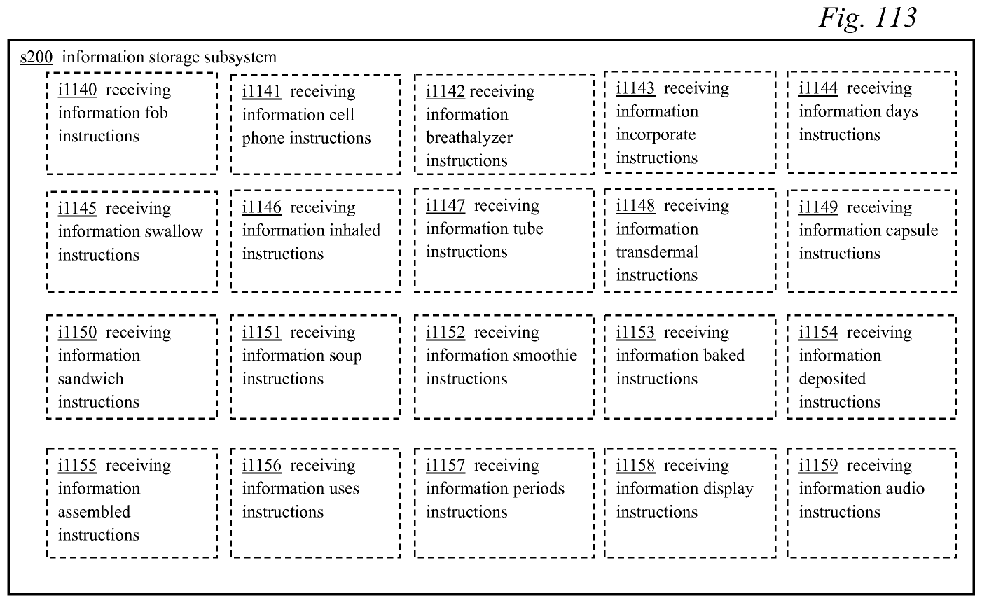

One or more exemplary instructions depicted in FIG. 113 as being borne in an exemplary version of a non-transitory signal bearing medium of information storage subsystem s200 include one or more receiving information fob instructions i1140, one or more receiving information cell phone instructions i1141, one or more receiving information breathalyzer instructions i1142, one or more receiving information incorporate instructions i1143, one or more receiving information days instructions i1144, one or more receiving information swallow instructions i1145, one or more receiving information inhaled instructions i1146, one or more receiving information tube instructions i1147, one or more receiving information transdermal instructions i1148, one or more receiving information capsule instructions i1149, one or more receiving information sandwich instructions i1150, one or more receiving information soup instructions i1151, one or more receiving information smoothie instructions i1152, one or more receiving information baked instructions i1153, one or more receiving information deposited instructions i1154, one or more receiving information assembled instructions i1155, one or more receiving information uses instructions i1156, one or more receiving information periods instructions i1157, one or more receiving information display instructions i1158, and one or more receiving information audio instructions i1159.

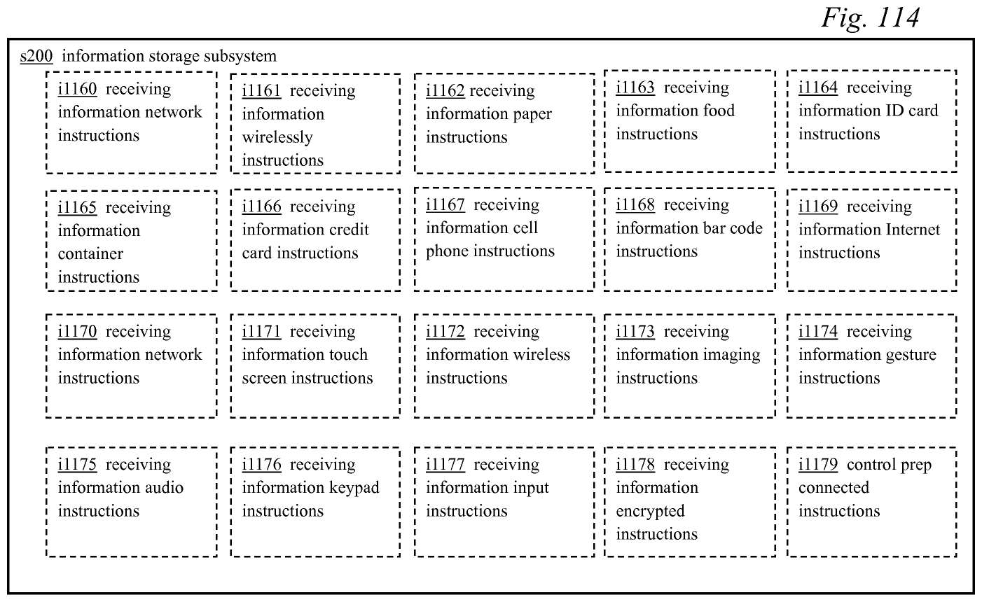

One or more exemplary instructions depicted in FIG. 114 as being borne in an exemplary version of a non-transitory signal bearing medium of information storage subsystem s200 include one or more receiving information network instructions i1160, one or more receiving information wirelessly instructions i1161, one or more receiving information paper instructions i1162, one or more receiving information food instructions i1163, one or more receiving information ID card instructions i1164, one or more receiving information container instructions i1165, and one or more receiving information credit card instructions i1166, one or more receiving information cell phone instructions i1167, one or more receiving information bar code instructions i1168, one or more receiving information Internet instructions i1169, one or more receiving information network instructions i1170, one or more receiving information touch screen instructions i1171, one or more receiving information wireless instructions i1172, one or more receiving information imaging instructions i1173, one or more receiving information gesture instructions i1174, one or more receiving information audio instructions i1175, one or more receiving information keypad instructions i1176, one or more receiving information input instructions i1177, one or more receiving information encrypted instructions i1178, and one or more control prep connected instructions i1179.

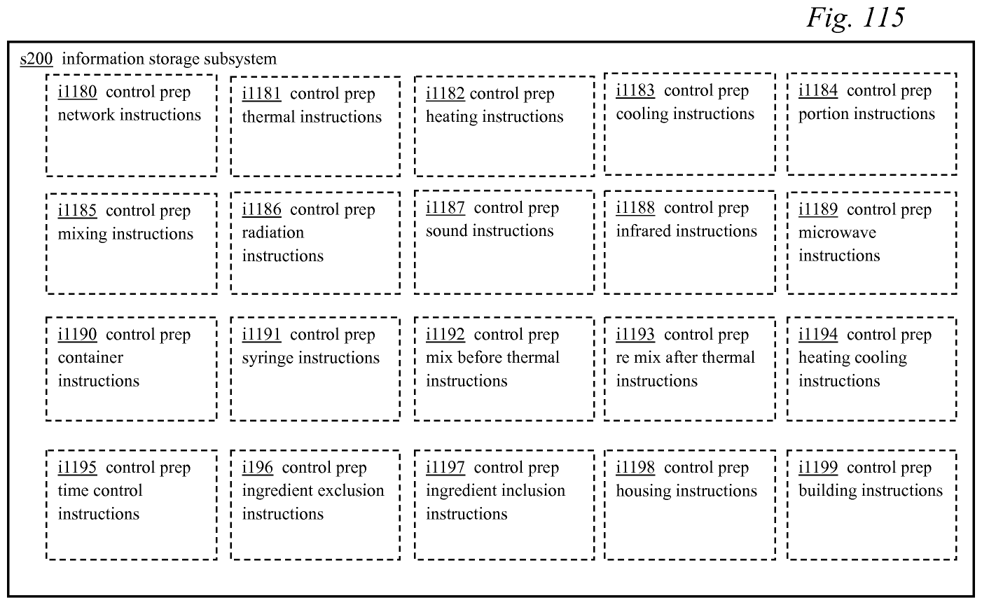

One or more exemplary instructions depicted in FIG. 115 as being borne in an exemplary version of a non-transitory signal bearing medium of information storage subsystem s200 include one or more control prep network instructions i1180, one or more control prep thermal instructions i1181, one or more control prep heating instructions i1182, one or more control prep cooling instructions i1183, one or more control prep portion instructions i1184, one or more control prep mixing instructions i1185, and one or more control prep radiation instructions i1186, one or more control prep sound instructions i1187, one or more control prep infrared instructions i1188, one or more control prep microwave instructions i1189, one or more control prep container instructions i1190, one or more control prep syringe instructions i1191, one or more control prep mix before thermal instructions i1192, one or more control prep re mix after thermal instructions i1193, one or more control prep heating cooling instructions i1194, one or more control prep time control instructions i1195, one or more control prep ingredient exclusion instructions i1196, one or more control prep ingredient inclusion instructions i1197, one or more control prep housing instructions i1198, and one or more control prep building instructions i1199.

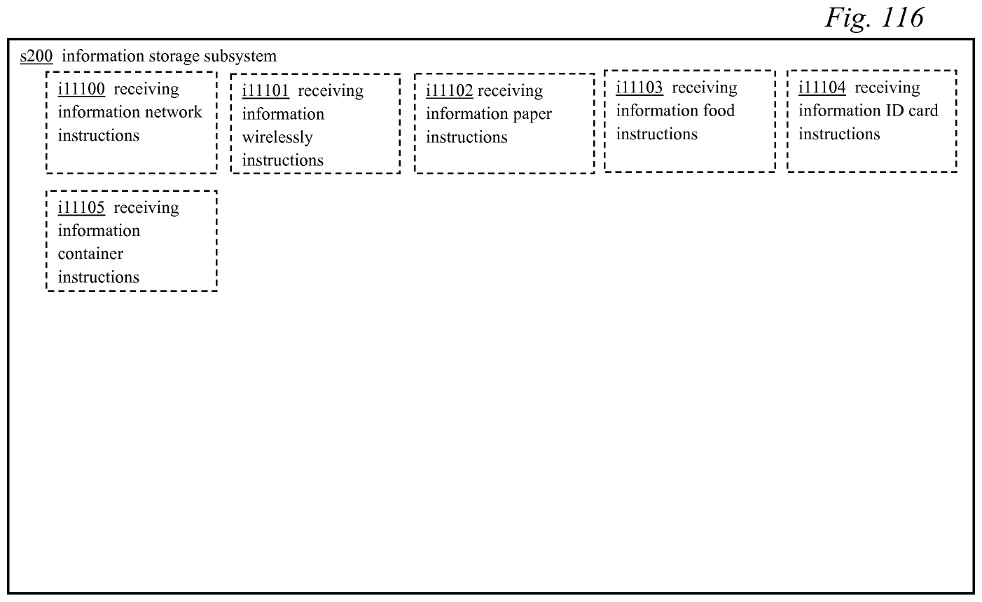

One or more exemplary instructions depicted in FIG. 116 as being borne in an exemplary version of a non-transitory signal bearing medium of information storage subsystem s200 include one or more control prep mall instructions i11100, one or more control prep restaurant instructions i11101, one or more control prep airplane instructions i11102, one or more control prep vehicle instructions i11103, one or more control prep territory instructions i11104, and one or more control prep region instructions i11105.

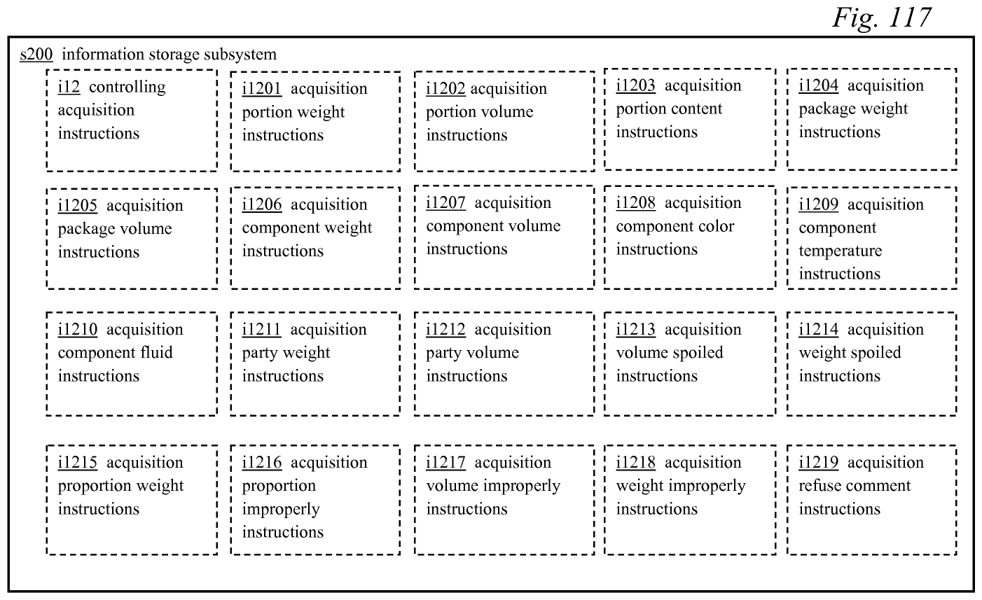

One or more exemplary instructions depicted in FIG. 117 as being borne in an exemplary version of a non-transitory signal bearing medium of information storage subsystem s200 include one or more controlling acquisition instructions i112, one or more acquisition portion weight instructions i11201, one or more acquisition portion volume instructions i11202, one or more acquisition portion content instructions i11203, one or more acquisition package weight instructions i11204, one or more acquisition package volume instructions i11205, one or more acquisition component weight instructions i11206, one or more acquisition component volume instructions i11207, one or more acquisition component color instructions i11208, one or more acquisition component temperature instructions i11209, one or more acquisition component fluid instructions i11210, one or more acquisition party weight instructions i11211, one or more acquisition party volume instructions i11212, one or more acquisition volume spoiled instructions i11213, one or more acquisition weight spoiled instructions i11214, one or more acquisition proportion weight instructions i11215, one or more acquisition proportion improperly instructions i11216, one or more acquisition volume improperly instructions i11217, one or more acquisition weight improperly instructions i11218, and one or more acquisition refuse comment instructions i11219.

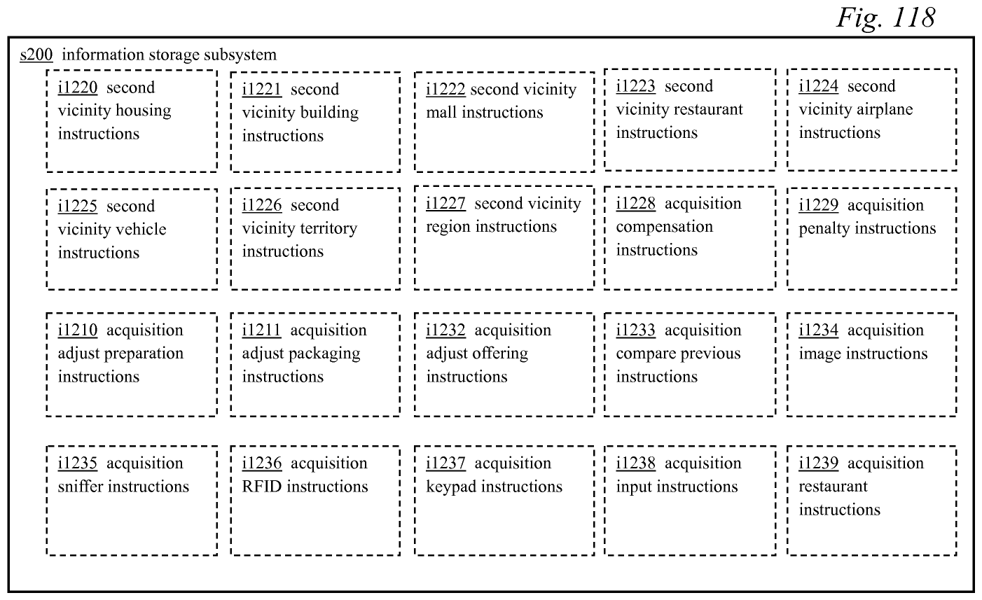

One or more exemplary instructions depicted in FIG. 118 as being borne in an exemplary version of a non-transitory signal bearing medium of information storage subsystem s200 include one or more second vicinity housing instructions i11220, one or more second vicinity building instructions i11221, one or more second vicinity mall instructions i11222, one or more second vicinity restaurant instructions i11223, one or more second vicinity airplane instructions i11224, one or more second vicinity vehicle instructions i11225, one or more second vicinity territory instructions i11226, one or more second vicinity region instructions i11227, one or more acquisition compensation instructions i11228, one or more acquisition penalty instructions i11229, one or more acquisition adjust preparation instructions i11230, one or more acquisition adjust packaging instructions i11231, one or more acquisition adjust offering instructions i11232, one or more acquisition compare previous instructions i11233, one or more acquisition image instructions i11234, one or more acquisition sniffer instructions i11235, one or more acquisition RFID instructions i11236, one or more acquisition keypad instructions i11237, one or more acquisition input instructions i11238, and one or more acquisition restaurant instructions i11239.

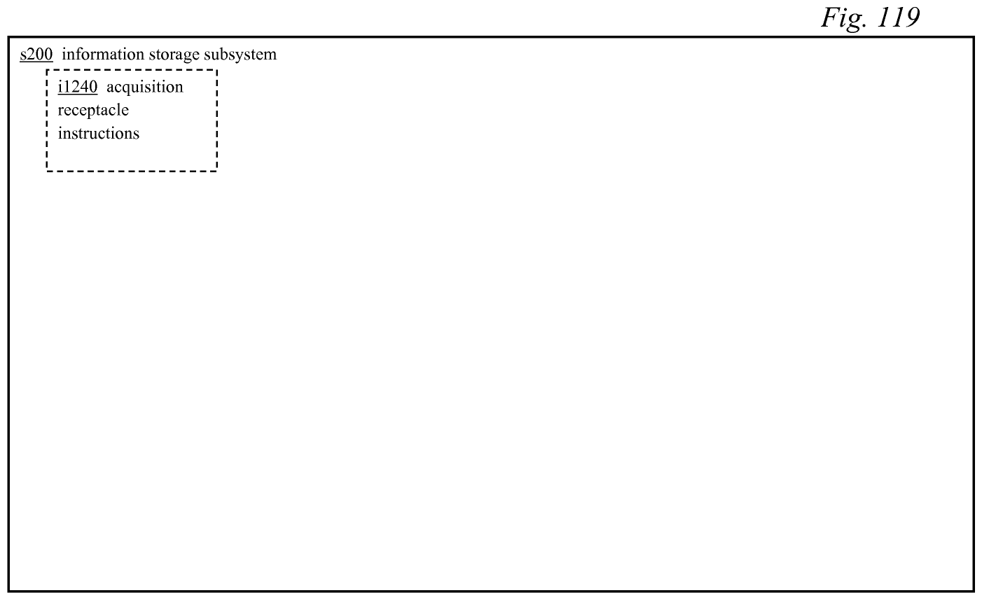

One or more exemplary instructions depicted in FIG. 119 as being borne in an exemplary version of a non-transitory signal bearing medium of information storage subsystem s200 include one or more controlling acquisition instructions i11240.

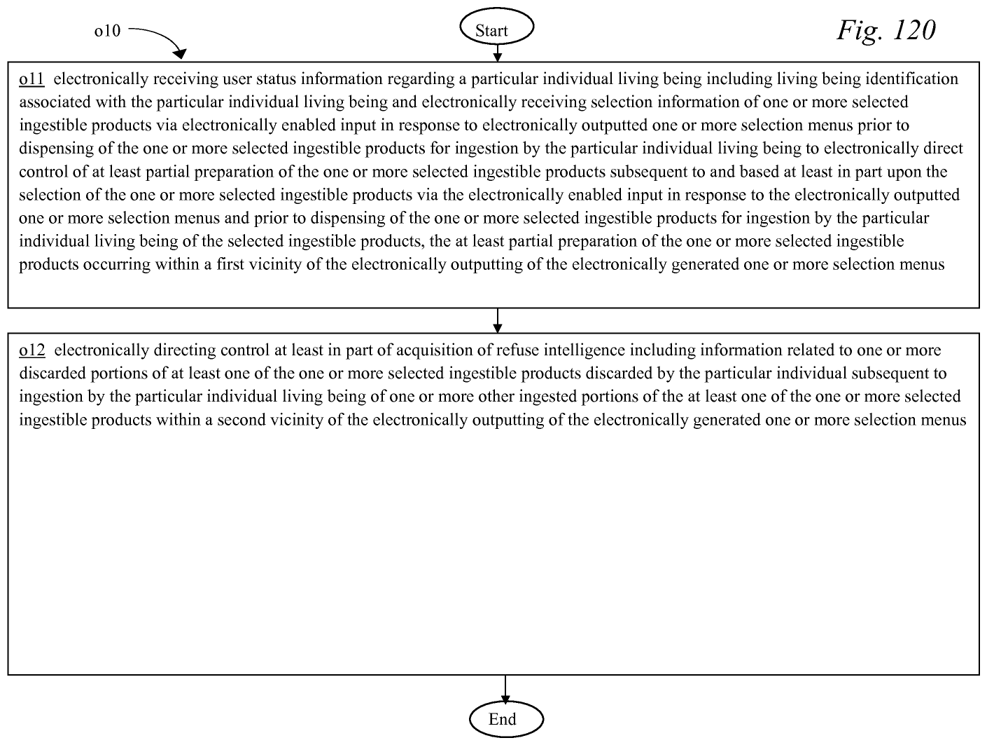

An operational flow o10 as shown in FIG. 120 represents example operations related to electronically receiving user status information regarding a particular individual living being including living being identification associated with the particular individual living being and electronically receiving selection information of one or more selected ingestible products via electronically enabled input in response to electronically outputted one or more selection menus prior to dispensing of the one or more selected ingestible products for ingestion by the particular individual living being to electronically direct control of at least partial preparation of the one or more selected ingestible products subsequent to and based at least in part upon the selection of the one or more selected ingestible products via the electronically enabled input in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus and electronically directing control at least in part of acquisition of refuse intelligence including information related to one or more discarded portions of at least one of the one or more selected ingestible products discarded by the particular individual subsequent to ingestion by the particular individual living being of one or more other ingested portions of the at least one of the one or more selected ingestible products within a second vicinity of the electronically outputting of the electronically generated one or more selection menus.

FIG. 120 and those figures that follow may have various examples of operational flows, and explanation may be provided with respect to the above-described examples of FIGS. 1-7 and/or with respect to other examples and contexts. Nonetheless, it should be understood that the operational flows may be executed in a number of other environments and contexts, and/or in modified versions of FIGS. 1-7. Furthermore, although the various operational flows are presented in the sequence(s) illustrated, it should be understood that the various operations may be performed in other orders than those which are illustrated, or may be performed concurrently.

In FIG. 120 and those figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

As shown in FIG. 120, the operational flow o10 proceeds to operation o11 for electronically receiving user status information regarding a particular individual living being including living being identification associated with the particular individual living being and electronically receiving selection information of one or more selected ingestible products via electronically enabled input in response to electronically outputted one or more selection menus prior to dispensing of the one or more selected ingestible products for ingestion by the particular individual living being to electronically direct control of at least partial preparation of the one or more selected ingestible products subsequent to and based at least in part upon the selection of the one or more selected ingestible products via the electronically enabled input in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus. An exemplary version of a non-transitory signal bearing medium of information storage subsystem s200 is depicted as bearing one or more receiving information instructions i11 that when executed will direct performance of the operation of 1. In an implementation, the one or more receiving information instructions i11 when executed direct electronically receiving (e.g. the network cable component s502 carries information to the transceiver component s522, etc.) user status information regarding a particular individual living being (e.g. a particular human being, animal, etc.) including living being identification associated with the particular individual living being (e.g. identification numbers, passwords, biometric data such as voice prints, stored in information storage subsystem 200) and electronically receiving (e.g. the network cable component s502 carries information to the transceiver component s522, etc.) selection information of one or more selected ingestible products via electronically enabled input (e.g. input using a keypad, voice commands, etc. to implement one or more selections, etc.)in response to electronically outputted (e.g. outputted on electronic display screens, etc.) one or more selection menus (e.g. textual, graphical, audio-visual or other sorts of menus, etc.) prior to dispensing of the one or more selected ingestible products for ingestion by the particular individual living being to electronically direct control (e.g. the microprocessor component s102 can direct control, etc.) of at least partial preparation (e.g. mixing and blending steps of making a smoothie, etc.) of the one or more selected ingestible products (e.g. a fruit smoothie, etc.) subsequent to and based at least in part upon the selection of the one or more selected ingestible products via the electronically enabled input (e.g. graphical user interface s302 is used to input selection of a fruit smoothie to be prepared by the digestible product preparation system 10, etc.) in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus (e.g. the graphical user interface s302 displaying the one or more selection menus is located within a room of a building that also houses the material processing subsystem 700 as the first vicinity used to prepare the selected fruit smoothie, etc.). Furthermore, the receiving information electrical circuitry arrangement (“elec circ arrange”) e11 when activated will perform the operation o11. In an implementation, the receiving information electrical circuitry arrangement e11, when activated performs electronically receiving (e.g. the network cable component s502 carries information to the transceiver component s522, etc.) user status information regarding a particular individual living being (e.g. a particular human being, animal, etc.) including living being identification associated with the particular individual living being (e.g. identification numbers, passwords, biometric data such as voice prints, stored in information storage subsystem 200) and electronically receiving (e.g. the network cable component s502 carries information to the transceiver component s522, etc.) selection information of one or more selected ingestible products via electronically enabled input (e.g. input using a keypad, voice commands, etc. to implement one or more selections, etc.)in response to electronically outputted (e.g. outputted on electronic display screens, etc.) one or more selection menus (e.g. textual, graphical, audio-visual or other sorts of menus, etc.) prior to dispensing of the one or more selected ingestible products for ingestion by the particular individual living being to electronically direct control (e.g. the microprocessor component s102 can direct control, etc.) of at least partial preparation (e.g. mixing and blending steps of making a smoothie, etc.) of the one or more selected ingestible products (e.g. a fruit smoothie, etc.) subsequent to and based at least in part upon the selection of the one or more selected ingestible products via the electronically enabled input (e.g. graphical user interface s302 is used to input selection of a fruit smoothie to be prepared by the digestible product preparation system 10, etc.) in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus (e.g. the graphical user interface s302 displaying the one or more selection menus is located within a room of a building that also houses the material processing subsystem 700 as the first vicinity used to prepare the selected fruit smoothie, etc.). In an implementation, the electronically receiving user status information regarding a particular individual living being including living being identification associated with the particular individual living being and electronically receiving selection information of one or more selected ingestible products via electronically enabled input in response to electronically outputted one or more selection menus prior to dispensing of the one or more selected ingestible products for ingestion by the particular individual living being to electronically direct control of at least partial preparation of the one or more selected ingestible products subsequent to and based at least in part upon the selection of the one or more selected ingestible products via the electronically enabled input in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus is carried out by electronically receiving (e.g. the network cable component s502 carries information to the transceiver component s522, etc.) user status information regarding a particular individual living being (e.g. a particular human being, animal, etc.) including living being identification associated with the particular individual living being (e.g. identification numbers, passwords, biometric data such as voice prints, stored in information storage subsystem 200) and electronically receiving (e.g. the network cable component s502 carries information to the transceiver component s522, etc.) selection information of one or more selected ingestible products via electronically enabled input (e.g. input using a keypad, voice commands, etc. to implement one or more selections, etc.)in response to electronically outputted (e.g. outputted on electronic display screens, etc.) one or more selection menus (e.g. textual, graphical, audio-visual or other sorts of menus, etc.) prior to dispensing of the one or more selected ingestible products for ingestion by the particular individual living being to electronically direct control (e.g. the microprocessor component s102 can direct control, etc.) of at least partial preparation (e.g. mixing and blending steps of making a smoothie, etc.) of the one or more selected ingestible products (e.g. a fruit smoothie, etc.) subsequent to and based at least in part upon the selection of the one or more selected ingestible products via the electronically enabled input (e.g. graphical user interface s302 is used to input selection of a fruit smoothie to be prepared by the digestible product preparation system 10, etc.) in response to the electronically outputted one or more selection menus and prior to dispensing of the one or more selected ingestible products for ingestion by the particular individual living being of the selected ingestible products, the at least partial preparation of the one or more selected ingestible products occurring within a first vicinity of the electronically outputting of the electronically generated one or more selection menus (e.g. the graphical user interface s302 displaying the one or more selection menus is located within a room of a building that also houses the material processing subsystem 700 as the first vicinity used to prepare the selected fruit smoothie, etc.).

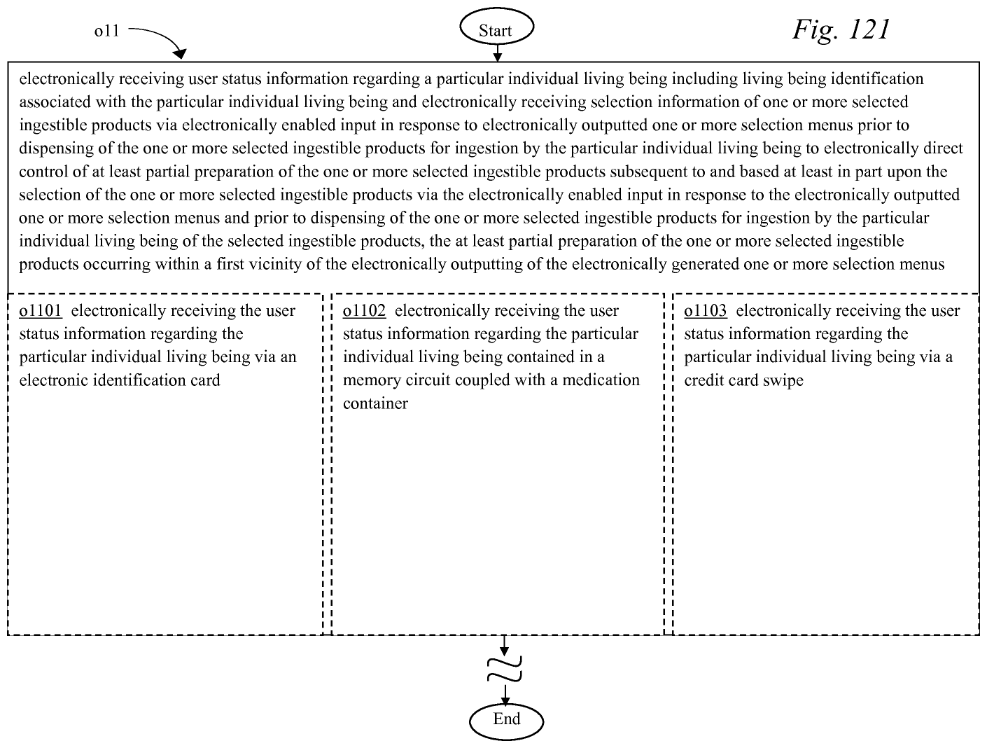

In one or more implementations, as shown in FIG. 121, operation o11 includes an operation o1101 for electronically receiving the user status information regarding the particular individual living being via an electronic identification card. An exemplary version of a non-transitory signal bearing medium of information storage subsystem s200 is depicted as bearing one or more receiving information ID card instructions i1101 that when executed will direct performance of the operation o1101. In an implementation, the one or more receiving information ID card instructions i1101 when executed direct electronically receiving the user status information regarding the particular individual living being via an electronic identification card (e.g. an implementation of the receiver component s528 is configured to electronically engage with a card having memory storage holding the user status information, etc.). Furthermore, the receiving information ID card electrical circuitry arrangement (“elec circ arrange”) e1101 when activated will perform the operation o1101. In an implementation, the receiving information ID card electrical circuitry arrangement e1101, when activated performs electronically receiving the user status information regarding the particular individual living being via an electronic identification card (e.g. an implementation of the receiver component s528 is configured to electronically engage with a card having memory storage holding the user status information, etc.). In an implementation, the electronically receiving the user status information regarding the particular individual living being via an electronic identification card is carried out by electronically receiving the user status information regarding the particular individual living being via an electronic identification card (e.g. an implementation of the receiver component s528 is configured to electronically engage with a card having memory storage holding the user status information, etc.).

In one or more implementations, operation o11 includes an operation o1102 for electronically receiving the user status information regarding the particular individual living being contained in a memory circuit coupled with a medication container. An exemplary version of a non-transitory signal bearing medium of information storage subsystem s200 is depicted as bearing one or more receiving information memory instructions i102 that when executed will direct performance of the operation o1102. In an implementation, the one or more receiving information memory instructions i102 when executed direct electronically receiving the user status information regarding the particular individual living being contained in a memory circuit coupled with a medication container (e.g. an implementation of the receiver component s528 is configured to electronically engage with a memory storage coupled with a medication container to receive the user status information in electronic form, etc.). Furthermore, the receiving information memory electrical circuitry arrangement e1102 when activated will perform the operation o1102. In an implementation, the receiving information memory electrical circuitry arrangement e1102, when activated performs electronically receiving the user status information regarding the particular individual living being contained in a memory circuit coupled with a medication container (e.g. an implementation of the receiver component s528 is configured to electronically engage with a memory storage coupled with a medication container to receive the user status information in electronic form, etc.). In an implementation, the electronically receiving the user status information regarding the particular individual living being contained in a memory circuit coupled with a medication container is carried out by electronically receiving the user status information regarding the particular individual living being contained in a memory circuit coupled with a medication container (e.g. an implementation of the receiver component s528 is configured to electronically engage with a memory storage coupled with a medication container to receive the user status information in electronic form, etc.).

In one or more implementations, operation o11 includes an operation o1103 for electronically receiving the user status information regarding the particular individual living being via a credit card swipe. An exemplary version of a non-transitory signal bearing medium of information storage subsystem s200 is depicted as bearing one or more receiving information credit card instructions i1103 that when executed will direct performance of the operation o1103. In an implementation, the one or more receiving information credit card instructions i1103 when executed direct electronically receiving the user status information regarding the particular individual living being via a credit card swipe (e.g. an implementation of the receiver component s528 is configured to electronically engage with an electronic memory stripe integrated into a credit card to receive the user status information, etc.). Furthermore, the receiving information credit card electrical circuitry arrangement e1103 when activated will perform the operation o1103. In an implementation, the receiving information credit card electrical circuitry arrangement e1103, when activated performs electronically receiving the user status information regarding the particular individual living being via a credit card swipe (e.g. an implementation of the receiver component s528 is configured to electronically engage with an electronic memory stripe integrated into a credit card to receive the user status information, etc.). In an implementation, the is electronically receiving the user status information regarding the particular individual living being via a credit card swipe carried out by electronically receiving the user status information regarding the particular individual living being via a credit card swipe (e.g. an implementation of the receiver component s528 is configured to electronically engage with an electronic memory stripe integrated into a credit card to receive the user status information, etc.).

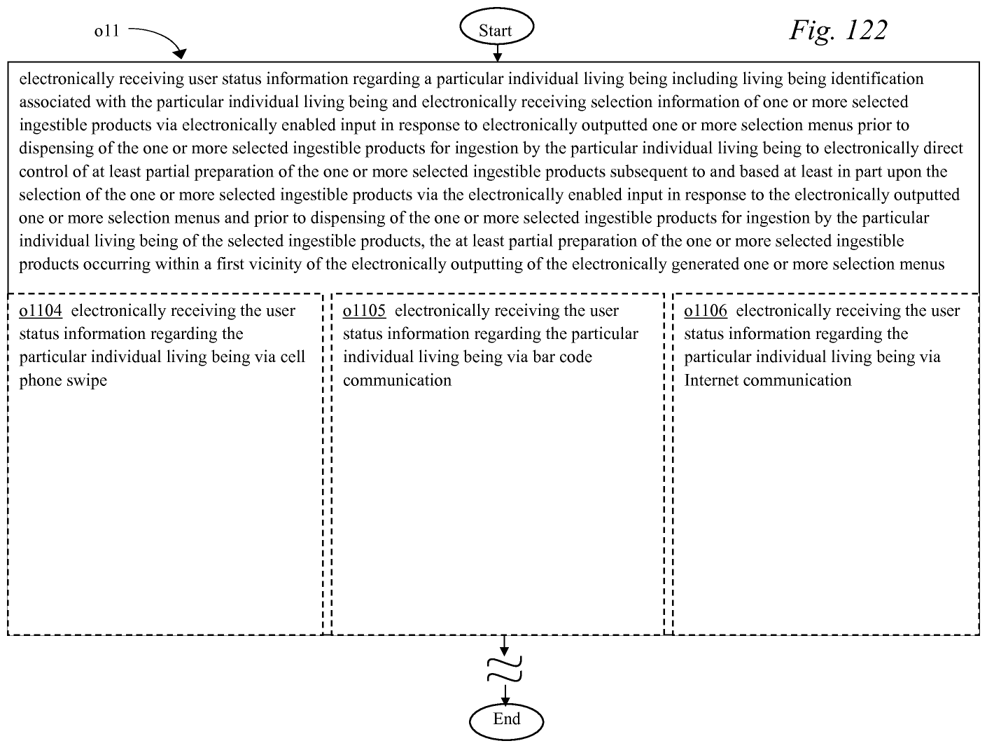

In one or more implementations, as shown in FIG. 122, operation o11 includes an operation o1104 for electronically receiving the user status information regarding the particular individual living being via cell phone swipe. An exemplary version of a non-transitory signal bearing medium of information storage subsystem s200 is depicted as bearing one or more receiving information cell phone instructions i1104 that when executed will direct performance of the operation o1104. In an implementation, the one or more receiving information cell phone instructions i1104 when executed direct electronically receiving the user status information regarding the particular individual living being via cell phone swipe (e.g. an implementation of the receiver component s528 is configured to electronically engage with an electronic memory component integrated into a cell phone to receive the user status information, etc.). Furthermore, the receiving information cell phone electrical circuitry arrangement e1104 when activated will perform the operation o1104. In an implementation, the receiving information cell phone electrical circuitry arrangement e1104, when activated performs electronically receiving the user status information regarding the particular individual living being via cell phone swipe (e.g. an implementation of the receiver component s528 is configured to electronically engage with an electronic memory component integrated into a cell phone to receive the user status information, etc.). In an implementation, the is electronically receiving the user status information regarding the particular individual living being via cell phone swipe carried out by electronically receiving the user status information regarding the particular individual living being via cell phone swipe (e.g. an implementation of the receiver component s528 is configured to electronically engage with an electronic memory component integrated into a cell phone to receive the user status information, etc.).

In one or more implementations, operation o11 includes an operation o1105 for electronically receiving the user status information regarding the particular individual living being via bar code communication. An exemplary version of a non-transitory signal bearing medium of information storage subsystem s200 is depicted as bearing one or more receiving information bar code instructions i1105 that when executed will direct performance of the operation o1105. In an implementation, the one or more receiving information bar code instructions i1105 when executed direct electronically receiving the user status information regarding the particular individual living being via bar code communication (e.g. an implementation of the receiver component s528 is configured to electronically read a bar code label to receive the user status information, etc.). Furthermore, the receiving information bar code electrical circuitry arrangement e1105 when activated will perform the operation o1105. In an implementation, the receiving information bar code electrical circuitry arrangement e1105, when activated performs electronically receiving the user status information regarding the particular individual living being via bar code communication (e.g. an implementation of the receiver component s528 is configured to electronically read a bar code label to receive the user status information, etc.). In an implementation, the electronically receiving the user status information regarding the particular individual living being via bar code communication is carried out by electronically receiving the user status information regarding the particular individual living being via bar code communication (e.g. an implementation of the receiver component s528 is configured to electronically read a bar code label to receive the user status information, etc.).

In one or more implementations, operation o11 includes an operation o1106 for electronically receiving the user status information regarding the particular individual living being via Internet communication. An exemplary version of a non-transitory signal bearing medium of information storage subsystem s200 is depicted as bearing one or more receiving information Internet instructions i106 that when executed will direct performance of the operation o1106. In an implementation, the one or more receiving information Internet instructions i106 when executed direct electronically receiving the user status information regarding the particular individual living being via Internet communication (e.g. an implementation of the receiver component s528 is configured to electronically receive through the internet network component s508 the user status information, etc.). Furthermore, the receiving information Internet electrical circuitry arrangement e1106 when activated will perform the operation o1106. In an implementation, the receiving information Internet electrical circuitry arrangement e1106, when activated performs electronically receiving the user status information regarding the particular individual living being via Internet communication (e.g. an implementation of the receiver component s528 is configured to electronically receive through the internet network component s508 the user status information, etc.). In an implementation, the electronically receiving the user status information regarding the particular individual living being via Internet communication is carried out by electronically receiving the user status information regarding the particular individual living being via Internet communication (e.g. an implementation of the receiver component s528 is configured to electronically receive through the internet network component s508 the user status information, etc.).

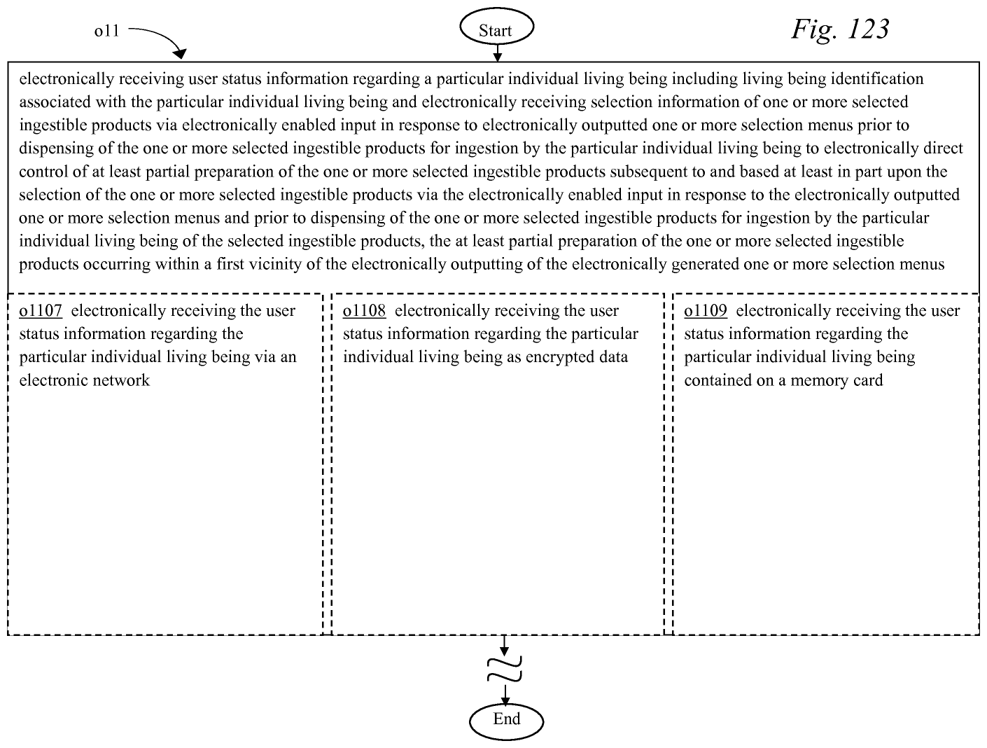

In one or more implementations, as shown in FIG. 123, operation o11 includes an operation o1107 for electronically receiving the user status information regarding the particular individual living being via an electronic network. An exemplary version of a non-transitory signal bearing medium of information storage subsystem s200 is depicted as bearing one or more receiving information network instructions i107 that when executed will direct performance of the operation o1107. In an implementation, the one or more receiving information network instructions i107 when executed direct electronically receiving the user status information regarding the particular individual living being via an electronic network (e.g. an implementation of the receiver component s528 is configured to electronically engage with the network cable component s502 to receive the user status information, etc.). Furthermore, the receiving information network electrical circuitry arrangement e1107 when activated will perform the operation o1107. In an implementation, the receiving information network electrical circuitry arrangement e1107, when activated performs electronically receiving the user status information regarding the particular individual living being via an electronic network (e.g. an implementation of the receiver component s528 is configured to electronically engage with the network cable component s502 to receive the user status information, etc.). In an implementation, the electronically receiving the user status information regarding the particular individual living being via an electronic network is carried out by electronically receiving the user status information regarding the particular individual living being via an electronic network (e.g. an implementation of the receiver component s528 is configured to electronically engage with the network cable component s502 to receive the user status information, etc.).

In one or more implementations, operation o11 includes an operation o1108 for electronically receiving the user status information regarding the particular individual living being as encrypted data. An exemplary version of a non-transitory signal bearing medium of information storage subsystem s200 is depicted as bearing one or more receiving encrypted information instructions i1108 that when executed will direct performance of the operation o1108. In an implementation, the one or more receiving encrypted information instructions i1108 when executed direct electronically receiving the user status information as encrypted data (e.g. an implementation of the receiver component s528 is configured to electronically receive through the encrypted communication component s520 the user status information, etc.). Furthermore, the receiving encrypted information electrical circuitry arrangement e1108 when activated will perform the operation o1108. In an implementation, the receiving encrypted information electrical circuitry arrangement e1108, when activated performs electronically receiving the user status information as encrypted data (e.g. an implementation of the receiver component s528 is configured to electronically receive through the encrypted communication component s520 the user status information, etc.). In an implementation, the electronically receiving the user status information regarding the particular individual living being as encrypted data is carried out by electronically receiving the user status information as encrypted data (e.g. an implementation of the receiver component s528 is configured to electronically receive through the encrypted communication component s520 the user status information, etc.).

In one or more implementations, operation o11 includes an operation o1109 for electronically receiving the user status information regarding the particular individual living being contained on a memory card. An exemplary version of a non-transitory signal bearing medium of information storage subsystem s200 is depicted as bearing one or more receiving information memory card instructions i1109 that when executed will direct performance of the operation o1109. In an implementation, the one or more receiving information memory card instructions i1109 when executed direct electronically receiving the user status information contained on a memory card (e.g. an implementation of the receiver component s528 is configured to electronically engage with an electronic memory card to receive the user status information, etc.). Furthermore, the receiving information memory card electrical circuitry arrangement e1109 when activated will perform the operation o1109. In an implementation, the receiving information memory card electrical circuitry arrangement e1109, when activated performs electronically receiving the user status information contained on a memory card (e.g. an implementation of the receiver component s528 is configured to electronically engage with an electronic memory card to receive the user status information, etc.). In an implementation, the electronically receiving the user status information regarding the particular individual living being contained on a memory card is carried out by electronically receiving the user status information contained on a memory card (e.g. an implementation of the receiver component s528 is configured to electronically engage with an electronic memory card to receive the user status information, etc.).

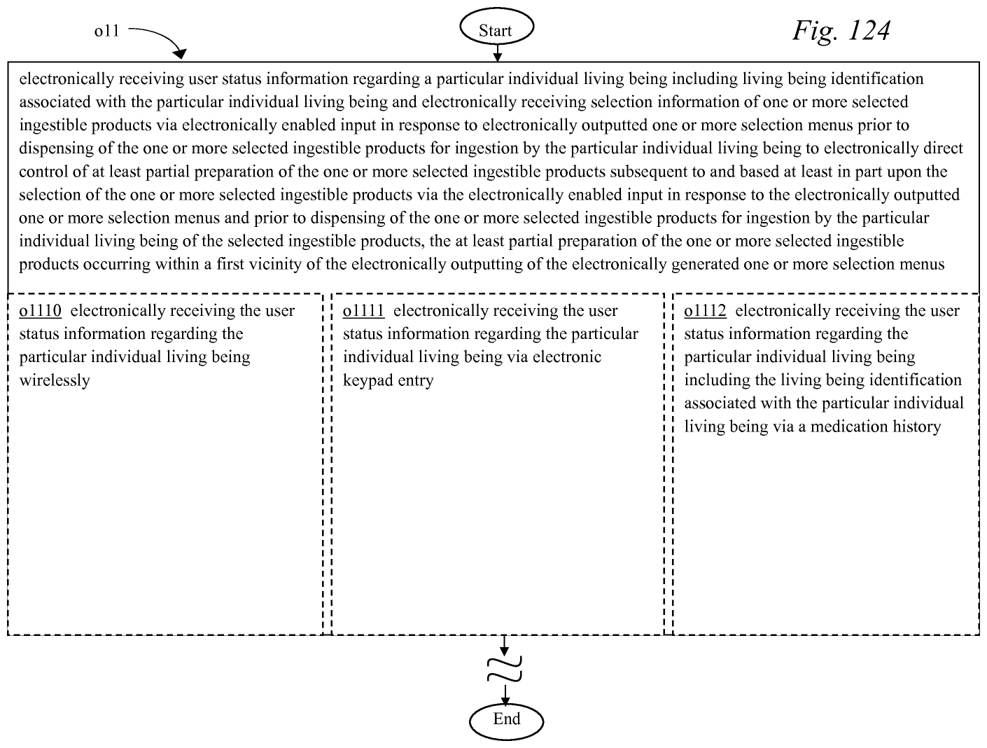

In one or more implementations, as shown in FIG. 124, operation o11 includes an operation o1110 for electronically receiving the user status information regarding the particular individual living being wirelessly. An exemplary version of a non-transitory signal bearing medium of information storage subsystem s200 is depicted as bearing one or more receiving information wirelessly instructions i1110 that when executed will direct performance of the operation o1110. In an implementation, the one or more receiving information wirelessly instructions i1110 when executed direct electronically receiving the user status information wirelessly (e.g. an implementation of the receiver component s528 is configured to electronically receive through the wireless network component s512 the user status information, etc.). Furthermore, the receiving information wirelessly electrical circuitry arrangement e1110 when activated will perform the operation o1110. In an implementation, the receiving information wirelessly electrical circuitry arrangement e1110, when activated performs electronically receiving the user status information wirelessly (e.g. an implementation of the receiver component s528 is configured to electronically receive through the wireless network component s512 the user status information, etc.). In an implementation, the electronically receiving the user status information regarding the particular individual living being wirelessly is carried out by electronically receiving the user status information wirelessly (e.g. an implementation of the receiver component s528 is configured to electronically receive through the wireless network component s512 the user status information, etc.).

In one or more implementations, operation o11 includes an operation o1111 for electronically receiving the user status information regarding the particular individual living being via electronic keypad entry. An exemplary version of a non-transitory signal bearing medium of information storage subsystem s200 is depicted as bearing one or more receiving information keypad entry instructions i1111 that when executed will direct performance of the operation o1111. In an implementation, the one or more receiving information keypad entry instructions i1111 when executed direct electronically receiving the user status information regarding the particular individual living being via electronic keypad entry (e.g. an implementation of the receiver component s528 is configured to electronically engage with the keypad component s308 to receive the user status information as inputted by a user, etc.). Furthermore, the receiving information keypad entry electrical circuitry arrangement e1111 when activated will perform the operation o1111. In an implementation, the receiving information keypad entry electrical circuitry arrangement e1111, when activated performs electronically receiving the user status information regarding the particular individual living being via electronic keypad entry (e.g. an implementation of the receiver component s528 is configured to electronically engage with the keypad component s308 to receive the user status information as inputted by a user, etc.). In an implementation, the electronically receiving the user status information regarding the particular individual living being via electronic keypad entry is carried out by electronically receiving the user status information regarding the particular individual living being via electronic keypad entry (e.g. an implementation of the receiver component s528 is configured to electronically engage with the keypad component s308 to receive the user status information as inputted by a user, etc.).

In one or more implementations, operation o11 includes an operation o1112 for electronically receiving the user status information regarding the particular individual living being including the living being identification associated with the particular individual living being via a medication history. An exemplary version of a non-transitory signal bearing medium of information storage subsystem s200 is depicted as bearing one or more receiving information meds history instructions i1112 that when executed will direct performance of the operation o1112. In an implementation, the one or more receiving information meds history instructions i1112 when executed direct electronically receiving the user status information regarding the particular individual living being including the living being identification associated with the particular individual living being via a medication history (e.g. an implementation of the receiver component s528 is configured to electronically engage with the microprocessor component s102 to receive the user status information including the living being identification associated with the particular individual living being as determined by the microprocessor component to identify the name and control number of the medication history of the particular individual living being, etc.). Furthermore, the receiving information meds history electrical circuitry arrangement e1112 when activated will perform the operation o1112. In an implementation, the receiving information meds history electrical circuitry arrangement e1112, when activated performs electronically receiving the user status information regarding the particular individual living being including the living being identification associated with the particular individual living being via a medication history (e.g. an implementation of the receiver component s528 is configured to electronically engage with the microprocessor component s102 to receive the user status information including the living being identification associated with the particular individual living being as determined by the microprocessor component to identify the name and control number of the medication history of the particular individual living being, etc.). In an implementation, the electronically receiving the user status information regarding the particular individual living being including the living being identification associated with the particular individual living being via a medication history is carried out by electronically receiving the user status information regarding the particular individual living being including the living being identification associated with the particular individual living being via a medication history (e.g. an implementation of the receiver component s528 is configured to electronically engage with the microprocessor component s102 to receive the user status information including the living being identification associated with the particular individual living being as determined by the microprocessor component to identify the name and control number of the medication history of the particular individual living being, etc.).

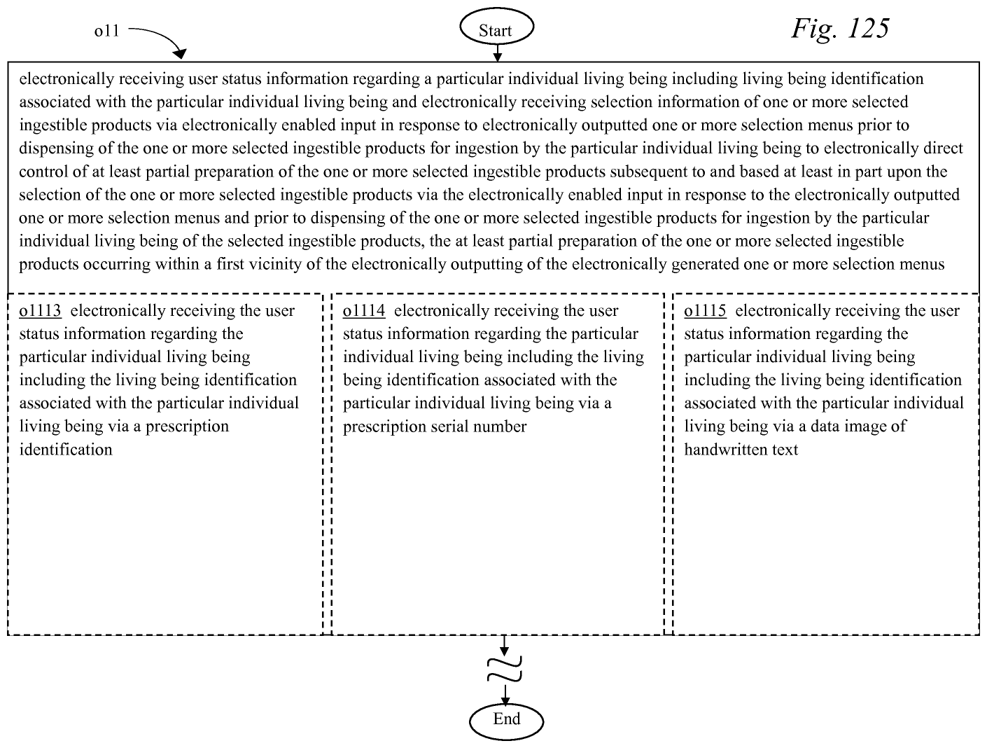

In one or more implementations, as shown in FIG. 125, operation o11 includes an operation o1113 for electronically receiving the user status information regarding the particular individual living being including the living being identification associated with the particular individual living being via a prescription identification. An exemplary version of a non-transitory signal bearing medium of information storage subsystem s200 is depicted as bearing one or more receiving information prescription ID instructions i1113 that when executed will direct performance of the operation o1113. In an implementation, the one or more receiving information prescription ID instructions i1113 when executed direct electronically receiving the user status information regarding the particular individual living being including the living being identification associated with the particular individual living being via a prescription identification (e.g. an implementation of the receiver component s528 is configured to electronically engage with the microprocessor component s102 to receive the user status information including the living being identification associated with the particular individual living being as determined by the microprocessor component to include a prescription identification, etc.). Furthermore, the receiving information prescription ID electrical circuitry arrangement e1113 when activated will perform the operation o1113. In an implementation, the receiving information prescription ID electrical circuitry arrangement e1113, when activated performs electronically receiving the user status information regarding the particular individual living being including the living being identification associated with the particular individual living being via a prescription identification (e.g. an implementation of the receiver component s528 is configured to electronically engage with the microprocessor component s102 to receive the user status information including the living being identification associated with the particular individual living being as determined by the microprocessor component to include a prescription identification, etc.). In an implementation, the electronically receiving the user status information regarding the particular individual living being including the living being identification associated with the particular individual living being via a prescription identification is carried out by electronically receiving the user status information regarding the particular individual living being including the living being identification associated with the particular individual living being via a prescription identification (e.g. an implementation of the receiver component s528 is configured to electronically engage with the microprocessor component s102 to receive the user status information including the living being identification associated with the particular individual living being as determined by the microprocessor component to include a prescription identification, etc.).

In one or more implementations, operation o11 includes an operation o1114 for electronically receiving the user status information regarding the particular individual living being including the living being identification associated with the particular individual living being via a prescription serial number. An exemplary version of a non-transitory signal bearing medium of information storage subsystem s200 is depicted as bearing one or more receiving information prescription number instructions i1114 that when executed will direct performance of the operation o1114. In an implementation, the one or more receiving information prescription number instructions i1114 when executed direct electronically receiving the user status information regarding the particular individual living being including the living being identification associated with the particular individual living being via a prescription serial number (e.g. an implementation of the receiver component s528 is configured to electronically engage with the microprocessor component s102 to receive the user status information including the living being identification associated with the particular individual living being as determined by the microprocessor component to include a prescription serial number, etc.). Furthermore, the receiving information prescription number electrical circuitry arrangement e1114 when activated will perform the operation o1114. In an implementation, the receiving information prescription number electrical circuitry arrangement e1114, when activated performs electronically receiving the user status information regarding the particular individual living being including the living being identification associated with the particular individual living being via a prescription serial number (e.g. an implementation of the receiver component s528 is configured to electronically engage with the microprocessor component s102 to receive the user status information including the living being identification associated with the particular individual living being as determined by the microprocessor component to include a prescription serial number, etc.). In an implementation, the electronically receiving the user status information regarding the particular individual living being including the living being identification associated with the particular individual living being via a prescription serial number is carried out by electronically receiving the user status information regarding the particular individual living being including the living being identification associated with the particular individual living being via a prescription serial number (e.g. an implementation of the receiver component s528 is configured to electronically engage with the microprocessor component s102 to receive the user status information including the living being identification associated with the particular individual living being as determined by the microprocessor component to include a prescription serial number, etc.).

In one or more implementations, operation o11 includes an operation o1115 for electronically receiving the user status information regarding the particular individual living being including the living being identification associated with the particular individual living being via a data image of handwritten text. An exemplary version of a non-transitory signal bearing medium of information storage subsystem s200 is depicted as bearing one or more receiving information handwritten instructions i1115 that when executed will direct performance of the operation o1115. In an implementation, the one or more receiving information handwritten instructions i1115 when executed direct electronically receiving the user status information regarding the particular individual living being including the living being identification associated with the particular individual living being via a data image of handwritten text (e.g. an implementation of the receiver component s528 is configured to electronically engage with the microprocessor component s102 to receive the user status information regarding the particular individual living being including the living being identification associated with the particular individual living being as determined by the microprocessor component through electronic handwriting analysis of the data image of the handwritten text, etc.). Furthermore, the receiving information handwritten electrical circuitry arrangement e1115 when activated will perform the operation o1115. In an implementation, the receiving information handwritten electrical circuitry arrangement e1115, when activated performs electronically receiving the user status information regarding the particular individual living being including the living being identification associated with the particular individual living being via a data image of handwritten text (e.g. an implementation of the receiver component s528 is configured to electronically engage with the microprocessor component s102 to receive the user status information regarding the particular individual living being including the living being identification associated with the particular individual living being as determined by the microprocessor component through electronic handwriting analysis of the data image of the handwritten text, etc.). In an implementation, the electronically receiving the user status information regarding the particular individual living being including the living being identification associated with the particular individual living being via a data image of handwritten text is carried out by electronically receiving the user status information regarding the particular individual living being including the living being identification associated with the particular individual living being via a data image of handwritten text (e.g. an implementation of the receiver component s528 is configured to electronically engage with the microprocessor component s102 to receive the user status information regarding the particular individual living being including the living being identification associated with the particular individual living being as determined by the microprocessor component through electronic handwriting analysis of the data image of the handwritten text, etc.).

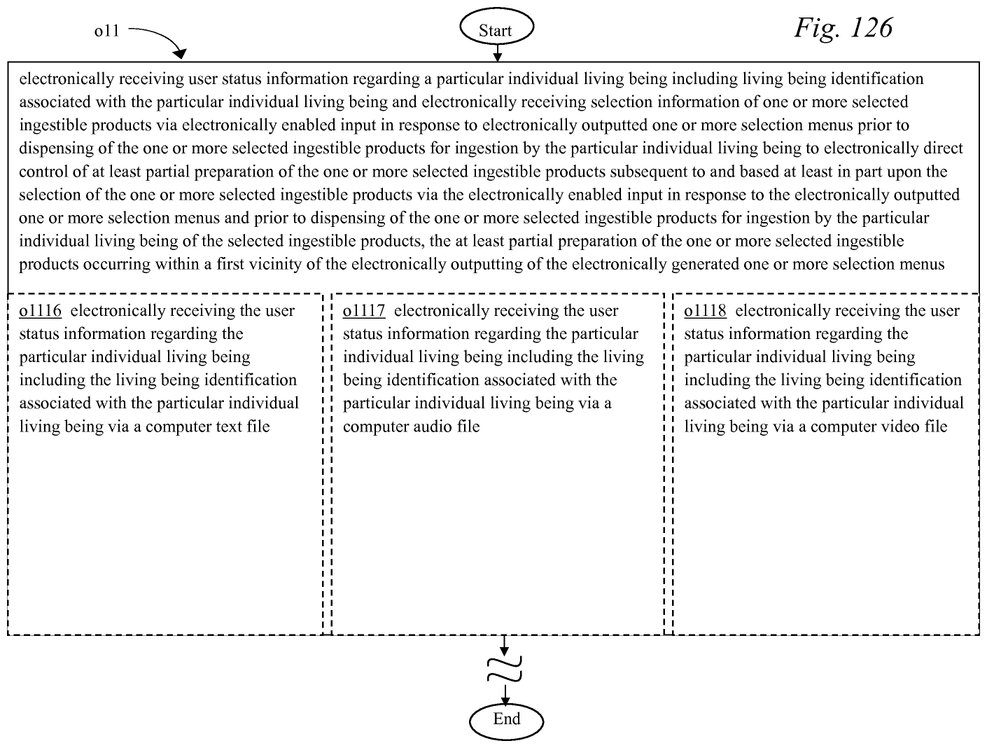

In one or more implementations, as shown in FIG. 126, operation o11 includes an operation o1116 for electronically receiving the user status information regarding the particular individual living being including the living being identification associated with the particular individual living being via a computer text file. An exemplary version of a non-transitory signal bearing medium of information storage subsystem s200 is depicted as bearing one or more receiving information text file instructions i1116 that when executed will direct performance of the operation o1116. In an implementation, the one or more receiving information text file instructions i1116 when executed direct electronically receiving the user status information regarding the particular individual living being including the living being identification associated with the particular individual living being via a computer text file (e.g. an implementation of the receiver component s528 is configured to electronically engage with the microprocessor component s102 to receive the user status information including the living being identification associated with the particular individual living being as determined by the microprocessor component through electronic reading of the computer text file, etc.). Furthermore, the receiving information text file electrical circuitry arrangement e1116 when activated will perform the operation o1116. In an implementation, the receiving information text file electrical circuitry arrangement e1116, when activated performs electronically receiving the user status information regarding the particular individual living being including the living being identification associated with the particular individual living being via a computer text file (e.g. an implementation of the receiver component s528 is configured to electronically engage with the microprocessor component s102 to receive the user status information including the living being identification associated with the particular individual living being as determined by the microprocessor component through electronic reading of the computer text file, etc.). In an implementation, the electronically receiving the user status information regarding the particular individual living being including the living being identification associated with the particular individual living being via a computer text file is carried out by electronically receiving the user status information regarding the particular individual living being including the living being identification associated with the particular individual living being via a computer text file (e.g. an implementation of the receiver component s528 is configured to electronically engage with the microprocessor component s102 to receive the user status information including the living being identification associated with the particular individual living being as determined by the microprocessor component through electronic reading of the computer text file, etc.).

In one or more implementations, operation o11 includes an operation o1117 for electronically receiving the user status information regarding the particular individual living being including the living being identification associated with the particular individual living being via a computer audio file. An exemplary version of a non-transitory signal bearing medium of information storage subsystem s200 is depicted as bearing one or more receiving information audio file instructions i1117 that when executed will direct performance of the operation o1117. In an implementation, the one or more receiving information audio file instructions i1117 when executed direct electronically receiving the user status information regarding the particular individual living being including the living being identification associated with the particular individual living being via a computer audio file (e.g. an implementation of the receiver component s528 is configured to electronically engage with the microprocessor component s102 to receive the user status information including the living being identification associated with the particular individual living being as determined by the microprocessor component through electronic reading of the computer audio file, etc.). Furthermore, the receiving information audio file electrical circuitry arrangement e1117 when activated will perform the operation o1117. In an implementation, the receiving information audio file electrical circuitry arrangement e1117, when activated performs electronically receiving the user status information regarding the particular individual living being including the living being identification associated with the particular individual living being via a computer audio file (e.g. an implementation of the receiver component s528 is configured to electronically engage with the microprocessor component s102 to receive the user status information including the living being identification associated with the particular individual living being as determined by the microprocessor component through electronic reading of the computer audio file, etc.). In an implementation, the electronically receiving the user status information regarding the particular individual living being including the living being identification associated with the particular individual living being via a computer audio file is carried out by electronically receiving the user status information regarding the particular individual living being including the living being identification associated with the particular individual living being via a computer audio file (e.g. an implementation of the receiver component s528 is configured to electronically engage with the microprocessor component s102 to receive the user status information including the living being identification associated with the particular individual living being as determined by the microprocessor component through electronic reading of the computer audio file, etc.).

In one or more implementations, operation o11 includes an operation o1118 for electronically receiving the user status information regarding the particular individual living being including the living being identification associated with the particular individual living being via a computer video file. An exemplary version of a non-transitory signal bearing medium of information storage subsystem s200 is depicted as bearing one or more receiving information video file instructions i1118 that when executed will direct performance of the operation o1118. In an implementation, the one or more receiving information video file instructions i1118 when executed direct electronically receiving the user status information regarding the particular individual living being including the living being identification associated with the particular individual living being via a computer video file (e.g. an implementation of the receiver component s528 is configured to electronically engage with the microprocessor component s102 to receive the user status information including the living being identification associated with the particular individual living being as determined by the microprocessor component through electronic reading of the computer video file, etc.). Furthermore, the receiving information video file electrical circuitry arrangement e1118 when activated will perform the operation o1118. In an implementation, the receiving information video file electrical circuitry arrangement e1118, when activated performs electronically receiving the user status information regarding the particular individual living being including the living being identification associated with the particular individual living being via a computer video file (e.g. an implementation of the receiver component s528 is configured to electronically engage with the microprocessor component s102 to receive the user status information including the living being identification associated with the particular individual living being as determined by the microprocessor component through electronic reading of the computer video file, etc.). In an implementation, the electronically receiving the user status information regarding the particular individual living being including the living being identification associated with the particular individual living being via a computer video file is carried out by electronically receiving the user status information regarding the particular individual living being including the living being identification associated with the particular individual living being via a computer video file (e.g. an implementation of the receiver component s528 is configured to electronically engage with the microprocessor component s102 to receive the user status information including the living being identification associated with the particular individual living being as determined by the microprocessor component through electronic reading of the computer video file, etc.).

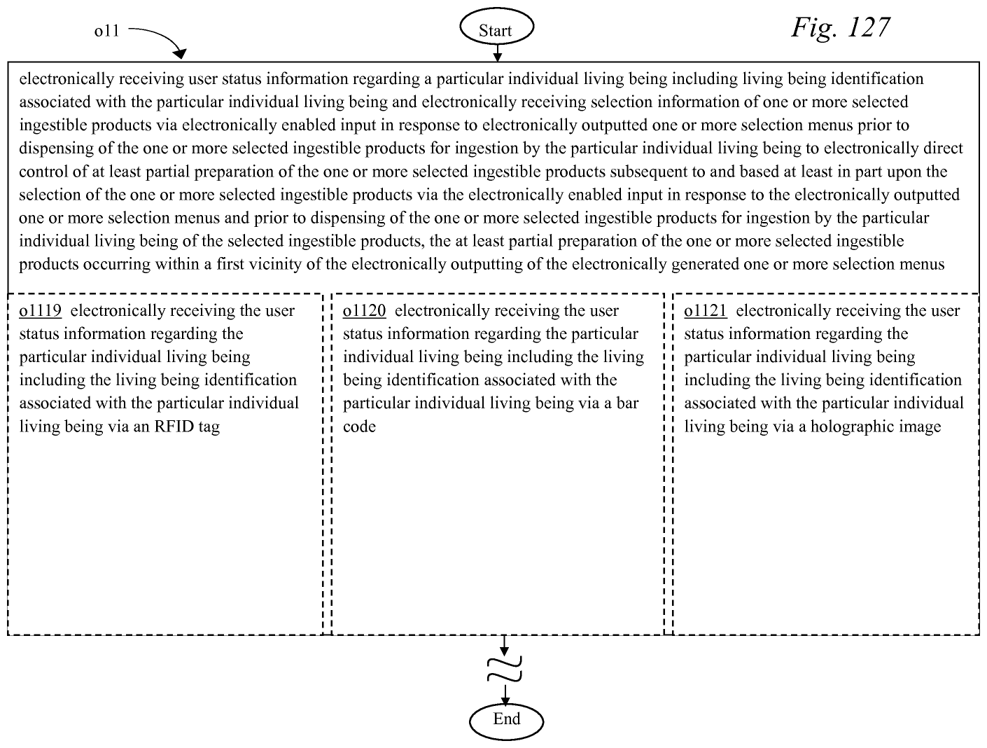

In one or more implementations, as shown in FIG. 127, operation o11 includes an operation o1119 for electronically receiving the user status information regarding the particular individual living being including the living being identification associated with the particular individual living being via an RFID tag. An exemplary version of a non-transitory signal bearing medium of information storage subsystem s200 is depicted as bearing one or more receiving information RFID instructions i1119 that when executed will direct performance of the operation o1119. In an implementation, the one or more receiving information RFID instructions i1119 when executed direct electronically receiving the user status information regarding the particular individual living being including the living being identification associated with the particular individual living being via an RFID tag (e.g. an implementation of the receiver component s528 is configured to electronically engage with the microprocessor component s102 to receive the user status information including the living being identification associated with the particular individual living being as determined by the microprocessor component through electronic reading be the radio frequency identification (RFID) sensing component s414 of the RFID tag, etc.). Furthermore, the receiving information RFID electrical circuitry arrangement e1119 when activated will perform the operation o1119. In an implementation, the receiving information RFID electrical circuitry arrangement e1119, when activated performs electronically receiving the user status information regarding the particular individual living being including the living being identification associated with the particular individual living being via an RFID tag (e.g. an implementation of the receiver component s528 is configured to electronically engage with the microprocessor component s102 to receive the user status information including the living being identification associated with the particular individual living being as determined by the microprocessor component through electronic reading be the radio frequency identification (RFID) sensing component s414 of the RFID tag, etc.). In an implementation, the electronically receiving the user status information regarding the particular individual living being including the living being identification associated with the particular individual living being via an RFID tag is carried out by electronically receiving the user status information regarding the particular individual living being including the living being identification associated with the particular individual living being via an RFID tag (e.g. an implementation of the receiver component s528 is configured to electronically engage with the microprocessor component s102 to receive the user status information including the living being identification associated with the particular individual living being as determined by the microprocessor component through electronic reading be the radio frequency identification (RFID) sensing component s414 of the RFID tag, etc.).

In one or more implementations, operation o11 includes an operation o1120 for electronically receiving the user status information regarding the particular individual living being including the living being identification associated with the particular individual living being via a bar code. An exemplary version of a non-transitory signal bearing medium of information storage subsystem s200 is depicted as bearing one or more receiving information bar code instructions i1120 that when executed will direct performance of the operation o1120. In an implementation, the one or more receiving information bar code instructions i1120 when executed direct electronically receiving the user status information regarding the particular individual living being including the living being identification associated with the particular individual living being via a bar code (e.g. an implementation of the receiver component s528 is configured to electronically engage with the microprocessor component s102 to receive the user status information including the living being identification associated with the particular individual living being as determined by the microprocessor component through electronic reading of the bar code, etc.). Furthermore, the receiving information bar code electrical circuitry arrangement e1120 when activated will perform the operation electronically receiving the user status information regarding the particular individual living being including the living being identification associated with the particular individual living being via a bar code. In an implementation, the receiving information bar code electrical circuitry arrangement e1120, when activated performs electronically receiving the user status information regarding the particular individual living being including the living being identification associated with the particular individual living being via a bar code (e.g. an implementation of the receiver component s528 is configured to electronically engage with the microprocessor component s102 to receive the user status information including the living being identification associated with the particular individual living being as determined by the microprocessor component through electronic reading of the bar code, etc.). In an implementation, the electronically receiving the user status information regarding the particular individual living being including the living being identification associated with the particular individual living being via a bar code is carried out by electronically receiving the user status information regarding the particular individual living being including the living being identification associated with the particular individual living being via a bar code (e.g. an implementation of the receiver component s528 is configured to electronically engage with the microprocessor component s102 to receive the user status information including the living being identification associated with the particular individual living being as determined by the microprocessor component through electronic reading of the bar code, etc.).

In one or more implementations, operation o11 includes an operation o1121 for electronically receiving the user status information regarding the particular individual living being including the living being identification associated with the particular individual living being via a holographic image. An exemplary version of a non-transitory signal bearing medium of information storage subsystem s200 is depicted as bearing one or more receiving information holographic instructions i1121 that when executed will direct performance of the operation o1121. In an implementation, the one or more receiving information holographic instructions i1121 when executed direct electronically receiving the user status information regarding the particular individual living being including the living being identification associated with the particular individual living being via a holographic image (e.g. an implementation of the receiver component s528 is configured to electronically engage with the microprocessor component s102 to receive the user status information including the living being identification associated with the particular individual living being as determined by the microprocessor component through electronic reading of the holographic image, etc.). Furthermore, the receiving information holographic electrical circuitry arrangement e1121 when activated will perform the operation o1121. In an implementation, the receiving information holographic electrical circuitry arrangement e1121, when activated performs electronically receiving the user status information regarding the particular individual living being including the living being identification associated with the particular individual living being via a holographic image (e.g. an implementation of the receiver component s528 is configured to electronically engage with the microprocessor component s102 to receive the user status information including the living being identification associated with the particular individual living being as determined by the microprocessor component through electronic reading of the holographic image, etc.). In an implementation, the electronically receiving the user status information regarding the particular individual living being including the living being identification associated with the particular individual living being via a holographic image is carried out by electronically receiving the user status information regarding the particular individual living being including the living being identification associated with the particular individual living being via a holographic image (e.g. an implementation of the receiver component s528 is configured to electronically engage with the microprocessor component s102 to receive the user status information including the living being identification associated with the particular individual living being as determined by the microprocessor component through electronic reading of the holographic image, etc.).

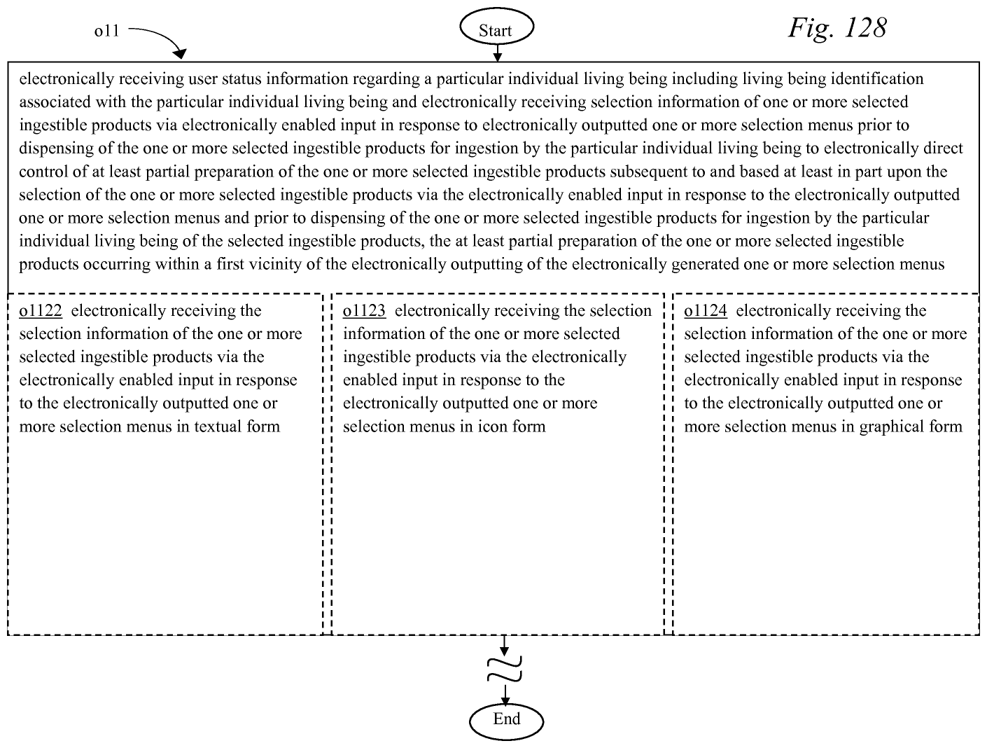

In one or more implementations, as shown in FIG. 128, operation o11 includes an operation o1122 for electronically receiving the selection information of the one or more selected ingestible products via the electronically enabled input in response to the electronically outputted one or more selection menus in textual form. An exemplary version of a non-transitory signal bearing medium of information storage subsystem s200 is depicted as bearing one or more receiving information textual instructions i1122 that when executed will direct performance of the operation o1122. In an implementation, the one or more receiving information textual instructions i1122 when executed direct electronically receiving the user status information regarding the particular individual living being including the living being identification associated with the particular individual living being to at least in part electronically generate, based at least in part upon the user status information regarding the particular individual living being, one or more selection menus in textual form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated allergies, one or more selection menus in textual form, such as a menu containing textual one or more descriptions of possible ingestible product to select from, etc.). Furthermore, the receiving information textual electrical circuitry arrangement e1122 when activated will perform the operation o1122. In an implementation, the receiving information textual electrical circuitry arrangement e1122, when activated performs electronically receiving the user status information regarding the particular individual living being including the living being identification associated with the particular individual living being to at least in part electronically generate, based at least in part upon the user status information regarding the particular individual living being, one or more selection menus in textual form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated allergies, one or more selection menus in textual form, such as a menu containing textual one or more descriptions of possible ingestible product to select from, etc.). In an implementation, the electronically receiving the selection information of the one or more selected ingestible products via the electronically enabled input in response to the electronically outputted one or more selection menus in textual form is carried out by electronically receiving the user status information regarding the particular individual living being including the living being identification associated with the particular individual living being to at least in part electronically generate, based at least in part upon the user status information regarding the particular individual living being, one or more selection menus in textual form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated allergies, one or more selection menus in textual form, such as a menu containing textual one or more descriptions of possible ingestible product to select from, etc.).

In one or more implementations, operation o11 includes an operation o1123 for electronically receiving the selection information of the one or more selected ingestible products via the electronically enabled input in response to the electronically outputted one or more selection menus in icon form. An exemplary version of a non-transitory signal bearing medium of information storage subsystem s200 is depicted as bearing one or more receiving information icon instructions i1123 that when executed will direct performance of the operation o1123. In an implementation, the one or more receiving information icon instructions i1123 when executed direct electronically receiving the user status information regarding the particular individual living being including the living being identification associated with the particular individual living being to at least in part electronically generate, based at least in part upon the user status information regarding the particular individual living being, one or more selection menus in icon form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated previous meals, one or more selection menus in icon form, such as a menu containing iconic one or more descriptions of possible ingestible product to select from, etc.). Furthermore, the receiving information icon electrical circuitry arrangement e1123 when activated will perform the operation o1123. In an implementation, the receiving information icon electrical circuitry arrangement e1123, when activated performs electronically receiving the user status information regarding the particular individual living being including the living being identification associated with the particular individual living being to at least in part electronically generate, based at least in part upon the user status information regarding the particular individual living being, one or more selection menus in icon form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated previous meals, one or more selection menus in icon form, such as a menu containing iconic one or more descriptions of possible ingestible product to select from, etc.). In an implementation, the electronically receiving the selection information of the one or more selected ingestible products via the electronically enabled input in response to the electronically outputted one or more selection menus in icon form is carried out by electronically receiving the user status information regarding the particular individual living being including the living being identification associated with the particular individual living being to at least in part electronically generate, based at least in part upon the user status information regarding the particular individual living being, one or more selection menus in icon form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated previous meals, one or more selection menus in icon form, such as a menu containing iconic one or more descriptions of possible ingestible product to select from, etc.).

In one or more implementations, operation o11 includes an operation o1124 for electronically receiving the selection information of the one or more selected ingestible products via the electronically enabled input in response to the electronically outputted one or more selection menus in graphical form. An exemplary version of a non-transitory signal bearing medium of information storage subsystem s200 is depicted as bearing one or more receiving information graphical instructions i1124 that when executed will direct performance of the operation o1124. In an implementation, the one or more receiving information graphical instructions i1124 when executed direct electronically receiving the user status information regarding the particular individual living being including the living being identification associated with the particular individual living being to at least in part electronically generate, based at least in part upon the user status information regarding the particular individual living being, one or more selection menus in graphical form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated favorite foods as observed and recorded in a database, one or more selection menus in graphical form, such as a menu containing graphical one or more descriptions of possible ingestible product to select from, etc.). Furthermore, the receiving information graphical electrical circuitry arrangement e1124 when activated will perform the operation o1124. In an implementation, the receiving information graphical electrical circuitry arrangement e1124, when activated performs electronically receiving the user status information regarding the particular individual living being including the living being identification associated with the particular individual living being to at least in part electronically generate, based at least in part upon the user status information regarding the particular individual living being, one or more selection menus in graphical form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated favorite foods as observed and recorded in a database, one or more selection menus in graphical form, such as a menu containing graphical one or more descriptions of possible ingestible product to select from, etc.). In an implementation, the electronically receiving the selection information of the one or more selected ingestible products via the electronically enabled input in response to the electronically outputted one or more selection menus in graphical form is carried out by electronically receiving the user status information regarding the particular individual living being including the living being identification associated with the particular individual living being to at least in part electronically generate, based at least in part upon the user status information regarding the particular individual living being, one or more selection menus in graphical form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated favorite foods as observed and recorded in a database, one or more selection menus in graphical form, such as a menu containing graphical one or more descriptions of possible ingestible product to select from, etc.).

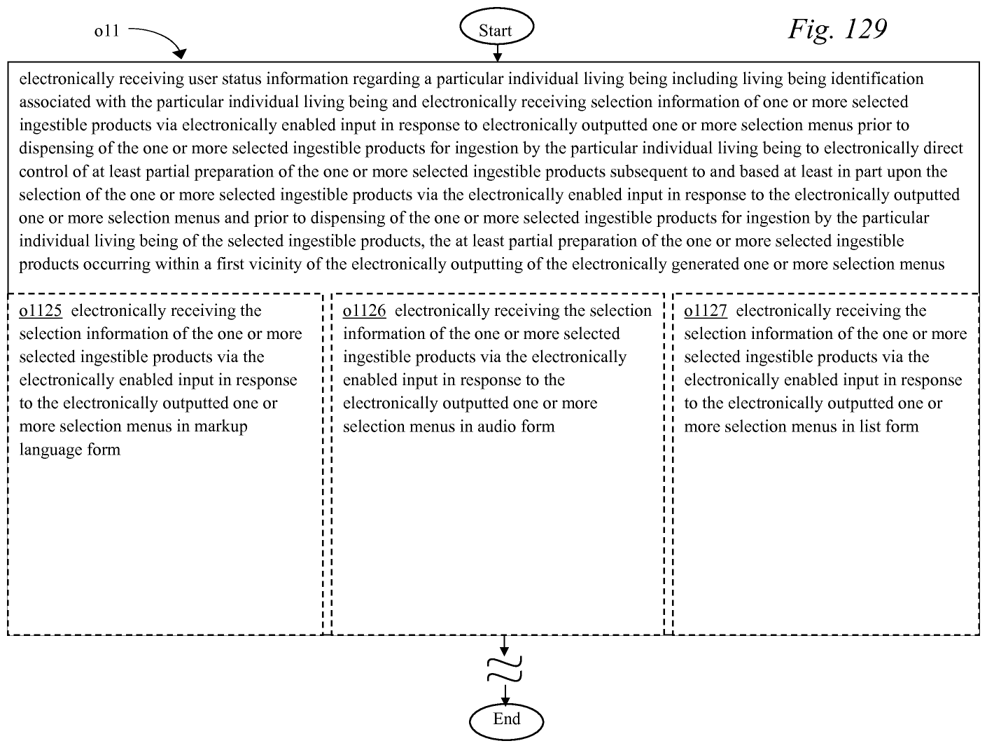

In one or more implementations, as shown in FIG. 129, operation o11 includes an operation o1125 for electronically receiving the selection information of the one or more selected ingestible products via the electronically enabled input in response to the electronically outputted one or more selection menus in markup language form. An exemplary version of a non-transitory signal bearing medium of information storage subsystem s200 is depicted as bearing one or more receiving information markup instructions i1125 that when executed will direct performance of the operation o1125. In an implementation, the one or more receiving information markup instructions i1125 when executed direct electronically receiving the user status information regarding the particular individual living being including the living being identification associated with the particular individual living being to at least in part electronically generate, based at least in part upon the user status information regarding the particular individual living being, one or more selection menus in markup language form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated health building goals, one or more selection menus in markup language form, such as a menu containing markup language one or more descriptions of possible ingestible product to select from, etc.). Furthermore, the receiving information markup electrical circuitry arrangement e1125 when activated will perform the operation o1125. In an implementation, the receiving information markup electrical circuitry arrangement e1125, when activated performs electronically receiving the user status information regarding the particular individual living being including the living being identification associated with the particular individual living being to at least in part electronically generate, based at least in part upon the user status information regarding the particular individual living being, one or more selection menus in markup language form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated health building goals, one or more selection menus in markup language form, such as a menu containing markup language one or more descriptions of possible ingestible product to select from, etc.). In an implementation, the electronically receiving the selection information of the one or more selected ingestible products via the electronically enabled input in response to the electronically outputted one or more selection menus in markup language form is carried out by electronically receiving the user status information regarding the particular individual living being including the living being identification associated with the particular individual living being to at least in part electronically generate, based at least in part upon the user status information regarding the particular individual living being, one or more selection menus in markup language form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated health building goals, one or more selection menus in markup language form, such as a menu containing markup language one or more descriptions of possible ingestible product to select from, etc.).

In one or more implementations, operation o11 includes an operation o1126 for electronically receiving the selection information of the one or more selected ingestible products via the electronically enabled input in response to the electronically outputted one or more selection menus in audio form. An exemplary version of a non-transitory signal bearing medium of information storage subsystem s200 is depicted as bearing one or more receiving information audio instructions i1126 that when executed will direct performance of the operation o1126. In an implementation, the one or more receiving information audio instructions i1126 when executed direct electronically receiving the user status information regarding the particular individual living being including the living being identification associated with the particular individual living being to at least in part electronically generate, based at least in part upon the user status information regarding the particular individual living being, one or more selection menus in audio form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated disease mitigating measures, one or more selection menus in audio form, such as a menu containing audio one or more descriptions of possible ingestible product to select from, etc.). Furthermore, the receiving information audio electrical circuitry arrangement e1126 when activated will perform the operation o1126. In an implementation, the receiving information audio electrical circuitry arrangement e1126, when activated performs electronically receiving the user status information regarding the particular individual living being including the living being identification associated with the particular individual living being to at least in part electronically generate, based at least in part upon the user status information regarding the particular individual living being, one or more selection menus in audio form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated disease mitigating measures, one or more selection menus in audio form, such as a menu containing audio one or more descriptions of possible ingestible product to select from, etc.). In an implementation, the electronically receiving the selection information of the one or more selected ingestible products via the electronically enabled input in response to the electronically outputted one or more selection menus in audio form is carried out by electronically receiving the user status information regarding the particular individual living being including the living being identification associated with the particular individual living being to at least in part electronically generate, based at least in part upon the user status information regarding the particular individual living being, one or more selection menus in audio form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated disease mitigating measures, one or more selection menus in audio form, such as a menu containing audio one or more descriptions of possible ingestible product to select from, etc.).

In one or more implementations, operation o11 includes an operation o1127 for electronically receiving the selection information of the one or more selected ingestible products via the electronically enabled input in response to the electronically outputted one or more selection menus in list form. An exemplary version of a non-transitory signal bearing medium of information storage subsystem s200 is depicted as bearing one or more receiving information list instructions i1127 that when executed will direct performance of the operation o1127. In an implementation, the one or more receiving information list instructions i1127 when executed direct electronically receiving the user status information regarding the particular individual living being including the living being identification associated with the particular individual living being to at least in part electronically generate, based at least in part upon the user status information regarding the particular individual living being, one or more selection menus in list form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated dislikes, one or more selection menus in list form, such as a menu containing listed one or more descriptions of possible ingestible product to select from, etc.)1. Furthermore, the receiving information list electrical circuitry arrangement e1127 when activated will perform the operation o1127. In an implementation, the receiving information list electrical circuitry arrangement e1127, when activated performs electronically receiving the user status information regarding the particular individual living being including the living being identification associated with the particular individual living being to at least in part electronically generate, based at least in part upon the user status information regarding the particular individual living being, one or more selection menus in list form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated dislikes, one or more selection menus in list form, such as a menu containing listed one or more descriptions of possible ingestible product to select from, etc.)1. In an implementation, the electronically receiving the selection information of the one or more selected ingestible products via the electronically enabled input in response to the electronically outputted one or more selection menus in list form is carried out by electronically receiving the user status information regarding the particular individual living being including the living being identification associated with the particular individual living being to at least in part electronically generate, based at least in part upon the user status information regarding the particular individual living being, one or more selection menus in list form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated dislikes, one or more selection menus in list form, such as a menu containing listed one or more descriptions of possible ingestible product to select from, etc.) 1.

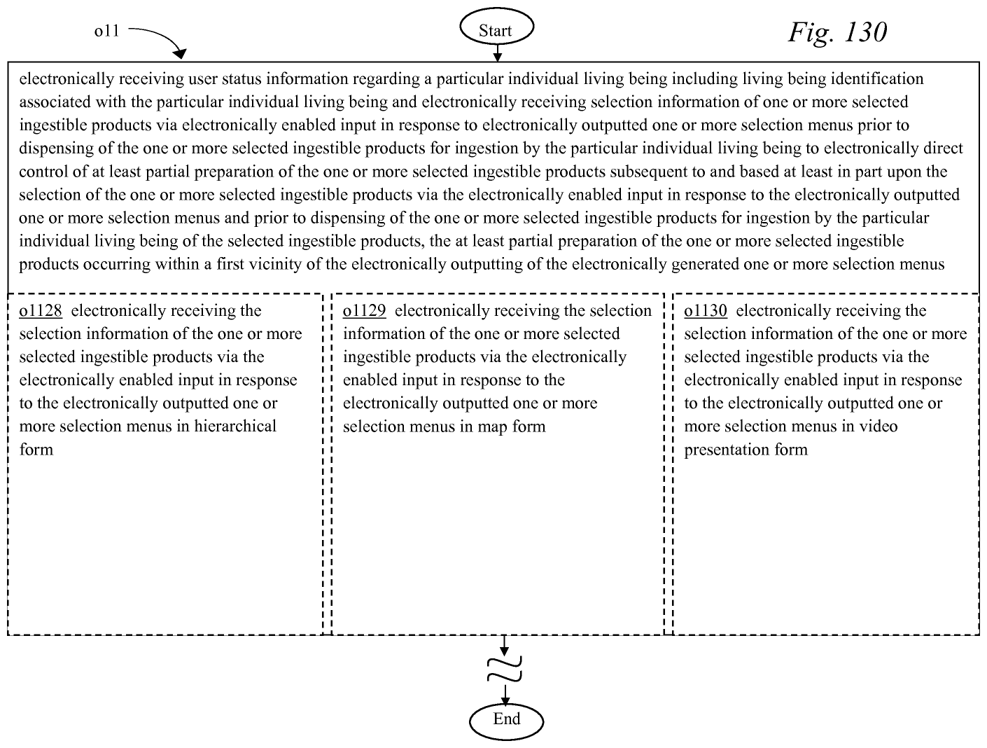

In one or more implementations, as shown in FIG. 130, operation o11 includes an operation o1128 for electronically receiving the selection information of the one or more selected ingestible products via the electronically enabled input in response to the electronically outputted one or more selection menus in hierarchical form. An exemplary version of a non-transitory signal bearing medium of information storage subsystem s200 is depicted as bearing one or more receiving information hierarchical instructions i1128 that when executed will direct performance of the operation o1128. In an implementation, the one or more receiving information hierarchical instructions i1128 when executed direct electronically receiving the user status information regarding the particular individual living being including the living being identification associated with the particular individual living being to at least in part electronically generate, based at least in part upon the user status information regarding the particular individual living being, one or more selection menus in hierarchical form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated past purchases, one or more selection menus in hierarchical form, such as a menu containing hierarchical one or more descriptions of possible ingestible product to select from, etc.). Furthermore, the receiving information hierarchical electrical circuitry arrangement e1128 when activated will perform the operation o1128. In an implementation, the receiving information hierarchical electrical circuitry arrangement e1128, when activated performs electronically receiving the user status information regarding the particular individual living being including the living being identification associated with the particular individual living being to at least in part electronically generate, based at least in part upon the user status information regarding the particular individual living being, one or more selection menus in hierarchical form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated past purchases, one or more selection menus in hierarchical form, such as a menu containing hierarchical one or more descriptions of possible ingestible product to select from, etc.). In an implementation, the electronically receiving the selection information of the one or more selected ingestible products via the electronically enabled input in response to the electronically outputted one or more selection menus in hierarchical form is carried out by electronically receiving the user status information regarding the particular individual living being including the living being identification associated with the particular individual living being to at least in part electronically generate, based at least in part upon the user status information regarding the particular individual living being, one or more selection menus in hierarchical form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated past purchases, one or more selection menus in hierarchical form, such as a menu containing hierarchical one or more descriptions of possible ingestible product to select from, etc.).

In one or more implementations, operation o11 includes an operation o1129 for electronically receiving the selection information of the one or more selected ingestible products via the electronically enabled input in response to the electronically outputted one or more selection menus in map form. An exemplary version of a non-transitory signal bearing medium of information storage subsystem s200 is depicted as bearing one or more receiving information map instructions i1129 that when executed will direct performance of the operation o1129. In an implementation, the one or more receiving information map instructions i1129 when executed direct electronically receiving the user status information regarding the particular individual living being including the living being identification associated with the particular individual living being to at least in part electronically generate, based at least in part upon the user status information regarding the particular individual living being, one or more selection menus in map form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated food preferences determined from use history stored in one or more distributed databases, one or more selection menus in map form, such as a menu having arrangements resembling one or more maps containing one or more selections and one or more descriptions of possible ingestible product to select from, etc.). Furthermore, the receiving information map electrical circuitry arrangement e1129 when activated will perform the operation o1129. In an implementation, the receiving information map electrical circuitry arrangement e1129, when activated performs electronically receiving the user status information regarding the particular individual living being including the living being identification associated with the particular individual living being to at least in part electronically generate, based at least in part upon the user status information regarding the particular individual living being, one or more selection menus in map form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated food preferences determined from use history stored in one or more distributed databases, one or more selection menus in map form, such as a menu having arrangements resembling one or more maps containing one or more selections and one or more descriptions of possible ingestible product to select from, etc.). In an implementation, the electronically receiving the selection information of the one or more selected ingestible products via the electronically enabled input in response to the electronically outputted one or more selection menus in map form is carried out by electronically receiving the user status information regarding the particular individual living being including the living being identification associated with the particular individual living being to at least in part electronically generate, based at least in part upon the user status information regarding the particular individual living being, one or more selection menus in map form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated food preferences determined from use history stored in one or more distributed databases, one or more selection menus in map form, such as a menu having arrangements resembling one or more maps containing one or more selections and one or more descriptions of possible ingestible product to select from, etc.).

In one or more implementations, operation o11 includes an operation o1130 for electronically receiving the selection information of the one or more selected ingestible products via the electronically enabled input in response to the electronically outputted one or more selection menus in video presentation form. An exemplary version of a non-transitory signal bearing medium of information storage subsystem s200 is depicted as bearing one or more receiving information video instructions i1130 that when executed will direct performance of the operation o1130. In an implementation, the one or more receiving information video instructions i1130 when executed direct electronically receiving the user status information regarding the particular individual living being including the living being identification associated with the particular individual living being to at least in part electronically generate, based at least in part upon the user status information regarding the particular individual living being, one or more selection menus in video presentation form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated one or more prescriptions, one or more selection menus in video presentation form, such as a menu containing one or more video presentations having one or more descriptions of possible ingestible product to select from, etc.). Furthermore, the receiving information video electrical circuitry arrangement e1130 when activated will perform the operation o1130. In an implementation, the receiving information video electrical circuitry arrangement e1130, when activated performs electronically receiving the user status information regarding the particular individual living being including the living being identification associated with the particular individual living being to at least in part electronically generate, based at least in part upon the user status information regarding the particular individual living being, one or more selection menus in video presentation form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated one or more prescriptions, one or more selection menus in video presentation form, such as a menu containing one or more video presentations having one or more descriptions of possible ingestible product to select from, etc.). In an implementation, the electronically receiving the selection information of the one or more selected ingestible products via the electronically enabled input in response to the electronically outputted one or more selection menus in video presentation form is carried out by electronically receiving the user status information regarding the particular individual living being including the living being identification associated with the particular individual living being to at least in part electronically generate, based at least in part upon the user status information regarding the particular individual living being, one or more selection menus in video presentation form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated one or more prescriptions, one or more selection menus in video presentation form, such as a menu containing one or more video presentations having one or more descriptions of possible ingestible product to select from, etc.).

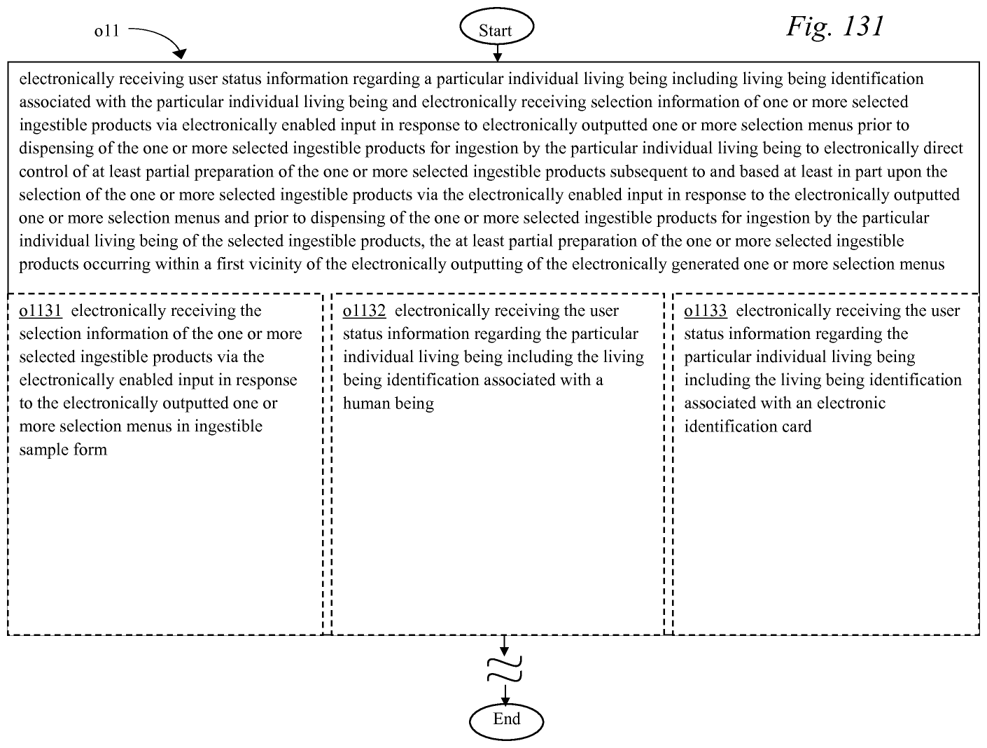

In one or more implementations, as shown in FIG. 131, operation o11 includes an operation o1131 for electronically receiving the selection information of the one or more selected ingestible products via the electronically enabled input in response to the electronically outputted one or more selection menus in ingestible sample form. An exemplary version of a non-transitory signal bearing medium of information storage subsystem s200 is depicted as bearing one or more receiving information sample instructions i1131 that when executed will direct performance of the operation o1131. In an implementation, the one or more receiving information sample instructions i1131 when executed direct electronically receiving the user status information regarding the particular individual living being including the living being identification associated with the particular individual living being to at least in part electronically generate, based at least in part upon the user status information regarding the particular individual living being, one or more selection menus in ingestible sample form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated one or more holidays stored in one or more databases, one or more selection menus in ingestible sample form, such as a menu containing ingestible samples that are either stored or produced in real time to serve as or otherwise complement one or more descriptions of possible ingestible product to select from, etc.). Furthermore, the receiving information sample electrical circuitry arrangement e1131 when activated will perform the operation o1131. In an implementation, the receiving information sample electrical circuitry arrangement e1131, when activated performs electronically receiving the user status information regarding the particular individual living being including the living being identification associated with the particular individual living being to at least in part electronically generate, based at least in part upon the user status information regarding the particular individual living being, one or more selection menus in ingestible sample form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated one or more holidays stored in one or more databases, one or more selection menus in ingestible sample form, such as a menu containing ingestible samples that are either stored or produced in real time to serve as or otherwise complement one or more descriptions of possible ingestible product to select from, etc.). In an implementation, the electronically receiving the selection information of the one or more selected ingestible products via the electronically enabled input in response to the electronically outputted one or more selection menus in ingestible sample form is carried out by electronically receiving the user status information regarding the particular individual living being including the living being identification associated with the particular individual living being to at least in part electronically generate, based at least in part upon the user status information regarding the particular individual living being, one or more selection menus in ingestible sample form (e.g. an implementation of the receiver component s528 is configured to electronically engage with the microprocessor component s102 to receive the user status information including the living being identification associated with the particular individual living being for the microprocessor component to at least in part electronically generate, based at least in part upon the user status information regarding the particular individual living being, such as based on associated one or more holidays stored in one or more databases, one or more selection menus in ingestible sample form, such as a menu containing ingestible samples that are either stored or produced in real time to serve as or otherwise complement one or more descriptions of possible ingestible product to select from, etc.).

In one or more implementations, operation o11 includes an operation o1132 for electronically receiving the user status information regarding the particular individual living being including the living being identification associated with a human being. An exemplary version of a non-transitory signal bearing medium of information storage subsystem s200 is depicted as bearing one or more receiving information human instructions i1132 that when executed will direct performance of the operation o1132. In an implementation, the one or more receiving information human instructions i1132 when executed direct electronically receiving the user status information regarding the particular individual living being including living being identification associated with a human being (e.g. an implementation of the receiver component s528 is configured to electronically engage with the microprocessor component s102 to receive the user status information regarding the particular individual living being including living being identification as determined by the microprocessor component to be identifying a human being, etc.). Furthermore, the receiving information human electrical circuitry arrangement e1132 when activated will perform the operation o1132. In an implementation, the receiving information human electrical circuitry arrangement e1132, when activated performs electronically receiving the user status information regarding the particular individual living being including living being identification associated with a human being (e.g. an implementation of the receiver component s528 is configured to electronically engage with the microprocessor component s102 to receive the user status information regarding the particular individual living being including living being identification as determined by the microprocessor component to be identifying a human being, etc.). In an implementation, the electronically receiving the user status information regarding the particular individual living being including the living being identification associated with a human being is carried out by electronically receiving the user status information regarding the particular individual living being including living being identification associated with a human being (e.g. an implementation of the receiver component s528 is configured to electronically engage with the microprocessor component s102 to receive the user status information regarding the particular individual living being including living being identification as determined by the microprocessor component to be identifying a human being, etc.).

In one or more implementations, operation o11 includes an operation o1133 for electronically receiving the user status information regarding the particular individual living being including the living being identification associated with an electronic identification card. An exemplary version of a non-transitory signal bearing medium of information storage subsystem s200 is depicted as bearing one or more receiving information ID card instructions i1133 that when executed will direct performance of the operation o1133. In an implementation, the one or more receiving information ID card instructions i1133 when executed direct electronically receiving the user status information regarding the particular individual living being including living being identification associated with an electronic identification card (e.g. an implementation of the receiver component s528 is configured to electronically engage with the microprocessor component s102 to receive the user status information regarding the particular individual living being including living being identification as determined by the microprocessor component to be identifying a living being through the electronic identification card, etc.). Furthermore, the receiving information ID card electrical circuitry arrangement e1133 when activated will perform the operation o1133. In an implementation, the receiving information ID card electrical circuitry arrangement e1133, when activated performs electronically receiving the user status information regarding the particular individual living being including living being identification associated with an electronic identification card (e.g. an implementation of the receiver component s528 is configured to electronically engage with the microprocessor component s102 to receive the user status information regarding the particular individual living being including living being identification as determined by the microprocessor component to be identifying a living being through the electronic identification card, etc.). In an implementation, the electronically receiving the user status information regarding the particular individual living being including the living being identification associated with an electronic identification card is carried out by electronically receiving the user status information regarding the particular individual living being including living being identification associated with an electronic identification card (e.g. an implementation of the receiver component s528 is configured to electronically engage with the microprocessor component s102 to receive the user status information regarding the particular individual living being including living being identification as determined by the microprocessor component to be identifying a living being through the electronic identification card, etc.).

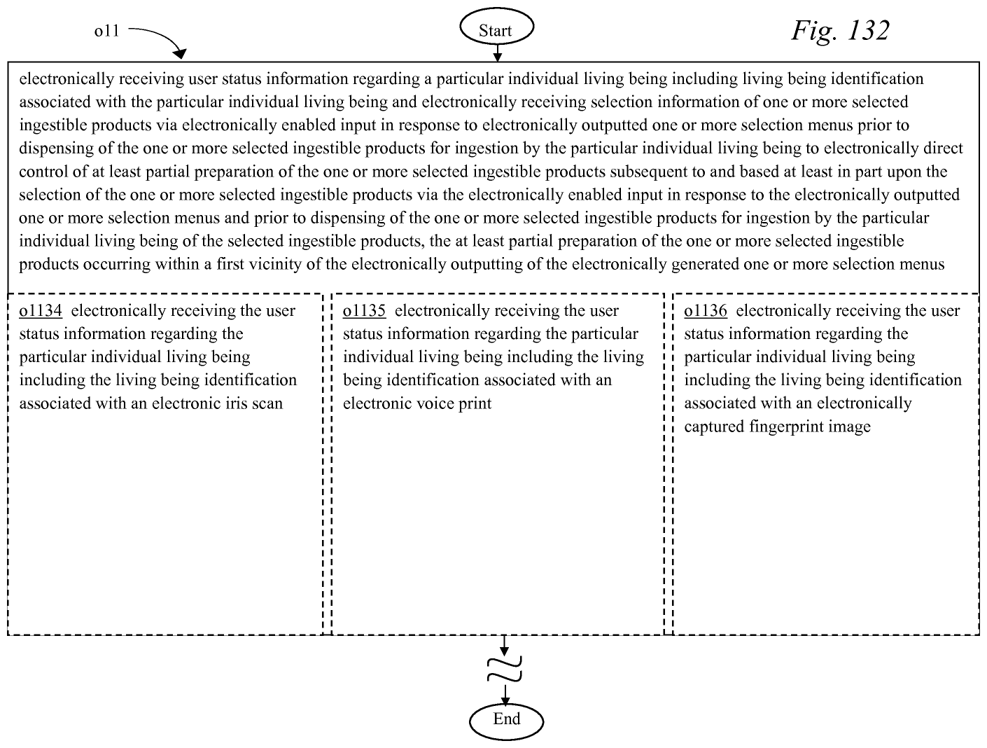

In one or more implementations, as shown in FIG. 132, operation o11 includes an operation o1134 for electronically receiving the user status information regarding the particular individual living being including the living being identification associated with an electronic iris scan. An exemplary version of a non-transitory signal bearing medium of information storage subsystem s200 is depicted as bearing one or more receiving information iris scan instructions i1134 that when executed will direct performance of the operation o1134. In an implementation, the one or more receiving information iris scan instructions i1134 when executed direct electronically receiving the user status information regarding the particular individual living being including living being identification associated with an electronic iris scan (e.g. an implementation of the receiver component s528 is configured to electronically engage with the microprocessor component s102 to receive the user status information regarding the particular individual living being including living being identification as determined by the microprocessor component to be identifying the living being through the electronic iris scan, etc.). Furthermore, the receiving information iris scan electrical circuitry arrangement e1134 when activated will perform the operation o1134. In an implementation, the receiving information iris scan electrical circuitry arrangement e1134, when activated performs electronically receiving the user status information regarding the particular individual living being including living being identification associated with an electronic iris scan (e.g. an implementation of the receiver component s528 is configured to electronically engage with the microprocessor component s102 to receive the user status information regarding the particular individual living being including living being identification as determined by the microprocessor component to be identifying the living being through the electronic iris scan, etc.). In an implementation, the electronically receiving the user status information regarding the particular individual living being including the living being identification associated with an electronic iris scan is carried out by electronically receiving the user status information regarding the particular individual living being including living being identification associated with an electronic iris scan (e.g. an implementation of the receiver component s528 is configured to electronically engage with the microprocessor component s102 to receive the user status information regarding the particular individual living being including living being identification as determined by the microprocessor component to be identifying the living being through the electronic iris scan, etc.).

In one or more implementations, operation o11 includes an operation o1135 for electronically receiving the user status information regarding the particular individual living being including the living being identification associated with an electronic voice print. An exemplary version of a non-transitory signal bearing medium of information storage subsystem s200 is depicted as bearing one or more receiving information voice instructions i1135 that when executed will direct performance of the operation o1135. In an implementation, the one or more receiving information voice instructions i1135 when executed direct electronically receiving the user status information regarding the particular individual living being including living being identification associated with an electronic voice print (e.g. an implementation of the receiver component s528 is configured to electronically engage with the microprocessor component s102 to receive the user status information regarding the particular individual living being including living being identification as determined by the microprocessor component to be identifying the living being through the electronic voice print, etc.). Furthermore, the receiving information voice electrical circuitry arrangement e1135 when activated will perform the operation o1135. In an implementation, the receiving information voice electrical circuitry arrangement e1135, when activated performs electronically receiving the user status information regarding the particular individual living being including living being identification associated with an electronic voice print (e.g. an implementation of the receiver component s528 is configured to electronically engage with the microprocessor component s102 to receive the user status information regarding the particular individual living being including living being identification as determined by the microprocessor component to be identifying the living being through the electronic voice print, etc.). In an implementation, the electronically receiving the user status information regarding the particular individual living being including the living being identification associated with an electronic voice print is carried out by electronically receiving the user status information regarding the particular individual living being including living being identification associated with an electronic voice print (e.g. an implementation of the receiver component s528 is configured to electronically engage with the microprocessor component s102 to receive the user status information regarding the particular individual living being including living being identification as determined by the microprocessor component to be identifying the living being through the electronic voice print, etc.).

In one or more implementations, operation o11 includes an operation o1136 for electronically receiving the user status information regarding the particular individual living being including the living being identification associated with an electronically captured fingerprint image. An exemplary version of a non-transitory signal bearing medium of information storage subsystem s200 is depicted as bearing one or more receiving information fingerprint instructions i1136 that when executed will direct performance of the operation o1136. In an implementation, the one or more receiving information fingerprint instructions i1136 when executed direct electronically receiving the user status information regarding the particular individual living being including living being identification associated with an electronically captured fingerprint image (e.g. an implementation of the receiver component s528 is configured to electronically engage with the microprocessor component s102 to receive the user status information regarding the particular individual living being including living being identification as determined by the microprocessor component to be identifying the living being through the electronically captured fingerprint image, etc.). Furthermore, the receiving information fingerprint electrical circuitry arrangement e1136 when activated will perform the operation o1136. In an implementation, the receiving information fingerprint electrical circuitry arrangement e1136, when activated performs electronically receiving the user status information regarding the particular individual living being including living being identification associated with an electronically captured fingerprint image (e.g. an implementation of the receiver component s528 is configured to electronically engage with the microprocessor component s102 to receive the user status information regarding the particular individual living being including living being identification as determined by the microprocessor component to be identifying the living being through the electronically captured fingerprint image, etc.). In an implementation, the electronically receiving the user status information regarding the particular individual living being including the living being identification associated with an electronically captured fingerprint image is carried out by electronically receiving the user status information regarding the particular individual living being including living being identification associated with an electronically captured fingerprint image (e.g. an implementation of the receiver component s528 is configured to electronically engage with the microprocessor component s102 to receive the user status information regarding the particular individual living being including living being identification as determined by the microprocessor component to be identifying the living being through the electronically captured fingerprint image, etc.).

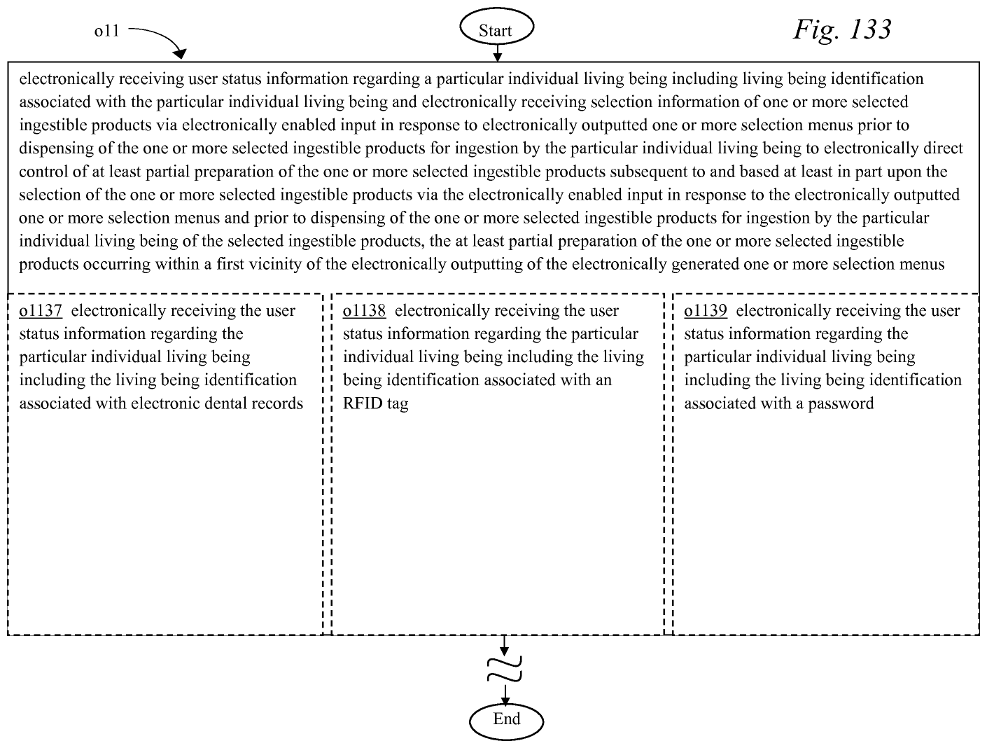

In one or more implementations, as shown in FIG. 133, operation o11 includes an operation o1137 for electronically receiving the user status information regarding the particular individual living being including the living being identification associated with electronic dental records. An exemplary version of a non-transitory signal bearing medium of information storage subsystem s200 is depicted as bearing one or more receiving information dental instructions i1137 that when executed will direct performance of the operation o1137. In an implementation, the one or more receiving information dental instructions i1137 when executed direct electronically receiving the user status information regarding the particular individual living being including living being identification associated with electronic dental records (e.g. an implementation of the receiver component s528 is configured to electronically engage with the microprocessor component s102 to receive the user status information regarding the particular individual living being including living being identification as determined by the microprocessor component to be identifying the living being through the electronic dental records, etc.). Furthermore, the receiving information dental electrical circuitry arrangement e1137 when activated will perform the operation o1137. In an implementation, the receiving information dental electrical circuitry arrangement e1137, when activated performs electronically receiving the user status information regarding the particular individual living being including living being identification associated with electronic dental records (e.g. an implementation of the receiver component s528 is configured to electronically engage with the microprocessor component s102 to receive the user status information regarding the particular individual living being including living being identification as determined by the microprocessor component to be identifying the living being through the electronic dental records, etc.). In an implementation, the electronically receiving the user status information regarding the particular individual living being including the living being identification associated with electronic dental records is carried out by electronically receiving the user status information regarding the particular individual living being including living being identification associated with electronic dental records (e.g. an implementation of the receiver component s528 is configured to electronically engage with the microprocessor component s102 to receive the user status information regarding the particular individual living being including living being identification as determined by the microprocessor component to be identifying the living being through the electronic dental records, etc.).

In one or more implementations, operation o11 includes an operation o1138 for electronically receiving the user status information regarding the particular individual living being including the living being identification associated with an RFID tag. An exemplary version of a non-transitory signal bearing medium of information storage subsystem s200 is depicted as bearing one or more receiving information RFID instructions i1138 that when executed will direct performance of the operation o1138. In an implementation, the one or more receiving information RFID instructions i1138 when executed direct electronically receiving the user status information regarding the particular individual living being including living being identification associated with an RFID tag (e.g. an implementation of the receiver component s528 is configured to electronically engage with the microprocessor component s102 to receive the user status information regarding the particular individual living being including living being identification as determined by the microprocessor component to be identifying the living being through the RFID tag, etc.). Furthermore, the receiving information RFID electrical circuitry arrangement e1138 when activated will perform the operation o1138. In an implementation, the receiving information RFID electrical circuitry arrangement e1138, when activated performs electronically receiving the user status information regarding the particular individual living being including living being identification associated with an RFID tag (e.g. an implementation of the receiver component s528 is configured to electronically engage with the microprocessor component s102 to receive the user status information regarding the particular individual living being including living being identification as determined by the microprocessor component to be identifying the living being through the RFID tag, etc.). In an implementation, the electronically receiving the user status information regarding the particular individual living being including the living being identification associated with an RFID tag is carried out by electronically receiving the user status information regarding the particular individual living being including living being identification associated with an RFID tag (e.g. an implementation of the receiver component s528 is configured to electronically engage with the microprocessor component s102 to receive the user status information regarding the particular individual living being including living being identification as determined by the microprocessor component to be identifying the living being through the RFID tag, etc.).

In one or more implementations, operation o11 includes an operation o1139 for electronically receiving the user status information regarding the particular individual living being including the living being identification associated with a password. An exemplary version of a non-transitory signal bearing medium of information storage subsystem s200 is depicted as bearing one or more receiving information password instructions i1139 that when executed will direct performance of the operation o1139. In an implementation, the one or more receiving information password instructions i1139 when executed direct electronically receiving the user status information regarding the particular individual living being including living being identification associated with a password (e.g. an implementation of the receiver component s528 is configured to electronically engage with the microprocessor component s102 to receive the user status information regarding the particular individual living being including living being identification as determined by the microprocessor component to be identifying the living being through the password, etc.). Furthermore, the receiving information password electrical circuitry arrangement e1139 when activated will perform the operation o1139. In an implementation, the receiving information password electrical circuitry arrangement e1139, when activated performs electronically receiving the user status information regarding the particular individual living being including living being identification associated with a password (e.g. an implementation of the receiver component s528 is configured to electronically engage with the microprocessor component s102 to receive the user status information regarding the particular individual living being including living being identification as determined by the microprocessor component to be identifying the living being through the password, etc.). In an implementation, the electronically receiving the user status information regarding the particular individual living being including the living being identification associated with a password is carried out by electronically receiving the user status information regarding the particular individual living being including living being identification associated with a password (e.g. an implementation of the receiver component s528 is configured to electronically engage with the microprocessor component s102 to receive the user status information regarding the particular individual living being including living being identification as determined by the microprocessor component to be identifying the living being through the password, etc.).

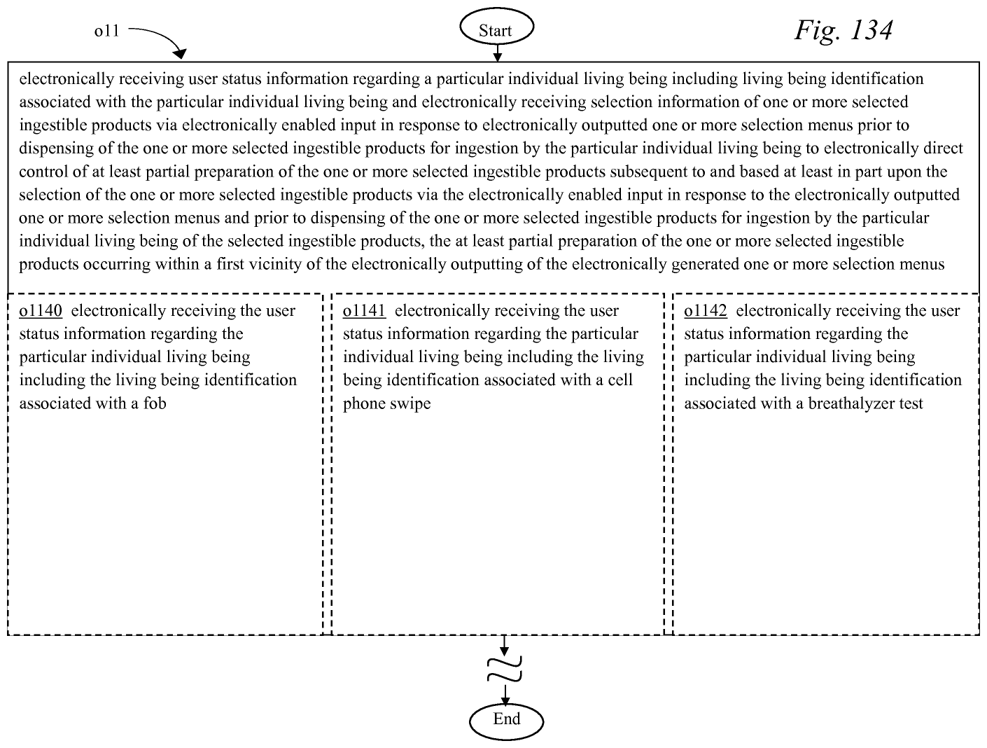

In one or more implementations, as shown in FIG. 134, operation o11 includes an operation o1140 for electronically receiving the user status information regarding the particular individual living being including the living being identification associated with a fob. An exemplary version of a non-transitory signal bearing medium of information storage subsystem s200 is depicted as bearing one or more receiving information fob instructions i1140 that when executed will direct performance of the operation o1140. In an implementation, the one or more receiving information fob instructions i1140 when executed direct electronically receiving the user status information regarding the particular individual living being including living being identification associated with a fob (e.g. an implementation of the receiver component s528 is configured to electronically engage with the microprocessor component s102 to receive the user status information regarding the particular individual living being including living being identification as determined by the microprocessor component to be identifying the living being through electronic data contained on the fob, etc.). Furthermore, the receiving information fob electrical circuitry arrangement e1140 when activated will perform the operation o1140. In an implementation, the receiving information fob electrical circuitry arrangement e1140, when activated performs electronically receiving the user status information regarding the particular individual living being including living being identification associated with a fob (e.g. an implementation of the receiver component s528 is configured to electronically engage with the microprocessor component s102 to receive the user status information regarding the particular individual living being including living being identification as determined by the microprocessor component to be identifying the living being through electronic data contained on the fob, etc.). In an implementation, the electronically receiving the user status information regarding the particular individual living being including the living being identification associated with a fob is carried out by electronically receiving the user status information regarding the particular individual living being including living being identification associated with a fob (e.g. an implementation of the receiver component s528 is configured to electronically engage with the microprocessor component s102 to receive the user status information regarding the particular individual living being including living being identification as determined by the microprocessor component to be identifying the living being through electronic data contained on the fob, etc.).

In one or more implementations, operation o11 includes an operation o1141 for electronically receiving the user status information regarding the particular individual living being including the living being identification associated with a cell phone swipe. An exemplary version of a non-transitory signal bearing medium of information storage subsystem s200 is depicted as bearing one or more receiving information cell phone instructions i1141 that when executed will direct performance of the operation o1141. In an implementation, the one or more receiving information cell phone instructions i1141 when executed direct electronically receiving the user status information regarding the particular individual living being including living being identification associated with a cell phone swipe (e.g. an implementation of the receiver component s528 is configured to electronically engage with the microprocessor component s102 to receive the user status information regarding the particular individual living being including living being identification as determined by the microprocessor component to be identifying the living being through passing the cell phone in close proximity to the cell phone, etc.). Furthermore, the receiving information cell phone electrical circuitry arrangement e1141 when activated will perform the operation o1141. In an implementation, the receiving information cell phone electrical circuitry arrangement e1141, when activated performs electronically receiving the user status information regarding the particular individual living being including living being identification associated with a cell phone swipe (e.g. an implementation of the receiver component s528 is configured to electronically engage with the microprocessor component s102 to receive the user status information regarding the particular individual living being including living being identification as determined by the microprocessor component to be identifying the living being through passing the cell phone in close proximity to the cell phone, etc.). In an implementation, the electronically receiving the user status information regarding the particular individual living being including the living being identification associated with a cell phone swipe is carried out by electronically receiving the user status information regarding the particular individual living being including living being identification associated with a cell phone swipe (e.g. an implementation of the receiver component s528 is configured to electronically engage with the microprocessor component s102 to receive the user status information regarding the particular individual living being including living being identification as determined by the microprocessor component to be identifying the living being through passing the cell phone in close proximity to the cell phone, etc.).

In one or more implementations, operation o11 includes an operation o1142 for electronically receiving the user status information regarding the particular individual living being including the living being identification associated with a breathalyzer test. An exemplary version of a non-transitory signal bearing medium of information storage subsystem s200 is depicted as bearing one or more receiving information breathalyzer instructions i1142 that when executed will direct performance of the operation o1142. In an implementation, the one or more receiving information breathalyzer instructions i1142 when executed direct electronically receiving the user status information regarding the particular individual living being including living being identification associated with a breathalyzer test (e.g. an implementation of the receiver component s528 is configured to electronically engage with the microprocessor component s102 to receive the user status information regarding the particular individual living being including living being identification as determined by the microprocessor component to be identifying the living being through the breathalyzer test of the living being, etc.). Furthermore, the receiving information breathalyzer electrical circuitry arrangement e1142 when activated will perform the operation o1142. In an implementation, the receiving information breathalyzer electrical circuitry arrangement e1142, when activated performs electronically receiving the user status information regarding the particular individual living being including living being identification associated with a breathalyzer test (e.g. an implementation of the receiver component s528 is configured to electronically engage with the microprocessor component s102 to receive the user status information regarding the particular individual living being including living being identification as determined by the microprocessor component to be identifying the living being through the breathalyzer test of the living being, etc.). In an implementation, the electronically receiving the user status information regarding the particular individual living being including the living being identification associated with a breathalyzer test is carried out by electronically receiving the user status information regarding the particular individual living being including living being identification associated with a breathalyzer test (e.g. an implementation of the receiver component s528 is configured to electronically engage with the microprocessor component s102 to receive the user status information regarding the particular individual living being including living being identification as determined by the microprocessor component to be identifying the living being through the breathalyzer test of the living being, etc.).

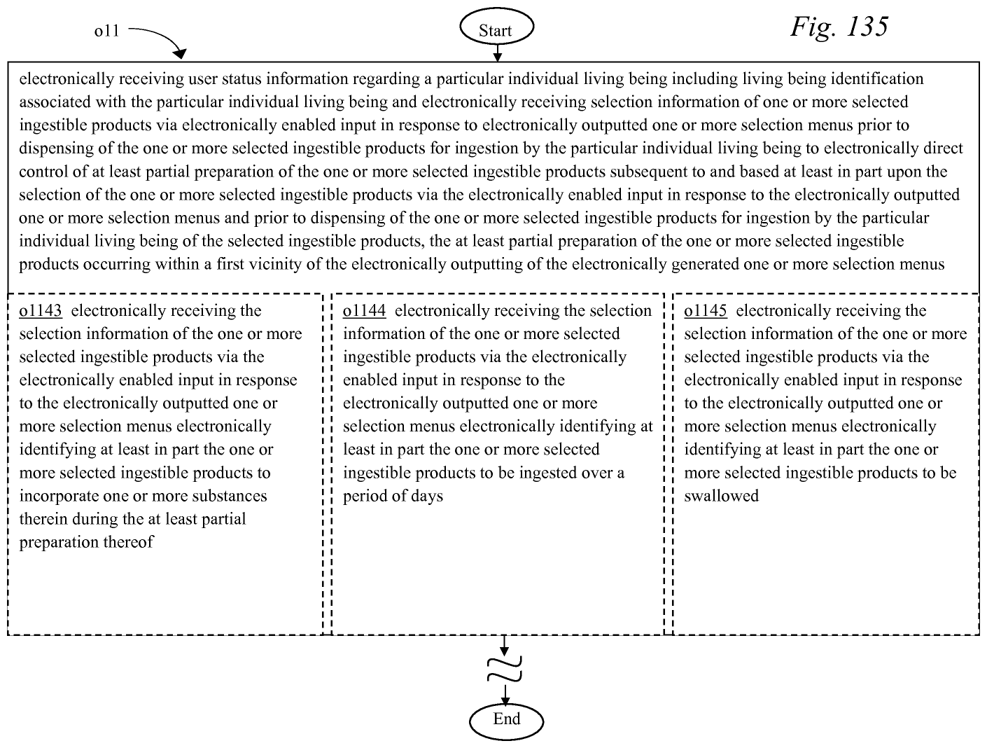

In one or more implementations, as shown in FIG. 135, operation o11 includes an operation o1143 for electronically receiving the selection information of the one or more selected ingestible products via the electronically enabled input in response to the electronically outputted one or more selection menus electronically identifying at least in part the one or more selected ingestible products to incorporate one or more substances therein during the at least partial preparation thereof. An exemplary version of a non-transitory signal bearing medium of information storage subsystem s200 is depicted as bearing one or more receiving information incorporate instructions i1143 that when executed will direct performance of the operation o1143. In an implementation, the one or more receiving information incorporate instructions i1143 when executed direct electronically receiving the selection information of the one or more selected ingestible products via the electronically enabled input in response to the electronically outputted one or more selection menus electronically identifying at least in part the one or more selected ingestible products to incorporate one or more substances therein during the at least partial preparation thereof (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to incorporate one or more substances therein during the at least partial preparation thereof such as a sandwich to include the substance as an amino acid incorporated into the sandwich, etc.). Furthermore, the receiving information incorporate electrical circuitry arrangement e1143 when activated will perform the operation o1143. In an implementation, the receiving information incorporate electrical circuitry arrangement e1143, when activated performs electronically receiving the selection information of the one or more selected ingestible products via the electronically enabled input in response to the electronically outputted one or more selection menus electronically identifying at least in part the one or more selected ingestible products to incorporate one or more substances therein during the at least partial preparation thereof (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to incorporate one or more substances therein during the at least partial preparation thereof such as a sandwich to include the substance as an amino acid incorporated into the sandwich, etc.). In an implementation, the electronically receiving the selection information of the one or more selected ingestible products via the electronically enabled input in response to the electronically outputted one or more selection menus electronically identifying at least in part the one or more selected ingestible products to incorporate one or more substances therein during the at least partial preparation thereof is carried out by electronically receiving the selection information of the one or more selected ingestible products via the electronically enabled input in response to the electronically outputted one or more selection menus electronically identifying at least in part the one or more selected ingestible products to incorporate one or more substances therein during the at least partial preparation thereof (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to incorporate one or more substances therein during the at least partial preparation thereof such as a sandwich to include the substance as an amino acid incorporated into the sandwich, etc.).

In one or more implementations, operation o11 includes an operation o1144 for electronically receiving the selection information of the one or more selected ingestible products via the electronically enabled input in response to the electronically outputted one or more selection menus electronically identifying at least in part the one or more selected ingestible products to be ingested over a period of days. An exemplary version of a non-transitory signal bearing medium of information storage subsystem s200 is depicted as bearing one or more receiving information days instructions i1144 that when executed will direct performance of the operation o1144. In an implementation, the one or more receiving information days instructions i1144 when executed direct electronically receiving the selection information of the one or more selected ingestible products via the electronically enabled input in response to the electronically outputted one or more selection menus electronically identifying at least in part the one or more selected ingestible products to be ingested over a period of days (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be ingested over a period of days such as a smoothie to contain an activator that is designed to interact with a substance, such as a pharmaceutical agent that is encapsulated in pill form to be ingested over a period of days by a living being, such as a boy, at the same time that the smoothie is being ingested by the boy, etc.). Furthermore, the receiving information days electrical circuitry arrangement e1144 when activated will perform the operation o1144. In an implementation, the receiving information days electrical circuitry arrangement e1144, when activated performs electronically receiving the selection information of the one or more selected ingestible products via the electronically enabled input in response to the electronically outputted one or more selection menus electronically identifying at least in part the one or more selected ingestible products to be ingested over a period of days (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be ingested over a period of days such as a smoothie to contain an activator that is designed to interact with a substance, such as a pharmaceutical agent that is encapsulated in pill form to be ingested over a period of days by a living being, such as a boy, at the same time that the smoothie is being ingested by the boy, etc.). In an implementation, the electronically receiving the selection information of the one or more selected ingestible products via the electronically enabled input in response to the electronically outputted one or more selection menus electronically identifying at least in part the one or more selected ingestible products to be ingested over a period of days is carried out by electronically receiving the selection information of the one or more selected ingestible products via the electronically enabled input in response to the electronically outputted one or more selection menus electronically identifying at least in part the one or more selected ingestible products to be ingested over a period of days (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be ingested over a period of days such as a smoothie to contain an activator that is designed to interact with a substance, such as a pharmaceutical agent that is encapsulated in pill form to be ingested over a period of days by a living being, such as a boy, at the same time that the smoothie is being ingested by the boy, etc.).

In one or more implementations, operation o11 includes an operation o1145 for electronically receiving the selection information of the one or more selected ingestible products via the electronically enabled input in response to the electronically outputted one or more selection menus electronically identifying at least in part the one or more selected ingestible products to be swallowed. An exemplary version of a non-transitory signal bearing medium of information storage subsystem s200 is depicted as bearing one or more receiving information swallow instructions i1145 that when executed will direct performance of the operation o1145. In an implementation, the one or more receiving information swallow instructions i1145 when executed direct electronically receiving the selection information of the one or more selected ingestible products via the electronically enabled input in response to the electronically outputted one or more selection menus electronically identifying at least in part the one or more selected ingestible products to be swallowed

(e.g., an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be swallowed such as a snack bar, etc.). Furthermore, the receiving information swallow electrical circuitry arrangement e1145 when activated will perform the operation o1145. In an implementation, the receiving information swallow electrical circuitry arrangement e1145, when activated performs electronically receiving the selection information of the one or more selected ingestible products via the electronically enabled input in response to the electronically outputted one or more selection menus electronically identifying at least in part the one or more selected ingestible products to be swallowed

(e.g., an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be swallowed such as a snack bar, etc.). In an implementation, the electronically receiving the selection information of the one or more selected ingestible products via the electronically enabled input in response to the electronically outputted one or more selection menus electronically identifying at least in part the one or more selected ingestible products to be swallowed is carried out by electronically receiving the selection information of the one or more selected ingestible products via the electronically enabled input in response to the electronically outputted one or more selection menus electronically identifying at least in part the one or more selected ingestible products to be swallowed

(e.g., an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be swallowed such as a snack bar, etc.).

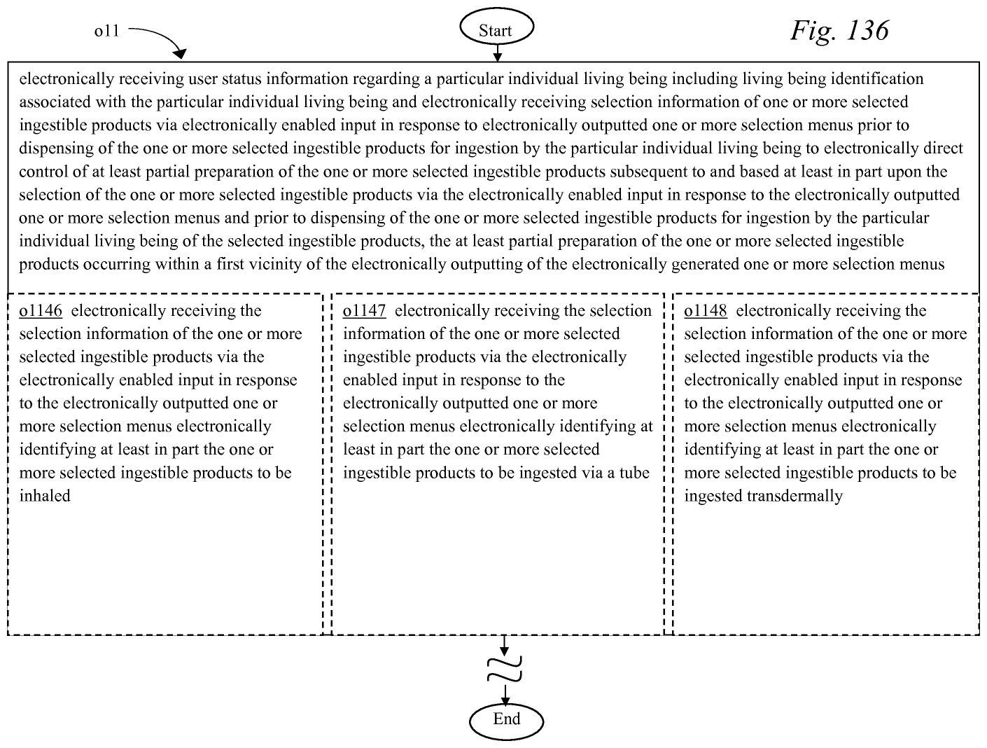

In one or more implementations, as shown in FIG. 136, operation o11 includes an operation o1146 for electronically receiving the selection information of the one or more selected ingestible products via the electronically enabled input in response to the electronically outputted one or more selection menus electronically identifying at least in part the one or more selected ingestible products to be inhaled. An exemplary version of a non-transitory signal bearing medium of information storage subsystem s200 is depicted as bearing one or more receiving information inhaled instructions i1146 that when executed will direct performance of the operation o1146. In an implementation, the one or more receiving information inhaled instructions i1146 when executed direct electronically receiving the selection information of the one or more selected ingestible products via the electronically enabled input in response to the electronically outputted one or more selection menus electronically identifying at least in part the one or more selected ingestible products to be inhaled (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be inhaled such as a medicament dispensed through a nebulizer, etc.). Furthermore, the receiving information inhaled electrical circuitry arrangement e1146 when activated will perform the operation o1146. In an implementation, the receiving information inhaled electrical circuitry arrangement e1146, when activated performs electronically receiving the selection information of the one or more selected ingestible products via the electronically enabled input in response to the electronically outputted one or more selection menus electronically identifying at least in part the one or more selected ingestible products to be inhaled (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be inhaled such as a medicament dispensed through a nebulizer, etc.). In an implementation, the electronically receiving the selection information of the one or more selected ingestible products via the electronically enabled input in response to the electronically outputted one or more selection menus electronically identifying at least in part the one or more selected ingestible products to be inhaled is carried out by electronically receiving the selection information of the one or more selected ingestible products via the electronically enabled input in response to the electronically outputted one or more selection menus electronically identifying at least in part the one or more selected ingestible products to be inhaled (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be inhaled such as a medicament dispensed through a nebulizer, etc.).

In one or more implementations, operation o11 includes an operation o1147 for electronically receiving the selection information of the one or more selected ingestible products via the electronically enabled input in response to the electronically outputted one or more selection menus electronically identifying at least in part the one or more selected ingestible products to be ingested via a tube. An exemplary version of a non-transitory signal bearing medium of information storage subsystem s200 is depicted as bearing one or more receiving information tube instructions i1147 that when executed will direct performance of the operation o1147. In an implementation, the one or more receiving information tube instructions i1147 when executed direct electronically receiving the selection information of the one or more selected ingestible products via the electronically enabled input in response to the electronically outputted one or more selection menus electronically identifying at least in part the one or more selected ingestible products to be ingested via a tube (e.g., an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be ingested via a tube such as a liquid meal replacement, etc.). Furthermore, the receiving information tube electrical circuitry arrangement e1147 when activated will perform the operation o1147. In an implementation, the receiving information tube electrical circuitry arrangement e1147, when activated performs electronically receiving the selection information of the one or more selected ingestible products via the electronically enabled input in response to the electronically outputted one or more selection menus electronically identifying at least in part the one or more selected ingestible products to be ingested via a tube (e.g., an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be ingested via a tube such as a liquid meal replacement, etc.). In an implementation, the electronically receiving the selection information of the one or more selected ingestible products via the electronically enabled input in response to the electronically outputted one or more selection menus electronically identifying at least in part the one or more selected ingestible products to be ingested via a tube is carried out by electronically receiving the selection information of the one or more selected ingestible products via the electronically enabled input in response to the electronically outputted one or more selection menus electronically identifying at least in part the one or more selected ingestible products to be ingested via a tube (e.g., an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be ingested via a tube such as a liquid meal replacement, etc.).

In one or more implementations, operation o11 includes an operation o1148 for electronically receiving the selection information of the one or more selected ingestible products via the electronically enabled input in response to the electronically outputted one or more selection menus electronically identifying at least in part the one or more selected ingestible products to be ingested transdermally. An exemplary version of a non-transitory signal bearing medium of information storage subsystem s200 is depicted as bearing one or more receiving information transdermal instructions i1148 that when executed will direct performance of the operation o1148. In an implementation, the one or more receiving information transdermal instructions i1148 when executed direct electronically receiving the selection information of the one or more selected ingestible products via the electronically enabled input in response to the electronically outputted one or more selection menus electronically identifying at least in part the one or more selected ingestible products to be ingested transdermally (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be ingested transdermally such as a cream, etc.). Furthermore, the receiving information transdermal electrical circuitry arrangement e1148 when activated will perform the operation o1148. In an implementation, the receiving information transdermal electrical circuitry arrangement e1148, when activated performs electronically receiving the selection information of the one or more selected ingestible products via the electronically enabled input in response to the electronically outputted one or more selection menus electronically identifying at least in part the one or more selected ingestible products to be ingested transdermally (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be ingested transdermally such as a cream, etc.). In an implementation, the electronically receiving the selection information of the one or more selected ingestible products via the electronically enabled input in response to the electronically outputted one or more selection menus electronically identifying at least in part the one or more selected ingestible products to be ingested transdermally is carried out by electronically receiving the selection information of the one or more selected ingestible products via the electronically enabled input in response to the electronically outputted one or more selection menus electronically identifying at least in part the one or more selected ingestible products to be ingested transdermally (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be ingested transdermally such as a cream, etc.).

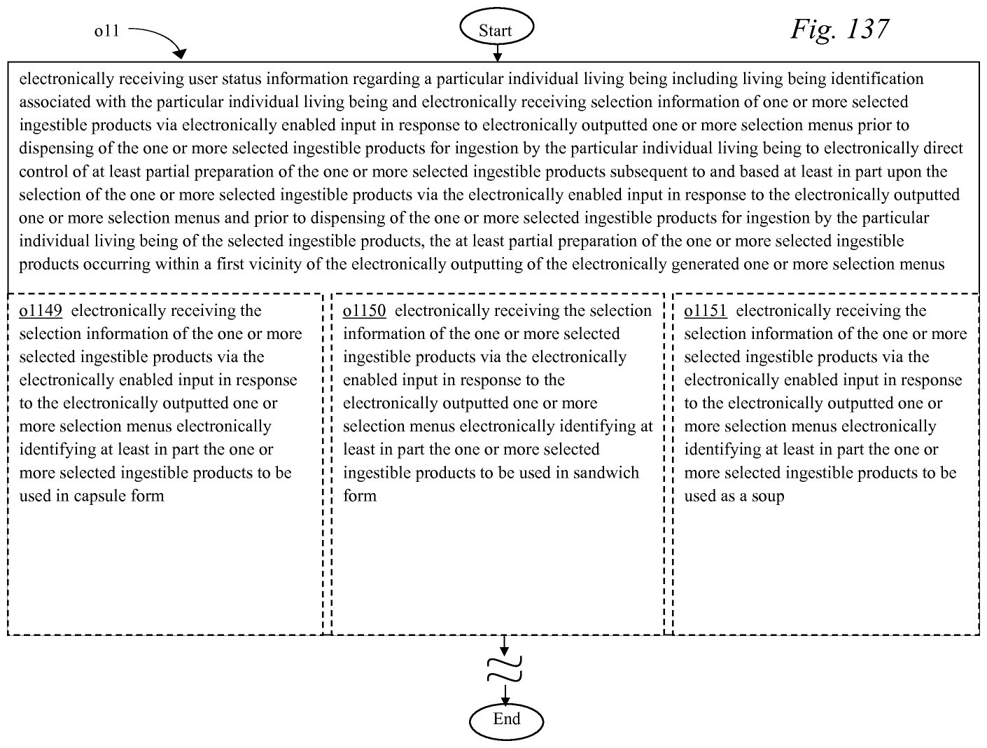

In one or more implementations, as shown in FIG. 137, operation o11 includes an operation o1149 for electronically receiving the selection information of the one or more selected ingestible products via the electronically enabled input in response to the electronically outputted one or more selection menus electronically identifying at least in part the one or more selected ingestible products to be used in capsule form. An exemplary version of a non-transitory signal bearing medium of information storage subsystem s200 is depicted as bearing one or more receiving information capsule instructions i1149 that when executed will direct performance of the operation o1149. In an implementation, the one or more receiving information capsule instructions i1149 when executed direct electronically receiving the selection information of the one or more selected ingestible products via the electronically enabled input in response to the electronically outputted one or more selection menus electronically identifying at least in part the one or more selected ingestible products to be used in a capsule form (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be used in capsule form, such as through capsules via encapsulation, etc.). Furthermore, the receiving information capsule electrical circuitry arrangement e1149 when activated will perform the operation o1149. In an implementation, the receiving information capsule electrical circuitry arrangement e1149, when activated performs electronically receiving the selection information of the one or more selected ingestible products via the electronically enabled input in response to the electronically outputted one or more selection menus electronically identifying at least in part the one or more selected ingestible products to be used in a capsule form (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be used in capsule form, such as through capsules via encapsulation, etc.). In an implementation, the electronically receiving the selection information of the one or more selected ingestible products via the electronically enabled input in response to the electronically outputted one or more selection menus electronically identifying at least in part the one or more selected ingestible products to be used in capsule form is carried out by electronically receiving the selection information of the one or more selected ingestible products via the electronically enabled input in response to the electronically outputted one or more selection menus electronically identifying at least in part the one or more selected ingestible products to be used in a capsule form (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be used in capsule form, such as through capsules via encapsulation, etc.).

In one or more implementations, operation o11 includes an operation o1150 for electronically receiving the selection information of the one or more selected ingestible products via the electronically enabled input in response to the electronically outputted one or more selection menus electronically identifying at least in part the one or more selected ingestible products to be used in sandwich form. An exemplary version of a non-transitory signal bearing medium of information storage subsystem s200 is depicted as bearing one or more receiving information sandwich instructions i1150 that when executed will direct performance of the operation o1150. In an implementation, the one or more receiving information sandwich instructions i1150 when executed direct electronically receiving the selection information of the one or more selected ingestible products via the electronically enabled input in response to the electronically outputted one or more selection menus electronically identifying at least in part the one or more selected ingestible products to be used in sandwich form (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products in sandwich form such as a hamburger, etc.). Furthermore, the receiving information sandwich electrical circuitry arrangement e1150 when activated will perform the operation o1150. In an implementation, the receiving information sandwich electrical circuitry arrangement e1150, when activated performs electronically receiving the selection information of the one or more selected ingestible products via the electronically enabled input in response to the electronically outputted one or more selection menus electronically identifying at least in part the one or more selected ingestible products to be used in sandwich form (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products in sandwich form such as a hamburger, etc.). In an implementation, the electronically receiving the selection information of the one or more selected ingestible products via the electronically enabled input in response to the electronically outputted one or more selection menus electronically identifying at least in part the one or more selected ingestible products to be used in sandwich form is carried out by electronically receiving the selection information of the one or more selected ingestible products via the electronically enabled input in response to the electronically outputted one or more selection menus electronically identifying at least in part the one or more selected ingestible products to be used in sandwich form (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products in sandwich form such as a hamburger, etc.).

In one or more implementations, operation o11 includes an operation o1151 for electronically receiving the selection information of the one or more selected ingestible products via the electronically enabled input in response to the electronically outputted one or more selection menus electronically identifying at least in part the one or more selected ingestible products to be used as a soup. An exemplary version of a non-transitory signal bearing medium of information storage subsystem s200 is depicted as bearing one or more receiving information soup instructions i1151 that when executed will direct performance of the operation o1151. In an implementation, the one or more receiving information soup instructions i1151 when executed direct electronically receiving the selection information of the one or more selected ingestible products via the electronically enabled input in response to the electronically outputted one or more selection menus electronically identifying at least in part the one or more selected ingestible products to be used as a soup (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used as a soup such as tomato soup, etc.). Furthermore, the receiving information soup electrical circuitry arrangement e1151 when activated will perform the operation o1151. In an implementation, the receiving information soup electrical circuitry arrangement e1151, when activated performs electronically receiving the selection information of the one or more selected ingestible products via the electronically enabled input in response to the electronically outputted one or more selection menus electronically identifying at least in part the one or more selected ingestible products to be used as a soup (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used as a soup such as tomato soup, etc.). In an implementation, the electronically receiving the selection information of the one or more selected ingestible products via the electronically enabled input in response to the electronically outputted one or more selection menus electronically identifying at least in part the one or more selected ingestible products to be used as a soup is carried out by electronically receiving the selection information of the one or more selected ingestible products via the electronically enabled input in response to the electronically outputted one or more selection menus electronically identifying at least in part the one or more selected ingestible products to be used as a soup (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used as a soup such as tomato soup, etc.).

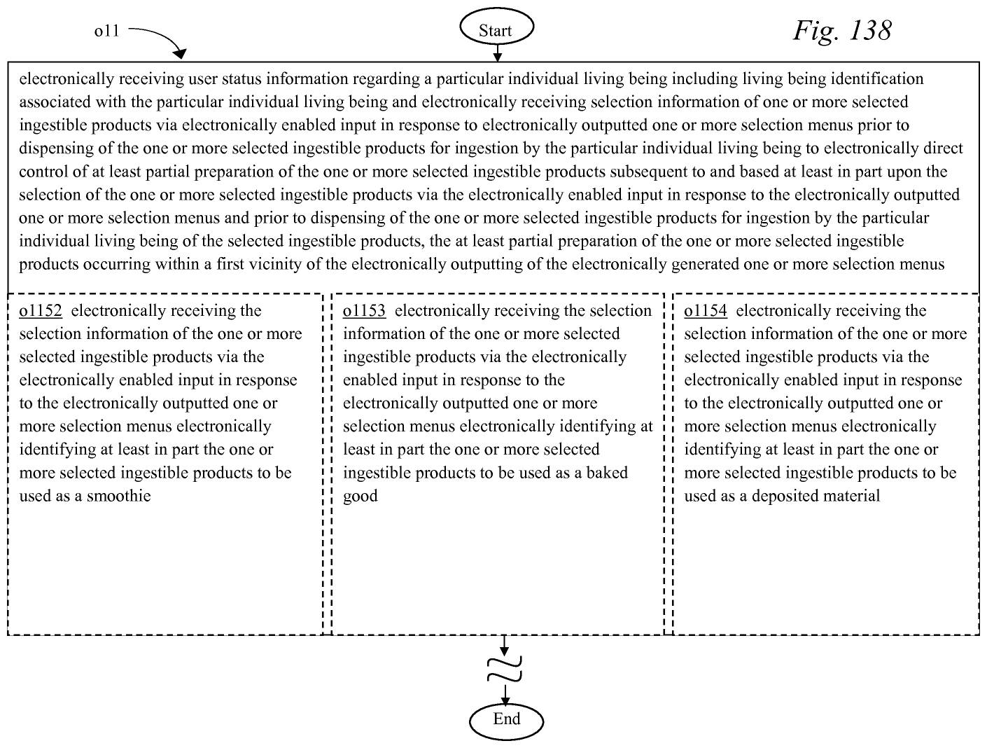

In one or more implementations, as shown in FIG. 138, operation o11 includes an operation o1152 for electronically receiving the selection information of the one or more selected ingestible products via the electronically enabled input in response to the electronically outputted one or more selection menus electronically identifying at least in part the one or more selected ingestible products to be used as a smoothie. An exemplary version of a non-transitory signal bearing medium of information storage subsystem s200 is depicted as bearing one or more receiving information smoothie instructions i1152 that when executed will direct performance of the operation o1152. In an implementation, the one or more receiving information smoothie instructions i1152 when executed direct electronically receiving the selection information of the one or more selected ingestible products via the electronically enabled input in response to the electronically outputted one or more selection menus electronically identifying at least in part the one or more selected ingestible products to be used as a smoothie (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used a smoothie such as a fruit smoothie, etc.). Furthermore, the receiving information smoothie electrical circuitry arrangement e1152 when activated will perform the operation o1152. In an implementation, the receiving information smoothie electrical circuitry arrangement e1152, when activated performs electronically receiving the selection information of the one or more selected ingestible products via the electronically enabled input in response to the electronically outputted one or more selection menus electronically identifying at least in part the one or more selected ingestible products to be used as a smoothie (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used a smoothie such as a fruit smoothie, etc.). In an implementation, the electronically receiving the selection information of the one or more selected ingestible products via the electronically enabled input in response to the electronically outputted one or more selection menus electronically identifying at least in part the one or more selected ingestible products to be used as a smoothie is carried out by electronically receiving the selection information of the one or more selected ingestible products via the electronically enabled input in response to the electronically outputted one or more selection menus electronically identifying at least in part the one or more selected ingestible products to be used as a smoothie (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used a smoothie such as a fruit smoothie, etc.).

In one or more implementations, operation o11 includes an operation o1153 for electronically receiving the selection information of the one or more selected ingestible products via the electronically enabled input in response to the electronically outputted one or more selection menus electronically identifying at least in part the one or more selected ingestible products to be used as a baked good. An exemplary version of a non-transitory signal bearing medium of information storage subsystem s200 is depicted as bearing one or more receiving information baked instructions i1153 that when executed will direct performance of the operation o1153. In an implementation, the one or more receiving information baked instructions i1153 when executed direct electronically receiving the selection information of the one or more selected ingestible products via the electronically enabled input in response to the electronically outputted one or more selection menus electronically identifying at least in part the one or more selected ingestible products to be used as a baked good (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used as a baked good such as a muffin, etc.). Furthermore, the receiving information baked electrical circuitry arrangement e1153 when activated will perform the operation o1153. In an implementation, the receiving information baked electrical circuitry arrangement e1153, when activated performs electronically receiving the selection information of the one or more selected ingestible products via the electronically enabled input in response to the electronically outputted one or more selection menus electronically identifying at least in part the one or more selected ingestible products to be used as a baked good (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used as a baked good such as a muffin, etc.). In an implementation, the electronically receiving the selection information of the one or more selected ingestible products via the electronically enabled input in response to the electronically outputted one or more selection menus electronically identifying at least in part the one or more selected ingestible products to be used as a baked good is carried out by electronically receiving the selection information of the one or more selected ingestible products via the electronically enabled input in response to the electronically outputted one or more selection menus electronically identifying at least in part the one or more selected ingestible products to be used as a baked good (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used as a baked good such as a muffin, etc.).

In one or more implementations, operation o11 includes an operation o1154 for electronically receiving the selection information of the one or more selected ingestible products via the electronically enabled input in response to the electronically outputted one or more selection menus electronically identifying at least in part the one or more selected ingestible products to be used as a deposited material. An exemplary version of a non-transitory signal bearing medium of information storage subsystem s200 is depicted as bearing one or more receiving information deposited instructions i1154 that when executed will direct performance of the operation o1154. In an implementation, the one or more receiving information deposited instructions i1154 when executed direct electronically receiving the selection information of the one or more selected ingestible products via the electronically enabled input in response to the electronically outputted one or more selection menus electronically identifying at least in part the one or more selected ingestible products to be used as a deposited material (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be used as a deposited material such as a multi-layered cake, etc.). Furthermore, the receiving information deposited electrical circuitry arrangement e1154 when activated will perform the operation o1154. In an implementation, the receiving information deposited electrical circuitry arrangement e1154, when activated performs electronically receiving the selection information of the one or more selected ingestible products via the electronically enabled input in response to the electronically outputted one or more selection menus electronically identifying at least in part the one or more selected ingestible products to be used as a deposited material (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be used as a deposited material such as a multi-layered cake, etc.). In an implementation, the electronically receiving the selection information of the one or more selected ingestible products via the electronically enabled input in response to the electronically outputted one or more selection menus electronically identifying at least in part the one or more selected ingestible products to be used as a deposited material is carried out by electronically receiving the selection information of the one or more selected ingestible products via the electronically enabled input in response to the electronically outputted one or more selection menus electronically identifying at least in part the one or more selected ingestible products to be used as a deposited material (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be used as a deposited material such as a multi-layered cake, etc.).

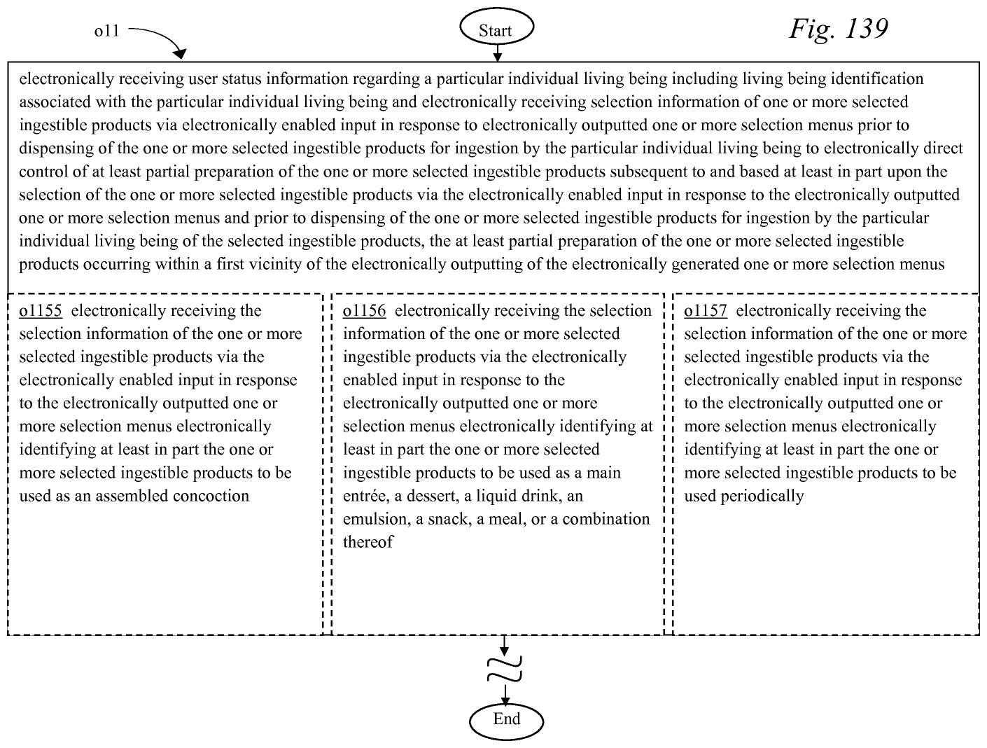

In one or more implementations, as shown in FIG. 139, operation o11 includes an operation o1155 for electronically receiving the selection information of the one or more selected ingestible products via the electronically enabled input in response to the electronically outputted one or more selection menus electronically identifying at least in part the one or more selected ingestible products to be used as an assembled concoction. An exemplary version of a non-transitory signal bearing medium of information storage subsystem s200 is depicted as bearing one or more receiving information assembled instructions i1155 that when executed will direct performance of the operation o1155. In an implementation, the one or more receiving information assembled instructions i1155 when executed direct electronically receiving the selection information of the one or more selected ingestible products via the electronically enabled input in response to the electronically outputted one or more selection menus electronically identifying at least in part the one or more selected ingestible products to be used as an assembled concoction (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be used as an assembled concoction such as a decorated confection, etc.). Furthermore, the receiving information assembled electrical circuitry arrangement e1155 when activated will perform the operation o1155. In an implementation, the receiving information assembled electrical circuitry arrangement e1155, when activated performs electronically receiving the selection information of the one or more selected ingestible products via the electronically enabled input in response to the electronically outputted one or more selection menus electronically identifying at least in part the one or more selected ingestible products to be used as an assembled concoction (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be used as an assembled concoction such as a decorated confection, etc.). In an implementation, the electronically receiving the selection information of the one or more selected ingestible products via the electronically enabled input in response to the electronically outputted one or more selection menus electronically identifying at least in part the one or more selected ingestible products to be used as an assembled concoction is carried out by electronically receiving the selection information of the one or more selected ingestible products via the electronically enabled input in response to the electronically outputted one or more selection menus electronically identifying at least in part the one or more selected ingestible products to be used as an assembled concoction (e.g. an implementation of the receiver component s528 is configured to electronically receive the selection information of the one or more ingestible products and engage with the microprocessor component s102 to direct the material processing subsystem s700 in response to the electronically outputted one or more selection menus electronically identifying at least in part the one or more selected ingestible products to be used as an assembled concoction such as a decorated confection, etc.).

In one or more implementations, operation o11 includes an operation o1156 for electronically receiving the selection information of the one or more selected ingestible products via the electronically enabled input in response to the electronically outputted one or more selection menus electronically identifying at least in part the one or more selected ingestible products to be used as a main entrée, a dessert, a liquid drink, an emulsion, a snack, a meal, or a combination thereof. An exemplary version of a non-transitory signal bearing medium of information storage subsystem s200 is depicted as bearing one or more receiving information uses instructions i1156 that when executed will direct performance of the operation o1156. In an implementation, the one or more receiving information uses instructions i1156 when executed direct electronically receiving the selection information of the one or more selected ingestible products via the electronically enabled input in response to the electronically outputted one or more selection menus electronically identifying at least in part the one or more selected ingestible products to be used as a main entrée, a dessert, a liquid drink, an emulsion, a snack, a meal, or a combination thereof (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used as a as a main entrée, a dessert, a liquid drink, an emulsion, a snack, a meal, or a combination thereof such as a steak dinner, etc.). Furthermore, the receiving information uses electrical circuitry arrangement e1156 when activated will perform the operation o1156. In an implementation, the receiving information uses electrical circuitry arrangement e1156, when activated performs electronically receiving the selection information of the one or more selected ingestible products via the electronically enabled input in response to the electronically outputted one or more selection menus electronically identifying at least in part the one or more selected ingestible products to be used as a main entrée, a dessert, a liquid drink, an emulsion, a snack, a meal, or a combination thereof (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used as a as a main entrée, a dessert, a liquid drink, an emulsion, a snack, a meal, or a combination thereof such as a steak dinner, etc.). In an implementation, the electronically receiving the selection information of the one or more selected ingestible products via the electronically enabled input in response to the electronically outputted one or more selection menus electronically identifying at least in part the one or more selected ingestible products to be used as a main entrée, a dessert, a liquid drink, an emulsion, a snack, a meal, or a combination thereof is carried out by electronically receiving the selection information of the one or more selected ingestible products via the electronically enabled input in response to the electronically outputted one or more selection menus electronically identifying at least in part the one or more selected ingestible products to be used as a main entrée, a dessert, a liquid drink, an emulsion, a snack, a meal, or a combination thereof (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used as a as a main entrée, a dessert, a liquid drink, an emulsion, a snack, a meal, or a combination thereof such as a steak dinner, etc.).

In one or more implementations, operation o11 includes an operation o1157 for electronically receiving the selection information of the one or more selected ingestible products via the electronically enabled input in response to the electronically outputted one or more selection menus electronically identifying at least in part the one or more selected ingestible products to be used periodically. An exemplary version of a non-transitory signal bearing medium of information storage subsystem s200 is depicted as bearing one or more receiving information periods instructions i1157 that when executed will direct performance of the operation o1157. In an implementation, the one or more receiving information periods instructions i1157 when executed direct electronically receiving the selection information of the one or more selected ingestible products via the electronically enabled input in response to the electronically outputted one or more selection menus electronically identifying at least in part the one or more selected ingestible products to be used periodically (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used periodically such as once a week, etc.). Furthermore, the receiving information periods electrical circuitry arrangement e1157 when activated will perform the operation o1157. In an implementation, the receiving information periods electrical circuitry arrangement e1157, when activated performs electronically receiving the selection information of the one or more selected ingestible products via the electronically enabled input in response to the electronically outputted one or more selection menus electronically identifying at least in part the one or more selected ingestible products to be used periodically (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used periodically such as once a week, etc.). In an implementation, the electronically receiving the selection information of the one or more selected ingestible products via the electronically enabled input in response to the electronically outputted one or more selection menus electronically identifying at least in part the one or more selected ingestible products to be used periodically is carried out by electronically receiving the selection information of the one or more selected ingestible products via the electronically enabled input in response to the electronically outputted one or more selection menus electronically identifying at least in part the one or more selected ingestible products to be used periodically (e.g. an implementation of the receiver component s528 is configured to electronically receive the selection information of the one or more ingestible products and engage with the microprocessor component s102 in response to the electronically outputted one or more selection menus electronically identifying at least in part the one or more selected ingestible products to be used periodically such as once a week, etc.).

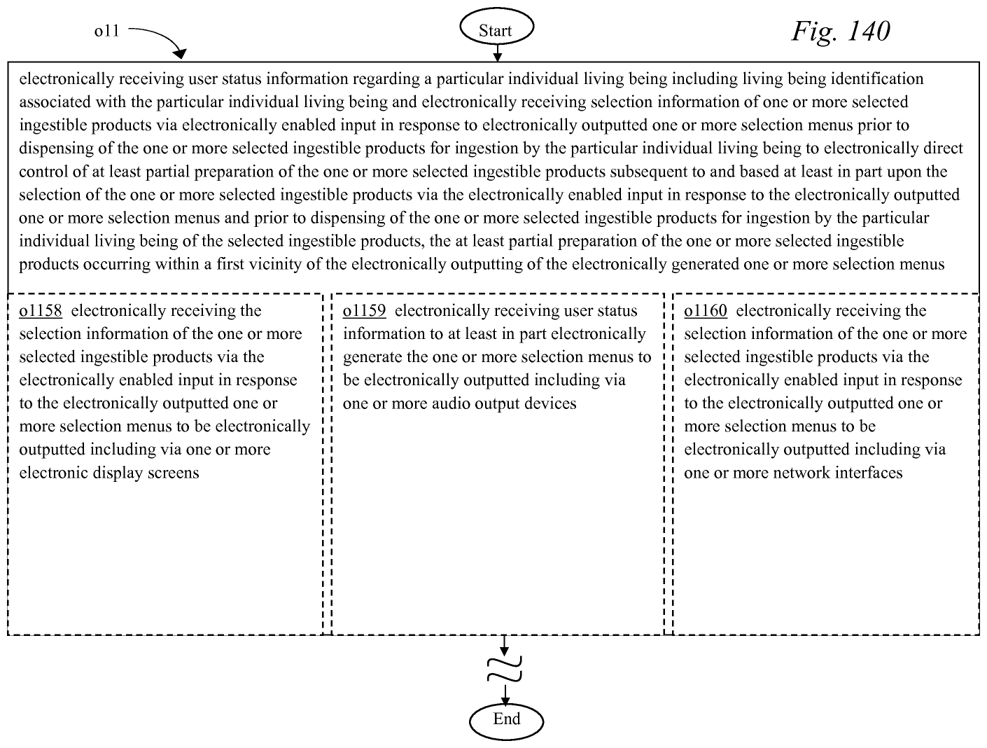

In one or more implementations, as shown in FIG. 140, operation o11 includes an operation o1158 for electronically receiving the selection information of the one or more selected ingestible products via the electronically enabled input in response to the electronically outputted one or more selection menus to be electronically outputted including via one or more electronic display screens. An exemplary version of a non-transitory signal bearing medium of information storage subsystem s200 is depicted as bearing one or more receiving information display instructions i1158 that when executed will direct performance of the operation o1158. In an implementation, the one or more receiving information display instructions i1158 when executed direct electronically receiving the selection information of the one or more selected ingestible products via the electronically enabled input in response to the electronically outputted one or more selection menus to be electronically outputted including via one or more electronic display screens (e.g. an implementation of the receiver component s528 is configured to electronically receive the selection information of the one or more ingestible products in a format for the microprocessor component s102 in response to the electronically outputted one or more selection menus to be electronically outputted including via one or more display screens such as via graphical user interface (GUI) component s302, etc.). Furthermore, the receiving information display electrical circuitry arrangement e1158 when activated will perform the operation o1158. In an implementation, the receiving information display electrical circuitry arrangement e1158, when activated performs electronically receiving the selection information of the one or more selected ingestible products via the electronically enabled input in response to the electronically outputted one or more selection menus to be electronically outputted including via one or more electronic display screens (e.g. an implementation of the receiver component s528 is configured to electronically receive the selection information of the one or more ingestible products in a format for the microprocessor component s102 in response to the electronically outputted one or more selection menus to be electronically outputted including via one or more display screens such as via graphical user interface (GUI) component s302, etc.). In an implementation, the electronically receiving the selection information of the one or more selected ingestible products via the electronically enabled input in response to the electronically outputted one or more selection menus to be electronically outputted including via one or more electronic display screens is carried out by electronically receiving the selection information of the one or more selected ingestible products via the electronically enabled input in response to the electronically outputted one or more selection menus to be electronically outputted including via one or more electronic display screens (e.g. an implementation of the receiver component s528 is configured to electronically receive the selection information of the one or more ingestible products in a format for the microprocessor component s102 in response to the electronically outputted one or more selection menus to be electronically outputted including via one or more display screens such as via graphical user interface (GUI) component s302, etc.).

In one or more implementations, operation o11 includes an operation o1159 for electronically receiving user status information to at least in part electronically generate the one or more selection menus to be electronically outputted including via one or more audio output devices. An exemplary version of a non-transitory signal bearing medium of information storage subsystem s200 is depicted as bearing one or more receiving information audio instructions i1159 that when executed will direct performance of the operation o1159. In an implementation, the one or more receiving information audio instructions i1159 when executed direct electronically receiving the selection information of the one or more selected ingestible products via the electronically enabled input in response to the electronically outputted one or more selection menus to be electronically outputted including via one or more audio output devices (e.g. an implementation of the receiver component s528 is configured to electronically receive the selection information of the one or more ingestible products in a format for the microprocessor component s102 in response to the electronically outputted one or more selection menus to be electronically outputted including via one or more audio output devices such as via audio in/out component s328, etc.). Furthermore, the receiving information audio electrical circuitry arrangement e1159 when activated will perform the operation o1159. In an implementation, the receiving information audio electrical circuitry arrangement e1159, when activated performs electronically receiving the selection information of the one or more selected ingestible products via the electronically enabled input in response to the electronically outputted one or more selection menus to be electronically outputted including via one or more audio output devices (e.g. an implementation of the receiver component s528 is configured to electronically receive the selection information of the one or more ingestible products in a format for the microprocessor component s102 in response to the electronically outputted one or more selection menus to be electronically outputted including via one or more audio output devices such as via audio in/out component s328, etc.). In an implementation, the electronically receiving user status information to at least in part electronically generate the one or more selection menus to be electronically outputted including via one or more audio output devices is carried out by electronically receiving the selection information of the one or more selected ingestible products via the electronically enabled input in response to the electronically outputted one or more selection menus to be electronically outputted including via one or more audio output devices (e.g. an implementation of the receiver component s528 is configured to electronically receive the selection information of the one or more ingestible products in a format for the microprocessor component s102 in response to the electronically outputted one or more selection menus to be electronically outputted including via one or more audio output devices such as via audio in/out component s328, etc.).

In one or more implementations, operation o11 includes an operation o1160 for electronically receiving the selection information of the one or more selected ingestible products via the electronically enabled input in response to the electronically outputted one or more selection menus to be electronically outputted including via one or more network interfaces. An exemplary version of a non-transitory signal bearing medium of information storage subsystem s200 is depicted as bearing one or more receiving information network instructions i1160 that when executed will direct performance of the operation o1160. In an implementation, the one or more receiving information network instructions i1160 when executed direct electronically receiving the selection information of the one or more selected ingestible products via the electronically enabled input in response to the electronically outputted one or more selection menus to be electronically outputted including via one or more network interfaces (e.g. an implementation of the receiver component s528 is configured to electronically receive the selection information of the one or more ingestible products in a format for the microprocessor component s102 in response to the electronically outputted one or more selection menus to be electronically outputted including via one or more network interfaces such as via wide area network component s516, etc.). Furthermore, the receiving information network electrical circuitry arrangement e1160 when activated will perform the operation o1160. In an implementation, the receiving information network electrical circuitry arrangement e1160, when activated performs electronically receiving the selection information of the one or more selected ingestible products via the electronically enabled input in response to the electronically outputted one or more selection menus to be electronically outputted including via one or more network interfaces (e.g. an implementation of the receiver component s528 is configured to electronically receive the selection information of the one or more ingestible products in a format for the microprocessor component s102 in response to the electronically outputted one or more selection menus to be electronically outputted including via one or more network interfaces such as via wide area network component s516, etc.). In an implementation, the electronically receiving the selection information of the one or more selected ingestible products via the electronically enabled input in response to the electronically outputted one or more selection menus to be electronically outputted including via one or more network interfaces is carried out by electronically receiving the selection information of the one or more selected ingestible products via the electronically enabled input in response to the electronically outputted one or more selection menus to be electronically outputted including via one or more network interfaces (e.g. an implementation of the receiver component s528 is configured to electronically receive the selection information of the one or more ingestible products in a format for the microprocessor component s102 in response to the electronically outputted one or more selection menus to be electronically outputted including via one or more network interfaces such as via wide area network component s516, etc.).

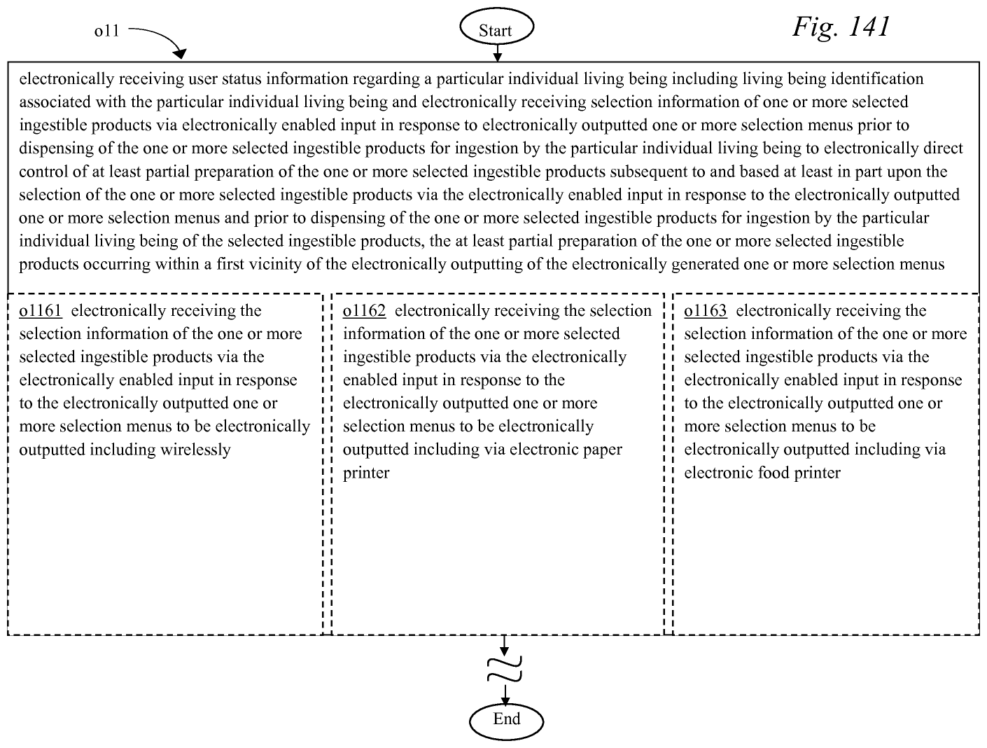

In one or more implementations, as shown in FIG. 141, operation o11 includes an operation o1161 for electronically receiving the selection information of the one or more selected ingestible products via the electronically enabled input in response to the electronically outputted one or more selection menus to be electronically outputted including wirelessly. An exemplary version of a non-transitory signal bearing medium of information storage subsystem s200 is depicted as bearing one or more receiving information wirelessly instructions i1161 that when executed will direct performance of the operation o1161. In an implementation, the one or more receiving information wirelessly instructions i1161 when executed direct electronically receiving the selection information of the one or more selected ingestible products via the electronically enabled input in response to the electronically outputted one or more selection menus to be electronically outputted including wirelessly (e.g. an implementation of the receiver component s528 is configured to electronically receive the selection information of the one or more ingestible products in a format for the microprocessor component s102 in response to the electronically outputted one or more selection menus to be electronically outputted including wirelessly such as via wireless network component s510, etc.). Furthermore, the receiving information wirelessly electrical circuitry arrangement e1161 when activated will perform the operation o1161. In an implementation, the receiving information wirelessly electrical circuitry arrangement e1161, when activated performs electronically receiving the selection information of the one or more selected ingestible products via the electronically enabled input in response to the electronically outputted one or more selection menus to be electronically outputted including wirelessly (e.g. an implementation of the receiver component s528 is configured to electronically receive the selection information of the one or more ingestible products in a format for the microprocessor component s102 in response to the electronically outputted one or more selection menus to be electronically outputted including wirelessly such as via wireless network component s510, etc.). In an implementation, the electronically receiving the selection information of the one or more selected ingestible products via the electronically enabled input in response to the electronically outputted one or more selection menus to be electronically outputted including wirelessly is carried out by electronically receiving the selection information of the one or more selected ingestible products via the electronically enabled input in response to the electronically outputted one or more selection menus to be electronically outputted including wirelessly (e.g. an implementation of the receiver component s528 is configured to electronically receive the selection information of the one or more ingestible products in a format for the microprocessor component s102 in response to the electronically outputted one or more selection menus to be electronically outputted including wirelessly such as via wireless network component s510, etc.).

In one or more implementations, operation o11 includes an operation o1162 for electronically receiving the selection information of the one or more selected ingestible products via the electronically enabled input in response to the electronically outputted one or more selection menus to be electronically outputted including via electronic paper printer. An exemplary version of a non-transitory signal bearing medium of information storage subsystem s200 is depicted as bearing one or more receiving information paper instructions i1162 that when executed will direct performance of the operation o1162. In an implementation, the one or more receiving information paper instructions i1162 when executed direct electronically receiving the selection information of the one or more selected ingestible products via the electronically enabled input in response to the electronically outputted one or more selection menus to be electronically outputted including via electronic paper printer (e.g. an implementation of the receiver component s528 is configured to electronically receive the selection information of the one or more ingestible products in a format for the microprocessor component s102 in response to the electronically outputted one or more selection menus to be electronically outputted including via electronic paper printer such as via scanner component s338, etc.). Furthermore, the receiving information paper electrical circuitry arrangement e1162 when activated will perform the operation o1162. In an implementation, the receiving information paper electrical circuitry arrangement e1162, when activated performs electronically receiving the selection information of the one or more selected ingestible products via the electronically enabled input in response to the electronically outputted one or more selection menus to be electronically outputted including via electronic paper printer (e.g. an implementation of the receiver component s528 is configured to electronically receive the selection information of the one or more ingestible products in a format for the microprocessor component s102 in response to the electronically outputted one or more selection menus to be electronically outputted including via electronic paper printer such as via scanner component s338, etc.). In an implementation, the electronically receiving the selection information of the one or more selected ingestible products via the electronically enabled input in response to the electronically outputted one or more selection menus to be electronically outputted including via electronic paper printer is carried out by electronically receiving the selection information of the one or more selected ingestible products via the electronically enabled input in response to the electronically outputted one or more selection menus to be electronically outputted including via electronic paper printer (e.g. an implementation of the receiver component s528 is configured to electronically receive the selection information of the one or more ingestible products in a format for the microprocessor component s102 in response to the electronically outputted one or more selection menus to be electronically outputted including via electronic paper printer such as via scanner component s338, etc.).

In one or more implementations, operation o11 includes an operation o1163 for electronically receiving the selection information of the one or more selected ingestible products via the electronically enabled input in response to the electronically outputted one or more selection menus to be electronically outputted including via electronic food printer. An exemplary version of a non-transitory signal bearing medium of information storage subsystem s200 is depicted as bearing one or more receiving information food instructions i1163 that when executed will direct performance of the operation o1163. In an implementation, the one or more receiving information food instructions i1163 when executed direct electronically receiving the selection information of the one or more selected ingestible products via the electronically enabled input in response to the electronically outputted one or more selection menus to be electronically outputted including via electronic food printer (e.g. an implementation of the receiver component s528 is configured to electronically receive the selection information of the one or more ingestible products in a format for the microprocessor component s102 in response to the electronically outputted one or more selection menus to be electronically outputted including via electronic food printer such as via deposition component s740, etc.). Furthermore, the receiving information food electrical circuitry arrangement e1163 when activated will perform the operation o1163. In an implementation, the receiving information food electrical circuitry arrangement e1163, when activated performs electronically receiving the selection information of the one or more selected ingestible products via the electronically enabled input in response to the electronically outputted one or more selection menus to be electronically outputted including via electronic food printer (e.g. an implementation of the receiver component s528 is configured to electronically receive the selection information of the one or more ingestible products in a format for the microprocessor component s102 in response to the electronically outputted one or more selection menus to be electronically outputted including via electronic food printer such as via deposition component s740, etc.). In an implementation, the electronically receiving the selection information of the one or more selected ingestible products via the electronically enabled input in response to the electronically outputted one or more selection menus to be electronically outputted including via electronic food printer is carried out by electronically receiving the selection information of the one or more selected ingestible products via the electronically enabled input in response to the electronically outputted one or more selection menus to be electronically outputted including via electronic food printer (e.g. an implementation of the receiver component s528 is configured to electronically receive the selection information of the one or more ingestible products in a format for the microprocessor component s102 in response to the electronically outputted one or more selection menus to be electronically outputted including via electronic food printer such as via deposition component s740, etc.).

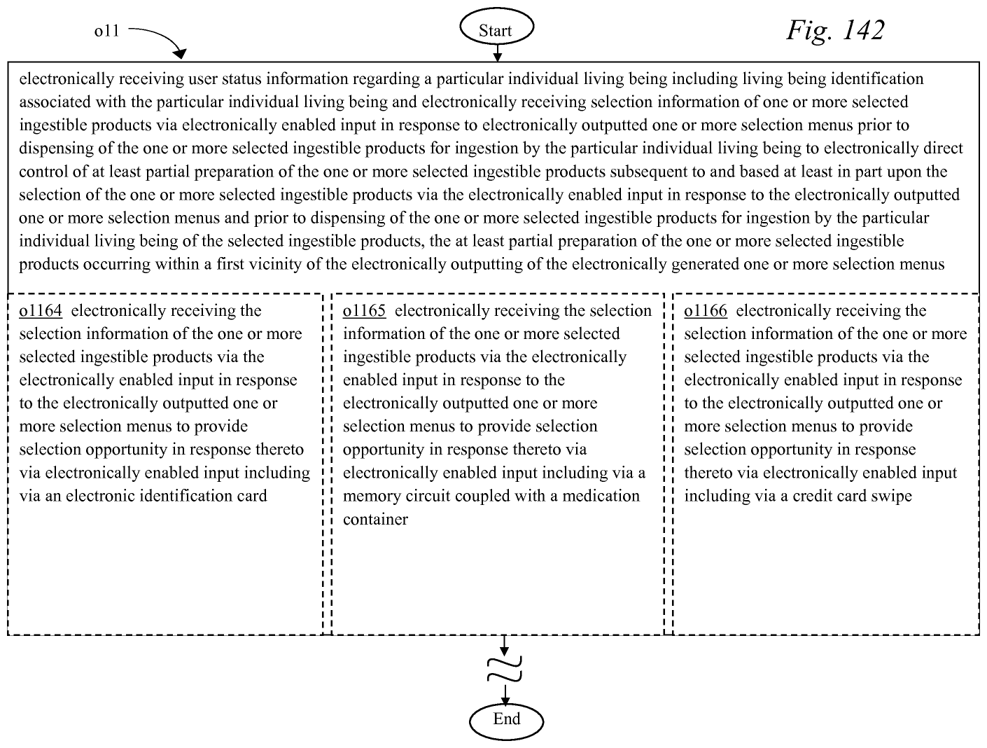

In one or more implementations, as shown in FIG. 142, operation o11 includes an operation o1164 for electronically receiving the selection information of the one or more selected ingestible products via the electronically enabled input in response to the electronically outputted one or more selection menus to provide selection opportunity in response thereto via electronically enabled input including via an electronic identification card. An exemplary version of a non-transitory signal bearing medium of information storage subsystem s200 is depicted as bearing one or more receiving information ID card instructions i1164 that when executed will direct performance of the operation o1164. In an implementation, the one or more receiving information ID card instructions i1164 when executed direct electronically receiving the selection information of the one or more selected ingestible products via the electronically enabled input in response to the electronically outputted one or more selection menus to provide the selection opportunity in response thereto via electronically enabled input including via an electronic identification card (e.g. an implementation of the receiver component s528 is configured to electronically engage with a card having memory storage holding the user status information, etc.). Furthermore, the receiving information ID card electrical circuitry arrangement e1164 when activated will perform the operation o1164. In an implementation, the receiving information ID card electrical circuitry arrangement e1164, when activated performs electronically receiving the selection information of the one or more selected ingestible products via the electronically enabled input in response to the electronically outputted one or more selection menus to provide the selection opportunity in response thereto via electronically enabled input including via an electronic identification card (e.g. an implementation of the receiver component s528 is configured to electronically engage with a card having memory storage holding the user status information, etc.). In an implementation, the electronically receiving the selection information of the one or more selected ingestible products via the electronically enabled input in response to the electronically outputted one or more selection menus to provide selection opportunity in response thereto via electronically enabled input including via an electronic identification card is carried out by electronically receiving the selection information of the one or more selected ingestible products via the electronically enabled input in response to the electronically outputted one or more selection menus to provide the selection opportunity in response thereto via electronically enabled input including via an electronic identification card (e.g. an implementation of the receiver component s528 is configured to electronically engage with a card having memory storage holding the user status information, etc.).

In one or more implementations, operation o11 includes an operation o1165 for electronically receiving the selection information of the one or more selected ingestible products via the electronically enabled input in response to the electronically outputted one or more selection menus to provide selection opportunity in response thereto via electronically enabled input including via a memory circuit coupled with a medication container. A non-transitory signal bearing medium includes one or more receiving information container instructions i1165 that when executed will direct performance of the operation o1165. In an implementation, the one or more receiving information container instructions i1165 when executed direct electronically receiving the selection information of the one or more selected ingestible products via the electronically enabled input in response to the electronically outputted one or more selection menus to provide the selection opportunity in response thereto via electronically enabled input including via in a memory circuit coupled with a medication container (e.g. an implementation of the receiver component s528 is configured to electronically engage with a memory storage coupled with a medication container to receive the electronically enabled input in electronic form, etc.). Furthermore, the receiving information container electrical circuitry arrangement e1165 when activated will perform the operation o1165. In an implementation, the receiving information container electrical circuitry arrangement e1165, when activated performs electronically receiving the selection information of the one or more selected ingestible products via the electronically enabled input in response to the electronically outputted one or more selection menus to provide the selection opportunity in response thereto via electronically enabled input including via in a memory circuit coupled with a medication container (e.g. an implementation of the receiver component s528 is configured to electronically engage with a memory storage coupled with a medication container to receive the electronically enabled input in electronic form, etc.). In an implementation, the electronically receiving the selection information of the one or more selected ingestible products via the electronically enabled input in response to the electronically outputted one or more selection menus to provide selection opportunity in response thereto via electronically enabled input including via a memory circuit coupled with a medication container is carried out by electronically receiving the selection information of the one or more selected ingestible products via the electronically enabled input in response to the electronically outputted one or more selection menus to provide the selection opportunity in response thereto via electronically enabled input including via in a memory circuit coupled with a medication container (e.g. an implementation of the receiver component s528 is configured to electronically engage with a memory storage coupled with a medication container to receive the electronically enabled input in electronic form, etc.).

In one or more implementations, operation o11 includes an operation o1166 for electronically receiving the selection information of the one or more selected ingestible products via the electronically enabled input in response to the electronically outputted one or more selection menus to provide selection opportunity in response thereto via electronically enabled input including via a credit card swipe. A non-transitory signal bearing medium includes one or more receiving information credit card instructions i1166 that when executed will direct performance of the operation o1166. In an implementation, the one or more receiving information credit card instructions i1166 when executed direct electronically receiving the selection information of the one or more selected ingestible products via the electronically enabled input in response to the electronically outputted one or more selection menus to provide the selection opportunity in response thereto via electronically enabled input including via a credit card swipe (e.g. an implementation of the receiver component s528 is configured to electronically engage with an electronic memory stripe integrated into a credit card to receive the electronically enabled input, etc.). Furthermore, the receiving information credit card electrical circuitry arrangement e1166 when activated will perform the operation o1166. In an implementation, the receiving information credit card electrical circuitry arrangement e1166, when activated performs electronically receiving the selection information of the one or more selected ingestible products via the electronically enabled input in response to the electronically outputted one or more selection menus to provide the selection opportunity in response thereto via electronically enabled input including via a credit card swipe (e.g. an implementation of the receiver component s528 is configured to electronically engage with an electronic memory stripe integrated into a credit card to receive the electronically enabled input, etc.). In an implementation, the electronically receiving the selection information of the one or more selected ingestible products via the electronically enabled input in response to the electronically outputted one or more selection menus to provide selection opportunity in response thereto via electronically enabled input including via a credit card swipe is carried out by electronically receiving the selection information of the one or more selected ingestible products via the electronically enabled input in response to the electronically outputted one or more selection menus to provide the selection opportunity in response thereto via electronically enabled input including via a credit card swipe (e.g. an implementation of the receiver component s528 is configured to electronically engage with an electronic memory stripe integrated into a credit card to receive the electronically enabled input, etc.).

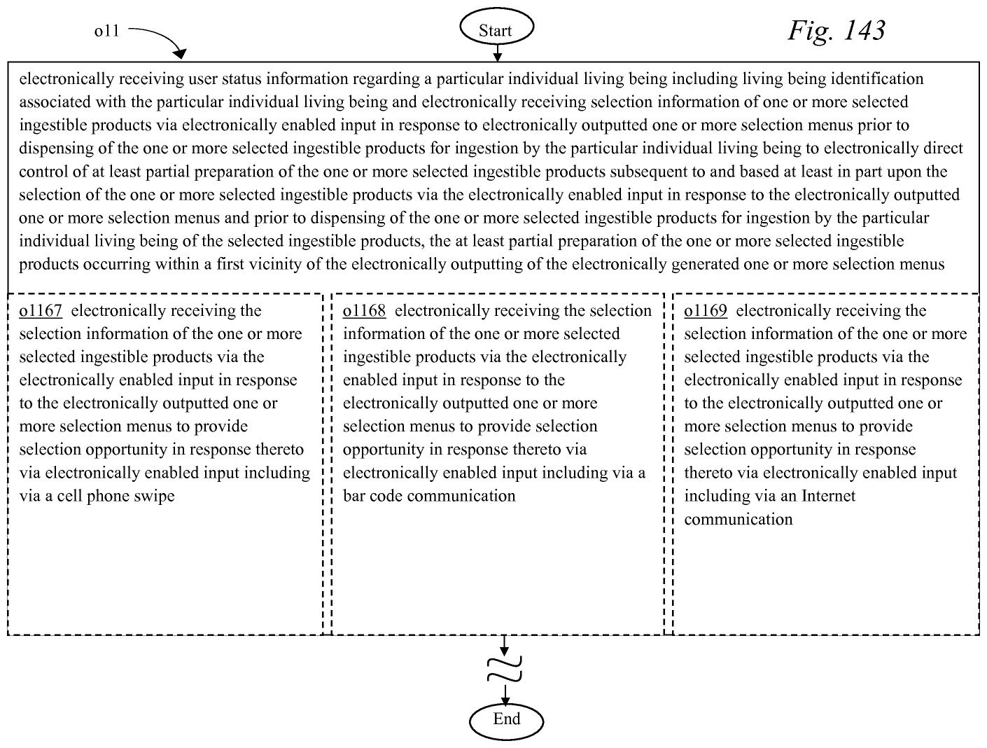

In one or more implementations, as shown in FIG. 143, operation o11 includes an operation o1167 for electronically receiving the selection information of the one or more selected ingestible products via the electronically enabled input in response to the electronically outputted one or more selection menus to provide selection opportunity in response thereto via electronically enabled input including via a cell phone swipe. An exemplary version of a non-transitory signal bearing medium of information storage subsystem s200 is depicted as bearing one or more receiving information cell phone instructions i1167 that when executed will direct performance of the operation o1167. In an implementation, the one or more receiving information cell phone instructions i1167 when executed direct electronically receiving the selection information of the one or more selected ingestible products via the electronically enabled input in response to the electronically outputted one or more selection menus to provide the selection opportunity in response thereto via electronically enabled input including via cell phone swipe (e.g. an implementation of the receiver component s528 is configured to electronically engage with an electronic memory component integrated into a cell phone to receive the electronically enabled input, etc.). Furthermore, the receiving information cell phone electrical circuitry arrangement e1167 when activated will perform the operation o1167. In an implementation, the receiving information cell phone electrical circuitry arrangement e1167, when activated performs electronically receiving the selection information of the one or more selected ingestible products via the electronically enabled input in response to the electronically outputted one or more selection menus to provide the selection opportunity in response thereto via electronically enabled input including via cell phone swipe (e.g. an implementation of the receiver component s528 is configured to electronically engage with an electronic memory component integrated into a cell phone to receive the electronically enabled input, etc.). In an implementation, the electronically receiving the selection information of the one or more selected ingestible products via the electronically enabled input in response to the electronically outputted one or more selection menus to provide selection opportunity in response thereto via electronically enabled input including via a cell phone swipe is carried out by electronically receiving the selection information of the one or more selected ingestible products via the electronically enabled input in response to the electronically outputted one or more selection menus to provide the selection opportunity in response thereto via electronically enabled input including via cell phone swipe (e.g. an implementation of the receiver component s528 is configured to electronically engage with an electronic memory component integrated into a cell phone to receive the electronically enabled input, etc.).

In one or more implementations, operation o11 includes an operation o1168 for electronically receiving the selection information of the one or more selected ingestible products via the electronically enabled input in response to the electronically outputted one or more selection menus to provide selection opportunity in response thereto via electronically enabled input including via a bar code communication. A non-transitory signal bearing medium includes one or more receiving information bar code instructions i1168 that when executed will direct performance of the operation o1168. In an implementation, the one or more receiving information bar code instructions i1168 when executed direct electronically receiving the selection information of the one or more selected ingestible products via the electronically enabled input in response to the electronically outputted one or more selection menus to provide the selection opportunity in response thereto via electronically enabled input including via bar code communication (e.g. an implementation of the receiver component s528 is configured to electronically read a bar code label to receive the electronically enabled input, etc.). Furthermore, the receiving information bar code electrical circuitry arrangement e1168 when activated will perform the operation o1168. In an implementation, the receiving information bar code electrical circuitry arrangement e1168, when activated performs electronically receiving the selection information of the one or more selected ingestible products via the electronically enabled input in response to the electronically outputted one or more selection menus to provide the selection opportunity in response thereto via electronically enabled input including via bar code communication (e.g. an implementation of the receiver component s528 is configured to electronically read a bar code label to receive the electronically enabled input, etc.). In an implementation, the electronically receiving the selection information of the one or more selected ingestible products via the electronically enabled input in response to the electronically outputted one or more selection menus to provide selection opportunity in response thereto via electronically enabled input including via a bar code communication is carried out by electronically receiving the selection information of the one or more selected ingestible products via the electronically enabled input in response to the electronically outputted one or more selection menus to provide the selection opportunity in response thereto via electronically enabled input including via bar code communication (e.g. an implementation of the receiver component s528 is configured to electronically read a bar code label to receive the electronically enabled input, etc.).

In one or more implementations, operation o11 includes an operation o1169 for electronically receiving the selection information of the one or more selected ingestible products via the electronically enabled input in response to the electronically outputted one or more selection menus to provide selection opportunity in response thereto via electronically enabled input including via an Internet communication. A non-transitory signal bearing medium includes one or more receiving information Internet instructions i1169 that when executed will direct performance of the operation o1169. In an implementation, the one or more receiving information Internet instructions i1169 when executed direct electronically receiving the selection information of the one or more selected ingestible products via the electronically enabled input in response to the electronically outputted one or more selection menus to provide the selection opportunity in response thereto via electronically enabled input including via Internet communication (e.g. an implementation of the receiver component s528 is configured to electronically receive through the internet network component s508 the user status information, etc.). Furthermore, the receiving information Internet electrical circuitry arrangement e1169 when activated will perform the operation o1169. In an implementation, the receiving information Internet electrical circuitry arrangement e1169, when activated performs electronically receiving the selection information of the one or more selected ingestible products via the electronically enabled input in response to the electronically outputted one or more selection menus to provide the selection opportunity in response thereto via electronically enabled input including via Internet communication (e.g. an implementation of the receiver component s528 is configured to electronically receive through the internet network component s508 the user status information, etc.). In an implementation, the electronically receiving the selection information of the one or more selected ingestible products via the electronically enabled input in response to the electronically outputted one or more selection menus to provide selection opportunity in response thereto via electronically enabled input including via an Internet communication is carried out by electronically receiving the selection information of the one or more selected ingestible products via the electronically enabled input in response to the electronically outputted one or more selection menus to provide the selection opportunity in response thereto via electronically enabled input including via Internet communication (e.g. an implementation of the receiver component s528 is configured to electronically receive through the internet network component s508 the user status information, etc.).

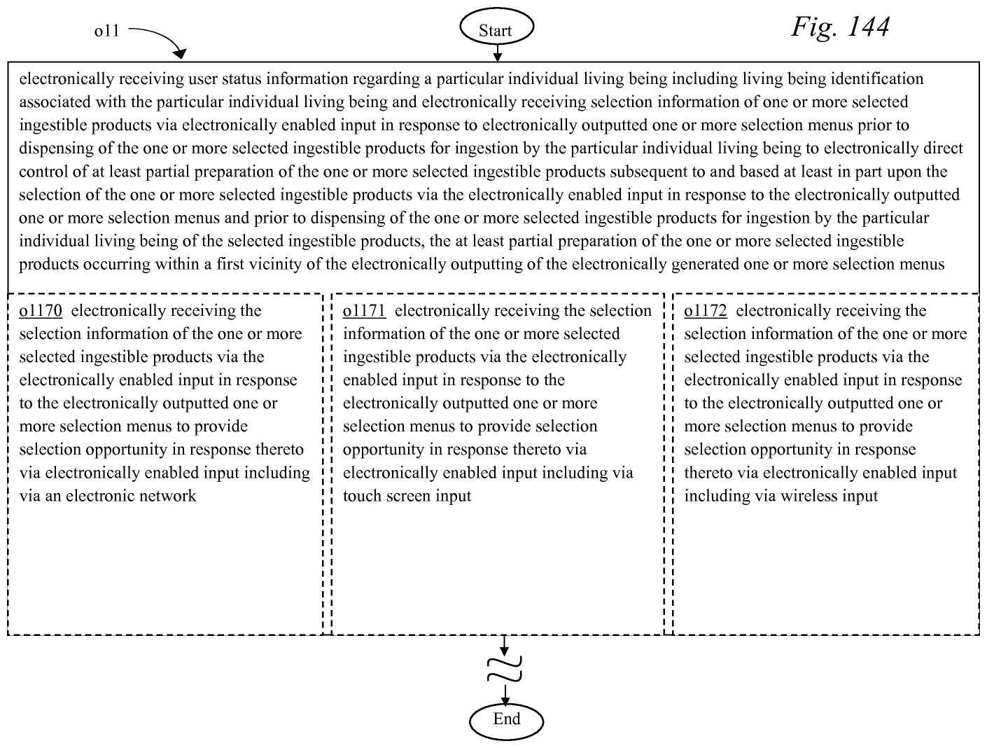

In one or more implementations, as shown in FIG. 144, operation o11 includes an operation o1170 for electronically receiving the selection information of the one or more selected ingestible products via the electronically enabled input in response to the electronically outputted one or more selection menus to provide selection opportunity in response thereto via electronically enabled input including via an electronic network. An exemplary version of a non-transitory signal bearing medium of information storage subsystem s200 is depicted as bearing one or more receiving information network instructions i1170 that when executed will direct performance of the operation o1170. In an implementation, the one or more receiving information network instructions i1170 when executed direct electronically receiving the selection information of the one or more selected ingestible products via the electronically enabled input in response to the electronically outputted one or more selection menus to provide the selection opportunity in response thereto via electronically enabled input including via an electronic network (e.g. an implementation of the receiver component s528 is configured to electronically engage with the network cable component s502 to receive the electronically enabled input, etc.). Furthermore, the receiving information network electrical circuitry arrangement e1170 when activated will perform the operation o1170. In an implementation, the receiving information network electrical circuitry arrangement e1170, when activated performs electronically receiving the selection information of the one or more selected ingestible products via the electronically enabled input in response to the electronically outputted one or more selection menus to provide the selection opportunity in response thereto via electronically enabled input including via an electronic network (e.g. an implementation of the receiver component s528 is configured to electronically engage with the network cable component s502 to receive the electronically enabled input, etc.). In an implementation, the electronically receiving the selection information of the one or more selected ingestible products via the electronically enabled input in response to the electronically outputted one or more selection menus to provide selection opportunity in response thereto via electronically enabled input including via an electronic network is carried out by electronically receiving the selection information of the one or more selected ingestible products via the electronically enabled input in response to the electronically outputted one or more selection menus to provide the selection opportunity in response thereto via electronically enabled input including via an electronic network (e.g. an implementation of the receiver component s528 is configured to electronically engage with the network cable component s502 to receive the electronically enabled input, etc.).

In one or more implementations, operation o11 includes an operation o1171 for electronically receiving the selection information of the one or more selected ingestible products via the electronically enabled input in response to the electronically outputted one or more selection menus to provide selection opportunity in response thereto via electronically enabled input including via touch screen input. A non-transitory signal bearing medium includes one or more receiving information touch screen instructions i1171 that when executed will direct performance of the operation o1171. In an implementation, the one or more receiving information touch screen instructions i1171 when executed direct electronically receiving the selection information of the one or more selected ingestible products via the electronically enabled input in response to the electronically outputted one or more selection menus to provide the selection opportunity in response thereto via electronically enabled input including via touch screen input (e.g. an implementation of the receiver component s528 is configured to electronically receive through the touch screen component s314 the user status information, etc.). Furthermore, the receiving information touch screen electrical circuitry arrangement e1171 when activated will perform the operation o1171. In an implementation, the receiving information touch screen electrical circuitry arrangement e1171, when activated performs electronically receiving the selection information of the one or more selected ingestible products via the electronically enabled input in response to the electronically outputted one or more selection menus to provide the selection opportunity in response thereto via electronically enabled input including via touch screen input (e.g. an implementation of the receiver component s528 is configured to electronically receive through the touch screen component s314 the user status information, etc.). In an implementation, the electronically receiving the selection information of the one or more selected ingestible products via the electronically enabled input in response to the electronically outputted one or more selection menus to provide selection opportunity in response thereto via electronically enabled input including via touch screen input is carried out by electronically receiving the selection information of the one or more selected ingestible products via the electronically enabled input in response to the electronically outputted one or more selection menus to provide the selection opportunity in response thereto via electronically enabled input including via touch screen input (e.g. an implementation of the receiver component s528 is configured to electronically receive through the touch screen component s314 the user status information, etc.).

In one or more implementations, operation o11 includes an operation o1172 for electronically receiving the selection information of the one or more selected ingestible products via the electronically enabled input in response to the electronically outputted one or more selection menus to provide selection opportunity in response thereto via electronically enabled input including via wireless input. A non-transitory signal bearing medium includes one or more receiving information wireless instructions i1172 that when executed will direct performance of the operation o1172. In an implementation, the one or more receiving information wireless instructions i1172 when executed direct electronically receiving the selection information of the one or more selected ingestible products via the electronically enabled input in response to the electronically outputted one or more selection menus to provide the selection opportunity in response thereto via electronically enabled input including via wireless input (e.g. an implementation of the receiver component s528 is configured to electronically receive through the wireless network component s510 to receive the electronically enabled input, etc.). Furthermore, the receiving information wireless electrical circuitry arrangement e1172 when activated will perform the operation o1172. In an implementation, the receiving information wireless electrical circuitry arrangement e1172, when activated performs electronically receiving the selection information of the one or more selected ingestible products via the electronically enabled input in response to the electronically outputted one or more selection menus to provide the selection opportunity in response thereto via electronically enabled input including via wireless input (e.g. an implementation of the receiver component s528 is configured to electronically receive through the wireless network component s510 to receive the electronically enabled input, etc.). In an implementation, the electronically receiving the selection information of the one or more selected ingestible products via the electronically enabled input in response to the electronically outputted one or more selection menus to provide selection opportunity in response thereto via electronically enabled input including via wireless input is carried out by electronically receiving the selection information of the one or more selected ingestible products via the electronically enabled input in response to the electronically outputted one or more selection menus to provide the selection opportunity in response thereto via electronically enabled input including via wireless input (e.g. an implementation of the receiver component s528 is configured to electronically receive through the wireless network component s510 to receive the electronically enabled input, etc.).

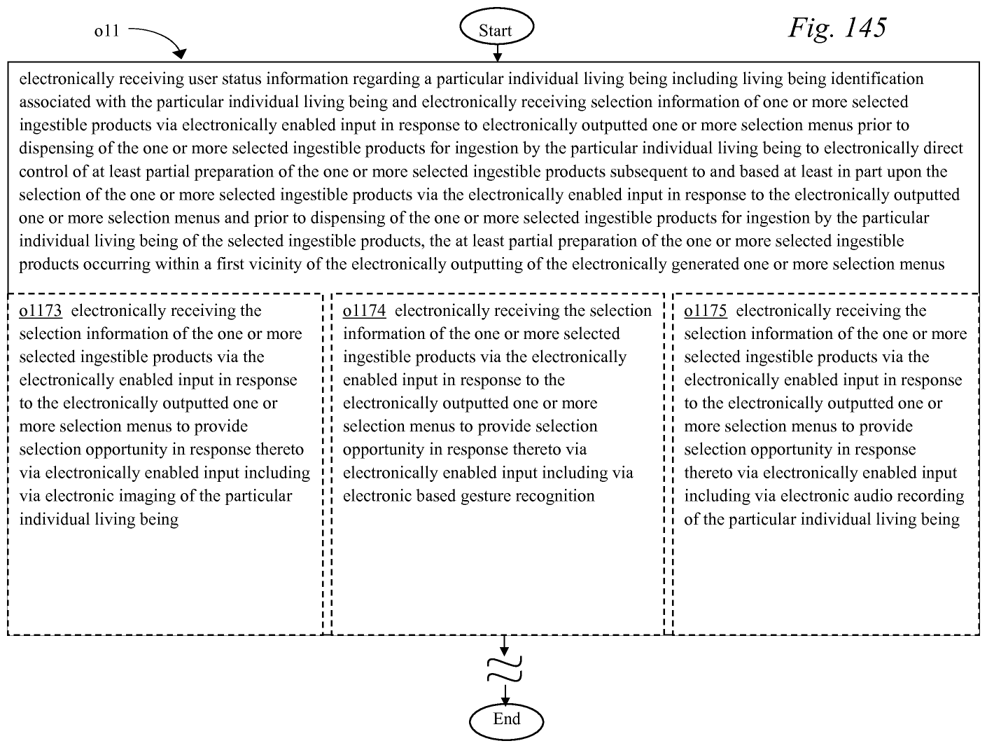

In one or more implementations, as shown in FIG. 145, operation o11 includes an operation o1173 for electronically receiving the selection information of the one or more selected ingestible products via the electronically enabled input in response to the electronically outputted one or more selection menus to provide selection opportunity in response thereto via electronically enabled input including via electronic imaging of the particular individual living being. An exemplary version of a non-transitory signal bearing medium of information storage subsystem s200 is depicted as bearing one or more receiving information imaging instructions i1173 that when executed will direct performance of the operation o1173. In an implementation, the one or more receiving information imaging instructions i1173 when executed direct electronically receiving the selection information of the one or more selected ingestible products via the electronically enabled input in response to the electronically outputted one or more selection menus to provide the selection opportunity in response thereto via electronically enabled input including via electronic imaging of the particular individual living being (e.g. an implementation of the receiver component s528 is configured to electronically receive through the camera component s336 the user status information, etc.). Furthermore, the receiving information imaging electrical circuitry arrangement e1173 when activated will perform the operation o1173. In an implementation, the receiving information imaging electrical circuitry arrangement e1173, when activated performs electronically receiving the selection information of the one or more selected ingestible products via the electronically enabled input in response to the electronically outputted one or more selection menus to provide the selection opportunity in response thereto via electronically enabled input including via electronic imaging of the particular individual living being (e.g. an implementation of the receiver component s528 is configured to electronically receive through the camera component s336 the user status information, etc.). In an implementation, the electronically receiving the selection information of the one or more selected ingestible products via the electronically enabled input in response to the electronically outputted one or more selection menus to provide selection opportunity in response thereto via electronically enabled input including via electronic imaging of the particular individual living being is carried out by electronically receiving the selection information of the one or more selected ingestible products via the electronically enabled input in response to the electronically outputted one or more selection menus to provide the selection opportunity in response thereto via electronically enabled input including via electronic imaging of the particular individual living being (e.g. an implementation of the receiver component s528 is configured to electronically receive through the camera component s336 the user status information, etc.).

In one or more implementations, operation o11 includes an operation o1174 for electronically receiving the selection information of the one or more selected ingestible products via the electronically enabled input in response to the electronically outputted one or more selection menus to provide selection opportunity in response thereto via electronically enabled input including via electronic based gesture recognition. A non-transitory signal bearing medium includes one or more receiving information gesture instructions i1174 that when executed will direct performance of the operation o1174. In an implementation, the one or more receiving information gesture instructions i1174 when executed direct electronically receiving the selection information of the one or more selected ingestible products via the electronically enabled input in response to the electronically outputted one or more selection menus to provide the selection opportunity in response thereto via electronically enabled input including via electronic based gesture recognition (e.g. an implementation of the receiver component s528 is configured to electronically engage with the optical sensing component s418 to receive the electronically enabled input as inputted by a user, etc.). Furthermore, the receiving information gesture electrical circuitry arrangement e1174 when activated will perform the operation o1174. In an implementation, the receiving information gesture electrical circuitry arrangement e1174, when activated performs electronically receiving the selection information of the one or more selected ingestible products via the electronically enabled input in response to the electronically outputted one or more selection menus to provide the selection opportunity in response thereto via electronically enabled input including via electronic based gesture recognition (e.g. an implementation of the receiver component s528 is configured to electronically engage with the optical sensing component s418 to receive the electronically enabled input as inputted by a user, etc.). In an implementation, the electronically receiving the selection information of the one or more selected ingestible products via the electronically enabled input in response to the electronically outputted one or more selection menus to provide selection opportunity in response thereto via electronically enabled input including via electronic based gesture recognition is carried out by electronically receiving the selection information of the one or more selected ingestible products via the electronically enabled input in response to the electronically outputted one or more selection menus to provide the selection opportunity in response thereto via electronically enabled input including via electronic based gesture recognition (e.g. an implementation of the receiver component s528 is configured to electronically engage with the optical sensing component s418 to receive the electronically enabled input as inputted by a user, etc.).

In one or more implementations, operation o11 includes an operation o1175 for electronically receiving the selection information of the one or more selected ingestible products via the electronically enabled input in response to the electronically outputted one or more selection menus to provide selection opportunity in response thereto via electronically enabled input including via electronic audio recording of the particular individual living being. A non-transitory signal bearing medium includes one or more receiving information audio instructions i1175 that when executed will direct performance of the operation o1175. In an implementation, the one or more receiving information audio instructions i1175 when executed direct electronically receiving the selection information of the one or more selected ingestible products via the electronically enabled input in response to the electronically outputted one or more selection menus to provide the selection opportunity in response thereto via electronically enabled input including via an electronic audio recording of the particular individual living being (e.g. an implementation of the receiver component s528 is configured to electronically engage with the sound sensing component s420 to receive the electronically enabled input, etc.). Furthermore, the receiving information audio electrical circuitry arrangement e1175 when activated will perform the operation o1175. In an implementation, the receiving information audio electrical circuitry arrangement e1175, when activated performs electronically receiving the selection information of the one or more selected ingestible products via the electronically enabled input in response to the electronically outputted one or more selection menus to provide the selection opportunity in response thereto via electronically enabled input including via an electronic audio recording of the particular individual living being (e.g. an implementation of the receiver component s528 is configured to electronically engage with the sound sensing component s420 to receive the electronically enabled input, etc.). In an implementation, the electronically receiving the selection information of the one or more selected ingestible products via the electronically enabled input in response to the electronically outputted one or more selection menus to provide selection opportunity in response thereto via electronically enabled input including via electronic audio recording of the particular individual living being is carried out by electronically receiving the selection information of the one or more selected ingestible products via the electronically enabled input in response to the electronically outputted one or more selection menus to provide the selection opportunity in response thereto via electronically enabled input including via an electronic audio recording of the particular individual living being (e.g. an implementation of the receiver component s528 is configured to electronically engage with the sound sensing component s420 to receive the electronically enabled input, etc.).

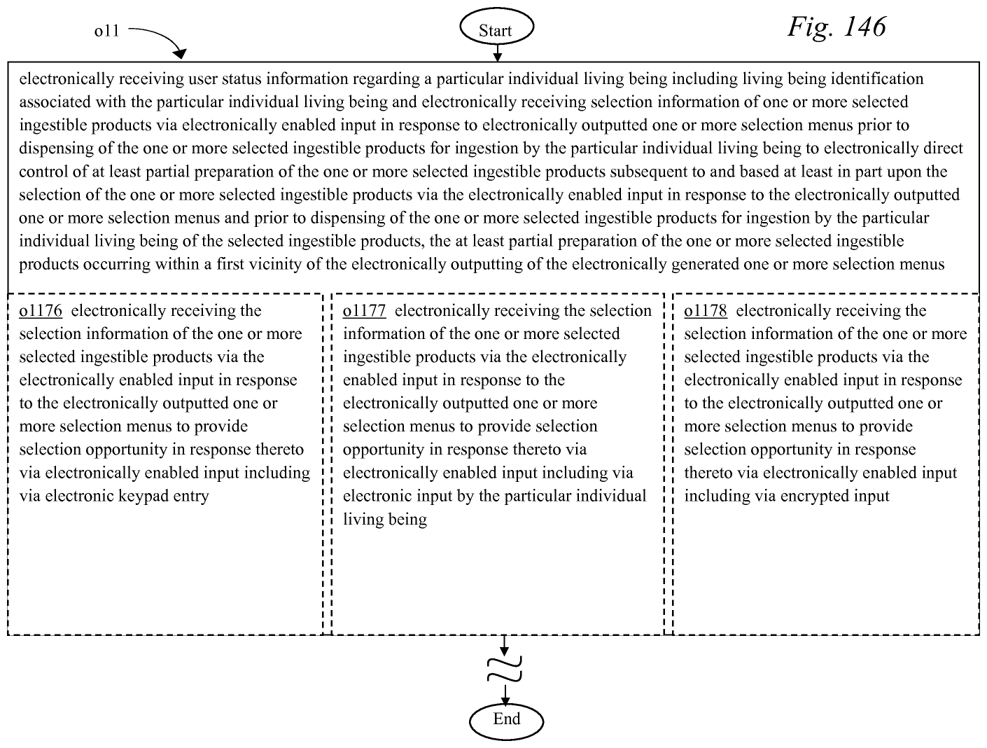

In one or more implementations, as shown in FIG. 146, operation o11 includes an operation o1176 for electronically receiving the selection information of the one or more selected ingestible products via the electronically enabled input in response to the electronically outputted one or more selection menus to provide selection opportunity in response thereto via electronically enabled input including via electronic keypad entry. An exemplary version of a non-transitory signal bearing medium of information storage subsystem s200 is depicted as bearing one or more receiving information keypad instructions i1176 that when executed will direct performance of the operation o1176. In an implementation, the one or more receiving information keypad instructions i1176 when executed direct electronically receiving the selection information of the one or more selected ingestible products via the electronically enabled input in response to the electronically outputted one or more selection menus to provide the selection opportunity in response thereto via electronically enabled input including via electronic keypad entry (e.g. an implementation of the receiver component s528 is configured to electronically engage with the keypad component s308 to receive the electronically enabled input, etc.). Furthermore, the receiving information keypad electrical circuitry arrangement e1176 when activated will perform the operation o1176. In an implementation, the receiving information keypad electrical circuitry arrangement e1176, when activated performs electronically receiving the selection information of the one or more selected ingestible products via the electronically enabled input in response to the electronically outputted one or more selection menus to provide the selection opportunity in response thereto via electronically enabled input including via electronic keypad entry (e.g. an implementation of the receiver component s528 is configured to electronically engage with the keypad component s308 to receive the electronically enabled input, etc.). In an implementation, the electronically receiving the selection information of the one or more selected ingestible products via the electronically enabled input in response to the electronically outputted one or more selection menus to provide selection opportunity in response thereto via electronically enabled input including via electronic keypad entry is carried out by electronically receiving the selection information of the one or more selected ingestible products via the electronically enabled input in response to the electronically outputted one or more selection menus to provide the selection opportunity in response thereto via electronically enabled input including via electronic keypad entry (e.g. an implementation of the receiver component s528 is configured to electronically engage with the keypad component s308 to receive the electronically enabled input, etc.).

In one or more implementations, operation o11 includes an operation o1177 for electronically receiving the selection information of the one or more selected ingestible products via the electronically enabled input in response to the electronically outputted one or more selection menus to provide selection opportunity in response thereto via electronically enabled input including via electronic input by the particular individual living being. A non-transitory signal bearing medium includes one or more receiving information input instructions i1177 that when executed will direct performance of the operation o1177. In an implementation, the one or more receiving information input instructions i1177 when executed direct electronically receiving the selection information of the one or more selected ingestible products via the electronically enabled input in response to the electronically outputted one or more selection menus to provide the selection opportunity in response thereto via electronically enabled input including via an electronic input by the particular individual living being (e.g. an implementation of the receiver component s528 is configured to electronically engage with the electromagnetic sensing component s402 to receive the electronically enabled input, etc.). Furthermore, the receiving information input electrical circuitry arrangement e1177 when activated will perform the operation o1177. In an implementation, the receiving information input electrical circuitry arrangement e1177, when activated performs electronically receiving the selection information of the one or more selected ingestible products via the electronically enabled input in response to the electronically outputted one or more selection menus to provide the selection opportunity in response thereto via electronically enabled input including via an electronic input by the particular individual living being (e.g. an implementation of the receiver component s528 is configured to electronically engage with the electromagnetic sensing component s402 to receive the electronically enabled input, etc.). In an implementation, the electronically receiving the selection information of the one or more selected ingestible products via the electronically enabled input in response to the electronically outputted one or more selection menus to provide selection opportunity in response thereto via electronically enabled input including via electronic input by the particular individual living being is carried out by electronically receiving the selection information of the one or more selected ingestible products via the electronically enabled input in response to the electronically outputted one or more selection menus to provide the selection opportunity in response thereto via electronically enabled input including via an electronic input by the particular individual living being (e.g. an implementation of the receiver component s528 is configured to electronically engage with the electromagnetic sensing component s402 to receive the electronically enabled input, etc.).

In one or more implementations, operation o11 includes an operation o1178 for electronically receiving the selection information of the one or more selected ingestible products via the electronically enabled input in response to the electronically outputted one or more selection menus to provide selection opportunity in response thereto via electronically enabled input including via encrypted input. A non-transitory signal bearing medium includes one or more receiving information encrypted instructions i1178 that when executed will direct performance of the operation o1178. In an implementation, the one or more receiving information encrypted instructions i1178 when executed direct electronically receiving the selection information of the one or more selected ingestible products via the electronically enabled input in response to the electronically outputted one or more selection menus to provide the selection opportunity in response thereto via electronically enabled input including via encrypted input (e.g. an implementation of the receiver component s528 is configured to electronically engage with the encrypted communication component s520 to receive the electronically enabled input, etc.). Furthermore, the receiving information encrypted electrical circuitry arrangement e1178 when activated will perform the operation o1178. In an implementation, the receiving information encrypted electrical circuitry arrangement e1178, when activated performs electronically receiving the selection information of the one or more selected ingestible products via the electronically enabled input in response to the electronically outputted one or more selection menus to provide the selection opportunity in response thereto via electronically enabled input including via encrypted input (e.g. an implementation of the receiver component s528 is configured to electronically engage with the encrypted communication component s520 to receive the electronically enabled input, etc.). In an implementation, the electronically receiving the selection information of the one or more selected ingestible products via the electronically enabled input in response to the electronically outputted one or more selection menus to provide selection opportunity in response thereto via electronically enabled input including via encrypted input is carried out by electronically receiving the selection information of the one or more selected ingestible products via the electronically enabled input in response to the electronically outputted one or more selection menus to provide the selection opportunity in response thereto via electronically enabled input including via encrypted input (e.g. an implementation of the receiver component s528 is configured to electronically engage with the encrypted communication component s520 to receive the electronically enabled input, etc.).

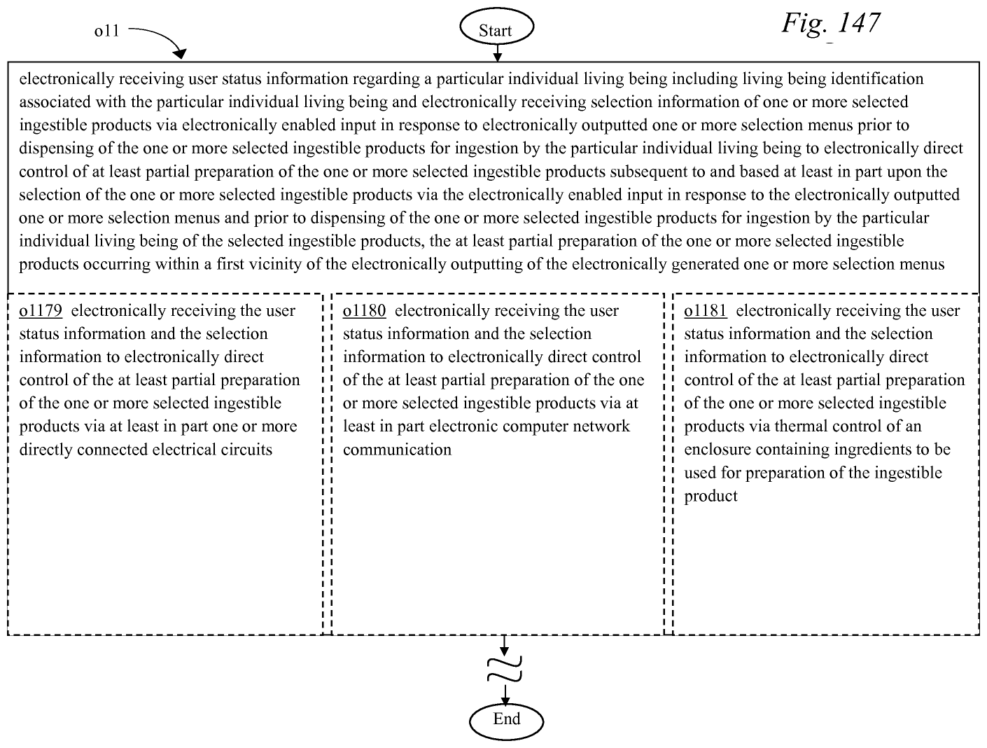

In one or more implementations, as shown in FIG. 147, operation o11 includes an operation o1179 for electronically receiving the user status information and the selection information to electronically direct control of the at least partial preparation of the one or more selected ingestible products via at least in part one or more directly connected electrical circuits. An exemplary version of a non-transitory signal bearing medium of information storage subsystem s200 is depicted as bearing one or more control prep connected instructions i1179 that when executed will direct performance of the operation o1179. In an implementation, the one or more control prep connected instructions i1179 when executed direct electronically receiving the user status information and the selection information to electronically direct control of the at least partial preparation of the one or more selected ingestible products via at least in part one or more directly connected electrical circuits (e.g. an implementation of the microprocessor component s102 is configured to electronically receive the user status information end the selection information through receiver component s528 co-located within a common housing of the ingestible product preparation system 10 to control the material processing subsystem 700 in preparation of the one or more ingestible products, etc.). Furthermore, the control prep connected electrical circuitry arrangement e1179 when activated will perform the operation o1179. In an implementation, the control prep connected electrical circuitry arrangement e1179, when activated performs electronically receiving the user status information and the selection information to electronically direct control of the at least partial preparation of the one or more selected ingestible products via at least in part one or more directly connected electrical circuits (e.g. an implementation of the microprocessor component s102 is configured to electronically receive the user status information end the selection information through receiver component s528 co-located within a common housing of the ingestible product preparation system 10 to control the material processing subsystem 700 in preparation of the one or more ingestible products, etc.). In an implementation, the electronically receiving the user status information and the selection information to electronically direct control of the at least partial preparation of the one or more selected ingestible products via at least in part one or more directly connected electrical circuits is carried out by electronically receiving the user status information and the selection information to electronically direct control of the at least partial preparation of the one or more selected ingestible products via at least in part one or more directly connected electrical circuits (e.g. an implementation of the microprocessor component s102 is configured to electronically receive the user status information end the selection information through receiver component s528 co-located within a common housing of the ingestible product preparation system 10 to control the material processing subsystem 700 in preparation of the one or more ingestible products, etc.).

In one or more implementations, operation o11 includes an operation o1180 for electronically receiving the user status information and the selection information to electronically direct control of the at least partial preparation of the one or more selected ingestible products via at least in part electronic computer network communication. A non-transitory signal bearing medium includes one or more control prep network instructions i1180 that when executed will direct performance of the operation o1180. In an implementation, the one or more control prep network instructions i1180 when executed direct electronically receiving the user status information and the selection information to electronically direct control of the at least partial preparation of the one or more selected ingestible products via at least in part electronic computer network communication (e.g. an implementation of the microprocessor component s102 is configured to electronically receive the user status information end the selection information through internet network components s508 to control the material processing subsystem 700 in preparation of the one or more ingestible products, etc.). Furthermore, the control prep network electrical circuitry arrangement e1180 when activated will perform the operation o1180. In an implementation, the control prep network electrical circuitry arrangement e1180, when activated performs electronically receiving the user status information and the selection information to electronically direct control of the at least partial preparation of the one or more selected ingestible products via at least in part electronic computer network communication (e.g. an implementation of the microprocessor component s102 is configured to electronically receive the user status information end the selection information through internet network components s508 to control the material processing subsystem 700 in preparation of the one or more ingestible products, etc.). In an implementation, the electronically receiving the user status information and the selection information to electronically direct control of the at least partial preparation of the one or more selected ingestible products via at least in part electronic computer network communication is carried out by electronically receiving the user status information and the selection information to electronically direct control of the at least partial preparation of the one or more selected ingestible products via at least in part electronic computer network communication (e.g. an implementation of the microprocessor component s102 is configured to electronically receive the user status information end the selection information through internet network components s508 to control the material processing subsystem 700 in preparation of the one or more ingestible products, etc.).

In one or more implementations, operation o11 includes an operation o1181 for electronically receiving the user status information and the selection information to electronically direct control of the at least partial preparation of the one or more selected ingestible products via thermal control of an enclosure containing ingredients to be used for preparation of the ingestible product. A non-transitory signal bearing medium includes one or more control prep thermal instructions i1181 that when executed will direct performance of the operation o1181. In an implementation, the one or more control prep thermal instructions i1181 when executed direct electronically receiving the user status information and the selection information to electronically direct control of the at least partial preparation of the one or more selected ingestible products via thermal control of an enclosure containing ingredients to be used for preparation of the ingestible product (e.g. an implementation of the microprocessor component s102 is configured to electronically control the laser component s708 according to a temperature profile included in the user status information or the selection information received thereby, etc.). Furthermore, the control prep thermal electrical circuitry arrangement e1181 when activated will perform the operation o1181. In an implementation, the control prep thermal electrical circuitry arrangement e1181, when activated performs electronically receiving the user status information and the selection information to electronically direct control of the at least partial preparation of the one or more selected ingestible products via thermal control of an enclosure containing ingredients to be used for preparation of the ingestible product (e.g. an implementation of the microprocessor component s102 is configured to electronically control the laser component s708 according to a temperature profile included in the user status information or the selection information received thereby, etc.). In an implementation, the electronically receiving the user status information and the selection information to electronically direct control of the at least partial preparation of the one or more selected ingestible products via thermal control of an enclosure containing ingredients to be used for preparation of the ingestible product is carried out by electronically receiving the user status information and the selection information to electronically direct control of the at least partial preparation of the one or more selected ingestible products via thermal control of an enclosure containing ingredients to be used for preparation of the ingestible product (e.g. an implementation of the microprocessor component s102 is configured to electronically control the laser component s708 according to a temperature profile included in the user status information or the selection information received thereby, etc.).

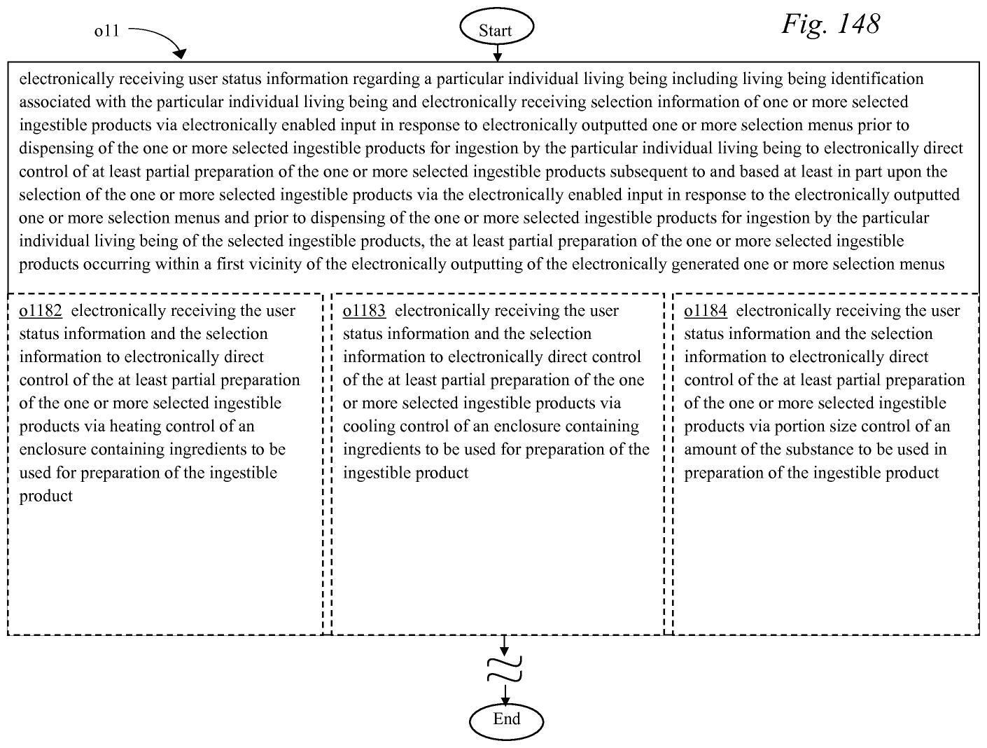

In one or more implementations, as shown in FIG. 148, operation o11 includes an operation o1182 for electronically receiving the user status information and the selection information to electronically direct control of the at least partial preparation of the one or more selected ingestible products via heating control of an enclosure containing ingredients to be used for preparation of the ingestible product. An exemplary version of a non-transitory signal bearing medium of information storage subsystem s200 is depicted as bearing one or more control prep heating instructions i1182 that when executed will direct performance of the operation o1182. In an implementation, the one or more control prep heating instructions i1182 when executed direct electronically receiving the user status information and the selection information to electronically direct control of the at least partial preparation of the one or more selected ingestible products via heating control of an enclosure containing ingredients to be used for preparation of the ingestible product (e.g. an implementation of the microprocessor component s102 is configured to electronically control the heating component s702 according to a temperature profile included in the user status information or the selection information received thereby, etc.). Furthermore, the control prep heating electrical circuitry arrangement e1182 when activated will perform the operation o1182. In an implementation, the control prep heating electrical circuitry arrangement e1182, when activated performs electronically receiving the user status information and the selection information to electronically direct control of the at least partial preparation of the one or more selected ingestible products via heating control of an enclosure containing ingredients to be used for preparation of the ingestible product (e.g. an implementation of the microprocessor component s102 is configured to electronically control the heating component s702 according to a temperature profile included in the user status information or the selection information received thereby, etc.). In an implementation, the electronically receiving the user status information and the selection information to electronically direct control of the at least partial preparation of the one or more selected ingestible products via heating control of an enclosure containing ingredients to be used for preparation of the ingestible product is carried out by electronically receiving the user status information and the selection information to electronically direct control of the at least partial preparation of the one or more selected ingestible products via heating control of an enclosure containing ingredients to be used for preparation of the ingestible product (e.g. an implementation of the microprocessor component s102 is configured to electronically control the heating component s702 according to a temperature profile included in the user status information or the selection information received thereby, etc.).

In one or more implementations, operation o11 includes an operation o1183 for electronically receiving the user status information and the selection information to electronically direct control of the at least partial preparation of the one or more selected ingestible products via cooling control of an enclosure containing ingredients to be used for preparation of the ingestible product. A non-transitory signal bearing medium includes one or more control prep cooling instructions i1183 that when executed will direct performance of the operation o1183. In an implementation, the one or more control prep cooling instructions i1183 when executed direct electronically receiving the user status information and the selection information to electronically direct control of the at least partial preparation of the one or more selected ingestible products via cooling control of an enclosure containing ingredients to be used for preparation of the ingestible product (e.g. an implementation of the microprocessor component s102 is configured to electronically control the cooling component s704 according to a temperature profile included in the user status information or the selection information received thereby, etc.). Furthermore, the control prep cooling electrical circuitry arrangement e1183 when activated will perform the operation o1183. In an implementation, the control prep cooling electrical circuitry arrangement e1183, when activated performs electronically receiving the user status information and the selection information to electronically direct control of the at least partial preparation of the one or more selected ingestible products via cooling control of an enclosure containing ingredients to be used for preparation of the ingestible product (e.g. an implementation of the microprocessor component s102 is configured to electronically control the cooling component s704 according to a temperature profile included in the user status information or the selection information received thereby, etc.). In an implementation, the electronically receiving the user status information and the selection information to electronically direct control of the at least partial preparation of the one or more selected ingestible products via cooling control of an enclosure containing ingredients to be used for preparation of the ingestible product is carried out by electronically receiving the user status information and the selection information to electronically direct control of the at least partial preparation of the one or more selected ingestible products via cooling control of an enclosure containing ingredients to be used for preparation of the ingestible product (e.g. an implementation of the microprocessor component s102 is configured to electronically control the cooling component s704 according to a temperature profile included in the user status information or the selection information received thereby, etc.).

In one or more implementations, operation o11 includes an operation o1184 for electronically receiving the user status information and the selection information to electronically direct control of the at least partial preparation of the one or more selected ingestible products via portion size control of an amount of the substance to be used in preparation of the ingestible product. A non-transitory signal bearing medium includes one or more control prep portion instructions i1184 that when executed will direct performance of the operation o1184. In an implementation, the one or more control prep portion instructions i1184 when executed direct electronically receiving the user status information and the selection information to electronically direct control of the at least partial preparation of the one or more selected ingestible products via portion size control of an amount of the substance to be used in preparation of the ingestible product (e.g. an implementation of the microprocessor component s102 is configured to electronically control the sorting component s728 according to a ingredient size distribution profile included in the user status information or the selection information received thereby, etc.). Furthermore, the control prep portion electrical circuitry arrangement e1184 when activated will perform the operation o1184. In an implementation, the control prep portion electrical circuitry arrangement e1184, when activated performs electronically receiving the user status information and the selection information to electronically direct control of the at least partial preparation of the one or more selected ingestible products via portion size control of an amount of the substance to be used in preparation of the ingestible product (e.g. an implementation of the microprocessor component s102 is configured to electronically control the sorting component s728 according to a ingredient size distribution profile included in the user status information or the selection information received thereby, etc.). In an implementation, the electronically receiving the user status information and the selection information to electronically direct control of the at least partial preparation of the one or more selected ingestible products via portion size control of an amount of the substance to be used in preparation of the ingestible product is carried out by electronically receiving the user status information and the selection information to electronically direct control of the at least partial preparation of the one or more selected ingestible products via portion size control of an amount of the substance to be used in preparation of the ingestible product (e.g. an implementation of the microprocessor component s102 is configured to electronically control the sorting component s728 according to a ingredient size distribution profile included in the user status information or the selection information received thereby, etc.).

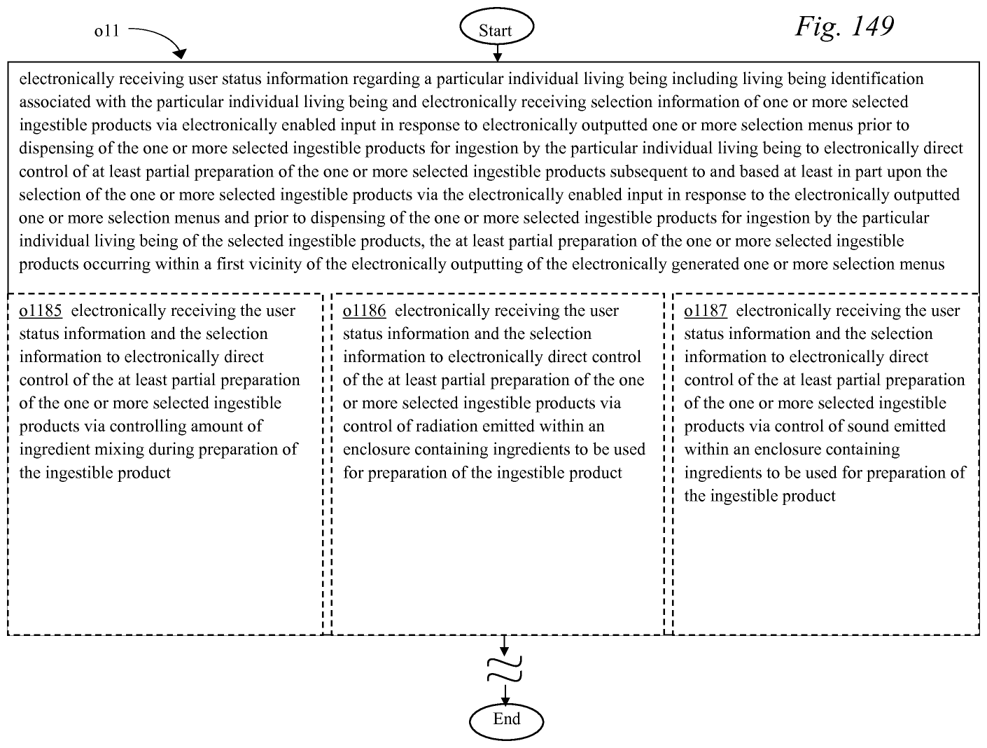

In one or more implementations, as shown in FIG. 149, operation o11 includes an operation o1185 for electronically receiving the user status information and the selection information to electronically direct control of the at least partial preparation of the one or more selected ingestible products via controlling amount of ingredient mixing during preparation of the ingestible product. An exemplary version of a non-transitory signal bearing medium of information storage subsystem s200 is depicted as bearing one or more control prep mixing instructions i1185 that when executed will direct performance of the operation o1185. In an implementation, the one or more control prep mixing instructions i1185 when executed direct electronically receiving the user status information and the selection information to electronically direct control of the at least partial preparation of the one or more selected ingestible products via controlling amount of ingredient mixing during preparation of the ingestible product (e.g. an implementation of the microprocessor component s102 is configured to electronically control the mixer component s716 according to a mixing profile included in the user status information or the selection information received thereby, etc.). Furthermore, the control prep mixing electrical circuitry arrangement e1185 when activated will perform the operation o1185. In an implementation, the control prep mixing electrical circuitry arrangement e1185, when activated performs electronically receiving the user status information and the selection information to electronically direct control of the at least partial preparation of the one or more selected ingestible products via controlling amount of ingredient mixing during preparation of the ingestible product (e.g. an implementation of the microprocessor component s102 is configured to electronically control the mixer component s716 according to a mixing profile included in the user status information or the selection information received thereby, etc.). In an implementation, the electronically receiving the user status information and the selection information to electronically direct control of the at least partial preparation of the one or more selected ingestible products via controlling amount of ingredient mixing during preparation of the ingestible product is carried out by electronically receiving the user status information and the selection information to electronically direct control of the at least partial preparation of the one or more selected ingestible products via controlling amount of ingredient mixing during preparation of the ingestible product (e.g. an implementation of the microprocessor component s102 is configured to electronically control the mixer component s716 according to a mixing profile included in the user status information or the selection information received thereby, etc.).

In one or more implementations, operation o11 includes an operation o1186 for electronically receiving the user status information and the selection information to electronically direct control of the at least partial preparation of the one or more selected ingestible products via control of radiation emitted within an enclosure containing ingredients to be used for preparation of the ingestible product. A non-transitory signal bearing medium includes one or more control prep radiation instructions i1186 that when executed will direct performance of the operation o1186. In an implementation, the one or more control prep radiation instructions i1186 when executed direct electronically receiving the user status information and the selection information to electronically direct control of the at least partial preparation of the one or more selected ingestible products via control of radiation emitted within an enclosure containing ingredients to be used for preparation of the ingestible product (e.g. an implementation of the microprocessor component s102 is configured to electronically control the energy emitting component s724 configured to emit radiation according to a radiation profile included in the user status information or the selection information received thereby, etc.). Furthermore, the control prep radiation electrical circuitry arrangement e1186 when activated will perform the operation o1186. In an implementation, the control prep radiation electrical circuitry arrangement e1186, when activated performs electronically receiving the user status information and the selection information to electronically direct control of the at least partial preparation of the one or more selected ingestible products via control of radiation emitted within an enclosure containing ingredients to be used for preparation of the ingestible product (e.g. an implementation of the microprocessor component s102 is configured to electronically control the energy emitting component s724 configured to emit radiation according to a radiation profile included in the user status information or the selection information received thereby, etc.). In an implementation, the electronically receiving the user status information and the selection information to electronically direct control of the at least partial preparation of the one or more selected ingestible products via control of radiation emitted within an enclosure containing ingredients to be used for preparation of the ingestible product is carried out by electronically receiving the user status information and the selection information to electronically direct control of the at least partial preparation of the one or more selected ingestible products via control of radiation emitted within an enclosure containing ingredients to be used for preparation of the ingestible product (e.g. an implementation of the microprocessor component s102 is configured to electronically control the energy emitting component s724 configured to emit radiation according to a radiation profile included in the user status information or the selection information received thereby, etc.).

In one or more implementations, operation o11 includes an operation o1187 for electronically receiving the user status information and the selection information to electronically direct control of the at least partial preparation of the one or more selected ingestible products via control of sound emitted within an enclosure containing ingredients to be used for preparation of the ingestible product. A non-transitory signal bearing medium includes one or more control prep sound instructions i1187 that when executed will direct performance of the operation o1187. In an implementation, the one or more control prep sound instructions i1187 when executed direct electronically receiving the user status information and the selection information to electronically direct control of the at least partial preparation of the one or more selected ingestible products via control of sound emitted within an enclosure containing ingredients to be used for preparation of the ingestible product (e.g. an implementation of the microprocessor component s102 is configured to electronically control the acoustic energy component s718 according to an acoustic energy profile included in the user status information or the selection information received thereby, etc.). Furthermore, the control prep sound electrical circuitry arrangement e1187 when activated will perform the operation o1187. In an implementation, the control prep sound electrical circuitry arrangement e1187, when activated performs electronically receiving the user status information and the selection information to electronically direct control of the at least partial preparation of the one or more selected ingestible products via control of sound emitted within an enclosure containing ingredients to be used for preparation of the ingestible product (e.g. an implementation of the microprocessor component s102 is configured to electronically control the acoustic energy component s718 according to an acoustic energy profile included in the user status information or the selection information received thereby, etc.). In an implementation, the electronically receiving the user status information and the selection information to electronically direct control of the at least partial preparation of the one or more selected ingestible products via control of sound emitted within an enclosure containing ingredients to be used for preparation of the ingestible product is carried out by electronically receiving the user status information and the selection information to electronically direct control of the at least partial preparation of the one or more selected ingestible products via control of sound emitted within an enclosure containing ingredients to be used for preparation of the ingestible product (e.g. an implementation of the microprocessor component s102 is configured to electronically control the acoustic energy component s718 according to an acoustic energy profile included in the user status information or the selection information received thereby, etc.).

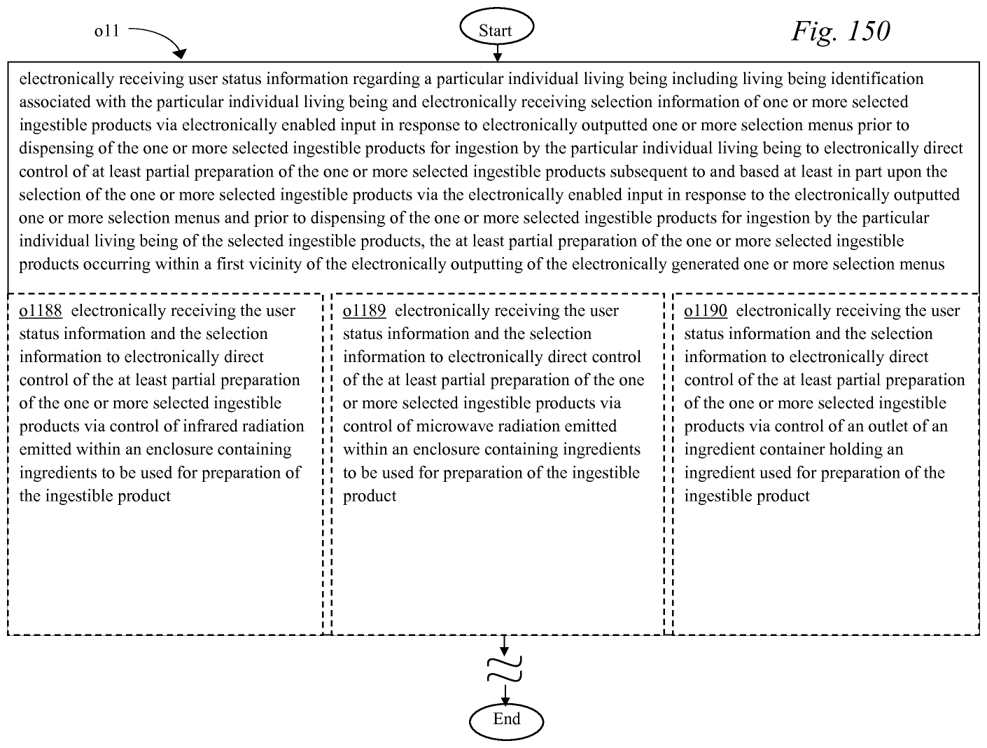

In one or more implementations, as shown in FIG. 150, operation o11 includes an operation o1188 for electronically receiving the user status information and the selection information to electronically direct control of the at least partial preparation of the one or more selected ingestible products via control of infrared radiation emitted within an enclosure containing ingredients to be used for preparation of the ingestible product. An exemplary version of a non-transitory signal bearing medium of information storage subsystem s200 is depicted as bearing one or more control prep infrared instructions i1188 that when executed will direct performance of the operation o1188. In an implementation, the one or more control prep infrared instructions i1188 when executed direct electronically receiving the user status information and the selection information to electronically direct control of the at least partial preparation of the one or more selected ingestible products via control of infrared radiation emitted within an enclosure containing ingredients to be used for preparation of the ingestible product (e.g. an implementation of the microprocessor component s102 is configured to electronically control the infrared component s730 according to a temperature profile included in the user status information or the selection information received thereby, etc.). Furthermore, the control prep infrared electrical circuitry arrangement e1188 when activated will perform the operation o1188. In an implementation, the control prep infrared electrical circuitry arrangement e1188, when activated performs electronically receiving the user status information and the selection information to electronically direct control of the at least partial preparation of the one or more selected ingestible products via control of infrared radiation emitted within an enclosure containing ingredients to be used for preparation of the ingestible product (e.g. an implementation of the microprocessor component s102 is configured to electronically control the infrared component s730 according to a temperature profile included in the user status information or the selection information received thereby, etc.). In an implementation, the electronically receiving the user status information and the selection information to electronically direct control of the at least partial preparation of the one or more selected ingestible products via control of infrared radiation emitted within an enclosure containing ingredients to be used for preparation of the ingestible product is carried out by electronically receiving the user status information and the selection information to electronically direct control of the at least partial preparation of the one or more selected ingestible products via control of infrared radiation emitted within an enclosure containing ingredients to be used for preparation of the ingestible product (e.g. an implementation of the microprocessor component s102 is configured to electronically control the infrared component s730 according to a temperature profile included in the user status information or the selection information received thereby, etc.).

In one or more implementations, operation o11 includes an operation o1189 for electronically receiving the user status information and the selection information to electronically direct control of the at least partial preparation of the one or more selected ingestible products via control of microwave radiation emitted within an enclosure containing ingredients to be used for preparation of the ingestible product. A non-transitory signal bearing medium includes one or more control prep microwave instructions i1189 that when executed will direct performance of the operation o1189. In an implementation, the one or more control prep microwave instructions i1189 when executed direct electronically receiving the user status information and the selection information to electronically direct control of the at least partial preparation of the one or more selected ingestible products via control of microwave radiation emitted within an enclosure containing ingredients to be used for preparation of the ingestible product (e.g. an implementation of the microprocessor component s102 is configured to electronically control the microwave component s706 according to a temperature profile included in the user status information or the selection information received thereby, etc.). Furthermore, the control prep microwave electrical circuitry arrangement e1189 when activated will perform the operation o1189. In an implementation, the control prep microwave electrical circuitry arrangement e1189, when activated performs electronically receiving the user status information and the selection information to electronically direct control of the at least partial preparation of the one or more selected ingestible products via control of microwave radiation emitted within an enclosure containing ingredients to be used for preparation of the ingestible product (e.g. an implementation of the microprocessor component s102 is configured to electronically control the microwave component s706 according to a temperature profile included in the user status information or the selection information received thereby, etc.). In an implementation, the electronically receiving the user status information and the selection information to electronically direct control of the at least partial preparation of the one or more selected ingestible products via control of microwave radiation emitted within an enclosure containing ingredients to be used for preparation of the ingestible product is carried out by electronically receiving the user status information and the selection information to electronically direct control of the at least partial preparation of the one or more selected ingestible products via control of microwave radiation emitted within an enclosure containing ingredients to be used for preparation of the ingestible product (e.g. an implementation of the microprocessor component s102 is configured to electronically control the microwave component s706 according to a temperature profile included in the user status information or the selection information received thereby, etc.).

In one or more implementations, operation o11 includes an operation o1190 for electronically receiving the user status information and the selection information to electronically direct control of the at least partial preparation of the one or more selected ingestible products via control of an outlet of an ingredient container holding an ingredient used for preparation of the ingestible product. A non-transitory signal bearing medium includes one or more control prep container instructions i1190 that when executed will direct performance of the operation o1190. In an implementation, the one or more control prep container instructions i1190 when executed direct electronically receiving the user status information and the selection information to electronically direct control of the at least partial preparation of the one or more selected ingestible products via control of an outlet of an ingredient container holding an ingredient used for preparation of the ingestible product (e.g. an implementation of the microprocessor component s102 is configured to electronically control an outlet of the material storage component s734 configured as an ingredient container according to an access profile included in the user status information or the selection information received thereby, etc.). Furthermore, the control prep container electrical circuitry arrangement e1190 when activated will perform the operation o1190. In an implementation, the control prep container electrical circuitry arrangement e1190, when activated performs electronically receiving the user status information and the selection information to electronically direct control of the at least partial preparation of the one or more selected ingestible products via control of an outlet of an ingredient container holding an ingredient used for preparation of the ingestible product (e.g. an implementation of the microprocessor component s102 is configured to electronically control an outlet of the material storage component s734 configured as an ingredient container according to an access profile included in the user status information or the selection information received thereby, etc.). In an implementation, the electronically receiving the user status information and the selection information to electronically direct control of the at least partial preparation of the one or more selected ingestible products via control of an outlet of an ingredient container holding an ingredient used for preparation of the ingestible product is carried out by electronically receiving the user status information and the selection information to electronically direct control of the at least partial preparation of the one or more selected ingestible products via control of an outlet of an ingredient container holding an ingredient used for preparation of the ingestible product (e.g. an implementation of the microprocessor component s102 is configured to electronically control an outlet of the material storage component s734 configured as an ingredient container according to an access profile included in the user status information or the selection information received thereby, etc.).

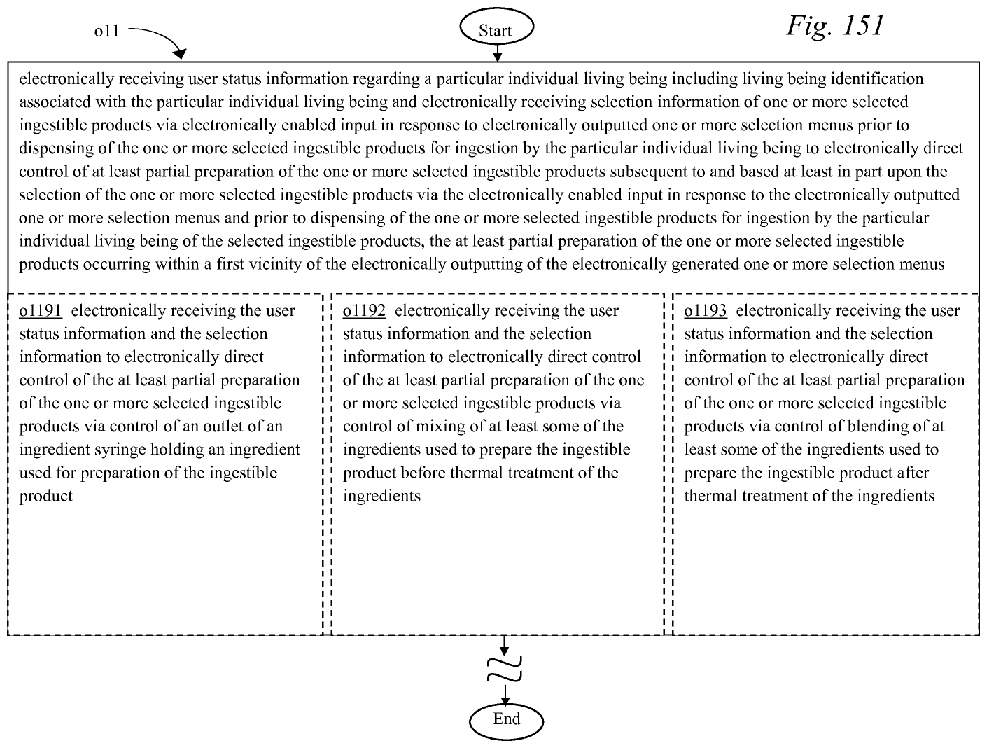

In one or more implementations, as shown in FIG. 151, operation o11 includes an operation o1191 for electronically receiving the user status information and the selection information to electronically direct control of the at least partial preparation of the one or more selected ingestible products via control of an outlet of an ingredient syringe holding an ingredient used for preparation of the ingestible product. An exemplary version of a non-transitory signal bearing medium of information storage subsystem s200 is depicted as bearing one or more control prep syringe instructions i1191 that when executed will direct performance of the operation o1191. In an implementation, the one or more control prep syringe instructions i1191 when executed direct electronically receiving the user status information and the selection information to electronically direct control of the at least partial preparation of the one or more selected ingestible products via control of an outlet of an ingredient syringe holding an ingredient used for preparation of the ingestible product (e.g. an implementation of the microprocessor component s102 is configured to electronically control an outlet of the material storage component s734 configured as an ingredient syringe according to an access profile included in the user status information or the selection information received thereby, etc.). Furthermore, the control prep syringe electrical circuitry arrangement e1191 when activated will perform the operation o1191. In an implementation, the control prep syringe electrical circuitry arrangement e1191, when activated performs electronically receiving the user status information and the selection information to electronically direct control of the at least partial preparation of the one or more selected ingestible products via control of an outlet of an ingredient syringe holding an ingredient used for preparation of the ingestible product (e.g. an implementation of the microprocessor component s102 is configured to electronically control an outlet of the material storage component s734 configured as an ingredient syringe according to an access profile included in the user status information or the selection information received thereby, etc.). In an implementation, the electronically receiving the user status information and the selection information to electronically direct control of the at least partial preparation of the one or more selected ingestible products via control of an outlet of an ingredient syringe holding an ingredient used for preparation of the ingestible product is carried out by electronically receiving the user status information and the selection information to electronically direct control of the at least partial preparation of the one or more selected ingestible products via control of an outlet of an ingredient syringe holding an ingredient used for preparation of the ingestible product (e.g. an implementation of the microprocessor component s102 is configured to electronically control an outlet of the material storage component s734 configured as an ingredient syringe according to an access profile included in the user status information or the selection information received thereby, etc.).

In one or more implementations, operation o11 includes an operation o1192 for electronically receiving the user status information and the selection information to electronically direct control of the at least partial preparation of the one or more selected ingestible products via control of mixing of at least some of the ingredients used to prepare the ingestible product before thermal treatment of the ingredients. A non-transitory signal bearing medium includes one or more control prep mix before thermal instructions i1192 that when executed will direct performance of the operation o1192. In an implementation, the one or more control prep mix before thermal instructions i1192 when executed direct electronically receiving the user status information and the selection information to electronically direct control of the at least partial preparation of the one or more selected ingestible products via control of mixing of at least some of the ingredients used to prepare the ingestible product before thermal treatment of the ingredients (e.g. an implementation of the microprocessor component s102 is configured to electronically control the mixer component s716 according to a mixing profile included in the user status information or the selection information received thereby, etc.). Furthermore, the control prep mix before thermal electrical circuitry arrangement e1192 when activated will perform the operation o1192. In an implementation, the control prep mix before thermal electrical circuitry arrangement e1192, when activated performs electronically receiving the user status information and the selection information to electronically direct control of the at least partial preparation of the one or more selected ingestible products via control of mixing of at least some of the ingredients used to prepare the ingestible product before thermal treatment of the ingredients (e.g. an implementation of the microprocessor component s102 is configured to electronically control the mixer component s716 according to a mixing profile included in the user status information or the selection information received thereby, etc.). In an implementation, the electronically receiving the user status information and the selection information to electronically direct control of the at least partial preparation of the one or more selected ingestible products via control of mixing of at least some of the ingredients used to prepare the ingestible product before thermal treatment of the ingredients is carried out by electronically receiving the user status information and the selection information to electronically direct control of the at least partial preparation of the one or more selected ingestible products via control of mixing of at least some of the ingredients used to prepare the ingestible product before thermal treatment of the ingredients (e.g. an implementation of the microprocessor component s102 is configured to electronically control the mixer component s716 according to a mixing profile included in the user status information or the selection information received thereby, etc.).

In one or more implementations, operation o11 includes an operation o1193 for electronically receiving the user status information and the selection information to electronically direct control of the at least partial preparation of the one or more selected ingestible products via control of blending of at least some of the ingredients used to prepare the ingestible product after thermal treatment of the ingredients. A non-transitory signal bearing medium includes one or more control prep re mix after thermal instructions i1193 that when executed will direct performance of the operation o1193. In an implementation, the one or more control prep re mix after thermal instructions i1193 when executed direct electronically receiving the user status information and the selection information to electronically direct control of the at least partial preparation of the one or more selected ingestible products via control of blending of at least some of the ingredients used to prepare the ingestible product after thermal treatment of the ingredients (e.g. an implementation of the microprocessor component s102 is configured to electronically control the blending component s714 according to a blending profile involving some of the ingredients used to prepare the ingestible product included in the user status information, etc.). Furthermore, the control prep re mix after thermal electrical circuitry arrangement e1193 when activated will perform the operation o1193. In an implementation, the control prep re mix after thermal electrical circuitry arrangement e1193, when activated performs electronically receiving the user status information and the selection information to electronically direct control of the at least partial preparation of the one or more selected ingestible products via control of blending of at least some of the ingredients used to prepare the ingestible product after thermal treatment of the ingredients (e.g. an implementation of the microprocessor component s102 is configured to electronically control the blending component s714 according to a blending profile involving some of the ingredients used to prepare the ingestible product included in the user status information, etc.). In an implementation, the electronically receiving the user status information and the selection information to electronically direct control of the at least partial preparation of the one or more selected ingestible products via control of blending of at least some of the ingredients used to prepare the ingestible product after thermal treatment of the ingredients is carried out by electronically receiving the user status information and the selection information to electronically direct control of the at least partial preparation of the one or more selected ingestible products via control of blending of at least some of the ingredients used to prepare the ingestible product after thermal treatment of the ingredients (e.g. an implementation of the microprocessor component s102 is configured to electronically control the blending component s714 according to a blending profile involving some of the ingredients used to prepare the ingestible product included in the user status information, etc.).

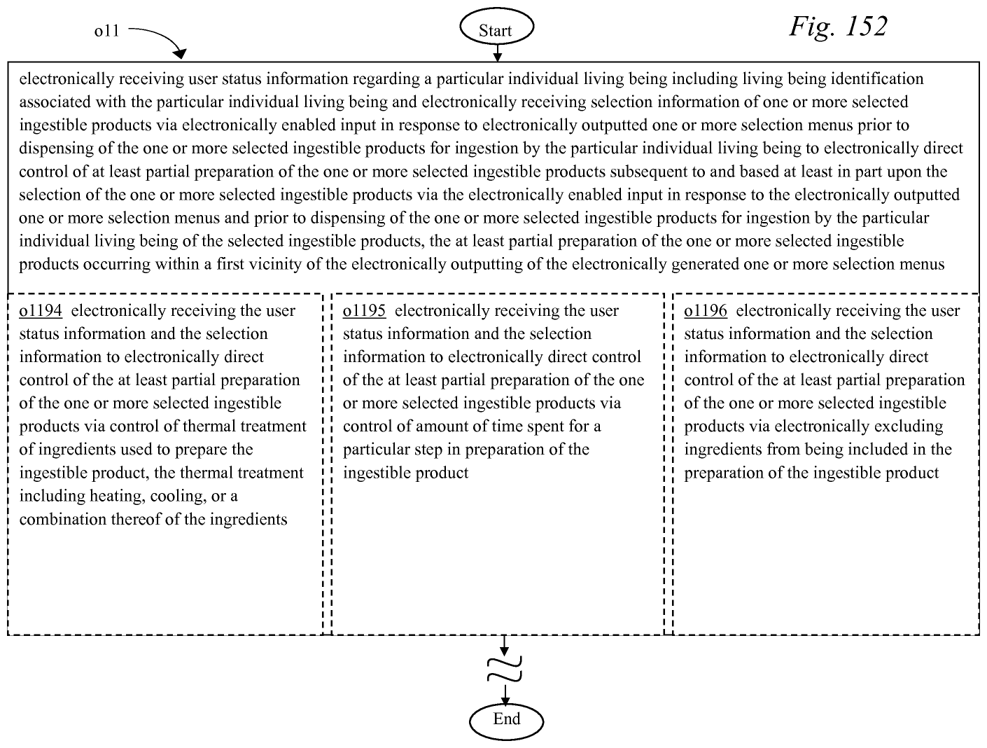

In one or more implementations, as shown in FIG. 152, operation o11 includes an operation o1194 for electronically receiving the user status information and the selection information to electronically direct control of the at least partial preparation of the one or more selected ingestible products via control of thermal treatment of ingredients used to prepare the ingestible product, the thermal treatment including heating, cooling, or a combination thereof of the ingredients. An exemplary version of a non-transitory signal bearing medium of information storage subsystem s200 is depicted as bearing one or more control prep heating cooling instructions i1194 that when executed will direct performance of the operation o1194. In an implementation, the one or more control prep heating cooling instructions i1194 when executed direct electronically receiving the user status information and the selection information to electronically direct control of the at least partial preparation of the one or more selected ingestible products via control of thermal treatment of ingredients used to prepare the ingestible product, thermal treatment including heating, cooling, or a combination thereof of the ingredients (e.g. an implementation of the microprocessor component s102 is configured to electronically control the heating component s702 and/or the cooling component s704 according to a thermal profile included in the user status information or the selection information received thereby, etc.). Furthermore, the control prep heating cooling electrical circuitry arrangement e1194 when activated will perform the operation o1194. In an implementation, the control prep heating cooling electrical circuitry arrangement e1194, when activated performs electronically receiving the user status information and the selection information to electronically direct control of the at least partial preparation of the one or more selected ingestible products via control of thermal treatment of ingredients used to prepare the ingestible product, thermal treatment including heating, cooling, or a combination thereof of the ingredients (e.g. an implementation of the microprocessor component s102 is configured to electronically control the heating component s702 and/or the cooling component s704 according to a thermal profile included in the user status information or the selection information received thereby, etc.). In an implementation, the electronically receiving the user status information and the selection information to electronically direct control of the at least partial preparation of the one or more selected ingestible products via control of thermal treatment of ingredients used to prepare the ingestible product, the thermal treatment including heating, cooling, or a combination thereof of the ingredients is carried out by electronically receiving the user status information and the selection information to electronically direct control of the at least partial preparation of the one or more selected ingestible products via control of thermal treatment of ingredients used to prepare the ingestible product, thermal treatment including heating, cooling, or a combination thereof of the ingredients (e.g. an implementation of the microprocessor component s102 is configured to electronically control the heating component s702 and/or the cooling component s704 according to a thermal profile included in the user status information or the selection information received thereby, etc.).

In one or more implementations, operation o11 includes an operation o1195 for electronically receiving the user status information and the selection information to electronically direct control of the at least partial preparation of the one or more selected ingestible products via control of amount of time spent for a particular step in preparation of the ingestible product. A non-transitory signal bearing medium includes one or more control prep time control instructions i1195 that when executed will direct performance of the operation o1195. In an implementation, the one or more control prep time control instructions i1195 when executed direct electronically receiving the user status information and the selection information to electronically direct control of the at least partial preparation of the one or more selected ingestible products via control of amount of time spent for a particular step in preparation of the ingestible product (e.g. an implementation of the microprocessor component s102 is configured to electronically control components of the material processing subsystem s700 based upon an internal clock of the microprocessor according to a time profile included in the user status information or the selection information received thereby, etc.). Furthermore, the control prep time control electrical circuitry arrangement e1195 when activated will perform the operation o1195. In an implementation, the control prep time control electrical circuitry arrangement e1195, when activated performs electronically receiving the user status information and the selection information to electronically direct control of the at least partial preparation of the one or more selected ingestible products via control of amount of time spent for a particular step in preparation of the ingestible product (e.g. an implementation of the microprocessor component s102 is configured to electronically control components of the material processing subsystem s700 based upon an internal clock of the microprocessor according to a time profile included in the user status information or the selection information received thereby, etc.). In an implementation, the electronically receiving the user status information and the selection information to electronically direct control of the at least partial preparation of the one or more selected ingestible products via control of amount of time spent for a particular step in preparation of the ingestible product is carried out by electronically receiving the user status information and the selection information to electronically direct control of the at least partial preparation of the one or more selected ingestible products via control of amount of time spent for a particular step in preparation of the ingestible product (e.g. an implementation of the microprocessor component s102 is configured to electronically control components of the material processing subsystem s700 based upon an internal clock of the microprocessor according to a time profile included in the user status information or the selection information received thereby, etc.).

In one or more implementations, operation o11 includes an operation o1196 for electronically receiving the user status information and the selection information to electronically direct control of the at least partial preparation of the one or more selected ingestible products via electronically excluding ingredients from being included in the preparation of the ingestible product. A non-transitory signal bearing medium includes one or more control prep ingredient exclusion instructions i1196 that when executed will direct performance of the operation o1196. In an implementation, the one or more control prep ingredient exclusion instructions i1196 when executed direct electronically receiving the user status information and the selection information to electronically direct control of the at least partial preparation of the one or more selected ingestible products via electronically excluding ingredients from being included in the preparation of the ingestible product (e.g. an implementation of the microprocessor component s102 is configured to electronically control the sorting component s728 to exclude one or more ingredients from being included in the ingestible product according to an exclusion profile included in the user status information or the selection information received thereby, etc.). Furthermore, the control prep ingredient exclusion electrical circuitry arrangement e1196 when activated will perform the operation o1196. In an implementation, the control prep ingredient exclusion electrical circuitry arrangement e1196, when activated performs electronically receiving the user status information and the selection information to electronically direct control of the at least partial preparation of the one or more selected ingestible products via electronically excluding ingredients from being included in the preparation of the ingestible product (e.g. an implementation of the microprocessor component s102 is configured to electronically control the sorting component s728 to exclude one or more ingredients from being included in the ingestible product according to an exclusion profile included in the user status information or the selection information received thereby, etc.). In an implementation, the electronically receiving the user status information and the selection information to electronically direct control of the at least partial preparation of the one or more selected ingestible products via electronically excluding ingredients from being included in the preparation of the ingestible product is carried out by electronically receiving the user status information and the selection information to electronically direct control of the at least partial preparation of the one or more selected ingestible products via electronically excluding ingredients from being included in the preparation of the ingestible product (e.g. an implementation of the microprocessor component s102 is configured to electronically control the sorting component s728 to exclude one or more ingredients from being included in the ingestible product according to an exclusion profile included in the user status information or the selection information received thereby, etc.).

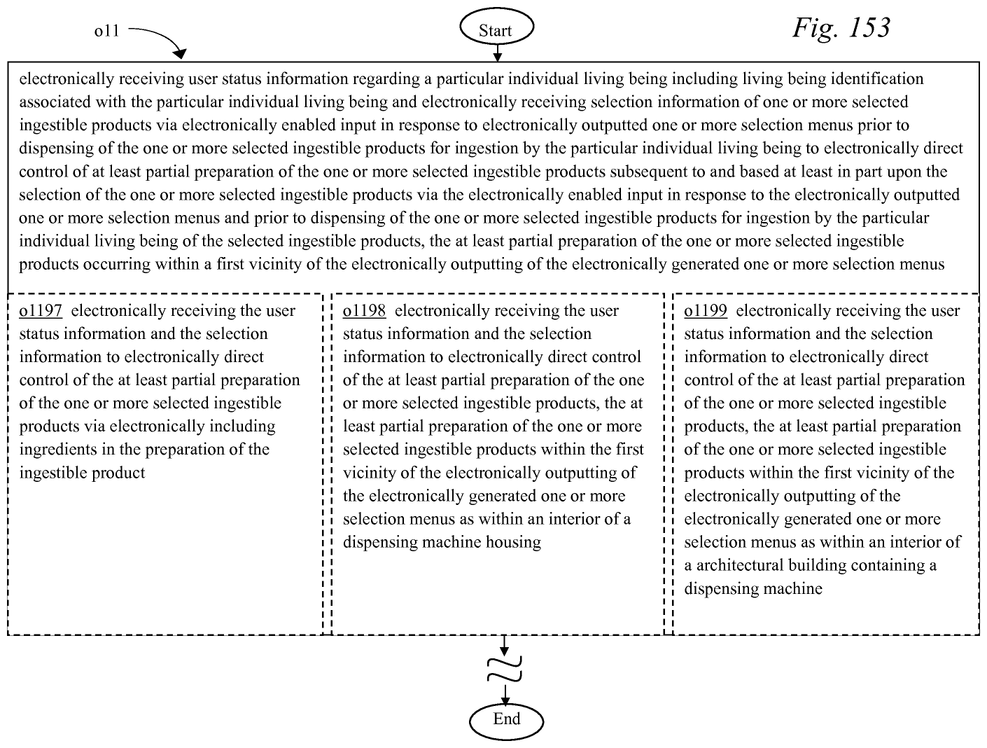

In one or more implementations, as shown in FIG. 153, operation o11 includes an operation o1197 for electronically receiving the user status information and the selection information to electronically direct control of the at least partial preparation of the one or more selected ingestible products via electronically including ingredients in the preparation of the ingestible product. An exemplary version of a non-transitory signal bearing medium of information storage subsystem s200 is depicted as bearing one or more control prep ingredient inclusion instructions i1197 that when executed will direct performance of the operation o1197. In an implementation, the one or more control prep ingredient inclusion instructions i1197 when executed direct electronically receiving the user status information and the selection information to electronically direct control of the at least partial preparation of the one or more selected ingestible products via electronically including ingredients in the preparation of the ingestible product (e.g. an implementation of the microprocessor component s102 is configured to electronically control the sorting component s728 to include one or more ingredients in the ingestible product according to an inclusion profile included in the user status information or the selection information received thereby, etc.). Furthermore, the control prep ingredient inclusion electrical circuitry arrangement e1197 when activated will perform the operation o1197. In an implementation, the control prep ingredient inclusion electrical circuitry arrangement e1197, when activated performs electronically receiving the user status information and the selection information to electronically direct control of the at least partial preparation of the one or more selected ingestible products via electronically including ingredients in the preparation of the ingestible product (e.g. an implementation of the microprocessor component s102 is configured to electronically control the sorting component s728 to include one or more ingredients in the ingestible product according to an inclusion profile included in the user status information or the selection information received thereby, etc.). In an implementation, the electronically receiving the user status information and the selection information to electronically direct control of the at least partial preparation of the one or more selected ingestible products via electronically including ingredients in the preparation of the ingestible product is carried out by electronically receiving the user status information and the selection information to electronically direct control of the at least partial preparation of the one or more selected ingestible products via electronically including ingredients in the preparation of the ingestible product (e.g. an implementation of the microprocessor component s102 is configured to electronically control the sorting component s728 to include one or more ingredients in the ingestible product according to an inclusion profile included in the user status information or the selection information received thereby, etc.).

In one or more implementations, operation o11 includes an operation o1198 for electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a dispensing machine housing. A non-transitory signal bearing medium includes one or more control prep housing instructions i1198 that when executed will direct performance of the operation o1198. In an implementation, the one or more control prep housing instructions i1198 when executed direct electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a dispensing machine housing (e.g. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the digestible product preparation system 10 that uses for instance visual display component s304 to electronically output the electronically generated one or more selection menus, etc.). Furthermore, the control prep housing electrical circuitry arrangement e1198 when activated will perform the operation o1198. In an implementation, the control prep housing electrical circuitry arrangement e1198, when activated performs electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a dispensing machine housing (e.g. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the digestible product preparation system 10 that uses for instance visual display component s304 to electronically output the electronically generated one or more selection menus, etc.). In an implementation, the electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a dispensing machine housing is carried out by electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a dispensing machine housing (e.g. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the digestible product preparation system 10 that uses for instance visual display component s304 to electronically output the electronically generated one or more selection menus, etc.).

In one or more implementations, operation o11 includes an operation o1199 for electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a architectural building containing a dispensing machine. A non-transitory signal bearing medium includes one or more control prep building instructions i1199 that when executed will direct performance of the operation o1199. In an implementation, the one or more control prep building instructions i1199 when executed direct electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a architectural building containing a dispensing machine (e.g. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of an airport wherein the digestible product preparation system 10 is located that communicates with for instance the visual display component s304 to electronically output the electronically generated one or more selection menus also within the airport, etc.). Furthermore, the control prep building electrical circuitry arrangement e1199 when activated will perform the operation o1199. In an implementation, the control prep building electrical circuitry arrangement e1199, when activated performs electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a architectural building containing a dispensing machine (e.g. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of an airport wherein the digestible product preparation system 10 is located that communicates with for instance the visual display component s304 to electronically output the electronically generated one or more selection menus also within the airport, etc.). In an implementation, the electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a architectural building containing a dispensing machine is carried out by electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a architectural building containing a dispensing machine (e.g. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of an airport wherein the digestible product preparation system 10 is located that communicates with for instance the visual display component s304 to electronically output the electronically generated one or more selection menus also within the airport, etc.).

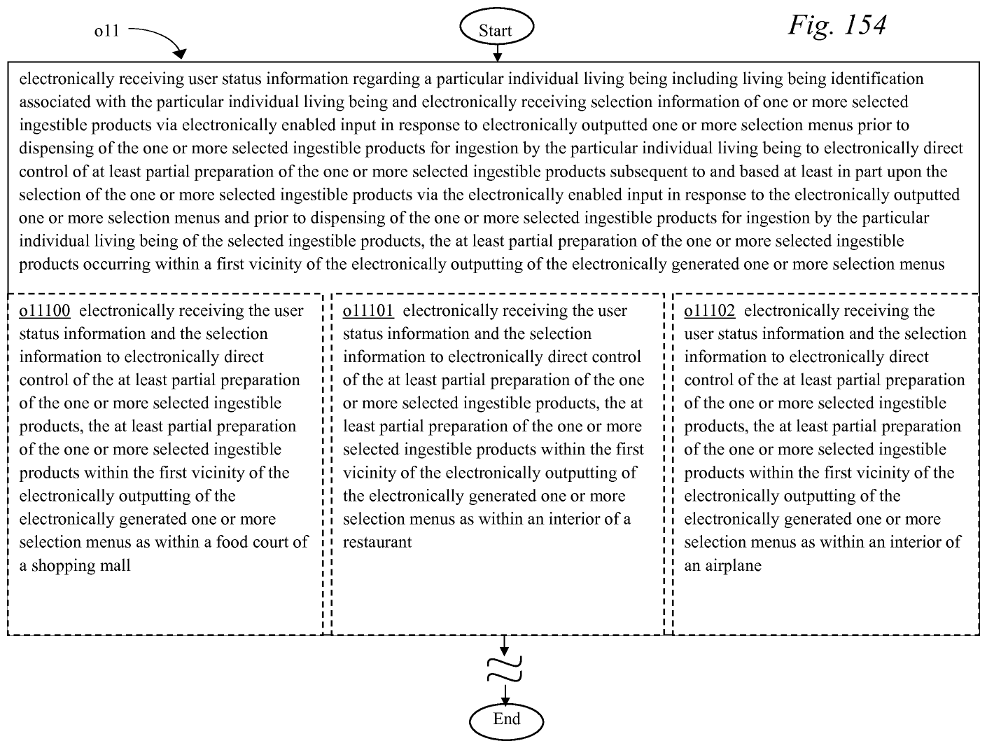

In one or more implementations, as shown in FIG. 154, operation o11 includes an operation o11100 for electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within a food court of a shopping mall. An exemplary version of a non-transitory signal bearing medium of information storage subsystem s200 is depicted as bearing one or more control prep mall instructions i11100 that when executed will direct performance of the operation o11100. In an implementation, the one or more control prep mall instructions i11100 when executed direct electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within a food court of a shopping mall (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the food court of the shopping mall wherein the digestible product preparation system 10 is located that communicates with for instance the visual display component s304 to electronically output the electronically generated one or more selection menus also within the food court of the shopping mall, etc.). Furthermore, the control prep mall electrical circuitry arrangement e11100 when activated will perform the operation o11100. In an implementation, the control prep mall electrical circuitry arrangement e11100, when activated performs electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within a food court of a shopping mall (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the food court of the shopping mall wherein the digestible product preparation system 10 is located that communicates with for instance the visual display component s304 to electronically output the electronically generated one or more selection menus also within the food court of the shopping mall, etc.). In an implementation, the electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within a food court of a shopping mall is carried out by electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within a food court of a shopping mall (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the food court of the shopping mall wherein the digestible product preparation system 10 is located that communicates with for instance the visual display component s304 to electronically output the electronically generated one or more selection menus also within the food court of the shopping mall, etc.).

In one or more implementations, operation o11 includes an operation o11101 for electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a restaurant. A non-transitory signal bearing medium includes one or more control prep restaurant instructions i11101 that when executed will direct performance of the operation o11101. In an implementation, the one or more control prep restaurant instructions i11101 when executed direct electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a restaurant (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the restaurant wherein the digestible product preparation system 10 is located that communicates with for instance the visual display component s304 to electronically output the electronically generated one or more selection menus also within the restaurant, etc.). Furthermore, the control prep restaurant electrical circuitry arrangement e11101 when activated will perform the operation o11101. In an implementation, the control prep restaurant electrical circuitry arrangement e11101, when activated performs electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a restaurant (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the restaurant wherein the digestible product preparation system 10 is located that communicates with for instance the visual display component s304 to electronically output the electronically generated one or more selection menus also within the restaurant, etc.). In an implementation, the electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a restaurant is carried out by electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a restaurant (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the restaurant wherein the digestible product preparation system 10 is located that communicates with for instance the visual display component s304 to electronically output the electronically generated one or more selection menus also within the restaurant, etc.).

In one or more implementations, operation o11 includes an operation o11102 for electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of an airplane. A non-transitory signal bearing medium includes one or more control prep airplane instructions i11102 that when executed will direct performance of the operation o11102. In an implementation, the one or more control prep airplane instructions i11102 when executed direct electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of an airplane (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the airplane wherein the digestible product preparation system 10 is located that communicates with for instance the visual display component s304 to electronically output the electronically generated one or more selection menus also within the airplane, etc.). Furthermore, the control prep airplane electrical circuitry arrangement e11102 when activated will perform the operation o11102. In an implementation, the control prep airplane electrical circuitry arrangement e11102, when activated performs electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of an airplane (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the airplane wherein the digestible product preparation system 10 is located that communicates with for instance the visual display component s304 to electronically output the electronically generated one or more selection menus also within the airplane, etc.). In an implementation, the electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of an airplane is carried out by electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of an airplane (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the airplane wherein the digestible product preparation system 10 is located that communicates with for instance the visual display component s304 to electronically output the electronically generated one or more selection menus also within the airplane, etc.).

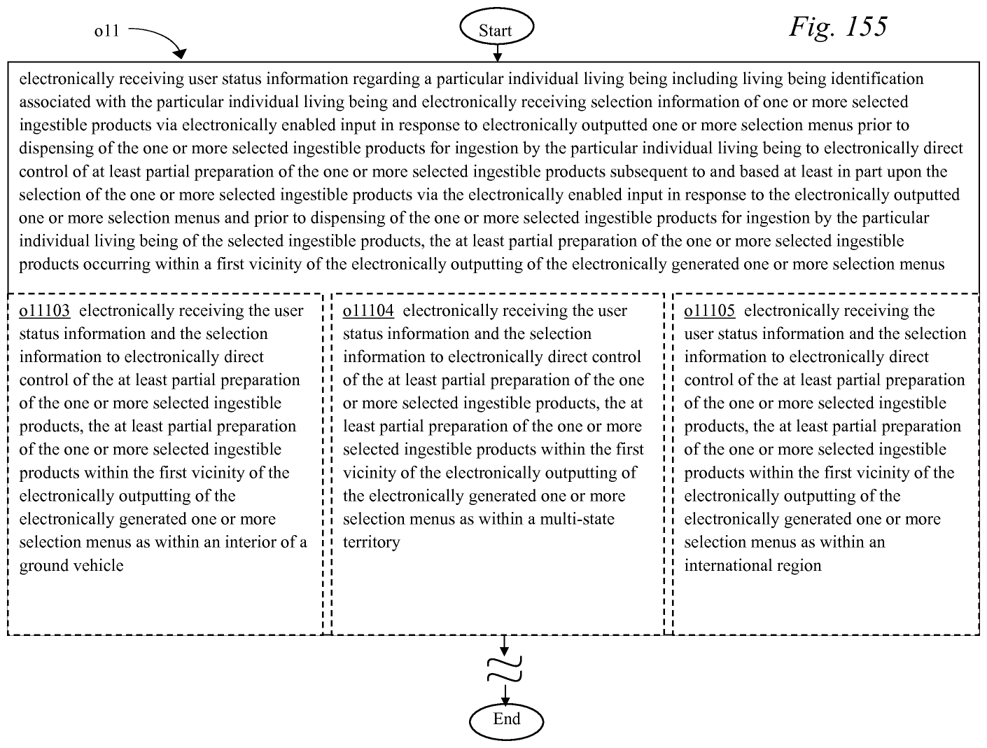

In one or more implementations, as shown in FIG. 155, operation o11 includes an operation o11103 for electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a ground vehicle. An exemplary version of a non-transitory signal bearing medium of information storage subsystem s200 is depicted as bearing one or more control prep vehicle instructions i11103 that when executed will direct performance of the operation o11103. In an implementation, the one or more control prep vehicle instructions i11103 when executed direct electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a ground vehicle (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the ground vehicle wherein the digestible product preparation system 10 is located that communicates with for instance the visual display component s304 to electronically output the electronically generated one or more selection menus also within the ground vehicle, etc.). Furthermore, the control prep vehicle electrical circuitry arrangement e11103 when activated will perform the operation o11103. In an implementation, the control prep vehicle electrical circuitry arrangement e11103, when activated performs electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a ground vehicle (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the ground vehicle wherein the digestible product preparation system 10 is located that communicates with for instance the visual display component s304 to electronically output the electronically generated one or more selection menus also within the ground vehicle, etc.). In an implementation, the electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a ground vehicle is carried out by electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an interior of a ground vehicle (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the ground vehicle wherein the digestible product preparation system 10 is located that communicates with for instance the visual display component s304 to electronically output the electronically generated one or more selection menus also within the ground vehicle, etc.).

In one or more implementations, operation o11 includes an operation o11104 for electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within a multi-state territory. A non-transitory signal bearing medium includes one or more control prep territory instructions i11104 that when executed will direct performance of the operation o11104. In an implementation, the one or more control prep territory instructions i11104 when executed direct electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within a multi-state territory (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the multi-state territory of Colorado, Wyoming, Montana, Utah, New Mexico, and Texas wherein the digestible product preparation system 10 is located that communicates with for instance the visual display component s304 to electronically output the electronically generated one or more selection menus also within the multi-state territory of Colorado, Wyoming, Montana, Utah, New Mexico, and Texas, etc.). Furthermore, the control prep territory electrical circuitry arrangement e11104 when activated will perform the operation o11104. In an implementation, the control prep territory electrical circuitry arrangement e11104, when activated performs electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within a multi-state territory (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the multi-state territory of Colorado, Wyoming, Montana, Utah, New Mexico, and Texas wherein the digestible product preparation system 10 is located that communicates with for instance the visual display component s304 to electronically output the electronically generated one or more selection menus also within the multi-state territory of Colorado, Wyoming, Montana, Utah, New Mexico, and Texas, etc.). In an implementation, the electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within a multi-state territory is carried out by electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within a multi-state territory (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the interior of the multi-state territory of Colorado, Wyoming, Montana, Utah, New Mexico, and Texas wherein the digestible product preparation system 10 is located that communicates with for instance the visual display component s304 to electronically output the electronically generated one or more selection menus also within the multi-state territory of Colorado, Wyoming, Montana, Utah, New Mexico, and Texas, etc.).

In one or more implementations, operation o11 includes an operation o11105 for electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an international region. A non-transitory signal bearing medium includes one or more control prep region instructions i11105 that when executed will direct performance of the operation o11105. In an implementation, the one or more control prep region instructions i11105 when executed direct electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an international region (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the international region of England, Germany, France, Brazil, Russia, India, China, and the United States wherein the digestible product preparation system 10 is located that communicates with for instance the visual display component s304 to electronically output the electronically generated one or more selection menus also within the international region of England, Germany, France, Brazil, Russia, India, China, and the United States, etc.). Furthermore, the control prep region electrical circuitry arrangement e11105 when activated will perform the operation o11105. In an implementation, the control prep region electrical circuitry arrangement e11105, when activated performs electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an international region (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the international region of England, Germany, France, Brazil, Russia, India, China, and the United States wherein the digestible product preparation system 10 is located that communicates with for instance the visual display component s304 to electronically output the electronically generated one or more selection menus also within the international region of England, Germany, France, Brazil, Russia, India, China, and the United States, etc.). In an implementation, the electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an international region is carried out by electronically receiving the user status information and the selection information to electronically direct control of the at least partial preparation of the one or more selected ingestible products, the at least partial preparation of the one or more selected ingestible products within the first vicinity of the electronically outputting of the electronically generated one or more selection menus as within an international region (i.e. an implementation of the microprocessor component s102 is configured to receive the user status information and the selection information through the electronic communication subsystem 500 to electronically direct control of the material processing subsystem 700 for at least partial preparation of the one or more selected ingestible products within the first vicinity as within the international region of England, Germany, France, Brazil, Russia, India, China, and the United States wherein the digestible product preparation system 10 is located that communicates with for instance the visual display component s304 to electronically output the electronically generated one or more selection menus also within the international region of England, Germany, France, Brazil, Russia, India, China, and the United States, etc.).

As shown in FIG. 39, the operational flow o10 proceeds to operation o12 for electronically directing control at least in part of acquisition of refuse intelligence including information related to one or more discarded portions of at least one of the one or more selected ingestible products discarded by the particular individual subsequent to ingestion by the particular individual living being of one or more other ingested portions of the at least one of the one or more selected ingestible products within a second vicinity of the electronically outputting of the electronically generated one or more selection menus. An exemplary version of a non-transitory signal bearing medium of information storage subsystem s200 is depicted as bearing one or more controlling acquisition instructions i112 that when executed will direct performance of the operation o12. In an implementation, the one or more controlling acquisition instructions i112 when executed direct electronically directing control (e.g. the microprocessor component s102 can direct control, etc.) at least in part of acquisition of refuse intelligence including information related to one or more discarded portions of at least one of the one or more selected ingestible products discarded (e.g. directing control of sensing system s400 including sound sensing component s410 along with recognition application implemented by microprocessor s102 to obtain weight of the discarded portions, etc.) by the particular individual living being subsequent to ingestion by the particular individual living being of one or more other ingested portions of at least one of the one or more selected ingestible products (e.g. including fruit smoothies, etc.) within a second vicinity of the electronically outputting of the electronically generated one or more selection menus (e.g. the graphical user interface s302 displaying the one or more selection menus is located within a room of a building as the second vicinity that also houses the sensing subsystem s400 used for acquisition of refuse intelligence information such as use of the weight sensing component s410 along with the microprocessor s102 to weight of the discarded portions of the selected fruit smoothie, etc.). Furthermore, the controlling acquisition electrical circuitry arrangement e12 when activated will perform the operation o12. In an implementation, the controlling acquisition electrical circuitry arrangement e12, when activated performs electronically directing control (e.g. the microprocessor component s102 can direct control, etc.) at least in part of acquisition of refuse intelligence including information related to one or more discarded portions of at least one of the one or more selected ingestible products discarded (e.g. directing control of sensing system s400 including sound sensing component s410 along with recognition application implemented by microprocessor s102 to obtain weight of the discarded portions, etc.) by the particular individual living being subsequent to ingestion by the particular individual living being of one or more other ingested portions of at least one of the one or more selected ingestible products (e.g. including fruit smoothies, etc.) within a second vicinity of the electronically outputting of the electronically generated one or more selection menus (e.g. the graphical user interface s302 displaying the one or more selection menus is located within a room of a building as the second vicinity that also houses the sensing subsystem s400 used for acquisition of refuse intelligence information such as use of the weight sensing component s410 along with the microprocessor s102 to weight of the discarded portions of the selected fruit smoothie, etc.). In an implementation, the electronically directing control at least in part of acquisition of refuse intelligence including information related to one or more discarded portions of at least one of the one or more selected ingestible products discarded by the particular individual subsequent to ingestion by the particular individual living being of one or more other ingested portions of the at least one of the one or more selected ingestible products within a second vicinity of the electronically outputting of the electronically generated one or more selection menus is carried out by electronically directing control (e.g. the microprocessor component s102 can direct control, etc.) at least in part of acquisition of refuse intelligence including information related to one or more discarded portions of at least one of the one or more selected ingestible products discarded (e.g. directing control of sensing system s400 including sound sensing component s410 along with recognition application implemented by microprocessor s102 to obtain weight of the discarded portions, etc.) by the particular individual living being subsequent to ingestion by the particular individual living being of one or more other ingested portions of at least one of the one or more selected ingestible products (e.g. including fruit smoothies, etc.) within a second vicinity of the electronically outputting of the electronically generated one or more selection menus (e.g. the graphical user interface s302 displaying the one or more selection menus is located within a room of a building as the second vicinity that also houses the sensing subsystem s400 used for acquisition of refuse intelligence information such as use of the weight sensing component s410 along with the microprocessor s102 to weight of the discarded portions of the selected fruit smoothie, etc.).

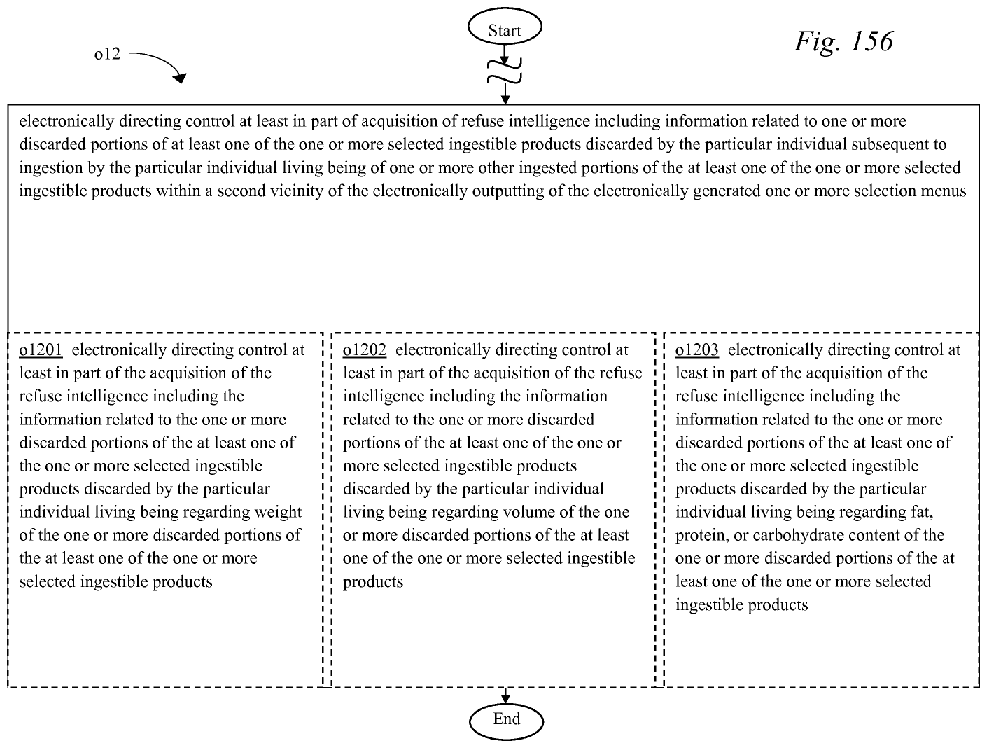

In one or more implementations, as shown in FIG. 156, operation o12 includes an operation o1201 for electronically directing control at least in part of the acquisition of the refuse intelligence including the information related to the one or more discarded portions of the at least one of the one or more selected ingestible products discarded by the particular individual living being regarding weight of the one or more discarded portions of the at least one of the one or more selected ingestible products. An exemplary version of a non-transitory signal bearing medium of information storage subsystem s200 is depicted as bearing one or more acquisition portion weight instructions i11201 that when executed will direct performance of the operation o1201. In an implementation, the one or more acquisition portion weight instructions i11201 when executed direct electronically directing control at least in part of the acquisition of the refuse intelligence including the information related to the one or more discarded portions of the at least one of the one or more selected ingestible products discarded by the particular individual living being regarding weight of the one or more discarded portions of the at least one of the one or more selected ingestible products (e.g. an implementation of the microprocessor component s102 is configured to electronically direct control at least in part of the acquisition of the refuse intelligence including the information related to the one or more discarded portions of the at least one of the one or more selected ingestible products discarded by the particular individual living being such as through the weight sensing component s410 regarding weight of the one or more discarded portions of the at least one of the one or more selected ingestible products such as a sandwich, etc.). Furthermore, the acquisition portion weight electrical circuitry arrangement e1201 when activated will perform the operation o1201. In an implementation, the acquisition portion weight electrical circuitry arrangement e1201, when activated performs electronically directing control at least in part of the acquisition of the refuse intelligence including the information related to the one or more discarded portions of the at least one of the one or more selected ingestible products discarded by the particular individual living being regarding weight of the one or more discarded portions of the at least one of the one or more selected ingestible products (e.g. an implementation of the microprocessor component s102 is configured to electronically direct control at least in part of the acquisition of the refuse intelligence including the information related to the one or more discarded portions of the at least one of the one or more selected ingestible products discarded by the particular individual living being such as through the weight sensing component s410 regarding weight of the one or more discarded portions of the at least one of the one or more selected ingestible products such as a sandwich, etc.). In an implementation, the electronically directing control at least in part of the acquisition of the refuse intelligence including the information related to the one or more discarded portions of the at least one of the one or more selected ingestible products discarded by the particular individual living being regarding weight of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding weight of the one or more discarded portions of the at least one of the one or more selected ingestible products (e.g. an implementation of the microprocessor component s102 is configured to electronically direct control at least in part of the acquisition of the refuse intelligence including the information related to the one or more discarded portions of the at least one of the one or more selected ingestible products discarded by the particular individual living being such as through the weight sensing component s410 regarding weight of the one or more discarded portions of the at least one of the one or more selected ingestible products such as a sandwich, etc.).

In one or more implementations, operation o12 includes an operation o1202 for electronically directing control at least in part of the acquisition of the refuse intelligence including the information related to the one or more discarded portions of the at least one of the one or more selected ingestible products discarded by the particular individual living being regarding volume of the one or more discarded portions of the at least one of the one or more selected ingestible products. An exemplary version of a non-transitory signal bearing medium of information storage subsystem s200 is depicted as bearing one or more acquisition portion volume instructions i11202 that when executed will direct performance of the operation o1202. In an implementation, the one or more acquisition portion volume instructions i11202 when executed direct electronically directing control at least in part of the acquisition of the refuse intelligence including the information related to the one or more discarded portions of the at least one of the one or more selected ingestible products discarded by the particular individual living being regarding volume of the one or more discarded portions of the at least one of the one or more selected ingestible products (e.g. an implementation of the microprocessor component s102 is configured to electronically direct control at least in part of the acquisition of the refuse intelligence including the information related to the one or more discarded portions of the at least one of the one or more selected ingestible products discarded by the particular individual living being such as through the photodetecting sensing component s406 in conjunction with a volume recognition application operated in part by the microprocessor s102 regarding volume of the one or more discarded portions of the at least one of the one or more selected ingestible products such as a turkey dinners, etc.). Furthermore, the acquisition portion volume electrical circuitry arrangement e1202 when activated will perform the operation o1202. In an implementation, the acquisition portion volume electrical circuitry arrangement e1202, when activated performs electronically directing control at least in part of the acquisition of the refuse intelligence including the information related to the one or more discarded portions of the at least one of the one or more selected ingestible products discarded by the particular individual living being regarding volume of the one or more discarded portions of the at least one of the one or more selected ingestible products (e.g. an implementation of the microprocessor component s102 is configured to electronically direct control at least in part of the acquisition of the refuse intelligence including the information related to the one or more discarded portions of the at least one of the one or more selected ingestible products discarded by the particular individual living being such as through the photodetecting sensing component s406 in conjunction with a volume recognition application operated in part by the microprocessor s102 regarding volume of the one or more discarded portions of the at least one of the one or more selected ingestible products such as a turkey dinners, etc.). In an implementation, the electronically directing control at least in part of the acquisition of the refuse intelligence including the information related to the one or more discarded portions of the at least one of the one or more selected ingestible products discarded by the particular individual living being regarding volume of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding volume of the one or more discarded portions of the at least one of the one or more selected ingestible products (e.g. an implementation of the microprocessor component s102 is configured to electronically direct control at least in part of the acquisition of the refuse intelligence including the information related to the one or more discarded portions of the at least one of the one or more selected ingestible products discarded by the particular individual living being such as through the photodetecting sensing component s406 in conjunction with a volume recognition application operated in part by the microprocessor s102 regarding volume of the one or more discarded portions of the at least one of the one or more selected ingestible products such as a turkey dinners, etc.).

In one or more implementations, operation o12 includes an operation o1203 for electronically directing control at least in part of the acquisition of the refuse intelligence including the information related to the one or more discarded portions of the at least one of the one or more selected ingestible products discarded by the particular individual living being regarding fat, protein, or carbohydrate content of the one or more discarded portions of the at least one of the one or more selected ingestible products. An exemplary version of a non-transitory signal bearing medium of information storage subsystem s200 is depicted as bearing one or more acquisition portion content instructions i11203 that when executed will direct performance of the operation o1203. In an implementation, the one or more acquisition portion content instructions i11203 when executed direct electronically directing control at least in part of the acquisition of the refuse intelligence including the information related to the one or more discarded portions of the at least one of the one or more selected ingestible products discarded by the particular individual living being regarding fat, protein, or carbohydrate content of the one or more discarded portions of the at least one of the one or more selected ingestible products (e.g. an implementation of the microprocessor component s102 is configured to electronically control at least in part the acquisition of the refuse intelligence such as through chemical sensing component s416 along with chemical recognition application operated through the microprocessor s102 including the information related to the one or more discarded portions of the at least one of the one or more selected ingestible products discarded by the particular individual living being regarding fat, protein, or carbohydrate content of the one or more discarded portions of the at least one of the one or more selected ingestible products, etc.). Furthermore, the acquisition portion content electrical circuitry arrangement e1203 when activated will perform the operation o1203. In an implementation, the acquisition portion content electrical circuitry arrangement e1203, when activated performs electronically directing control at least in part of the acquisition of the refuse intelligence including the information related to the one or more discarded portions of the at least one of the one or more selected ingestible products discarded by the particular individual living being regarding fat, protein, or carbohydrate content of the one or more discarded portions of the at least one of the one or more selected ingestible products (e.g. an implementation of the microprocessor component s102 is configured to electronically control at least in part the acquisition of the refuse intelligence such as through chemical sensing component s416 along with chemical recognition application operated through the microprocessor s102 including the information related to the one or more discarded portions of the at least one of the one or more selected ingestible products discarded by the particular individual living being regarding fat, protein, or carbohydrate content of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding fat, protein, or carbohydrate content of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding fat, protein, or carbohydrate content of the one or more discarded portions of the at least one of the one or more selected ingestible products (e.g. an implementation of the microprocessor component s102 is configured to electronically control at least in part the acquisition of the refuse intelligence such as through chemical sensing component s416 along with chemical recognition application operated through the microprocessor s102 including the information related to the one or more discarded portions of the at least one of the one or more selected ingestible products discarded by the particular individual living being regarding fat, protein, or carbohydrate content of the one or more discarded portions of the at least one of the one or more selected ingestible products, etc.).

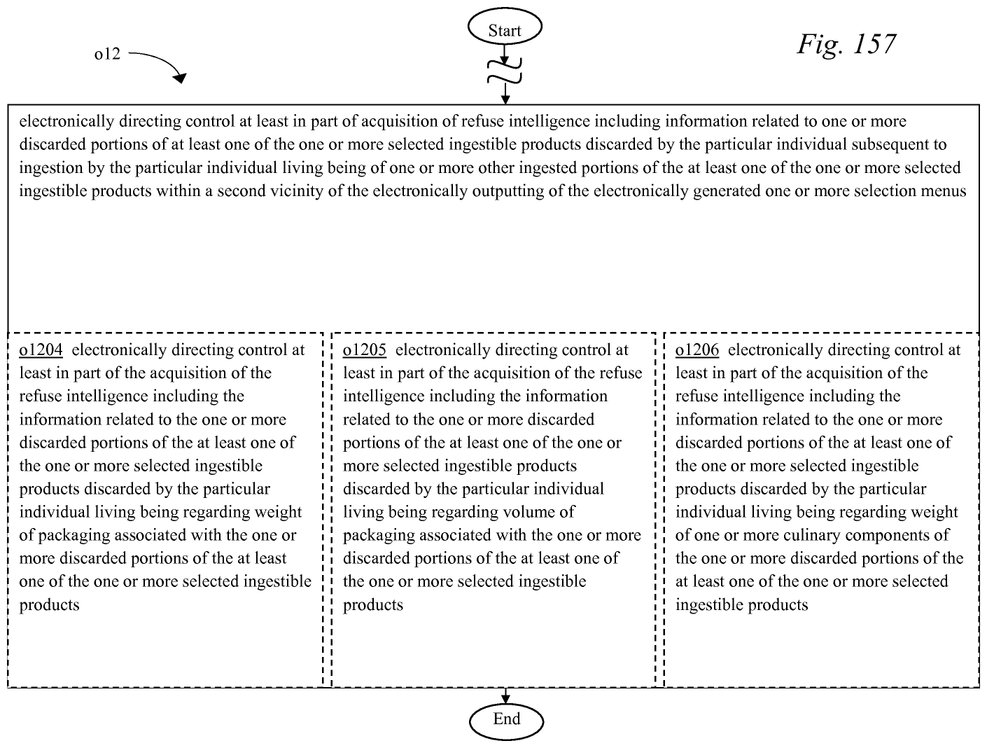

In one or more implementations, as shown in FIG. 157, operation o12 includes an operation o1204 for electronically directing control at least in part of the acquisition of the refuse intelligence including the information related to the one or more discarded portions of the at least one of the one or more selected ingestible products discarded by the particular individual living being regarding weight of packaging associated with the one or more discarded portions of the at least one of the one or more selected ingestible products. An exemplary version of a non-transitory signal bearing medium of information storage subsystem s200 is depicted as bearing one or more acquisition package weight instructions i11204 that when executed will direct performance of the operation o1204. In an implementation, the one or more acquisition package weight instructions i11204 when executed direct electronically directing control at least in part of the acquisition of the refuse intelligence including the information related to the one or more discarded portions of the at least one of the one or more selected ingestible products discarded by the particular individual living being regarding weight of packaging associated with the one or more discarded portions of the at least one of the one or more selected ingestible products (e.g. an implementation of the microprocessor component s102 is configured to electronically control at least in part the acquisition of the refuse intelligence such as through weight sensing component s410 along with weight recognition application operated by the microprocessor s102 including the information related to the one or more discarded portions of the at least one of the one or more selected ingestible products discarded by the particular individual living being regarding weight of packaging associated with the one or more discarded portions of the at least one of the one or more selected ingestible products, etc.). Furthermore, the acquisition package weight electrical circuitry arrangement e1204 when activated will perform the operation o1204. In an implementation, the acquisition package weight electrical circuitry arrangement e1204, when activated performs electronically directing control at least in part of the acquisition of the refuse intelligence including the information related to the one or more discarded portions of the at least one of the one or more selected ingestible products discarded by the particular individual living being regarding weight of packaging associated with the one or more discarded portions of the at least one of the one or more selected ingestible products (e.g. an implementation of the microprocessor component s102 is configured to electronically control at least in part the acquisition of the refuse intelligence such as through weight sensing component s410 along with weight recognition application operated by the microprocessor s102 including the information related to the one or more discarded portions of the at least one of the one or more selected ingestible products discarded by the particular individual living being regarding weight of packaging associated with the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding weight of packaging associated with the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding weight of packaging associated with the one or more discarded portions of the at least one of the one or more selected ingestible products (e.g. an implementation of the microprocessor component s102 is configured to electronically control at least in part the acquisition of the refuse intelligence such as through weight sensing component s410 along with weight recognition application operated by the microprocessor s102 including the information related to the one or more discarded portions of the at least one of the one or more selected ingestible products discarded by the particular individual living being regarding weight of packaging associated with the one or more discarded portions of the at least one of the one or more selected ingestible products, etc.).

In one or more implementations, operation o12 includes an operation o1205 for electronically directing control at least in part of the acquisition of the refuse intelligence including the information related to the one or more discarded portions of the at least one of the one or more selected ingestible products discarded by the particular individual living being regarding volume of packaging associated with the one or more discarded portions of the at least one of the one or more selected ingestible products. An exemplary version of a non-transitory signal bearing medium of information storage subsystem s200 is depicted as bearing one or more acquisition package volume instructions i11205 that when executed will direct performance of the operation o1205. In an implementation, the one or more acquisition package volume instructions i11205 when executed direct electronically directing control at least in part of the acquisition of the refuse intelligence including the information related to the one or more discarded portions of the at least one of the one or more selected ingestible products discarded by the particular individual living being regarding volume of packaging associated with the one or more discarded portions of the at least one of the one or more selected ingestible products (e.g. an implementation of the microprocessor component s102 is configured to electronically control at least in part the acquisition of the refuse intelligence such as through sounding sensing component s420 including the information related to the one or more discarded portions of the at least one of the one or more selected ingestible products discarded by the particular individual living being regarding volume of packaging associated with the one or more discarded portions of the at least one of the one or more selected ingestible products, etc.). Furthermore, the acquisition package volume electrical circuitry arrangement e1205 when activated will perform the operation o1205. In an implementation, the acquisition package volume electrical circuitry arrangement e1205, when activated performs electronically directing control at least in part of the acquisition of the refuse intelligence including the information related to the one or more discarded portions of the at least one of the one or more selected ingestible products discarded by the particular individual living being regarding volume of packaging associated with the one or more discarded portions of the at least one of the one or more selected ingestible products (e.g. an implementation of the microprocessor component s102 is configured to electronically control at least in part the acquisition of the refuse intelligence such as through sounding sensing component s420 including the information related to the one or more discarded portions of the at least one of the one or more selected ingestible products discarded by the particular individual living being regarding volume of packaging associated with the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding volume of packaging associated with the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding volume of packaging associated with the one or more discarded portions of the at least one of the one or more selected ingestible products (e.g. an implementation of the microprocessor component s102 is configured to electronically control at least in part the acquisition of the refuse intelligence such as through sounding sensing component s420 including the information related to the one or more discarded portions of the at least one of the one or more selected ingestible products discarded by the particular individual living being regarding volume of packaging associated with the one or more discarded portions of the at least one of the one or more selected ingestible products, etc.).

In one or more implementations, operation o12 includes an operation o1206 for electronically directing control at least in part of the acquisition of the refuse intelligence including the information related to the one or more discarded portions of the at least one of the one or more selected ingestible products discarded by the particular individual living being regarding weight of one or more culinary components of the one or more discarded portions of the at least one of the one or more selected ingestible products. An exemplary version of a non-transitory signal bearing medium of information storage subsystem s200 is depicted as bearing one or more acquisition component weight instructions i11206 that when executed will direct performance of the operation o1206. In an implementation, the one or more acquisition component weight instructions i11206 when executed direct electronically directing control at least in part of the acquisition of the refuse intelligence including the information related to the one or more discarded portions of the at least one of the one or more selected ingestible products discarded by the particular individual living being regarding weight of one or more culinary components of the one or more discarded portions of the at least one of the one or more selected ingestible products (e.g. an implementation of the microprocessor component s102 is configured to electronically control at least in part the acquisition such as through weight sensing component s410 with weight recognition application operated by the microprocessor s102 of the refuse intelligence including the information related to the one or more discarded portions of the at least one of the one or more selected ingestible products discarded by the particular individual living being regarding weight of one or more culinary components such as bread component, meat component, vegetable component, pasta component, etc of the one or more discarded portions of the at least one of the one or more selected ingestible products, etc.). Furthermore, the acquisition component weight electrical circuitry arrangement e1206 when activated will perform the operation o1205. In an implementation, the acquisition component weight electrical circuitry arrangement e1206, when activated performs electronically directing control at least in part of the acquisition of the refuse intelligence including the information related to the one or more discarded portions of the at least one of the one or more selected ingestible products discarded by the particular individual living being regarding weight of one or more culinary components of the one or more discarded portions of the at least one of the one or more selected ingestible products (e.g. an implementation of the microprocessor component s102 is configured to electronically control at least in part the acquisition such as through weight sensing component s410 with weight recognition application operated by the microprocessor s102 of the refuse intelligence including the information related to the one or more discarded portions of the at least one of the one or more selected ingestible products discarded by the particular individual living being regarding weight of one or more culinary components such as bread component, meat component, vegetable component, pasta component, etc of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding weight of one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding weight of one or more culinary components of the one or more discarded portions of the at least one of the one or more selected ingestible products (e.g. an implementation of the microprocessor component s102 is configured to electronically control at least in part the acquisition such as through weight sensing component s410 with weight recognition application operated by the microprocessor s102 of the refuse intelligence including the information related to the one or more discarded portions of the at least one of the one or more selected ingestible products discarded by the particular individual living being regarding weight of one or more culinary components such as bread component, meat component, vegetable component, pasta component, etc of the one or more discarded portions of the at least one of the one or more selected ingestible products, etc.).

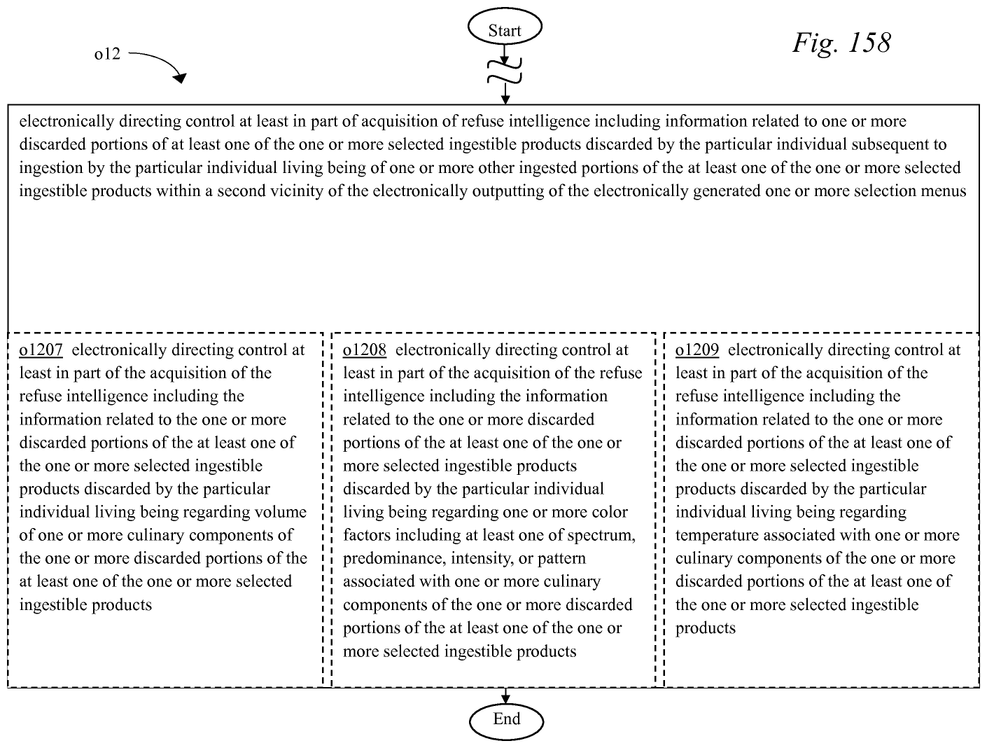

In one or more implementations, as shown in FIG. 158, operation o12 includes an operation o1207 for electronically directing control at least in part of the acquisition of the refuse intelligence including the information related to the one or more discarded portions of the at least one of the one or more selected ingestible products discarded by the particular individual living being regarding volume of one or more culinary components of the one or more discarded portions of the at least one of the one or more selected ingestible products. An exemplary version of a non-transitory signal bearing medium of information storage subsystem s200 is depicted as bearing one or more acquisition component volume instructions i11207 that when executed will direct performance of the operation o1207. In an implementation, the one or more acquisition component volume instructions i11207 when executed direct electronically directing control at least in part of the acquisition of the refuse intelligence including the information related to the one or more discarded portions of the at least one of the one or more selected ingestible products discarded by the particular individual living being regarding volume of one or more culinary components of the one or more discarded portions of the at least one of the one or more selected ingestible products (e.g. an implementation of the microprocessor component s102 is configured to electronically control at least in part the acquisition of the refuse intelligence such as through photodetecting components s406 with volume recognition application operated by microprocessor s102 including the information related to the one or more discarded portions of the at least one of the one or more selected ingestible products discarded by the particular individual living being regarding volume of one or more culinary components of the one or more discarded portions of the at least one of the one or more selected ingestible products, etc.). Furthermore, the acquisition component volume electrical circuitry arrangement e1207 when activated will perform the operation o1207. In an implementation, the acquisition component volume electrical circuitry arrangement e1207, when activated performs electronically directing control at least in part of the acquisition of the refuse intelligence including the information related to the one or more discarded portions of the at least one of the one or more selected ingestible products discarded by the particular individual living being regarding volume of one or more culinary components of the one or more discarded portions of the at least one of the one or more selected ingestible products (e.g. an implementation of the microprocessor component s102 is configured to electronically control at least in part the acquisition of the refuse intelligence such as through photodetecting components s406 with volume recognition application operated by microprocessor s102 including the information related to the one or more discarded portions of the at least one of the one or more selected ingestible products discarded by the particular individual living being regarding volume of one or more culinary components of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding volume of one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding volume of one or more culinary components of the one or more discarded portions of the at least one of the one or more selected ingestible products (e.g. an implementation of the microprocessor component s102 is configured to electronically control at least in part the acquisition of the refuse intelligence such as through photodetecting components s406 with volume recognition application operated by microprocessor s102 including the information related to the one or more discarded portions of the at least one of the one or more selected ingestible products discarded by the particular individual living being regarding volume of one or more culinary components of the one or more discarded portions of the at least one of the one or more selected ingestible products, etc.).

In one or more implementations, operation o12 includes an operation o1208 for electronically directing control at least in part of the acquisition of the refuse intelligence including the information related to the one or more discarded portions of the at least one of the one or more selected ingestible products discarded by the particular individual living being regarding one or more color factors including at least one of spectrum, predominance, intensity, or pattern associated with one or more culinary components of the one or more discarded portions of the at least one of the one or more selected ingestible products. An exemplary version of a non-transitory signal bearing medium of information storage subsystem s200 is depicted as bearing one or more acquisition component color instructions i11208 that when executed will direct performance of the operation o1208. In an implementation, the one or more acquisition component color instructions i11208 when executed direct electronically directing control at least in part of the acquisition of the refuse intelligence including the information related to the one or more discarded portions of the at least one of the one or more selected ingestible products discarded by the particular individual living being regarding one or more color factors including at least one of spectrum, predominance, intensity, or pattern associated with one or more culinary components of the one or more discarded portions of the at least one of the one or more selected ingestible products (e.g. an implementation of the microprocessor component s102 is configured to electronically control at least in part the acquisition of the refuse intelligence such as through electromagnetic sensing component s402 with color factors recognition application operated by the microprocessor s102 including the information related to the one or more discarded portions of the at least one of the one or more selected ingestible products discarded by the particular individual living being regarding one or more color factors including at least one of spectrum, predominance, intensity, or pattern associated with one or more culinary components of the one or more discarded portions of the at least one of the one or more selected ingestible products, etc.). Furthermore, the acquisition component color electrical circuitry arrangement e1208 when activated will perform the operation o1208. In an implementation, the acquisition component color electrical circuitry arrangement e1208, when activated performs electronically directing control at least in part of the acquisition of the refuse intelligence including the information related to the one or more discarded portions of the at least one of the one or more selected ingestible products discarded by the particular individual living being regarding one or more color factors including at least one of spectrum, predominance, intensity, or pattern associated with one or more culinary components of the one or more discarded portions of the at least one of the one or more selected ingestible products (e.g. an implementation of the microprocessor component s102 is configured to electronically control at least in part the acquisition of the refuse intelligence such as through electromagnetic sensing component s402 with color factors recognition application operated by the microprocessor s102 including the information related to the one or more discarded portions of the at least one of the one or more selected ingestible products discarded by the particular individual living being regarding one or more color factors including at least one of spectrum, predominance, intensity, or pattern associated with one or more culinary components of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding one or more color factors including at least one of spectrum, predominance, intensity, or pattern associated with one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding one or more color factors including at least one of spectrum, predominance, intensity, or pattern associated with one or more culinary components of the one or more discarded portions of the at least one of the one or more selected ingestible products (e.g. an implementation of the microprocessor component s102 is configured to electronically control at least in part the acquisition of the refuse intelligence such as through electromagnetic sensing component s402 with color factors recognition application operated by the microprocessor s102 including the information related to the one or more discarded portions of the at least one of the one or more selected ingestible products discarded by the particular individual living being regarding one or more color factors including at least one of spectrum, predominance, intensity, or pattern associated with one or more culinary components of the one or more discarded portions of the at least one of the one or more selected ingestible products, etc.).

In one or more implementations, operation o12 includes an operation o1209 for electronically directing control at least in part of the acquisition of the refuse intelligence including the information related to the one or more discarded portions of the at least one of the one or more selected ingestible products discarded by the particular individual living being regarding temperature associated with one or more culinary components of the one or more discarded portions of the at least one of the one or more selected ingestible products. An exemplary version of a non-transitory signal bearing medium of information storage subsystem s200 is depicted as bearing one or more acquisition component temperature instructions i11209 that when executed will direct performance of the operation o1209. In an implementation, the one or more acquisition component temperature instructions i11209 when executed direct electronically directing control at least in part of the acquisition of the refuse intelligence including the information related to the one or more discarded portions of the at least one of the one or more selected ingestible products discarded by the particular individual living being regarding temperature associated with one or more culinary components of the one or more discarded portions of the at least one of the one or more selected ingestible products (e.g. an implementation of the microprocessor component s102 is configured to electronically control at least in part the acquisition of the refuse intelligence such as through temperature sensing component s224 including the information related to the one or more discarded portions of the at least one of the one or more selected ingestible products discarded by the particular individual living being regarding temperature associated with one or more culinary components such as flavor components, fiber components, etc. of the one or more discarded portions of the at least one of the one or more selected ingestible products, etc.). Furthermore, the acquisition component temperature electrical circuitry arrangement e1209 when activated will perform the operation o1209. In an implementation, the acquisition component temperature electrical circuitry arrangement e1209, when activated performs electronically directing control at least in part of the acquisition of the refuse intelligence including the information related to the one or more discarded portions of the at least one of the one or more selected ingestible products discarded by the particular individual living being regarding temperature associated with one or more culinary components of the one or more discarded portions of the at least one of the one or more selected ingestible products (e.g. an implementation of the microprocessor component s102 is configured to electronically control at least in part the acquisition of the refuse intelligence such as through temperature sensing component s224 including the information related to the one or more discarded portions of the at least one of the one or more selected ingestible products discarded by the particular individual living being regarding temperature associated with one or more culinary components such as flavor components, fiber components, etc. of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding temperature associated with one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding temperature associated with one or more culinary components of the one or more discarded portions of the at least one of the one or more selected ingestible products (e.g. an implementation of the microprocessor component s102 is configured to electronically control at least in part the acquisition of the refuse intelligence such as through temperature sensing component s224 including the information related to the one or more discarded portions of the at least one of the one or more selected ingestible products discarded by the particular individual living being regarding temperature associated with one or more culinary components such as flavor components, fiber components, etc. of the one or more discarded portions of the at least one of the one or more selected ingestible products, etc.).

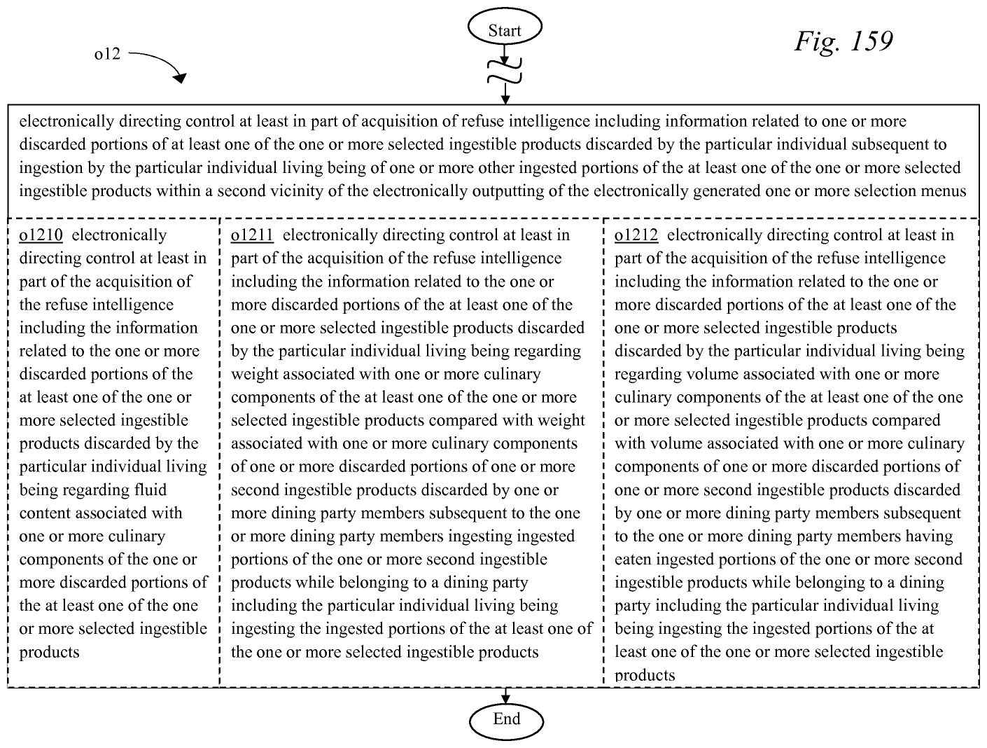

In one or more implementations, as shown in FIG. 159, operation o12 includes an operation o1210 for electronically directing control at least in part of the acquisition of the refuse intelligence including the information related to the one or more discarded portions of the at least one of the one or more selected ingestible products discarded by the particular individual living being regarding fluid content associated with one or more culinary components of the one or more discarded portions of the at least one of the one or more selected ingestible products. An exemplary version of a non-transitory signal bearing medium of information storage subsystem s200 is depicted as bearing one or more acquisition component fluid instructions i11210 that when executed will direct performance of the operation o1210. In an implementation, the one or more acquisition component fluid instructions i11210 when executed direct electronically directing control at least in part of the acquisition of the refuse intelligence including the information related to the one or more discarded portions of the at least one of the one or more selected ingestible products discarded by the particular individual living being regarding fluid content associated with one or more culinary components of the one or more discarded portions of the at least one of the one or more selected ingestible products (e.g. an implementation of the microprocessor component s102 is configured to electronically control at least in part the acquisition of the refuse intelligence such as through liquid sensing component s416, along with fluid recognition application implemented with the microprocessor component s102 including the information related to the one or more discarded portions of the at least one of the one or more selected ingestible products discarded by the particular individual living being regarding fluid content associated with one or more culinary components such as liquid fruit component, liquid water component, liquid sweetener component, etc of the one or more discarded portions of the at least one of the one or more selected ingestible products, etc.). Furthermore, the acquisition component fluid electrical circuitry arrangement e1210 when activated will perform the operation o1210. In an implementation, the acquisition component fluid electrical circuitry arrangement e1210, when activated performs electronically directing control at least in part of the acquisition of the refuse intelligence including the information related to the one or more discarded portions of the at least one of the one or more selected ingestible products discarded by the particular individual living being regarding fluid content associated with one or more culinary components of the one or more discarded portions of the at least one of the one or more selected ingestible products (e.g. an implementation of the microprocessor component s102 is configured to electronically control at least in part the acquisition of the refuse intelligence such as through liquid sensing component s416, along with fluid recognition application implemented with the microprocessor component s102 including the information related to the one or more discarded portions of the at least one of the one or more selected ingestible products discarded by the particular individual living being regarding fluid content associated with one or more culinary components such as liquid fruit component, liquid water component, liquid sweetener component, etc of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding fluid content associated with one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding fluid content associated with one or more culinary components of the one or more discarded portions of the at least one of the one or more selected ingestible products (e.g. an implementation of the microprocessor component s102 is configured to electronically control at least in part the acquisition of the refuse intelligence such as through liquid sensing component s416, along with fluid recognition application implemented with the microprocessor component s102 including the information related to the one or more discarded portions of the at least one of the one or more selected ingestible products discarded by the particular individual living being regarding fluid content associated with one or more culinary components such as liquid fruit component, liquid water component, liquid sweetener component, etc of the one or more discarded portions of the at least one of the one or more selected ingestible products, etc.).

In one or more implementations, operation o12 includes an operation o1211 for electronically directing control at least in part of the acquisition of the refuse intelligence including the information related to the one or more discarded portions of the at least one of the one or more selected ingestible products discarded by the particular individual living being regarding weight associated with one or more culinary components of the at least one of the one or more selected ingestible products compared with weight associated with one or more culinary components of one or more discarded portions of one or more second ingestible products discarded by one or more dining party members subsequent to the one or more dining party members ingesting ingested portions of the one or more second ingestible products while belonging to a dining party including the particular individual living being ingesting the ingested portions of the at least one of the one or more selected ingestible products. An exemplary version of a non-transitory signal bearing medium of information storage subsystem s200 is depicted as bearing one or more acquisition party weight instructions i11211 that when executed will direct performance of the operation o1211. In an implementation, the one or more acquisition party weight instructions i11211 when executed direct electronically directing control at least in part of the acquisition of the refuse intelligence including the information related to the one or more discarded portions of the at least one of the one or more selected ingestible products discarded by the particular individual living being regarding weight associated with one or more culinary components of the at least one of the one or more selected ingestible products compared with weight associated with one or more culinary components of one or more discarded portions of one or more second ingestible products discarded by one or more dining party members subsequent to the one or more dining party members ingesting ingested portions of the one or more second ingestible products while belonging to a dining party including the particular individual living being ingesting the ingested portions of the at least one of the one or more selected ingestible products (e.g. an implementation of the microprocessor component s102 is configured to electronically control at least in part the acquisition such as through weight sensing component s336 and recognition application implemented through the microprocessor component of the refuse intelligence including the information related to the one or more discarded portions of the at least one of the one or more selected ingestible products discarded by the particular individual living being regarding weight associated with one or more culinary components such as entrée component, main course component, side dish component, dessert component, etc. of the at least one of the one or more selected ingestible products compared with weight associated with one or more culinary components of one or more discarded portions of one or more second ingestible products discarded by one or more dining party members subsequent to the one or more dining party members ingesting ingested portions of the one or more second ingestible products while belonging to a dining party including the particular individual living being ingesting the ingested portions of the at least one of the one or more selected ingestible products, etc.). Furthermore, the acquisition party weight electrical circuitry arrangement e1211 when activated will perform the operation o1211. In an implementation, the acquisition party weight electrical circuitry arrangement e1211, when activated performs electronically directing control at least in part of the acquisition of the refuse intelligence including the information related to the one or more discarded portions of the at least one of the one or more selected ingestible products discarded by the particular individual living being regarding weight associated with one or more culinary components of the at least one of the one or more selected ingestible products compared with weight associated with one or more culinary components of one or more discarded portions of one or more second ingestible products discarded by one or more dining party members subsequent to the one or more dining party members ingesting ingested portions of the one or more second ingestible products while belonging to a dining party including the particular individual living being ingesting the ingested portions of the at least one of the one or more selected ingestible products (e.g. an implementation of the microprocessor component s102 is configured to electronically control at least in part the acquisition such as through weight sensing component s336 and recognition application implemented through the microprocessor component of the refuse intelligence including the information related to the one or more discarded portions of the at least one of the one or more selected ingestible products discarded by the particular individual living being regarding weight associated with one or more culinary components such as entrée component, main course component, side dish component, dessert component, etc. of the at least one of the one or more selected ingestible products compared with weight associated with one or more culinary components of one or more discarded portions of one or more second ingestible products discarded by one or more dining party members subsequent to the one or more dining party members ingesting ingested portions of the one or more second ingestible products while belonging to a dining party including the particular individual living being ingesting the ingested portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding weight associated with one or more culinary components of the at least one of the one or more selected ingestible products compared with weight associated with one or more culinary components of one or more discarded portions of one or more second ingestible products discarded by one or more dining party members subsequent to the one or more dining party members ingesting ingested portions of the one or more second ingestible products while belonging to a dining party including the particular individual living being ingesting the ingested portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding weight associated with one or more culinary components of the at least one of the one or more selected ingestible products compared with weight associated with one or more culinary components of one or more discarded portions of one or more second ingestible products discarded by one or more dining party members subsequent to the one or more dining party members ingesting ingested portions of the one or more second ingestible products while belonging to a dining party including the particular individual living being ingesting the ingested portions of the at least one of the one or more selected ingestible products (e.g. an implementation of the microprocessor component s102 is configured to electronically control at least in part the acquisition such as through weight sensing component s336 and recognition application implemented through the microprocessor component of the refuse intelligence including the information related to the one or more discarded portions of the at least one of the one or more selected ingestible products discarded by the particular individual living being regarding weight associated with one or more culinary components such as entrée component, main course component, side dish component, dessert component, etc. of the at least one of the one or more selected ingestible products compared with weight associated with one or more culinary components of one or more discarded portions of one or more second ingestible products discarded by one or more dining party members subsequent to the one or more dining party members ingesting ingested portions of the one or more second ingestible products while belonging to a dining party including the particular individual living being ingesting the ingested portions of the at least one of the one or more selected ingestible products, etc.).

In one or more implementations, operation o12 includes an operation o1212 for electronically directing control at least in part of the acquisition of the refuse intelligence including the information related to the one or more discarded portions of the at least one of the one or more selected ingestible products discarded by the particular individual living being regarding volume associated with one or more culinary components of the at least one of the one or more selected ingestible products compared with volume associated with one or more culinary components of one or more discarded portions of one or more second ingestible products discarded by one or more dining party members subsequent to the one or more dining party members having eaten ingested portions of the one or more second ingestible products while belonging to a dining party including the particular individual living being ingesting the ingested portions of the at least one of the one or more selected ingestible products. An exemplary version of a non-transitory signal bearing medium of information storage subsystem s200 is depicted as bearing one or more acquisition party volume instructions i11212 that when executed will direct performance of the operation o1212. In an implementation, the one or more acquisition party volume instructions i11212 when executed direct electronically directing control at least in part of the acquisition of the refuse intelligence including the information related to the one or more discarded portions of the at least one of the one or more selected ingestible products discarded by the particular individual living being regarding volume associated with one or more culinary components of the at least one of the one or more selected ingestible products compared with volume associated with one or more culinary components of one or more discarded portions of one or more second ingestible products discarded by one or more dining party members subsequent to the one or more dining party members having eaten ingested portions of the one or more second ingestible products while belonging to a dining party including the particular individual living being ingesting the ingested portions of the at least one of the one or more selected ingestible products (e.g. an implementation of the microprocessor component s102 is configured to electronically control at least in part the acquisition such as through photodetecting component s406 and recognition application implemented by the microprocessor component s102 of the refuse intelligence including the information related to the one or more discarded portions of the at least one of the one or more selected ingestible products discarded by the particular individual living being regarding volume associated with one or more culinary components of the at least one of the one or more selected ingestible products compared with volume associated with one or more culinary components such as bread component, meat component, salad component, etc. of one or more discarded portions of one or more second ingestible products discarded by one or more dining party members subsequent to the one or more dining party members having eaten ingested portions of the one or more second ingestible products while belonging to a dining party including the particular individual living being ingesting the ingested portions of the at least one of the one or more selected ingestible products, etc.). Furthermore, the acquisition party volume electrical circuitry arrangement e1212 when activated will perform the operation o1212. In an implementation, the acquisition party volume electrical circuitry arrangement e1212, when activated performs electronically directing control at least in part of the acquisition of the refuse intelligence including the information related to the one or more discarded portions of the at least one of the one or more selected ingestible products discarded by the particular individual living being regarding volume associated with one or more culinary components of the at least one of the one or more selected ingestible products compared with volume associated with one or more culinary components of one or more discarded portions of one or more second ingestible products discarded by one or more dining party members subsequent to the one or more dining party members having eaten ingested portions of the one or more second ingestible products while belonging to a dining party including the particular individual living being ingesting the ingested portions of the at least one of the one or more selected ingestible products (e.g. an implementation of the microprocessor component s102 is configured to electronically control at least in part the acquisition such as through photodetecting component s406 and recognition application implemented by the microprocessor component s102 of the refuse intelligence including the information related to the one or more discarded portions of the at least one of the one or more selected ingestible products discarded by the particular individual living being regarding volume associated with one or more culinary components of the at least one of the one or more selected ingestible products compared with volume associated with one or more culinary components such as bread component, meat component, salad component, etc. of one or more discarded portions of one or more second ingestible products discarded by one or more dining party members subsequent to the one or more dining party members having eaten ingested portions of the one or more second ingestible products while belonging to a dining party including the particular individual living being ingesting the ingested portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding volume associated with one or more culinary components of the at least one of the one or more selected ingestible products compared with volume associated with one or more culinary components of one or more discarded portions of one or more second ingestible products discarded by one or more dining party members subsequent to the one or more dining party members having eaten ingested portions of the one or more second ingestible products while belonging to a dining party including the particular individual living being ingesting the ingested portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding volume associated with one or more culinary components of the at least one of the one or more selected ingestible products compared with volume associated with one or more culinary components of one or more discarded portions of one or more second ingestible products discarded by one or more dining party members subsequent to the one or more dining party members having eaten ingested portions of the one or more second ingestible products while belonging to a dining party including the particular individual living being ingesting the ingested portions of the at least one of the one or more selected ingestible products (e.g. an implementation of the microprocessor component s102 is configured to electronically control at least in part the acquisition such as through photodetecting component s406 and recognition application implemented by the microprocessor component s102 of the refuse intelligence including the information related to the one or more discarded portions of the at least one of the one or more selected ingestible products discarded by the particular individual living being regarding volume associated with one or more culinary components of the at least one of the one or more selected ingestible products compared with volume associated with one or more culinary components such as bread component, meat component, salad component, etc. of one or more discarded portions of one or more second ingestible products discarded by one or more dining party members subsequent to the one or more dining party members having eaten ingested portions of the one or more second ingestible products while belonging to a dining party including the particular individual living being ingesting the ingested portions of the at least one of the one or more selected ingestible products, etc.).

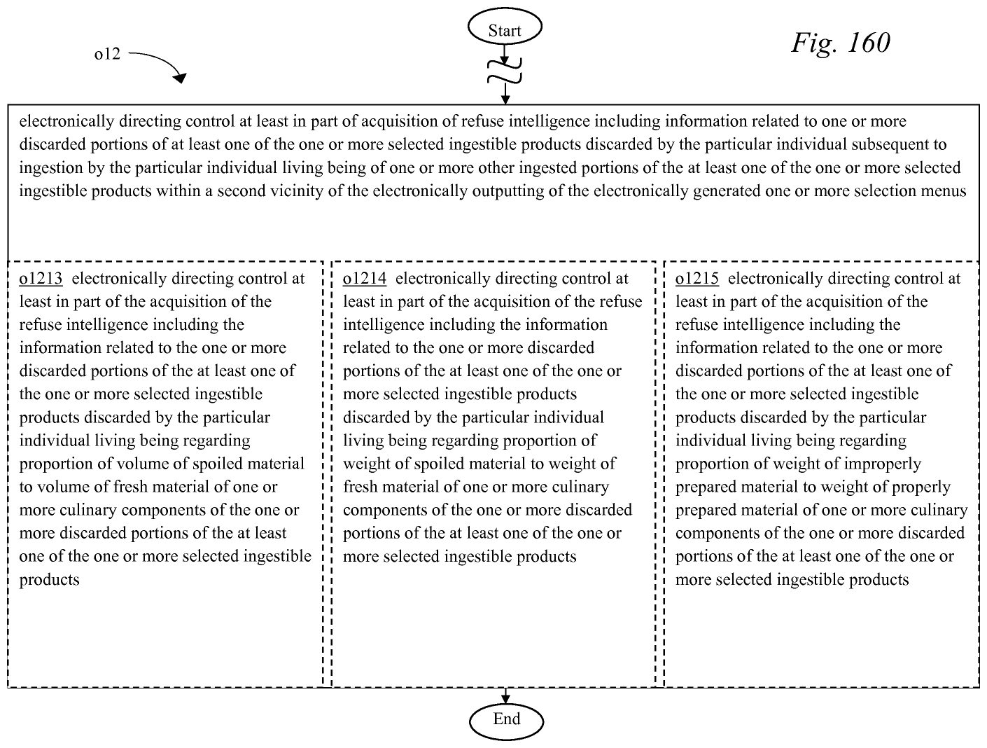

In one or more implementations, as shown in FIG. 160, operation o12 includes an operation o1213 for electronically directing control at least in part of the acquisition of the refuse intelligence including the information related to the one or more discarded portions of the at least one of the one or more selected ingestible products discarded by the particular individual living being regarding proportion of volume of spoiled material to volume of fresh material of one or more culinary components of the one or more discarded portions of the at least one of the one or more selected ingestible products. An exemplary version of a non-transitory signal bearing medium of information storage subsystem s200 is depicted as bearing one or more acquisition volume spoiled instructions i11213 that when executed will direct performance of the operation o1213. In an implementation, the one or more acquisition volume spoiled instructions i11213 when executed direct electronically directing control at least in part of the acquisition of the refuse intelligence including the information related to the one or more discarded portions of the at least one of the one or more selected ingestible products discarded by the particular individual living being regarding proportion of volume of spoiled material to volume of fresh material of one or more culinary components of the one or more discarded portions of the at least one of the one or more selected ingestible products (e.g. an implementation of the microprocessor component s102 is configured to electronically control at least in part the acquisition such as through photodetecting s406 of the refuse intelligence including the information related to the one or more discarded portions of the at least one of the one or more selected ingestible products discarded by the particular individual living being regarding proportion of volume of spoiled material to volume of fresh material of one or more culinary components such as appetizer component, dessert component, etc of the one or more discarded portions of the at least one of the one or more selected ingestible products, etc.). Furthermore, the acquisition volume spoiled electrical circuitry arrangement e1213 when activated will perform the operation o1213. In an implementation, the acquisition volume spoiled electrical circuitry arrangement e1213, when activated performs electronically directing control at least in part of the acquisition of the refuse intelligence including the information related to the one or more discarded portions of the at least one of the one or more selected ingestible products discarded by the particular individual living being regarding proportion of volume of spoiled material to volume of fresh material of one or more culinary components of the one or more discarded portions of the at least one of the one or more selected ingestible products (e.g. an implementation of the microprocessor component s102 is configured to electronically control at least in part the acquisition such as through photodetecting s406 of the refuse intelligence including the information related to the one or more discarded portions of the at least one of the one or more selected ingestible products discarded by the particular individual living being regarding proportion of volume of spoiled material to volume of fresh material of one or more culinary components such as appetizer component, dessert component, etc of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding proportion of volume of spoiled material to volume of fresh material of one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding proportion of volume of spoiled material to volume of fresh material of one or more culinary components of the one or more discarded portions of the at least one of the one or more selected ingestible products (e.g. an implementation of the microprocessor component s102 is configured to electronically control at least in part the acquisition such as through photodetecting s406 of the refuse intelligence including the information related to the one or more discarded portions of the at least one of the one or more selected ingestible products discarded by the particular individual living being regarding proportion of volume of spoiled material to volume of fresh material of one or more culinary components such as appetizer component, dessert component, etc of the one or more discarded portions of the at least one of the one or more selected ingestible products, etc.).

In one or more implementations, operation o12 includes an operation o1214 for electronically directing control at least in part of the acquisition of the refuse intelligence including the information related to the one or more discarded portions of the at least one of the one or more selected ingestible products discarded by the particular individual living being regarding proportion of weight of spoiled material to weight of fresh material of one or more culinary components of the one or more discarded portions of the at least one of the one or more selected ingestible products. An exemplary version of a non-transitory signal bearing medium of information storage subsystem s200 is depicted as bearing one or more acquisition weight spoiled instructions i11214 that when executed will direct performance of the operation o1214. In an implementation, the one or more acquisition weight spoiled instructions i11214 when executed direct electronically directing control at least in part of the acquisition of the refuse intelligence including the information related to the one or more discarded portions of the at least one of the one or more selected ingestible products discarded by the particular individual living being regarding proportion of weight of spoiled material to weight of fresh material of one or more culinary components of the one or more discarded portions of the at least one of the one or more selected ingestible products (e.g. an implementation of the microprocessor component s102 is configured to electronically control at least in part the acquisition of the refuse intelligence such as through weight sensing component s410 and chemical sensing component s416 with recognition application operated by the microprocessor s102 including the information related to the one or more discarded portions of the at least one of the one or more selected ingestible products discarded by the particular individual living being regarding proportion of weight of spoiled material to weight of fresh material of one or more culinary components such as meat component, grain component, liquid component of the one or more discarded portions of the at least one of the one or more selected ingestible products, etc.). Furthermore, the acquisition weight spoiled electrical circuitry arrangement e1214 when activated will perform the operation o1214. In an implementation, the acquisition weight spoiled electrical circuitry arrangement e1214, when activated performs electronically directing control at least in part of the acquisition of the refuse intelligence including the information related to the one or more discarded portions of the at least one of the one or more selected ingestible products discarded by the particular individual living being regarding proportion of weight of spoiled material to weight of fresh material of one or more culinary components of the one or more discarded portions of the at least one of the one or more selected ingestible products (e.g. an implementation of the microprocessor component s102 is configured to electronically control at least in part the acquisition of the refuse intelligence such as through weight sensing component s410 and chemical sensing component s416 with recognition application operated by the microprocessor s102 including the information related to the one or more discarded portions of the at least one of the one or more selected ingestible products discarded by the particular individual living being regarding proportion of weight of spoiled material to weight of fresh material of one or more culinary components such as meat component, grain component, liquid component of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding proportion of weight of spoiled material to weight of fresh material of one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding proportion of weight of spoiled material to weight of fresh material of one or more culinary components of the one or more discarded portions of the at least one of the one or more selected ingestible products (e.g. an implementation of the microprocessor component s102 is configured to electronically control at least in part the acquisition of the refuse intelligence such as through weight sensing component s410 and chemical sensing component s416 with recognition application operated by the microprocessor s102 including the information related to the one or more discarded portions of the at least one of the one or more selected ingestible products discarded by the particular individual living being regarding proportion of weight of spoiled material to weight of fresh material of one or more culinary components such as meat component, grain component, liquid component of the one or more discarded portions of the at least one of the one or more selected ingestible products, etc.).

In one or more implementations, operation o12 includes an operation o1215 for electronically directing control at least in part of the acquisition of the refuse intelligence including the information related to the one or more discarded portions of the at least one of the one or more selected ingestible products discarded by the particular individual living being regarding proportion of weight of improperly prepared material to weight of properly prepared material of one or more culinary components of the one or more discarded portions of the at least one of the one or more selected ingestible products. An exemplary version of a non-transitory signal bearing medium of information storage subsystem s200 is depicted as bearing one or more acquisition proportion weight instructions i11215 that when executed will direct performance of the operation o1215. In an implementation, the one or more acquisition proportion weight instructions i11215 when executed direct electronically directing control at least in part of the acquisition of the refuse intelligence including the information related to the one or more discarded portions of the at least one of the one or more selected ingestible products discarded by the particular individual living being regarding proportion of weight of improperly prepared material to weight of properly prepared material of one or more culinary components of the one or more discarded portions of the at least one of the one or more selected ingestible products (e.g. an implementation of the microprocessor component s102 is configured to electronically control at least in part the acquisition of the refuse intelligence such as through weight sensing component s410, camera component s336 and recognition application implemented by the microprocessor component s102 including the information related to the one or more discarded portions of the at least one of the one or more selected ingestible products discarded by the particular individual living being regarding proportion of weight of improperly prepared material to weight of properly prepared material of one or more culinary components of the one or more discarded portions of the at least one of the one or more selected ingestible products, etc.). Furthermore, the acquisition proportion weight electrical circuitry arrangement e1215 when activated will perform the operation o1215. In an implementation, the acquisition proportion weight electrical circuitry arrangement e1215, when activated performs electronically directing control at least in part of the acquisition of the refuse intelligence including the information related to the one or more discarded portions of the at least one of the one or more selected ingestible products discarded by the particular individual living being regarding proportion of weight of improperly prepared material to weight of properly prepared material of one or more culinary components of the one or more discarded portions of the at least one of the one or more selected ingestible products (e.g. an implementation of the microprocessor component s102 is configured to electronically control at least in part the acquisition of the refuse intelligence such as through weight sensing component s410, camera component s336 and recognition application implemented by the microprocessor component s102 including the information related to the one or more discarded portions of the at least one of the one or more selected ingestible products discarded by the particular individual living being regarding proportion of weight of improperly prepared material to weight of properly prepared material of one or more culinary components of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding proportion of weight of improperly prepared material to weight of properly prepared material of one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding proportion of weight of improperly prepared material to weight of properly prepared material of one or more culinary components of the one or more discarded portions of the at least one of the one or more selected ingestible products (e.g. an implementation of the microprocessor component s102 is configured to electronically control at least in part the acquisition of the refuse intelligence such as through weight sensing component s410, camera component s336 and recognition application implemented by the microprocessor component s102 including the information related to the one or more discarded portions of the at least one of the one or more selected ingestible products discarded by the particular individual living being regarding proportion of weight of improperly prepared material to weight of properly prepared material of one or more culinary components of the one or more discarded portions of the at least one of the one or more selected ingestible products, etc.).

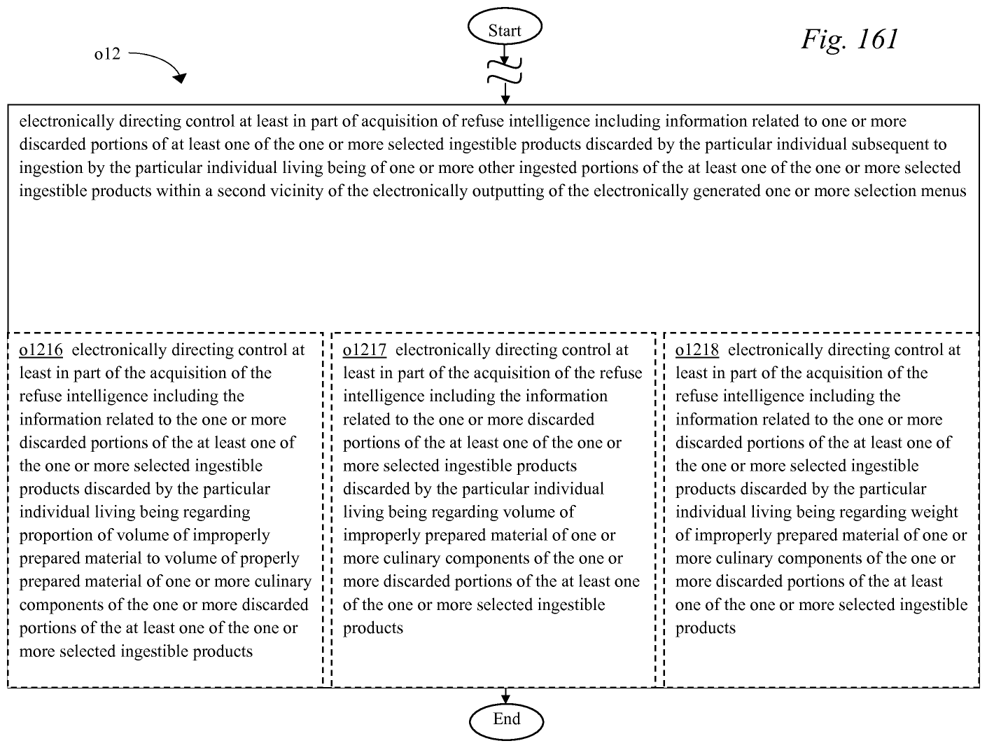

In one or more implementations, as shown in FIG. 161, operation o12 includes an operation o1216 for electronically directing control at least in part of the acquisition of the refuse intelligence including the information related to the one or more discarded portions of the at least one of the one or more selected ingestible products discarded by the particular individual living being regarding proportion of volume of improperly prepared material to volume of properly prepared material of one or more culinary components of the one or more discarded portions of the at least one of the one or more selected ingestible products. An exemplary version of a non-transitory signal bearing medium of information storage subsystem s200 is depicted as bearing one or more acquisition proportion improperly instructions i11216 that when executed will direct performance of the operation o1216. In an implementation, the one or more acquisition proportion improperly instructions i11216 when executed direct electronically directing control at least in part of the acquisition of the refuse intelligence including the information related to the one or more discarded portions of the at least one of the one or more selected ingestible products discarded by the particular individual living being regarding proportion of volume of improperly prepared material to volume of properly prepared material of one or more culinary components of the one or more discarded portions of the at least one of the one or more selected ingestible products (e.g. an implementation of the microprocessor component s102 is configured to electronically control at least in part the acquisition such as through the camera component s336 and recognition application implemented by the microprocessor component s102 of the refuse intelligence including the information related to the one or more discarded portions of the at least one of the one or more selected ingestible products discarded by the particular individual living being regarding proportion of volume of improperly prepared material to volume of properly prepared material of one or more culinary components of the one or more discarded portions of the at least one of the one or more selected ingestible products, etc.). Furthermore, the acquisition proportion improperly electrical circuitry arrangement e1216 when activated will perform the operation o1216. In an implementation, the acquisition proportion improperly electrical circuitry arrangement e1216, when activated performs electronically directing control at least in part of the acquisition of the refuse intelligence including the information related to the one or more discarded portions of the at least one of the one or more selected ingestible products discarded by the particular individual living being regarding proportion of volume of improperly prepared material to volume of properly prepared material of one or more culinary components of the one or more discarded portions of the at least one of the one or more selected ingestible products (e.g. an implementation of the microprocessor component s102 is configured to electronically control at least in part the acquisition such as through the camera component s336 and recognition application implemented by the microprocessor component s102 of the refuse intelligence including the information related to the one or more discarded portions of the at least one of the one or more selected ingestible products discarded by the particular individual living being regarding proportion of volume of improperly prepared material to volume of properly prepared material of one or more culinary components of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding proportion of volume of improperly prepared material to volume of properly prepared material of one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding proportion of volume of improperly prepared material to volume of properly prepared material of one or more culinary components of the one or more discarded portions of the at least one of the one or more selected ingestible products (e.g. an implementation of the microprocessor component s102 is configured to electronically control at least in part the acquisition such as through the camera component s336 and recognition application implemented by the microprocessor component s102 of the refuse intelligence including the information related to the one or more discarded portions of the at least one of the one or more selected ingestible products discarded by the particular individual living being regarding proportion of volume of improperly prepared material to volume of properly prepared material of one or more culinary components of the one or more discarded portions of the at least one of the one or more selected ingestible products, etc.).

In one or more implementations, operation o12 includes an operation o1217 for electronically directing control at least in part of the acquisition of the refuse intelligence including the information related to the one or more discarded portions of the at least one of the one or more selected ingestible products discarded by the particular individual living being regarding volume of improperly prepared material of one or more culinary components of the one or more discarded portions of the at least one of the one or more selected ingestible products. An exemplary version of a non-transitory signal bearing medium of information storage subsystem s200 is depicted as bearing one or more acquisition volume improperly instructions i11217 that when executed will direct performance of the operation o1217. In an implementation, the one or more acquisition volume improperly instructions i11217 when executed direct electronically directing control at least in part of the acquisition of the refuse intelligence including the information related to the one or more discarded portions of the at least one of the one or more selected ingestible products discarded by the particular individual living being regarding volume of improperly prepared material of one or more culinary components of the one or more discarded portions of the at least one of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being regarding volume of improperly prepared material of one or more culinary components such as protein component, fat component, carbohydrate component, etc of the one or more discarded portions of the at least one of the one or more selected ingestible products, etc.). Furthermore, the acquisition volume improperly electrical circuitry arrangement e1217 when activated will perform the operation o1217. In an implementation, the acquisition volume improperly electrical circuitry arrangement e1217, when activated performs electronically directing control at least in part of the acquisition of the refuse intelligence including the information related to the one or more discarded portions of the at least one of the one or more selected ingestible products discarded by the particular individual living being regarding volume of improperly prepared material of one or more culinary components of the one or more discarded portions of the at least one of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being regarding volume of improperly prepared material of one or more culinary components such as protein component, fat component, carbohydrate component, etc of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding volume of improperly prepared material of one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding volume of improperly prepared material of one or more culinary components of the one or more discarded portions of the at least one of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being regarding volume of improperly prepared material of one or more culinary components such as protein component, fat component, carbohydrate component, etc of the one or more discarded portions of the at least one of the one or more selected ingestible products, etc.).

In one or more implementations, operation o12 includes an operation o1218 for electronically directing control at least in part of the acquisition of the refuse intelligence including the information related to the one or more discarded portions of the at least one of the one or more selected ingestible products discarded by the particular individual living being regarding weight of improperly prepared material of one or more culinary components of the one or more discarded portions of the at least one of the one or more selected ingestible products. An exemplary version of a non-transitory signal bearing medium of information storage subsystem s200 is depicted as bearing one or more acquisition weight improperly instructions i11218 that when executed will direct performance of the operation o1218. In an implementation, the one or more acquisition weight improperly instructions i11218 when executed direct electronically directing control at least in part of the acquisition of the refuse intelligence including the information related to the one or more discarded portions of the at least one of the one or more selected ingestible products discarded by the particular individual living being regarding weight of improperly prepared material of one or more culinary components of the one or more discarded portions of the at least one of the one or more selected ingestible products (e.g. an implementation of the microprocessor component s102 is configured to electronically control at least in part the acquisition such as through weight sensing component s410, chemical sensing component s416 and recognition application implemented by the microprocessor component s102 of the refuse intelligence including the information related to the one or more discarded portions of the at least one of the one or more selected ingestible products discarded by the particular individual living being regarding weight of improperly prepared material of one or more culinary components of the one or more discarded portions of the at least one of the one or more selected ingestible products, etc.). Furthermore, the acquisition weight improperly electrical circuitry arrangement e1218 when activated will perform the operation o1218. In an implementation, the acquisition weight improperly electrical circuitry arrangement e1218, when activated performs electronically directing control at least in part of the acquisition of the refuse intelligence including the information related to the one or more discarded portions of the at least one of the one or more selected ingestible products discarded by the particular individual living being regarding weight of improperly prepared material of one or more culinary components of the one or more discarded portions of the at least one of the one or more selected ingestible products (e.g. an implementation of the microprocessor component s102 is configured to electronically control at least in part the acquisition such as through weight sensing component s410, chemical sensing component s416 and recognition application implemented by the microprocessor component s102 of the refuse intelligence including the information related to the one or more discarded portions of the at least one of the one or more selected ingestible products discarded by the particular individual living being regarding weight of improperly prepared material of one or more culinary components of the one or more discarded portions of the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being regarding weight of improperly prepared material of one or more culinary components of the one or more discarded portions of the at least one of the one or more selected ingestible products is carried out by electronically directing control at least in part of the acquisition of the refuse intelligence including the information related to the one or more discarded portions of the at least one of the one or more selected ingestible products discarded by the particular individual living being regarding weight of improperly prepared material of one or more culinary components of the one or more discarded portions of the at least one of the one or more selected ingestible products (e.g. an implementation of the microprocessor component s102 is configured to electronically control at least in part the acquisition such as through weight sensing component s410, chemical sensing component s416 and recognition application implemented by the microprocessor component s102 of the refuse intelligence including the information related to the one or more discarded portions of the at least one of the one or more selected ingestible products discarded by the particular individual living being regarding weight of improperly prepared material of one or more culinary components of the one or more discarded portions of the at least one of the one or more selected ingestible products, etc.).

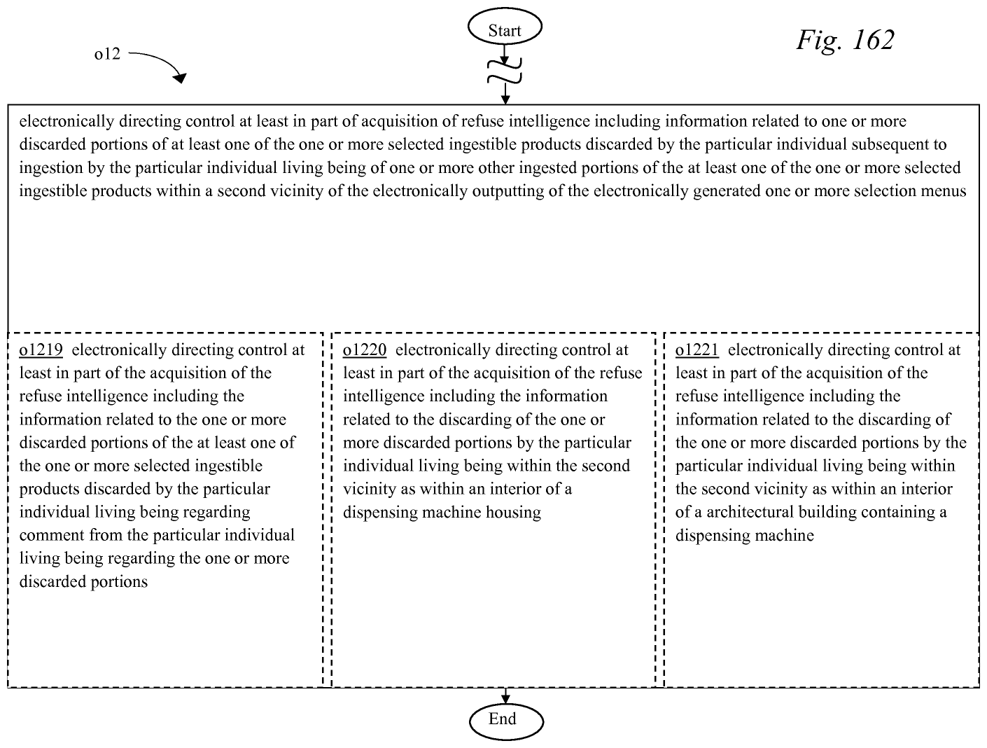

In one or more implementations, as shown in FIG. 162, operation o12 includes an operation o1219 for electronically directing control at least in part of the acquisition of the refuse intelligence including the information related to the one or more discarded portions of the at least one of the one or more selected ingestible products discarded by the particular individual living being regarding comment from the particular individual living being regarding the one or more discarded portions. An exemplary version of a non-transitory signal bearing medium of information storage subsystem s200 is depicted as bearing one or more acquisition refuse comment instructions i11219 that when executed will direct performance of the operation o1219. In an implementation, the one or more acquisition refuse comment instructions i11219 when executed direct electronically directing control at least in part of the acquisition of the refuse intelligence including the information related to the one or more discarded portions of the at least one of the one or more selected ingestible products discarded by the particular individual living being regarding comment from the particular individual living being regarding the one or more discarded portions (e.g. an implementation of the microprocessor component s102 is configured to electronically control at least in part the acquisition of the refuse intelligence such as through sound sensing component s420 and recognition application operated by microprocessor s102 including the information related to the one or more discarded portions of the at least one of the one or more selected ingestible products discarded by the particular individual living being regarding comment from the particular individual living being regarding the one or more discarded portions, etc.). Furthermore, the acquisition refuse comment electrical circuitry arrangement e1219 when activated will perform the operation o1219. In an implementation, the acquisition refuse comment electrical circuitry arrangement e1219, when activated performs electronically directing control at least in part of the acquisition of the refuse intelligence including the information related to the one or more discarded portions of the at least one of the one or more selected ingestible products discarded by the particular individual living being regarding comment from the particular individual living being regarding the one or more discarded portions (e.g. an implementation of the microprocessor component s102 is configured to electronically control at least in part the acquisition of the refuse intelligence such as through sound sensing component s420 and recognition application operated by microprocessor s102 including the information related to the one or more discarded portions of the at least one of the one or more selected ingestible products discarded by the particular individual living being regarding comment from the particular individual living being regarding the one or more discarded portions, etc.). In an implementation, the electronically directing control at least in part of the acquisition of the refuse intelligence including the information related to the one or more discarded portions of the at least one of the one or more selected ingestible products discarded by the particular individual living being regarding comment from the particular individual living being regarding the one or more discarded portions is carried out by electronically directing control at least in part of the acquisition of the refuse intelligence including the information related to the one or more discarded portions of the at least one of the one or more selected ingestible products discarded by the particular individual living being regarding comment from the particular individual living being regarding the one or more discarded portions (e.g. an implementation of the microprocessor component s102 is configured to electronically control at least in part the acquisition of the refuse intelligence such as through sound sensing component s420 and recognition application operated by microprocessor s102 including the information related to the one or more discarded portions of the at least one of the one or more selected ingestible products discarded by the particular individual living being regarding comment from the particular individual living being regarding the one or more discarded portions, etc.).

In one or more implementations, operation o12 includes an operation o1220 for electronically directing control at least in part of the acquisition of the refuse intelligence including the information related to the discarding of the one or more discarded portions by the particular individual living being within the second vicinity as within an interior of a dispensing machine housing. An exemplary version of a non-transitory signal bearing medium of information storage subsystem s200 is depicted as bearing one or more second vicinity housing instructions i11220 that when executed will direct performance of the operation o1220. In an implementation, the one or more second vicinity housing instructions i11220 when executed direct electronically directing control at least in part of the acquisition of the refuse intelligence including the information related to the discarding of the one or more discarded portions by the particular individual living being within the second vicinity as within an interior of a dispensing machine housing (e.g. an implementation of the microprocessor component s102 is configured through the electronic communication subsystem 500 to electronically direct control at least in part of the acquisition of the refuse intelligence within the second vicinity as within the interior of the digestible product preparation system 10 that uses for instance visual display component s304 to electronically output the electronically generated one or more selection menus, etc.). Furthermore, the second vicinity housing electrical circuitry arrangement e1220 when activated will perform the operation o1220. In an implementation, the second vicinity housing electrical circuitry arrangement e1220, when activated performs electronically directing control at least in part of the acquisition of the refuse intelligence including the information related to the discarding of the one or more discarded portions by the particular individual living being within the second vicinity as within an interior of a dispensing machine housing (e.g. an implementation of the microprocessor component s102 is configured through the electronic communication subsystem 500 to electronically direct control at least in part of the acquisition of the refuse intelligence within the second vicinity as within the interior of the digestible product preparation system 10 that uses for instance visual display component s304 to electronically output the electronically generated one or more selection menus, etc.). In an implementation, the electronically directing control at least in part of the acquisition of the refuse intelligence including the information related to the discarding of the one or more discarded portions by the particular individual living being within the second vicinity as within an interior of a dispensing machine housing is carried out by electronically directing control at least in part of the acquisition of the refuse intelligence including the information related to the discarding of the one or more discarded portions by the particular individual living being within the second vicinity as within an interior of a dispensing machine housing (e.g. an implementation of the microprocessor component s102 is configured through the electronic communication subsystem 500 to electronically direct control at least in part of the acquisition of the refuse intelligence within the second vicinity as within the interior of the digestible product preparation system 10 that uses for instance visual display component s304 to electronically output the electronically generated one or more selection menus, etc.).

In one or more implementations, operation o12 includes an operation o1221 for electronically directing control at least in part of the acquisition of the refuse intelligence including the information related to the discarding of the one or more discarded portions by the particular individual living being within the second vicinity as within an interior of a architectural building containing a dispensing machine. An exemplary version of a non-transitory signal bearing medium of information storage subsystem s200 is depicted as bearing one or more second vicinity building instructions i11221 that when executed will direct performance of the operation o1221. In an implementation, the one or more second vicinity building instructions i11221 when executed direct electronically directing control at least in part of the acquisition of the refuse intelligence including the information related to the discarding of the one or more discarded portions by the particular individual living being within the second vicinity as within an interior of a architectural building containing a dispensing machine (e.g. an implementation of the microprocessor component s102 is configured through the electronic communication subsystem 500 to electronically direct control at least in part of the acquisition of the refuse intelligence within the second vicinity as within the interior of an airport wherein the digestible product preparation system 10 is located that communicates with for instance the visual display component s304 to electronically output the electronically generated one or more selection menus also within the airport, etc.). Furthermore, the second vicinity building electrical circuitry arrangement e1221 when activated will perform the operation o1221. In an implementation, the second vicinity building electrical circuitry arrangement e1221, when activated performs electronically directing control at least in part of the acquisition of the refuse intelligence including the information related to the discarding of the one or more discarded portions by the particular individual living being within the second vicinity as within an interior of a architectural building containing a dispensing machine (e.g. an implementation of the microprocessor component s102 is configured through the electronic communication subsystem 500 to electronically direct control at least in part of the acquisition of the refuse intelligence within the second vicinity as within the interior of an airport wherein the digestible product preparation system 10 is located that communicates with for instance the visual display component s304 to electronically output the electronically generated one or more selection menus also within the airport, etc.). In an implementation, the electronically directing control at least in part of the acquisition of the refuse intelligence including the information related to the discarding of the one or more discarded portions by the particular individual living being within the second vicinity as within an interior of a architectural building containing a dispensing machine is carried out by electronically directing control at least in part of the acquisition of the refuse intelligence including the information related to the discarding of the one or more discarded portions by the particular individual living being within the second vicinity as within an interior of a architectural building containing a dispensing machine (e.g. an implementation of the microprocessor component s102 is configured through the electronic communication subsystem 500 to electronically direct control at least in part of the acquisition of the refuse intelligence within the second vicinity as within the interior of an airport wherein the digestible product preparation system 10 is located that communicates with for instance the visual display component s304 to electronically output the electronically generated one or more selection menus also within the airport, etc.).

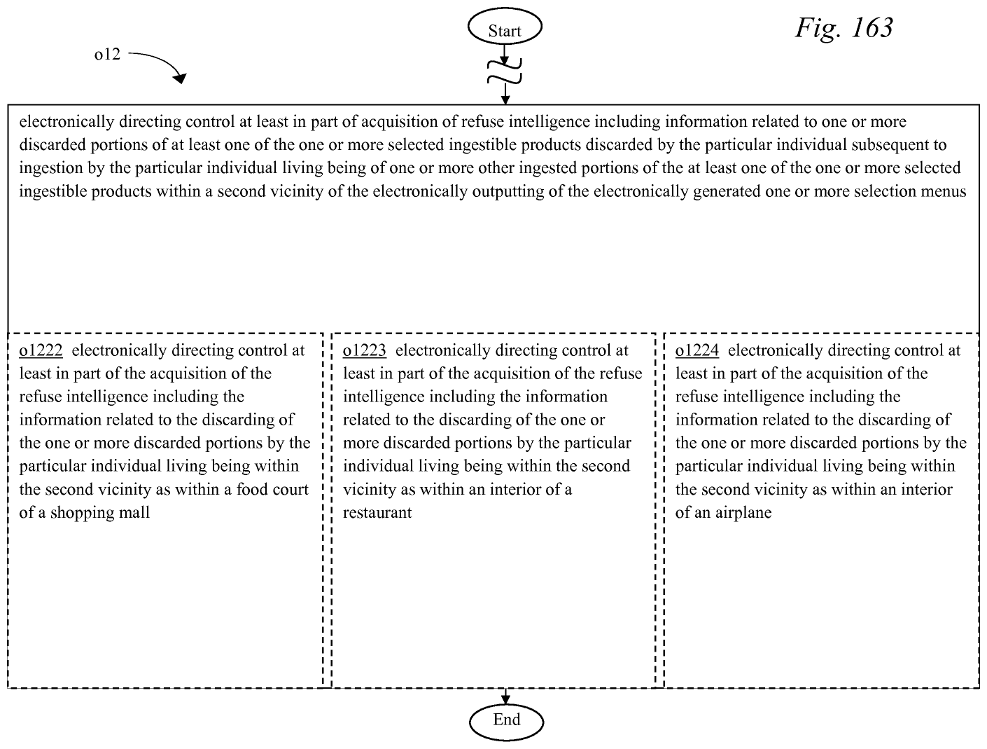

In one or more implementations, as shown in FIG. 163, operation o12 includes an operation o1222 for electronically directing control at least in part of the acquisition of the refuse intelligence including the information related to the discarding of the one or more discarded portions by the particular individual living being within the second vicinity as within a food court of a shopping mall. An exemplary version of a non-transitory signal bearing medium of information storage subsystem s200 is depicted as bearing one or more second vicinity mall instructions i11222 that when executed will direct performance of the operation o1222. In an implementation, the one or more second vicinity mall instructions i11222 when executed direct electronically directing control at least in part of the acquisition of the refuse intelligence including the information related to the discarding of the one or more discarded portions by the particular individual living being within the second vicinity as within a food court of a shopping mall (i.e. an implementation of the microprocessor component s102 is configured through the electronic communication subsystem 500 to electronically direct control at least in part of the acquisition of the refuse intelligence within the second vicinity as within the food court of the shopping mall wherein the digestible product preparation system 10 is located that communicates with for instance the visual display component s304 to electronically output the electronically generated one or more selection menus also within the food court of the shopping mall, etc.). Furthermore, the second vicinity mall electrical circuitry arrangement e1222 when activated will perform the operation o1222. In an implementation, the second vicinity mall electrical circuitry arrangement e1222, when activated performs electronically directing control at least in part of the acquisition of the refuse intelligence including the information related to the discarding of the one or more discarded portions by the particular individual living being within the second vicinity as within a food court of a shopping mall (i.e. an implementation of the microprocessor component s102 is configured through the electronic communication subsystem 500 to electronically direct control at least in part of the acquisition of the refuse intelligence within the second vicinity as within the food court of the shopping mall wherein the digestible product preparation system 10 is located that communicates with for instance the visual display component s304 to electronically output the electronically generated one or more selection menus also within the food court of the shopping mall, etc.). In an implementation, the electronically directing control at least in part of the acquisition of the refuse intelligence including the information related to the discarding of the one or more discarded portions by the particular individual living being within the second vicinity as within a food court of a shopping mall is carried out by electronically directing control at least in part of the acquisition of the refuse intelligence including the information related to the discarding of the one or more discarded portions by the particular individual living being within the second vicinity as within a food court of a shopping mall (i.e. an implementation of the microprocessor component s102 is configured through the electronic communication subsystem 500 to electronically direct control at least in part of the acquisition of the refuse intelligence within the second vicinity as within the food court of the shopping mall wherein the digestible product preparation system 10 is located that communicates with for instance the visual display component s304 to electronically output the electronically generated one or more selection menus also within the food court of the shopping mall, etc.)

In one or more implementations, operation o12 includes an operation o1223 for electronically directing control at least in part of the acquisition of the refuse intelligence including the information related to the discarding of the one or more discarded portions by the particular individual living being within the second vicinity as within an interior of a restaurant. An exemplary version of a non-transitory signal bearing medium of information storage subsystem s200 is depicted as bearing one or more second vicinity restaurant instructions i11223 that when executed will direct performance of the operation o1223. In an implementation, the one or more second vicinity restaurant instructions i11223 when executed direct electronically directing control at least in part of the acquisition of the refuse intelligence including the information related to the discarding of the one or more discarded portions by the particular individual living being within the second vicinity as within an interior of a restaurant (i.e. an implementation of the microprocessor component s102 is configured through the electronic communication subsystem 500 to electronically direct control at least in part of the acquisition of the refuse intelligence within the second vicinity as within the interior of the restaurant wherein the digestible product preparation system 10 is located that communicates with for instance the visual display component s304 to electronically output the electronically generated one or more selection menus also within the restaurant, etc.). Furthermore, the second vicinity restaurant electrical circuitry arrangement e1223 when activated will perform the operation o1223. In an implementation, the second vicinity restaurant electrical circuitry arrangement e1223, when activated performs electronically directing control at least in part of the acquisition of the refuse intelligence including the information related to the discarding of the one or more discarded portions by the particular individual living being within the second vicinity as within an interior of a restaurant (i.e. an implementation of the microprocessor component s102 is configured through the electronic communication subsystem 500 to electronically direct control at least in part of the acquisition of the refuse intelligence within the second vicinity as within the interior of the restaurant wherein the digestible product preparation system 10 is located that communicates with for instance the visual display component s304 to electronically output the electronically generated one or more selection menus also within the restaurant, etc.). In an implementation, the electronically directing control at least in part of the acquisition of the refuse intelligence including the information related to the discarding of the one or more discarded portions by the particular individual living being within the second vicinity as within an interior of a restaurant is carried out by electronically directing control at least in part of the acquisition of the refuse intelligence including the information related to the discarding of the one or more discarded portions by the particular individual living being within the second vicinity as within an interior of a restaurant (i.e. an implementation of the microprocessor component s102 is configured through the electronic communication subsystem 500 to electronically direct control at least in part of the acquisition of the refuse intelligence within the second vicinity as within the interior of the restaurant wherein the digestible product preparation system 10 is located that communicates with for instance the visual display component s304 to electronically output the electronically generated one or more selection menus also within the restaurant, etc.).

In one or more implementations, operation o12 includes an operation o1224 for electronically directing control at least in part of the acquisition of the refuse intelligence including the information related to the discarding of the one or more discarded portions by the particular individual living being within the second vicinity as within an interior of an airplane. An exemplary version of a non-transitory signal bearing medium of information storage subsystem s200 is depicted as bearing one or more second vicinity airplane instructions i11224 that when executed will direct performance of the operation o1224. In an implementation, the one or more second vicinity airplane instructions i11224 when executed direct electronically directing control at least in part of the acquisition of the refuse intelligence including the information related to the discarding of the one or more discarded portions by the particular individual living being within the second vicinity as within an interior of an airplane (i.e. an implementation of the microprocessor component s102 is configured through the electronic communication subsystem 500 to electronically direct control at least in part of the acquisition of the refuse intelligence within the second vicinity as within the interior of the airplane wherein the digestible product preparation system 10 is located that communicates with for instance the visual display component s304 to electronically output the electronically generated one or more selection menus also within the airplane, etc.). Furthermore, the second vicinity airplane electrical circuitry arrangement e1224 when activated will perform the operation o1224. In an implementation, the second vicinity airplane electrical circuitry arrangement e1224, when activated performs electronically directing control at least in part of the acquisition of the refuse intelligence including the information related to the discarding of the one or more discarded portions by the particular individual living being within the second vicinity as within an interior of an airplane (i.e. an implementation of the microprocessor component s102 is configured through the electronic communication subsystem 500 to electronically direct control at least in part of the acquisition of the refuse intelligence within the second vicinity as within the interior of the airplane wherein the digestible product preparation system 10 is located that communicates with for instance the visual display component s304 to electronically output the electronically generated one or more selection menus also within the airplane, etc.). In an implementation, the electronically directing control at least in part of the acquisition of the refuse intelligence including the information related to the discarding of the one or more discarded portions by the particular individual living being within the second vicinity as within an interior of an airplane is carried out by electronically directing control at least in part of the acquisition of the refuse intelligence including the information related to the discarding of the one or more discarded portions by the particular individual living being within the second vicinity as within an interior of an airplane (i.e. an implementation of the microprocessor component s102 is configured through the electronic communication subsystem 500 to electronically direct control at least in part of the acquisition of the refuse intelligence within the second vicinity as within the interior of the airplane wherein the digestible product preparation system 10 is located that communicates with for instance the visual display component s304 to electronically output the electronically generated one or more selection menus also within the airplane, etc.).

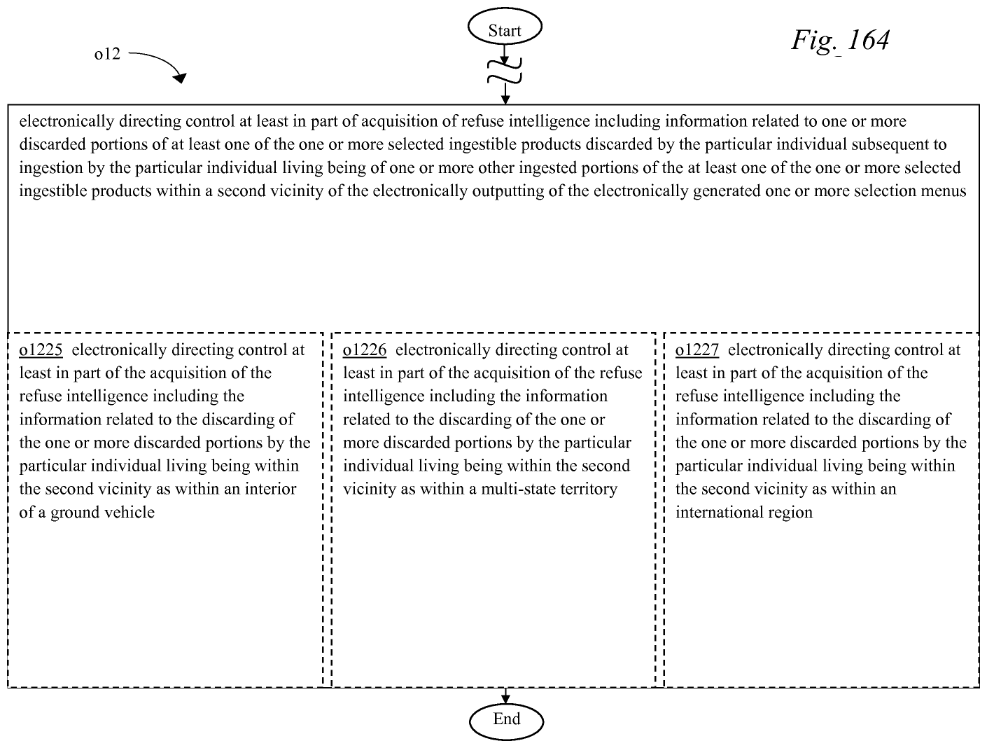

In one or more implementations, as shown in FIG. 164, operation o12 includes an operation o1225 for electronically directing control at least in part of the acquisition of the refuse intelligence including the information related to the one or more discarded portions of the at least one of the one or more selected ingestible products discarded by the particular individual living being regarding fat, protein, or carbohydrate content of the one or more discarded portions of the at least one of the one or more selected ingestible products. An exemplary version of a non-transitory signal bearing medium of information storage subsystem s200 is depicted as bearing one or more second vicinity vehicle instructions i11225 that when executed will direct performance of the operation o1225. In an implementation, the one or more second vicinity vehicle instructions i11225 when executed direct electronically directing control at least in part of the acquisition of the refuse intelligence including the information related to the discarding of the one or more discarded portions by the particular individual living being within the second vicinity as within an interior of a ground vehicle (i.e. an implementation of the microprocessor component s102 is configured through the electronic communication subsystem 500 to electronically direct control at least in part of the acquisition of the refuse intelligence within the second vicinity as within the interior of the ground vehicle wherein the digestible product preparation system 10 is located that communicates with for instance the visual display component s304 to electronically output the electronically generated one or more selection menus also within the ground vehicle, etc.). Furthermore, the second vicinity vehicle electrical circuitry arrangement e1225 when activated will perform the operation o1225. In an implementation, the second vicinity vehicle electrical circuitry arrangement e1225, when activated performs electronically directing control at least in part of the acquisition of the refuse intelligence including the information related to the discarding of the one or more discarded portions by the particular individual living being within the second vicinity as within an interior of a ground vehicle (i.e. an implementation of the microprocessor component s102 is configured through the electronic communication subsystem 500 to electronically direct control at least in part of the acquisition of the refuse intelligence within the second vicinity as within the interior of the ground vehicle wherein the digestible product preparation system 10 is located that communicates with for instance the visual display component s304 to electronically output the electronically generated one or more selection menus also within the ground vehicle, etc.). In an implementation, the electronically directing control at least in part of the acquisition of the refuse intelligence including the information related to the discarding of the one or more discarded portions by the particular individual living being within the second vicinity as within an interior of a ground vehicle is carried out by electronically directing control at least in part of the acquisition of the refuse intelligence including the information related to the discarding of the one or more discarded portions by the particular individual living being within the second vicinity as within an interior of a ground vehicle (i.e. an implementation of the microprocessor component s102 is configured through the electronic communication subsystem 500 to electronically direct control at least in part of the acquisition of the refuse intelligence within the second vicinity as within the interior of the ground vehicle wherein the digestible product preparation system 10 is located that communicates with for instance the visual display component s304 to electronically output the electronically generated one or more selection menus also within the ground vehicle, etc.)

In one or more implementations, operation o12 includes an operation o1226 for electronically directing control at least in part of the acquisition of the refuse intelligence including the information related to the discarding of the one or more discarded portions by the particular individual living being within the second vicinity as within a multi-state territory. An exemplary version of a non-transitory signal bearing medium of information storage subsystem s200 is depicted as bearing one or more second vicinity territory instructions i11226 that when executed will direct performance of the operation o1226. In an implementation, the one or more second vicinity territory instructions i11226 when executed direct electronically directing control at least in part of the acquisition of the refuse intelligence including the information related to the discarding of the one or more discarded portions by the particular individual living being within the second vicinity as within a multi-state territory (i.e. an implementation of the microprocessor component s102 is configured through the electronic communication subsystem 500 to electronically direct control at least in part of the acquisition of the refuse intelligence within the second vicinity as within the interior of the multi-state territory of Colorado, Wyoming, Montana, Utah, New Mexico, and Texas wherein the digestible product preparation system 10 is located that communicates with for instance the visual display component s304 to electronically output the electronically generated one or more selection menus also within the multi-state territory of Colorado, Wyoming, Montana, Utah, New Mexico, and Texas, etc.). Furthermore, the second vicinity territory electrical circuitry arrangement e1226 when activated will perform the operation o1226. In an implementation, the second vicinity territory electrical circuitry arrangement e1226, when activated performs electronically directing control at least in part of the acquisition of the refuse intelligence including the information related to the discarding of the one or more discarded portions by the particular individual living being within the second vicinity as within a multi-state territory (i.e. an implementation of the microprocessor component s102 is configured through the electronic communication subsystem 500 to electronically direct control at least in part of the acquisition of the refuse intelligence within the second vicinity as within the interior of the multi-state territory of Colorado, Wyoming, Montana, Utah, New Mexico, and Texas wherein the digestible product preparation system 10 is located that communicates with for instance the visual display component s304 to electronically output the electronically generated one or more selection menus also within the multi-state territory of Colorado, Wyoming, Montana, Utah, New Mexico, and Texas, etc.). In an implementation, the electronically directing control at least in part of the acquisition of the refuse intelligence including the information related to the discarding of the one or more discarded portions by the particular individual living being within the second vicinity as within a multi-state territory is carried out by electronically directing control at least in part of the acquisition of the refuse intelligence including the information related to the discarding of the one or more discarded portions by the particular individual living being within the second vicinity as within a multi-state territory (i.e. an implementation of the microprocessor component s102 is configured through the electronic communication subsystem 500 to electronically direct control at least in part of the acquisition of the refuse intelligence within the second vicinity as within the interior of the multi-state territory of Colorado, Wyoming, Montana, Utah, New Mexico, and Texas wherein the digestible product preparation system 10 is located that communicates with for instance the visual display component s304 to electronically output the electronically generated one or more selection menus also within the multi-state territory of Colorado, Wyoming, Montana, Utah, New Mexico, and Texas, etc.).

In one or more implementations, operation o12 includes an operation o1227 for electronically directing control at least in part of the acquisition of the refuse intelligence including the information related to the discarding of the one or more discarded portions by the particular individual living being within the second vicinity as within an international region. An exemplary version of a non-transitory signal bearing medium of information storage subsystem s200 is depicted as bearing one or more second vicinity region instructions i11227 that when executed will direct performance of the operation o1227. In an implementation, the one or more second vicinity region instructions i11227 when executed direct electronically directing control at least in part of the acquisition of the refuse intelligence including the information related to the discarding of the one or more discarded portions by the particular individual living being within the second vicinity as within an international region (i.e. an implementation of the microprocessor component s102 is configured through the electronic communication subsystem 500 to electronically direct control at least in part of the acquisition of the refuse intelligence within the second vicinity as within the international region of England, Germany, France, Brazil, Russia, India, China, and the United States wherein the digestible product preparation system 10 is located that communicates with for instance the visual display component s304 to electronically output the electronically generated one or more selection menus also within the international region of England, Germany, France, Brazil, Russia, India, China, and the United States, etc.). Furthermore, the second vicinity region electrical circuitry arrangement e1227 when activated will perform the operation o1227. In an implementation, the second vicinity region electrical circuitry arrangement e1227, when activated performs electronically directing control at least in part of the acquisition of the refuse intelligence including the information related to the discarding of the one or more discarded portions by the particular individual living being within the second vicinity as within an international region (i.e. an implementation of the microprocessor component s102 is configured through the electronic communication subsystem 500 to electronically direct control at least in part of the acquisition of the refuse intelligence within the second vicinity as within the international region of England, Germany, France, Brazil, Russia, India, China, and the United States wherein the digestible product preparation system 10 is located that communicates with for instance the visual display component s304 to electronically output the electronically generated one or more selection menus also within the international region of England, Germany, France, Brazil, Russia, India, China, and the United States, etc.). In an implementation, the electronically directing control at least in part of the acquisition of the refuse intelligence including the information related to the discarding of the one or more discarded portions by the particular individual living being within the second vicinity as within an international region is carried out by electronically directing control at least in part of the acquisition of the refuse intelligence including the information related to the discarding of the one or more discarded portions by the particular individual living being within the second vicinity as within an international region (i.e. an implementation of the microprocessor component s102 is configured through the electronic communication subsystem 500 to electronically direct control at least in part of the acquisition of the refuse intelligence within the second vicinity as within the international region of England, Germany, France, Brazil, Russia, India, China, and the United States wherein the digestible product preparation system 10 is located that communicates with for instance the visual display component s304 to electronically output the electronically generated one or more selection menus also within the international region of England, Germany, France, Brazil, Russia, India, China, and the United States, etc.).

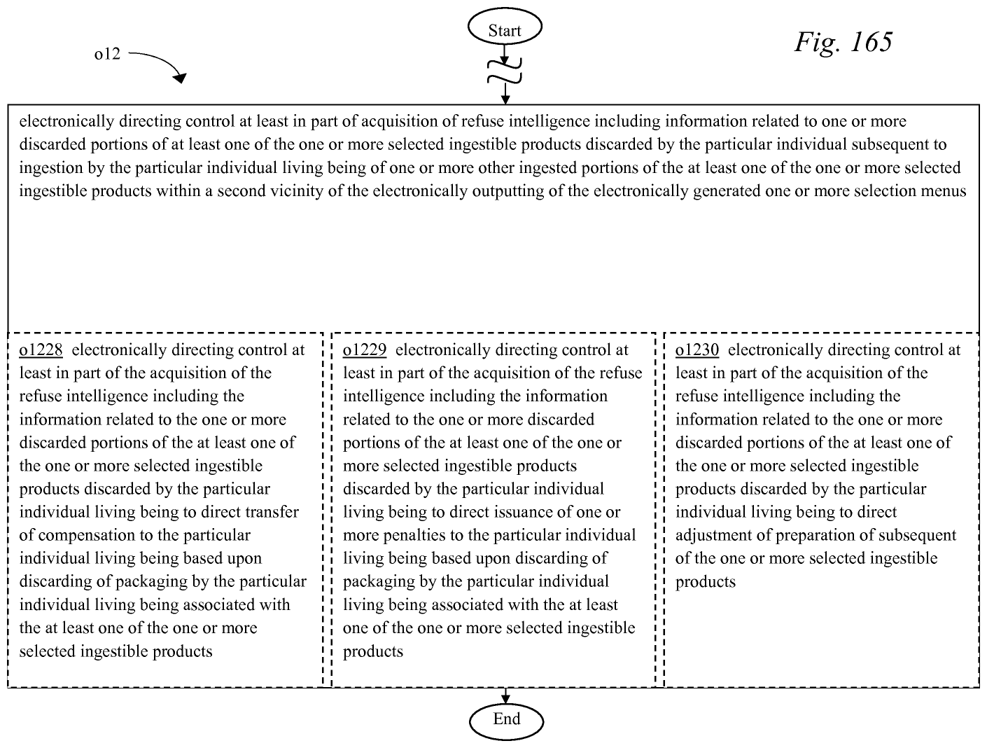

In one or more implementations, as shown in FIG. 165, operation o12 includes an operation o1228 for electronically directing control at least in part of the acquisition of the refuse intelligence including the information related to the one or more discarded portions of the at least one of the one or more selected ingestible products discarded by the particular individual living being to direct transfer of compensation to the particular individual living being based upon discarding of packaging by the particular individual living being associated with the at least one of the one or more selected ingestible products. An exemplary version of a non-transitory signal bearing medium of information storage subsystem s200 is depicted as bearing one or more acquisition compensation instructions i11228 that when executed will direct performance of the operation o1228. In an implementation, the one or more acquisition compensation instructions i11228 when executed direct electronically directing control at least in part of the acquisition of the refuse intelligence including the information related to the one or more discarded portions of the at least one of the one or more selected ingestible products discarded by the particular individual living being to direct transfer of compensation to the particular individual living being based upon discarding of packaging by the particular individual living being associated with the at least one of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being regarding to direct transfer of compensation such as through transfer program operated by the microprocessor s102 to the particular individual living being based upon discarding of packaging by the particular individual living being associated with the at least one of the one or more selected ingestible products, etc.). Furthermore, the acquisition compensation electrical circuitry arrangement e1228 when activated will perform the operation o1228. In an implementation, the acquisition compensation electrical circuitry arrangement e1228, when activated performs electronically directing control at least in part of the acquisition of the refuse intelligence including the information related to the one or more discarded portions of the at least one of the one or more selected ingestible products discarded by the particular individual living being to direct transfer of compensation to the particular individual living being based upon discarding of packaging by the particular individual living being associated with the at least one of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being regarding to direct transfer of compensation such as through transfer program operated by the microprocessor s102 to the particular individual living being based upon discarding of packaging by the particular individual living being associated with the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being to direct transfer of compensation to the particular individual living being based upon discarding of packaging by the particular individual living being associated with the at least one of the one or more selected ingestible products is carried out by electronically directing control at least in part of the acquisition of the refuse intelligence including the information related to the one or more discarded portions of the at least one of the one or more selected ingestible products discarded by the particular individual living being to direct transfer of compensation to the particular individual living being based upon discarding of packaging by the particular individual living being associated with the at least one of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being regarding to direct transfer of compensation such as through transfer program operated by the microprocessor s102 to the particular individual living being based upon discarding of packaging by the particular individual living being associated with the at least one of the one or more selected ingestible products, etc.)

In one or more implementations, operation o12 includes an operation o1229 for electronically directing control at least in part of the acquisition of the refuse intelligence including the information related to the one or more discarded portions of the at least one of the one or more selected ingestible products discarded by the particular individual living being to direct issuance of one or more penalties to the particular individual living being based upon discarding of packaging by the particular individual living being associated with the at least one of the one or more selected ingestible products. An exemplary version of a non-transitory signal bearing medium of information storage subsystem s200 is depicted as bearing one or more acquisition penalty instructions i11229 that when executed will direct performance of the operation o1229. In an implementation, the one or more acquisition penalty instructions i11229 when executed direct electronically directing control at least in part of the acquisition of the refuse intelligence including the information related to the one or more discarded portions of the at least one of the one or more selected ingestible products discarded by the particular individual living being to direct issuance of one or more penalties to the particular individual living being based upon discarding of packaging by the particular individual living being associated with the at least one of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct issuance of one or more penalties such as through penalty issuance application operated by microprocessor s102 to the particular individual living being based upon discarding of packaging by the particular individual living being associated with the at least one of the one or more selected ingestible products, etc.). Furthermore, the acquisition penalty electrical circuitry arrangement e1229 when activated will perform the operation o1229. In an implementation, the acquisition penalty electrical circuitry arrangement e1229, when activated performs electronically directing control at least in part of the acquisition of the refuse intelligence including the information related to the one or more discarded portions of the at least one of the one or more selected ingestible products discarded by the particular individual living being to direct issuance of one or more penalties to the particular individual living being based upon discarding of packaging by the particular individual living being associated with the at least one of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct issuance of one or more penalties such as through penalty issuance application operated by microprocessor s102 to the particular individual living being based upon discarding of packaging by the particular individual living being associated with the at least one of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being to direct issuance of one or more penalties to the particular individual living being based upon discarding of packaging by the particular individual living being associated with the at least one of the one or more selected ingestible products is carried out by electronically directing control at least in part of the acquisition of the refuse intelligence including the information related to the one or more discarded portions of the at least one of the one or more selected ingestible products discarded by the particular individual living being to direct issuance of one or more penalties to the particular individual living being based upon discarding of packaging by the particular individual living being associated with the at least one of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct issuance of one or more penalties such as through penalty issuance application operated by microprocessor s102 to the particular individual living being based upon discarding of packaging by the particular individual living being associated with the at least one of the one or more selected ingestible products, etc.).

In one or more implementations, operation o12 includes an operation o1230 for electronically directing control at least in part of the acquisition of the refuse intelligence including the information related to the one or more discarded portions of the at least one of the one or more selected ingestible products discarded by the particular individual living being to direct adjustment of preparation of subsequent of the one or more selected ingestible products. An exemplary version of a non-transitory signal bearing medium of information storage subsystem s200 is depicted as bearing one or more acquisition adjust preparation instructions i11230 that when executed will direct performance of the operation o1230. In an implementation, the one or more acquisition adjust preparation instructions i11230 when executed direct electronically directing control at least in part of the acquisition of the refuse intelligence including the information related to the one or more discarded portions of the at least one of the one or more selected ingestible products discarded by the particular individual living being to direct adjustment of preparation of subsequent of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct adjustment of preparation such as through microprocessor s102 and material processing subsystem s700 of subsequent of the one or more selected ingestible products, etc.). Furthermore, the acquisition adjust preparation electrical circuitry arrangement e1230 when activated will perform the operation o1230. In an implementation, the acquisition adjust preparation electrical circuitry arrangement e1230, when activated performs electronically directing control at least in part of the acquisition of the refuse intelligence including the information related to the one or more discarded portions of the at least one of the one or more selected ingestible products discarded by the particular individual living being to direct adjustment of preparation of subsequent of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct adjustment of preparation such as through microprocessor s102 and material processing subsystem s700 of subsequent of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being to direct adjustment of preparation of subsequent of the one or more selected ingestible products is carried out by electronically directing control at least in part of the acquisition of the refuse intelligence including the information related to the one or more discarded portions of the at least one of the one or more selected ingestible products discarded by the particular individual living being to direct adjustment of preparation of subsequent of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct adjustment of preparation such as through microprocessor s102 and material processing subsystem s700 of subsequent of the one or more selected ingestible products, etc.).

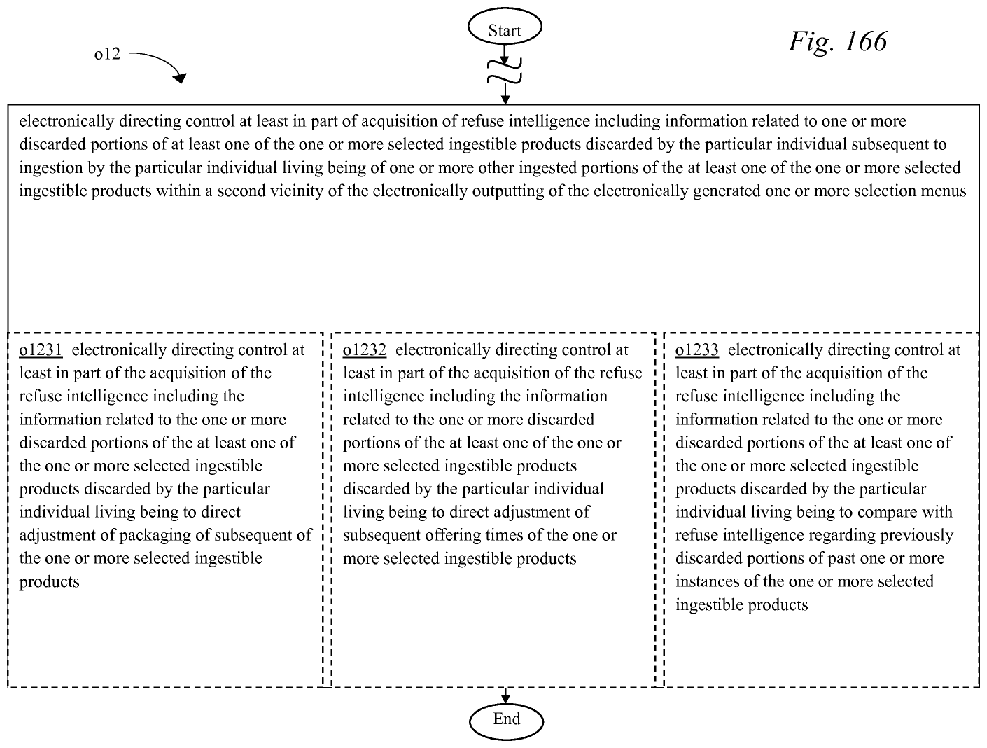

In one or more implementations, as shown in FIG. 166, operation o12 includes an operation o1231 for electronically directing control at least in part of the acquisition of the refuse intelligence including the information related to the one or more discarded portions of the at least one of the one or more selected ingestible products discarded by the particular individual living being to direct adjustment of packaging of subsequent of the one or more selected ingestible products. An exemplary version of a non-transitory signal bearing medium of information storage subsystem s200 is depicted as bearing one or more acquisition adjust packaging instructions i11231 that when executed will direct performance of the operation o1231. In an implementation, the one or more acquisition adjust packaging instructions i11231 when executed direct electronically directing control at least in part of the acquisition of the refuse intelligence including the information related to the one or more discarded portions of the at least one of the one or more selected ingestible products discarded by the particular individual living being to direct adjustment of packaging of subsequent of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct adjustment of packaging such as through microprocessor s102 and material storage component s734 of subsequent of the one or more selected ingestible products, etc.). Furthermore, the acquisition adjust packaging electrical circuitry arrangement e1231 when activated will perform the operation o1231. In an implementation, the acquisition adjust packaging electrical circuitry arrangement e1231, when activated performs electronically directing control at least in part of the acquisition of the refuse intelligence including the information related to the one or more discarded portions of the at least one of the one or more selected ingestible products discarded by the particular individual living being to direct adjustment of packaging of subsequent of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct adjustment of packaging such as through microprocessor s102 and material storage component s734 of subsequent of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being to direct adjustment of packaging of subsequent of the one or more selected ingestible products is carried out by electronically directing control at least in part of the acquisition of the refuse intelligence including the information related to the one or more discarded portions of the at least one of the one or more selected ingestible products discarded by the particular individual living being to direct adjustment of packaging of subsequent of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct adjustment of packaging such as through microprocessor s102 and material storage component s734 of subsequent of the one or more selected ingestible products, etc.)

In one or more implementations, operation o12 includes an operation o1232 for electronically directing control at least in part of the acquisition of the refuse intelligence including the information related to the one or more discarded portions of the at least one of the one or more selected ingestible products discarded by the particular individual living being to direct adjustment of subsequent offering times of the one or more selected ingestible products. An exemplary version of a non-transitory signal bearing medium of information storage subsystem s200 is depicted as bearing one or more acquisition adjust offering instructions i11232 that when executed will direct performance of the operation o1232. In an implementation, the one or more acquisition adjust offering instructions i11232 when executed direct electronically directing control at least in part of the acquisition of the refuse intelligence including the information related to the one or more discarded portions of the at least one of the one or more selected ingestible products discarded by the particular individual living being to direct adjustment of subsequent offering times of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct adjustment of subsequent offering times through scheduling application operated by microprocessor s102 of the one or more selected ingestible products, etc.). Furthermore, the acquisition adjust offering electrical circuitry arrangement e1232 when activated will perform the operation o1232. In an implementation, the acquisition adjust offering electrical circuitry arrangement e1232, when activated performs electronically directing control at least in part of the acquisition of the refuse intelligence including the information related to the one or more discarded portions of the at least one of the one or more selected ingestible products discarded by the particular individual living being to direct adjustment of subsequent offering times of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct adjustment of subsequent offering times through scheduling application operated by microprocessor s102 of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being to direct adjustment of subsequent offering times of the one or more selected ingestible products is carried out by electronically directing control at least in part of the acquisition of the refuse intelligence including the information related to the one or more discarded portions of the at least one of the one or more selected ingestible products discarded by the particular individual living being to direct adjustment of subsequent offering times of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to direct adjustment of subsequent offering times through scheduling application operated by microprocessor s102 of the one or more selected ingestible products, etc.).

In one or more implementations, operation o12 includes an operation o1233 for electronically directing control at least in part of the acquisition of the refuse intelligence including the information related to the one or more discarded portions of the at least one of the one or more selected ingestible products discarded by the particular individual living being to compare with refuse intelligence regarding previously discarded portions of past one or more instances of the one or more selected ingestible products. An exemplary version of a non-transitory signal bearing medium of information storage subsystem s200 is depicted as bearing one or more acquisition compare previous instructions i11233 that when executed will direct performance of the operation o1233. In an implementation, the one or more acquisition compare previous instructions i11233 when executed direct electronically directing control at least in part of the acquisition of the refuse intelligence including the information related to the one or more discarded portions of the at least one of the one or more selected ingestible products discarded by the particular individual living being to compare with refuse intelligence regarding previously discarded portions of past one or more instances of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to compare with refuse intelligence regarding previously discarded portions such as through comparison application operated by microprocessor s102 with access to disk farm component s224 containing historical refuse data of past one or more instances of the one or more selected ingestible products, etc.). Furthermore, the acquisition compare previous electrical circuitry arrangement e1233 when activated will perform the operation o1233. In an implementation, the acquisition compare previous electrical circuitry arrangement e1233, when activated performs electronically directing control at least in part of the acquisition of the refuse intelligence including the information related to the one or more discarded portions of the at least one of the one or more selected ingestible products discarded by the particular individual living being to compare with refuse intelligence regarding previously discarded portions of past one or more instances of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to compare with refuse intelligence regarding previously discarded portions such as through comparison application operated by microprocessor s102 with access to disk farm component s224 containing historical refuse data of past one or more instances of the one or more selected ingestible products, etc.). In an implementation, the electronically directing control at least in part of the acquisition of the refuse intelligence including the information related to the one or more discarded portions of the at least one of the one or more selected ingestible products discarded by the particular individual living being to compare with refuse intelligence regarding previously discarded portions of past one or more instances of the one or more selected ingestible products is carried out by electronically directing control at least in part of the acquisition of the refuse intelligence including the information related to the one or more discarded portions of the at least one of the one or more selected ingestible products discarded by the particular individual living being to compare with refuse intelligence regarding previously discarded portions of past one or more instances of the one or more selected ingestible products (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being to compare with refuse intelligence regarding previously discarded portions such as through comparison application operated by microprocessor s102 with access to disk farm component s224 containing historical refuse data of past one or more instances of the one or more selected ingestible products, etc.).

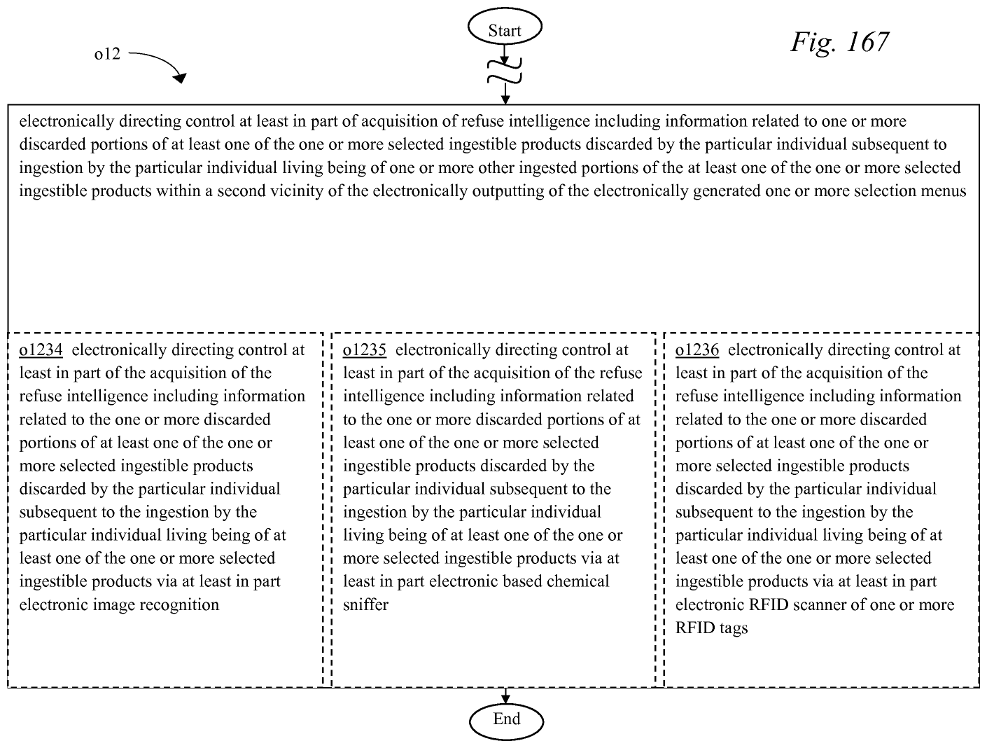

In one or more implementations, as shown in FIG. 167, operation o12 includes an operation o1234 for electronically directing control at least in part of the acquisition of the refuse intelligence including information related to the one or more discarded portions of at least one of the one or more selected ingestible products discarded by the particular individual subsequent to the ingestion by the particular individual living being via at least in part electronic image recognition. An exemplary version of a non-transitory signal bearing medium of information storage subsystem s200 is depicted as bearing one or more acquisition image instructions i11234 that when executed will direct performance of the operation o1234. In an implementation, the one or more acquisition image instructions i11234 when executed direct electronically directing control at least in part of the acquisition of the refuse intelligence including information related to the one or more discarded portions of the at least one of the one or more selected ingestible products discarded by the particular individual living being subsequent to the ingestion by the particular individual living being via at least in part electronic image recognition (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being via at least in part electronic image recognition products such as the image recognition application implemented by the microprocessor component s102, etc.). Furthermore, the acquisition image electrical circuitry arrangement e1234 when activated will perform the operation o1234. In an implementation, the acquisition image electrical circuitry arrangement e1234, when activated performs electronically directing control at least in part of the acquisition of the refuse intelligence including information related to the one or more discarded portions of the at least one of the one or more selected ingestible products discarded by the particular individual living being subsequent to the ingestion by the particular individual living being via at least in part electronic image recognition (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being via at least in part electronic image recognition products such as the image recognition application implemented by the microprocessor component s102, etc.). In an implementation, the electronically directing control at least in part of the acquisition of the refuse intelligence including information related to the one or more discarded portions of at least one of the one or more selected ingestible products discarded by the particular individual subsequent to the ingestion by the particular individual living being via at least in part electronic image recognition is carried out by electronically directing control at least in part of the acquisition of the refuse intelligence including information related to the one or more discarded portions of the at least one of the one or more selected ingestible products discarded by the particular individual living being subsequent to the ingestion by the particular individual living being via at least in part electronic image recognition (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being via at least in part electronic image recognition products such as the image recognition application implemented by the microprocessor component s102, etc.)

In one or more implementations, operation o12 includes an operation o1235 for electronically directing control at least in part of the acquisition of the refuse intelligence including information related to the one or more discarded portions of at least one of the one or more selected ingestible products discarded by the particular individual subsequent to the ingestion by the particular individual living being via at least in part electronic based chemical sniffer. An exemplary version of a non-transitory signal bearing medium of information storage subsystem s200 is depicted as bearing one or more acquisition sniffer instructions i11235 that when executed will direct performance of the operation o1235. In an implementation, the one or more acquisition sniffer instructions i11235 when executed direct electronically directing control at least in part of the acquisition of the refuse intelligence including information related to the one or more discarded portions of the at least one of the one or more selected ingestible products discarded by the particular individual living being subsequent to the ingestion by the particular individual living being via at least in part electronic based chemical sniffer (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being via at least in part electronic based chemical sniffer such as a chemical recognition application implemented by chemical sensing component s416 with the microprocessor component s102, etc.). Furthermore, the acquisition sniffer electrical circuitry arrangement e1235 when activated will perform the operation o1235. In an implementation, the acquisition sniffer electrical circuitry arrangement e1235, when activated performs electronically directing control at least in part of the acquisition of the refuse intelligence including information related to the one or more discarded portions of the at least one of the one or more selected ingestible products discarded by the particular individual living being subsequent to the ingestion by the particular individual living being via at least in part electronic based chemical sniffer (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being via at least in part electronic based chemical sniffer such as a chemical recognition application implemented by chemical sensing component s416 with the microprocessor component s102, etc.). In an implementation, the electronically directing control at least in part of the acquisition of the refuse intelligence including information related to the one or more discarded portions of at least one of the one or more selected ingestible products discarded by the particular individual subsequent to the ingestion by the particular individual living being via at least in part electronic based chemical sniffer is carried out by electronically directing control at least in part of the acquisition of the refuse intelligence including information related to the one or more discarded portions of the at least one of the one or more selected ingestible products discarded by the particular individual living being subsequent to the ingestion by the particular individual living being via at least in part electronic based chemical sniffer (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being via at least in part electronic based chemical sniffer such as a chemical recognition application implemented by chemical sensing component s416 with the microprocessor component s102, etc.).

In one or more implementations, operation o12 includes an operation o1236 for electronically directing control at least in part of the acquisition of the refuse intelligence including information related to the one or more discarded portions of at least one of the one or more selected ingestible products discarded by the particular individual subsequent to the ingestion by the particular individual living being via at least in part electronic RFID scanner of one or more RFID tags. An exemplary version of a non-transitory signal bearing medium of information storage subsystem s200 is depicted as bearing one or more acquisition RFID instructions i11236 that when executed will direct performance of the operation o1236. In an implementation, the one or more acquisition RFID instructions i11236 when executed direct electronically directing control at least in part of the acquisition of the refuse intelligence including information related to the one or more discarded portions of the at least one of the one or more selected ingestible products discarded by the particular individual living being subsequent to the ingestion by the particular individual living being via at least in part electronic RFID scanner of one or more RFID tags (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being subsequent to the ingestion by the particular individual living being via at least in part electronic RFID scanner of one or more RFID tags such as embedded in packaging and/or ingestible product as read by radio frequency identification (RFID) sensing component s414 with recognition application implemented by the microprocessor component s102, etc.). Furthermore, the acquisition RFID electrical circuitry arrangement e1236 when activated will perform the operation o1236. In an implementation, the acquisition RFID electrical circuitry arrangement e1236, when activated performs electronically directing control at least in part of the acquisition of the refuse intelligence including information related to the one or more discarded portions of the at least one of the one or more selected ingestible products discarded by the particular individual living being subsequent to the ingestion by the particular individual living being via at least in part electronic RFID scanner of one or more RFID tags (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being subsequent to the ingestion by the particular individual living being via at least in part electronic RFID scanner of one or more RFID tags such as embedded in packaging and/or ingestible product as read by radio frequency identification (RFID) sensing component s414 with recognition application implemented by the microprocessor component s102, etc.). In an implementation, the electronically directing control at least in part of the acquisition of the refuse intelligence including information related to the one or more discarded portions of at least one of the one or more selected ingestible products discarded by the particular individual subsequent to the ingestion by the particular individual living being via at least in part electronic RFID scanner of one or more RFID tags is carried out by electronically directing control at least in part of the acquisition of the refuse intelligence including information related to the one or more discarded portions of the at least one of the one or more selected ingestible products discarded by the particular individual living being subsequent to the ingestion by the particular individual living being via at least in part electronic RFID scanner of one or more RFID tags (e.g. an implementation of the microprocessor component s102 is configured to electronically control at least in part the acquisition such as through camera component s336 and recognition application implemented by microprocessor component s102 of the refuse intelligence including the information related to the one or more discarded portions of the at least one of the one or more selected ingestible products discarded by the particular individual living being subsequent to the ingestion by the particular individual living being via at least in part electronic RFID scanner of one or more RFID tags such as embedded in packaging and/or ingestible product as read by radio frequency identification (RFID) sensing component s414 with recognition application implemented by the microprocessor component s102, etc.).

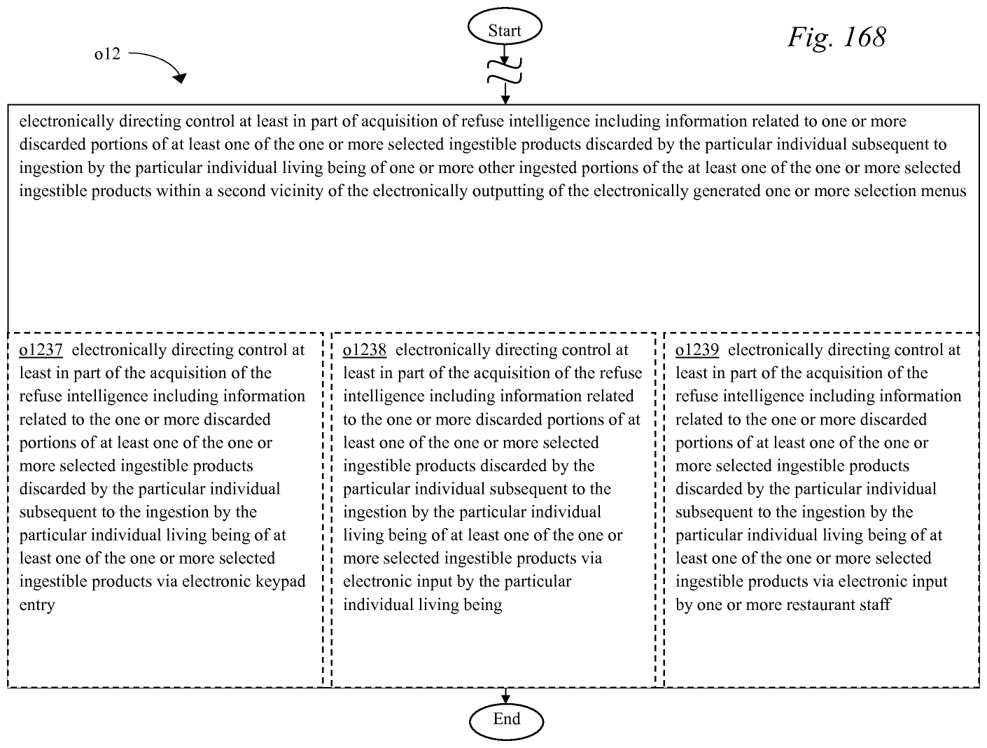

In one or more implementations, as shown in FIG. 168, operation o12 includes an operation o1237 for electronically directing control at least in part of the acquisition of the refuse intelligence including information related to the one or more discarded portions of at least one of the one or more selected ingestible products discarded by the particular individual subsequent to the ingestion by the particular individual living being via electronic keypad entry. An exemplary version of a non-transitory signal bearing medium of information storage subsystem s200 is depicted as bearing one or more acquisition keypad instructions i11237 that when executed will direct performance of the operation o1237. In an implementation, the one or more acquisition keypad instructions i11237 when executed direct electronically directing control at least in part of the acquisition of the refuse intelligence including information related to the one or more discarded portions of at least one of the one or more selected ingestible products discarded by the particular individual living being subsequent to the ingestion by the particular individual living being via electronic keypad entry (e.g. an implementation of the microprocessor component s102 is configured to electronically control at least in part the acquisition of the refuse intelligence including the information related to the one or more discarded portions of the at least one of the one or more selected ingestible products discarded by the particular individual living being subsequent to the ingestion by the particular individual living being via electronic keypad entry such as keypad component s308 communicatively linked to the microprocessor component s102, etc.). Furthermore, the acquisition keypad electrical circuitry arrangement e1237 when activated will perform the operation o1237. In an implementation, the acquisition keypad electrical circuitry arrangement e1237, when activated performs electronically directing control at least in part of the acquisition of the refuse intelligence including information related to the one or more discarded portions of at least one of the one or more selected ingestible products discarded by the particular individual living being subsequent to the ingestion by the particular individual living being via electronic keypad entry (e.g. an implementation of the microprocessor component s102 is configured to electronically control at least in part the acquisition of the refuse intelligence including the information related to the one or more discarded portions of the at least one of the one or more selected ingestible products discarded by the particular individual living being subsequent to the ingestion by the particular individual living being via electronic keypad entry such as keypad component s308 communicatively linked to the microprocessor component s102, etc.). In an implementation, the electronically directing control at least in part of the acquisition of the refuse intelligence including information related to the one or more discarded portions of at least one of the one or more selected ingestible products discarded by the particular individual subsequent to the ingestion by the particular individual living being via electronic keypad entry is carried out by electronically directing control at least in part of the acquisition of the refuse intelligence including information related to the one or more discarded portions of at least one of the one or more selected ingestible products discarded by the particular individual living being subsequent to the ingestion by the particular individual living being via electronic keypad entry (e.g. an implementation of the microprocessor component s102 is configured to electronically control at least in part the acquisition of the refuse intelligence including the information related to the one or more discarded portions of the at least one of the one or more selected ingestible products discarded by the particular individual living being subsequent to the ingestion by the particular individual living being via electronic keypad entry such as keypad component s308 communicatively linked to the microprocessor component s102, etc.)

In one or more implementations, operation o12 includes an operation o1238 for electronically directing control at least in part of the acquisition of the refuse intelligence including information related to the one or more discarded portions of at least one of the one or more selected ingestible products discarded by the particular individual subsequent to the ingestion by the particular individual living being via electronic input by the particular individual living being. An exemplary version of a non-transitory signal bearing medium of information storage subsystem s200 is depicted as bearing one or more acquisition input instructions i11238 that when executed will direct performance of the operation o1238. In an implementation, the one or more acquisition input instructions i11238 when executed direct electronically directing control at least in part of the acquisition of the refuse intelligence including information related to the one or more discarded portions of the at least one of the one or more selected ingestible products discarded by the particular individual living being subsequent to the ingestion by the particular individual living being via electronic input by the particular individual living being (e.g. an implementation of the microprocessor component s102 is configured to electronically control at least in part the acquisition of the refuse intelligence including the information related to the one or more discarded portions of at least one of the one or more selected ingestible products discarded by the particular individual living being subsequent to the ingestion by the particular individual living being via electronic input by the particular individual living being such as through use of the graphical user interface (GUI) component s302, etc.). Furthermore, the acquisition input electrical circuitry arrangement e1238 when activated will perform the operation o1238. In an implementation, the acquisition input electrical circuitry arrangement e1238, when activated performs electronically directing control at least in part of the acquisition of the refuse intelligence including information related to the one or more discarded portions of the at least one of the one or more selected ingestible products discarded by the particular individual living being subsequent to the ingestion by the particular individual living being via electronic input by the particular individual living being (e.g. an implementation of the microprocessor component s102 is configured to electronically control at least in part the acquisition of the refuse intelligence including the information related to the one or more discarded portions of at least one of the one or more selected ingestible products discarded by the particular individual living being subsequent to the ingestion by the particular individual living being via electronic input by the particular individual living being such as through use of the graphical user interface (GUI) component s302, etc.). In an implementation, the electronically directing control at least in part of the acquisition of the refuse intelligence including information related to the one or more discarded portions of at least one of the one or more selected ingestible products discarded by the particular individual subsequent to the ingestion by the particular individual living being via electronic input by the particular individual living being is carried out by electronically directing control at least in part of the acquisition of the refuse intelligence including information related to the one or more discarded portions of the at least one of the one or more selected ingestible products discarded by the particular individual living being subsequent to the ingestion by the particular individual living being via electronic input by the particular individual living being (e.g. an implementation of the microprocessor component s102 is configured to electronically control at least in part the acquisition of the refuse intelligence including the information related to the one or more discarded portions of at least one of the one or more selected ingestible products discarded by the particular individual living being subsequent to the ingestion by the particular individual living being via electronic input by the particular individual living being such as through use of the graphical user interface (GUI) component s302, etc.).

In one or more implementations, operation o12 includes an operation o1239 for electronically directing control at least in part of the acquisition of the refuse intelligence including information related to the one or more discarded portions of at least one of the one or more selected ingestible products discarded by the particular individual subsequent to the ingestion by the particular individual living being via electronic input by one or more restaurant staff. An exemplary version of a non-transitory signal bearing medium of information storage subsystem s200 is depicted as bearing one or more acquisition restaurant instructions i11239 that when executed will direct performance of the operation o1239. In an implementation, the one or more acquisition restaurant instructions i11239 when executed direct electronically directing control at least in part of the acquisition of the refuse intelligence including information related to the one or more discarded portions of the at least one of the one or more selected ingestible products discarded by the particular individual living being subsequent to the ingestion by the particular individual living being via electronic input by one or more restaurant staff (e.g. an implementation of the microprocessor component s102 is configured to electronically control at least in part the acquisition of the refuse intelligence including the information related to the one or more discarded portions of the at least one of the one or more selected ingestible products discarded by the particular individual living being subsequent to the ingestion by the particular individual living being via electronic input by one or more restaurant staff such as a wait person using a touch screen component s314, etc.). Furthermore, the acquisition restaurant electrical circuitry arrangement e1239 when activated will perform the operation o1239. In an implementation, the acquisition restaurant electrical circuitry arrangement e1239, when activated performs electronically directing control at least in part of the acquisition of the refuse intelligence including information related to the one or more discarded portions of the at least one of the one or more selected ingestible products discarded by the particular individual living being subsequent to the ingestion by the particular individual living being via electronic input by one or more restaurant staff (e.g. an implementation of the microprocessor component s102 is configured to electronically control at least in part the acquisition of the refuse intelligence including the information related to the one or more discarded portions of the at least one of the one or more selected ingestible products discarded by the particular individual living being subsequent to the ingestion by the particular individual living being via electronic input by one or more restaurant staff such as a wait person using a touch screen component s314, etc.). In an implementation, the electronically directing control at least in part of the acquisition of the refuse intelligence including information related to the one or more discarded portions of at least one of the one or more selected ingestible products discarded by the particular individual subsequent to the ingestion by the particular individual living being via electronic input by one or more restaurant staff is carried out by electronically directing control at least in part of the acquisition of the refuse intelligence including information related to the one or more discarded portions of the at least one of the one or more selected ingestible products discarded by the particular individual living being subsequent to the ingestion by the particular individual living being via electronic input by one or more restaurant staff (e.g. an implementation of the microprocessor component s102 is configured to electronically control at least in part the acquisition of the refuse intelligence including the information related to the one or more discarded portions of the at least one of the one or more selected ingestible products discarded by the particular individual living being subsequent to the ingestion by the particular individual living being via electronic input by one or more restaurant staff such as a wait person using a touch screen component s314, etc.).

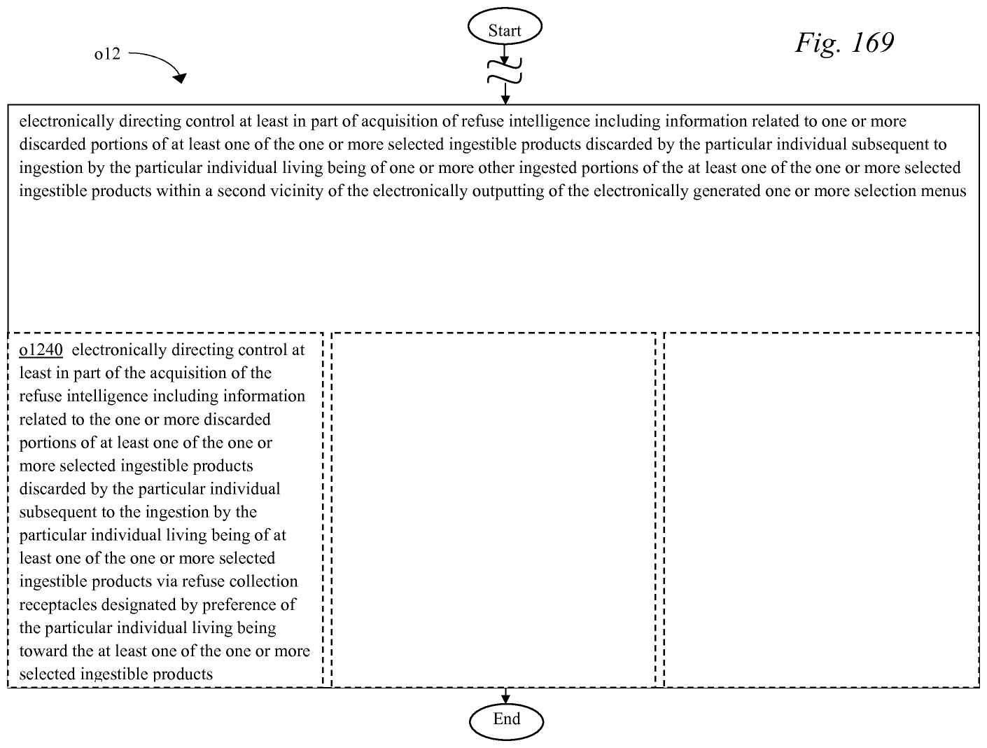

In one or more implementations, as shown in FIG. 169, operation o12 includes an operation o1240 for electronically directing control at least in part of the acquisition of the refuse intelligence including information related to the one or more discarded portions of at least one of the one or more selected ingestible products discarded by the particular individual subsequent to the ingestion by the particular individual living being via refuse collection receptacles designated by preference of the particular individual living being toward the at least one of the one or more selected ingestible products. An exemplary version of a non-transitory signal bearing medium of information storage subsystem s200 is depicted as bearing one or more acquisition receptacle instructions i11240 that when executed will direct performance of the operation o1240. In an implementation, the one or more acquisition receptacle instructions i11240 when executed direct electronically directing control at least in part of the acquisition of the refuse intelligence including information related to the one or more discarded portions of the at least one of the one or more selected ingestible products discarded by the particular individual living being subsequent to the ingestion by the particular individual living being via refuse collection receptacles designated by preference of the particular individual living being toward the at least one of the one or more selected ingestible products (e.g. an implementation of the microprocessor component s102 is configured to electronically control at least in part the acquisition of the refuse intelligence including the information related to the one or more discarded portions of the at least one of the one or more selected ingestible products discarded by the particular individual living being subsequent to the ingestion by the particular individual living being via refuse collection receptacles designated by preference of the particular individual living being toward the at least one of the one or more selected ingestible products such as through camera component s336 along with recognition application operated by microprocessor s102a, etc.). Furthermore, the acquisition receptacle electrical circuitry arrangement e1240 when activated will perform the operation o1240. In an implementation, the acquisition receptacle electrical circuitry arrangement e1240, when activated performs electronically directing control at least in part of the acquisition of the refuse intelligence including information related to the one or more discarded portions of the at least one of the one or more selected ingestible products discarded by the particular individual living being subsequent to the ingestion by the particular individual living being via refuse collection receptacles designated by preference of the particular individual living being toward the at least one of the one or more selected ingestible products (e.g. an implementation of the microprocessor component s102 is configured to electronically control at least in part the acquisition of the refuse intelligence including the information related to the one or more discarded portions of the at least one of the one or more selected ingestible products discarded by the particular individual living being subsequent to the ingestion by the particular individual living being via refuse collection receptacles designated by preference of the particular individual living being toward the at least one of the one or more selected ingestible products such as through camera component s336 along with recognition application operated by microprocessor s102a, etc.). In an implementation, the electronically directing control at least in part of the acquisition of the refuse intelligence including information related to the one or more discarded portions of at least one of the one or more selected ingestible products discarded by the particular individual subsequent to the ingestion by the particular individual living being via refuse collection receptacles designated by preference of the particular individual living being toward the at least one of the one or more selected ingestible products is carried out by electronically directing control at least in part of the acquisition of the refuse intelligence including information related to the one or more discarded portions of the at least one of the one or more selected ingestible products discarded by the particular individual living being subsequent to the ingestion by the particular individual living being via refuse collection receptacles designated by preference of the particular individual living being toward the at least one of the one or more selected ingestible products (e.g. an implementation of the microprocessor component s102 is configured to electronically control at least in part the acquisition of the refuse intelligence including the information related to the one or more discarded portions of the at least one of the one or more selected ingestible products discarded by the particular individual living being subsequent to the ingestion by the particular individual living being via refuse collection receptacles designated by preference of the particular individual living being toward the at least one of the one or more selected ingestible products such as through camera component s336 along with recognition application operated by microprocessor s102a, etc.)

Those having skill in the art will recognize that the state of the art has progressed to the point where there is little distinction left between hardware and software implementations of aspects of systems; the use of hardware or software is generally (but not always, in that in certain contexts the choice between hardware an d software can become significant) a design choice representing cost vs. efficiency tradeoffs. Those having skill in the art will appreciate that there are various vehicles by which processes and/or systems and/or other technologies described herein can be effected (e.g., hardware, software, and/or firmware in one or more machines or articles of manufacture), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation that is implemented in one or more machines or articles of manufacture; or, yet again alternatively, the implementer may opt for some combination of hardware, software, and/or firmware in one or more machines or articles of manufacture (limited to patentable subject matter under 35 USC 101). Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware in one or more machines or articles of manufacture.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof (limited to patentable subject matter under 35 U.S.C. 101). In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure (limited to patentable subject matter under 35 USC 101). In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof (limited to patentable subject matter under 35 U.S.C. 101) can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1-20. (canceled)

21. A system, comprising:
circuitry configured for outputting a menu of one or more food item options to a consumer;
circuitry configured for collecting at least one indication of one or more selected food items responsive to the menu of the one or more food item options;
circuitry configured for controlling at least one food production component to prepare the one or more selected food items based at least in part on the circuitry configured for collecting at least one indication of the one or more selected food items and based at least in part on consumer status information determined from one or more previous interactions with the consumer;
circuitry configured for acquiring at least some information related to one or more discarded portions of the one or more selected food items; and
circuitry configured for directing adjustment of one or more subsequent preparations of the one or more selected food items based at least in part on the circuitry configured for acquiring at least some information related to the one or more discarded portions of the one or more selected food items.

22. The system of claim 21, wherein circuitry configured for acquiring at least some information related to one or more discarded portions of the one or more selected food items comprises:
circuitry configured for acquiring the at least some information via image recognition of user behavior without user solicitation.

23. The system of claim 21, wherein circuitry configured for acquiring at least some information related to one or more discarded portions of the one or more selected food items comprises:
circuitry configured for acquiring the at least some information via audio data analysis of user comments.

24. The system of claim 21, wherein circuitry configured for acquiring at least some information related to one or more discarded portions of the one or more selected food items comprises:
circuitry configured for acquiring the at least some information via at least one recognition by at least one electronic RFID sensing component of one or more RFID tags embedded in at least one packaging containing the one or more selected food items.

25. The system of claim 21, further comprising:
circuitry configured for making at least one integrity determination related to at least one ingredient of the one or more selected food items; and
circuitry configured for providing an integrity indication to the consumer based at least partially on the at least one integrity determination.

26. The system of claim 21, further comprising:
circuitry configured for making at least one integrity determination related to at least one ingredient of the one or more selected food items; and
circuitry configured for inhibiting one or more preparation or dispensing operations based at least partially on the at least one integrity determination.

27. The system of claim 21, wherein circuitry configured for outputting a menu of one or more food item options comprises:
circuitry configured for outputting a menu of one or more food item options based at least in part on at least some information related to one or more previously discarded portions of past one or more instances of the one or more selected food items.

28. The system of claim 27, wherein circuitry configured for outputting a menu of one or more food item options based at least in part on at least some information related to one or more previously discarded portions of past one or more instances of the one or more selected food items comprises:
circuitry configured for outputting a menu customized for a particular user including at least one or more food items having been chosen for inclusion within the menu customized for the particular user based at least in part on at least some information related to the particular user having discarded one or more past instances of the one or more food items.

29. The system of claim 21, wherein circuitry configured for controlling at least one food production component to prepare the one or more selected food items based at least in part on the circuitry configured for collecting at least one indication of the one or more selected food items comprises:
circuitry configured for controlling at least one food deposition component to deposit one or more ingredients of the one or more selected food items at a pixel level resolution based at least in part on the circuitry configured for collecting at least one indication of the one or more selected food items.

30. The system of claim 21, wherein circuitry configured for collecting at least one indication of one or more selected food items responsive to the menu of the one or more food item options comprises:
circuitry configured for performing at least one user gesture recognition of one or more user gestures portrayed within one or more images received responsive to the menu of the one or more food item options to determine the one or more selected food items indicated by the one or more user gestures.

31. The system of claim 21, wherein circuitry configured for outputting a menu of one or more food item options comprises:
circuitry configured for receiving an identification of a user;
circuitry configured for accessing at least one disk farm component containing historical refuse data of past one or more instances of one or more food items selected by the user; and
circuitry configured for selecting one or more food items for the menu of one or more food item options for the user at least partly based on the circuitry configured for accessing the at least one disk farm component containing the historical refuse data of the past one or more instances of the one or more food items selected by the user.

32. The system of claim 21, wherein circuitry configured for controlling at least one food production component to prepare the one or more selected food items based at least in part on the circuitry configured for collecting at least one indication of the one or more selected food items comprises:
circuitry configured for controlling at least one electronic food printer to prepare the one or more selected food items based at least in part on the circuitry configured for collecting the at least one indication of the one or more selected food items.

33. The system of claim 21, wherein circuitry configured for directing adjustment of one or more subsequent preparations of the one or more selected food items based at least in part on the circuitry configured for acquiring at least some information related to the one or more discarded portions of the one or more selected food items comprises:
circuitry configured for directing adjustment of at least one packaging of the one or more subsequent preparations of the one or more selected food items based at least in part on the circuitry configured for acquiring at least some information related to the one or more discarded portions of the one or more selected food items.

34. The system of claim 21, wherein circuitry configured for directing adjustment of one or more subsequent preparations of the one or more selected food items based at least in part on the circuitry configured for acquiring at least some information related to the one or more discarded portions of the one or more selected food items comprises:
circuitry configured for directing adjustment of one or more subsequent offering times of the one or more subsequent preparations of the one or more selected food items based at least in part on the circuitry configured for acquiring at least some information related to the one or more discarded portions of the one or more selected food items.

35. The system of claim 34, wherein circuitry configured for directing adjustment of one or more subsequent offering times of the one or more subsequent preparations of the one or more selected food items based at least in part on the circuitry configured for acquiring at least some information related to the one or more discarded portions of the one or more selected food items comprises:
circuitry configured for controlling at least one scheduling application to direct the adjustment of the one or more subsequent offering times of the one or more subsequent preparations of the one or more selected food items based at least in part on the circuitry configured for acquiring at least some information related to the one or more discarded portions of the one or more selected food items.

36. The system of claim 21, wherein circuitry configured for acquiring at least some information related to one or more discarded portions of the one or more selected food items comprises:
circuitry configured for acquiring, at least partly via at least one camera component, at least some video portraying one or more discard activities related to the one or more discarded portions of the one or more selected food items; and
circuitry configured for performing image recognition upon the at least some video to analyze at least some user behavior associated with the one or more discard activities to generate the at least some information related to the one or more discarded portions of the one or more selected food items.

37. The system of claim 21, wherein circuitry configured for acquiring at least some information related to one or more discarded portions of the one or more selected food items comprises:
circuitry configured for acquiring, at least partly via at least one magnetic strip reader, the at least some information from at least one magnetic strip affixed to at least one packaging containing the one or more discarded portions of the one or more selected food items.

38. The system of claim 21, wherein circuitry configured for acquiring at least some information related to one or more discarded portions of the one or more selected food items comprises:
circuitry configured for acquiring, at least partly via at least one chemical sniffer, one or more chemical based identifiers indicative of one or more constituents of the one or more discarded portions of the one or more selected food items.

39. A system, comprising:
at least one processing device; and
one or more instructions which, when executed by the at least one processing device, cause the at least one processing device to perform one or more operations including at least:
outputting a menu of one or more food item options to a consumer;
collecting at least one indication of one or more selected food items responsive to the menu of the one or more food item options;
controlling at least one food production component to prepare the one or more selected food items based at least in part on the collecting at least one indication of the one or more selected food items and based at least in part on consumer status information determined from one or more previous interactions with the consumer;
acquiring at least some information related to one or more discarded portions of the one or more selected food items; and
directing adjustment of one or more subsequent preparations of the one or more selected food items based at least in part on the acquiring at least some information related to the one or more discarded portions of the one or more selected food items.

40. A method, comprising:
outputting a menu of one or more food item options to a consumer;
collecting at least one indication of one or more selected food items responsive to the menu of the one or more food item options;
controlling at least one food production component to prepare the one or more selected food items based at least in part on the collecting at least one indication of the one or more selected food items and based at least in part on consumer status information determined from one or more previous interactions with the consumer;
acquiring at least some information related to one or more discarded portions of the one or more selected food items; and
directing adjustment of one or more subsequent preparations of the one or more selected food items based at least in part on the acquiring at least some information related to the one or more discarded portions of the one or more selected food items,
wherein at least one of the outputting, collecting, controlling, acquiring, or directing is at least partially implemented via at least one processing device.
